(19) United States
(12) Patent Application Publication
(10) Pub. No.: US 2019/0272487 A1
(43) Pub. Date: Sep. 5, 2019

(54) System And Method For The Delivery Of Services To A Property Owner

(71) Applicant: Homee Inc., Tampa, FL (US)

(72) Inventors: David G. Theus, Florence, KY (US); Douglas C. Schaedler, Tampa, FL (US); Steven M. Brinager, Harold, KY (US); Gina Kemper, Cincinnati, OH (US)

(21) Appl. No.: 16/415,806

(22) Filed: May 17, 2019

Related U.S. Application Data
(63) Continuation-in-part of application No. 15/894,433, filed on Feb. 12, 2018.
(60) Provisional application No. 62/673,464, filed on May 18, 2018.
(60) Provisional application No. 62/777,630, filed on Dec. 10, 2018.
(60) Provisional application No. 62/457,544, filed on Feb. 10, 2017.

(51) Int. Cl. G06Q 10/06; G06Q 50/16

(52) U.S. Cl. CPC G06Q 10/06311; G06Q 10/06314; G06Q 10/06312; G06Q 50/163

(57) ABSTRACT

The invention provides for an on-demand provision of a property maintenance service job through a computing system including one or more servers that interface with a plurality of devices. A plurality of profiles for service providers are maintained for providers that provide property services. A consumer job request from a device of a consumer is captured through the system for a job at a jobsite. Then, a plurality of provider job requests may be generated for the service providers. The job requests are associated with a job and job site associated with the consumer ordering service. Job requests are directed to devices of a plurality of service providers in a sequential fashion controlled by provider criteria. An acceptance of the job request is received from a device of a service provider. Upon acceptance of the job request by the provider device, a location of the service provider device is evaluated with respect to the job site. A timer is generated and is associated with the job. The timer is configured for being started and stopped with the device of the service provider. Approval is obtained from the consumer for the start of a timer through the consumer device. Then the subsequent progression of the timer associated with the job is monitored until the job is finished or ended in another way.

### CROSS-REFERENCE TO RELATED APPLICATIONS

This application claims priority to and the benefit of the filing date of U.S. Provisional Patent Application No. 62/777,630 filed Dec. 10, 2018; and claims priority to and the benefit of the filing date of U.S. Provisional Patent Application No. 62/673,464 filed May 18, 2018. This application is a continuation-in-part to U.S. patent application Ser. No. 15/894,433 filed Feb. 12, 2018, which claims priority to and the benefit of the filing date of U.S. Provisional Patent Application No. 62/457,544 filed Feb. 10, 2017. All such applications are expressly incorporated herein by reference in their entirety.

### FIELD OF THE INVENTION

The present invention relates generally to the provision of on-demand services, and more specifically to provision of on-demand property maintenance services, including repair and improvement services for property owners.

### BACKGROUND OF THE INVENTION

Property owners, such as owners of homes or rental properties, are inherently faced with issues in maintaining the property. For example, it is often necessary to maintain or repair various mechanical systems or other systems of the property. Such maintenance may be specifically directed to electrical systems, HVAC systems, plumbing systems. Alternatively, there just may a need to fix something on the property that may or may not be tied to a specific system.

As such, property owners will engage a company to handle such property maintenance services. Traditionally, a property owner would have to find out who might offer the needed services and would then have to obtain the contact information and call and schedule such services. The experience or quality of the company or person doing the job would often be unknown. The jobs would then be scheduled in the future, often at an inconvenient time and usually involving a wait for the job to be started. The overall rate or cost of the job would be uncertain and not particularly transparent, unless the information was specifically asked for by the consumer. And even if an hourly rate was involved, it was difficult to track the work on the job and ensure efficiency and cost effectiveness. Furthermore, the job might take several days to complete and then would be billed at a later time, removed from the completion date of the job. As such, the traditional experience for a consumer is not the most convenient, cost effective, or transparent.

The provider also has some downside with respect to the particular job that is engaged in the traditional economic model. They do not know if they will get paid by the consumer. They would often get paid a significant time after the job was completed and they would have to maintain records and information to prepare a bill at a later time for presentation to the consumer. Furthermore, they have to maintain a system for scheduling and follow up on various jobs.

Accordingly, the current economic model for the provision of property maintenance services, including repair and improvement services for property owners, has some drawbacks.

The present invention addresses several of the drawbacks as noted above and other insufficiencies in the current business model by providing on-demand property maintenance services in a transparent and cost-effective manner for both the consumer and service provider.

### SUMMARY OF THE INVENTION

The invention provides for an on-demand provision of a property maintenance service job through a computing system including one or more servers that interface with a plurality of devices. A plurality of profiles for service providers are maintained for providers that provide property services. A consumer job request from a device of a consumer is captured through the system for a job at a jobsite. Then, a plurality of provider job requests may be generated for the service providers. The job requests are associated with a job and job site associated with the consumer ordering service and job request. Job requests are directed to devices of a plurality of service providers in a sequential fashion controlled by provider criteria. The service providers can be part of networks and groups or obtain certification in order to create a hierarchy in the job request flow. Similarly, consumers designate an acceptance of the job request is received from a device of a service provider. Upon acceptance of the job request by the provider device, a location of the service provider device is evaluated with respect to the job site. A timer is generated and is associated with the job and the timer is controlled in a joint fashion by both the consumer and provider in the job performance. The timer is configured for being started and stopped with the device of the service provider. Approval is obtained from the consumer for the start of a timer through the consumer device. Then the subsequent progression of the timer associated with the job is monitored until the job is finished or ended in another way.

### BRIEF DESCRIPTION OF THE DRAWINGS

The accompanying drawings, which are incorporated in and constitute a part of this specification, illustrate embodiments of the invention and, together with a general description of the invention given below, serve to explain the principles of the invention.

FIG. 1 is a block diagram of a service system, one or more mobile devices, and one or more client devices consistent with embodiments of the invention.

FIG. 2 is a block diagram of an embodiment of a service system of FIG. 1.

FIG. 3 is a block diagram of an embodiment of a mobile device of FIG. 1.

FIG. 4 is a block diagram of an embodiment of a mobile device of FIG. 1.

FIGS. 5A-5C are flow diagrams illustrating a sequence of operations for requesting a service job that may be performed by the systems and devices of FIG. 1 consistent with embodiments of the invention.

FIG. 5D is a flow diagram illustrating a sequence of operations for a provider performing a service job to completion consistent with embodiments of the invention.

FIGS. 5E-5F are flow diagrams illustrating a sequence of operations for a service job where a provider reaches a limit for the job consistent with embodiments of the invention.

FIGS. 5G and 51 are flow diagrams illustrating the creation of companies and networks of service providers for performing jobs consistent with embodiments of the invention.

FIG. 5H is a flow diagram illustrating a sequence of operations for creating properties for management of job requests and service providers and residents consistent with embodiments of the invention.

FIGS. 5J-5M are flow diagrams illustrating a sequence of operations for a job request and finding a provider for the job consistent with embodiments of the invention.

FIGS. 6A-6J and FIGS. 7A-7N and 8A-8B are diagrammatic views of example graphical user interfaces that may be output on a display of a device of FIG. 1 for controlling the flow of the invention with the engagement of a consumer and provider, respectively, in accordance with the invention.

FIGS. 9A-9Q are diagrammatic views of exemplary graphical user interfaces on a Consumer device for selecting service, consistent with embodiments of the invention.

FIG. 10A-10DD are a diagrammatic view of an exemplary graphical user interfaces on a Provider device for a job request, consistent with embodiments of the invention.

FIGS. 11A-11F are diagrammatic views of exemplary graphical user interfaces on a device for cancellation of a job, consistent with embodiments of the invention.

FIGS. 12A-12Y are diagrammatic views of exemplary graphical user interfaces on a Provider device for providing service in a job request, consistent with embodiments of the invention.

FIG. 13A-13C are graphs and tables regarding wage rates for use consistent with embodiments of the invention.

FIG. 14A-14I are additional diagrammatic views of example graphical user interfaces for queued jobs, consistent with embodiments of the invention.

FIGS. 15A-15XX and 16A-16P are diagrammatic views of exemplary graphical user interfaces on a Consumer device for active work flow and completion of a job, consistent with the embodiments of the invention.

FIGS. 17A-17NN and 18A-18T are diagrammatic views of exemplary graphical user interfaces on Provider device for active workflow and completion of a job, consistent with embodiments of the invention.

FIGS. 18A-18T are diagrammatic views of exemplary graphical user interfaces for both consumer and provider devices illustrating time or information associated with a job, that are consistent with embodiments of the invention.

FIGS. 19A-19V are diagrammatic views of exemplary graphical user interfaces for Provider and Consumer devices illustrating limits reached in a job workflow, consistent with embodiments of the invention.

FIGS. 20A-20FF and 21A-21I are diagrammatic views of exemplary graphical user interfaces on a Consumer and Provider devices for a provider to become part of a Network of providers, consistent with embodiments of the invention.

FIGS. 22A-22LL are diagrammatic views of exemplary graphical user interface on a Provider device for providers to become part of a company, consistent with embodiments of the invention.

FIGS. 23A-23LL and 24A-24F and 25 and are diagrammatic views of exemplary graphical user interface on a Provider device for a provider to define properties with residents for job requests, consistent with embodiments of the invention.

FIGS. 26A-26P and 27A-27F are diagrammatic views of exemplary graphical user interface on Consumer and Provider devices respectively for Product installation job service and flow, consistent with embodiments of the invention.

FIGS. 28A-28Q and 29A-29H are diagrammatic views of exemplary graphical user interfaces on a provider device for Smart Home installation job service and flow, consistent with embodiments of the invention.

FIGS. 30A-30L are diagrammatic views of exemplary graphical user interfaces on a Provider device for a provider to be certified and badged for certain job requests and product installations, consistent with embodiments of the invention.

FIGS. 31A-31S and 32A-32T are diagrammatic views of exemplary graphical user interfaces on Consumer and Provider devices respectively for providing an Inspection job workflow, consistent with embodiments of the invention.

FIGS. 33A-33C and 34A-34J are diagrammatic views of exemplary graphical user interfaces on Consumer and Provider devices for Queueing a job workflow consistent with embodiments of the invention.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF EMBODIMENTS OF THE INVENTION

The present invention is implemented in a hardware and software platform that incorporates a plurality of computing devices, such as mobile computing devices, used by both consumers and service providers and running individual applications or “Apps”. The mobile devices and Apps interface with one or more backend computing devices, such as server devices/servers running one or more service programs for the processing and exchange of data and information between the customers and service providers in the provision of on-demand services and job workflow, such as mechanical and handyman services and other services at a home, commercial building, vacation property or some other building or property. The invention provides an interactive environment that allows a customer (consumer) to obtain services from various contractors or service providers (providers) in an on-demand environment and to control the workflow through interaction in accordance with the invention. Through separate mobile device interfaces and the backend system, information and communication is provided back and forth between the customer and service provider for interaction management of a particular ordered job. The provider, who might be a plumber, electrician, HVAC technician, handyman or other skilled worker that can provide the desired service, interfaces during the job in various ways and at various junctures according to timed workflow to ensure proper completion of the job and control of the workflow at the convenience of both consumer and provider. The job completes with financial transactions between the consumer and provider.

For the purposes of illustrating the invention, the user or customer of the service and the user of the consumer App, such as a homeowner, for example, is referred to as a “consumer”. The service provider, on the other hand, who interfaces with the provider App, is referred to as a “provider”. However, the terminology is illustrative and not limiting with respect to the invention. For example, a property manager may be a consumer, even though work is done on another resident's property. Similarly, the various computing devices used to implement the invention are referred to as “consumer device” and “provider device” without being limiting. The various devices can be any suitable computing devices for providing network connectivity, processing resources and functions, and data input/output interfaces for enabling a particular user to communicate with the backend system over a network to provide the job-related interaction between consumer and provider.

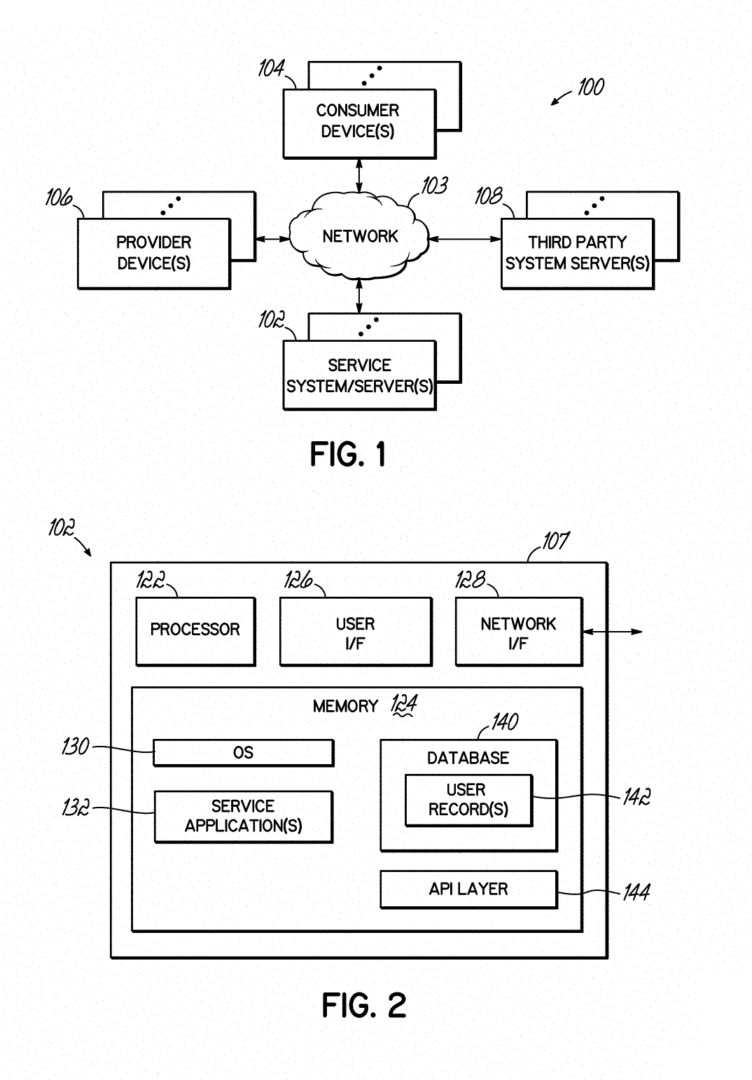

Turning now to the Figures, and particularly to FIG. 1, this figure provides a general block diagram illustrating an overall system 100 for implementing the invention consistent with embodiments of the invention. As shown in FIG. 1, system 100 includes a service system/servers 102, in accordance with aspects of the invention, wherein one or more service programs are implemented on computing devices, such as one or more server devices or servers. The system 102 including hardware and software is referred to as the backend system or backend servers, as appropriate. The distribution and arrangement of the servers or other devices implementing the service system 102 is not limiting to the invention.

The service system 102 may be connected with consumer and provider devices 104, 106 and appropriate Apps through a suitable communication network 103, where the communication network 103 may comprise one or more cellular voice/data networks, various wireless networks (e.g. the Internet), local area networks (LAN), wide area networks (WAN), one or more high speed bus connections, and/or other such types of communication networks, or combinations of networks for providing the functional communications between service system 102 and various devices 104, 106. To that end, the system 100 will include one or more user computing devices 104, 106, such as mobile devices for communication with each other and the service system 102 through an appropriate network link 103. In one typical use of the invention, the consumer and provider devices 104, 106 may typically be a cellular phone or smart phone, tablet computer, laptop computer, thin client terminal and/or other such computing device, that a mobile consumer and provider can use, but the invention is not limited to such devices.

As will be described in detail below, consistent with embodiments of the invention, the devices 104, 106 provide suitable user interfaces for use by respective consumers and providers to provide inputs, receive/send information, receive/send notifications, and otherwise engage with the service system 102 for the requesting, scheduling and provision of on-demand services in accordance with the invention. System 102 may provide additional information to one or both of the consumer or provider devices as necessary to implement the functionality as described herein. The input data and information from a consumer or provider, provided through their devices, may be utilized to set up various user records associated with requested and scheduled service jobs. Such records may be maintained on the service system and provided to the mobile devices as needed. The user records may include a variety of different information about a consumer, about a provider, about the job location, about a property where a job is performed, about a network of providers associated with the property, about a company associated with one or more providers, about whether the property is a stand-alone property (for example an owner occupied property) or one that is managed, about the job type, as well as information about the location of the consumer and job, location of the provider, distances between the provider and a job site, about the duration of a job, billing information, cost information, etc, for the completion of a job in an on-demand environment. The user records created may be constantly edited depending on inputs from one or both of the consumer and provider as discussed herein. The service system 102 provides a platform for the invention implementation of the beginning, ongoing progress, and completion of one or more jobs between system users in addition to providing access to other systems for obtaining information needed by the overall service system, the consumer(s) or provider(s).

Consistent with embodiments of the invention, an interface, such as a web-based user interface, may provide user access to information on the service system 102 regarding jobs. A user such as the consumer or provider may access the web-based user interface with an Internet web browser. In some embodiments, the interface generated by the service system 102 may be a dedicated interface, such as an interface that may be provided by a special purpose application. In one embodiment, as discussed herein, the service system 102 maintains the various consumer and provider records/profiles and job histories. Through an appropriate web interface, as known to a person of ordinary skill in the art, a user (whether a consumer or provider or other user) is provided a portal where they might access and edit their records or profiles, might review job histories and information and may edit any passwords used in the invention.

Moreover, consistent with embodiments of the invention, a mobile device 104, 106 may be registered with the service system 102 such that the mobile device 104, 106 is linked with one or more user records for a registered user of the system, such as a consumer or provider. The user's interface with the user records using the mobile devices. After registration with the service system, the mobile devices may be configured to execute their respective Apps to cause the mobile device to monitor the progress of the job and interaction by the consumer and provider and provide and capture various job states. The various job states that are set by the mobile devices are then stored by the backend service system.

FIG. 2 provides an exemplary block diagram that illustrates components/elements of the one or more servers 107 that may be part of the backbone providing of the service system 102 consistent with embodiments of the invention. Such servers for implementing system 102 may include one or more application servers, database servers, or other suitable servers as needed for processing and storing the data needed for the invention and interfacing with the various client mobile devices. The service system server 107 includes at least one processor/processing element or CPU 122, such as a hardware-based microprocessor, and a computer readable medium or memory 124 that is coupled to at least one processor 122, such as for storing or carrying the software that includes the executable instructions that are executed by the processor 122 or other processing element. The memory 124 may represent the random-access memory (RAM) devices comprising the main storage of the service system 102, as well as any supplemental levels of memory, e.g., cache memories, non-volatile or backup memories (e.g., programmable or flash memories), read-only memories, etc. In addition, memory 124 may be considered to include memory storage physically located elsewhere in the service system 102, e.g., any cache memory in a microprocessor, as well as any storage capacity used as a virtual memory, e.g., as stored on a mass storage device or on another computer coupled to the service system 102. Examples of memory elements may also include hard drives, CD or DVD units, magnetic memory etc as noted further herein.

For the interface with a user or operator, the service system 102 may include a user interface 126 incorporating one or more user input/output devices, e.g., a keyboard, a mouse or other pointing device, a display, a printer, etc. Data may be communicated by the system 102 to and from another device, computer or terminal (e.g., the consumer device 104, the provider device 106, etc.) over a suitable network interface 128 that is coupled to the appropriate communication network 103. The network interface 128 may include multiple interfaces, such as with various servers, and other suitable interfaces for connecting the elements that form the backbone for implementing the system 100 of the invention. Also, the server may include one or more API (application program interface) layers 144 for interfacing with the devices 104, 106 as well as one or more third party systems/servers as discussed herein. The service system 102 also may be in communication with one or more mass storage devices, which may be, for example, internal hard disk storage devices, external hard disk storage devices, external databases, storage area network devices, etc, through suitable networking interfaces as indicated at 128. As such, system 102 may be implemented through one or more servers 107 and the software and hardware components will be referred to generally herein as the “service system”. The various interfaces, 126 and 128 are implemented through appropriate hardware and software components as is known to a person of skill in the art.

The service system 102 servers may typically operate under the control of an operating system 130 and execute or otherwise rely upon various computer software applications, components, programs, objects, modules, engines, data structures, etc., including for example, a service application 132. In one embodiment, the service application 132 is configured to work with each of the various devices 104, 106 for exchanging information, interfacing with other services, managing data and providing the data used in executing both the provider application and consumer applications operating on the devices 104, 106 in implementing the features of the invention. The memory 124 of the service system 102 may generally include or provide one or more databases 140 that may store one or more user records 142. A database in system 102 might also involve a separate database server that interfaces with server 107 as appropriate. In general, each user record 142 of the status database may be associated with a registered user that had registered with the service system 102, and the user record may store job information, user profile information, job status or state information and other information for one or more mobile devices that are linked to the registered user and/or were registered by the particular registered system user.

The database(s) 140 may comprise data and supporting data structures that store and organize the data used by the invention, including data from the mobile devices, data input from the users, user records associated with consumers, providers and the on-demand jobs schedule and/or in progress along with other data and information. In particular, the databases 140 may be arranged with any database organization and/or structure including, but not limited to, a relational database, a hierarchical database, a network database, and/or combinations thereof. A suitable database management system in the form of a computer software application executing as instructions on a processor 122 of the service system 102 may be used to access the information or data stored in records of the databases 140 in response to one or more queries, where a query may be dynamically determined and executed by the operating system 130 and/or other applications 132, as is known in the art.

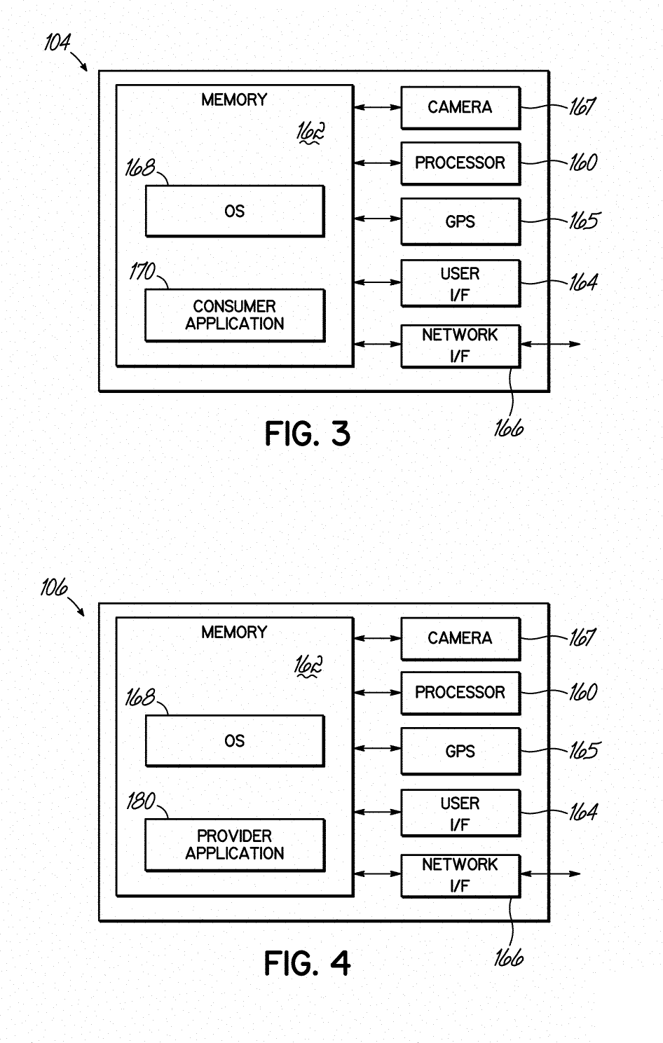

FIGS. 3 and 4 provide exemplary block diagrams that illustrate the components of the mobile devices 104, 106 consistent with embodiments of the invention. Generally multiple mobile devices 104, 106 are part of the system 100 of the invention for use by both consumers and providers. The mobile devices 104, 106 include at least one processor element or processor 160 including at least one hardware-based microprocessor and a memory 162 coupled to the at least one processor 160. The memory 162 may represent the random-access memory (RAM) devices comprising the main storage of the mobile devices 104, 106 as well as any supplemental levels of memory, e.g., cache memories, non-volatile or backup memories (e.g., programmable or flash memories), read-only memories, etc. In addition, memory 162 may be considered to include memory storage physically located elsewhere in the mobile devices 104, 106 e.g., any cache memory in a microprocessor, as well as any storage capacity used as a virtual memory, e.g., as stored on a mass storage device or on another computing device coupled to the mobile devices 104, 106. As described above with respect to the service system 102 of FIG. 2, the mobile devices 104, 106 may include one or more appropriate user interface(s) 164 for interfacing with a user and one or more appropriate network interface(s) 166 for communication over the one communication network 103. The user interface 164 refers broadly and generally to any suitable input and output elements and related hardware/software for receiving data/information from a user and displaying data/information to the user. For example, with a computing device 104, 106, the user interface might include hardware components such as a keyboard, microphone, speaker, touch screen, display screen etc. and appropriate interface software for communicating or interfacing with a user. Generally, most mobile devices, such as phone or tablet devices, rely upon their touch screens to provide a suitable user interface for engaging the devices and the applications they run and for inputting data/information and displaying various communicative outputs and data/information associated with the invention. The same screen is both the input interface and output interface as described in the embodiment illustrated herein. The network interface provides the hardware/software interface suitable for communication with other computing devices, such as service system 102. For example, such a network interface may include a cellular network interface, as well as a wireless or Wi-Fi interface or other suitable network interfaces for communication over one or more network(s) 103.

The mobile device 104 typically operates under the control of an operating system 168 and/or application and executes or otherwise relies upon various computer software applications, components, programs, objects, modules, data structures, etc., including for example, a consumer application or consumer App 170 in accordance with the invention. The consumer App 170 may be executed by the processor 160 of the mobile device 104 so that a consumer, for example, can order an on-demand service, can monitor the provision of that service and various conditions related to the service job, and pay for the job, as discussed further herein. The consumer application also is used to interface with the service system 102 and provider and provider device 106 in accordance with the invention. Data and inputs are entered by the consumer through the user interface 164 and information is displayed also through the user interface.

In one embodiment, the consumer application 170 may be implemented as a downloadable application or app, such as an application supported by Android and iOS operating systems available from Open Handset Alliance and Apple Computer, respectively, or in other forms of program code as appropriate for a particular mobile device, such as a mobile phone or tablet device, for example. In some embodiments, the consumer application 170 may be downloaded to a device 104 from an external source including for example, a network accessible location (e.g., a mobile application store, an accessible database), a computer readable storage media, and/or other such external sources.

Device 104 may also implement a GPS functionality for providing location information associated with the user as described herein. In the current invention, the location of the user and provider are used to determine arrival times and job start times and other information that allows the consumer and provider to make decision on the job execution. As such, the device 104 will generally include GPS functionality 165 as implemented with known hardware/software elements to provide the device and ultimately the service system 102 the necessary information regarding the location of the device and thus the location of the user. As discussed herein, the invention will use the location information as provided by the devices 104, 106 and GPS functionality 165 and combine that information and data with other sources or databases, such as from third party systems 108. The third party systems, often interfaced through the API layer 144 of the service system 102, provide map information and other granular location data associated with a user. In that way, maps can be displayed, distances of separation between the user and provider calculated, travel times determined, charge rates calculated, points of interest displayed etc, as is known in the art.

The devices 104, 106, as with typical mobile devices, will also usually have some kind of camera functionality 167 for capturing still images or videos as is known in the art. The present invention uses the camera functionality as in input interface as discussed herein.

FIG. 4 provides a block diagram, similar to that of FIG. 3, that illustrates the components of the client device 106 consistent with embodiments of the invention. The provider device 106 may be similar to the consumer device 104 (for example, two mobile phone devices) and thus the various elements are illustrated with similar reference numerals and operate as noted with respect to FIG. 3. However, since the provider device is used by a service provider and thus creates that side of the invention as described herein, the device 106 will generally be running a different provider application 180. Of course, a provider of one service might also act as a consumer of another service and so both Apps 170, 180 may be resident on the same device. Using a provider application, a service provider can, for example, respond to and provide on-demand service, interface with the consumer in the provision of that service, track the time of the service and costs, and be paid for the completed job as discussed further herein.

In general, the various executable software routines that are executed to implement the embodiments disclosed herein, whether implemented as part of an operating system or a specific application, component, program, object, module or sequence of instructions, or even a subset thereof, may be referred to herein as “computer program code,” or simply “program code.” For the particular invention, the client parts of the code are referred to as the “App” associated with each client. The program code/App generally creates a workflow in the invention for the parties and comprises one or more instructions that are resident at various times in various memory and storage devices in a computer, and that, when read and executed by one or more hardware-based processing units in a computer (e.g., processors, microprocessors, processing cores, or other hardware-based circuit logic), cause that computer to perform the steps embodying desired functionality. Moreover, while embodiments have and hereinafter will be described in the context of fully functioning computers/devices and computer systems, those skilled in the art will appreciate that the various embodiments are capable of being distributed as a program product in a variety of forms, and that the invention applies equally regardless of the particular type of computer readable media used to actually carry out the distribution. Furthermore, as functionality of the system might be distributed between the various components, such as system servers, mobile devices, and other components, the invention is not limited to specific components handling specific functions. As discussed herein, software program code as a module or component may exist on a hardware component independently of other program code or it can be a shared element of other code.

Such computer readable media may include computer readable storage media and communication media. Computer readable storage media is non-transitory in nature, and may include volatile and non-volatile, and removable and non-removable media implemented in any method or technology for storage of information, such as computer-readable instructions, data structures, program modules or other data. Computer readable storage media may further include RAM, ROM, erasable programmable read-only memory (EPROM), electrically erasable programmable read-only memory (EEPROM), flash memory or other solid state memory technology, CD-ROM, DVD, or other optical storage, magnetic cassettes, magnetic tape, magnetic disk storage or other magnetic storage devices, or any other medium that can be used to store the desired information and which can be accessed by a computer or other device. Communication media may embody computer readable instructions, data structures or other program modules. By way of example, and not limitation, communication media may include wired media such as a wired network or direct-wired connection, and wireless media such as acoustic, RF, infrared and other wireless media. Combinations of any of the above may also be included within the scope of computer readable media.

Various program code/Apps described hereinafter may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization and allocation of program functionality described herein.

Furthermore, the implementation of the invention is done through a number of devices and preferably devices that include a number of different user interfaces for engagement and process flow through the invention, as well as data entry. In one embodiment, input interfaces may include touch screen capability and/or voice technology to be used as engagement and input modalities. Accordingly, through user interfaces and screens presented through a consumer application 170 or a provider application 180, various different fields in the screens are presented for the workflow. Some fields are informational fields, some fields are engageable fields which create an action in the workflow or present a different screen interface, and some fields are combinations wherein information is provided directing a user how to engage the fields. As will be appreciated by a person of ordinary skill in the art, the interface screens may be laid out in any number of different ways for a user or users' convenience. That may include a single screen interface or a scrollable or swipable screen interface wherein certain touch modes may present continuations of the screen or related screens. Accordingly, the present invention is not limited to a particular screen interface or field layout. Rather, the present invention provides a functionality as described and disclosed herein which is implemented through the noted screen interfaces to provide the program process flow of the invention and the control of job requests and job workflow.

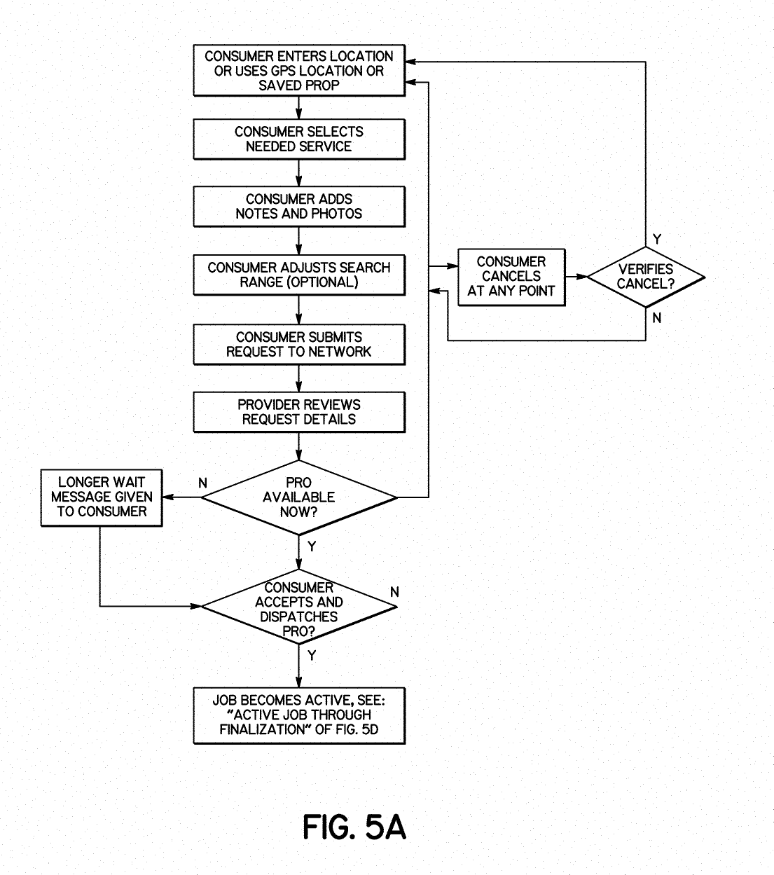

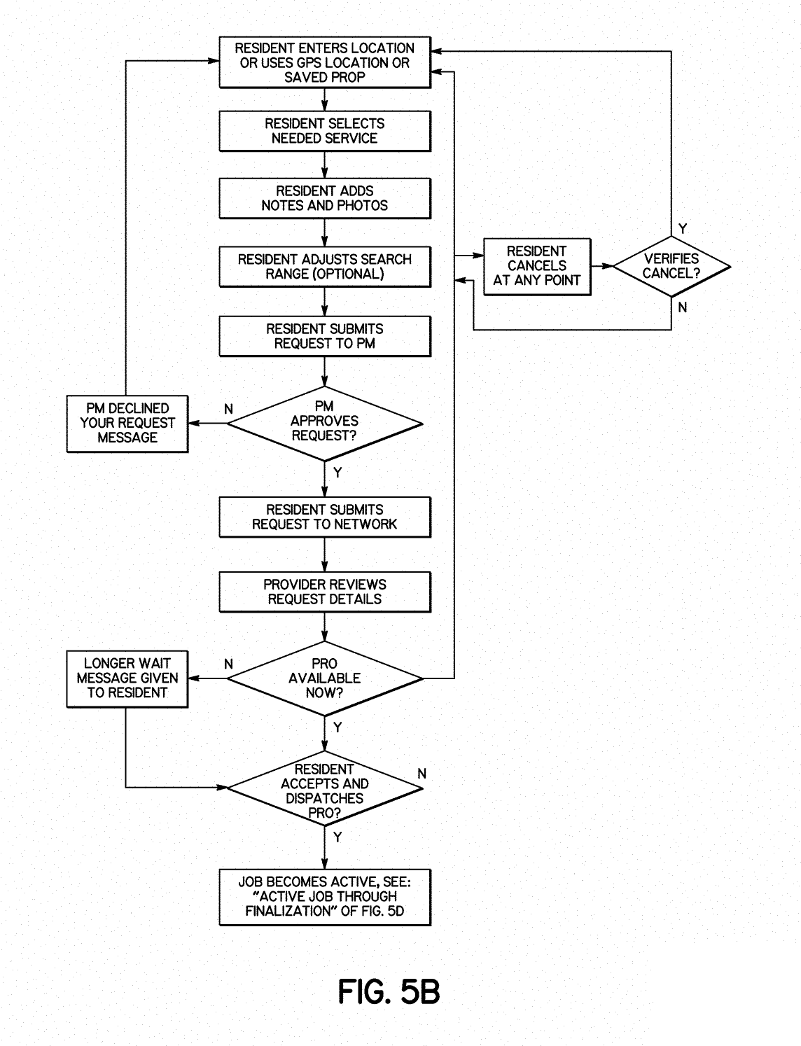

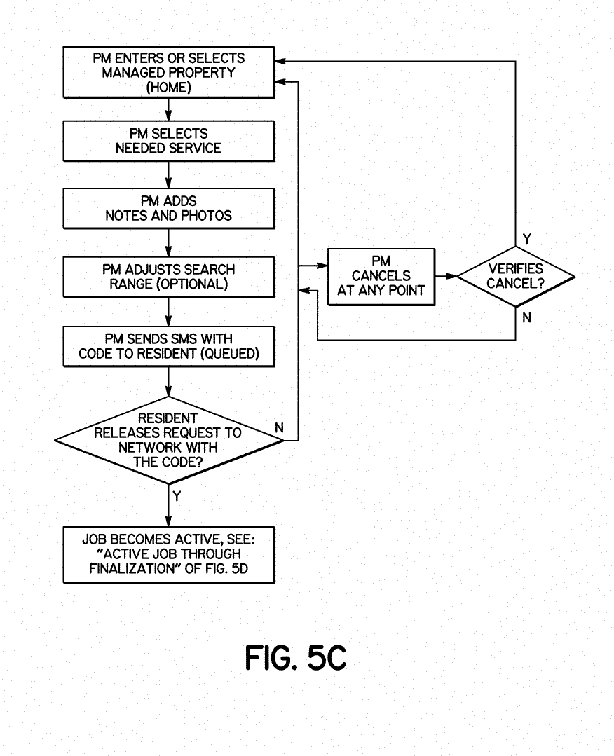

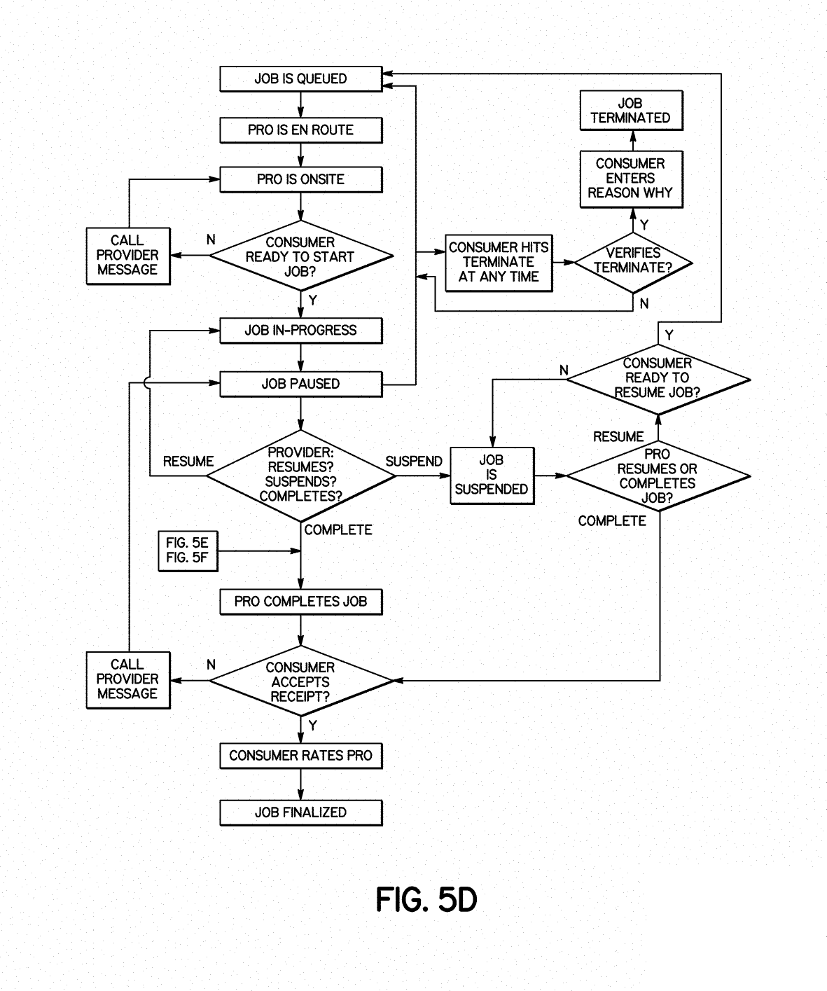

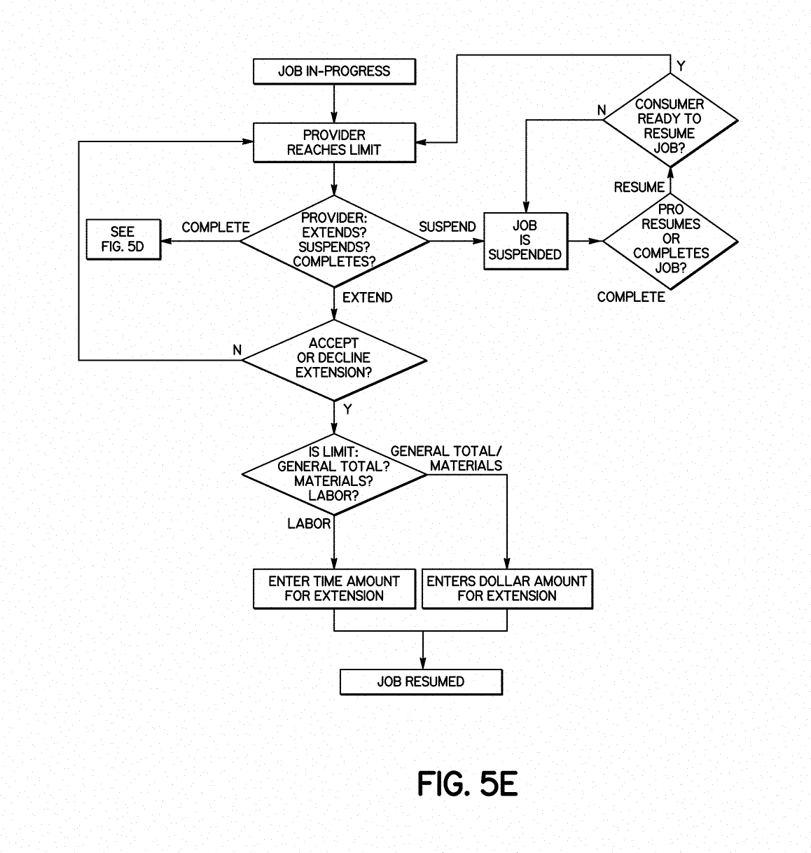

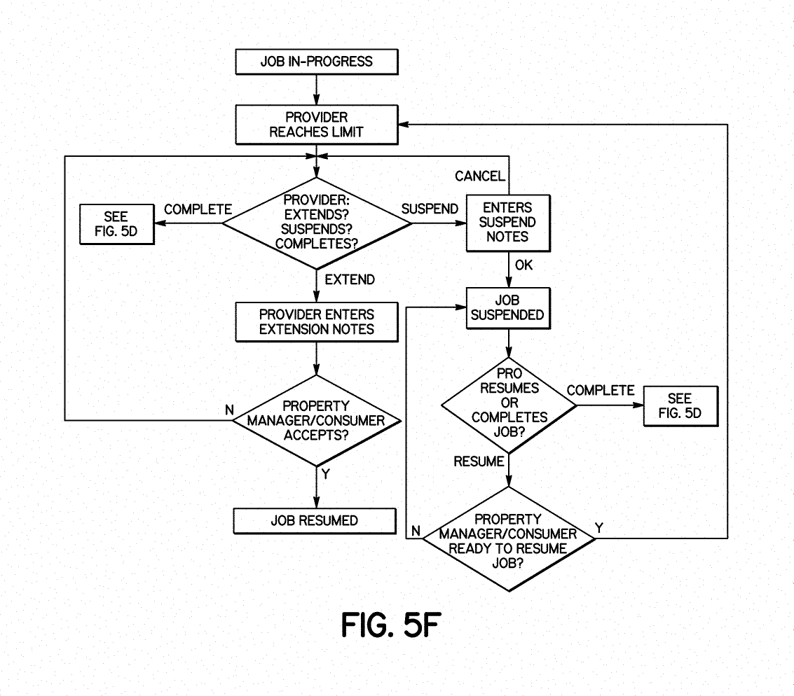

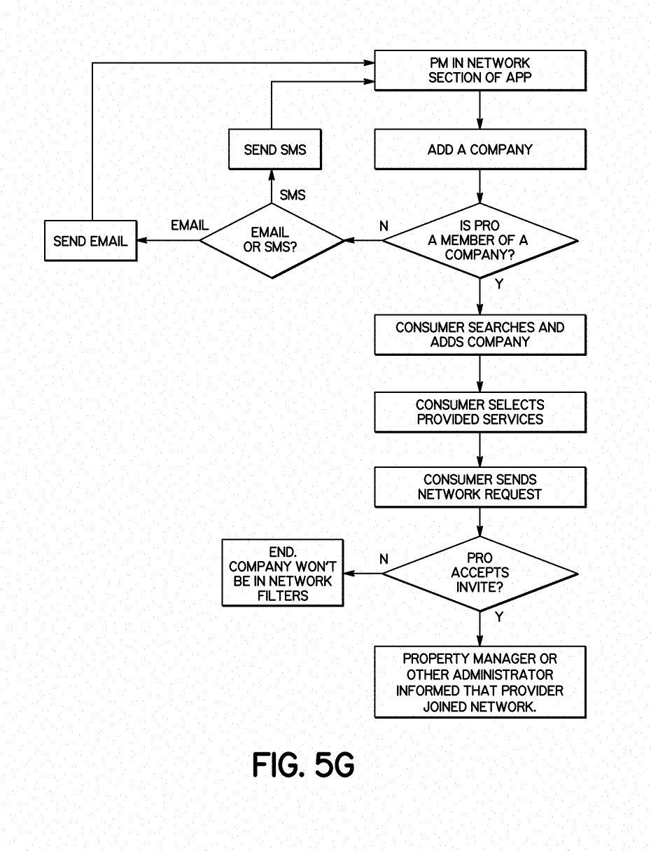

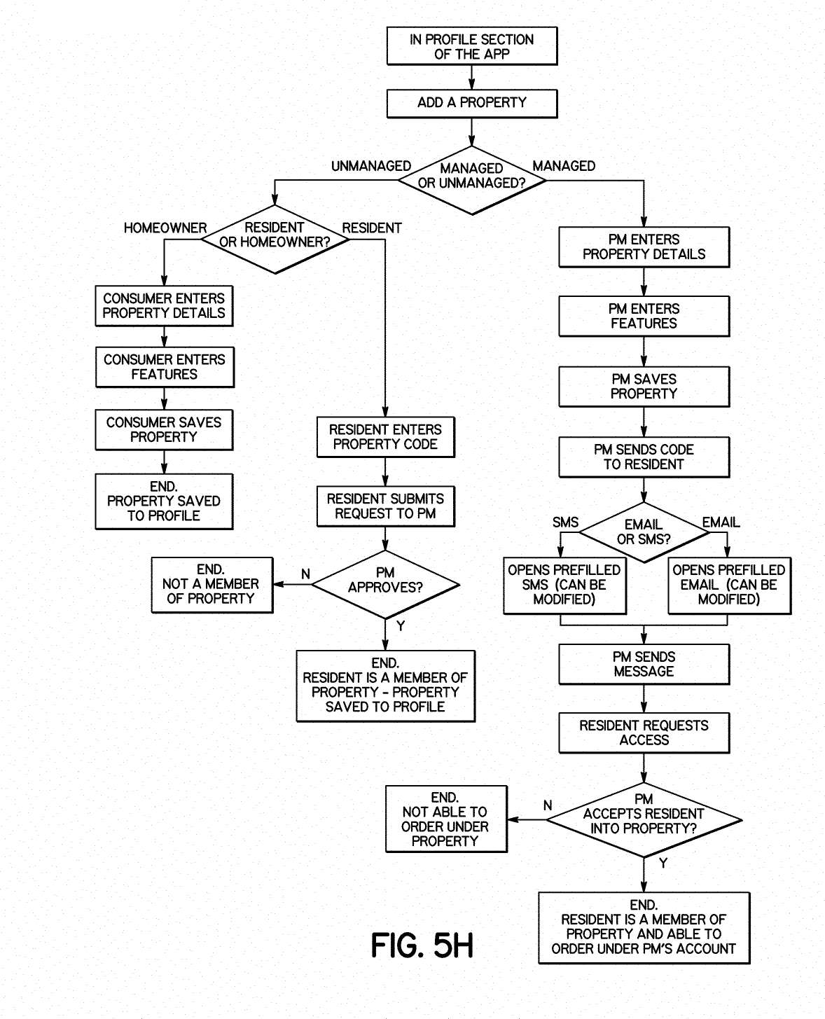

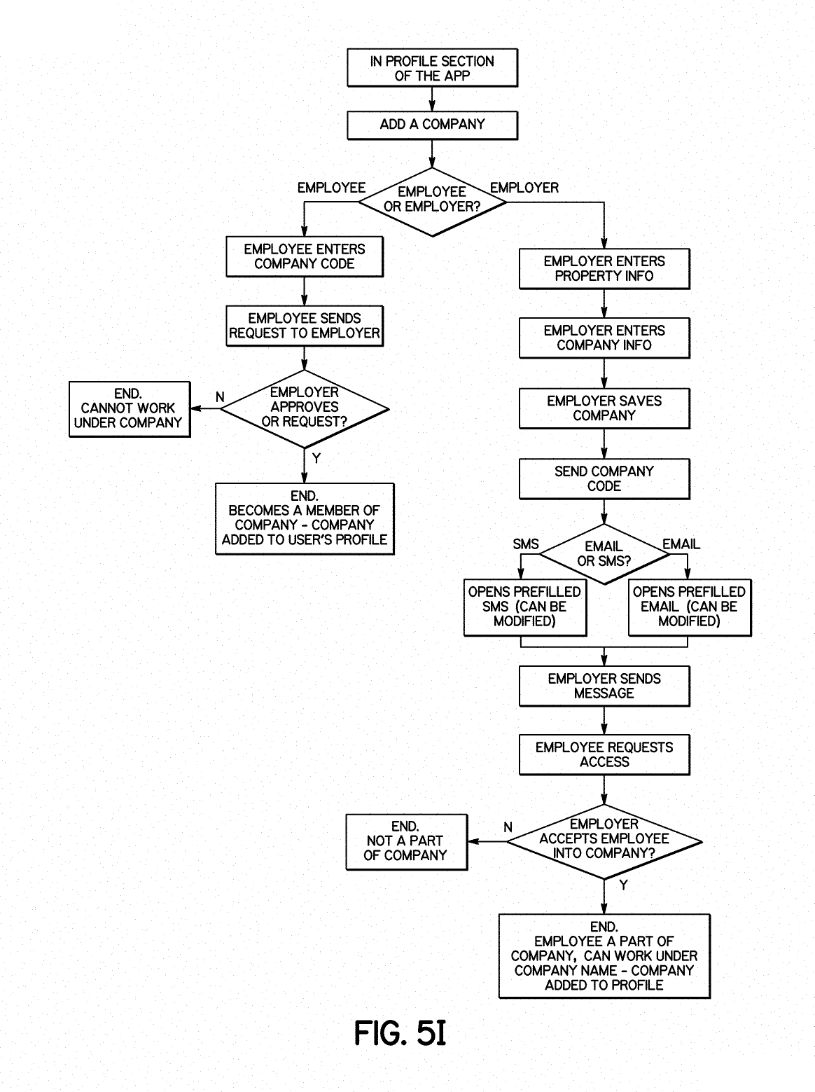

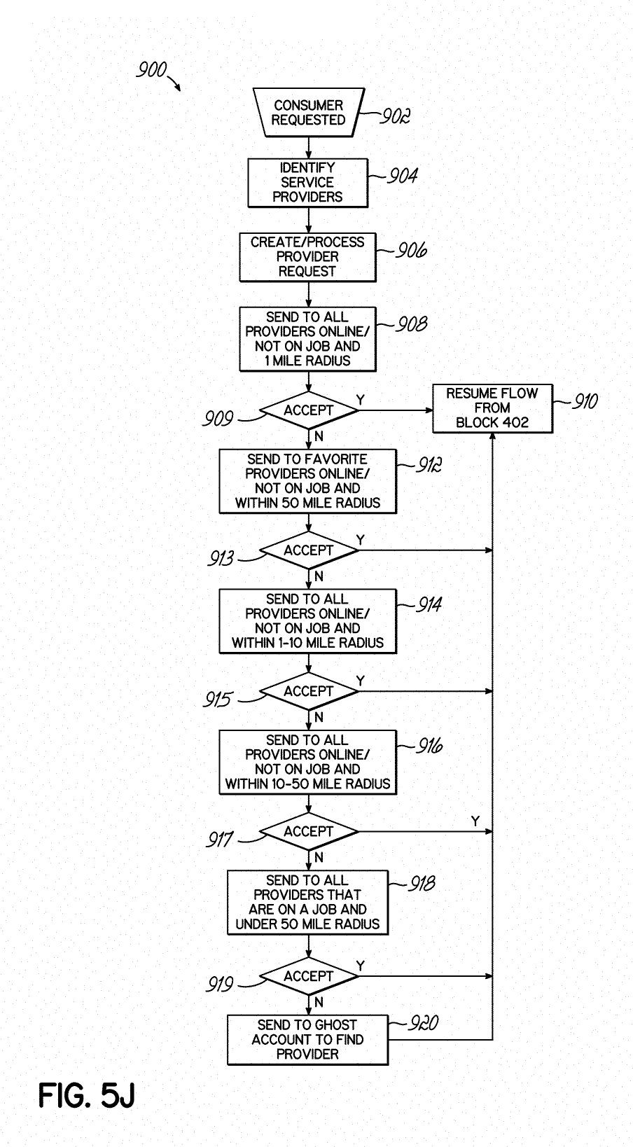

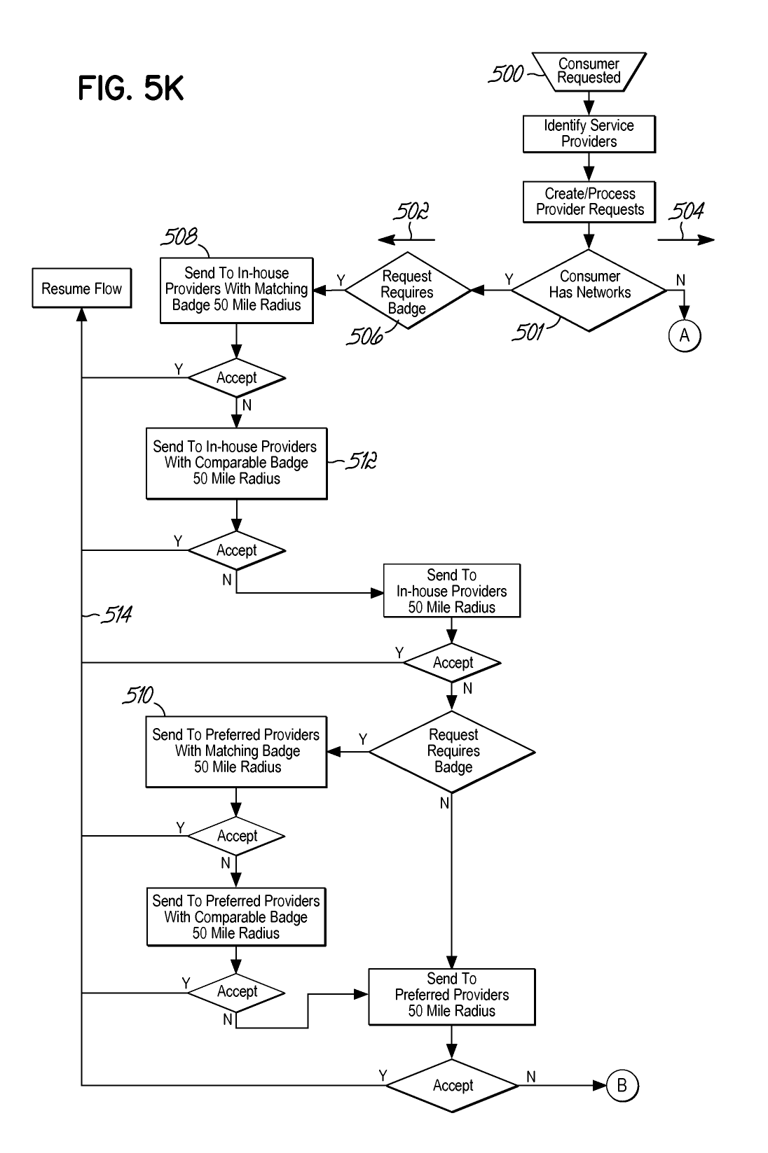

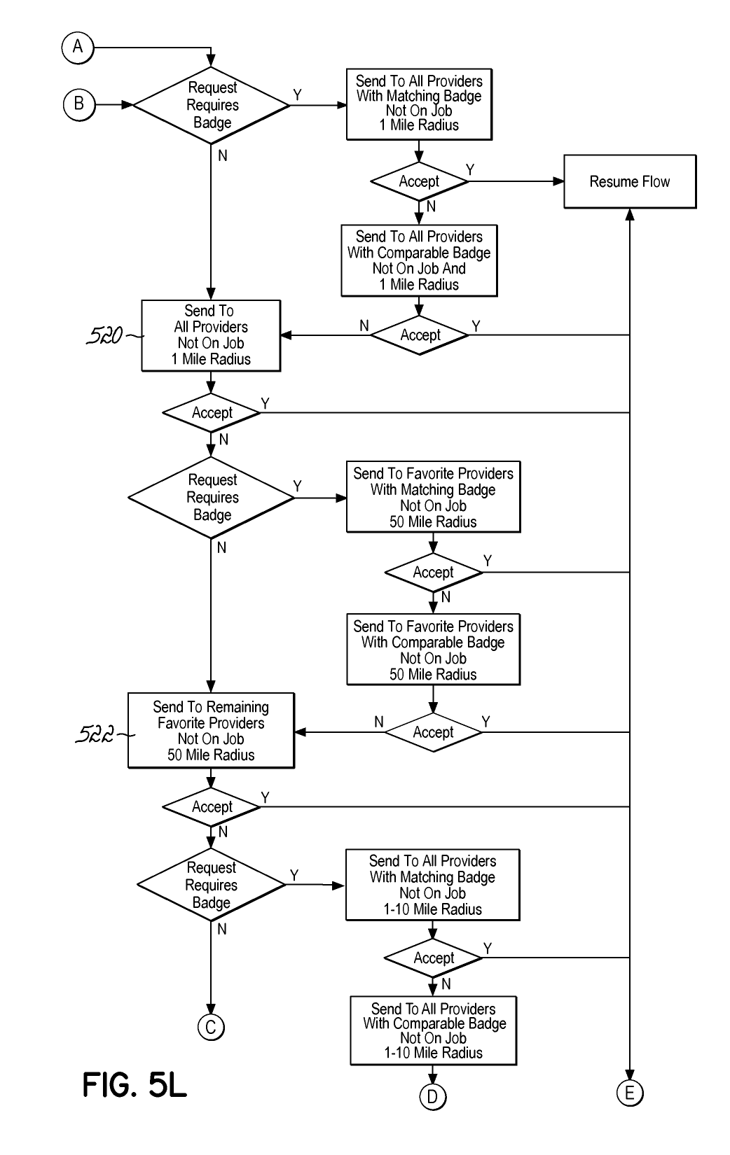

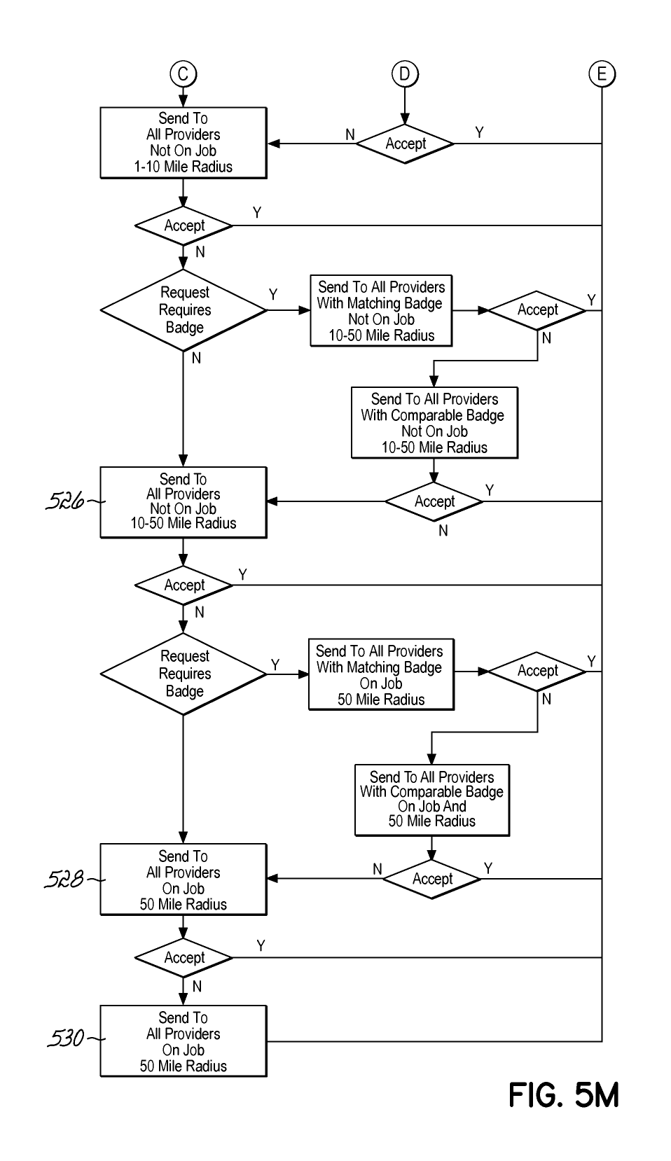

Turning now to various additional figures as illustrated herein, the operation of the invention is described. The invention incorporates unique interactions between both a consumer and a service provider, which each have their own devices, and the interaction of each of the devices with service system 102 as described herein for performing jobs in accordance with the invention. The consumers may take various roles, such as in individual home owner, a property manager, or a resident of a property manager. Similarly, a provider may have various roles, such as an independent provider, an employee of a company, or an employer of a company. An employer may oversee other employee providers and may actually act as a provider themselves. FIG. 5A-5M illustrate embodiments of workflows or flowcharts of functions in accordance with the invention and will be described in combination with various figures of user interfaces of the mobile devices (screens/screen shots). The screens facilitate program flow and party interaction and illustrate the communicative interfaces and interaction platforms for each of the devices 104, 106 as provided through user interfaces 164 associated with the devices. The various flows of the flow diagrams and flowcharts illustrate the various actions and decision points and branches provided by the invention and the interaction of the consumer and provider. The different users of the system will take different actions and provide inputs to control the flow of the applications. The various inputs will then result in various flows and timed jobs and job states that change and are set by the devices 104, 106 acting with system 102 and then stored appropriately on the service system/server 102.

With mobile devices having touch screen user interfaces that provide both a display and also various input fields that are activated by touching the field or screen, the input and output flow of the invention is illustrated through the various screens. Accordingly, the various screen shots of the figures illustrate the program flow of the invention, and when the application notes a consumer screen or provider screen is presented or provided to the user, this refers to the operation and running of a respective consumer or provider App that then generates the user interface that is reflected in the screen for both providing output information and then capturing user inputs in accordance with the invention system. The input fields may be in various forms, such as a portion of the screen, button fields, icons, sliders, thumbnails, bars, drop down menus, etc, and so herein such input fields will often be referred to as just “fields” to indicate the input user interface. Such fields are touched or engaged by the user. The invention is not limited to the way in which the portions of the screen are arranged to capture the desired touch inputs or touch engagement. Similarly, the screen is a display and thus the output user interface will display various text and other information through the progress of the invention and the ordering of on-demand service. As such, various notifications, messages, informational displays, menus, alerts, dialog boxes, modal dialog boxes, windows, etc displayed on the screen will also be generally referred to as “notifications” or message fields to indicate the output user interface and the invention is not limited by the output screen display nomenclature.

Each of the Apps, including the consumer application 170 and provider application 180 are separately addressed initially to show the engagement by a consumer or service provider. As noted, consumers may have various roles or identities as will providers. Herein, the terms “application” and “app” or “App” are used interchangeably when referring to the consumer application/App 170 and provider application/App 180. The Apps are executed by the respective devices where they reside and request inputs. As will be appreciated, the processing provided by the various applications will provide an interaction between one or more consumers and one or more providers in the requesting and fulfilling of service job.

The process flow provided by the applications will be represented in the functioning of the devices and the various screens interfaces that are presented in the consumer and provider devices. As such, reference is made to screens and their functionality to reflect the functioning of the applications and process flow. While some informational fields in the screens are for displaying information, other fields are engageable by the users for providing the necessary functions of the applications and to trigger actions to be taken in the applications for practicing the invention. Accordingly, the reference to the “screens” if for evidencing the functions that are provided by the processing of the various applications and are not just for display purposes.

FIGS. 5A-5M illustrate various flows associated with features of an embodiment of the invention.

For example, the process flow illustrated in FIG. 5A illustrates the feature of the invention associated with generally a typical job request, such as a job request that includes one consumer and one provider. The consumer makes a request which is then submitted to the network for a search of providers as disclosed herein. Once a provider is found and then accepted by the consumer, the job becomes an active job and continues as disclosed herein. Further discussion of such a job request flow is disclosed herein.

FIG. 5B illustrates a job request, such as through the resident of a managed property. As disclosed herein, for certain embodiments, the property manager must approve the request which will then proceed through the search process until the resident is matched with a provider. Then the job will continue as an active job through finalization. In other embodiments of the invention, if the resident does not need approval from the property manager, then the approval step might be bypassed or skipped, and the job can continue as an active job through finalization. Further discussion of such a job request flow is disclosed herein.

FIG. 5C illustrates the process flow of the invention associated with a property manager ordering a job for a resident of a managed property that may be a non-user of the system. In that way, the property manager selects the needed service and then messages the resident to turn over the job to the resident who can then control the start of the job. After the job has been initiated by the resident through sending a code via a message, and the job is picked up by a provider, the property manager has control of the job and starts the job time which will proceed as an active job through finalization in accordance with an embodiment of the invention. Further discussion of such a job request is disclosed herein.

FIG. 5D illustrates the process flow associated with an active job through finalization of the job. The process flow provides an interaction between the consumer and the provider which gives both the consumer and provider control in the process for starting and stopping and otherwise disposing of an active job until the job is finalized. Further discussion of such a job flow is disclosed herein.

FIG. 5E illustrates a process flow associated with a job that has limits imposed wherein the limits have been reached. The flow is the process associated with the consumer App and the consumer side of the process. Only managed properties have limits and the property manager is the entity that has control of any extensions to those limits. FIG. 5F is the process flow associated with a limit that has been reached from the provider side of the process. Further discussion of a job flow in a limited scenario is disclosed herein.

FIG. 5G discloses the process flow associated with a property manager setting up a network of providers to be associated with the property. It illustrates interaction between a property manager and one or more providers for joining a network for handling job requests. Further discussion of network providers is disclosed herein.

FIG. 5H illustrates a process flow associated with a property that is added to the profile of a consumer, such as a homeowner or resident or to the profile of a process manager that has one or more managed properties. It further illustrates the invitation process of a property manager to their residents to join the property for the purpose of job requests by a resident in a property. Further discussion of resident requests and job flow is disclosed herein.

FIG. 5I illustrates a process flow associated with a provider adding a company to their profile with either the status of an employer or employee of the company. The process flow shows interaction between an employee being added to a company profile through the approval of an employer provider for responding to job requests as a company provider. Further discussion of company providers is disclosed herein.

FIGS. 5J and 5K05M illustrate the process flows of embodiments of a job request and provider search protocol.

### Consumer Application

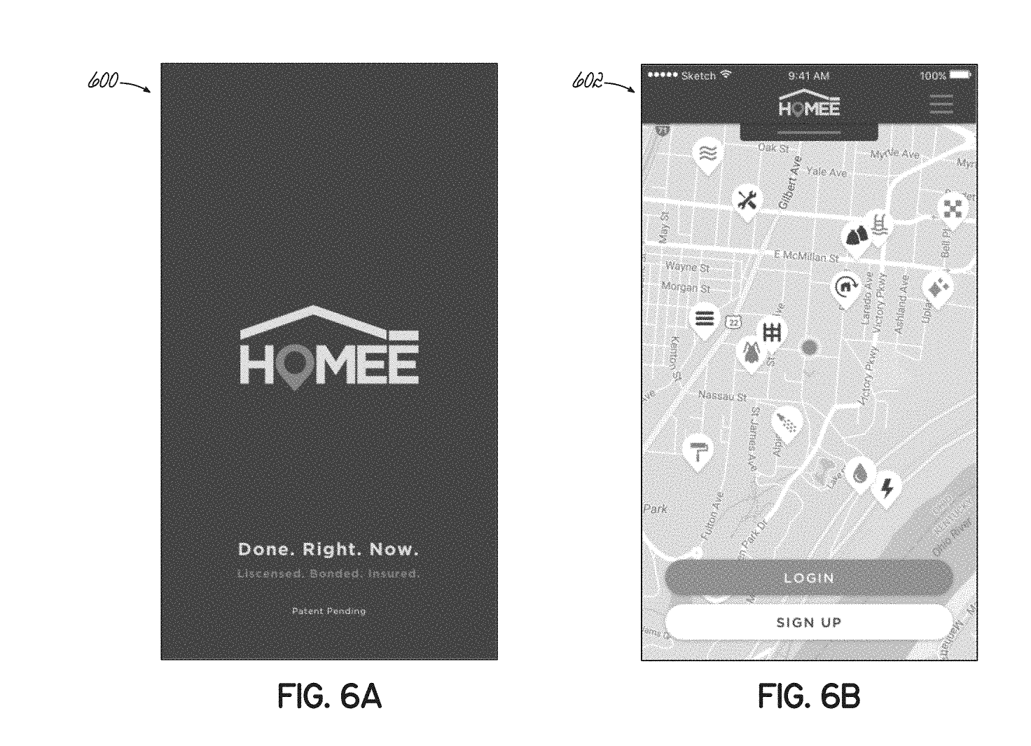

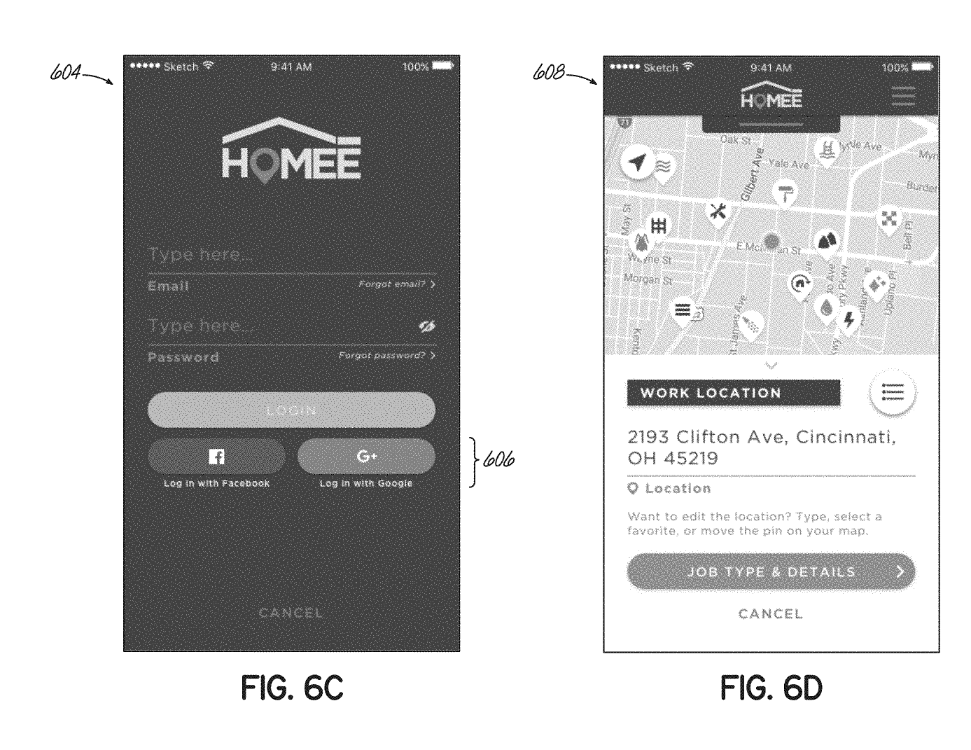

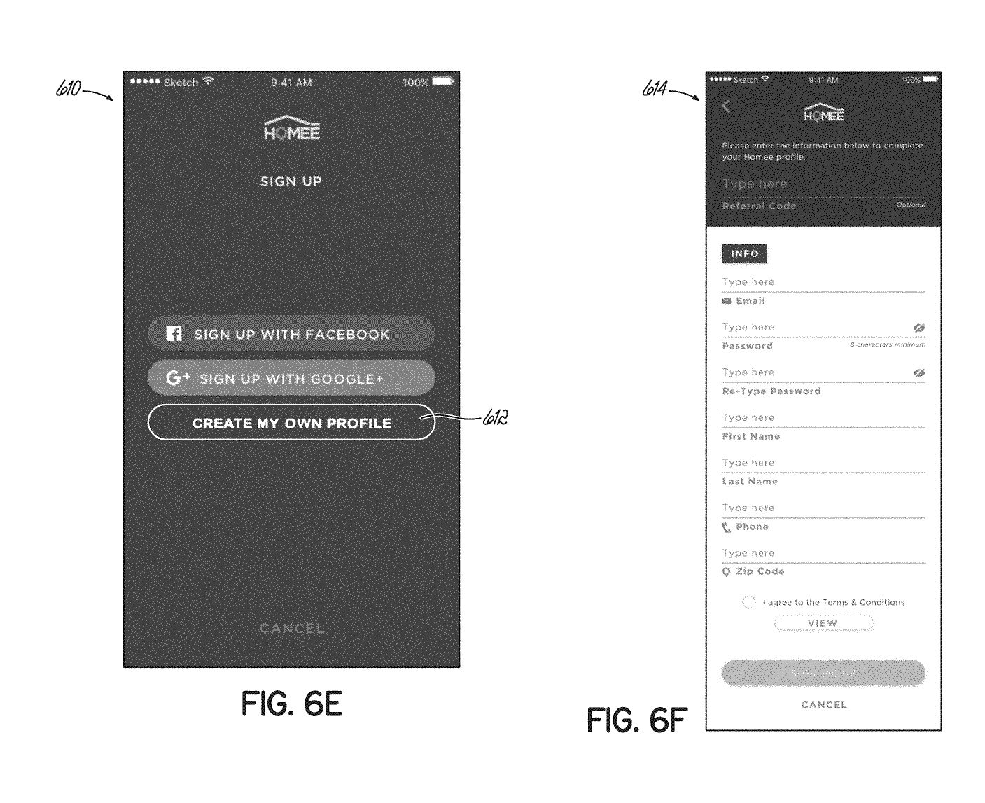

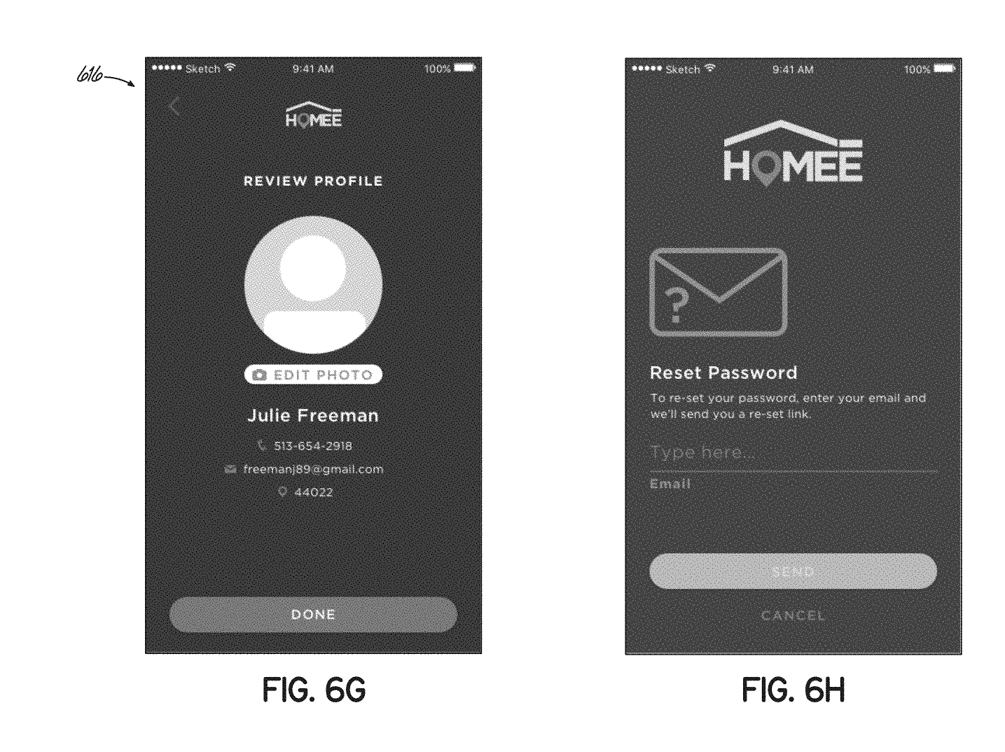

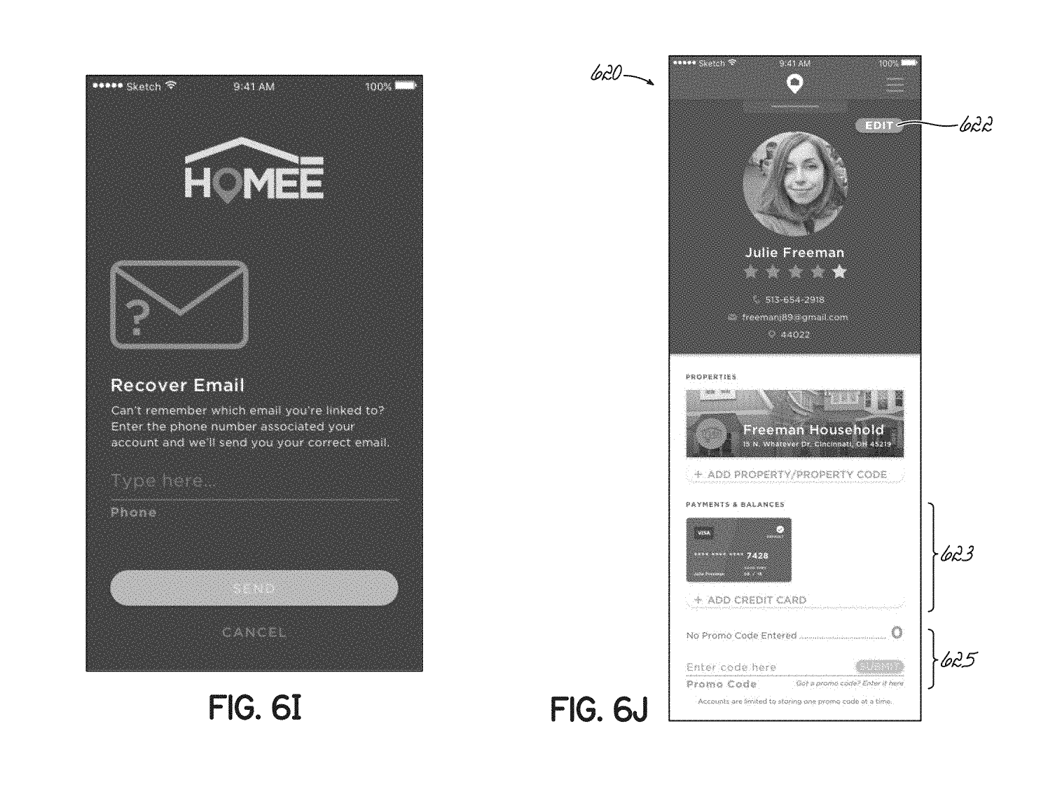

The consumer App is downloaded in a suitable fashion, such as from an App store or other source, onto the consumer device 104. Upon download and installation of the consumer application 170 on a supported device (e.g., phone and/or tablet, Android and/or iOS), a landing or splash screen 600 is presented to a user as shown in FIG. 6A that illustrates the App title, one or more tag lines and various icons/imagery. After this splash screen, a user is presented with a map screen 602 as shown in FIG. 6B that gives them the option to login or to sign up as a new consumer. Also, the system tracks providers and the map shows the various providers that are online around the location of the consumer. If the user or consumer is already signed up, screen 604 of FIG. 6C is presented to give them the ability in various fields as shown, such as email, password. The consumer can also sign in with Facebook or Google+ depending on how the original account was set up. Assuming that all of the information is entered properly for the consumer to sign in, they are then presented with a home screen 608 is shown in FIG. 6D that indicates what the location is and also shows a map with providers that are online near them.

If a new consumer or user has to sign up, they may be presented with screens 610 of FIG. 6E which allows them to select an appropriate field 612 to create a profile. For the creation of a consumer profile, a screen 614 of FIG. 6F may be prevented and appropriately filled in by the consumer. The profile is stored by system 100 and may be accessed and used as discussed herein. Upon completion, screen 616 of FIG. 6G will allow completion of the sign-up process and allow possible entry of other additional information, such as a photo as shown in FIG. 6G.

The consumer App 170 can also provide editing of the consumer's profile as well as obtaining or addressing issues surrounding forgotten passwords and emails, as is typical in a login process. For example, the screens of FIGS. 6H and 61 might be presented. Furthermore, FIG. 6J illustrates a screen 620 the provides applicable fields 622 for editing the profile of the consumer as appropriate. Once a consumer is ready to proceed, they can make job requests and order services in accordance with the various features of the invention as discussed herein and control workflow with a provider.

Because the consumer App requires location tracking and relies on device notifications, various permissions are needed from the consumer user. For example, for downloading the App, the App Stores may require location access and messaging notification permission and thus screens notifying and requiring user acceptance must be present. An exemplary location access permission screen might have informational fields and input fields and the message notification permission screen might be similar with different information, as is known in the art. Generally, these screens are one time notifications per installation but might be shown again if a user uninstalls the App and then reinstalls it. After the initial landing screen and subsequent notifications, users might be presented with other informational screens, which overview various details associated with the App and the use of the service. The splash screens may be shown periodically to a user following the initial display.

Once a consumer swipes through or provides inputs to the initial screens and splash screens, a map screen 608 is presented that shows the location of the consumer centered on a map view. As noted, the GPS functionality 165 of the consumer device and third party location services accessed through the service system 102 are used by the consumer App 170. The location is generally centered on the map view with a custom pin icon as illustrated in FIG. 6D. Any in-app notifications/messaging may be presented to the user in an appropriate section of the screen. One such notification may be that there are no service providers or professionals that are within the viewed map area. The consumer might be instructed to zoom out in the view to locate providers. The consumer interacts with the map view of FIG. 6D to pan, zoom in or zoom out, slide or otherwise present touch input using the standard device gestures for a touch screen (push, pinch fingers to zoom in, tap and move to pan) as are known to a person of ordinary skill in the art.

If a provider is determined and the consumer would like to engage one for on-demand service, a consumer is required to either Login (with existing credentials) or Register to create a new account. User registration screens also displaying information in addition to prompting the consumer to enter data, such as through the touch screen fields. For example, term field might provide a hyperlink to the Consumer Legal Terms of Use which are located on a website that is provided as part of the service system 102 and can be accessed through the network 103 and service system 102 to be displayed on a screen by tapping or engaging the Term link 214. A consumer must then accept these terms to process a successful registration which is required to utilize the full consumer App.

Once a consumer has registered successfully and the consumer account is created, and an appropriate consumer account record created, consumers are then presented with a login screen 604 as shown in FIG. 6C. The consumer can use the data/information that they provided on the registration screen (email and password, for example) for inputs for the login. Alternatively, they can use various social credentials as illustrated by fields 606 of FIG. 6C. For example, the service system 102 may utilize OAuth or some other authorization standard or program to link to one or more social accounts from third party services and to the respective credentials to the user account/record associated with consumer. In the illustrated embodiment, both Facebook and Google might be utilized for social logins as seen in FIG. 6C. Once a consumer creates an account, a consumer profile is created.

As will be appreciated and as discussed herein with each of the provider and consumer Apps, various profiles and other information, such as for a consumer, a provider, a property manager or an employer are available for viewing and editing. Also, information about past jobs (job history) of a provider or networks of a property manager might also be reviewed. Information about a property that is set up is also available for consumers and providers in the process of ordering a job, completing the job and interfacing with the other party. To that end, various profiles might be accessed such as through menu fields 800, 802 as shown in the screens 8A and 8B for the consumer and provider Apps, respectively. Engagement with those fields will present other selectable menu fields for accessing consumer and provider profile information. Also network information or job history information might also be presented. Furthermore, because of the interaction provided by the inventive system between the users, within certain profiles screens, fields associated with another user are presented. As disclosed herein, for example, a service provider will be able to access a consumer profile through fields presented in a job history screen. In that way a provider might also see profile information on a boss/employer. Additionally, a resident consumer might be presented with the profile of a property manager consumer, or vice versa, in a similar linked fashion. For a company profile, an employer provider may be linked to various employee providers as well. The system 102 of the invention provides the necessary links between the entities in accordance with the features of the invention.

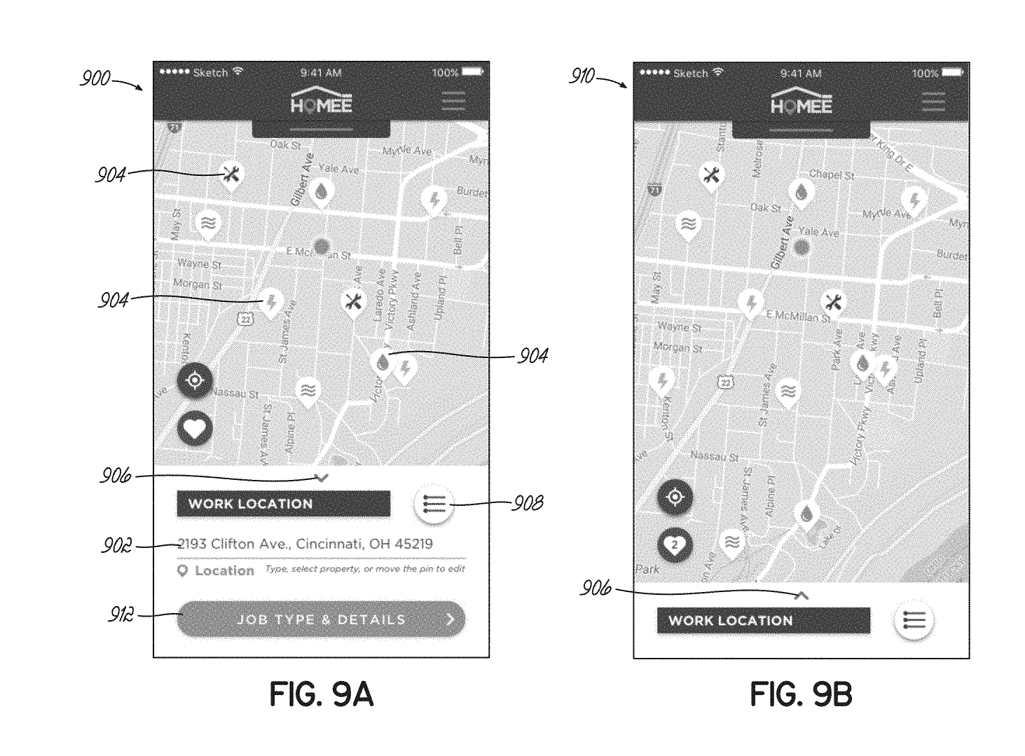

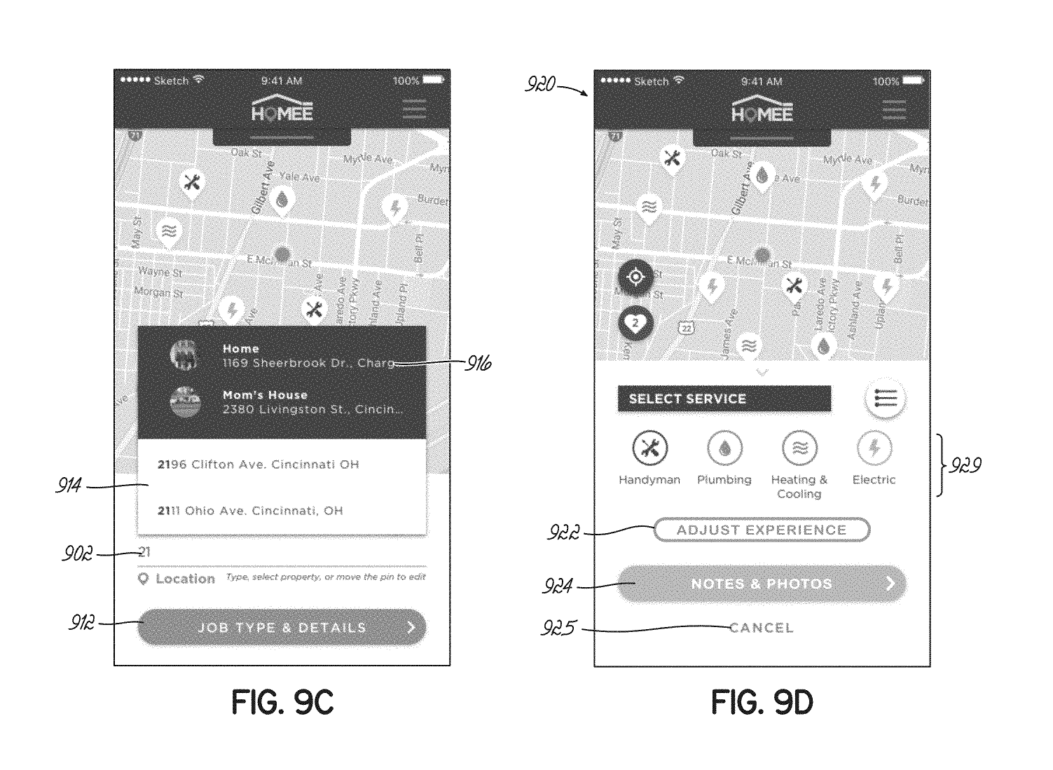

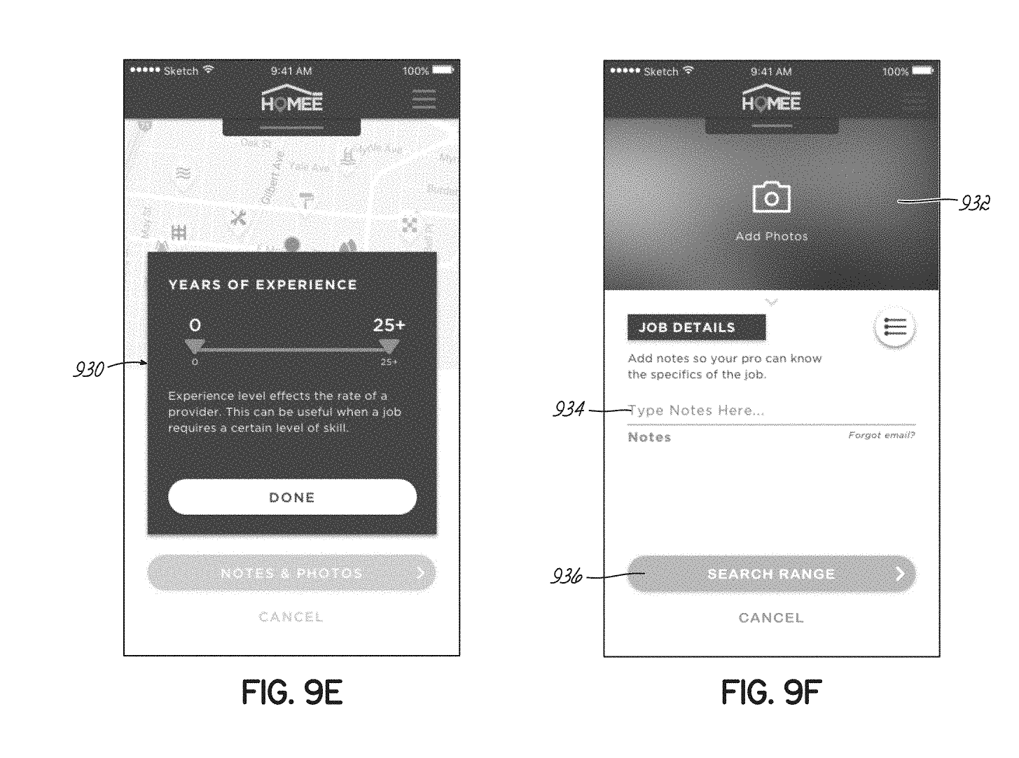

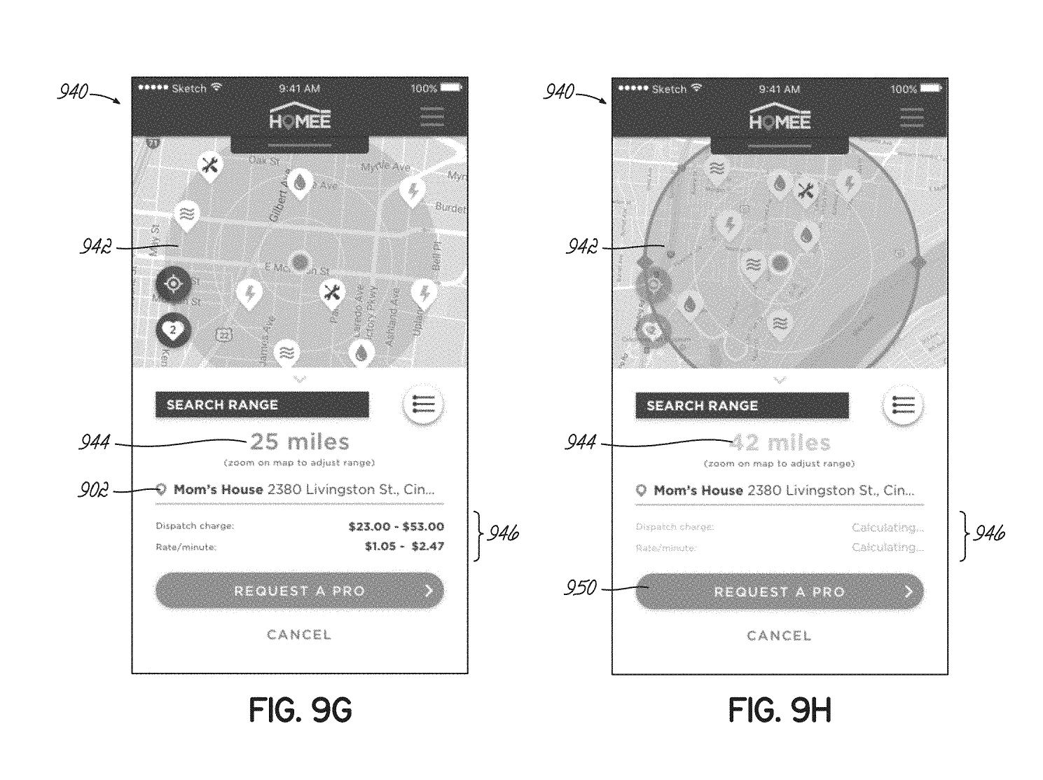

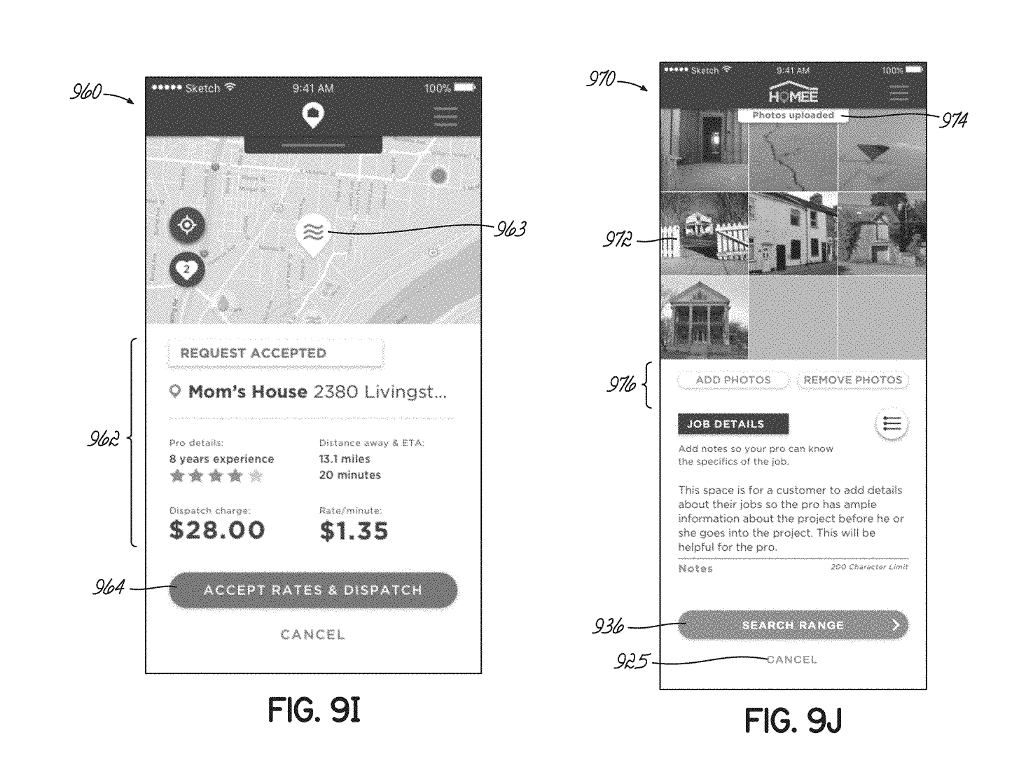

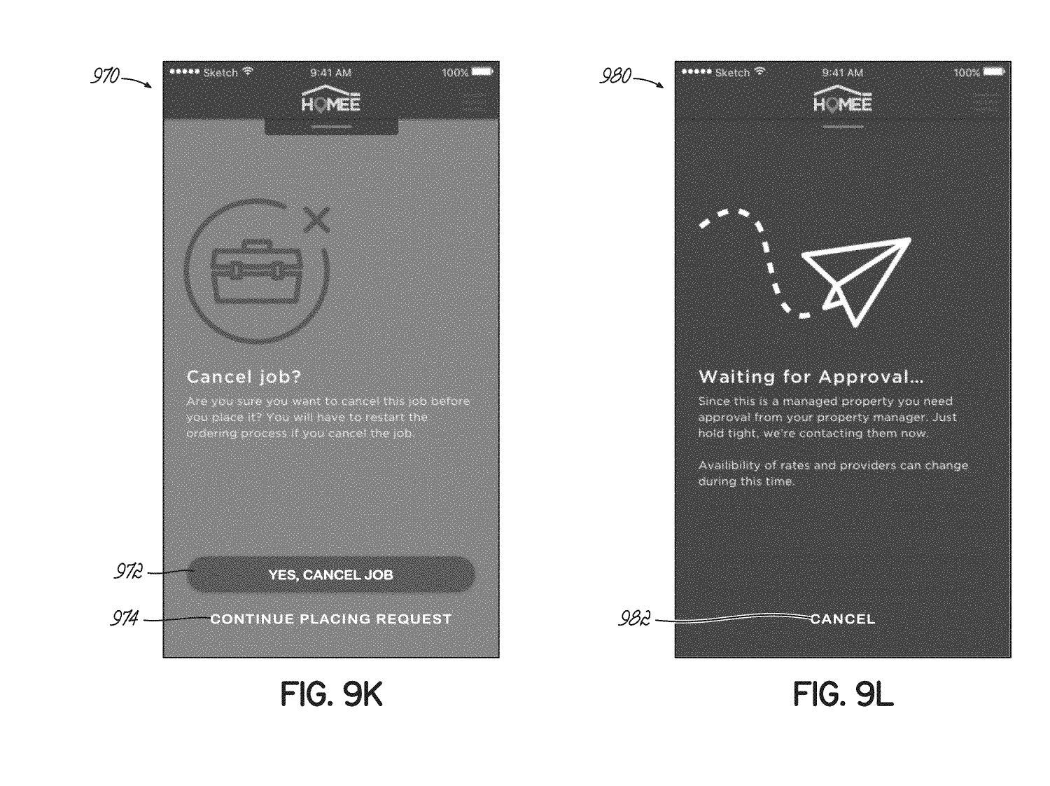

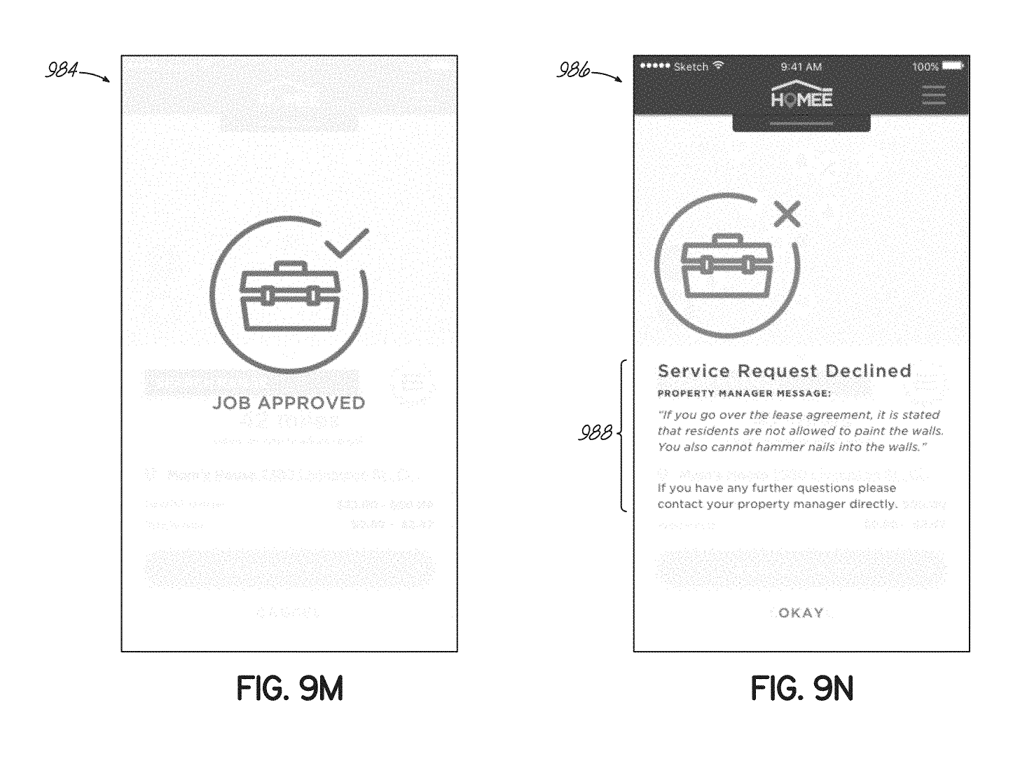

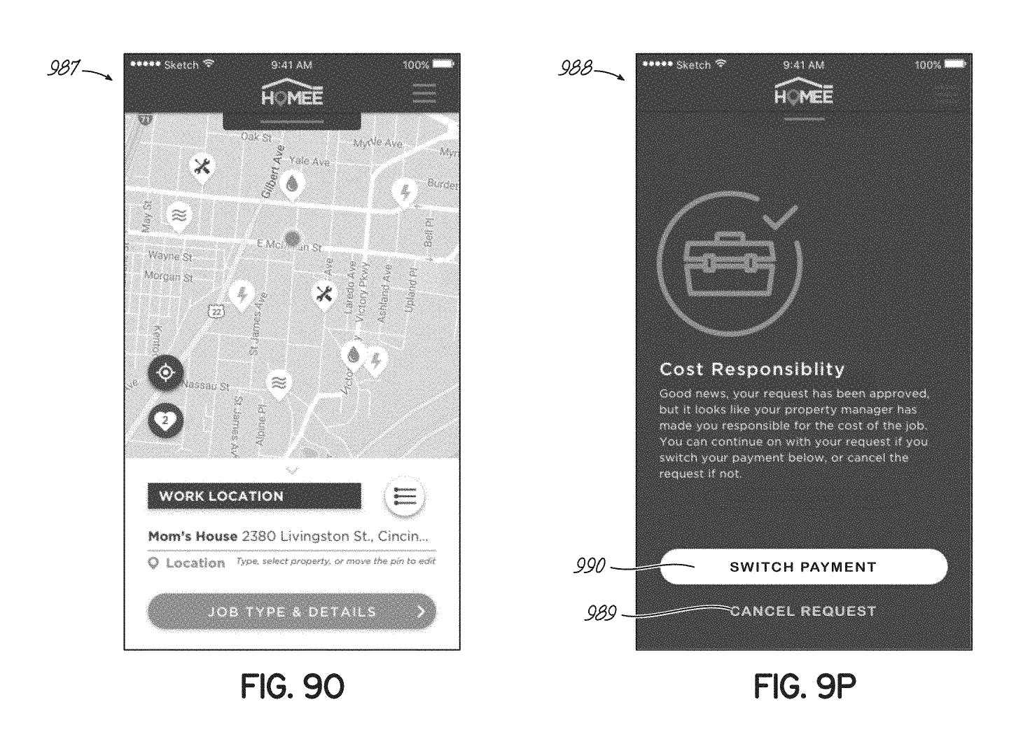

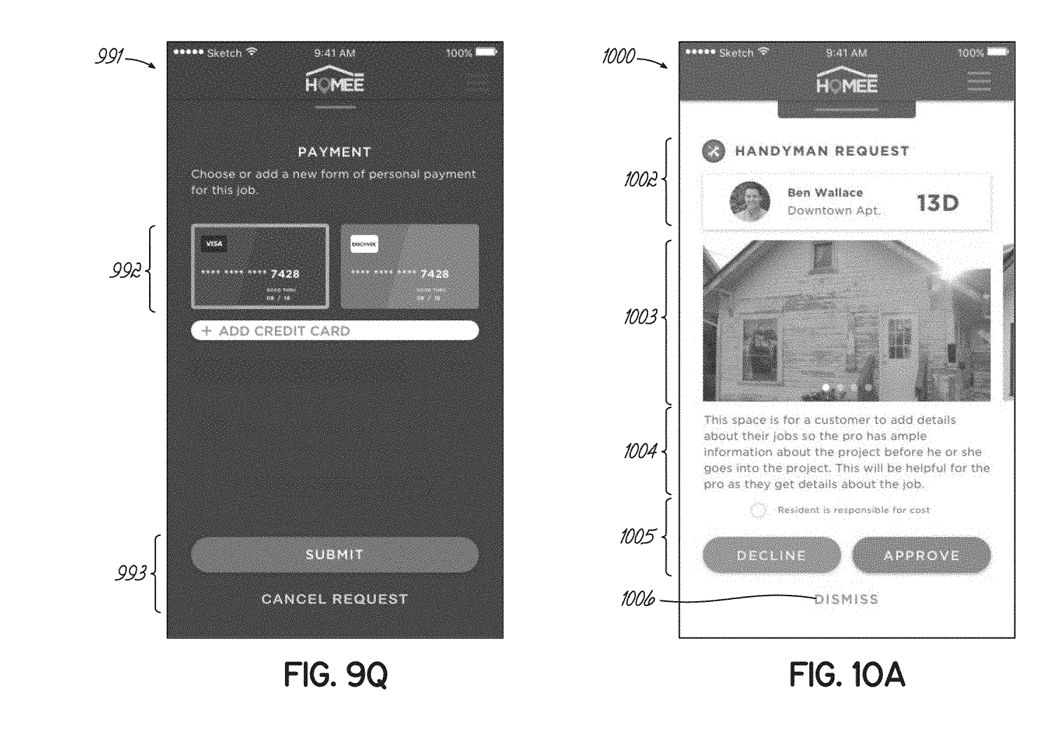

After successful login, the consumer is presented with an authenticated map view screen or home screen 900 as shown in FIG. 9A. Generally, a consumer's session lasts indefinitely unless they logout of the App or a new App version upgrade requires them to re-authenticate. This map view 900 displays the consumer's current location 902 as well as various pins 904 of the various service providers and professionals located in the current specific map view, or alternatively displays a notification that there are no or “zero” providers. From this screen 900, the consumer can engage field 912 to select an on-demand service in accordance with the invention to specify the type of on-demand service or trade they require. A user can expand/collapse the location search area through field 906 to see more of the map as shown in FIG. 9B. Also, as shown in FIG. 9C field 902 may be engaged to add another property rather than a current location. For example, one or more of the properties created in the consumer App as disclosed herein might be selected as noted in field 914. Also, an address might be added to field 902, or the centered location pin might be moved on the map to select another location for the job request.

As shown in FIG. 9D upon engagement of field 912, available services are shown in field 929 for selection and job requests by engagement of one of the fields/subfields and discussed further herein. The advanced control area allows for various ways to filter and control the map. The location search bar 902, consumers can type in various locations and the map feature of the consumer App will then reposition the screen around that location (city, state, longitude/latitude, POI, etc.) and use that location as a job location for requesting service. The map screen 900 is populated with various pins or icons 904 corresponding to local (per map view) providers based on provider records and data from the records previously set up and populated from a provider App as discussed herein and managed by service system 102 for use by the consumer App.

### Provider Application

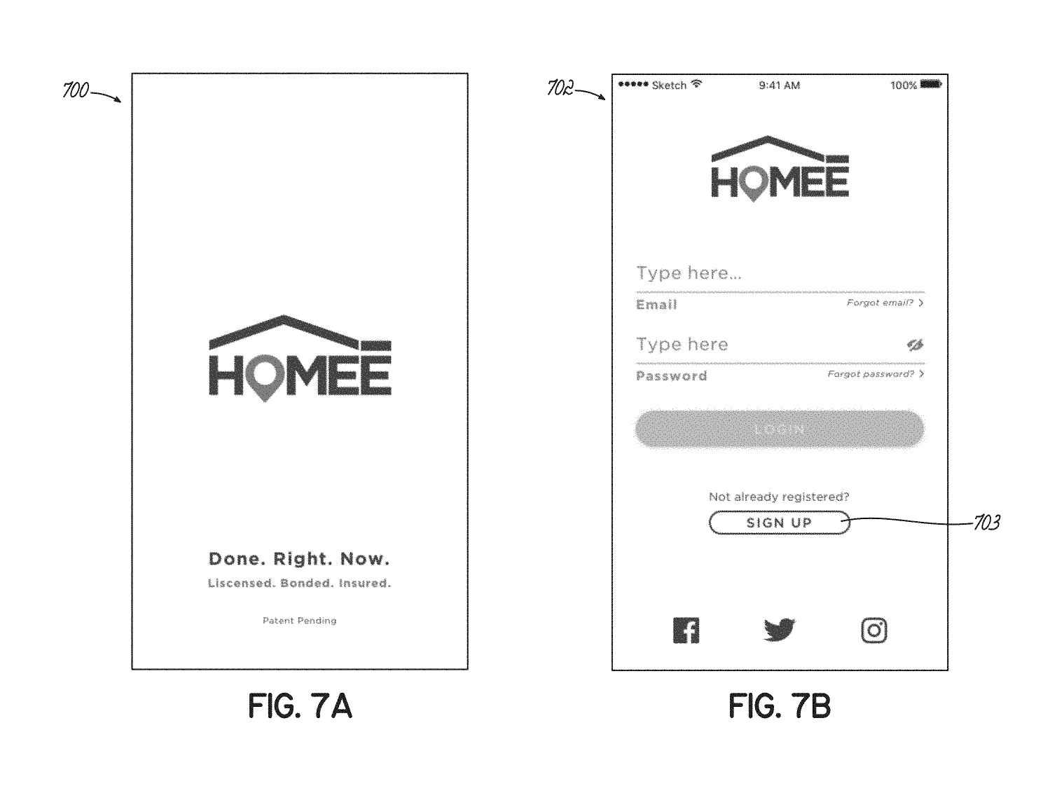

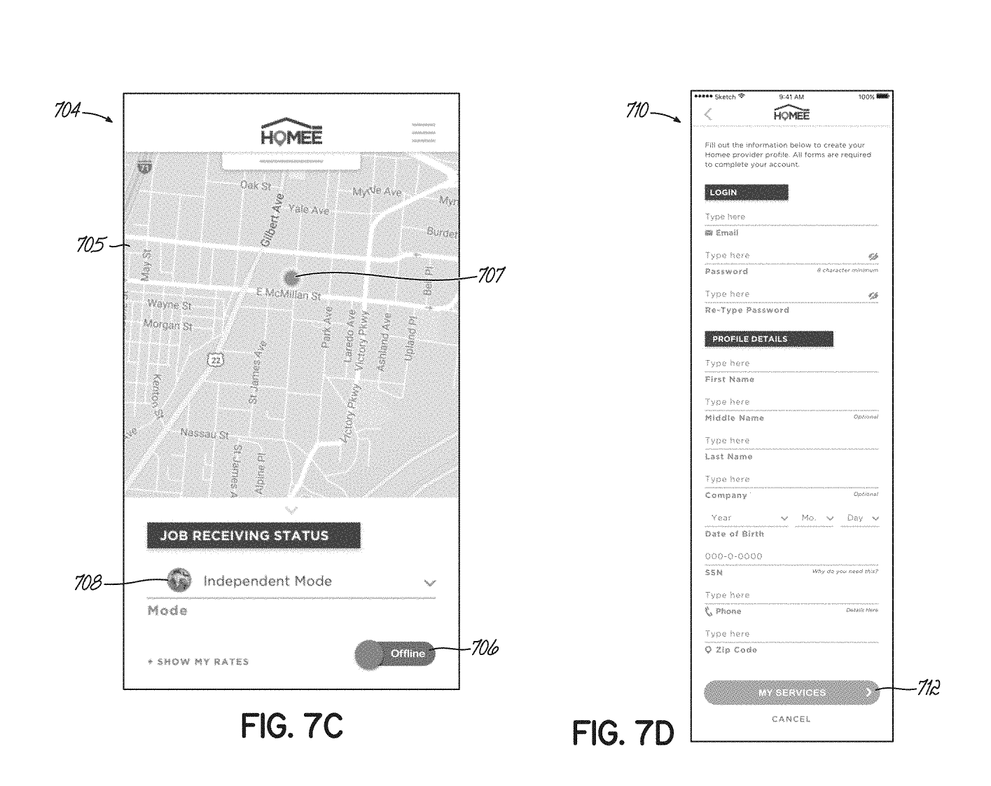

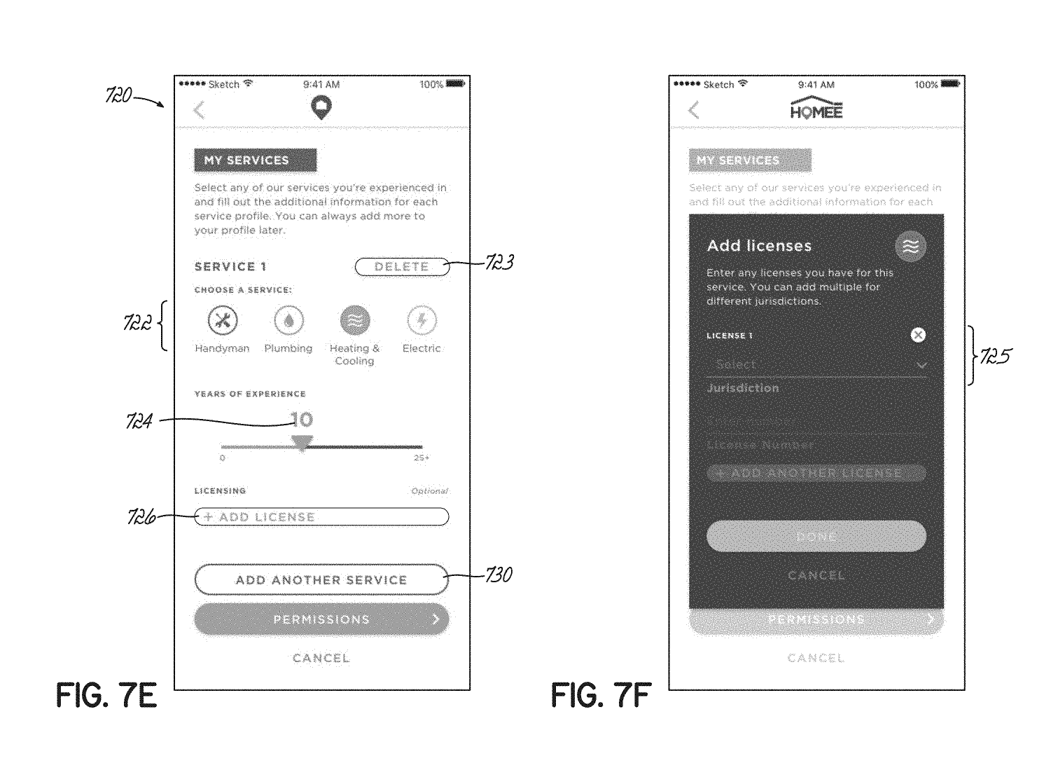

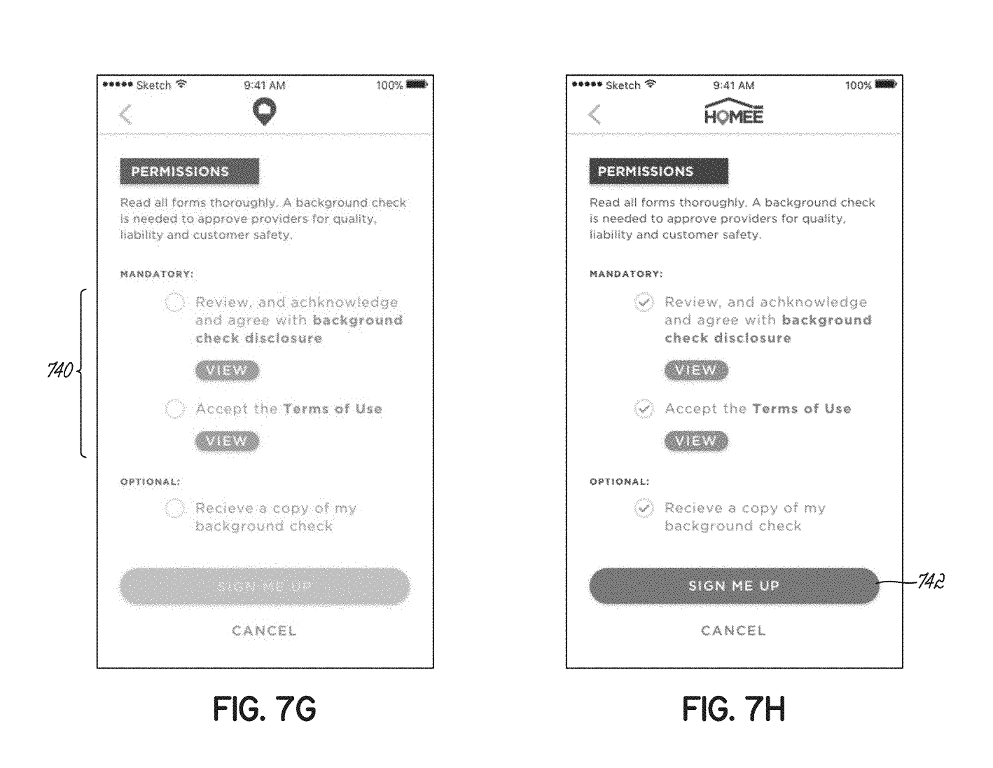

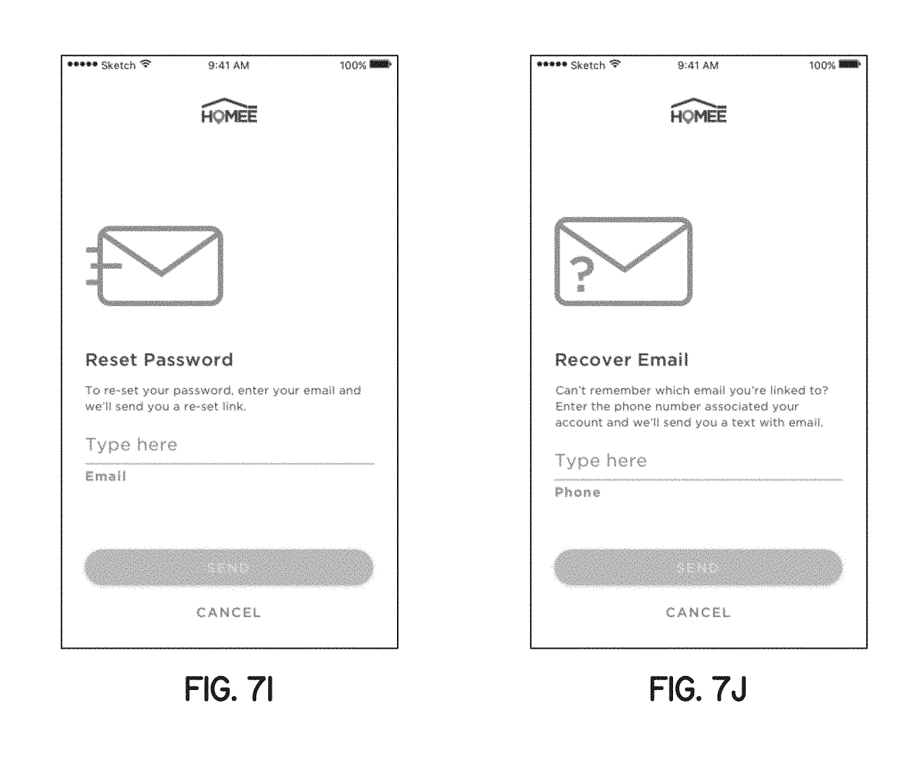

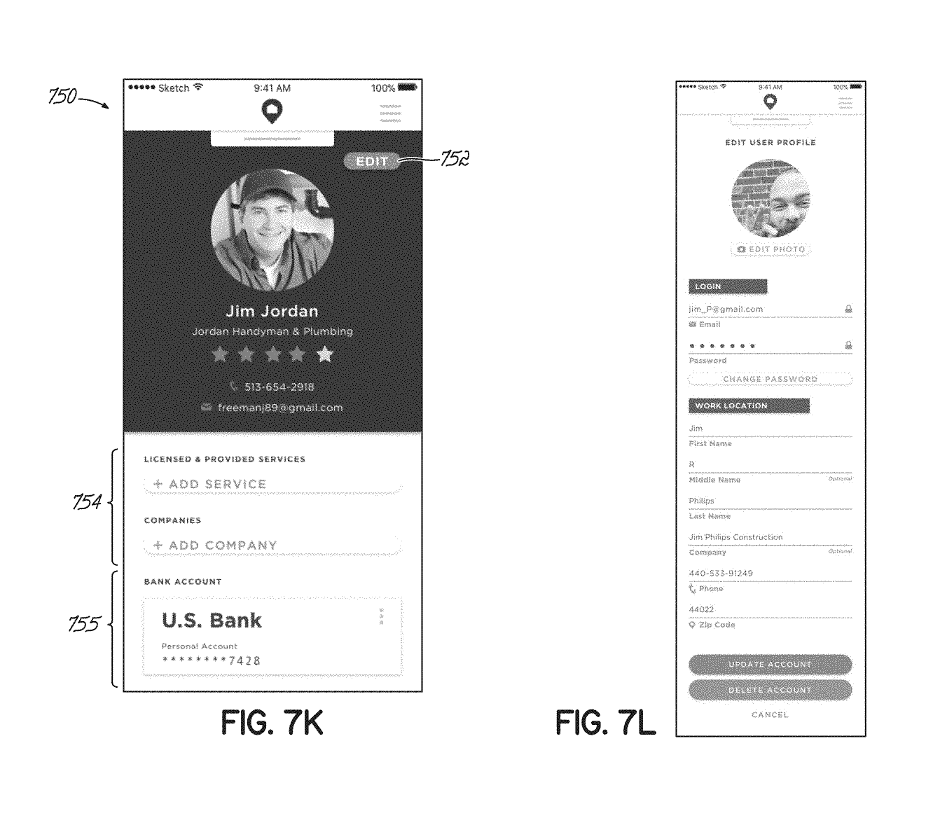

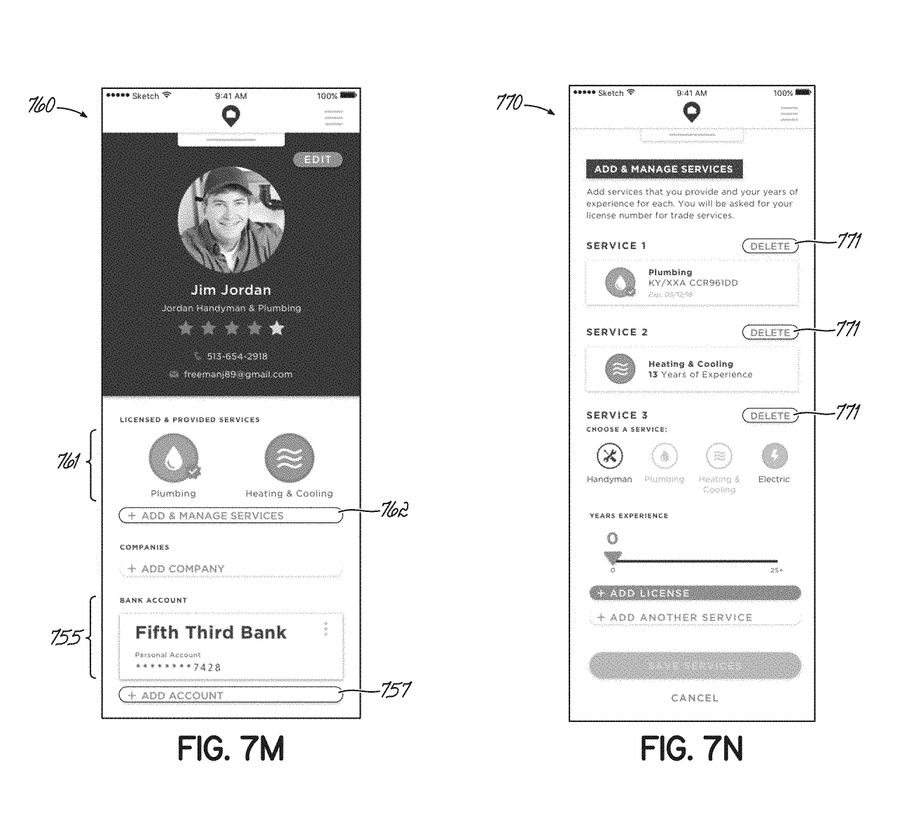

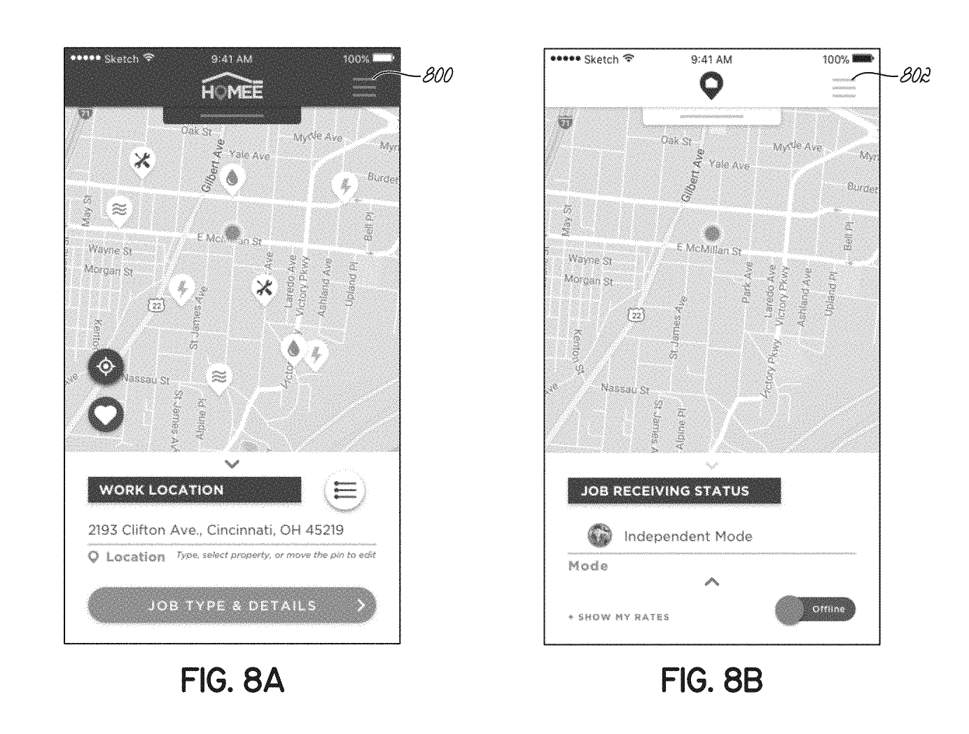

In accordance with another feature of the invention the other side of the interaction involves a provider that provides services to consumers. The service providers of the on-demand services interface with the inventive system 100 through a device 106 that runs a provider application 180. The provider application 180 is downloaded in a suitable fashion, such as from an app store, onto the provider device 104. Upon download and installation of the provider application 180 on a supported device (e.g., phone and/or tablet, Android and/or iOS), the App provides a landing screen 700 of FIG. 7A that is illustrated to a user and that has the App title, one or more tag lines and various icons/imagery along with other marketable information for a provider to begin the login or sign-up process.

Because the provider App also requires location tracking and relies on device notifications, various permissions are needed from the provider user as well. For example, for downloading the App, the App Stores may require location access and messaging notification permission and have screens notifying and requiring user acceptance. Again, the message notification permission screen might be similar with different information, as is known in the art. Generally, these screens are one time notifications per install but might be shown again if a user uninstalls the App and then reinstalls it.

Referring to FIG. 7A, a landing screen 700 is illustrated and then a login screen 702 of FIG. 7B is presented for receiving information through appropriate fields such as email and password fields. If a provider is already registered in their application and provides the appropriate login information, they are directed to a map home screen 704 as illustrated in FIG. 7C. As with the consumer map screen, field 705 illustrates the location of the provider with an icon field 707. Furthermore, the provider is given a number of fields to select how they would choose to provide their services. For example, as discussed herein, a field 706 provides the ability to be online or off-line. That is, the service provider can decide whether they want to take job requests or not at the current time. To that end, field 706 may be a toggle field. Furthermore, as discussed herein, a provider can operate as an individual or independent or might operate as part of a company as an employer company owner or employee. Field 708 provides the ability through either a drop-down selection menu or other appropriate mechanism to operate in an independent mode or in a company mode as part of a company as further discussed herein. The provider is then ready to receive a job request, assuming that they are in an online status.

If a provider is not registered, through interface screen 702 and field 703 they are given the ability to register or sign up. If signing up, they are presented with one or more screens as shown in FIG. 7D as screen 710 where they can enter login information and appropriate profile details such as their name, company, contact information and other information as necessary. As part of the process they might also be given the ability to add bank account information or to give other information. For example, a provider might need to have a certificate of general liability for operating in the inventive system and to provide service. This will have to be verified before they go on-line for a job as disclosed herein. Once those fields or any other fields are appropriately filled in, another field 712 might be engaged so that the provider can enter information regarding specific services that they provide. For entering services, screen 720 as illustrated in FIG. 7E might be presented. Therein, the provider might select one of the service fields 722. The provider must add at least one service that they will provide, in the registration process. Upon doing so, they can then enter their years of experience in field 724, such as a slider field to show those years of experience.

Furthermore, through field 726 the provider may enter license information. For adding a license, upon engaging field 726, the screen of FIG. 7F might be presented for entering additional information through field 725. Also, through field 730, other services may be added for a provider. The various selected services and licenses might then be displayed. Once all the services of been selected, the provider may have to acknowledge and accept certain permissions, such as background checks and terms of use that might be viewed and acknowledge through one or more appropriate field 740. Once the various permissions in terms are accepted, which may be mandatory as illustrated in the screen of FIG. 7H. Field 742 might be engaged for signing the provider up in the inventive system. As illustrated in FIG. 7E, various services might also be edited and deleted as appropriate through field 723 so that the provider can change their provider profile.

Similar to the consumer, if a provider forgets their password or email, they might be provided with an appropriate screen for recovering same as illustrated in FIGS. 71 and 7J in a known process. Also, the provider profile and account may be edited through a drop-down menu and screen 750 of FIG. 7K where an appropriate edit field 752 might be selected for editing the account. Therein, through an appropriate interface screen such as in FIG. 7L, fields may be provided for updating or deleting a provider account as well as changing information, such as the email, password and other information about the provider. Furthermore, again referring to FIG. 7K in screen 750, appropriate fields 754 are provided as well for the addition of one or more services as well as the addition of one or more companies that the provider may be associated with as disclosed and discussed herein. Also, as illustrated in FIG. 7K, bank account information can be added as part of the profile as shown in field 755.

Referring to interface screen 760 of FIG. 7M the profile screen for provider will show various service fields 761 through the fields that the provider has selected. Then by engaging field 762 the various services might be added or managed such as through another presented interface screen 770 as illustrated in FIG. 7N. Services and related experience and license information might be selected and added or deleted as appropriate through one or more fields 771. In that way, a provider can be registered to exist within the inventive system for providing services as discussed herein. You might also edit the bank account information by engaging field 755 or add an account through field 757. As may be appreciated, when adding information or editing information to a profile, various other different screens and fields, similar for example to the screen of FIG. 7N might be presented to gather/edit the necessary information

Once a user has registered successfully a provider account/record or profile is created. As noted, the various consumer and provider records and profile information are stored by the backend system 102. As part of registration, the provider might be required to fill out a background check form with additional information. As part of the registration, the provider gives information that is required for performing a background check is shown in the screen of FIG. 7D. For example, the provider may have to provide input data for their social security number, date of birth, email addresses, first and last name and other data details, which are then used for an extensive background check. The provider/account might be unable to go online within the provider App until the background check is cleared. In accordance with one embodiment, a third party system/service 108 is accessed by the provider device 106 and service system 102 for providing the background check service. For example, in one embodiment, Checkr (www.checkr.com) may be one of the possible third party services used by the system 100 of the invention for background checks.

In one embodiment of the invention, the system 100 checks for the following information, including an identity and criminal record:

### 1. Identity Check

IDENTITY VERIFICATION—a Social Security Number (SSN) verification is the most efficient way to verify a provider's identity. If an identity cannot be verified, the third party system alerts the applicant to request additional documentation.
ADDRESS HISTORY—The Identity Check includes a trace of all known addresses over the multiple years. Based on that information, third party searches relevant court jurisdictions for the same time period.

### 2. Criminal Records Check

SEX OFFENDER REGISTRY CHECK—A thorough background check includes a Sex Offender Registry Check. The third party searches registries for every state. The data returned includes date of registration and current status.
CRIMINAL RECORDS CHECK—The third party service performs direct searches of Federal, National, State and county court records for relevant information. This search is part of the baseline for establishing due diligence. Results include felony and misdemeanor criminal cases as well as, charges, disposition, dates and sentencing information.
GLOBAL WATCHLIST CHECK—This check searches known domestic and international terrorist watchlists as well as the records of the Office of Inspector General (OIG), Excluded Parties List (EPL) and additional domestic and international agency lists.
COUNTY AND FEDERAL CIVIL RECORDS CHECK—This check provides access to Superior (upper) and Municipal (lower) courts for civil records, as well as those presided over by the federal district court system.

The backend is automated such that when a background check is set to Clear status or has been manually cleared, the third party system triggers an update to the provider's account/record. For example, a flag may be set that shows the provider has a cleared background. Even with a cleared background, the provider is still unable to go online for taking jobs at this point until they have entered all of their deposit account information as noted herein.

Once the provider's account is created and they have a verified and cleared a background check, the provider is also designated in their record as an authorized buyer for a professional service account at a third party supply company as discussed further herein. In the illustrated embodiment of the invention, the service system 102 interfaces with a vendor such as Home Depot or Lowe's for providing a Professional Services account. This account allows the provider to procure parts at a particular store. For example, as noted herein, various jobs may require the purchase of certain parts or materials or other items. A provider that has a provider account/record pursuant to the invention would engage at a store and indicate that they are part of the system of the invention (a brand for the invention, such as HOMEE, might be used for the provider to designate that they are part of the HOMEE system 100). They then present a valid picture ID to the personnel of the store, such as a cashier and have that person input a particular Job ID that is associated with a job as discussed herein. They can then have the parts or materials, or other items charged to an account associated with the job ID and can walk out the door in a cashless transaction. The parts/materials are then linked by Job ID to the system of the invention and can be retrieved in the provider App electronically through system 102 and then submitted as part of the final transaction to the consumer upon completion of the job. In that way, proper information and costs associated with a job are obtained through a third party vendor and the inventive system.

Once a provider has registered successfully and the account is created, and an appropriate account record or profile is created, providers are then presented with a login screen 702 as shown in FIG. 7B. The provider can use the data/information that they provided on the registration screen 710 (email and password, for example) as input for the login.

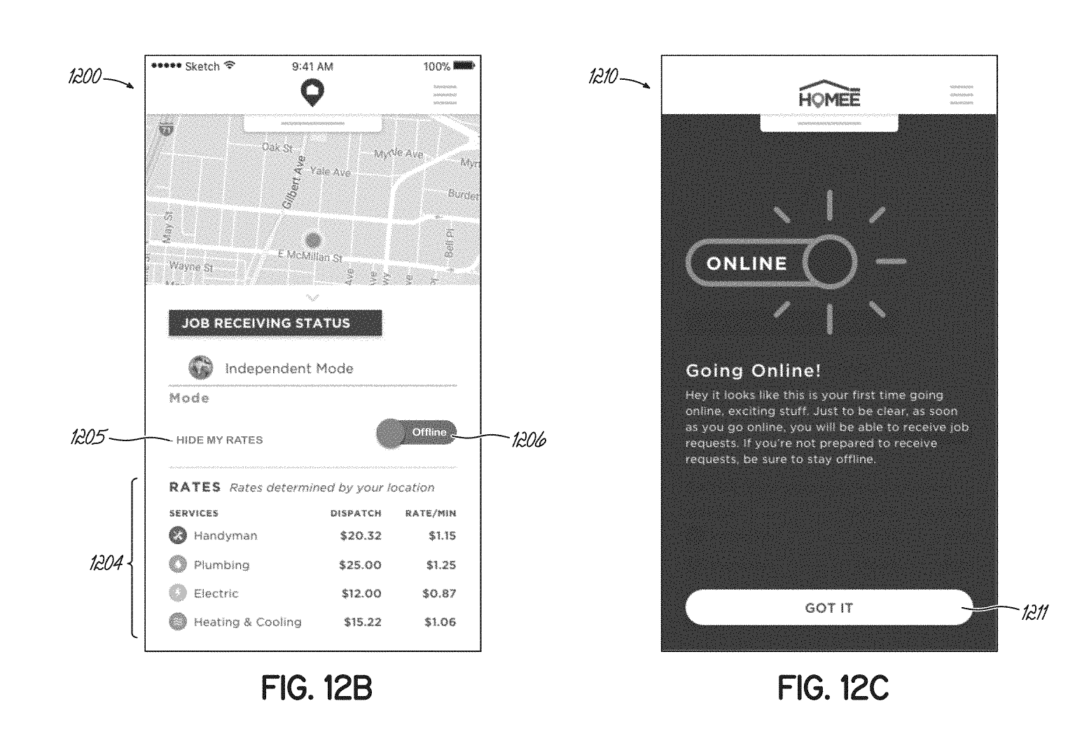

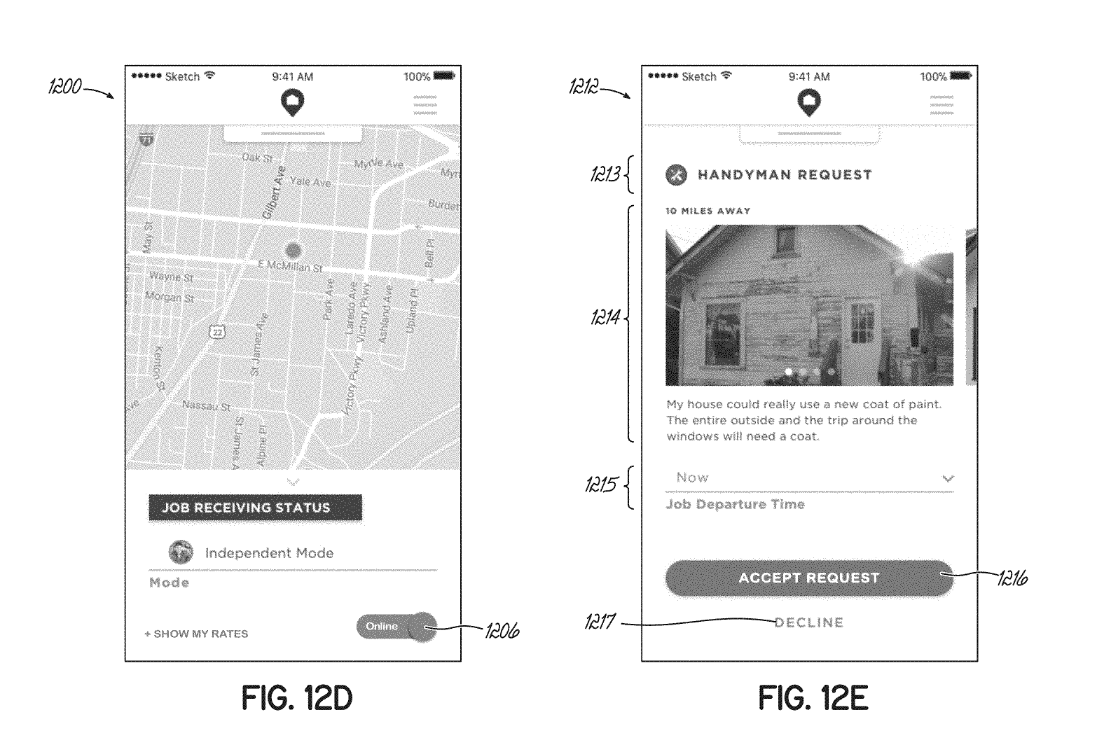

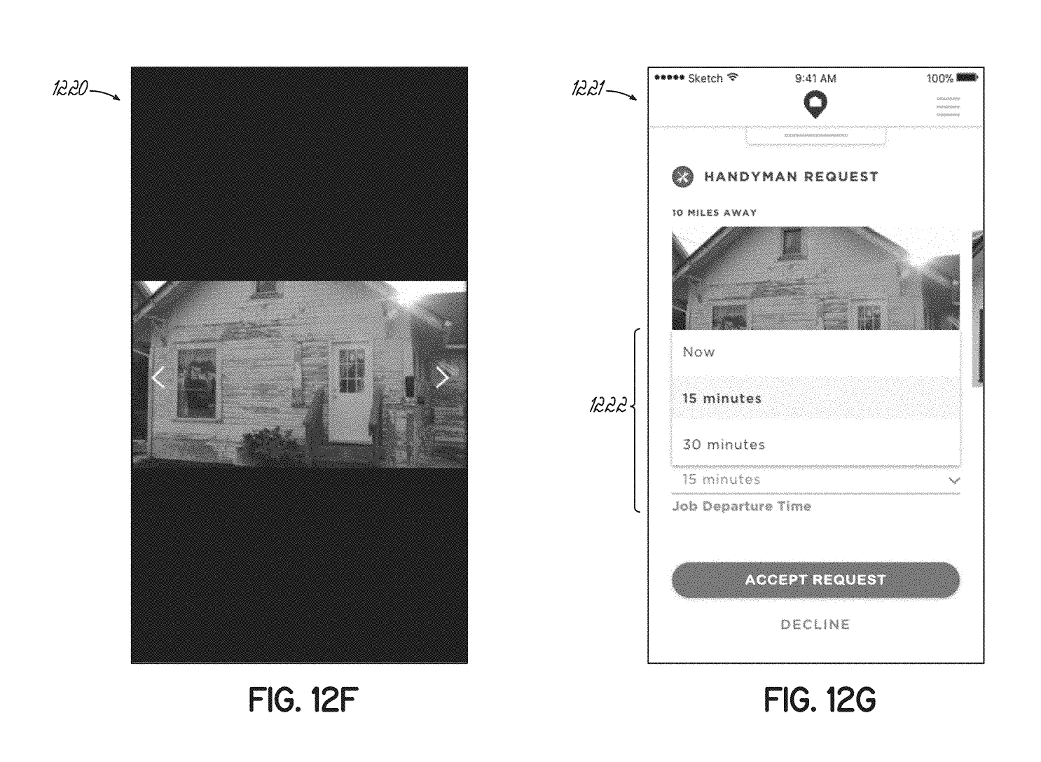

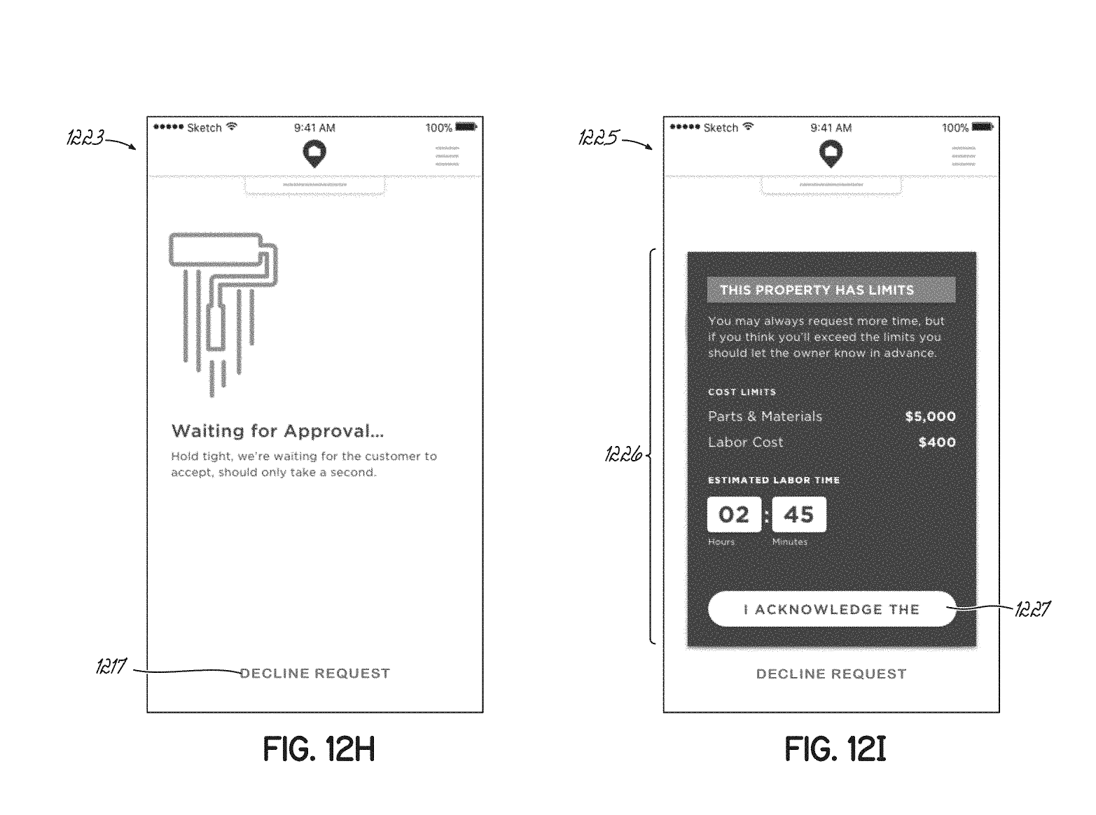

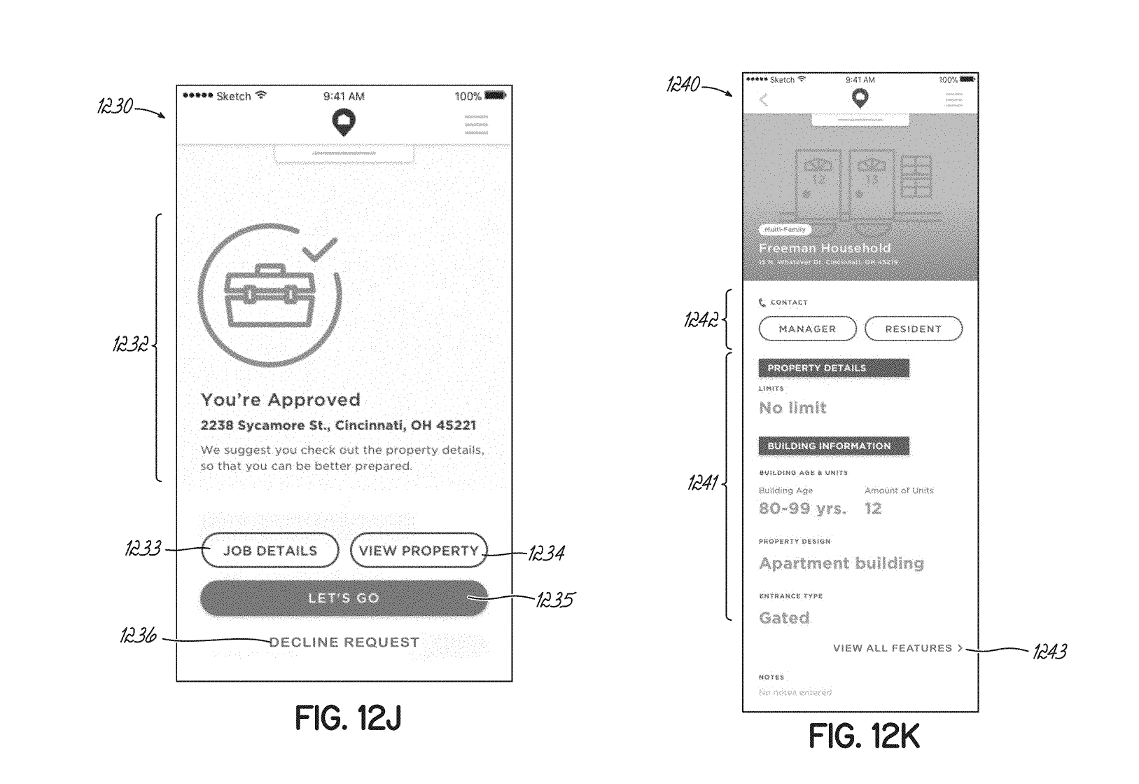

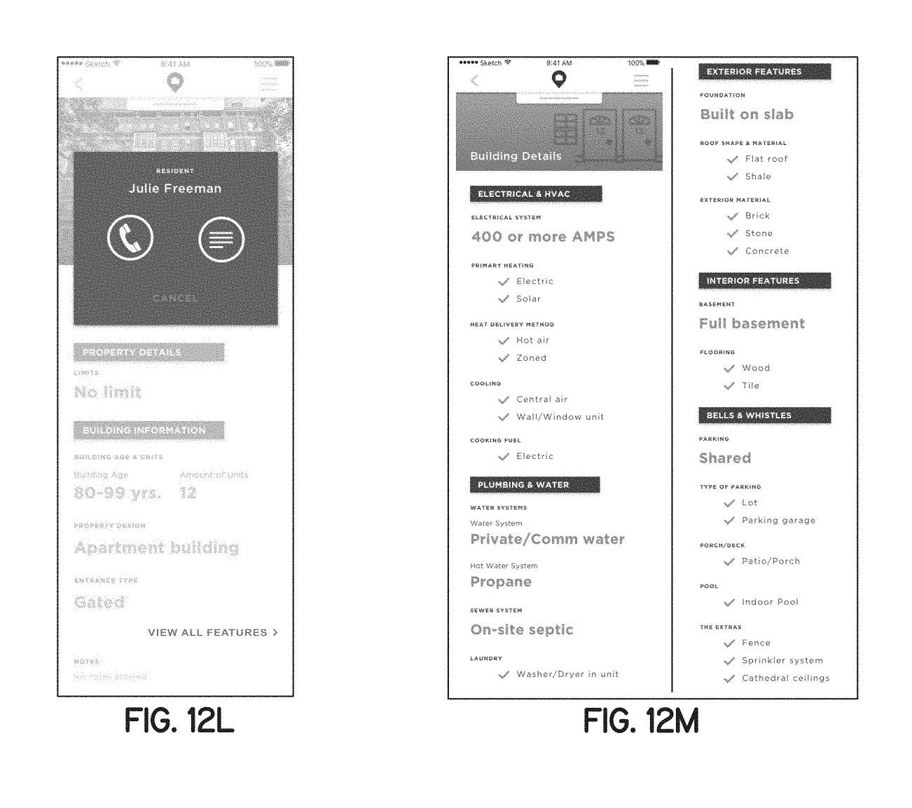

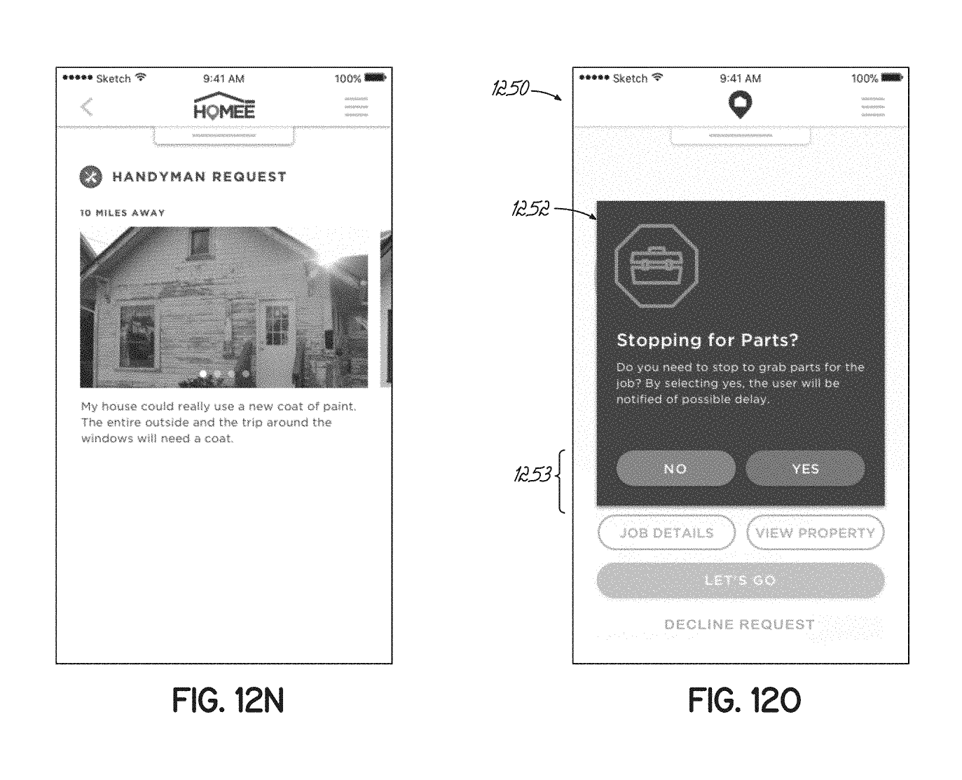

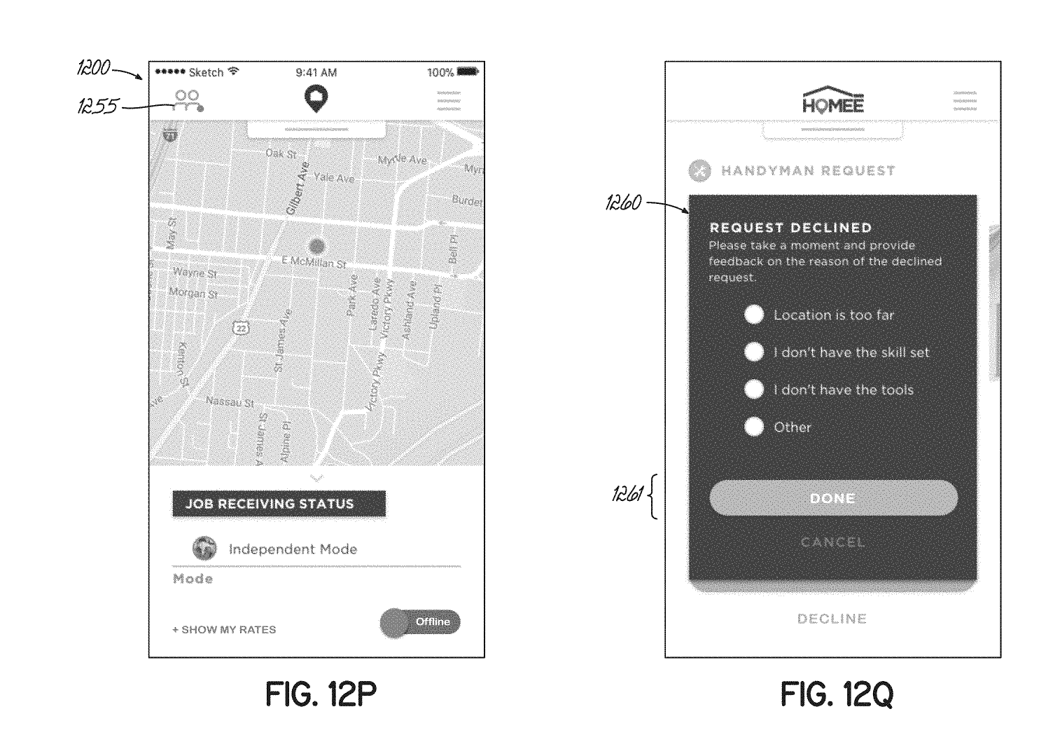

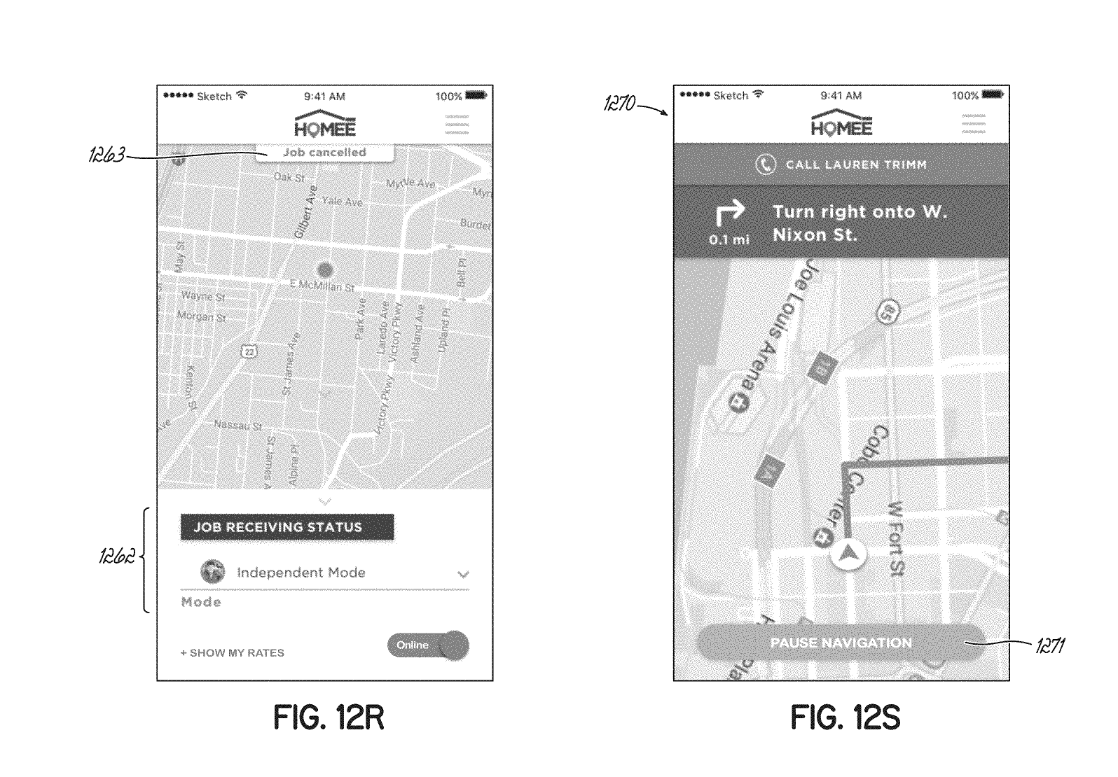

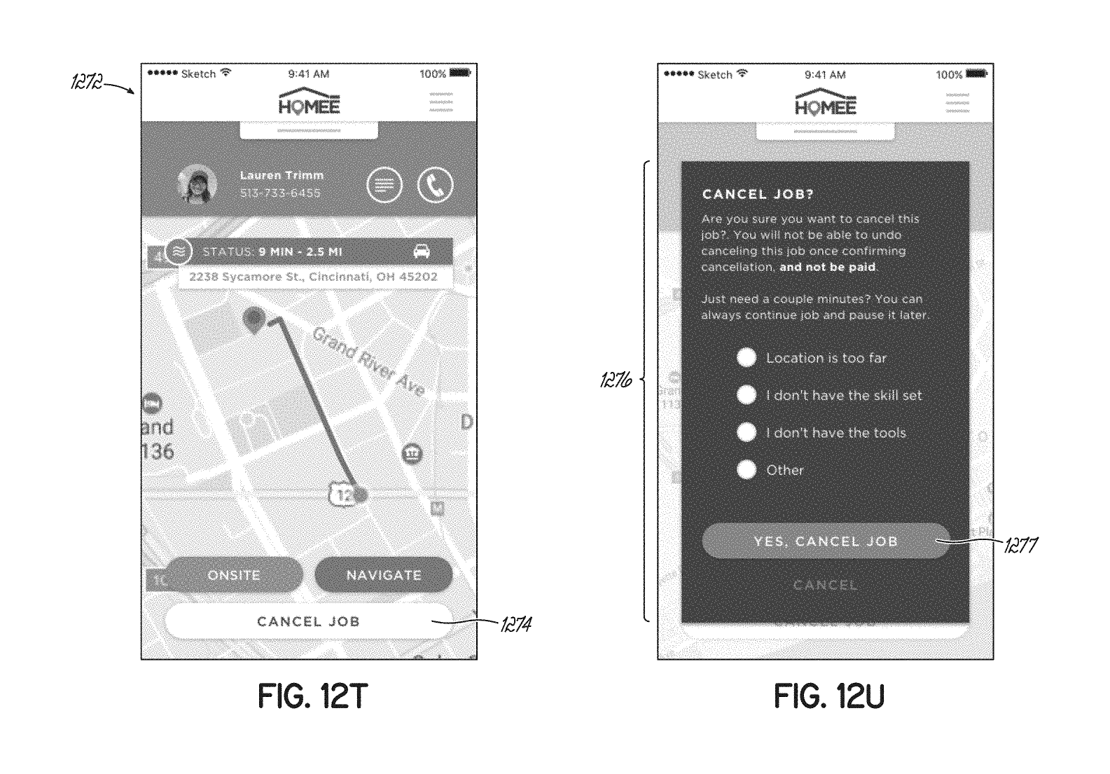

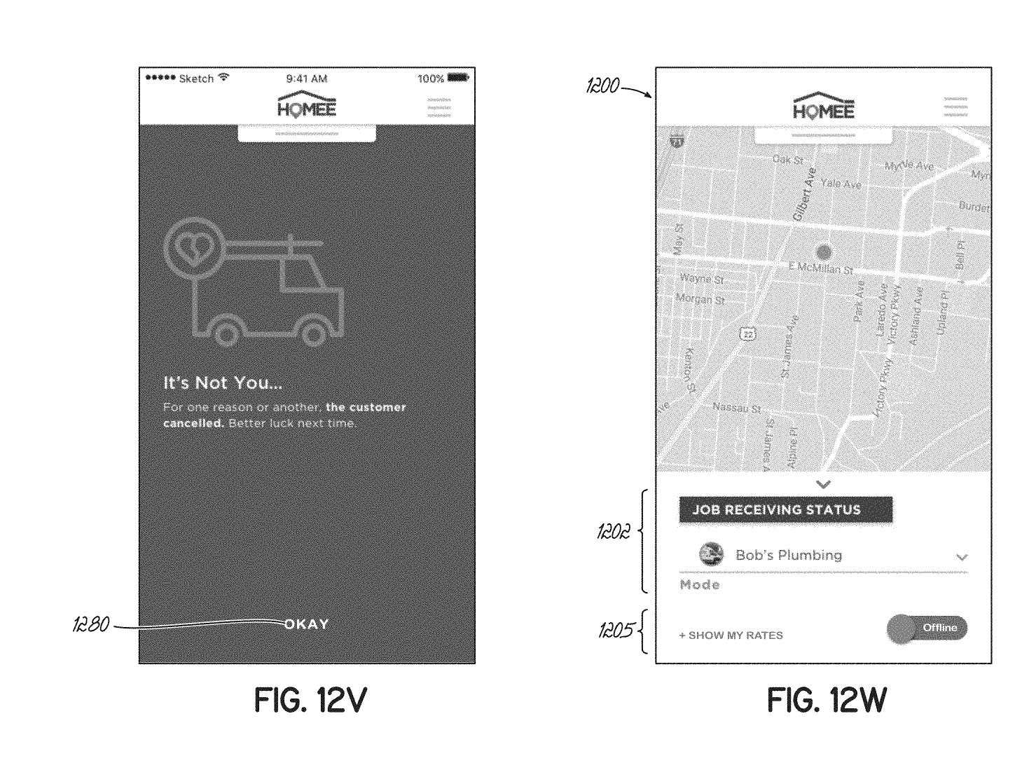

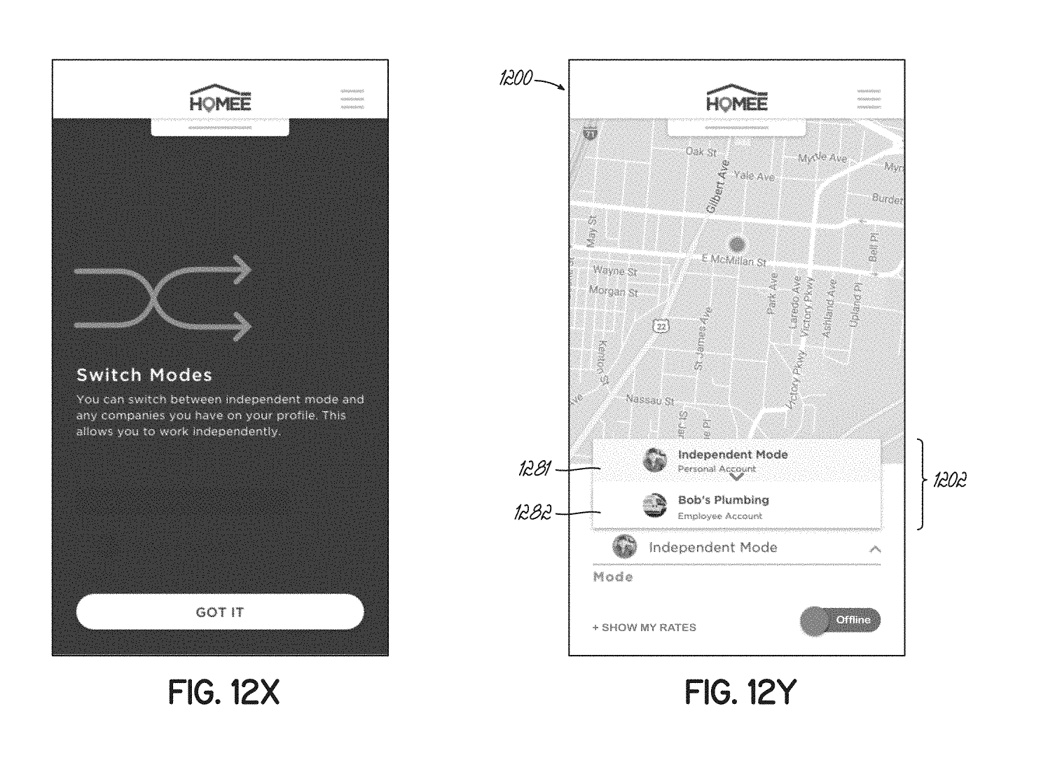

After successful login (a user's session lasts indefinitely unless they logout of the app or a new app version upgrade requires them to re authenticate), the user is presented by the provider App with a Map view on their device, such as screen 1200 as illustrated in FIG. 12A. This map view displays a map 1201 with the user's current location 1205. The map might also include various pins or fields or indicators of the locations where that particular provider completed service job requests or has suspended service job requests or in process jobs that are saved in the provider records/profile. In such cases, each of the job pins may be color coded depending on the job status. For example, one color, such as blue, might be used to indicate a completed job for the provider. Alternatively, another color, such as orange, might be used to indicate a suspended job, and green to indicate a job in process. Gray might be used for a suspended job. Such colors will also match with the colors used in various screen interfaces for jobs in a “on-going jobs” profile screen. A white field with multiple dots might indicate multiple ongoing jobs at a location in various status. In one embodiment, any existing pin fields may be engaged for accessing information about the job details

In accordance with one feature of the invention, the user can set their availability to receive job requests. Specifically, a toggle field 1206 as shown in FIGS. 12A and 12B gives the provider the opportunity to input and set their availability. Sliding the toggle off, as noted, sets that the provider is in an offline state, and they are not available to receive job requests. As such, when the consumer App is run, they would not appear as an available provider on the consumer App map view screen, screen 608 of FIG. 6D. Furthermore, the provider is kept in an offline state until their background check has cleared, any bank account information is added as discussed, and any Certificate of general liability is processed for their profile. Then they are able to go online by an appropriate engagement with field 1206.

### Job Order Workflow

Once the consumer and provider are registered and have suitable records and accounts on the system 102, they are able to interact and engage on jobs and job flow in accordance with the invention and to select and provide an on-demand service in accordance with the invention. Once a consumer using a device with the consumer App has is ready to order a service as illustrated in FIG. 9C, they engage the field 912. Referring to FIG. 9D, engaging field 912 will present fields 929 for selecting services. Once the service is selected, the consumer may select a provider based on experience (field 922) then they provide additional information, such as notes and photographs regarding the job (field 924). Various of the fields might not be selectable until a service is selected. Referring to FIG. 9E, once service is selected the provider is given the ability through engagement with field 922 to select the years of experience that are desired for the provider. As shown in the screen of FIG. 9E, field 930 might be presented for entering experience information, such as through a slider field as shown. Also, job details may be provided though engagement with field 924. As shown in the screen of FIG. 9F wherein fields 932 and 934 may be selected for adding photographs and notes. For editing photos, menus might be provided (not shown) for taking a picture or selecting photos from a gallery that may be stored on the device. Once the information is provided (and for some embodiments it may be mandatory) then field 936 might be selected for starting the search process for a provider. Field 936 may remain unselectable until any mandatory information is given.

Referring to the screen of FIG. 9G, once information is added and field 936 engaged, map screen 940 is presented with a range indicator 942 provided on the map showing the area in which a service request will be sent in accordance with the invention. The diameter of a search range might also be illustrated (field 944). Also, information regarding providers might be sent for providers within the search range as illustrated by fields 946. That information may include dispatch charges or time-based service rates. At this stage, the consumer has the ability to also change job site addresses, such as through engagement with field 902. In one embodiment, the user can change the search range or radius 942 through engagement with the map screen and by zooming in or out, the range in field 944 will increment as the user adjusts the range. Also, the rates in field 946 may be updated. Once the range has been determined and the rates have been set, if the consumer wants to proceed further, they can engage field 950 is shown in the screen of FIG. 9H for requesting a provider of such services as they have selected.

Requests will go out to available providers in a search format as discussed herein wherein selective filtering is used based on the provider attributes such as their services offered, their memberships in a group or network of providers or a company, their certification/badge for certain products, as well as the distance from the service location in order to select a suitable provider as disclosed herein (see FIGS. 5J-5M, for example). Also, if the consumer has set up a network as discussed, a particular search protocol will be used. A waiting screen might be illustrated (not shown) while the invention is searching for a suitable provider. As illustrated in FIG. 9I, once the provider accepts a job request a screen 960 is shown with informational fields displayed showing the location, years of experience, distance from the job, estimated time of arrival, rates, and other information as desired. The map might also highlight the service provider location (field 963). Field 964 can then be engaged to make the job active.

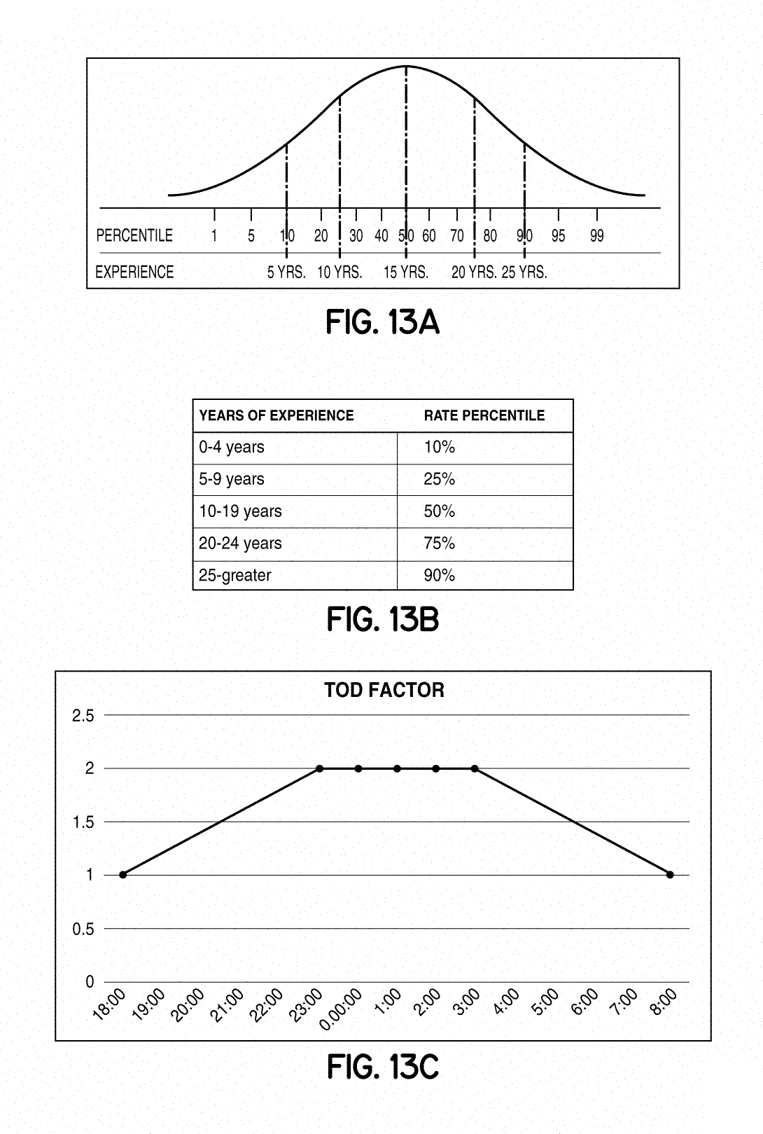

In accordance with one embodiment of the invention, the Rate information for a particular provider is determined using a particular algorithm of the invention. Information related to wage data for certain occupations is used and then modified according to the invention. For example, wage data from the US Department of Labor, Bureau of Labor Statistics may provide wage rate data for a location and for multiple percentiles. These percentiles are then correlated to a provider's years of experience. A normal distribution of wage percentiles is illustrated in FIG. 13A shown with years of service or expertise. In accordance with one embodiment, that information is contained within a look-up table of the system 102 that may be accessed based on job location as determined in the invention. FIG. 13B illustrates an exemplary table with wage rate percentiles associated with years of experience of a provider that may provide the basis for such a look-up table, in accordance with one aspect of the invention. As such, in a table there will be multiple wage rates for a particular location, based upon years of experience for the provider. The interpolated Rate Values are used and are further modified based on provider years of experience.

The rate may be modified by other factors in accordance with the invention. In the disclosed embodiment, a Time factor (which may take into account both time of day and actual day of the week) and a Rating factor are used for modification. As illustrated in FIG. 13C, a graph shows a Time factor (Time of Day—TOD) for an embodiment. During normal business operating hours (e.g., 8 AM-6 PM) the factor might be unity or 1×, but then it is adjusted accordingly as illustrated. The Rating factor, on the other hand, is based on a 1-5 star rating that is given to a provider by the consumer as noted herein for past jobs that have been completed. That information is stored for the provider profile record and then used for future rates of future jobs. As such a scale of X/5 with X=star rating, might be used to further modify the rate. So, a lower 1 star rating might create a 1/5 or 20% factor, a 2 star rating might create a 2/5 or 40% factor and so on, up to unity for a 5 star rating (5/5 factor).

For example, the Rate for a job might be determined according to: RATE=(Rate Factor−Rating)*(Rate Factor−TOD)*(Interpolated Rate Value based on Job Location [Corresponding to the Provider Years of Experience Percentile Look-up]). Therefore, the rate as used in the invention takes into account various factors to determine a fair and equitable rate based on the job conditions as well as the quality and experience of the provider themselves.

When a job is requested, through an interface with the backend service system 102, the system distributes the job request to the localized network in one or more specific search protocols as disclosed. Different search protocols may be used for the purposes of finding a provider and linking them to the job request as disclosed herein.

In one embodiment, the invention cycles between all the providers that are available in a defined radius or a map zoom level and then gives an exclusivity period for each before moving on and then gives a set time-out period for each such provider. If all the providers have been addressed and all the time-out periods are expired, the job request is then expired, and a consumer would have to begin again.

Referring to FIG. 9J, certain information regarding the job might be varied before requesting a provider. As shown on screen 970, selected photo 972 might be displayed and uploaded to the server as indicated by message field 974. Editing fields 976 allows the consumer to add or remove various photos for the job as desired. Also, during a job request, the process might be canceled by the consumer. For example, even after a service is selected such as illustrated in FIG. 9D, a cancel field 925 might be engaged wherein the user can cancel. The screen 970 the FIG. 9K is presented and the consumer can confirm cancellation through field 972 or continuation with the job request through field 974. If the job is canceled, a temporary message field, such as a “request cancelled” message might be displayed (not shown) and when the job is canceled, the consumer App will return to a map screen such as that illustrated on screen 900 of FIG. 9A.

The search protocols that are used for searching for a provider may take into account features of the consumer, such as whether they are an individual homeowner or a property manager managing multiple properties. Depending on the scenario of the search requests, different protocols might be used.

In accordance with one feature or embodiment of the invention, the consumer may have one or more actual “favorite” providers that they have used or want to use. The consumer can designate a favorite provider as disclosed herein. The consumer App will determine from the consumer profile if one or more certain providers has been designated as a favorite of the consumer. Then, in one embodiment of the invention, the protocol selects the provider using the following search process:

1) The consumer App determines the one or more favorite providers and also determines which of those providers are in an online condition and also which of those match the consumer's selected criteria (e.g., trade type, years of experience, license).

2) If such provider(s) are determined, a job request is sent to the closest matching favorite provider.

3) Wait a designated amount of time for a response. For example, in one embodiment, the system will wait 25 seconds, but shorter or longer wait times may be used. Generally, you will wait longer for a favorite provider to give them additional time to answer the job request.

4) If the closest favorite provider does not accept within the designated time (e.g., 25 second) which acts as an exclusivity period, the job request is sent to the next closest matching favorite provider, and another exclusivity period or wait period (e.g., 25 seconds) begins for that new or next provider.

5) If second or next closest does not accept within this next 25 second exclusivity period, the job request is sent to the next closest matching favorite provider with another exclusivity period or wait 25 seconds, and so on.

6) The job request pattern continues, spreading out the requests to all the record of favorite providers within a defined location radius, such as a 25 kilometer radius. In one embodiment, the map zoom level will only be used to view providers. In another embodiment, the map zoom level displayed on the consumer's device might be used for the search radius. The search continues until the job request is accepted by one of the favorite providers with an open request.

7) If no favorite providers are available or do not accept during the exclusivity period, then the system determines the rest of the providers that are in an online condition and which match the consumer selected criteria. As such, the protocol will continue is the fashion as noted herein for standard providers not given favorite status.

8) Send the job request to the closest matching provider.

9) This job request pattern continues, spreading out the requests to all the record of providers within a defined location radius or to the map zoom level displayed on the consumer's device, until the job request is accepted by one of the favorite or standard providers with an open request.

10) Each of the job requests from a consumer that is seeking a match stays open for a period of time (e.g., 5 minutes for each provider) before that particular consumer's request times out.

In accordance with another embodiment invention, a search protocol may be tailored for a managed property as disclosed herein. Specifically, a property manager may create one or more networks of providers that will have priority in providing a service for a job at the managed property. As disclosed herein, a property manager may invite one or more of the providers, such as through and in-App invitation, e.g. using a special code, to join a network associated with their managed property. For example, an in-house network might be created, and a preferred network might be created as well as other networks as disclosed herein. Then, in a search protocol, a search request is made to one network, and then later to another network if multiple networks have been set up and selected, and then to further networks as necessary to obtain a provider. In that way, the property manager can make sure that certain providers in their network are given priority for jobs.

One network, such as an in-house network, may include specific employees of the property manager. As such, they may be given highest priority in a search. A preferred network might be the next tier wherein certain preferred service providers will get priority. Thereafter, if the search is not fulfilled with a provider, the search may proceed to an open network which may include all other available providers. For example, as discussed herein, through an open network search, the search request might go first to favorite providers and then to other providers in a series of timed search steps as disclosed. The networks create exclusivity in a search if the network is the only one selected. For example, if the property manager sends a request to an in-house network only, the search will not push out past that particular network of providers into a preferred or open network to obtain a provider. If the property manager sent the request to the in-house network and open network, the request will first hit all available providers in the in-house network, and then go to the available providers in the open network if the search has not been picked up by an in-house provider. The search will thus depend on what network a property manager has selected for the job request. Using the protocol noted above, for example, when an in-house network is selected for a job provider search, the search protocol will proceed as noted in the protocol for only those providers that are in the in-house network. If one is found suitable for the search criteria, the search ends. If not, the search might progress on if other networks are set up and activated. The search might proceed next to the preferred network and would follow the listed protocol using only preferred providers in the network until a provider was found or the search protocol is exhausted or times out. Then if the selected network searches are exhausted, the search might proceed to an open network search and proceed as noted above for all available and on-line providers. That is, the search will proceed according to the noted protocol but will use the networks to limit the providers that are searched.

When setting up network as disclosed herein, providers may be asked to join certain networks for certain services they offer. Therefore, there may be a network associated for each of the services that could be searched. In another embodiment, specific networks may be set up for each property that is managed by property manager. That is, the property manager can approve a service provider selectively for certain networks associated with certain properties or associated with certain services that are to be provided. Alternatively, a network might be set up for all jobs that may pass through a property manager.

When a search is to be made, and the property manager has to approve the process, the property manager can designate which networks will be utilized in a search. That is, they can selectively activate certain networks. If no network has been set up, the search would just proceed in an open network fashion as discussed herein with respect to giving priority to any favorite providers and then to other providers as the search protocol proceeds. That is, it may start with favorites and then proceed with other providers within 1 mile, 10 miles, 50 miles, etc.

By selectively activating certain networks the property manager can tailor the search hierarchy for different services, different properties, and even different locations for property. For example, to provide a plumbing service, the property manager might only activate the preferred network so that preferred providers in that network receive priority. For a particular property location, the property manager might activate only an in-house network and so only in-house providers or employees of the property manager are given priority in the search. Also, if a certain property is within a geographical location, such as a city, all the properties in that city might have their own networks and search protocol as selected by the property manager. For example, for a city, the in-house network and then preferred network might be activated and so the search priority will proceed to all in-house providers, and then if none are found it will proceed to the preferred network of providers.

FIGS. 5K-5M illustrate an alternative search workflow in accordance with an embodiment of the invention wherein networks of the consumer as well as individual expertise and badging of the providers is taken into account. Specifically, when a job request is made 500, then a determination is made at 501 with respect to whether the consumer has one or more networks. If the consumer has networks, the flow might proceed through path 502. If not, the flow might proceed through path 504. To reach the various paths, determinations are made with respect to whether the job request requires a particular badge or particular expertise by the provider as illustrated in block 506 and throughout the flow of FIGS. 5K-5M. The job request is sent to various different providers in the hierarchy as shown in the figures with preference given to in-house providers such as in block 508 and then to preferred providers is in block 510.

Also, as illustrated in block 508, the requested badge is taken into account for a service provider as disclosed herein. If there is not a matching badge for a particular service provider as illustrated in block 508, the search request might be passed on to providers that have a comparable badge, such as for providers that may install a particular product, just not the particular brand noted in the requested badge, as shown in block 512. As noted in the flow of FIG. 5K, if the job is accepted through any of the various search protocol layers, normal job flow resumes as shown in path 514. In that way, for a consumer that has a network with in-house providers or preferred providers, the job request is provided through the various distance radius as disclosed.

If such a job request is sent and the options exhausted prior to the provider accepting as illustrated in FIG. 5K, flow might proceed as illustrated in FIGS. 5L and 5M for all providers through a hierarchy of providers based on distance or whether they are favorite providers. For example, as illustrated in block 520, close providers may receive the job request first and then favorite providers as illustrated in block 522. In each of the flow paths, if the job request requires a badge, the flow might be altered and directed to those providers that have matching or comparable bandages as illustrated in FIGS. 5L and 5M. FIGS. 5L and 5M illustrate the flow path when the consumer does not have networks and also illustrates the flow path, coming from FIG. 5K wherein a network provider has not accepted the job. As illustrated further in FIG. 5M, when very close or favorite providers have not accepted, the flow may proceed as illustrated in FIG. 5M wherein the radius of the providers is sequentially increased. For example, as shown in FIG. 5M, through blocks 524, 526, 528 and 530, the radius might be increased for the job search to try and get an accepting provider. As illustrated in FIG. 5M, at various junctures, if a badge is part of the job request then the flow will be redirected to such providers based upon matching badges or comparable badges within a certain job radius from the property. As noted, once a job is accepted at the various juncture points, the workflow will resume as described herein.

Generally, when a consumer that is a home owner orders a job, they complete the search process and move to an active job as disclosed herein. However, in accordance with another feature of the invention, the property might be a managed property and the consumer is a resident of that property, not the owner. A consumer entity requesting service as a resident, will need approval as shown in the flow of FIG. 5B. Referring to FIG. 9L, if the particular property that has been selected is one that is managed by someone else and also requires approval, the system contacts the property manager (PM) and seeks the necessary approval. To that end, the screen 980 as shown in FIG. 9L is presented to the resident consumer. Screen 980 informs the resident of the approval process through an appropriate message field 981 and also allows them to cancel the job request through field 982. If the property manager accepts the job, as discussed further herein, the system informs the resident through their device, such as by information in the screen 984 as shown in FIG. 9M (see FIG. 5B). If the request is denied, the resident is also informed, such as by screen 986 as shown in FIG. 9N. As further discussed herein, the property manager may give an explanation to a resident and such extra explanation is provided to the resident to information field 988. If the request is declined, the resident's device is presented with the map ordering screen 987 as illustrated in FIG. 9O.

In accordance with another feature of the invention, the resident themselves may be a consumer and may be able to pay for the job request. As such, they would not want the job request to be canceled based upon a decline request by the property manager. To that end, disclosed further herein, the property manager has the ability to shift the cost responsibility to the resident. Therefore, the request can be conditionally approved but responsibility shifted. To that end, the resident is presented with information that the cost to responsibility his been shifted. As illustrated in screen 988 of FIG. 9P. The resident is then given the ability to cancel the job through field 989 or to proceed and switch payment through field 990. Screen 991 of FIG. 9Q is then presented to the resident and through the fields 992 an existing payment method may be selected, or another credit card might be added depending upon the resident's profile. After payment has been arranged, the job requests can be canceled as discussed or submitted via field 993 in order to find a provider. If the job request is to proceed, based upon the approval by the property manager or based upon the resident taking over payment responsibility, it will proceed in a normal fashion as described herein with the search and selection of a provider.

A consumer that is a property manager (PM) will generally be running a consumer App on their device. To that end, the system will facilitate communication between a resident on the consumer App on their device and a property manager with a consumer App on the device of the property manager. When a job is requested by a resident, the consumer App of the residents sends information and data regarding the request to the consumer App of the PM through the service system and servers via the connecting network. Herein, those consumer applications will be referred to as “resident application” and “PM application”.

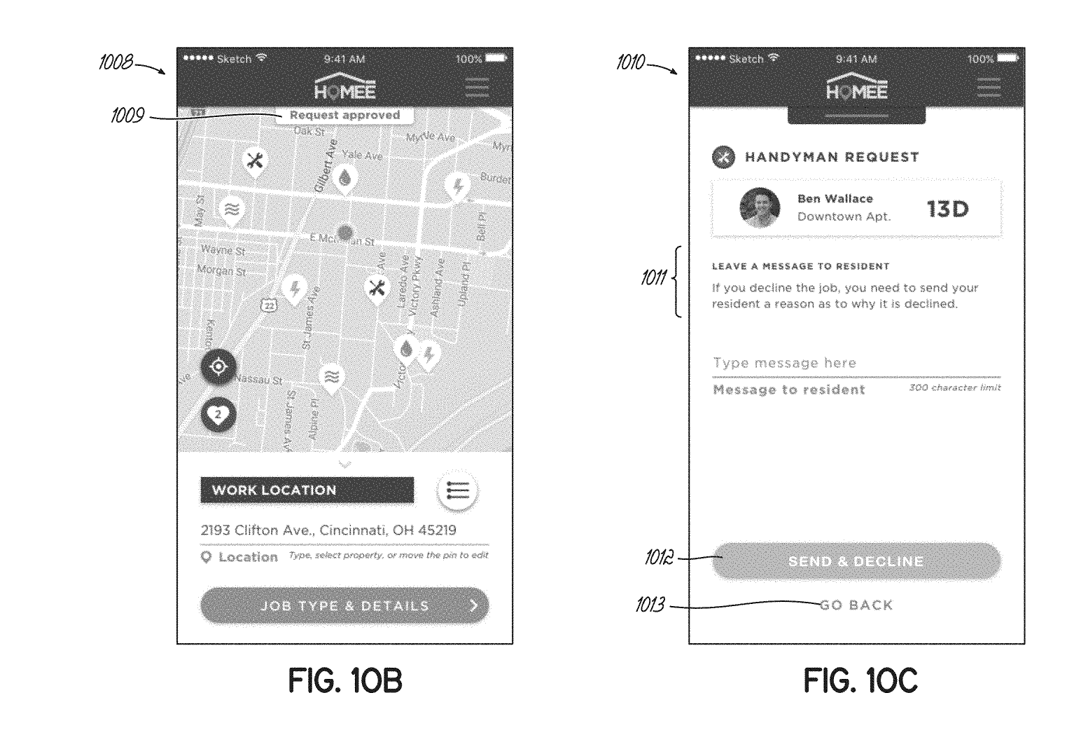

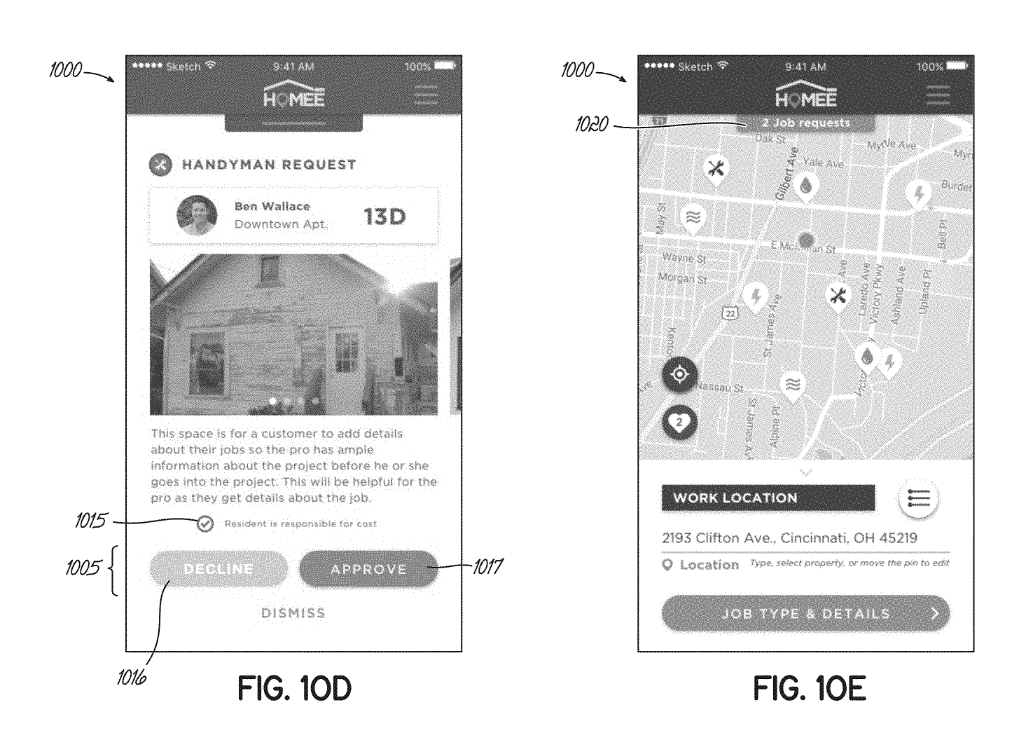

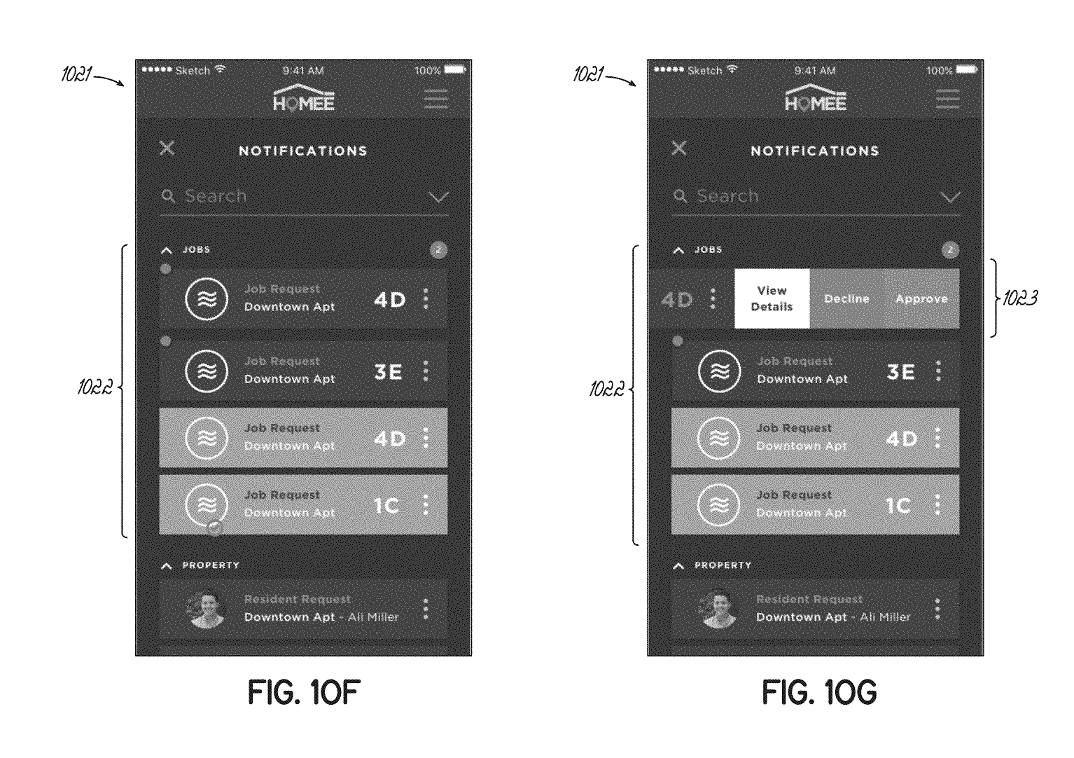

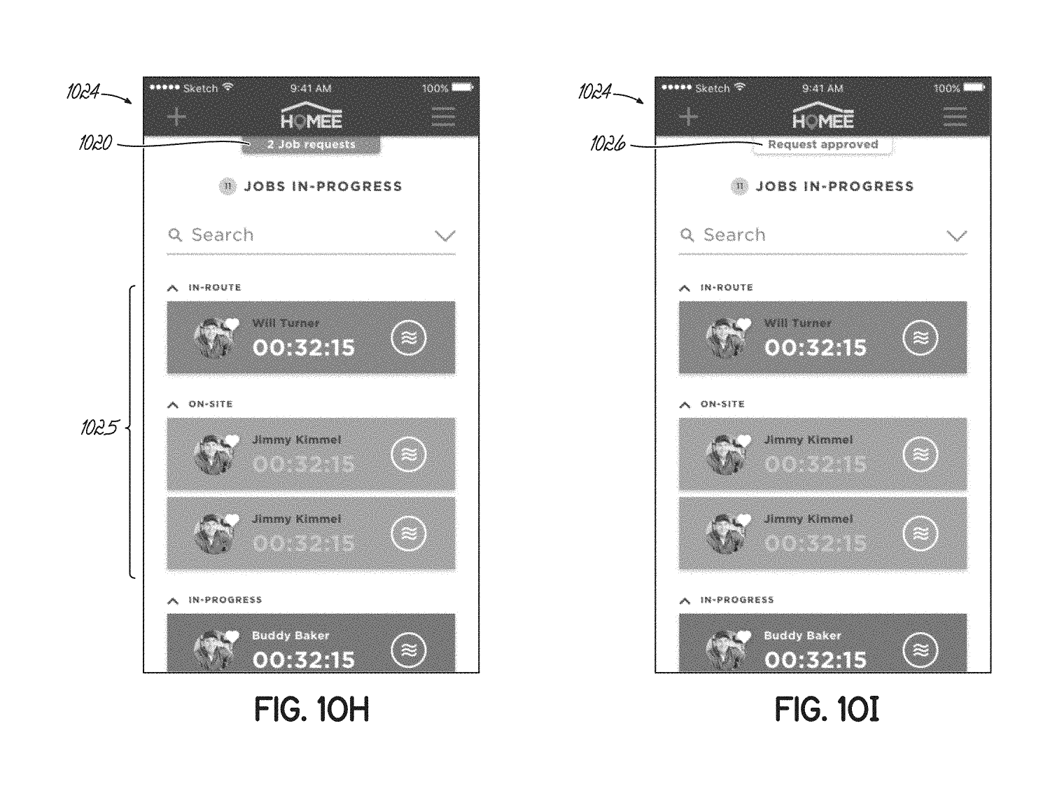

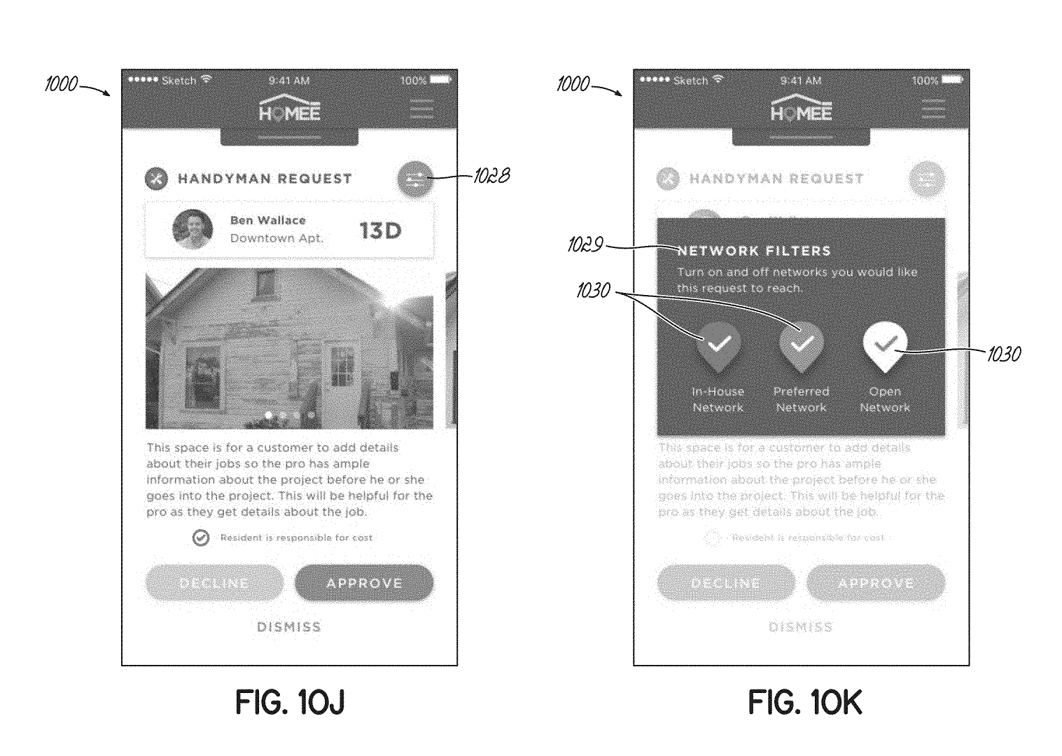

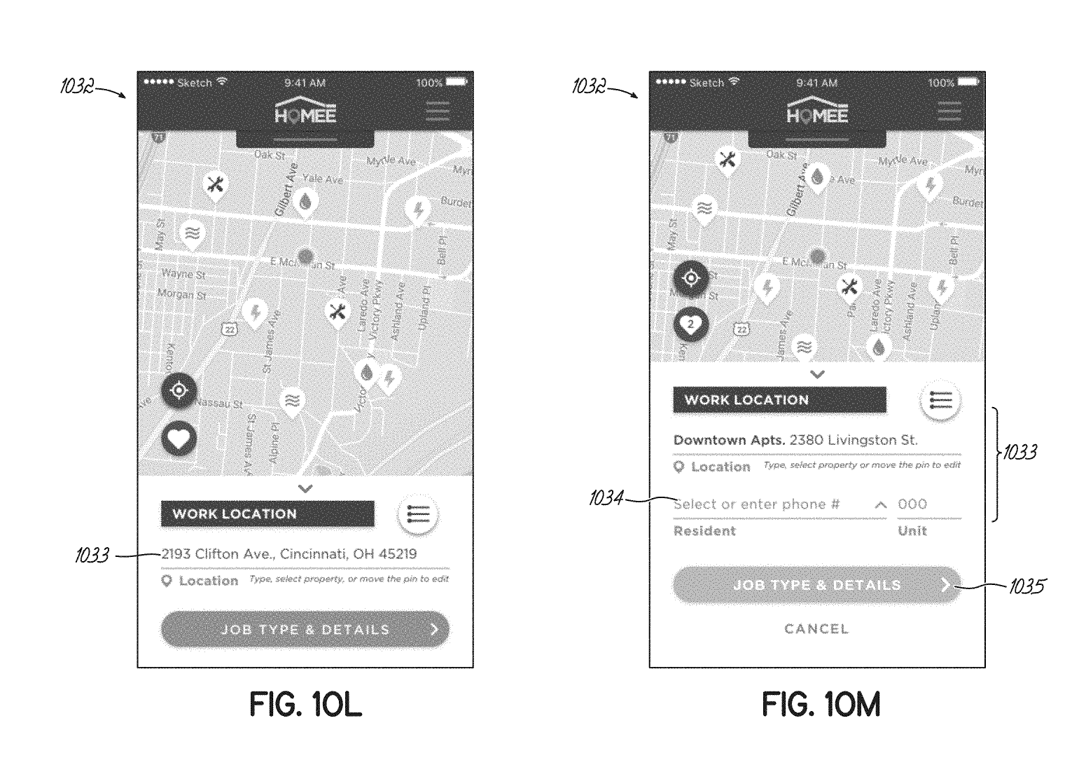

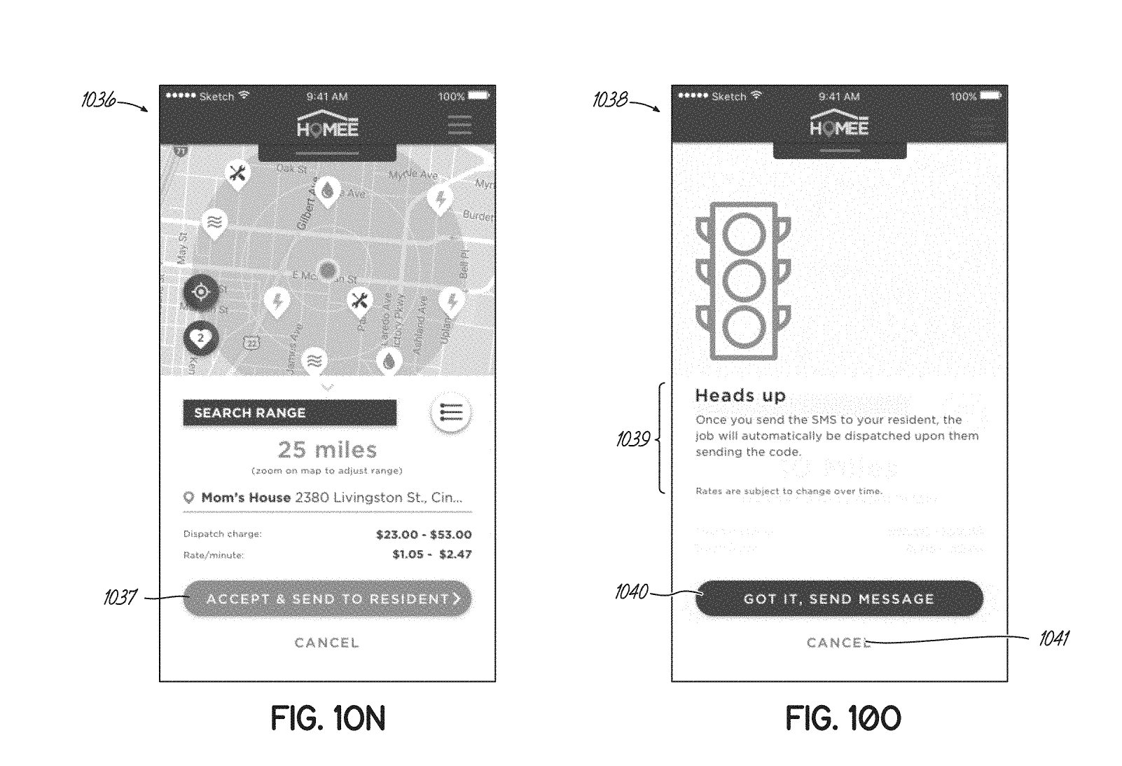

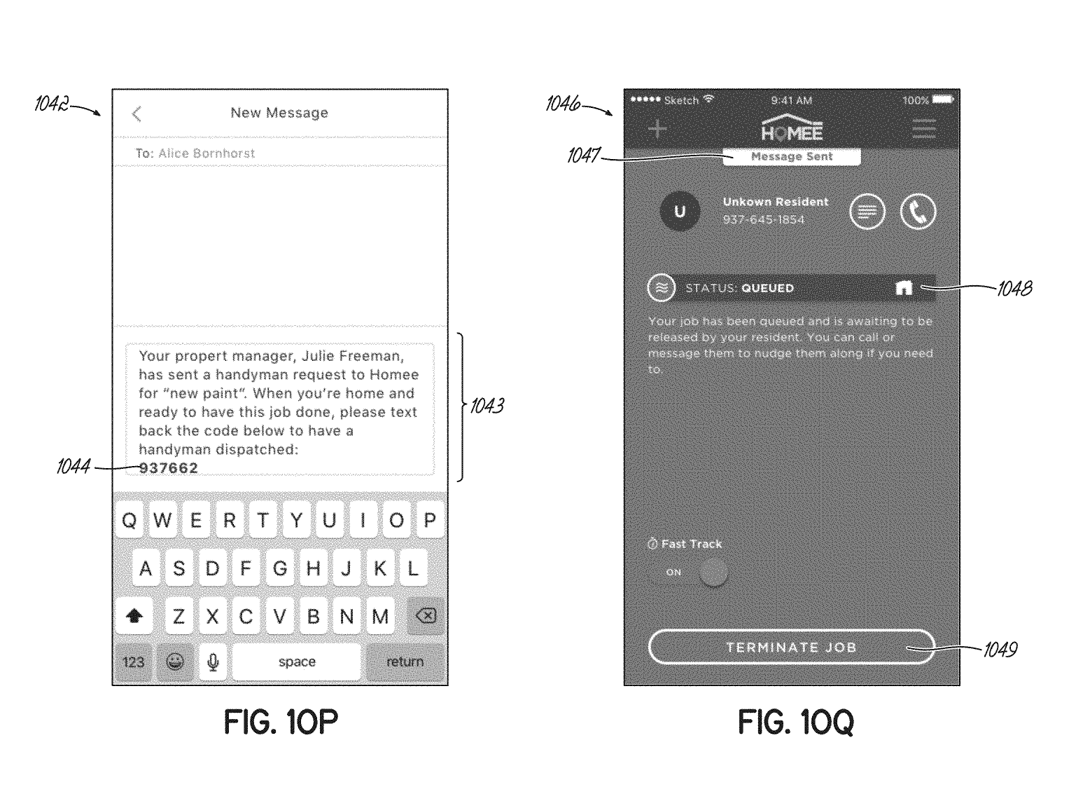

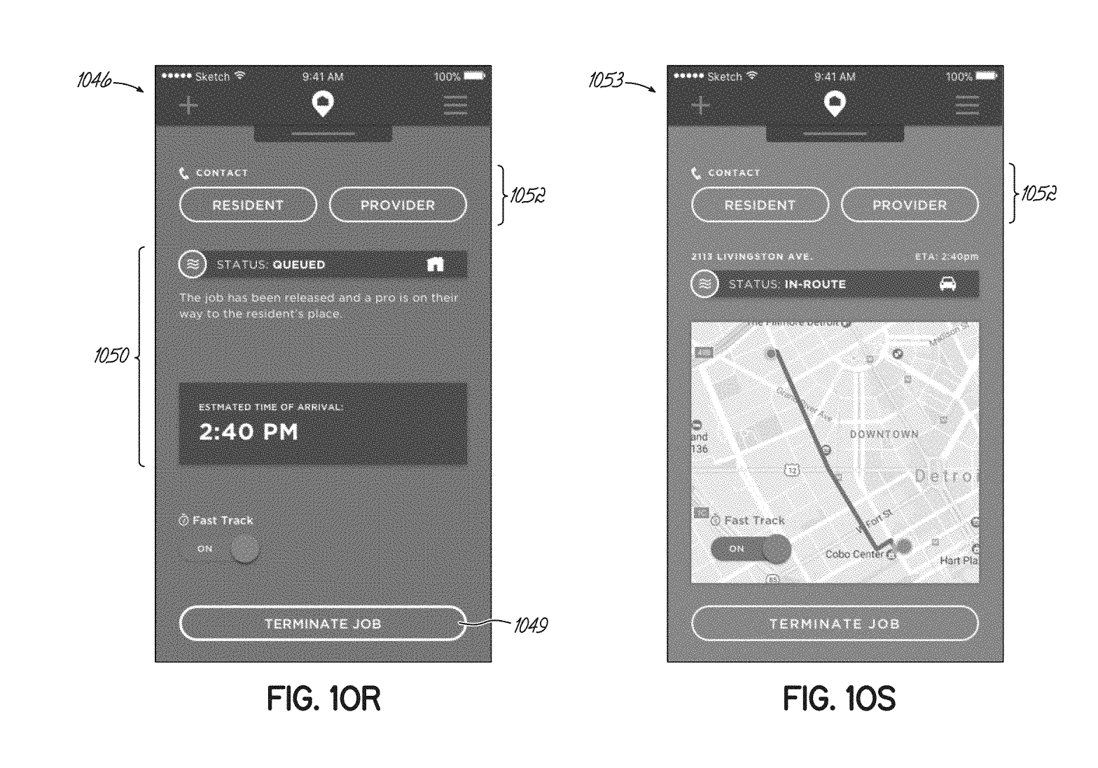

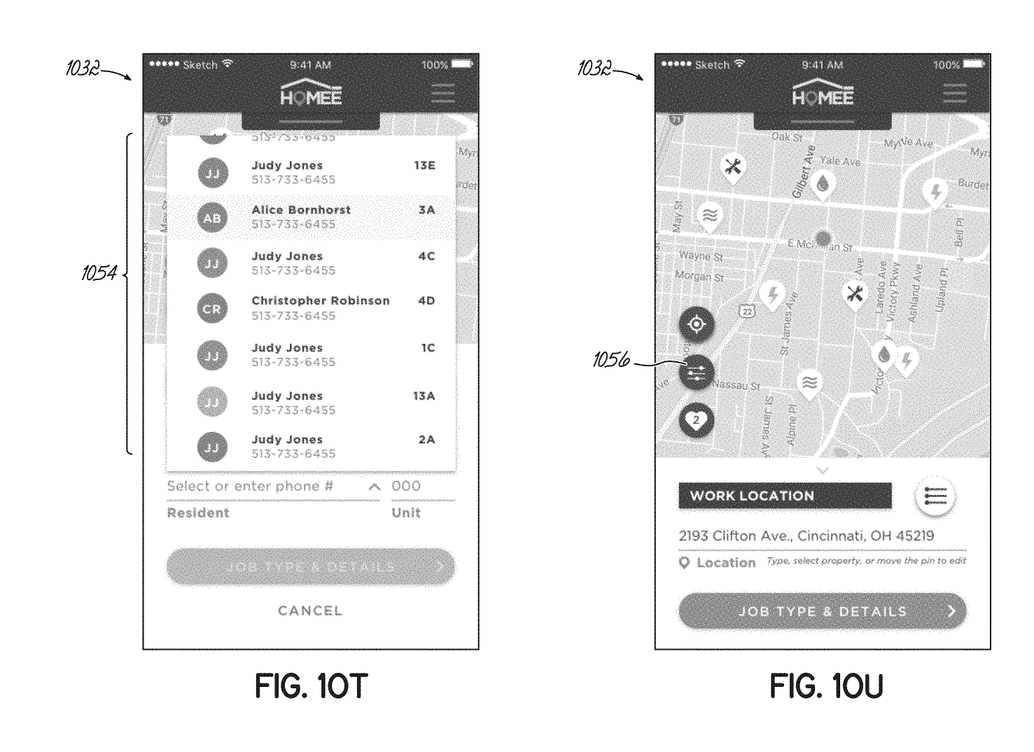

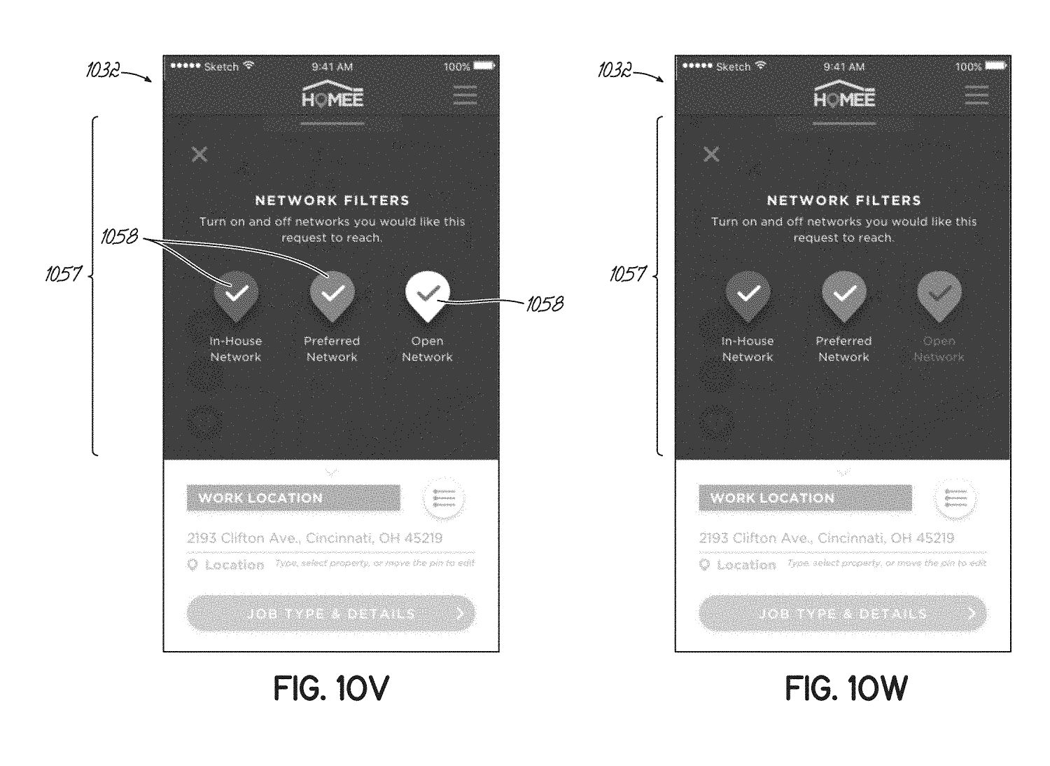

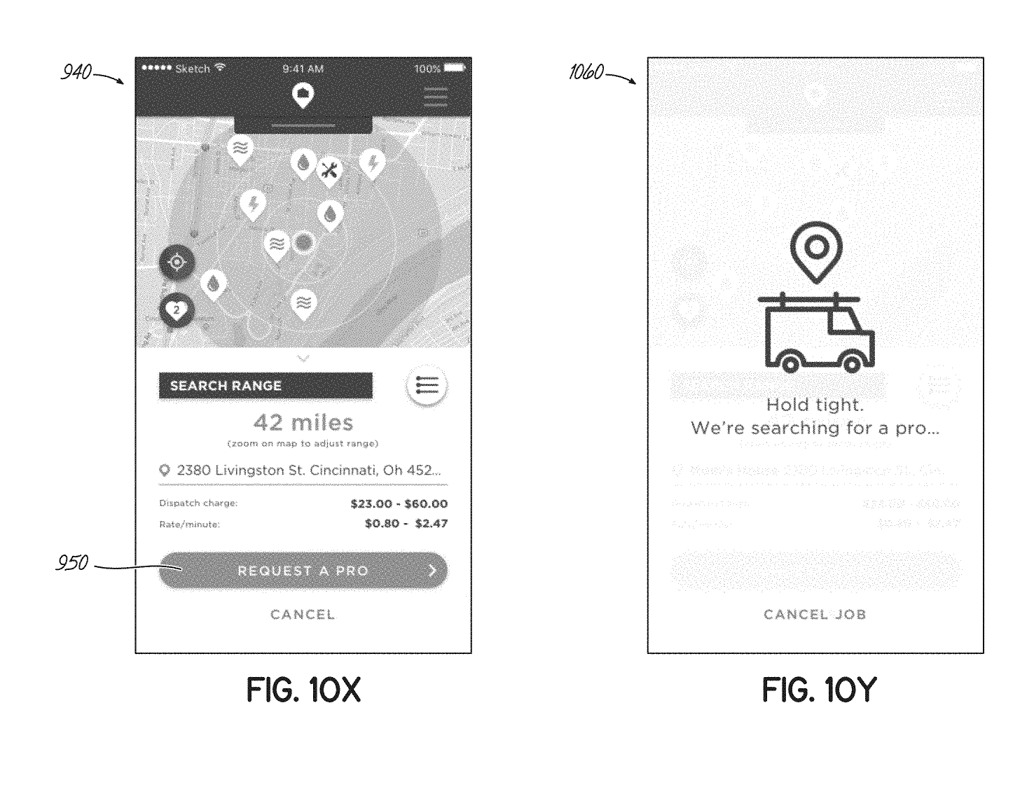

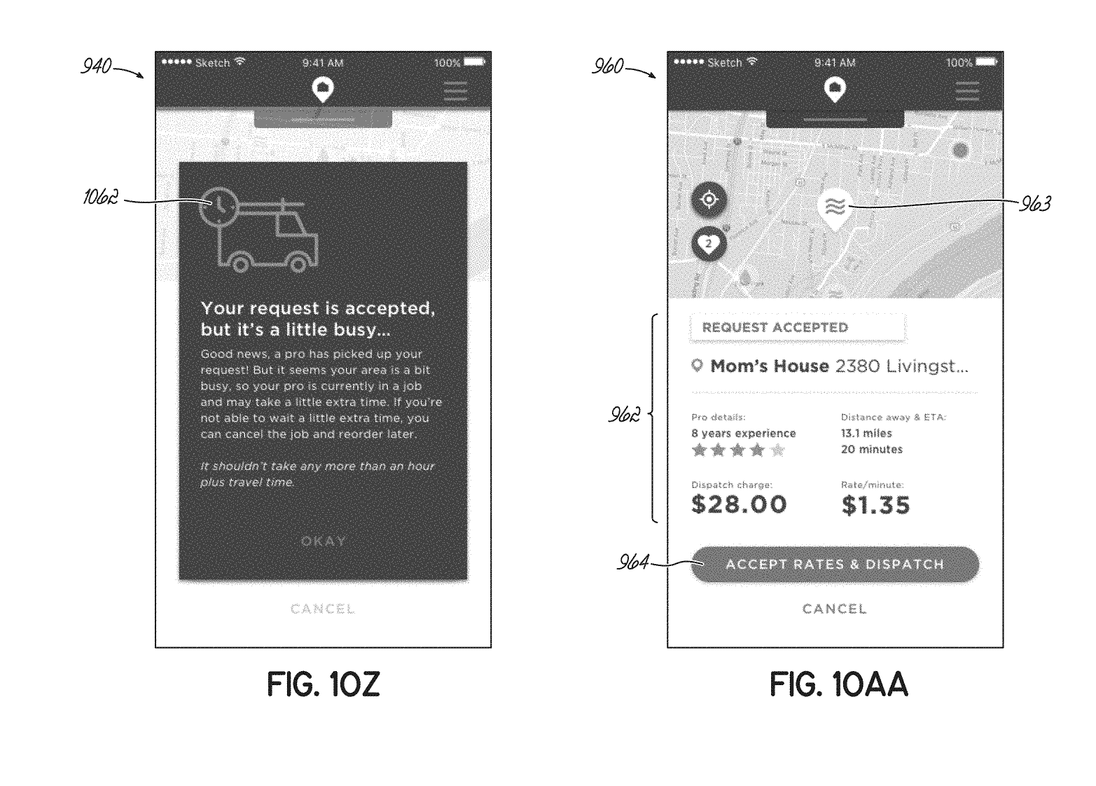

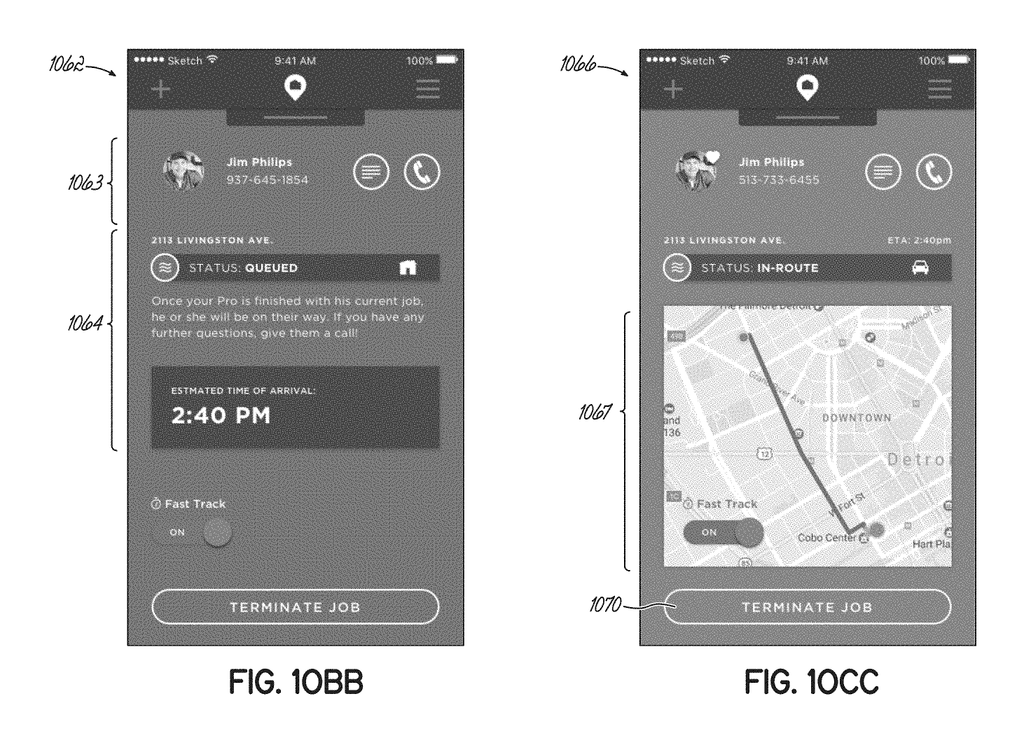

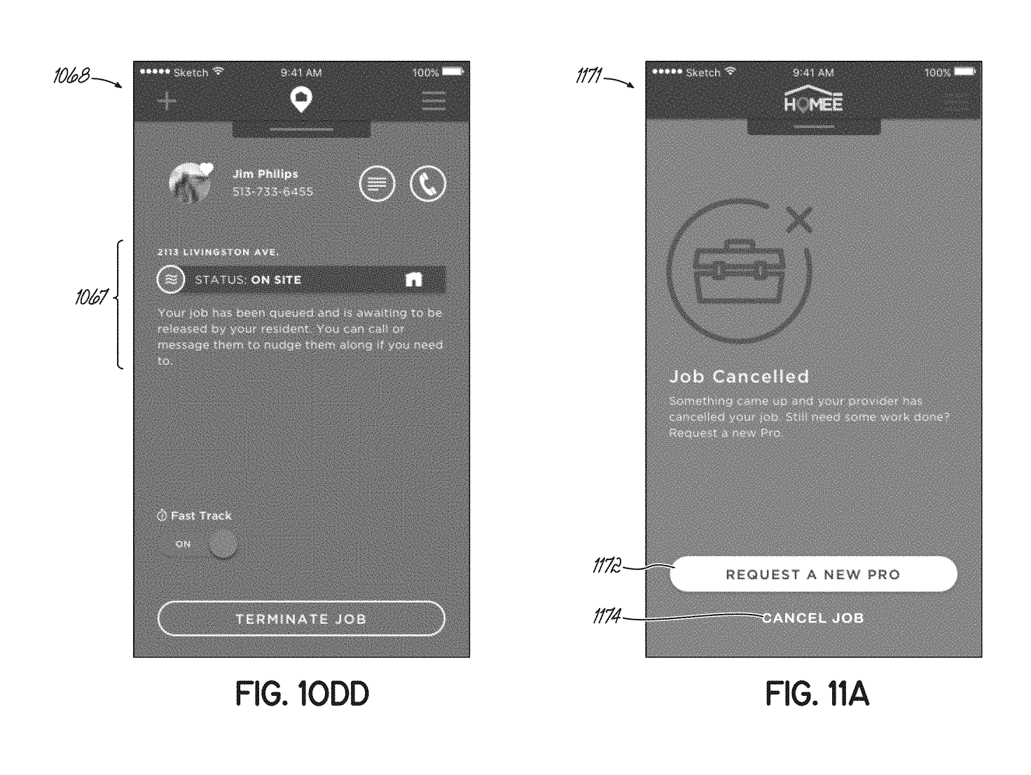

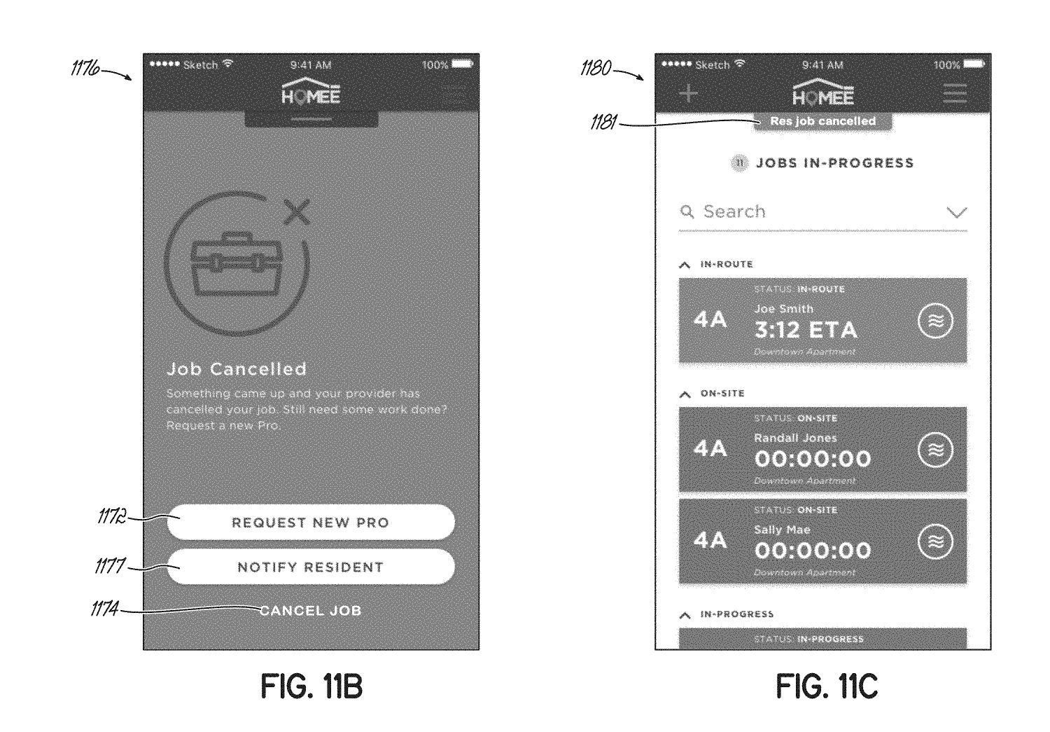

Referring to FIG. 10A, screen 1000 is presented to a PM providing information about a requested job for a managed property. Fields 1002 include information regarding the property associated with the job request as well as the type of job that is requested. Furthermore, field 1002 also includes information regarding the resident who is requesting the job. Fields 1003, 1004 provide the notes and photographs that are associated with the job request as entered by the resident. By tapping on one of those fields, such as the photo field, additional photos might be illustrated, such as by being swiped through in an appropriate field. As discussed herein, the invention gives the property manager the ability to approve or decline a requested job from a resident (see FIG. 5B). Fields 1005 can be selected as appropriate based upon the decision of the PM. The job request can be dismissed through field 1006, and no notification will be provided to the resident application and the job request will be left unresolved. If the job requested from a resident is approved, the PM application will return to a map screen such as screen field 1008 as illustrated in FIG. 10B and a message 1009 might be provided to indicate approval. The resident application can then proceed as discussed herein.

However, if the property manager decides to decline the job request as shown by screen 1010 in FIG. 10C, through field 1011 property managers are given the ability to include a message with the decline of the job request. The message can be optional or can be mandatory within the PM application. Field 1012 is provided for selection by the property manager to send the decline indication along with the noted message. Field 1012 may not be selectable until a message is entered if a message is mandatory. If the PM changes their mind and decides to approve a job request or for other reasons wants to return to screen 1000 of FIG. 10A, they can select field 1013. After the decline indication is sent, the PM application will return to a map screen similar to the screen as illustrated in FIG. 10B, albeit with a different message in field 1009 indicating that the job request from the resident has been declined.

As discussed herein, for jobs requested by a resident, the property manager may also shift responsibility for the cost of such a job request. To that end, as illustrated in the screen of FIG. 10D, field 1015 might be engaged or checked for indicating that the resident is responsible for the cost. If that is selected, the ability and field of the property manager to decline is removed such that field 1016 is not selectable but field 1017 is. This is a conditional approval. Then upon approval the PM application will inform the consumer application through the system and as noted FIGS. 9P and 9Q the resident has to address the cost aspects of the job. Again, upon approval the property manager is presented with screen 1008 is shown in FIG. 10B.

As may be appreciated, the property manager may be managing property for a number of residents and thus may receive a number of job requests from different residents. Referring to 10E through screen 1000, the PM application upon receiving multiple requests may provide a message 1020 of a plurality of job requests. Field 1020 may also be engaged for showing the various job request. Referring to FIG. 10F, screen 1021 is presented as a drop-down screen from field 1020 and shows a list of fields 1022 illustrating the various job requests. Newer notifications of job requests might be indicated, since by being listed on top or marked in some other way to indicate to the property manager that they are newer. Also, indications might be provided in the various fields 1022 to indicate that they have not yet been opened or addressed. Each of the fields in the list 1022 may be engaged. Upon engaging the field for a specific job request additional information may be selected. For example, as illustrated in FIG. 10G, a plurality of fields 1023 may be presented for the job request. The PM application will allow the property manager to see the associated details for job request, such as notes and photographs and also to decline or approve the job request directly from the fields 1023 in list 1022. The selectable subfields may be individually engaged as shown in 1023 of FIG. 10G. Again, upon declining or approving, the PM application will return the screen of a device to that illustrated in FIG. 10B.

Referring to FIG. 10H, if multiple job requests come from a resident and there are currently ongoing jobs as viewed by menu screen 1024 of FIG. 10H, the message field 1020 is presented. The PM application provides a menu list 1025 of jobs that are in progress or in various other stages as provided by the statuses of list 1025, such as in-progress, on-site, and in-route as illustrated on screen 1024 shown in FIG. 10H. An engageable message field 1020 as illustrated might be engaged to then provide a list of various job requests as shown in FIGS. 10F and 10G. One or more can be selected and then declined or approved as described herein. Then, depending upon whether one or more jobs are approved or declined, the consumer application flow would return to FIG. 10H. If the job was approved, a message field might be provided of an approval or a decline in field 1026 is shown in FIG. 10I. As described herein, if the job request is declined information might be required such as a message for the resident as described with respect to FIG. 10C.

As discussed further herein, a property manager may have set up various networks (see FIG. 5G). As such, upon receiving a job request from a resident, those networks might be accessed. For example, as is shown in FIG. 10J, the screen 1000 will be similar that as illustrated in FIG. 10A. However, if the PM has set up one or more networks a selectable field or button 1028 might be engaged for showing an overlay field 1029 with information regarding selectable network filters to be used in the search protocol. The field 1029 will include other selectable subfields 1030 for selecting a particular state of a network such as turning it ON or OFF. The fields 1030 may be engaged for toggling them ON and OFF in order to set up network filters that are to be used to request the search as discussed herein. By engaging some other area on screen 1000, field 1029 will disappear and the screen 1000 is presented for declining or approving the request as previously described. The filters are used for a search protocol for a job at a managed property, as disclosed herein.

In another alternative embodiment of the invention, a resident of a managed property may not be engaged with the system and thus may not be a consumer or have a device that runs the consumer App. As such, in accordance with another feature of the invention, a property manager will order for the non-user resident of a managed property as disclosed in the flow of FIG. 5C. To that end, in the PM application a screen such as that illustrated in FIG. 10L might be presented for selecting the location for job services discussed herein. Screen 1032 of FIG. 10L might include a location field 1033 that is prefilled with the property manager's current location, the field 1033 may also be engaged for entering a different location. Referring to the screen of FIG. 10M for the location field 1033, additional information through field 1034 might be required, such as the phone number of the resident as well as a unit number for the managed property listed in the address or work location field 1033. In accordance with one feature of the invention, some of the additional information of field 1034 might be mandatory and some might be optional. Whatever information is mandatory, the ability to proceed and select field 1035 for entering additional job types and details will not be selectable.

Once the mandatory information is entered, however, the job type might be selected as earlier discussed with respect to FIGS. 9A-9I. However, when the job has been arranged and it is desirable to request a provider, screen 1036 of FIG. 10N is provided through the PM application to the property manager with the field 1037 that is not simply to request a provider. Rather, as shown in FIG. 10N, field 1037 may be engaged to indicate that the property manager accepts the job parameters and is ready to send information to a resident who will then start the job on their schedule. More specifically, screen 1038 of FIG. 10O is provided as a one-time informational screen to indicate that the property manager has to have the resident approve the job so that it can be dispatched upon the resident's approval. Specifically, as shown in information field 1039, in one embodiment of the invention, the job can be dispatched upon the resident sending back a code that is sent to the resident by the property manager. Other information might also be included in the informational field 1039, such as a warning that rates are subject to change over time. Then, upon engagement with field 1040 message screen 1042 is presented that has a prefilled text message 1043 with a job code 1044 as illustrated in FIG. 10P. Once the message to the resident is sent, referring to FIG. 10Q, screen 1046 is presented to the property manager indicating that a message has been sent through informational field 1047 and also indicating through field 1048 that the job has been queued in the inventive system. Then, upon the resident texting back the code 1044, the job may be released in the system. Through the process, if the job is to be terminated field 1049 of FIG. 10Q might be engaged. Similarly, is shown in FIG. 10O, field 1041 mail out for cancellation of the job.

The resident is then in control of the starting of the queued job and when the provider will be matched with the job. Referring to FIG. 10R, once the resident releases the job such as through the message code (e.g., SMS code) the job will be indicated on the screen 1046 of the PM as a queued job with information fields such as indicating that the job has been released, and the provider is on their way and an estimated time of arrival as shown in field 1050. The PM application also interfaces with the system to gather information regarding the resident as well as the provider and provides fields 1052 for the PM to access the contact information. The job will then proceed as usual as described herein and screen 1053 as shown in FIG. 10S will be provided to the property manager allowing them to determine the status of job, the location of the provider, also to terminate the job is discussed further herein.

If the property manager has information for a number of residents entered into their profile, as illustrated in FIG. 10T, upon entering resident information for contact in field 1052, a drop-down menu field 1054 might provide a number of selectable residents that can be selected from a list as shown in FIG. 10T.

Referring to FIGS. 10U, 10V, and 10W if the property manager has provided various network filters, home screen 1032 as presented is shown in FIG. 10U, and a network button or field 1056 is provided for selecting one or more networks. Engagement of field 1056 provides a drop-down field 1057 with various engageable subfields 1058 for engagement to be selected and unselected as shown in FIG. 10V. Selected and unselected filter fields 1058 might be shown in different colors depending upon their selected or unselected state. Various networks can be selected, and a job request search will proceed with those networks as discussed herein. Field 1057 maybe then be closed as appropriate. The filters of the networks can then be used for the job request search when it is accepted and then sent to the resident for approval search and scheduling as discussed herein.

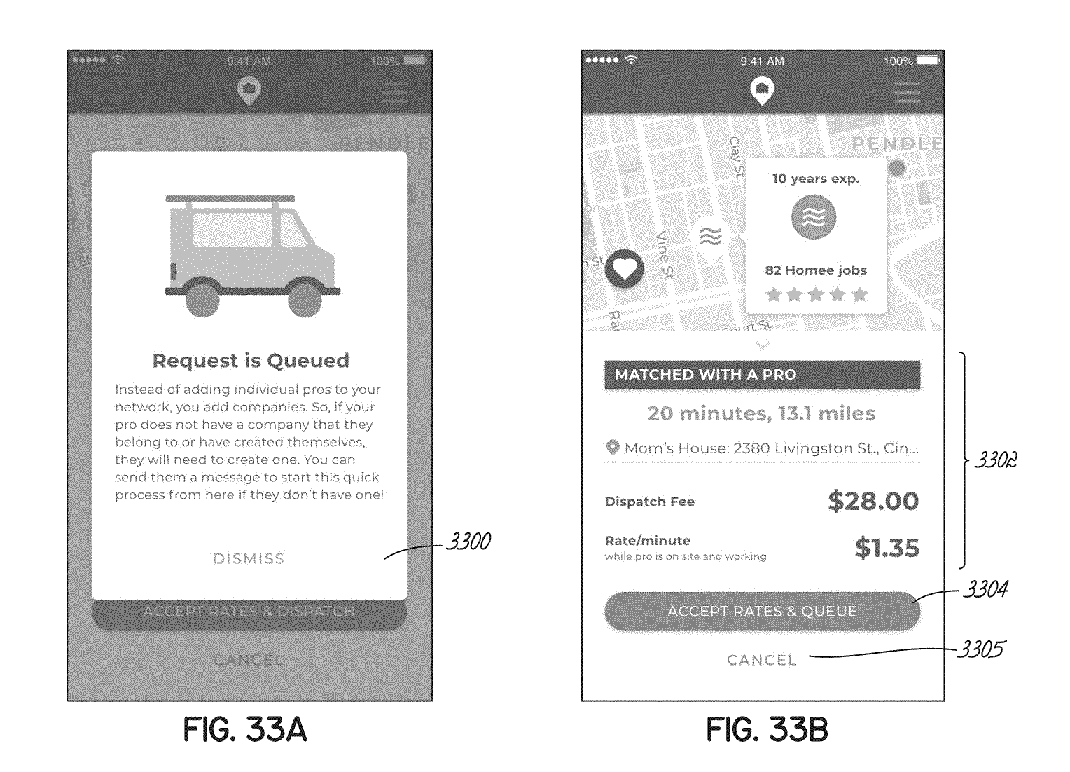

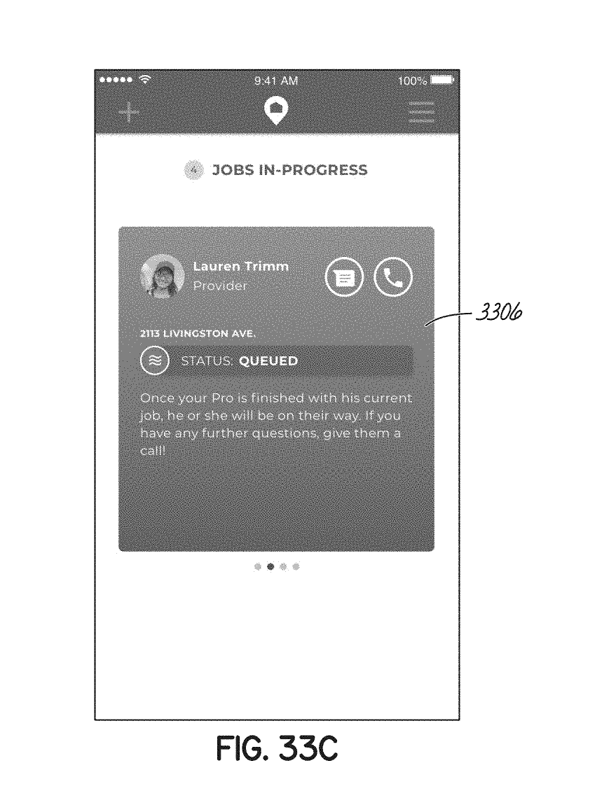

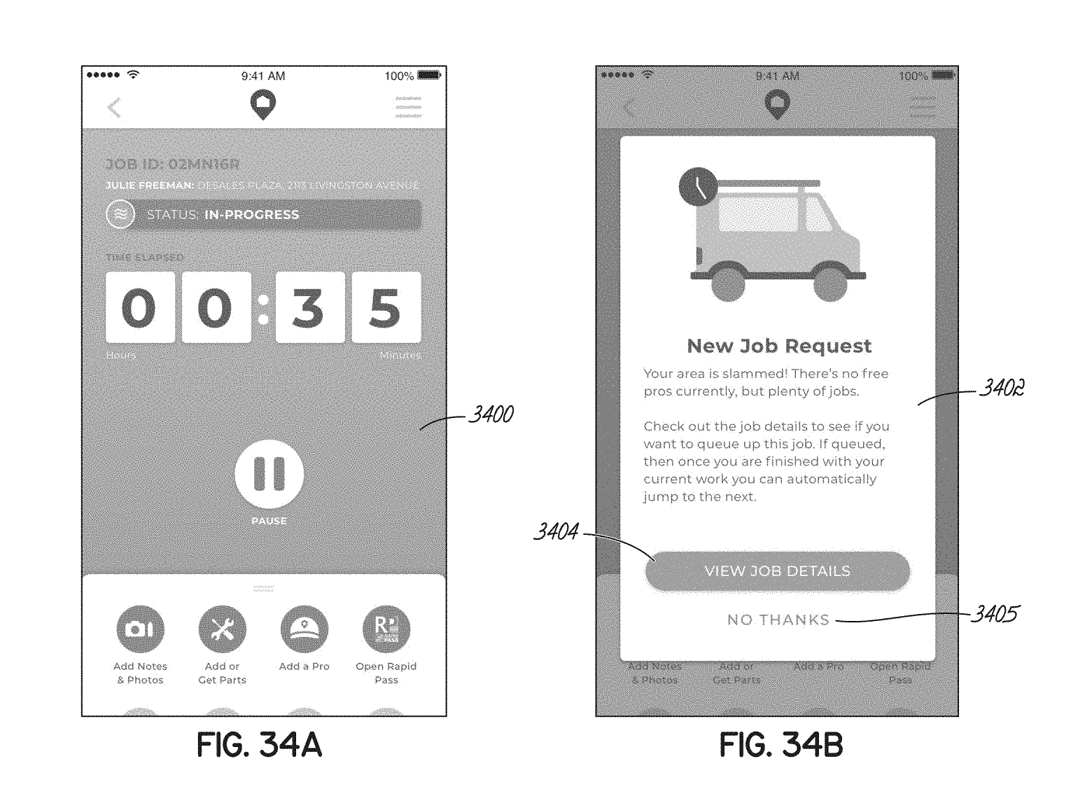

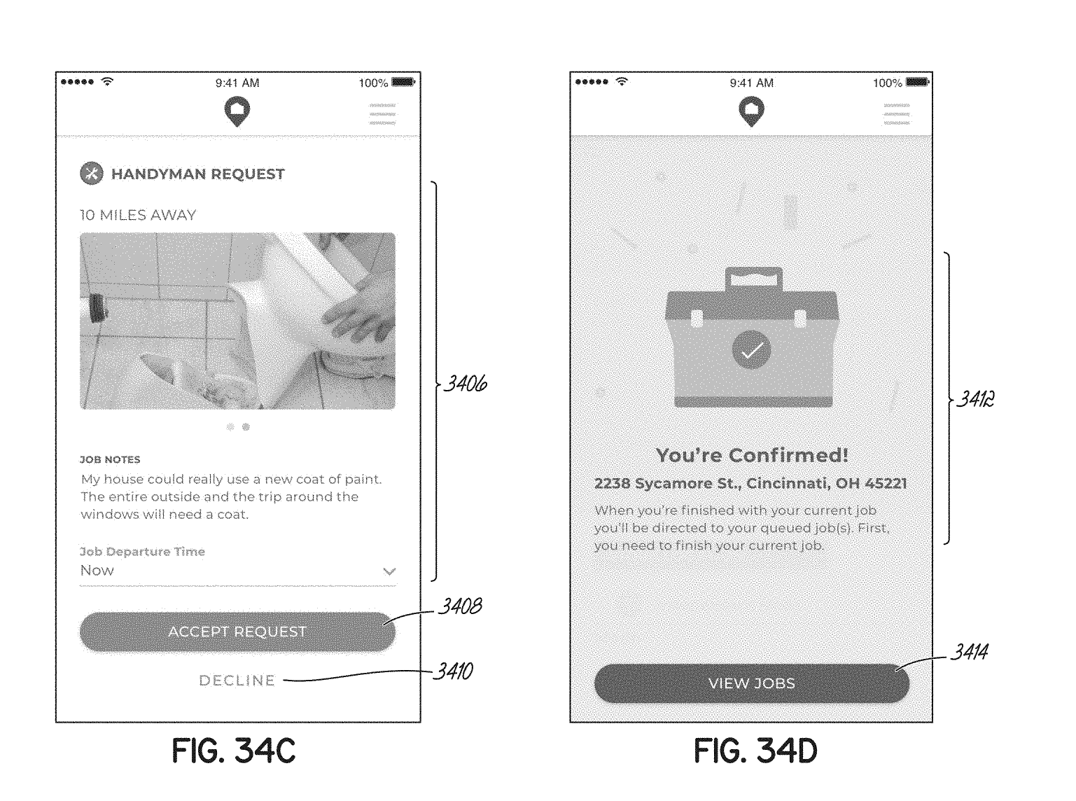

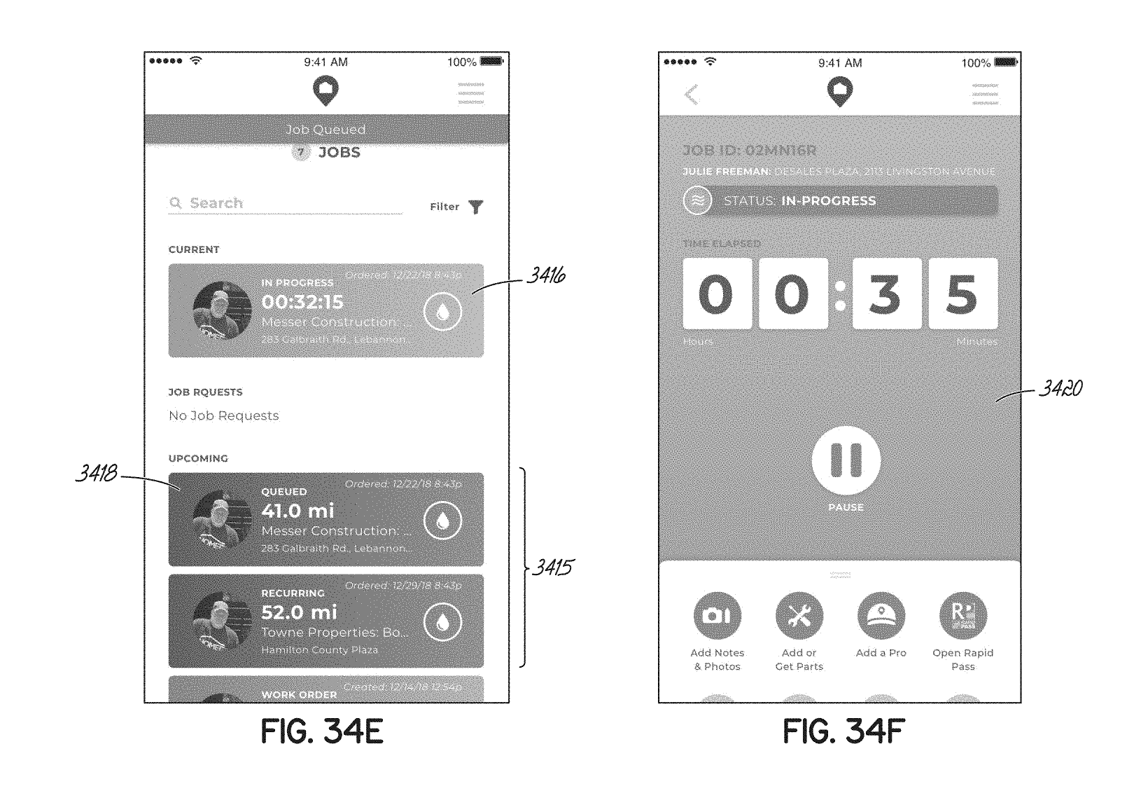

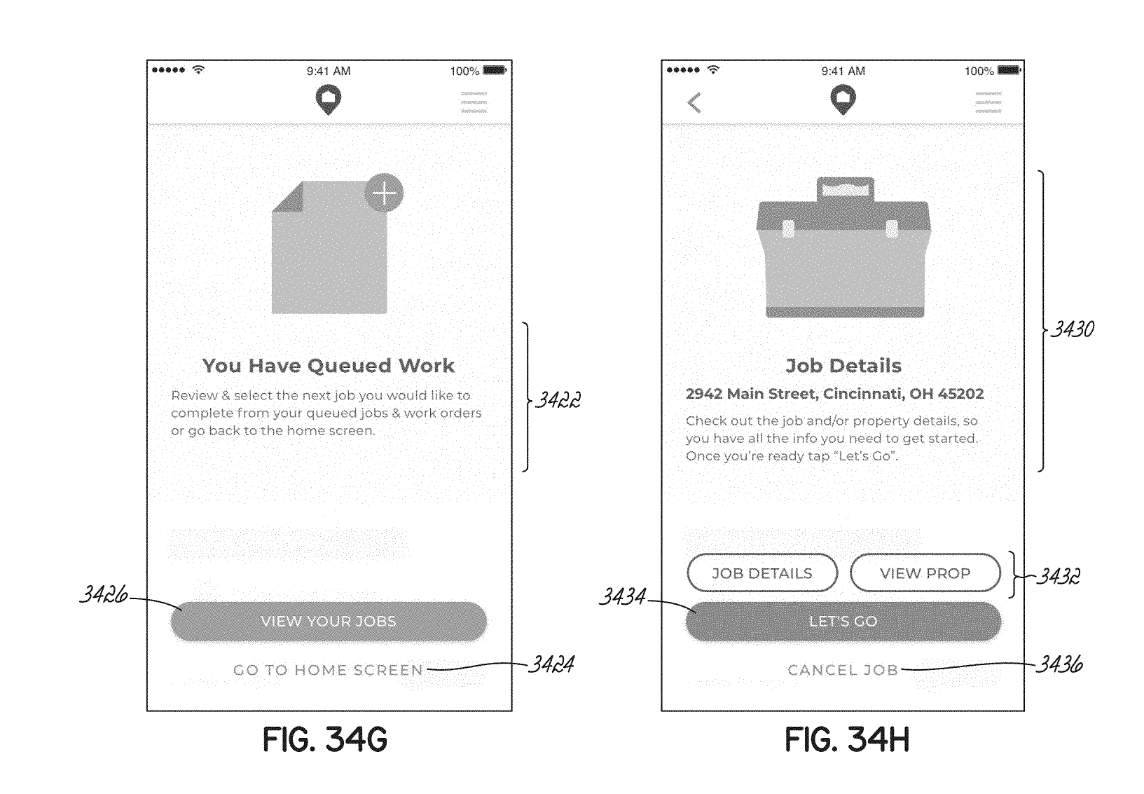

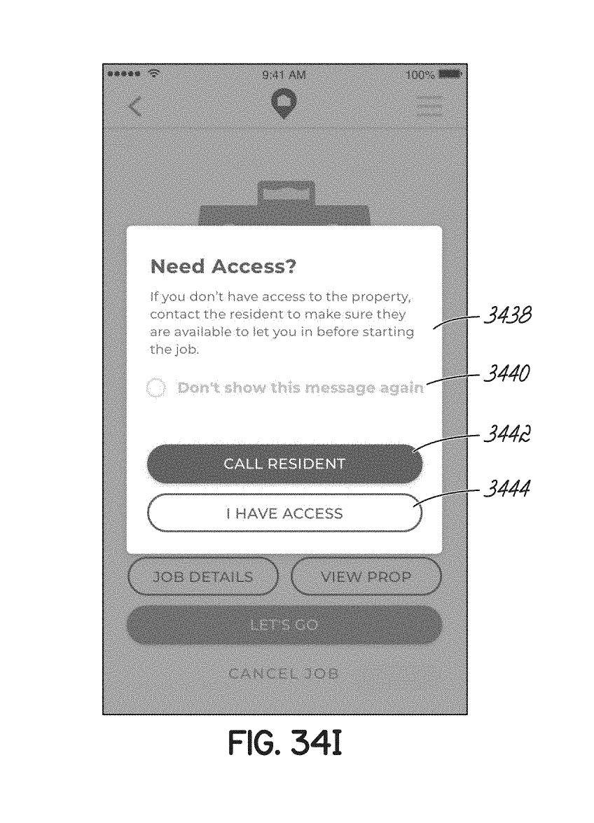

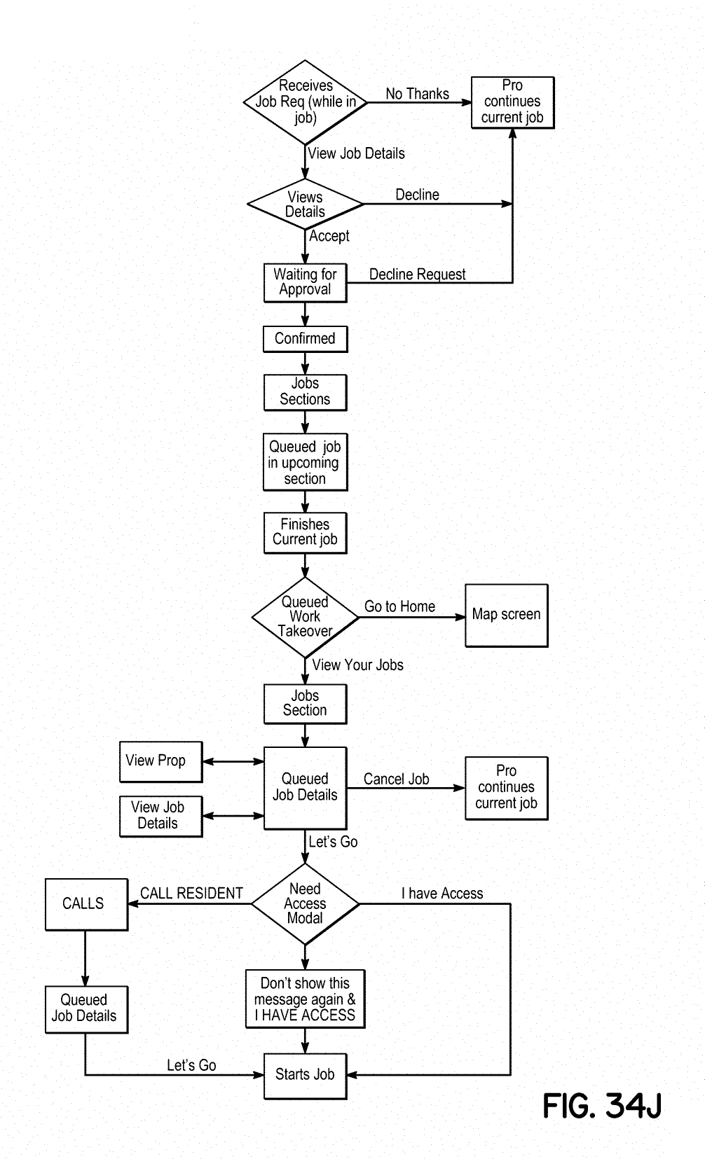

When a job is requested, and a search is underway, a situation may arise wherein a suitable provider to take a new job is already on an existing job. As such, the consumer App through the invention will put the new job in a queued status as discussed further with respect to FIGS. 33A-34J. Specifically, referring to FIG. 10X, and in reference to FIG. 9H, when a consumer is to request a provider, screen 940 as illustrated in FIG. 10X provides the rates and upon engagement of field 950 a provider may be requested, and a search undertaken using a search protocol as noted herein. As illustrated in FIG. 10Y an informational screen 1060 might indicate that the search is underway. However, if a provider that accepts a job is already on the job, another informational field 1062 might be provided to overlay screen 940 and indicate to the consumer that the provider is already on a job. Referring to screen 960 of FIG. 10AA (see also FIG. 9I) the consumer can review rate information and then except the rates and dispatch the request, such as through field 964. The job is then considered in a queued state until the provider can finish the current job. Referring to screen 1062 of FIG. 10BB informational fields 1063 and 1064 provide information associated with the provider as well as the status information for the job. Furthermore, as illustrated in FIG. 10BB, a message field explaining that the provider will be on their way to the new job upon finishing your current job. The estimated time of arrival provided in the informational fields 1064 is responsive to when the provider completes their job. The provider finishes early, the ETA will be updated as appropriate by the consumer App in the system.

Referring to FIG. 10CC and screen 1066, once the provider is finished with their current job the job will be active and proceed in a similar fashion as discussed herein with respect to FIG. 10S. As discussed further herein, other queuing functions are offered by the invention. Screen 1066 indicates that the job is activated, and the provider is still in-route as shown by status field 1067. Once the provider arrives, this status field may show that the provider is on-site as illustrated in the screen 1068 of FIG. 10DD. If the job was ordered by a resident, the resident would then have to release the job, so the provider can begin.

As illustrated in FIG. 10CC, in the provider app, the provider is given the ability, such as through field 1070 to cancel a job. The consumer must then decide if they want a new provider. Upon cancellation, screen 1171 of FIG. 10A is provided wherein the consumer can request a new provider through field 1172 or go ahead and cancel the job themselves completely through field 1174. If the consumer decides to request a new provider, they will be returned to screen such as the screen interface shown in FIG. 9G. Alternatively, if the consumer decides to cancel the job completely, such as through field 1174 a home screen or map screen such as that in screen interface shown in FIG. 9A may be presented to begin an entirely new process, if desired.

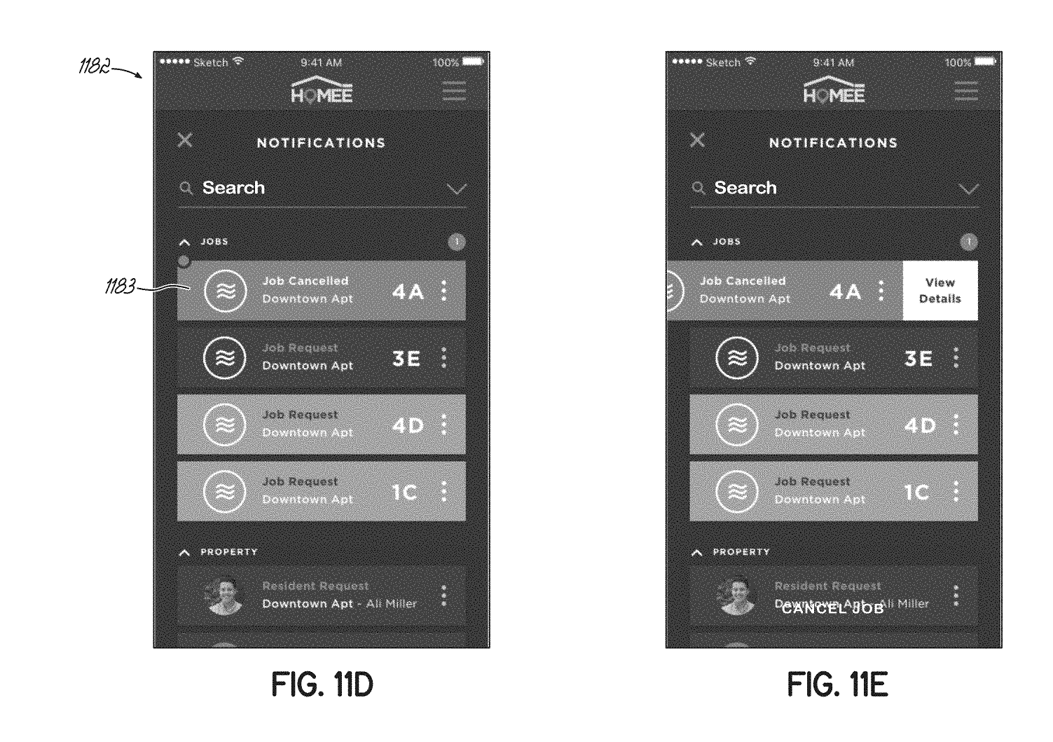

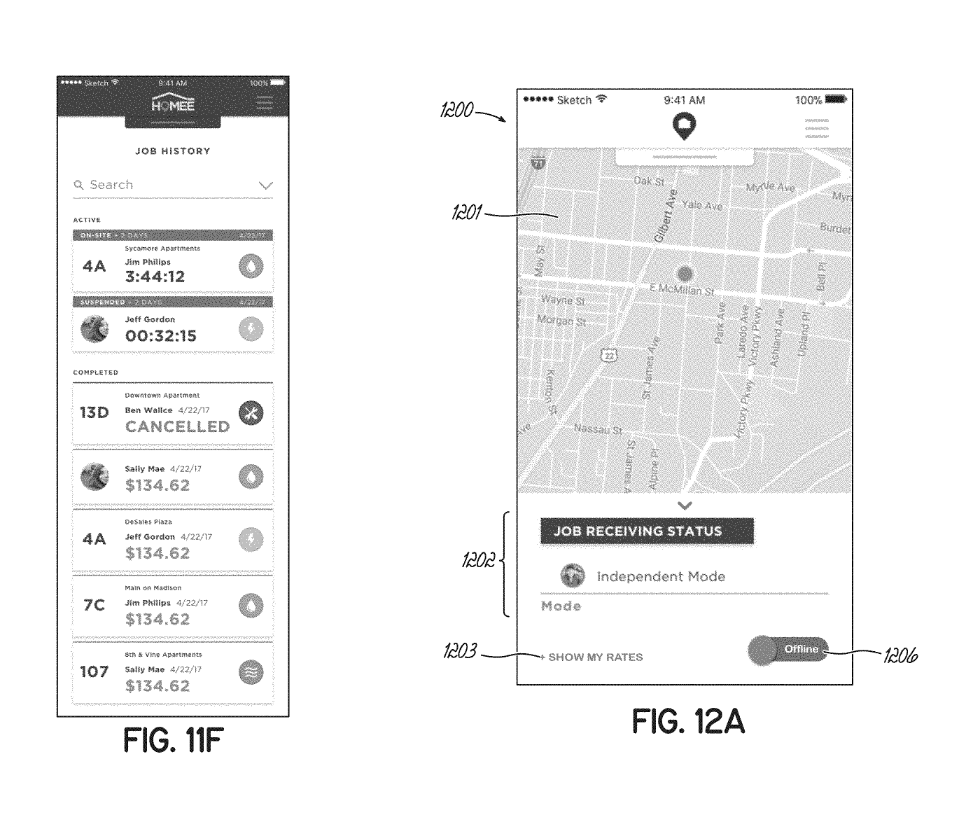

Referring to screen 1176 of FIG. 11B, if a property manager had ordered the job for a non-user resident as discussed herein they will be presented with an additional field 1177 which may be engaged for notifying a resident, such as through a message, that the job has been canceled and that they will be in touch to reschedule. A text message screen might then be provided in the property managers app for sending to a resident. The property manager may enter text, or alternatively, the system of the invention made provide a prefilled message.

In the scenario wherein, a resident's job is proceeding, such as through the approval of a property manager as discussed herein, the property manager will have access to the various active jobs that are proceeding, such as through menu screens as illustrated in FIGS. 10H and 101. Upon cancellation of one of the active jobs, as shown in FIG. 11C and screen 1180, an engageable message field 1181 might notify the property manager that a job has been canceled. Tapping upon that field will then reveal various notifications associated with jobs that are in progress. For example, field 1181 might be a drawer field that will open to various notifications associated with jobs that the property manager has approved. For example, referring to screen interface 1182 as illustrated in FIG. 11D, a cancellation is indicated at field 1183, which may be engaged such as by touch to then see various details of the canceled job as illustrated in the job listing screens of FIGS. 11E and 11F showing the noted details. For example, the details might be illustrated through a job history screen as shown in FIG. 11F.

In accordance with one aspect of the system, a job request is sent through the system which provides that job request to a number of different providers, and the job request is selected and controlled by the consumer as disclosed herein. The providers, upon receiving the job request can accept the request and then begin the job workflow according to other features of invention. The consumer App may be run by and associated with a homeowner, a resident of a manager property, or a property manager.

As disclosed herein, a provider made work on their own as an independent provider or as an employee of a larger company. Still further, the provider might be a company owner or employer of other service providers. An employer can also work as a service provider themselves. As such, the acceptance of the job request may proceed in different paths as discussed herein. Referring to FIG. 12A, if the provider is independent or an employee they may operate in a particular mode for receiving a job. For example, as illustrated in the screen of FIG. 12A field 1202 may indicate the job receiving status of the provider, such as an independent mode. Field 1202 may be a drop-down field for picking the mode of provider. See FIG. 12Y, for example. Job receiving status field 1202 thus provides a drop-down capability such as to change the mode from independent mode to employee mode if desired. If the provider does not belong to a company, they will only have the independent mode available. If the provider wants to see their current rates, they can engage field 1203 in which case a field 1204 might show the rates for different services as illustrated in FIG. 12B. The rates can then be hidden by engagement with field 1205. Field 1206 toggles to put a provider online to receive jobs requests or leave them off-line.

As illustrated in FIG. 12C, an informational screen 1210 might provide information to the provider that they are going online, such as for the first time. The information can explain that they should be ready to receive jobs and if they are not, then they should stay in an offline status. Engaging field 1211, the provider can dismiss the informational screen 1210. FIG. 12D indicates that the provider is in an online status as shown in field 1206. As such, and as discussed herein with respect to the job order workflow, the provider can receive job requests. Upon receiving such a job request within a search process screen 1212 of FIG. 12E, information about the job is presented such as through fields 1213 and 1214. For example, the type of service of the job request and the distance from the provider for the job location is indicated. Furthermore, the photos and text information as indicated by fields 1214 are displayed in screen 1212.

Additionally, on the screen of FIG. 12E a drop-down field 1215 is provided for indicating optional departure times if the provider cannot leave at that moment or cannot leave “now” but in some time soon. (See FIG. 12G. The service provider can then accept the job request through field 1216 or decline it through field 1217. Engaging the photograph subfield of field 1214, various photos may be reviewed and scrolled through his advocated in screen 1220 of FIG. 12F. If the drop-down field 1215 is engaged, screen 1221 is presented with drop-down job departure times as shown in the drop-down field 1222 of FIG. 12G. Once a request has been accepted, such as by engagement of field 1216, a waiting screen 1223 as shown in FIG. 12H is provided to the service provider. That is, the provider has to wait for the consumer or resident's approval as disclosed herein. If they still want to decline the request, field 1217 is still available.

Certain properties may have limits placed thereon with respect to labor costs and parts and materials. When a property is set up as a managed property as described herein, the limits may be set. Referring to FIG. 12I, upon a consumer or resident accepting the provider during the search process, the property limits information will be provided to the provider in screen 1225 via a pop-up field 1226, to inform them about the limits. This will happen if the property has limits that are set as discussed herein for managed properties. The provider then has to acknowledge the limits by engaging an input field 1227. Further disclosure regarding limits is set forth herein with respect to FIGS. 5E-5F. After the consumer has accepted the responding provider, screen 1230 is presented in the provider App with information as indicated by field 1232. In order to further prepare for the job, the provider can engage field 1233 to see job details or field 1234 to view the property information. Upon being satisfied with the details regarding the job, the provider can decide to proceed through engagement with field 1235 or may still decline through field 1236 as illustrated in FIG. 12J. If property details are requested through engagement with field 1234, the screen 1240 of FIG. 12K is provided that shows a plurality of property detail fields 1241. If it is a managed property, the provider is given fields 1242 such to call or message the property manager or resident. Further expansion of the property features is provided through engagement with field 1243 which will show a screen as illustrated in FIG. 12M with additional details. Alternatively, if it is desirable to contact the property manager or resident for engagement with field 1242, the screen of FIG. 12L will be provided for such contact.

Referring to FIG. 12J if it is desirable see job details through engagement with field 1233, the screen in FIG. 12N is presented to the provider showing photos, notes or messages, and the distance from the provider as well as the particular service requested. Appropriate “back” fields can be provided for getting back to the screen 1230 of FIG. 12J. Once the provider is ready to go and start navigating toward the job site they can engage field 1235. As noted, the provider can still decline at this point, such as through field 1236.

Referring to FIG. 12O if the provider needs to stop for parts on the way to a job site they need to let the consumer know. Accordingly, in accordance with one feature of the invention when field 1235 is engaged to begin the process of navigation, a screen 1250 is provided with a pop-up field 1252 asking the provider if they need she stopped to grab parts for the job. Various selectable subfields 1253 are provided for indicating YES or NO as shown in FIG. 12O.

As discussed herein, providers can be independent, employees, or also may be an employer. As such, the provider App may be used by an employer who works in independent mode as illustrated in FIG. 12P. If the provider is an employer, the screen 1200 will include a selectable icon 1255 which may be selected by the employer to switch over to ongoing jobs that are being handled by employees of the employer. As disclosed herein, an employer can create a company that will have a plurality of employees that join the company and can be managed through the present invention by providing the employer with the ability to see the employee's activities and the jobs that they are currently handling. Otherwise, the employer as a provider would accept the job request in a similar fashion as illustrated in FIGS. 12A-120 and described herein.

With respect to the screen of FIG. 12M, if more than 10 photos but be selected, they could be displayed in a gridded view with smaller photos that can be engaged and enlarged by tapping on them.

Refer again to FIG. 12E, a provider has the ability to accept or decline a job request. Upon declining a job request, in accordance with one aspect of invention, the provider may be required to state a particular reason why. Referring to FIG. 12Q, interface screen 1260 provides a verification process and a number of selectable reasons or the ability to provide a different reason to a consumer for declining the job request. Once the message choice is made and they have indicated that the process is complete through field 1261, the provider goes back to a screen for receiving jobs and a message field 1263 indicates the declined request (or a canceled job) as illustrated in screen 1262 of FIG. 12R and Field 1263. Such a process will occur before the provider has accepted and set forth the rates to the consumer and the consumer has accepted the provider and rates. If a provider initially accepts a job request and navigation to the job has begun pursuant to features of the invention as illustrated in FIG. 12S, screen 1270 provides a selectable field 1271 for pausing the navigation. Upon pausing navigation, options are then presented with screen interface 1272 as shown in FIG. 12T. The provider App then allows the provider to still cancel the job through engagement with field 1274 whereupon menu 1276 is provided as illustrated by the interface screen in FIG. 12U. The menu field 1276 provides a verification screen and message for the cancellation, and upon cancellation, such as by engaging field 1277, the provider is brought back to a home screen such as the screen interface illustrated in FIG. 12A. A message may be provided in that process on the home screen indicating that the job has been canceled. (See FIG. 12R).

As noted herein, the consumer can cancel the job completely or may cancel the job and request a new provider. In such a scenario, a message screen as illustrated in FIG. 12V is provided through the provider app to indicate a cancellation. Upon acknowledgment by the provider, such as through field 1280, the provider might be taken back to a home screen such as shown in FIG. 12A.

In accordance with another aspect of invention, a provider can operate in various different selectable modes. For example, they might operate in an independent mode (default for provider), they might also operate in the mode of being an employee or employer as discussed and disclosed herein with respect to setting up various providers through a company framework (most recently added company might become default). In handling job requests, the provider App presents a provider with the ability to change their modes for receiving a job request. For example, as illustrated in FIG. 12W, the drop-down field 1202 is presented a user can change their mode to working for a company as indicated in field 1202 of FIG. 12W or in independent mode (See FIG. 12R). Upon first switching modes through the field 1202, a message screen such as that illustrated in FIG. 12X might be provided to explain the mode switch. Thereafter, as illustrated in FIG. 12Y, the selectable drop-down fields 1202 might allow selection of the independent mode 1281 or an employer company 1282. Accordingly, the invention gives the provider the versatility of accepting job requests under different roles. In the role of an independent, payment made from a consumer upon job completion will go to the provider. If the provider is an employee and providing service in that capacity, payment would go to the employer.

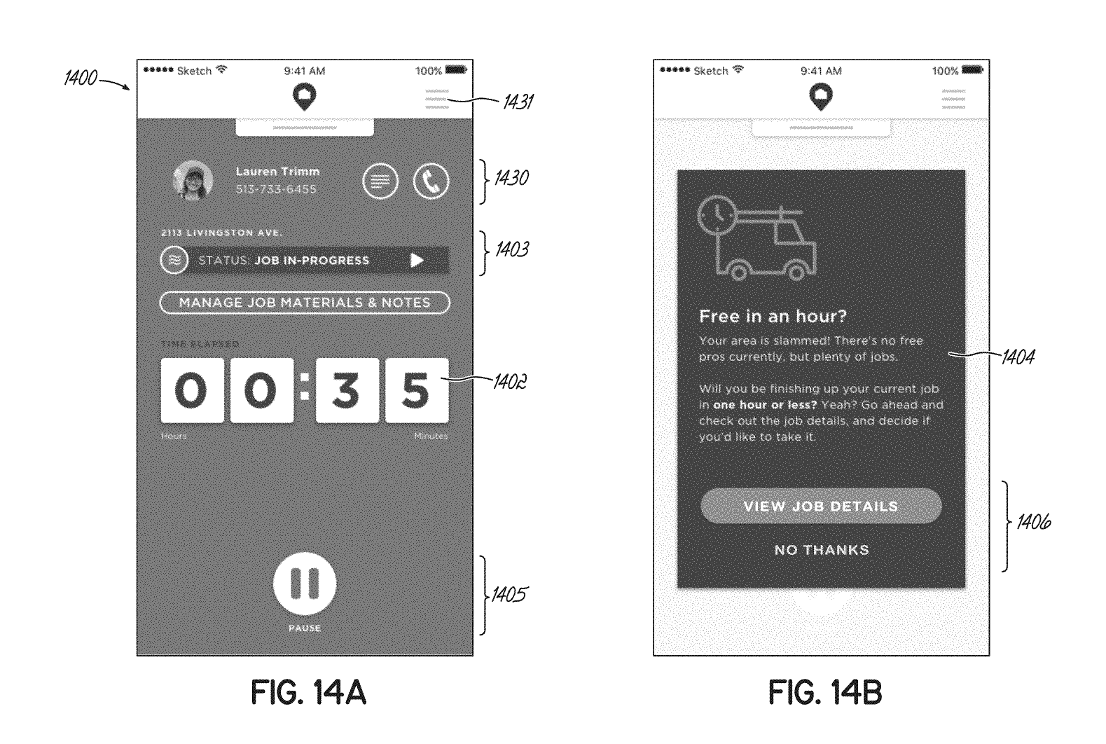

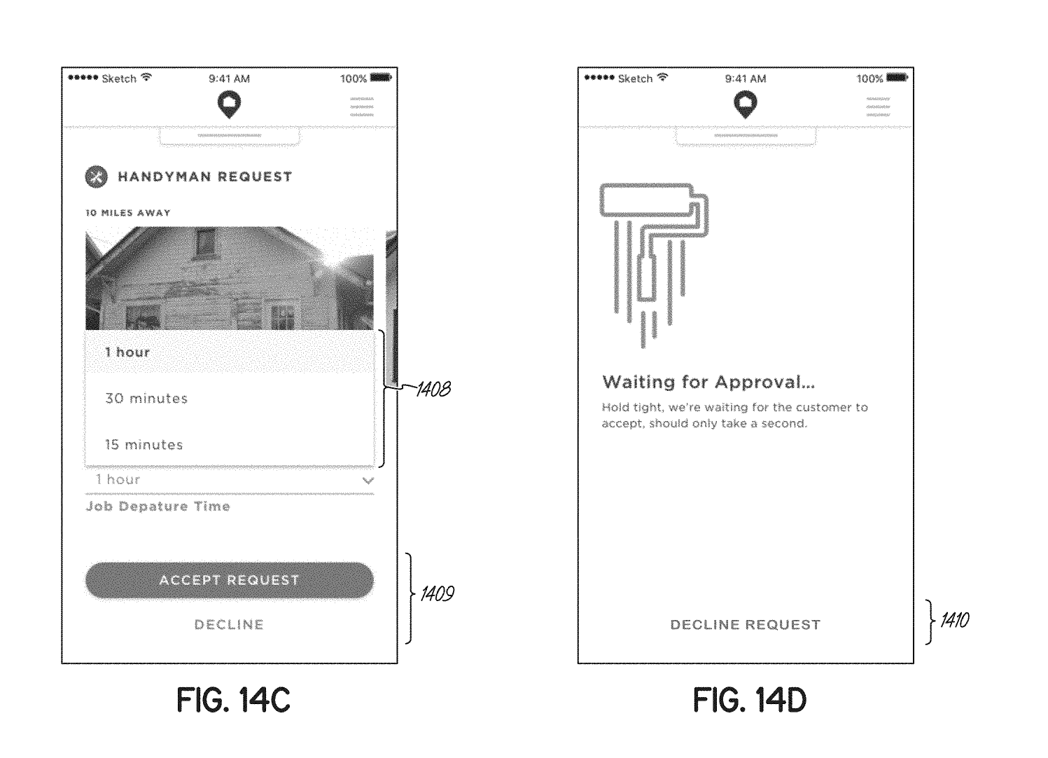

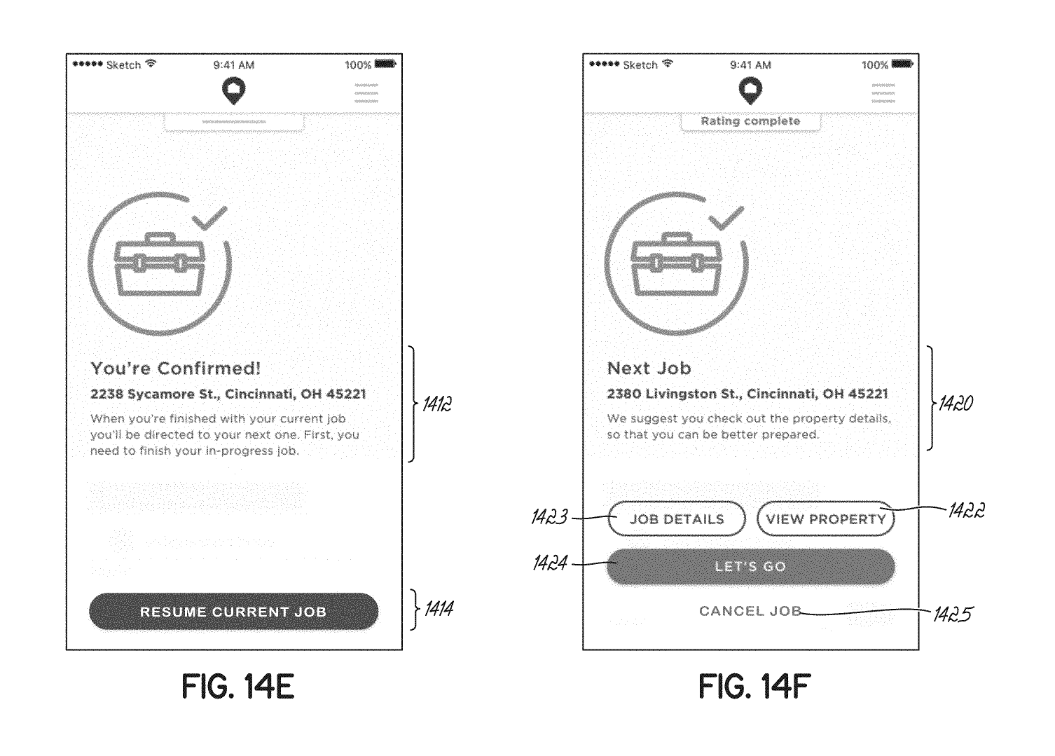

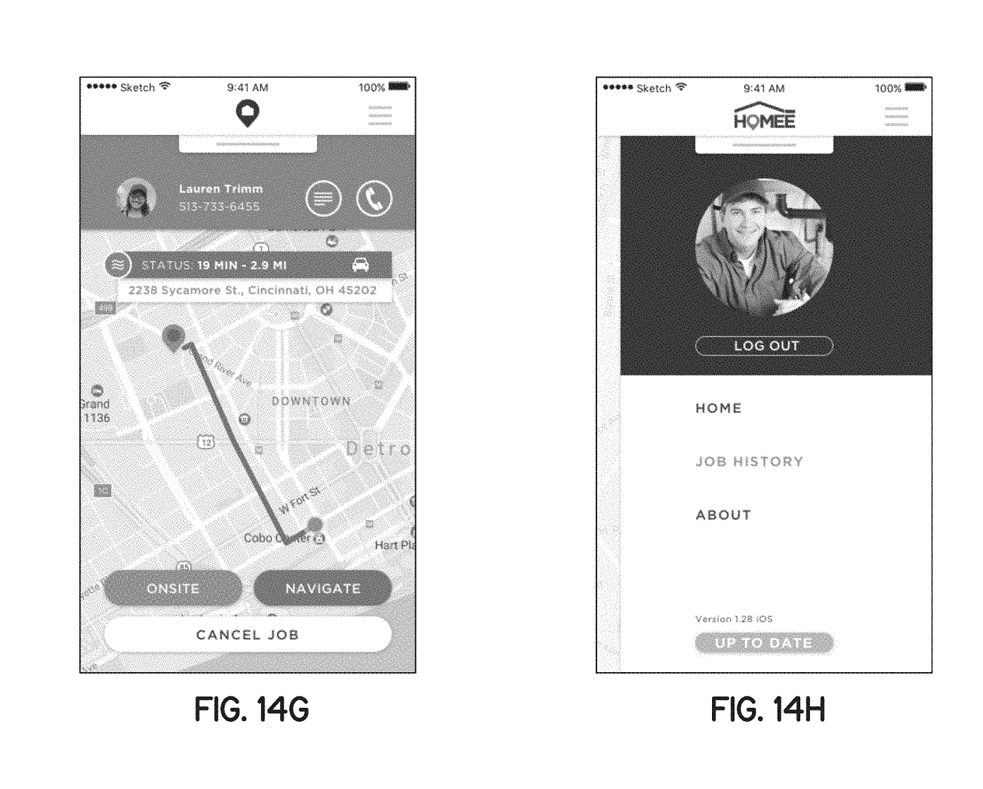

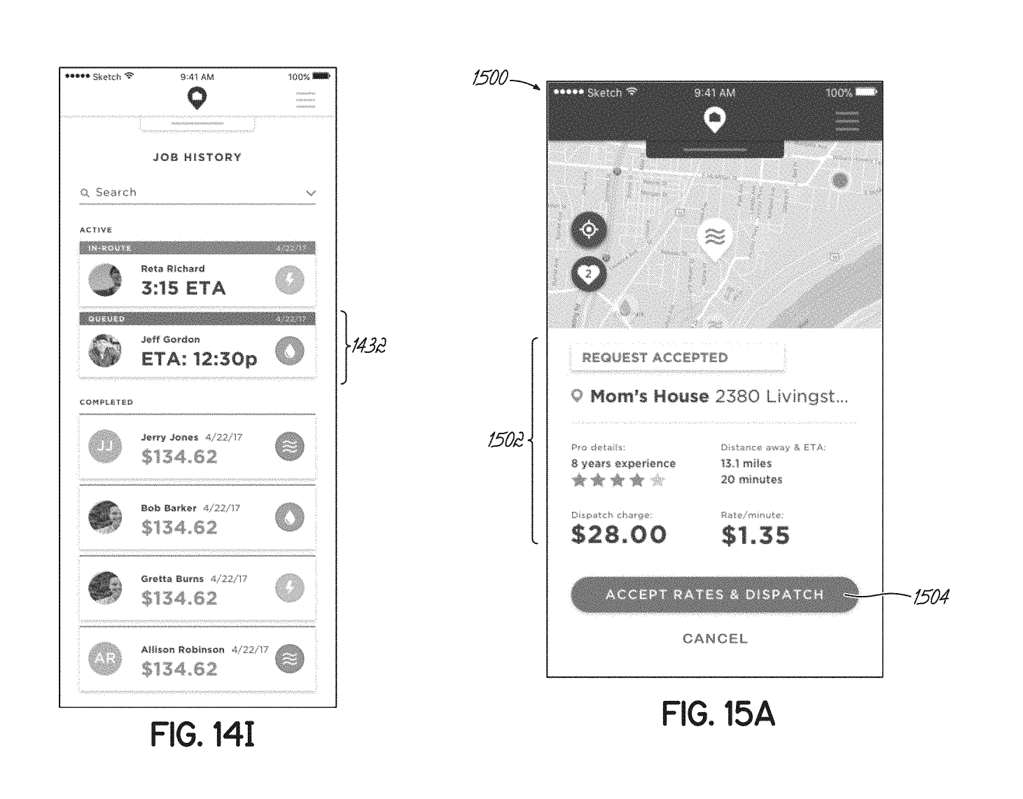

Situations will occur where any provider who is currently engaged in an active job, receives a request to accept another different job. In accordance with one feature of the invention, the provider can accept a new job then place that new job into a queue for future engagement in order to finish the current job. Referring to screen 1400 of FIG. 14A, a provider may be on a job with an appropriate job timer 1402 running for the current active job. As the search protocol makes its way through the various search layers looking for a suitable provider, and if all the other providers are busy, the invention will start contacting providers who are currently in an active job. As such, the screen of FIG. 14B is provided to the service provider and includes a message regarding new jobs 1404 giving the provider the ability to look into details about the job or to simply decline as shown in fields 1406. If details are desired, the screen of FIG. 14C is provided wherein the provider is given the ability to select when they will be ready as illustrated by fields 1408 and can then accept or decline requests per fields 1409. If the provider accepts the job they will then have to wait for the consumer to approve them and will be provided the screen of FIG. 14D with a suitable message. The provider still maintains the ability to decline a job as well, as set forth in field 1410. Upon approval by a consumer, the screen of FIG. 14E is illustrated with a suitable confirmation message 1412 and then a field for resuming the current job 1414. Then the provider will return to the current active job with a display screen such as shown in FIG. 14A. Of course, as discussed herein, other job screens, such as for a paused job, or for a completed job may also be displayed depending upon the particular status of the current job.

Once the current job is completed, the provider will then move on to the next or queued job. Upon completing the previous job and entering the suitable information as discussed herein to send to the current consumer for approval, the provider will be presented with the screen of FIG. 14F for the next job wherein information about the job, such as the address may be provided in a field 1420. Other selectable fields 1422, 1423 are provided for seeing additional details about the property which may have been entered into database for that property, as discussed herein, as well as details about the job. The field is then provided to be selected to proceed to the next job 1424 or to also cancel the job 1425. If the provider proceeds to the next job, a navigation screen as illustrated in FIG. 14G is provided to the provider just like the beginning of any other new job. Also, if the job is active and the provider accepts another job that is put into a queue as discussed herein, the provider can also, upon returning the active job screen of FIG. 14A, engage a suitable selectable menu field 1431 in order to look at the job history and will be presented with the screens of FIGS. 14H and 14I for selecting job history and then displaying the job history in the screen of FIG. 14I. In the job history, the job that is queued will be appropriately illustrated with a suitable field 1432.

### Active Job Flow

Once a job request is accepted and the job is to begin a timer is associated with the job for the consumer to keep track of the job progression and to control the job flow in accordance with one embodiment of the invention. As the job is progressing and may need to be stopped at different junctures, the timer will stop and can be restarted in several ways as discussed herein as the consumer and provider interact as reflected in the flow of FIG. 5D. Also, the timer provides control of the job by both parties in a satisfactory flow so there are no surprises in completion and cost.

In one embodiment of the invention, an interaction is provided generally between a consumer and a provider for the completion of a job. The timer is maintained and at selected job junctures the invention gives the provider as well as the consumer the flexibility to start and stop the job as well as provide the consumer with approval for the various junctures in the active job flow. To that end, the invention provides an interaction such that when a provider takes one action with respect to the job flow, the consumer is given the opportunity to approve or decline that action and the stoppage of the job flow and associated timer. That is, jobs may be paused and then restarted to give the provider the flexibility, such as to take a break, tend to another job, or possibly pick up parts that are necessary for the job. In one embodiment, the consumer has some control over the start and stop process in the job flow and can decline a request for a paused or suspended job based on their schedule. In another embodiment the invention as discussed herein, to eliminate too much management of the job flow by a consumer, the consumer can effectively trust the provider and can therefore put the job into a “fast track” mode. As described, the “fast-track” mode eliminates some of the interaction between the consumer and provider during the typical job flow.

Both of the consumer and provider Apps 170, 180 then will automatically switch their output screens to respective timer screens when the provider is onsite, and the job has begun. The provider and consumer App will illustrate a respective provider screen 616 and consumer screen 618 showing timers. The screens will have various fields and information to help the job flow interaction between the consumer and provider.

Referring to the screen of FIG. 14A of an active job, the provider screen 1400 may provide some or all of the following information:
JOB ID:—Unique string which ties together the consumer with the provider, the status changes as the job proceeds through the workflow and ties the final job details to the JOB ID (notes, materials list, pre and post images/videos). This may be displayed or just used by the system but not displayed to the consumer or provider in the App.
Time (hours: minutes: seconds)−Total Elapsed Time (field 1402)
STATUS: (pertains to workflow and status as shown in the workflow diagram of FIGS. 5A-5J) For example, the status could be ONSITE, IN-ROUTE, PAUSED, STOPPED. (Field 619)
Buttons to control timer (start, pause, resume, stop, finish). (Field 1405)
Consumer information field 1430.

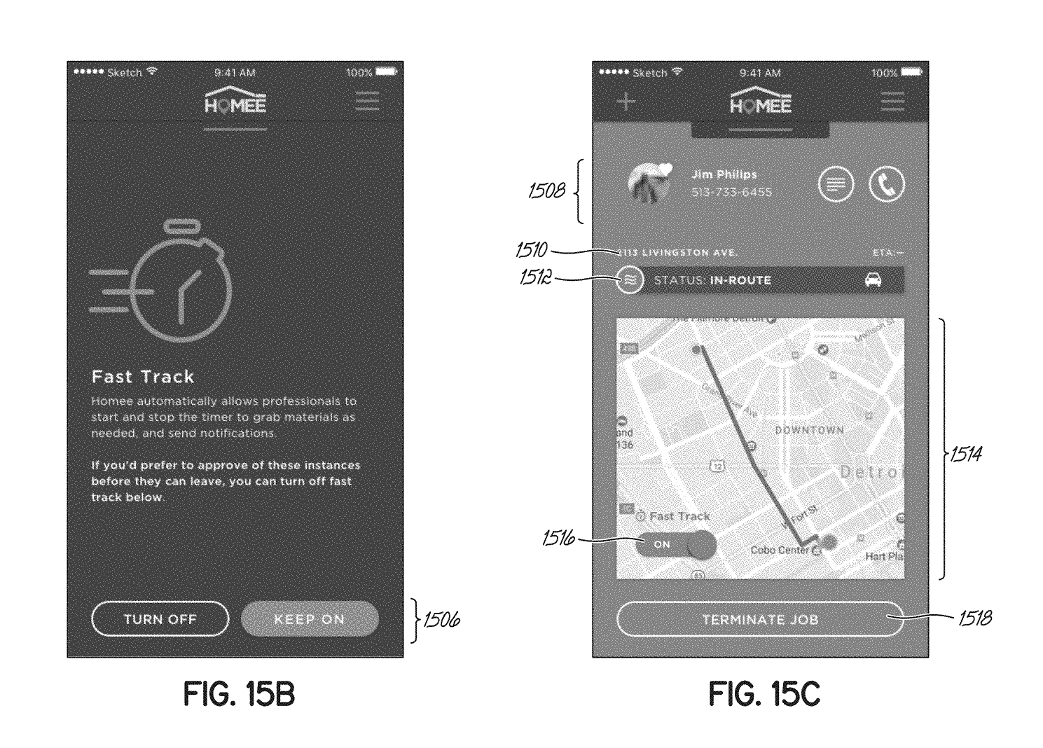

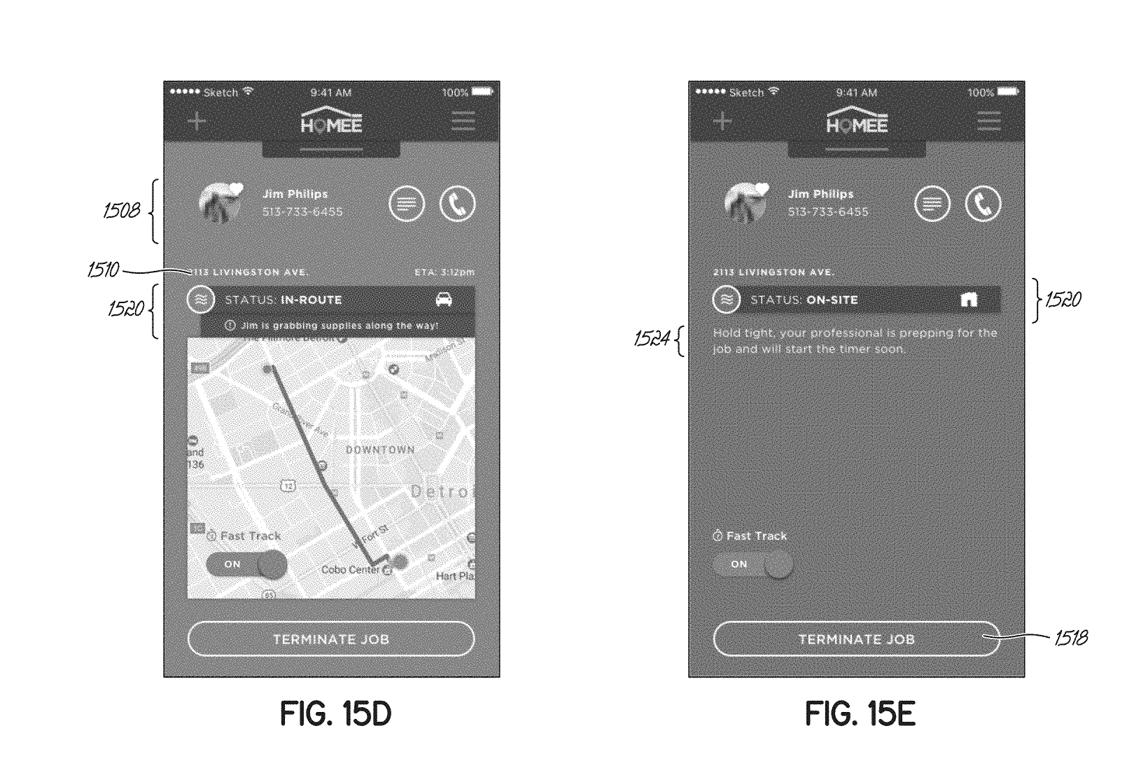

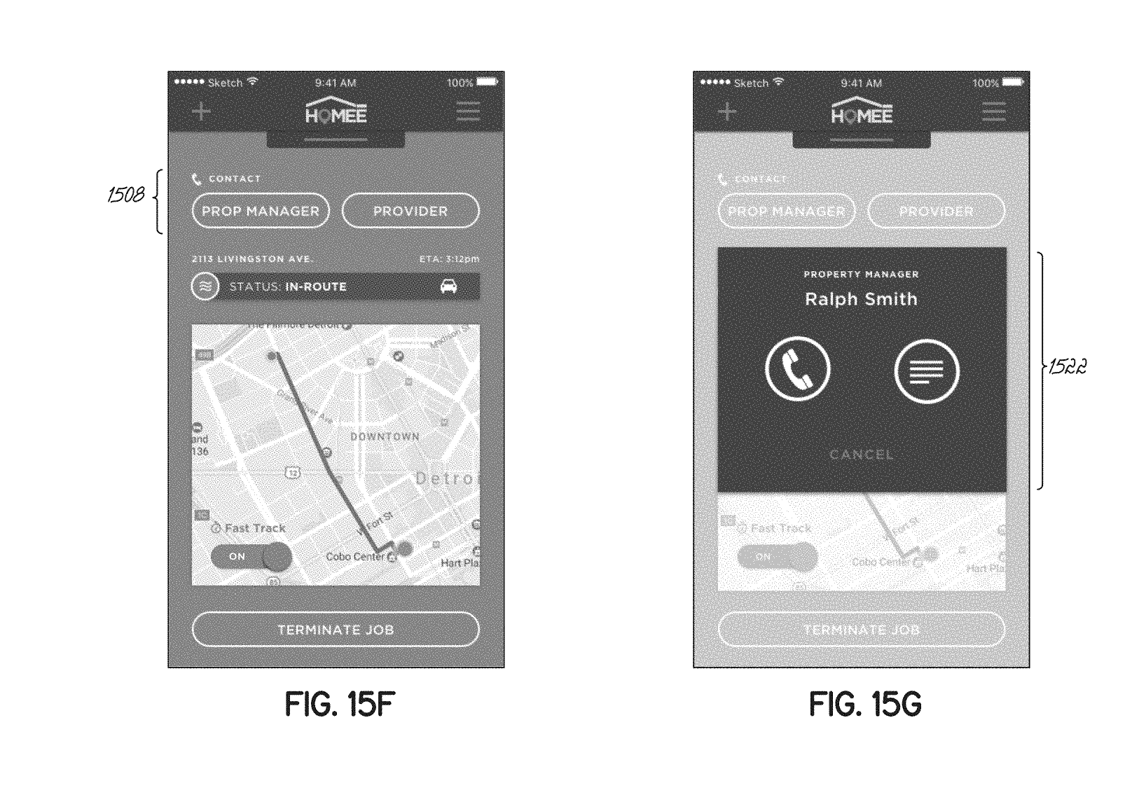

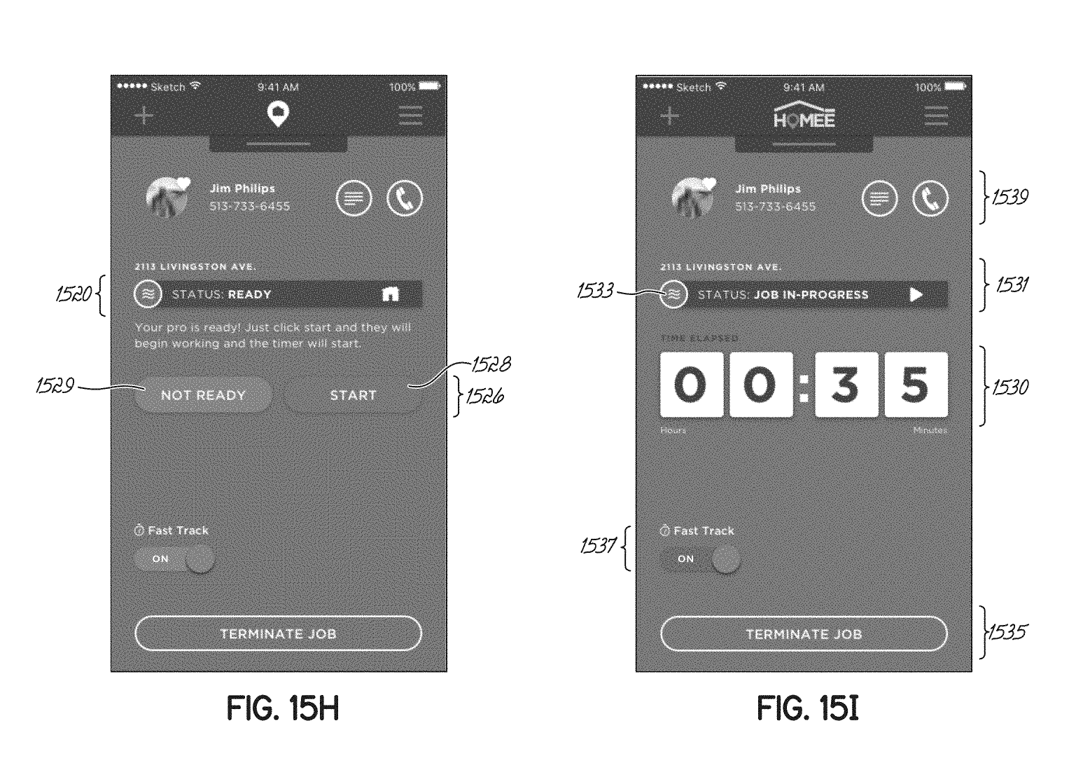

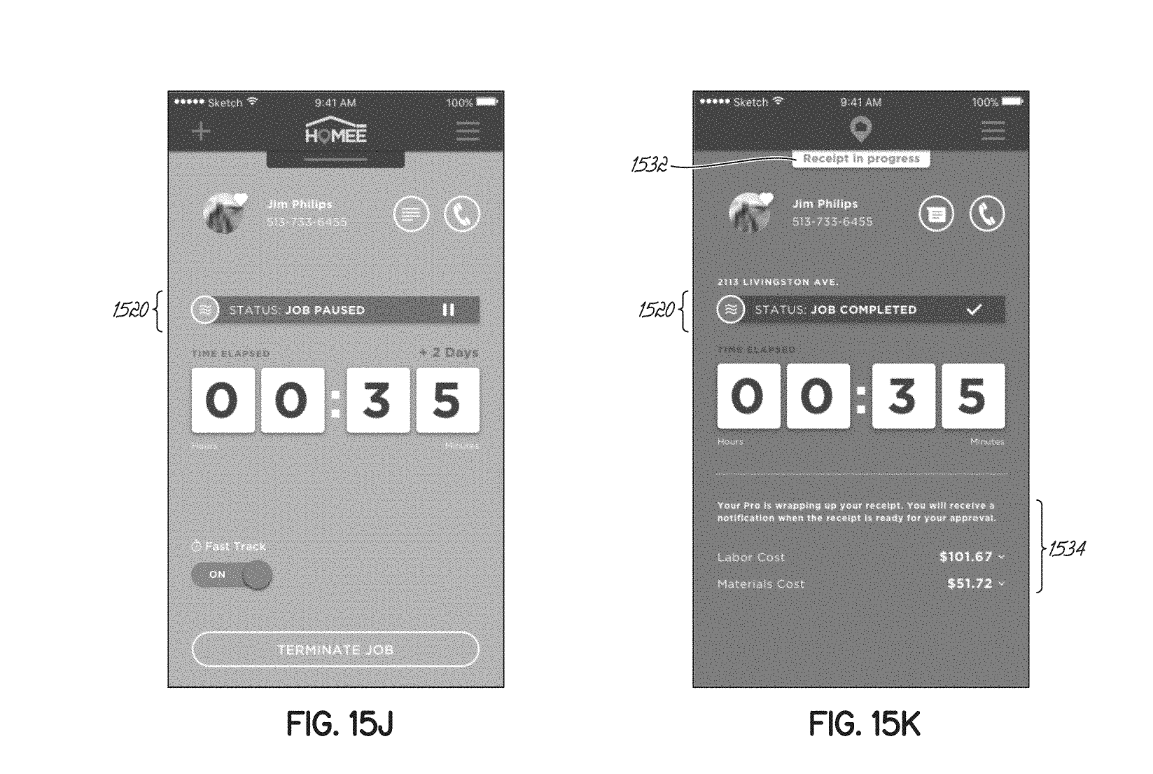

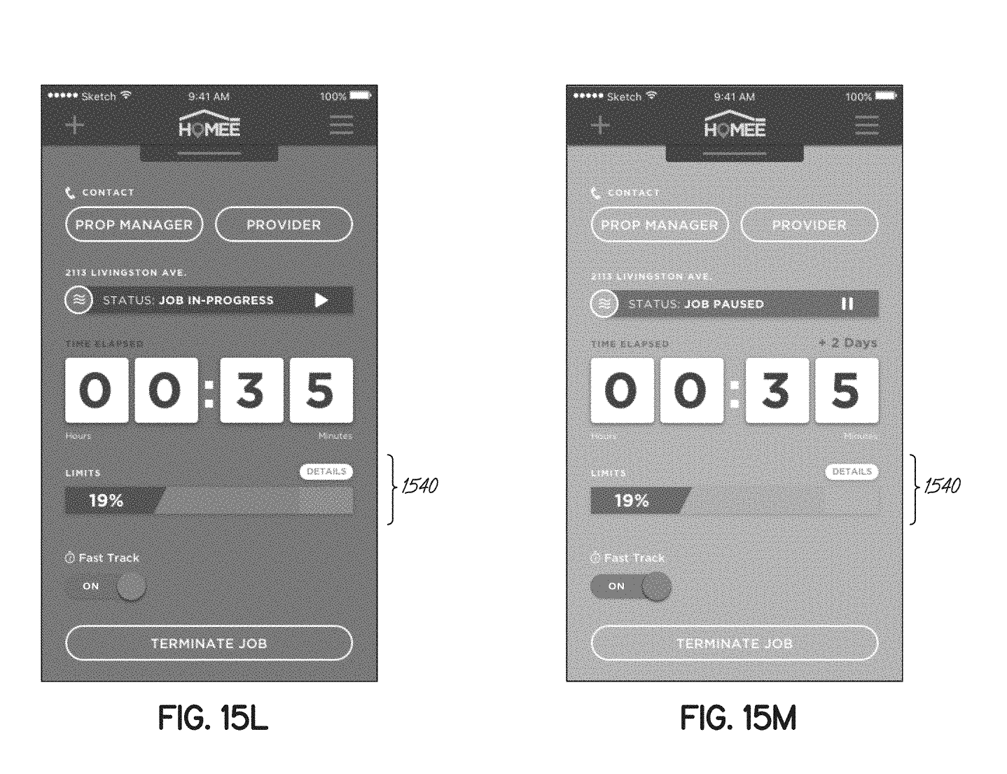

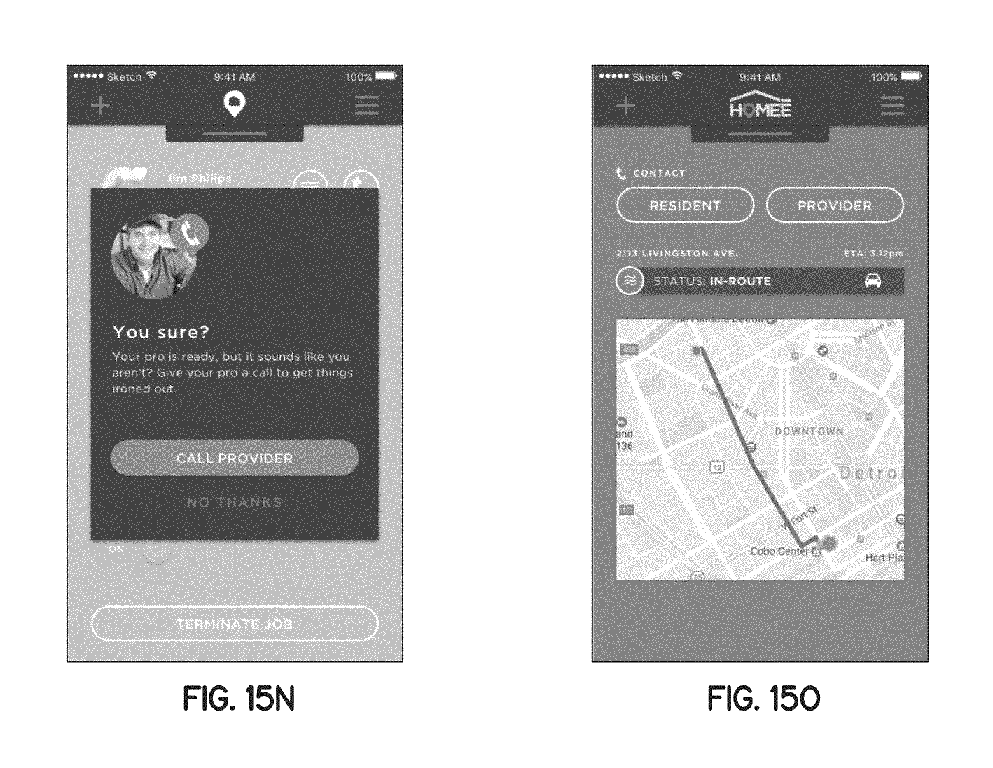

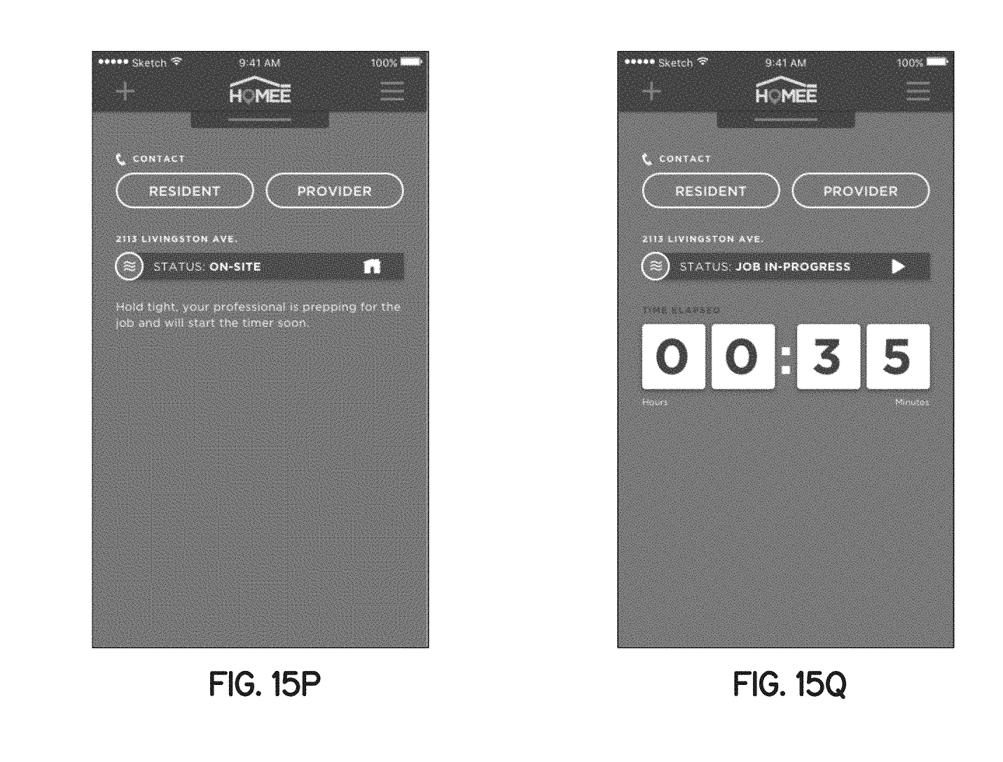

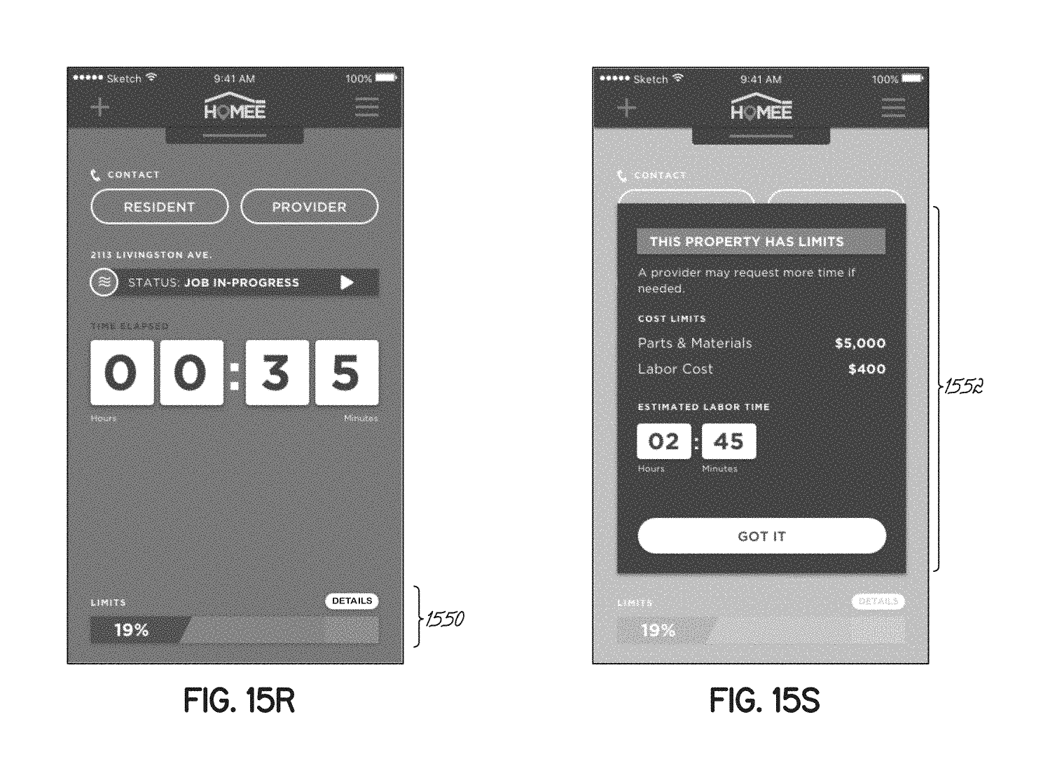

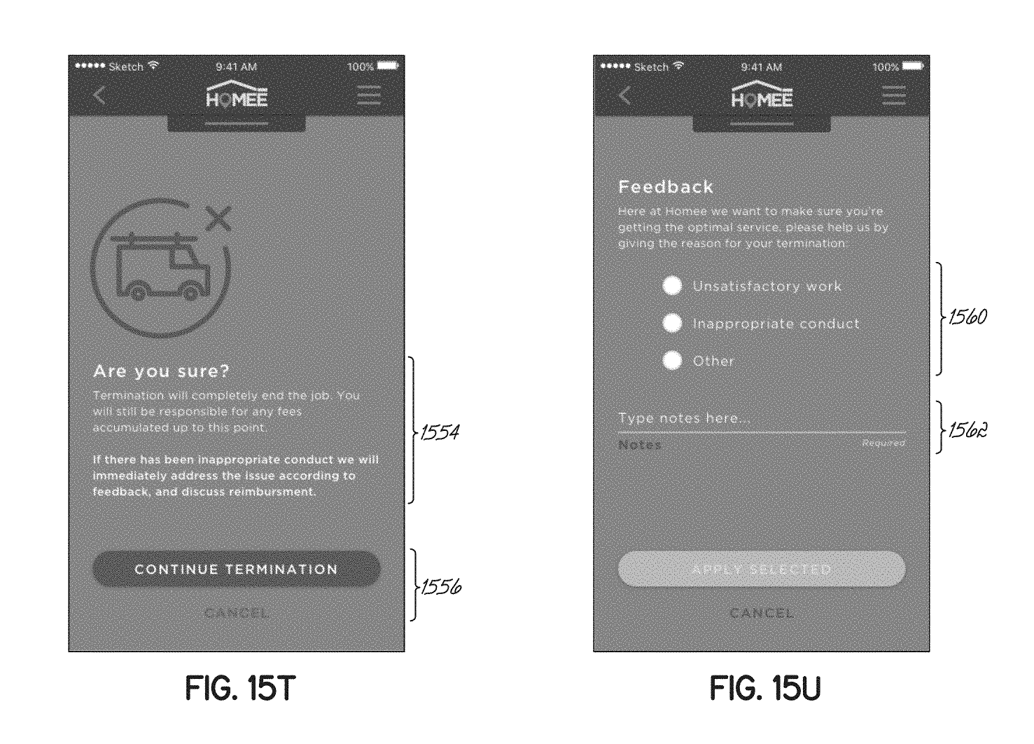

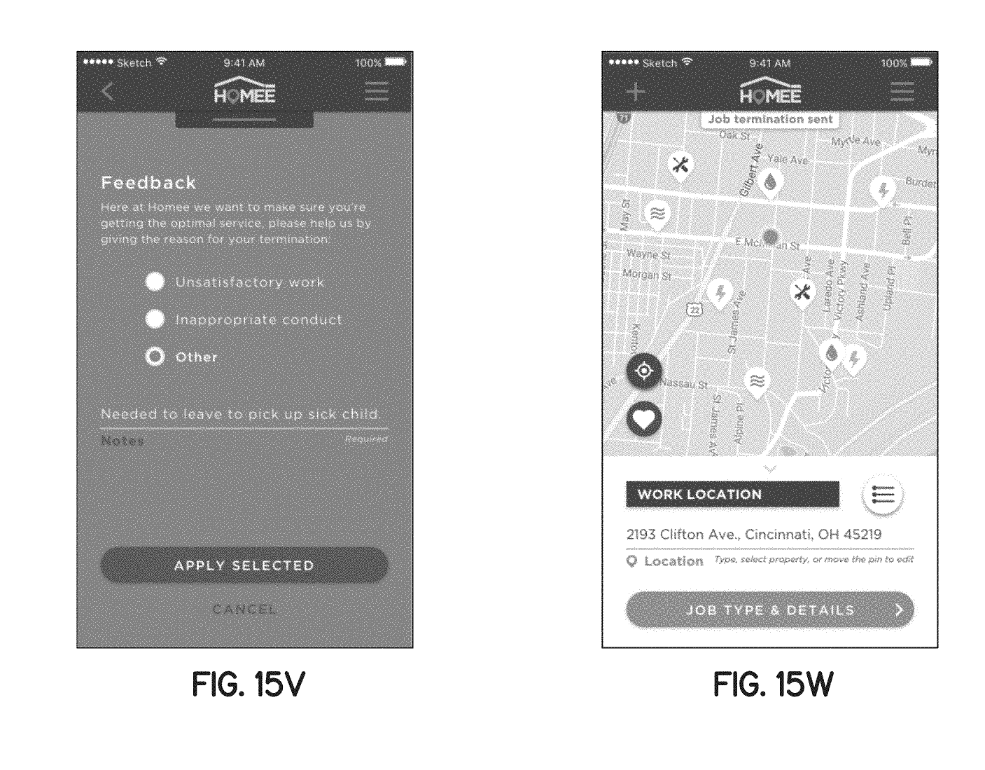

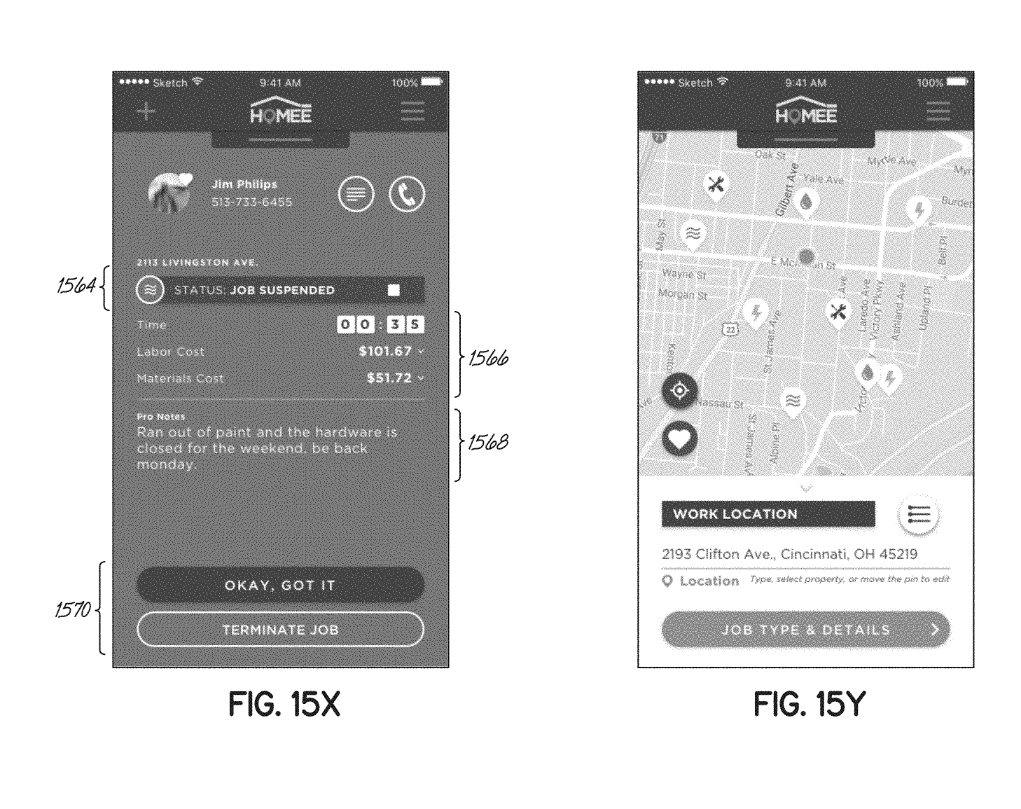

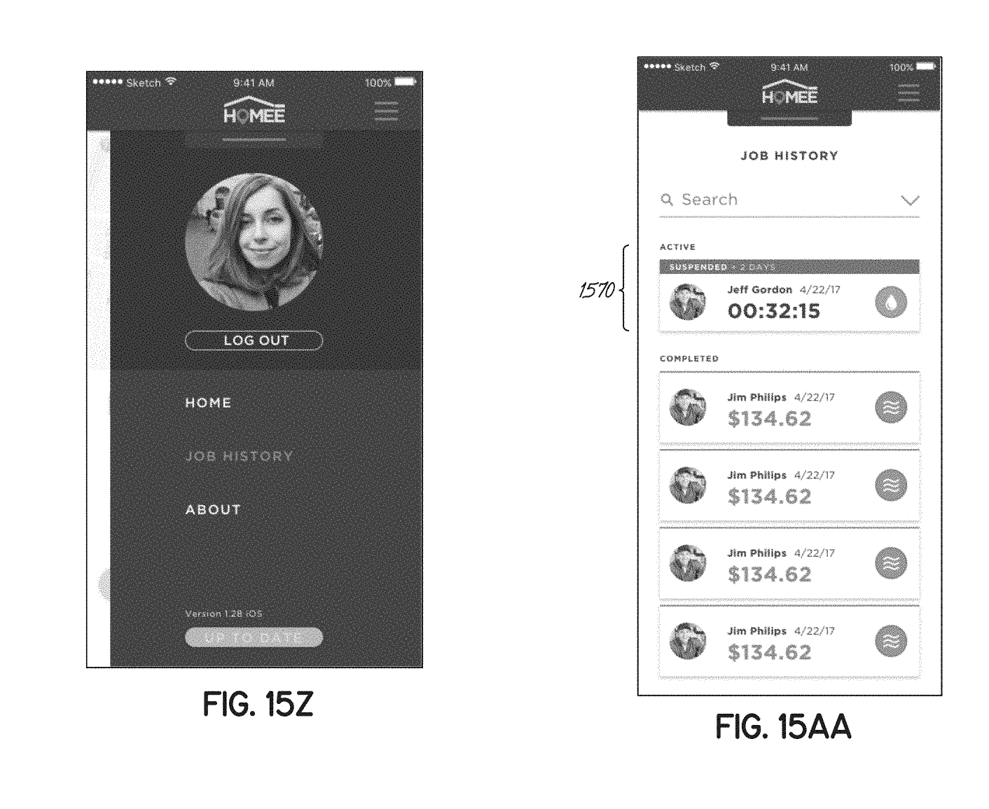

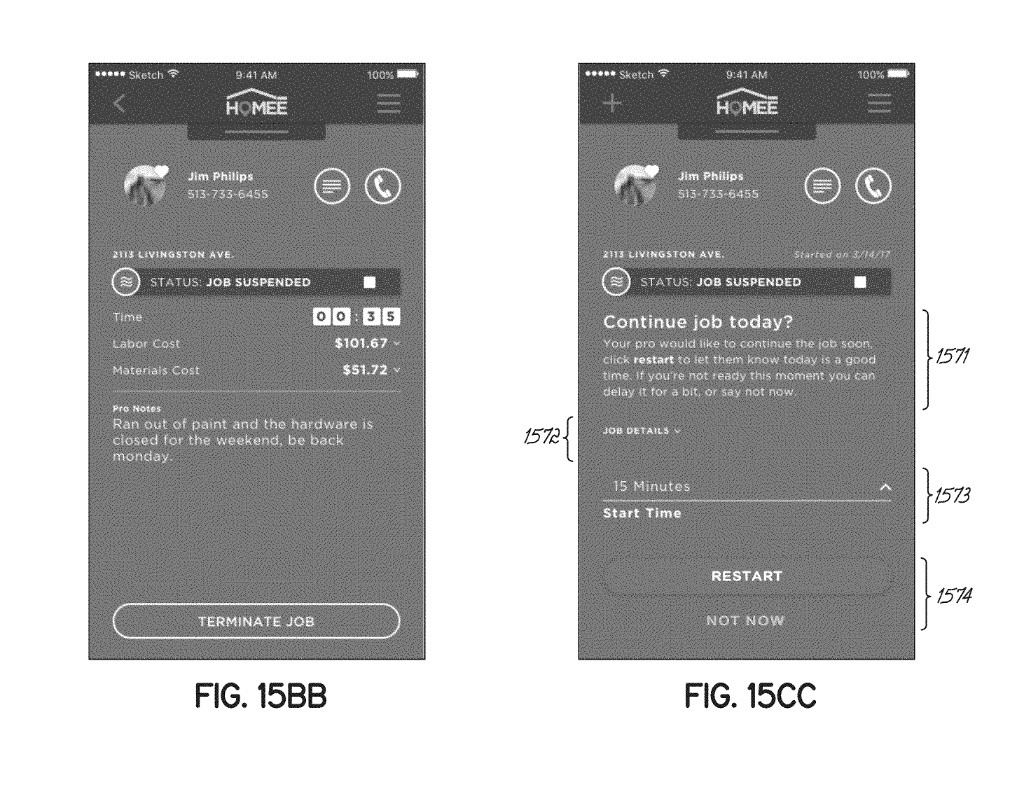

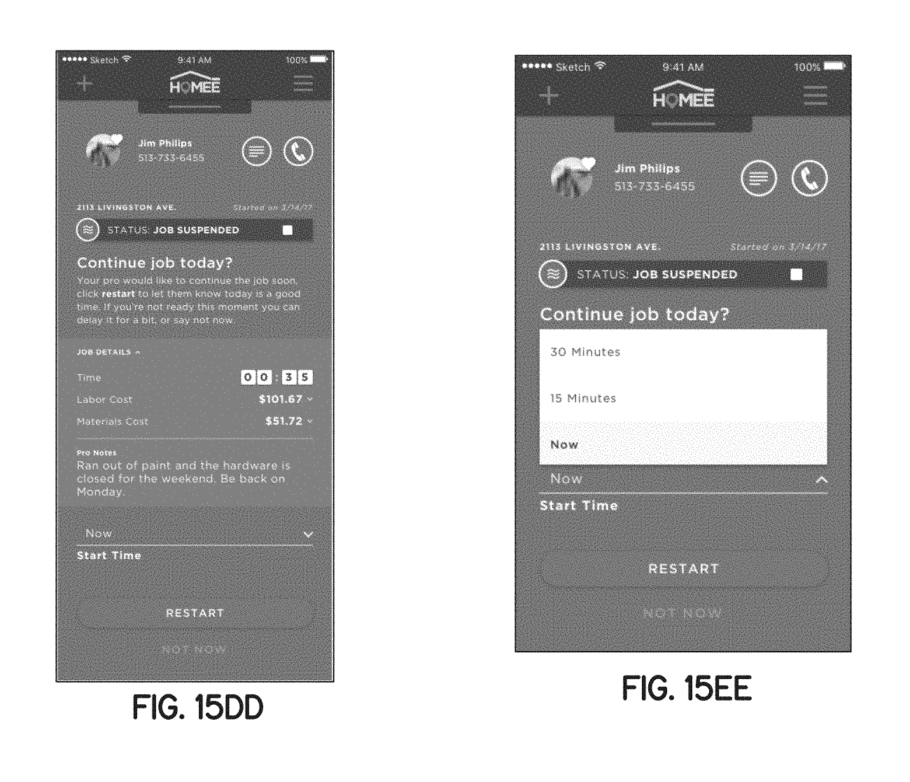

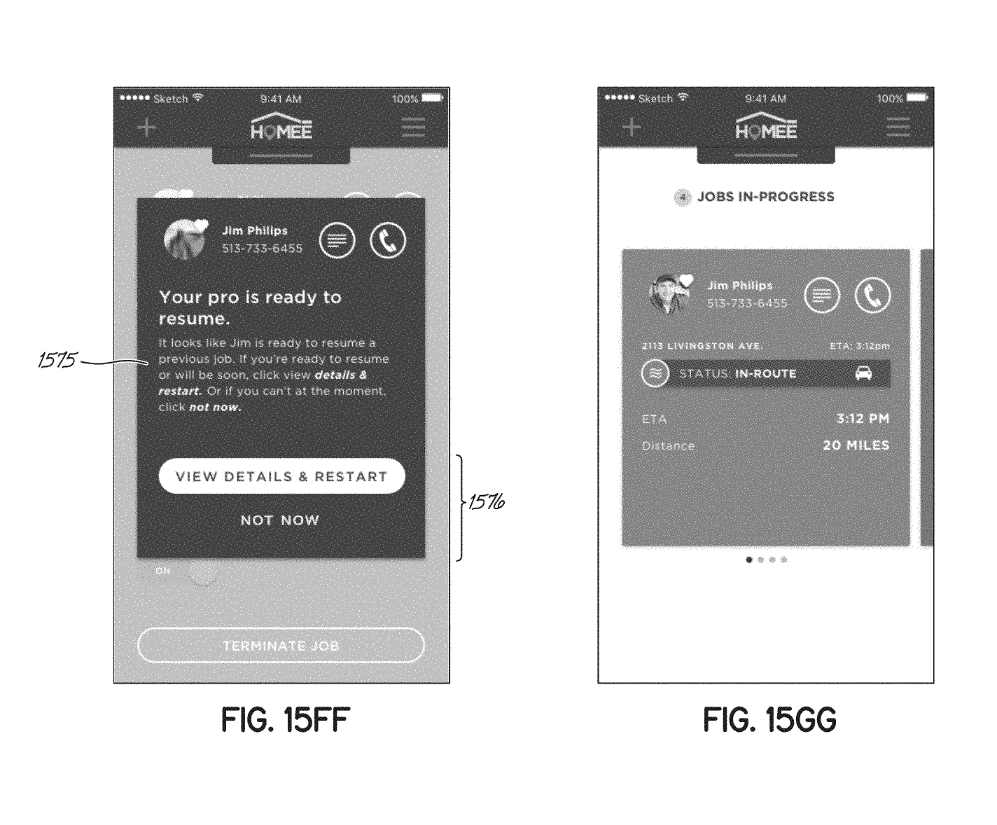

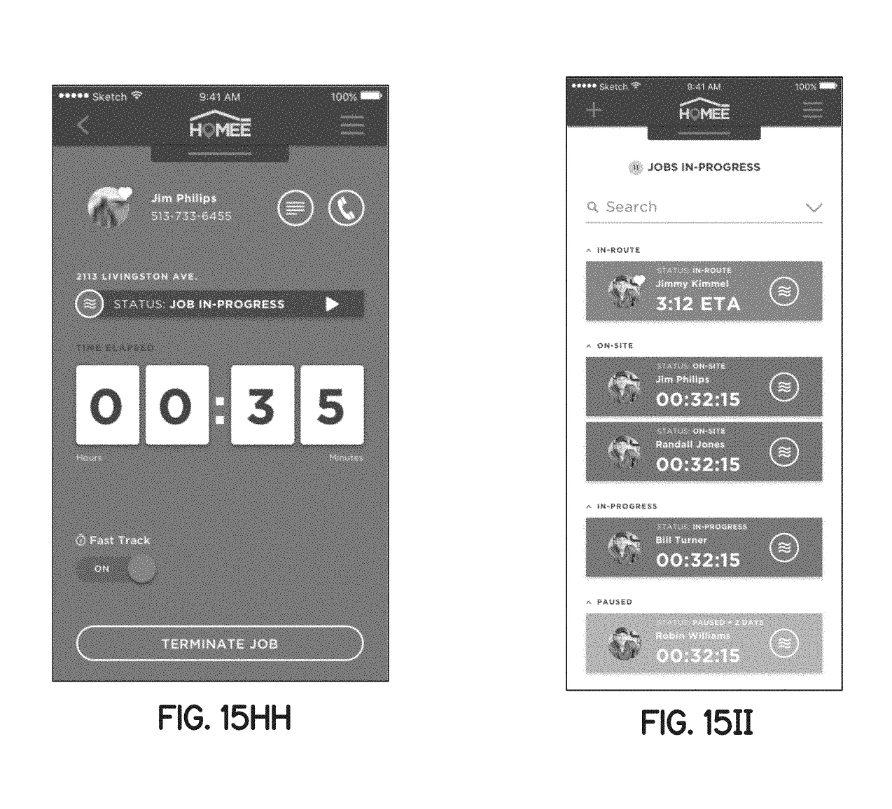

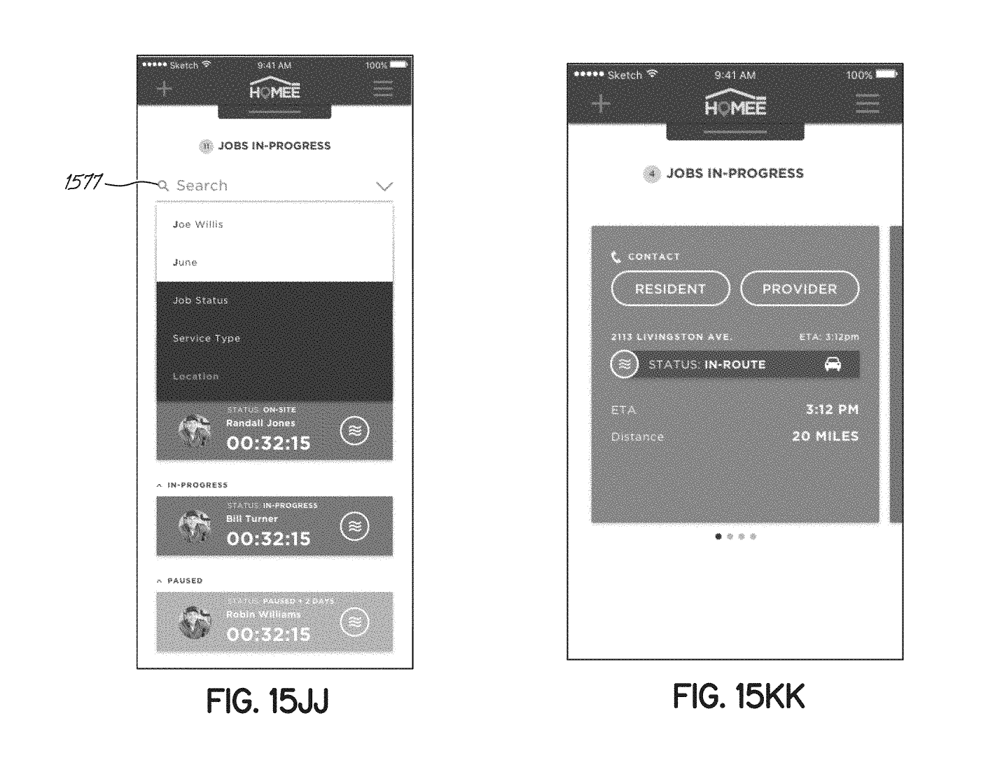

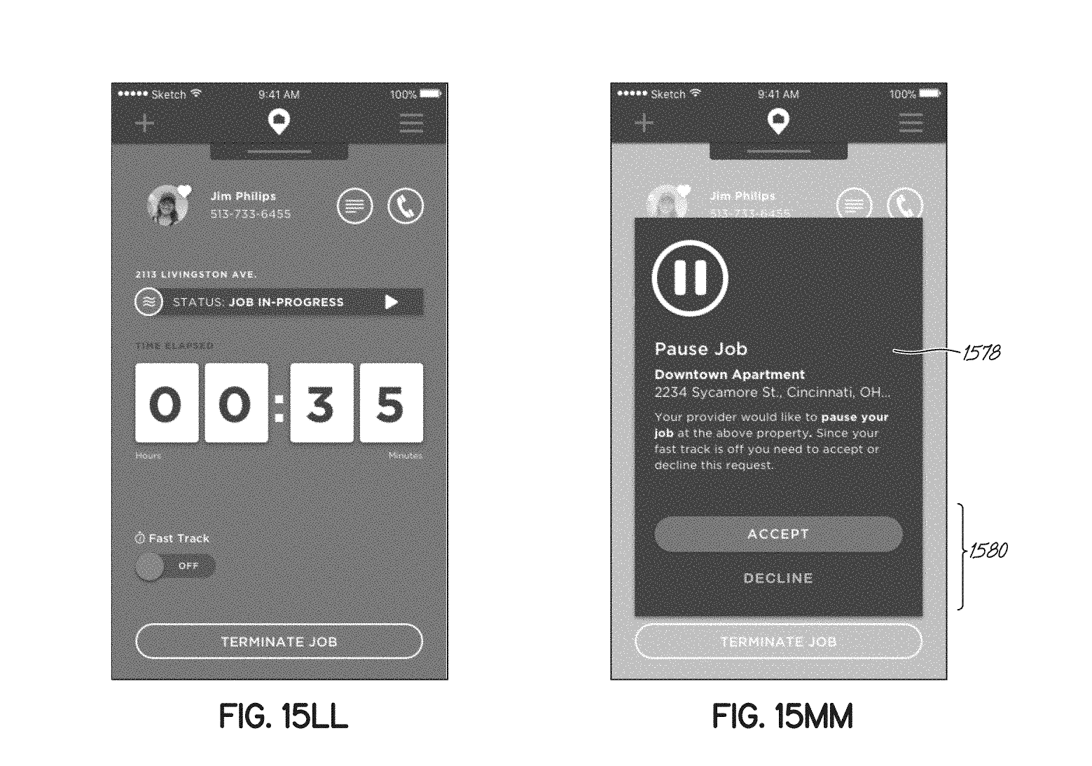

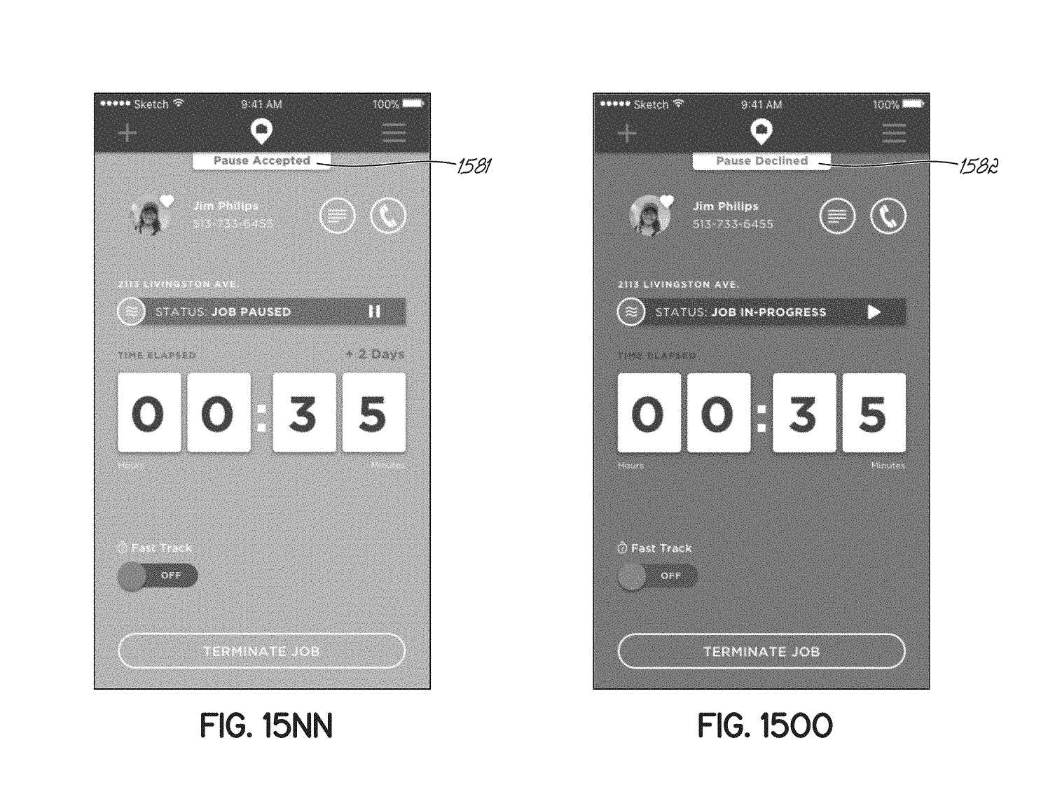

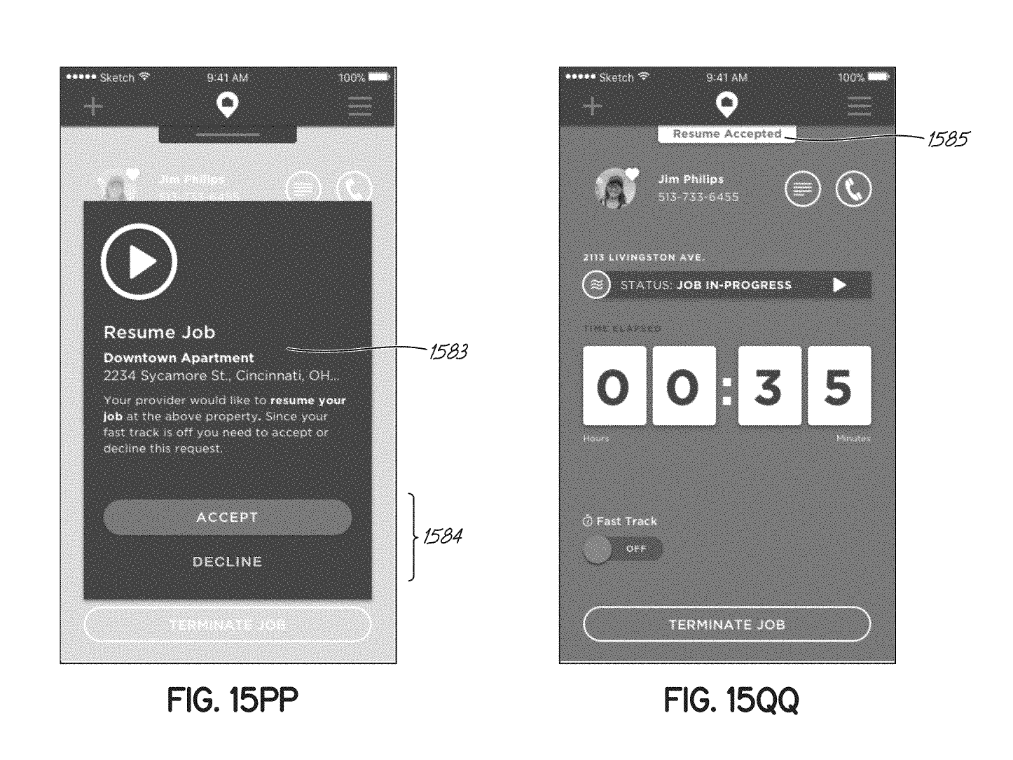

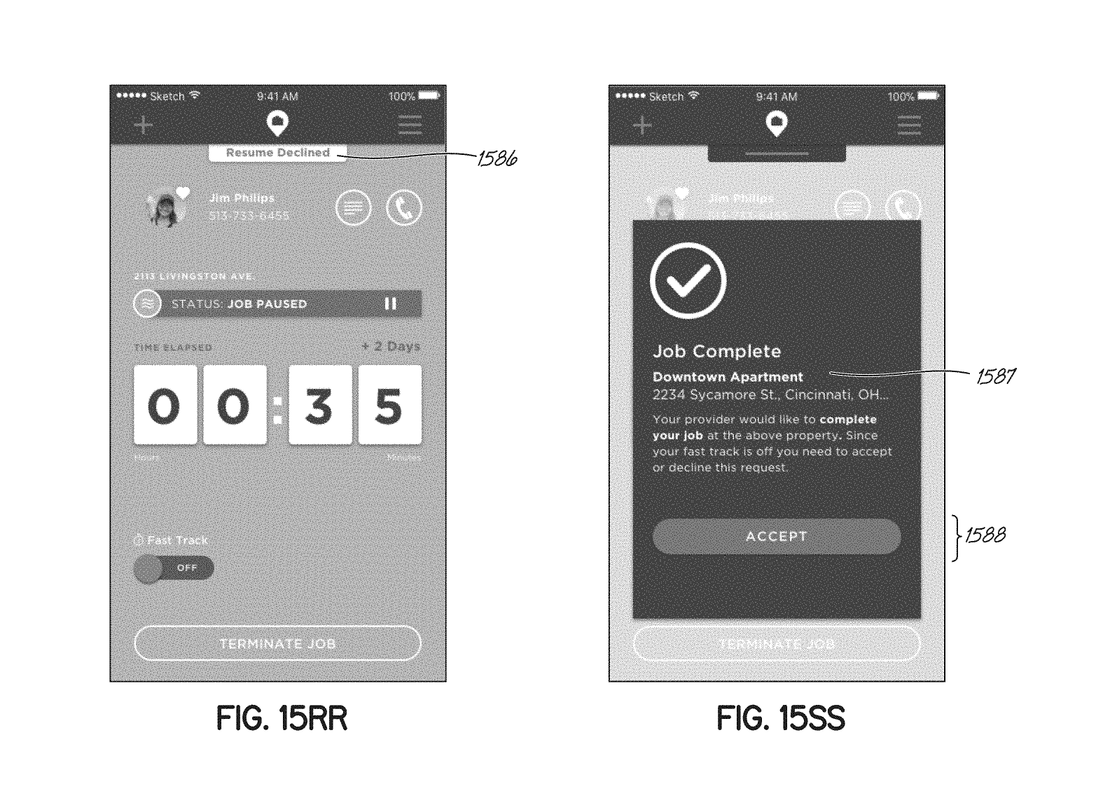

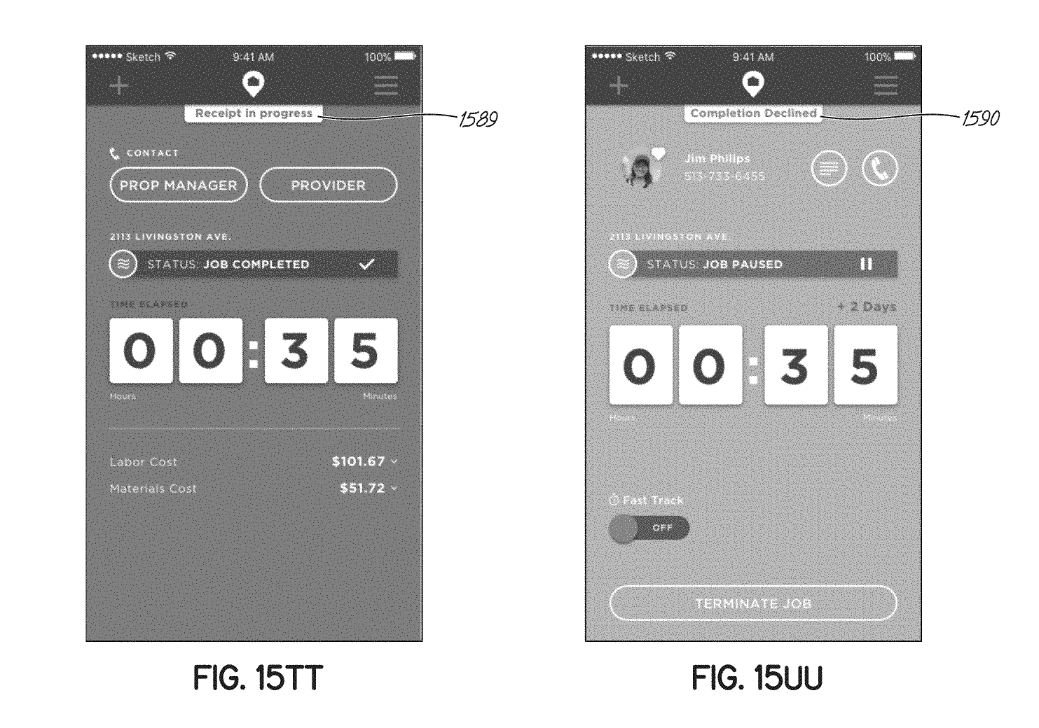

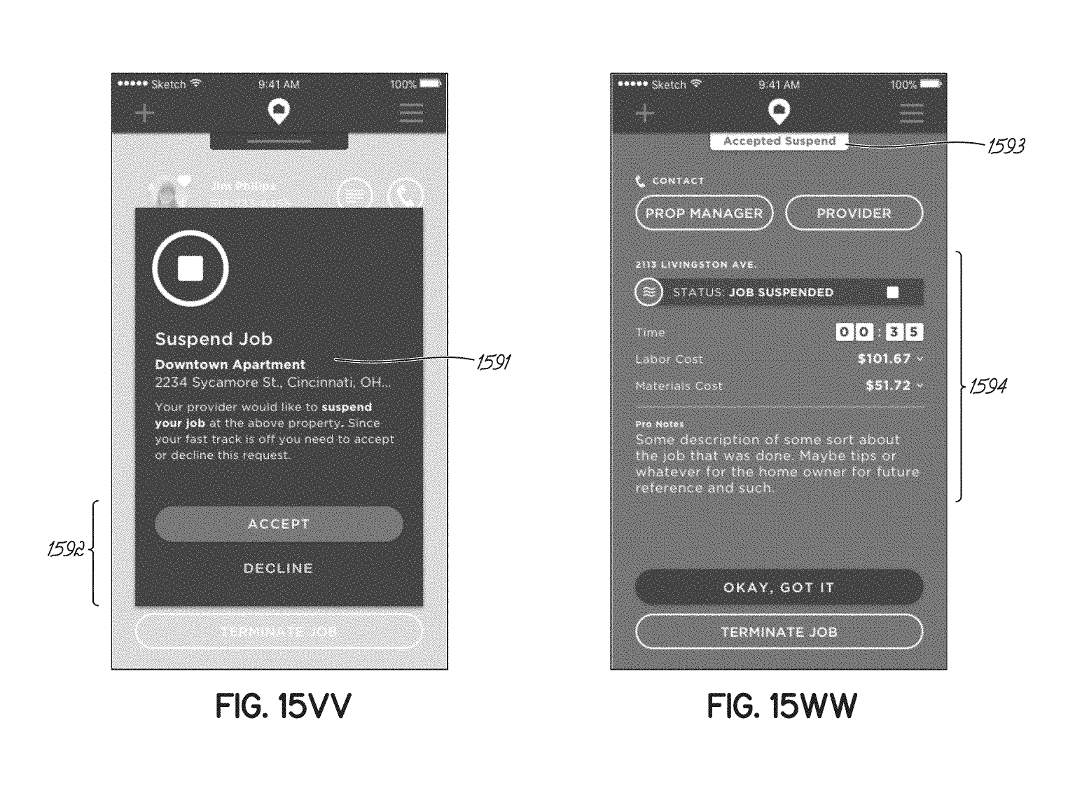

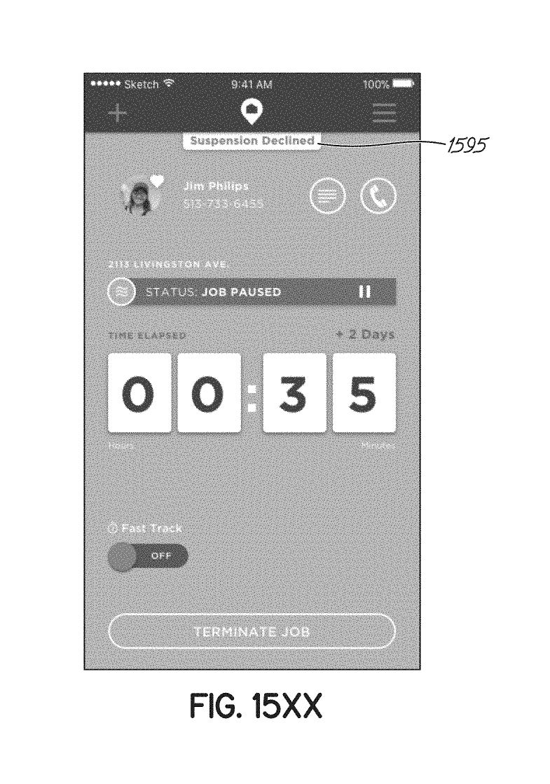

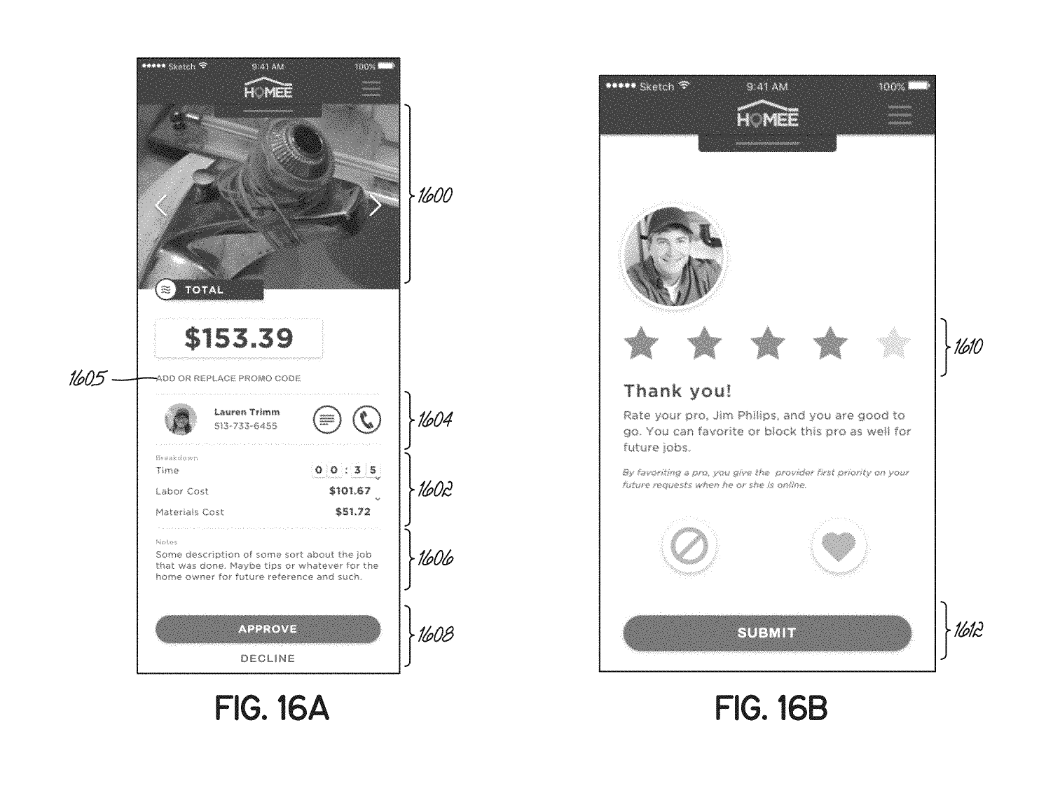

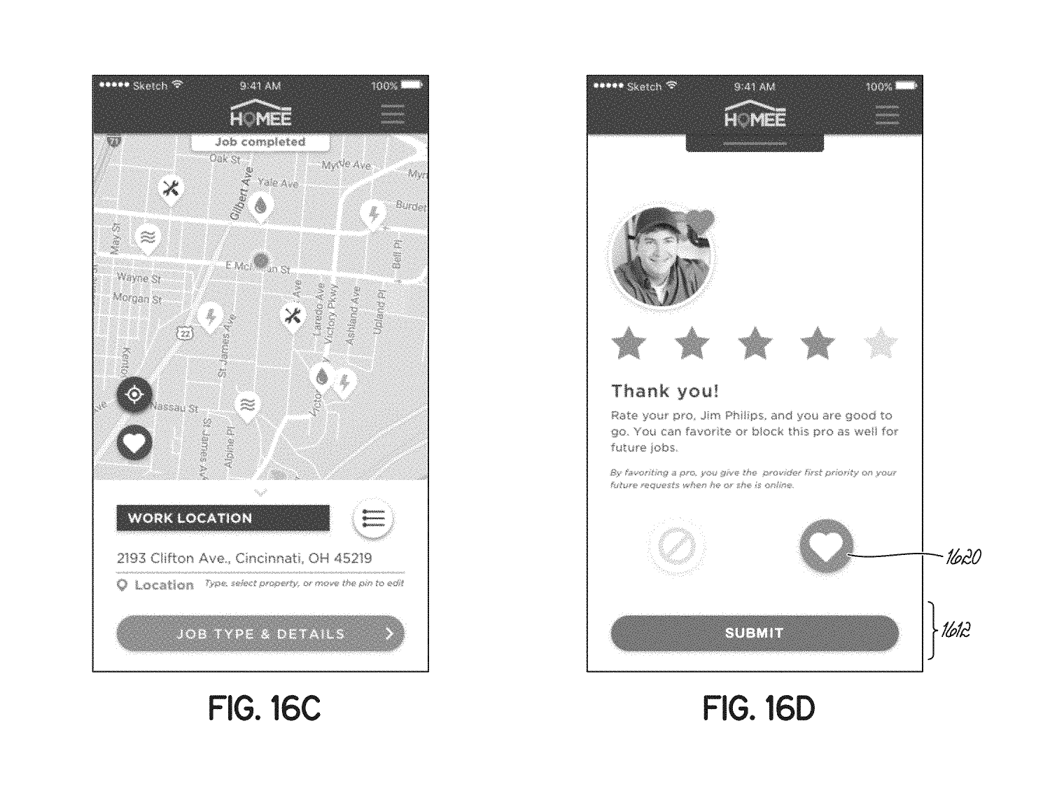

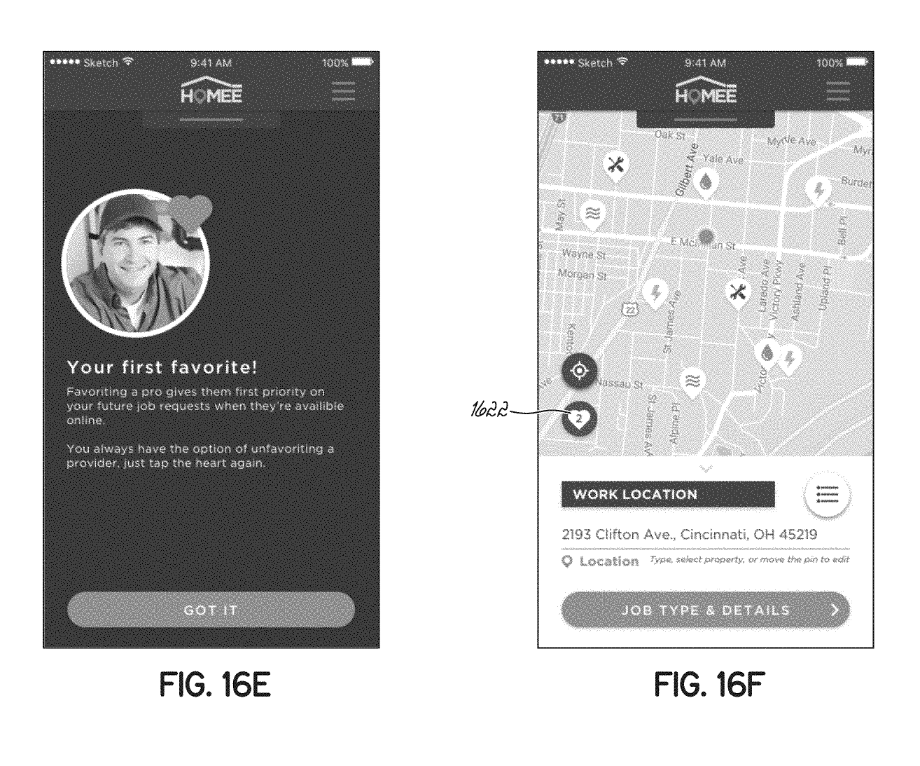

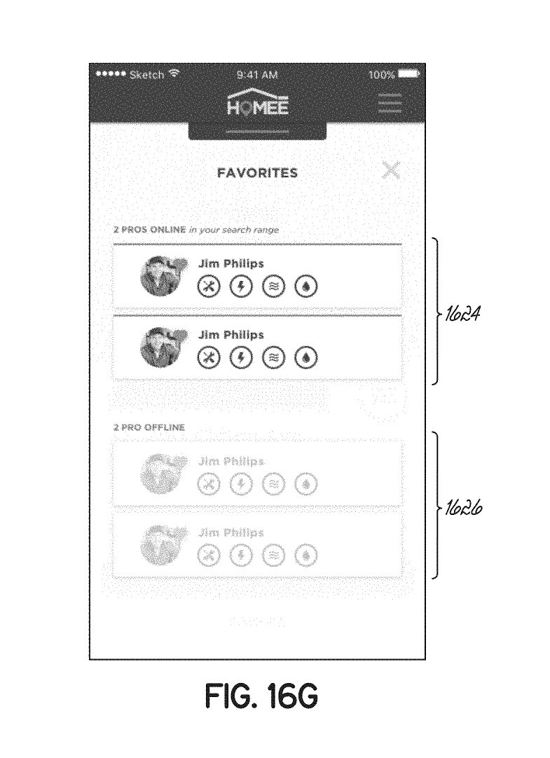

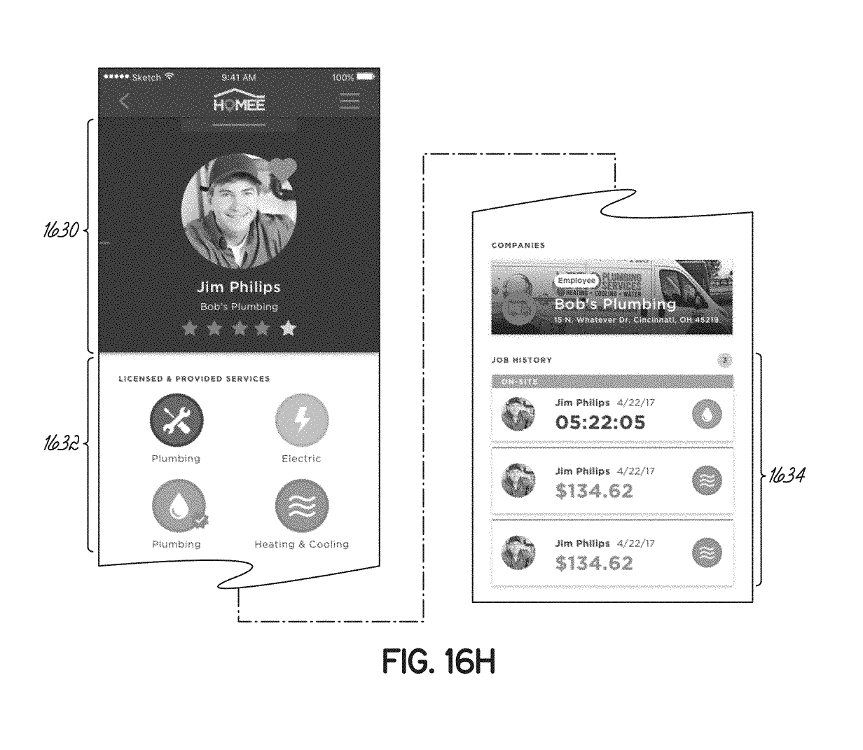

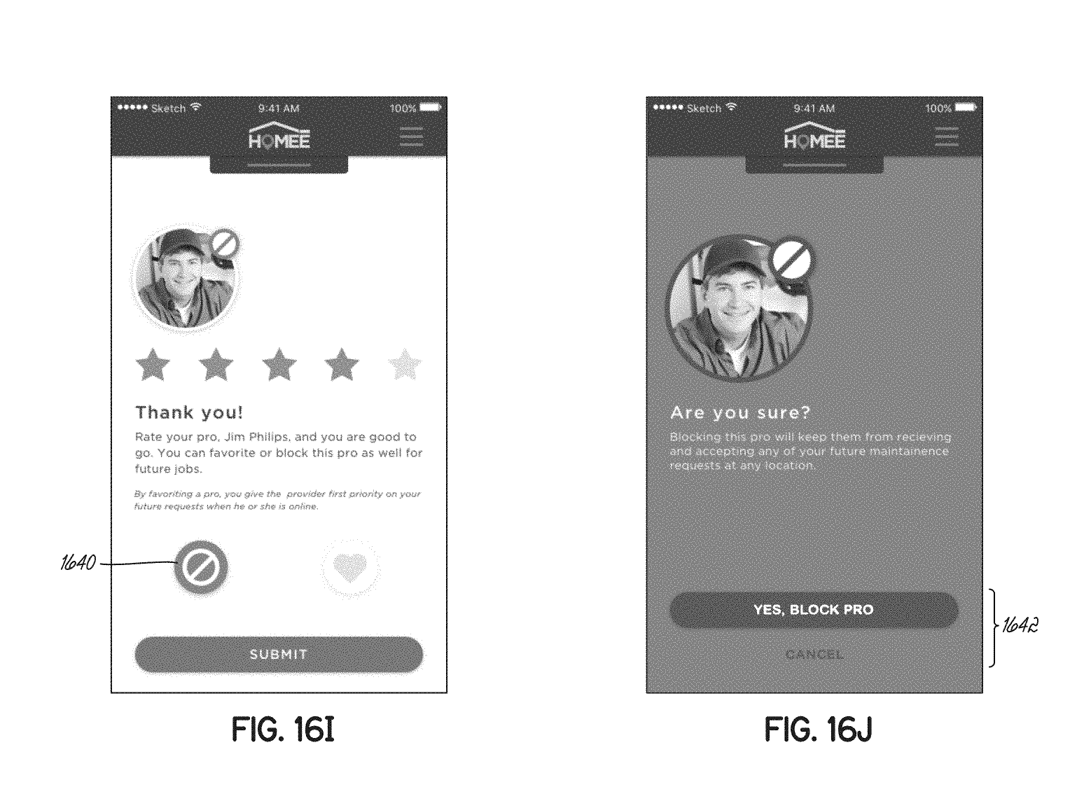

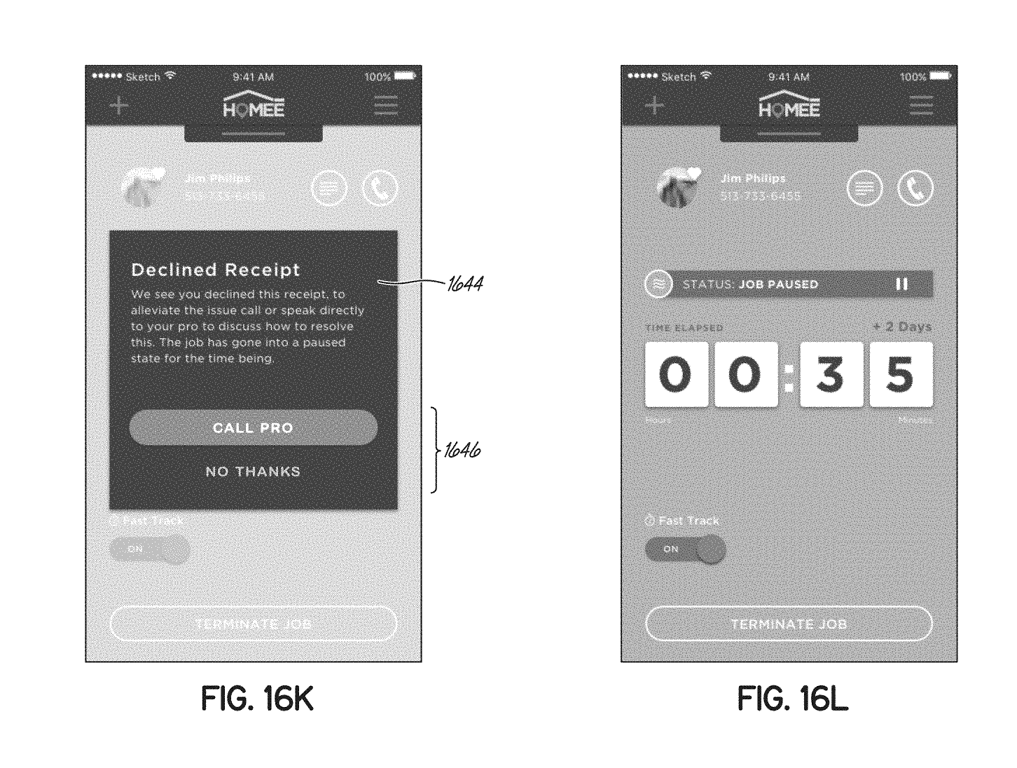

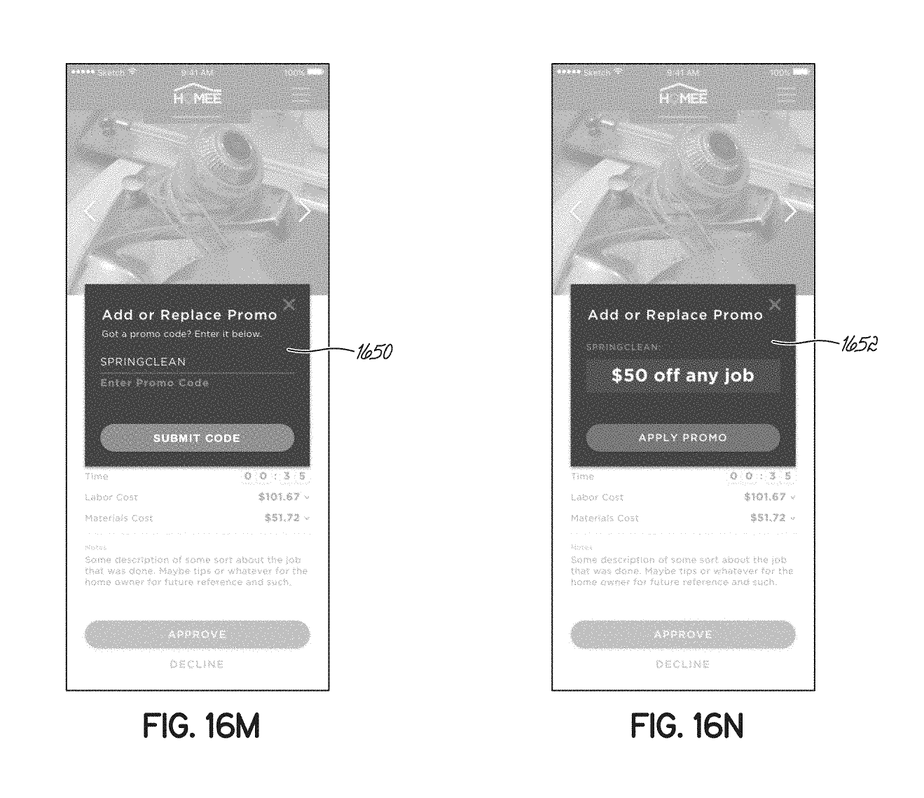

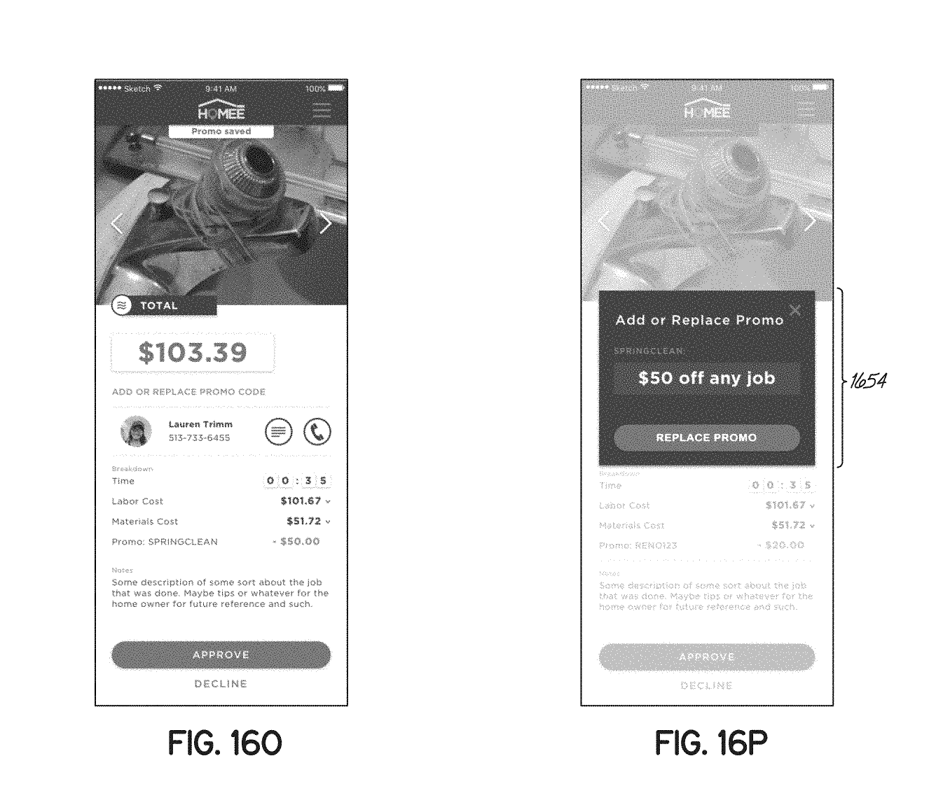

Referring to the screen of FIG. 15I, the consumer screen for an active job may provide the following information:
JOB ID: Unique string which ties together the consumer with the provider, the status changes as the job proceeds through the workflow and ties the final job details to the id (notes, materials list, pre and post images/videos)
Location: Full address of job location. This is important information if there are jobs at multiple locations for a particular consumer. (Field 1531)
Service Type: This is also important for jobs at multiple locations for a particular consumer. (Field 1533)
Time (hours: minutes: seconds)−Total Elapsed Time. (Field 1530)
STATUS (pertains to workflow and status shown in the workflow diagram of FIGS. 5A-5B) For example, the status could be ONSITE, IN-ROUTE, IN-PROGRESS, PAUSED, STOPPED. (Field 1531)
TERMINATE: used to abort the job immediately—Pauses the timer and notifies provider of consumer's intent to stop the job. This can be used for emergency situations, such as when a consumer might not be satisfied that provider is successfully able to complete job, or for other reasons etc.). (Field 1535)
FAST TRACK: this field might be engaged so that the service system 102 backend would automate the acceptance of various timer interactions (pause to resume, pause to stop, stop to suspend, stop to finish) between the consumer and provider. This is to streamline the interaction between provider and consumer as one feature of the invention. (Field 1537)
Provider information bar. (Field 1539)

Referring to FIG. 15A, when the job begins as discussed herein through the consumer App, the consumer is presented with information regarding a provider's years of experience and rates can then decide to have them do the job. As shown in screen 1500 of FIG. 15A provider information is given in fields 1502 and the selectable field 1504 is provided for accepting the provider and their rates and information. Once a provider is accepted, and if the consumer is engaging the system of the invention for the first time they are presented with the ability to “fast track” the job as shown in the screen of FIG. 15B. The fast-track option is explained in the screen in FIG. 15B and selectable fields 1506 provide the consumer with the ability to turn fast-track off or keep it on (default). In one embodiment of the invention, the fast-track option will be kept on for the benefit of the process flow and efficiency. As discussed herein, if fast track is turned off the system of the invention requires more interaction between a consumer and a provider.

As shown in the screen interface of FIG. 15C, once the provider has accepted a job request, information regarding the provider is shown (Field 1508).

Furthermore, the address that the provider is going to for the job as well as their estimated time of arrival is illustrated (Field 1510). Also, information about the job type and the provider status is illustrated (Field 1512). A map field 1514 is also provided to show the navigation of the provider to the job site. Through field 1516 a user may turn the “fast track” option on and off whenever they like. Also, field 1518 allows termination of the job at any time. As illustrated in the screen of FIG. 15D, the estimated time of arrival will show once the provider starts driving to the job site, as illustrated in field 1510 of FIG. 15D. Also, if the provider is stopping for parts, the provider can indicate on their device they are doing so, and the message will be provided to the consumer as illustrated in field 1520 of FIG. 15D.

The work flow may proceed for an individual homeowner or the property may actually be managed, such that the consumer who is ordering the job is a resident of the manage property. In such a case, the screen of FIG. 15F may be presented wherein the provider information of fields 1508 may include information regarding the property manager as shown. As such, if the resident consumer wants to contact either their property manager or the provider they might engage one of the selectable fields 1508 and the screen such as that shown in FIG. 15G is presented providing suitable selectable fields 1522 for either calling or messaging whichever entity is being contacted.

Once the provider has reached the job site, the screen of FIG. 15E may be presented which might include a change of color in the background screen for indicating the status change as shown in field 1520. Other messages might be provided as shown in field 1524 indicating that the timer has not started but may start soon. The provider will then request that they start the job as discussed herein and their job status will change to “ready” (Field 1520) as shown in the screen of FIG. 15H. The consumer is then given the ability to accept or decline the job timer by appropriate selectable fields 1526, as shown in the screen of FIG. 15H. If the start of the timer is accepted by the consumer, such as by engagement of field 1528, the timer screen of FIG. 15I is illustrated for the provider. The timer screen has a progressing timer field 1530 as shown and the screen may take a suitable background color, such as green, to provide the consumer with a quick status information on the active job. The timer will then begin tracking the time that the provider is providing their service on the job. As discussed herein, during the course of the job progression a job might be paused and a screen such as that in FIG. 15J may be provided which is a different background color and a different status indication in field 1520. Similarly, for a completed job the screen of FIG. 15K might be illustrated with another different background color and status indication in field 1520. In that way, the inventor provides an immediate indication of an active job status to the consumer.

During a pause and the screen of FIG. 15J, the timer has stopped its tracking and freezes at the current time. For completed jobs as discussed herein as shown in FIG. 15K, a message 1532 might indicate that the provider is compiling information regarding the completed job and informational fields 1534 might provide labor and material cost information along with additional information on job completion. For certain jobs, as discussed herein, limits may be placed on the job and thus information regarding such limits might also be displayed to a consumer. To that end, as illustrated in FIGS. 15L and 15M for ongoing and paused jobs, informational fields 1540 may be provided to show visual indication of the percentage of limits that have been reached currently or may allow a consumer to select further details regarding the limits and the progression of the job.

The consumer is provided the ability to start a timer as illustrated in the screen of FIG. 15H. If for some reason they indicate they are not ready such as by engaging field 1529, the consumer is presented with a screen of FIG. 15N where they can engage an appropriate field to either call the provider or dismiss the modal field that is part of the screen. If they decline the timer the consumer might be brought back to the screen similar to that of FIG. 15E with the provider indicated as on-site.

As discussed herein, a property manager will interact with job requests for a managed property wherein the consumer is a resident of the managed property. The property manager can view information regarding active jobs and will be provided screens similar to those that are provided to the resident/consumer such as the screens of FIGS. 15C, 15E, and 15I, for example. But the property manager will not have the ability to terminate the job from those screens and thus consumer screens may appear as illustrated in FIGS. 150, 15P, and 15Q for the property manager. Those screens indicate jobs without limits. If limits might be involved, a screen such as that shown in FIG. 15R is illustrated with fields 1550 with information regarding the percentage of limit reached as well as a selectable field for detail. The screen of FIG. 15S is presented to a consumer/resident or property manager upon requesting more detail regarding the limits from the selectable field 1550. Therein, job information might be provided in fields 1552 that show the amount of the cost limits for both parts/materials and labor as well as the estimated time for the labor.

As noted, an active job may be terminated at any time by a consumer, such as by selecting field 1518, which remains in the various active job screens as illustrated in the Figures. Once termination is selected, the consumer is presented with the screen of FIG. 15T where they are presented with a confirmation message filed 1554 letting them know about the termination. For example, they may be informed that they will have to pay all the fees up to that point in the job unless there is some further issue, such as inappropriate conduct. The consumer can rethink the termination or proceed with it based upon engaging one of the fields 1556. Upon continuing with termination, the screen of FIG. 15U is presented to the consumer wherein they are required to give feedback through selectable fields 1560 and a note field 1562. Once they have provided that feedback it may be applied to then complete the termination as illustrated in the screen of FIG. 15V and upon termination of the message they will be brought back to a home screen is shown in FIG. 15W.

A consumer may also allow a job to be suspended or paused. If a job is paused, a screen as illustrated in FIG. 15J is presented to the consumer. A pause might be requested for a short time situation wherein the job is to then be quickly resumed. However, if the job is to stop for a longer time, the job may be suspended by selecting the appropriate field. In such a case, a screen as shown in FIG. 15X is presented which may have a color change in the screen to provide a visual indication of a suspended job. For example, the screen might be gray. Field 1564 indicates the suspended status and field 1566 provides a breakdown of the job progress and expenses. Also, the consumer is provided with information as to why the job is suspended by the provider in field 1568. The consumer can acknowledge the suspension or terminate the job as noted in the selectable fields 1570. If the suspension is acknowledged, the consumer is presented with the screen of FIG. 15Y. Also, the consumer can find the suspended job in their job history as selected in FIG. 15Z. As shown in FIG. 15AA, in job listings a suspended job might be indicated separately through field 1570. Clicking on any one of the fields, such as field 1570, additional details regarding the job and it might be provided is shown in the screen of FIG. 15BB in where job status, accrued labor/costs and notes are shown along with information regarding the provider.

During a suspended job if a consumer has no other jobs ongoing they may be presented with the home screen as illustrated in FIG. 9A, such as for ordering another job. Then, when the provider indicates from their device that they want to continue or unsuspend the job, the consumer is presented with the screen of FIG. 15CC with a notification field 1571 indicating that the provider wants to resume the job that day and a message explaining how to restart the job. A resident can get details of the job by engaging field 1572. Also, they can select a suitable start time through engagement with field 1573. By selecting one of the fields of 1574 they can restart the job or indicate that it is not a good day for the provider to come back to the job site. Upon selecting job details of field 1572 the consumer is presented with the screen of FIG. 15DD. Alternatively, in selecting a start time the consumer might be presented with the screen of FIG. 15EE. Finally, when ready to resume the consumer can select the restart field 1574 and the unsuspended job will resume as illustrated with respect to FIGS. 15D-15I as discussed herein.

If the consumer is currently in an active job and is presented with the timer screen of FIG. 15I, a request by the provider to unsuspend or resume a job will present the screen of FIG. 15FF wherein a modal field 1575 is presented with an informational field regarding the provider resuming the job and giving the consumer the ability through selectable fields 1576 to view the details of the job and restart it or dismiss the restart. If the consumer desires to restart or unsuspend the job they will then be presented with the screens of FIGS. 15CC-15EE and further job follow-up screens of FIGS. 15D-15I until the job and associated timer are again started. In that way, in the workflow, the consumer can restart the job, pick a start time and proceed.

A consumer or property manager may have multiple jobs ongoing. As such, through an appropriate drop-down menu the consumer/resident or property manager may review the various active jobs. The screen of 15GG may be presented allowing the consumer to contact a provider, see the location of a job, an ETA and/or status with any distance information. With four or less jobs, the card view as illustrated in the screen of FIG. 15JJ might be provided. Tapping that card view lead to FIG. 15KK which is a larger screen, for a particular job.

As indicated in FIG. 15GG if there are four or fewer jobs the various card views might be illustrated by swiping left or right. Alternatively, if there are five or more jobs, the screen of FIG. 1511 might be presented and various smaller cards might be presented. Tapping on those may yield a similar view as shown in FIG. 15JJ. The view may also incorporate a search field 1577 as shown in FIG. 15JJ where a consumer can search or filter the list of active jobs by job status, service types, or location for example. Other search criteria might be utilized. A property manager might also be able to look at the various active jobs in a similar fashion. Referring to FIG. 15KK, in addition to the provider information, the property manager might also have information regarding the resident or consumer for the purposes of contacting them about the job.

As described herein, when a job begins and is paused or suspended the provider will request that the job again resume, and the consumer will be presented with the ability to approve the resumed job, or not. The various job flow described with respect to FIGS. 15A-15KK for example, may proceed as noted with a fast track feature set to ON. This thus eliminates some of the interaction back and forth between the consumer and provider to streamline the process. However, fast track may be turned off and the interaction flow between consumer and provider will add additional steps for allowing a consumer to control the job flow. For example, the consumer can control when the job is paused and resumed as well as when the job might be put into a suspended state. For example, as discussed with respect to FIG. 15X, when fast track is on, a provider can simply suspend the job and the consumer will have control over when the job is restarted. However, if fast track is off, the provider will have to get permission from the consumer to actually suspend the job.

Referring to FIG. 15LL an active job is illustrated with a timer. When the provider seeks to pause the job, a modal message field of 1578 opens indicating the pause attempt along with the information regarding the location of the job as shown in the screen of FIG. 15MM. Through fields 1580, the consumer can accept or decline the pause. If the pause is accepted, a pause screen as illustrated in FIG. 15NN is presented and the job proceeds to a paused status. A message field 1581 might also be provided to indicate that the pause is accepted. However, if the pause is declined as illustrated in FIG. 1500 the job remains active with the screen indicating that there's a job in progress. Message field 1582 then indicates that the pause was declined.

When there is no fast track, a job that is paused then must have permission to be resumed. A paused job is illustrated in the screen of FIG. 15NN might be resumed by the provider who engages the appropriate field in their paused job screen. As illustrated in in the screen FIG. 15PP, a modal message 1583 is provided to the consumer for resuming the job with suitable location and job information and fields 1584 for the consumer to provide an acceptance of the job resumption or to decline. If the resume request is accepted by the consumer, the consumer is presented with the active job screen of FIG. 15QQ with a suitable message 1585 indicating that the resume was accepted. However, if the resume is declined, the job will stay paused as indicated in the screen of FIG. 15RR with a suitable message 1586.

Similarly, the consumer can control the job completion process. For example, if the provider indicates that the job is complete by engaging their devices appropriates in the selected complete job field, a modal message 1587 appears in the consumer App providing information regarding a job as well as selectable fields 1588 for accepting or declining a completion process. If the consumer accepts that the job is complete they are presented the with screen of FIG. 15TT with a suitable message field 1589 that a receipt for the job is in progress. However, if the completion process is declined by the consumer, consumer will then be presented again with the paused screen as shown in FIG. 15UU with an appropriate message field 1590 indicating that the completion request is declined.

In accordance with another aspect of the invention, the consumer can control the suspension process. For example, if a job is to be suspended by the provider, the consumer is presented with the screen of FIG. 15W with a suitable modal message field 1591 regarding the requested suspension. Fields 1592 give the consumer the ability to accept or decline the requested suspension. If suspension is accepted, the consumer will be presented with the screen of FIG. 15WW with a suitable message 1593 indicating that the suspension is accepted and providing additional information fields 1594 about the suspended job. The job will then transition into a suspended state. However, if the suspension request is declined, the consumer is presented with the screen of FIG. 15XX with a suitable message 1595 that the suspension has been declined. The job will then stay in a paused state or other previous state prior to the suspension request.

Once a job has been completed, the two parties of the system must then settle the transaction by receiving a receipt for the work done from the provider and then having the consumer approve the receipt for payment purposes. For to the screen of FIG. 15TT, when a job has been completed, the provider proceeds with putting together a receipt and then sending it to the consumer. As discussed herein, the provider receipt will have information including material and labor cost, time, as well as any photos.

Referring to FIG. 16A, once the provider sends the receipt, the consumer App presents the screen of FIG. 16A which includes information fields about the job, such as photos of field 1600, time and cost information such as fields 1602, contact information for the provider in field 1604 information and notes about the job in field 1606, and selectable fields 1608 for approving or declining the receipt. Certain fields, such as photos and notes might be required for every job in one embodiment of the invention. If the consumer approves the receipt, the system will have the consumer rate the provider. As such, the consumer App presents the screen of FIG. 16B with selectable fields 1610 for rating the provider, such as from 1 to 5 stars. Once the rating is provided, it can be submitted through field 1612. The consumer is then return to the beginning map screen as shown in FIG. 16C. Once the receipt is approved and any other requirements, such as rating the provider, are addressed, the transaction will be complete, and money will move from the consumer account to the provider account. The consumer could be a homeowner or a property manager. In a managed property situation, the property manager will be paying, unless the resident has been given the job with payment responsibility as disclosed herein. If a provider is operating in independent mode, the provider doing that work will receive the payment in their account. If the provider is an employee of a company and is operating as such an employee, payment would go to the account of the employer provider.

In one embodiment of the invention, the provider can be made into an “favorite” of the consumer. As a favorite they can get priority with respect to future jobs.

Referring to FIG. 16D, field 1620 may be selected for making that provider a favorite. If it is the first time that a consumer has made a pro into a favorite status, the consumer represents the screen of FIG. 16E providing information about what it means to favorite a provider. Various search protocols use that status as disclosed. Once the rating and favorite status is provided, field 1612 may be engaged to submit the rating.

Once a provider is a favorite, and a consumer has named one or more favorites, as illustrated in FIG. 16F, the consumer start screen will include a field 1622 indicating favorites. Engagement of that field presents the screen of FIG. 16G in the consumer App with a listing of online favorites and off-line favorites 1626. Engaging one of the favorite card fields for provider as listed will present the profile for that provider to the consumer as illustrated in FIG. 16H. The providers contact information and photo field 1630 will include a suitable icon indicating that they are a favorite provider, such as a heart. Other information regarding the provider is also shown the profile as such as services 1632 ongoing and completed jobs 1634, etc. As noted, the various fields in the provider's profile might be engage for showing additional screens with information including company details as well as details on jobs.

In accordance with another embodiment invention, the provider might be made a favorite right from the provider's profile. That is, there may be a field that is engageable to make the provider a favorite.

Alternative to a favorite provider, one or more providers might also be blocked so that they will not then again be assigned to a job or get a job request from the consumer. To that end, as illustrated in the screen of FIG. 16I an engageable field 1645 might be highlighted in order to block the provider the fields to favorite or block are toggle fields that can be toggled ON and OFF. If the consumer blocks a provider for the first time, informational screen of FIG. 16J is provided to explain the blocking process and to allow the consumer to proceed or cancel the process (Field 1642).

While a receipt generally may be approved, the receipt can also be declined as illustrated in the field 1608 of FIG. 16A. If the receipt is decline, the consumer app resents modal field 1644 which confirms and explains the declined receipt and provides field 1646 for calling the provider or continuing in the process. If the receipt is declined, the consumer is presented with the pause job screen of FIG. 16L.

As illustrated in the screen of FIG. 16A, the total price is presented. In accordance with one feature of the invention, a consumer might have one or more promotional codes associate cost reduction features. Referring to FIG. 16A, field 1605 might be engaged to add or replace a promo code within the receipt. Engaging field 1605 will present the modal field 1650 as illustrated in screen 16M. In the modal field, the promotional code may be entered and then submitted. Once the code has been submitted, the modal field of 1652 as shown in screen of FIG. 16N will allow the promotional code to be applied to the receipt and it will be reflected in the total price as illustrated in the receipt screen as shown in the screen of FIG. 16O. If a promotional code all already exists such as the code shown in FIG. 16O, and the consumer wishes to replace that promotional code, they can again engage field 1605 then, upon entering a new promotional code is shown in FIG. 16P, field 1654 will provide them with a subfield for replacing the promotional code.

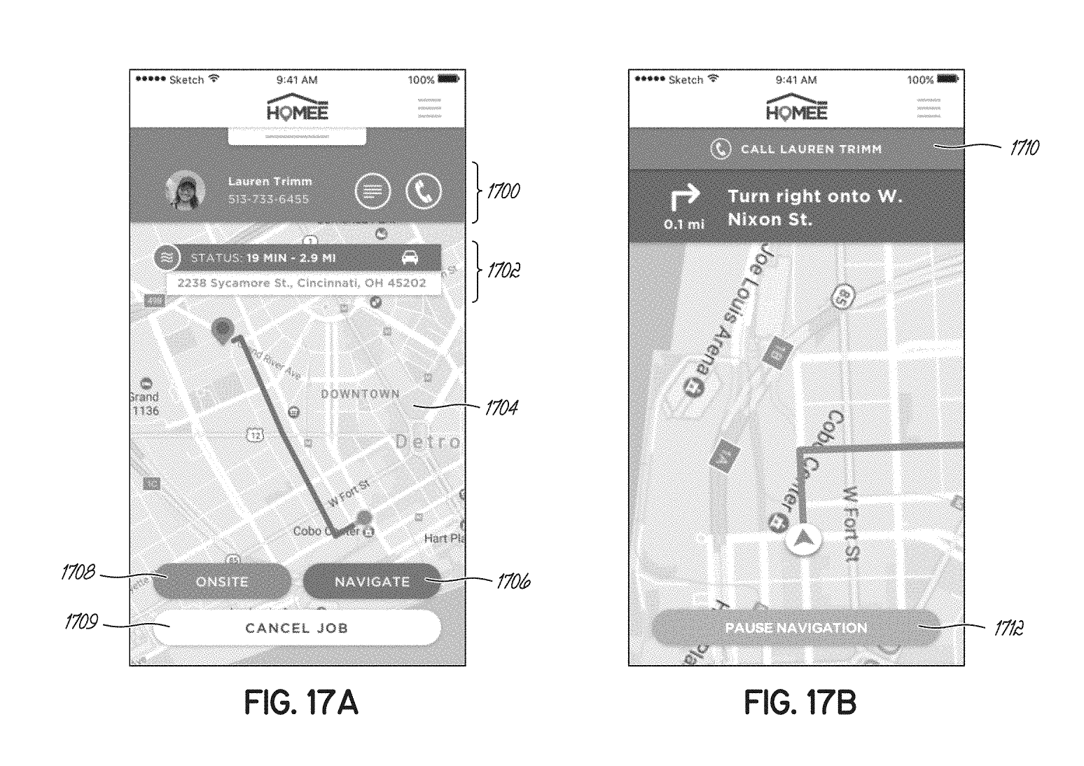

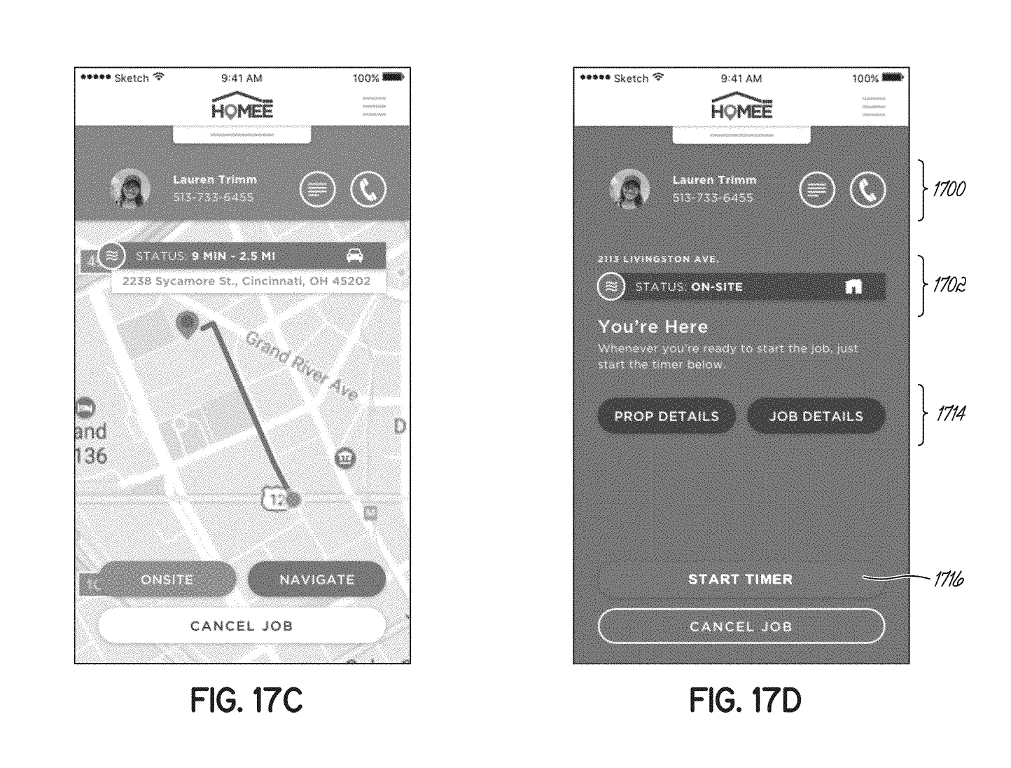

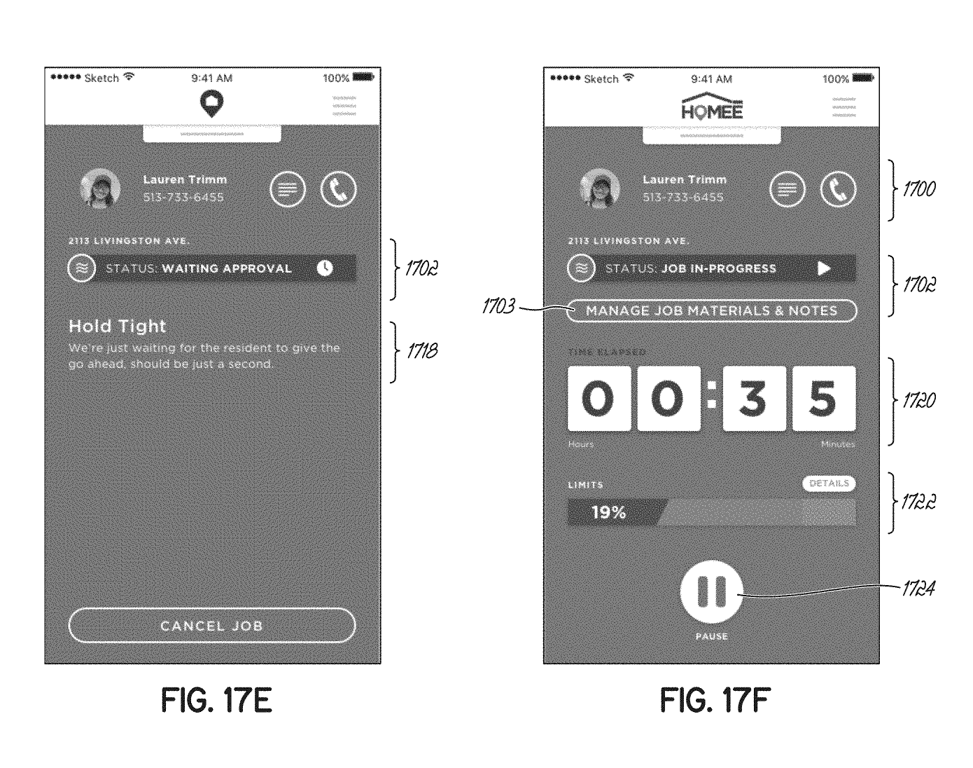

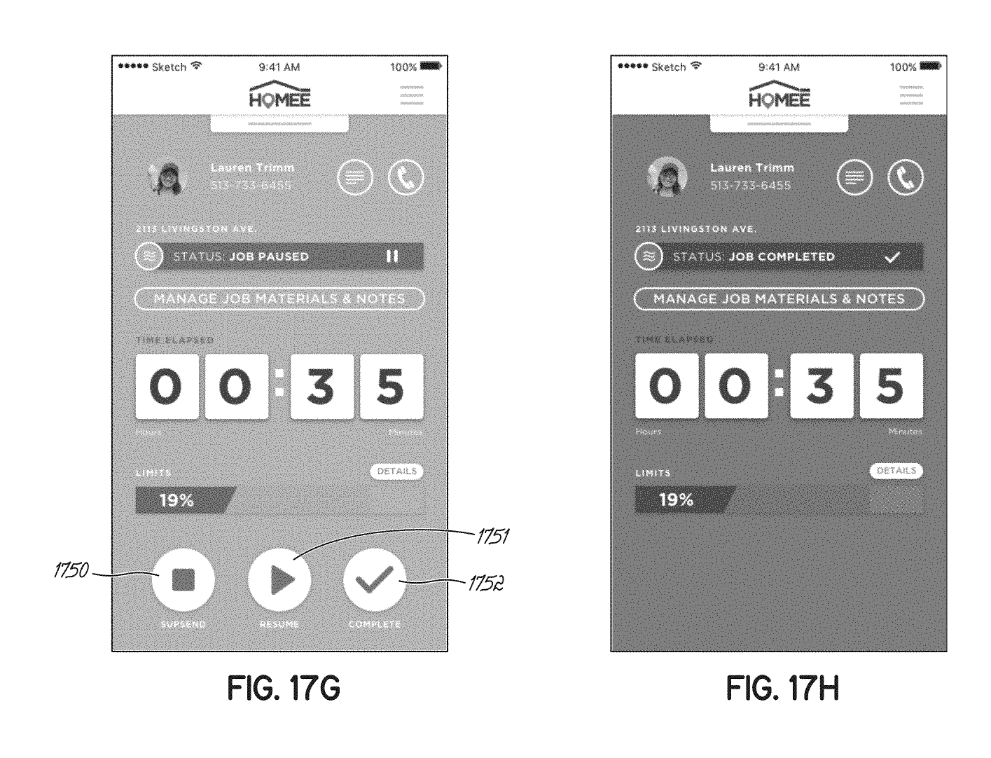

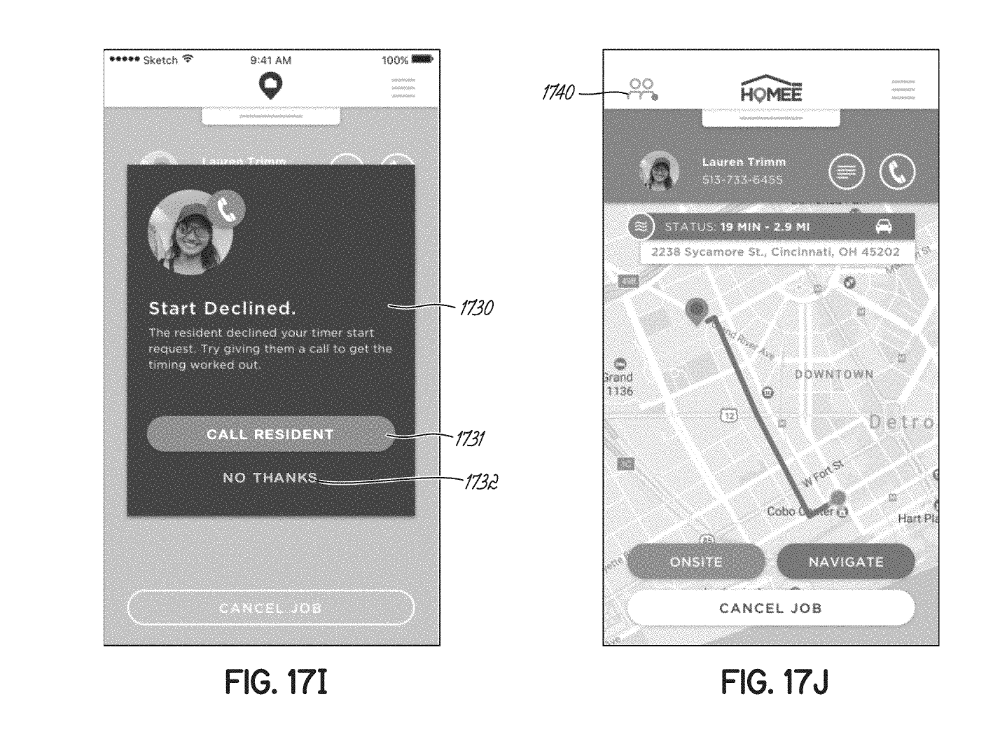

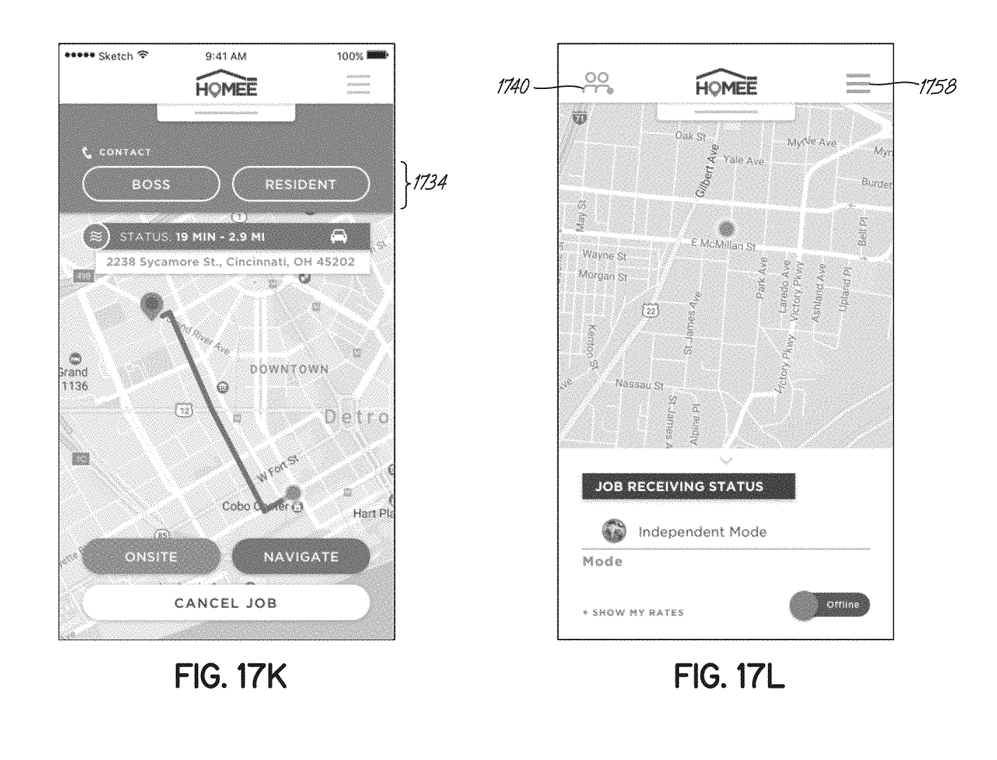

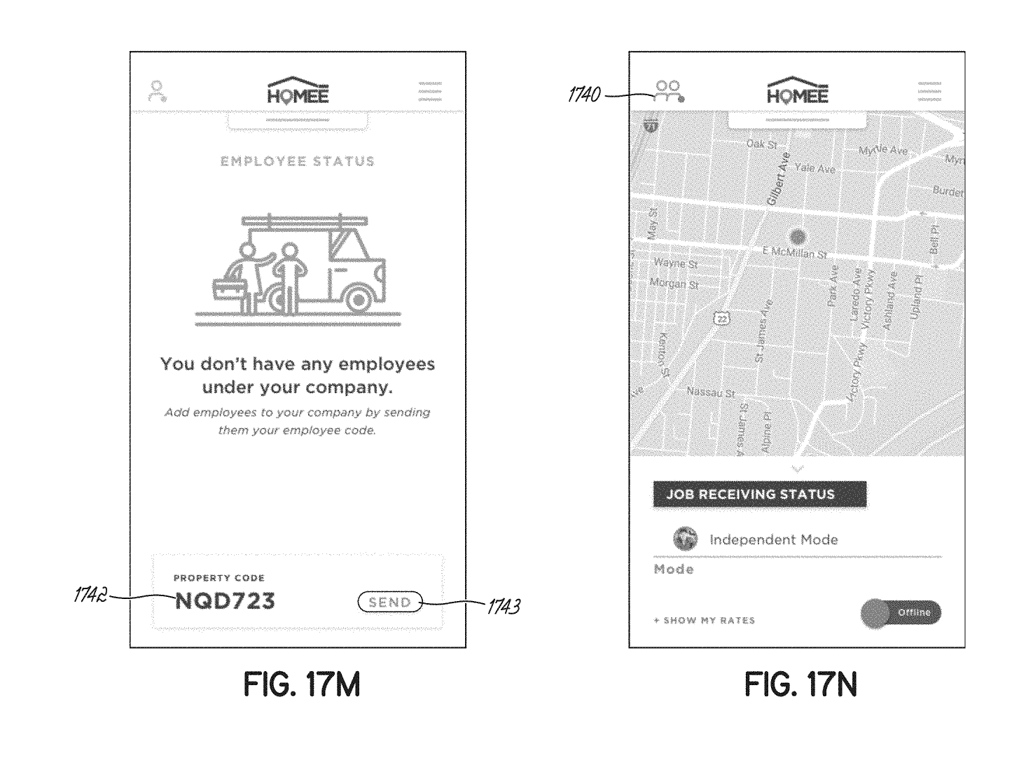

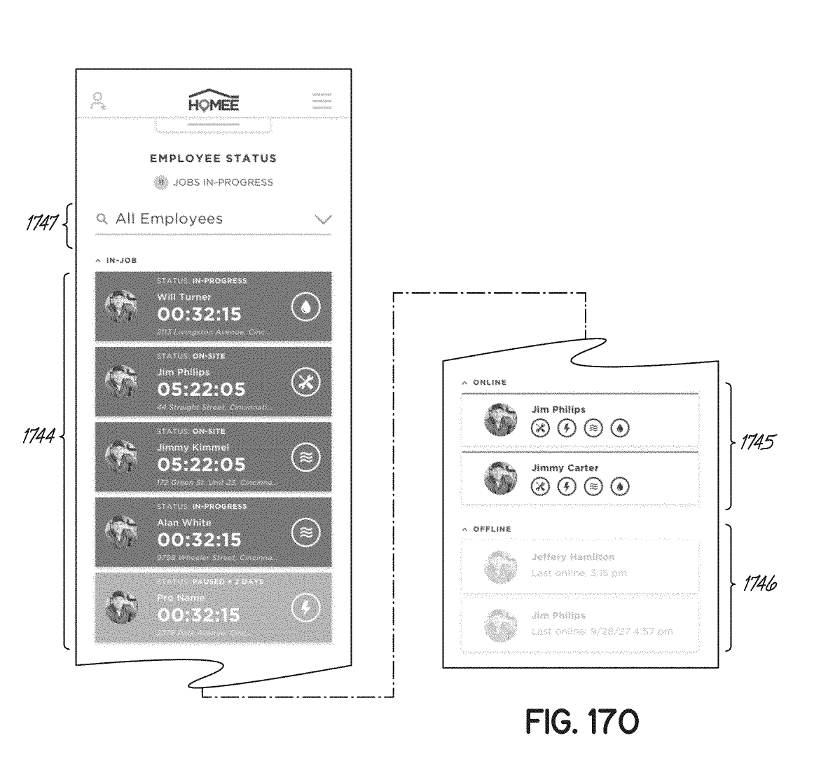

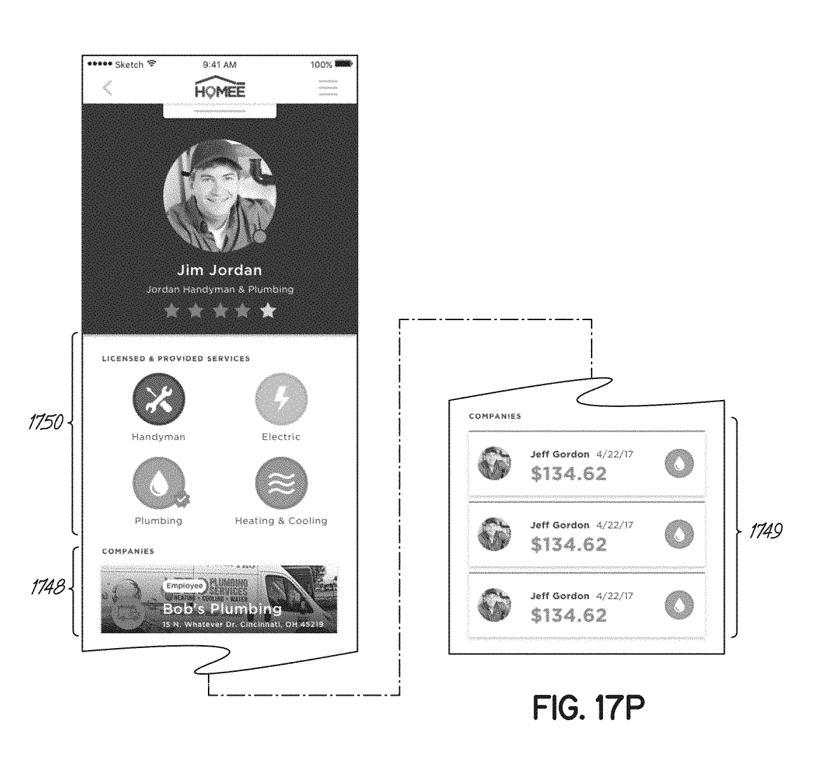

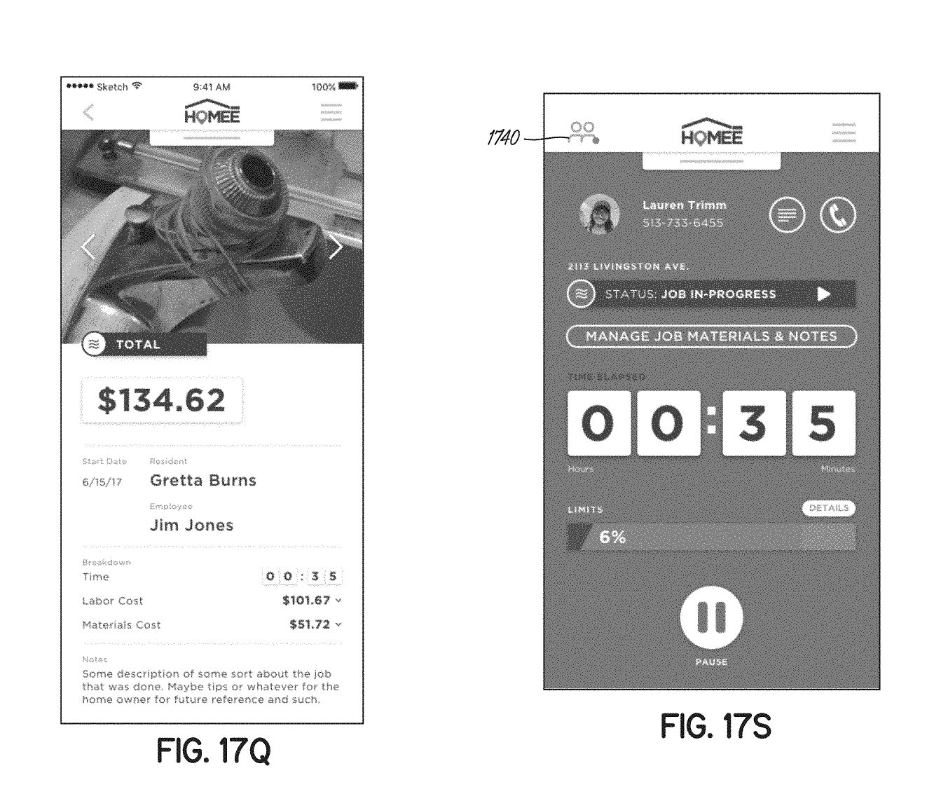

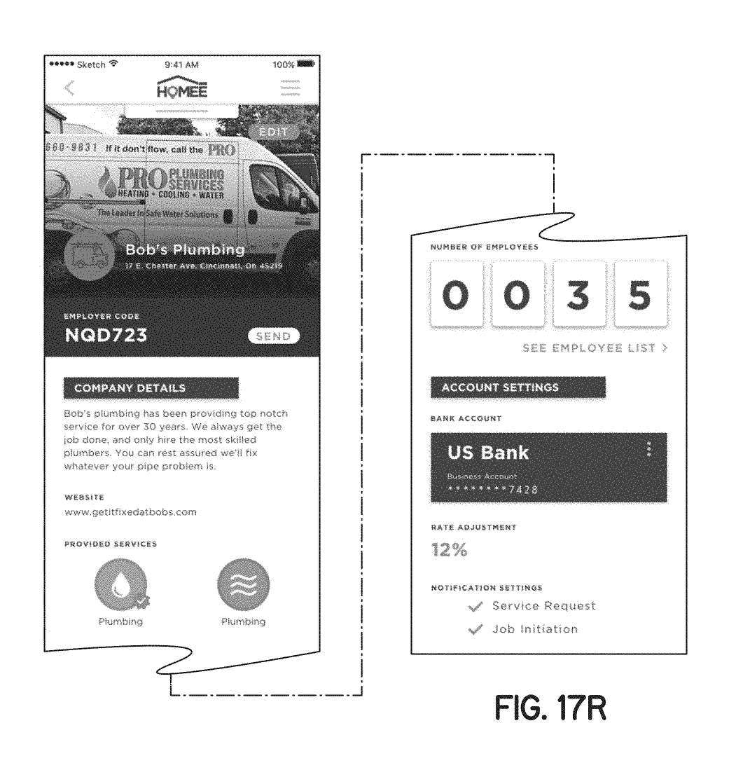

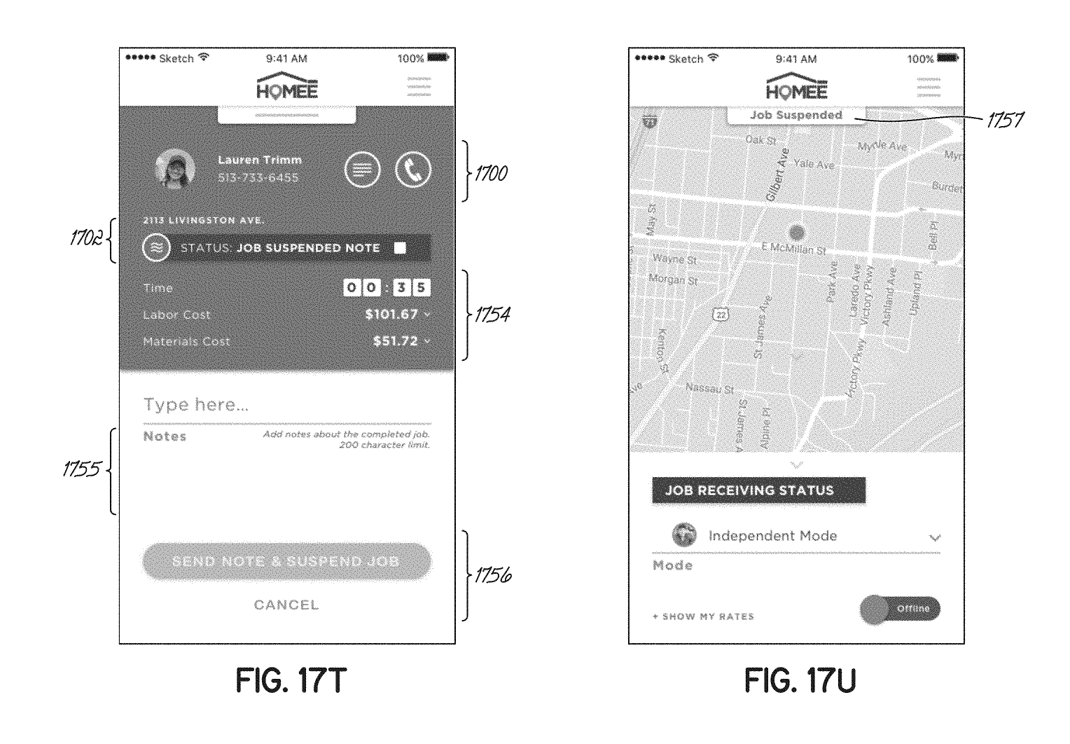

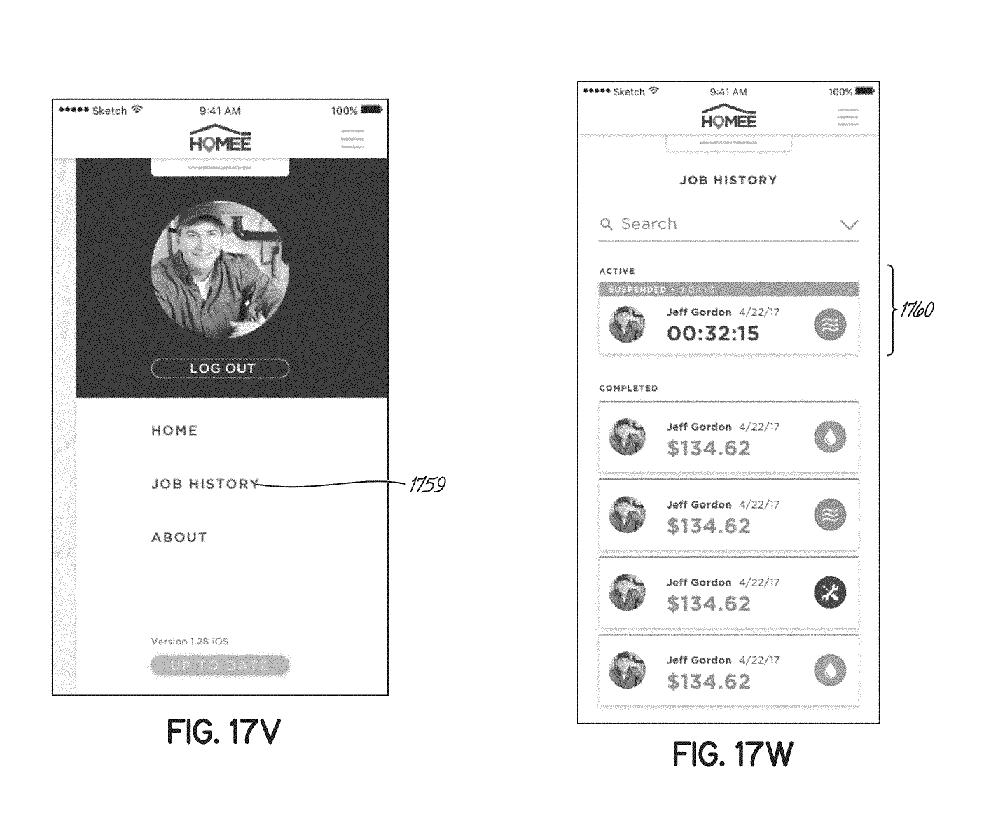

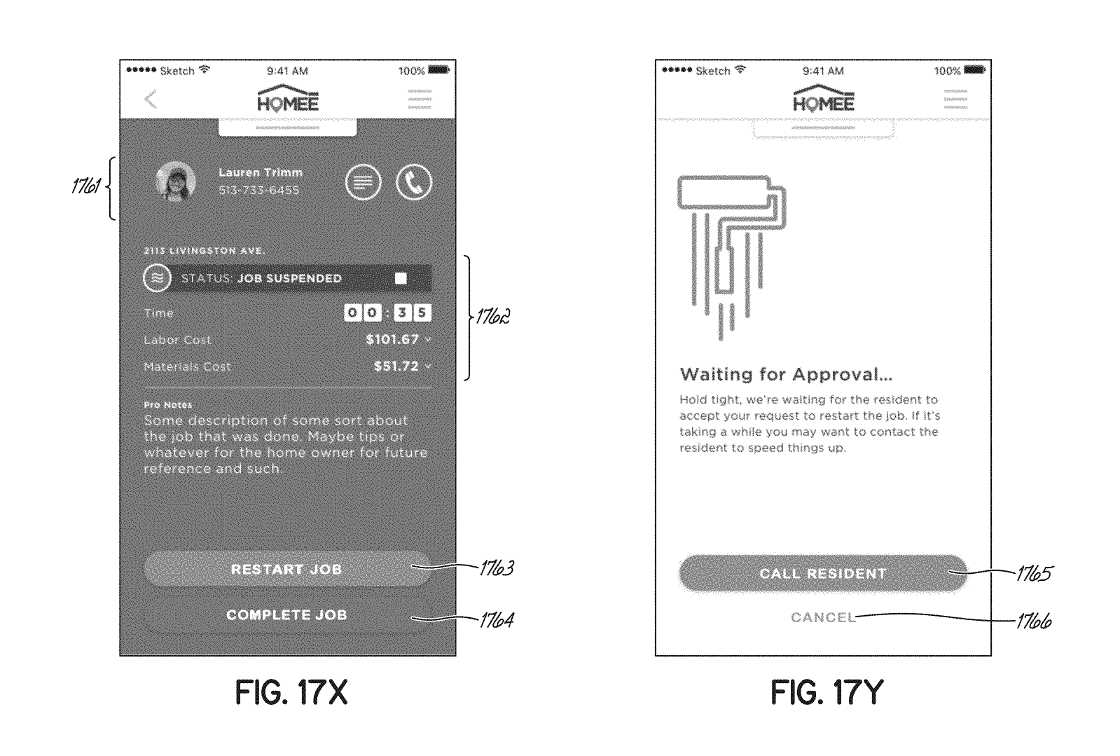

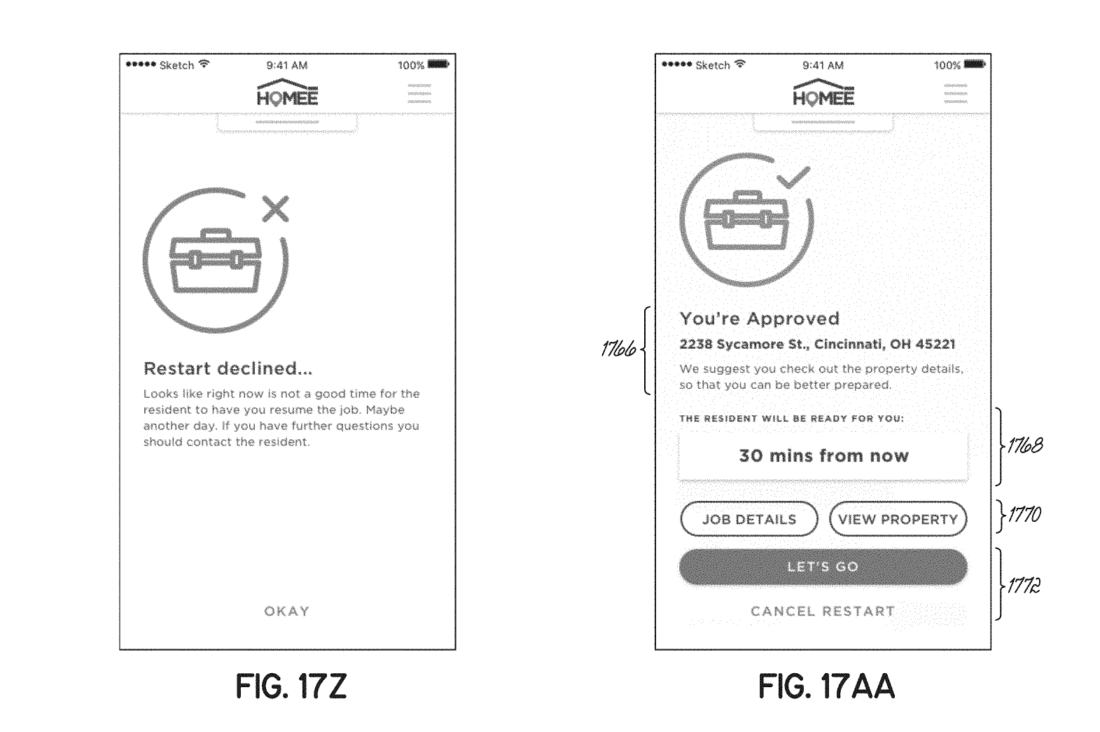

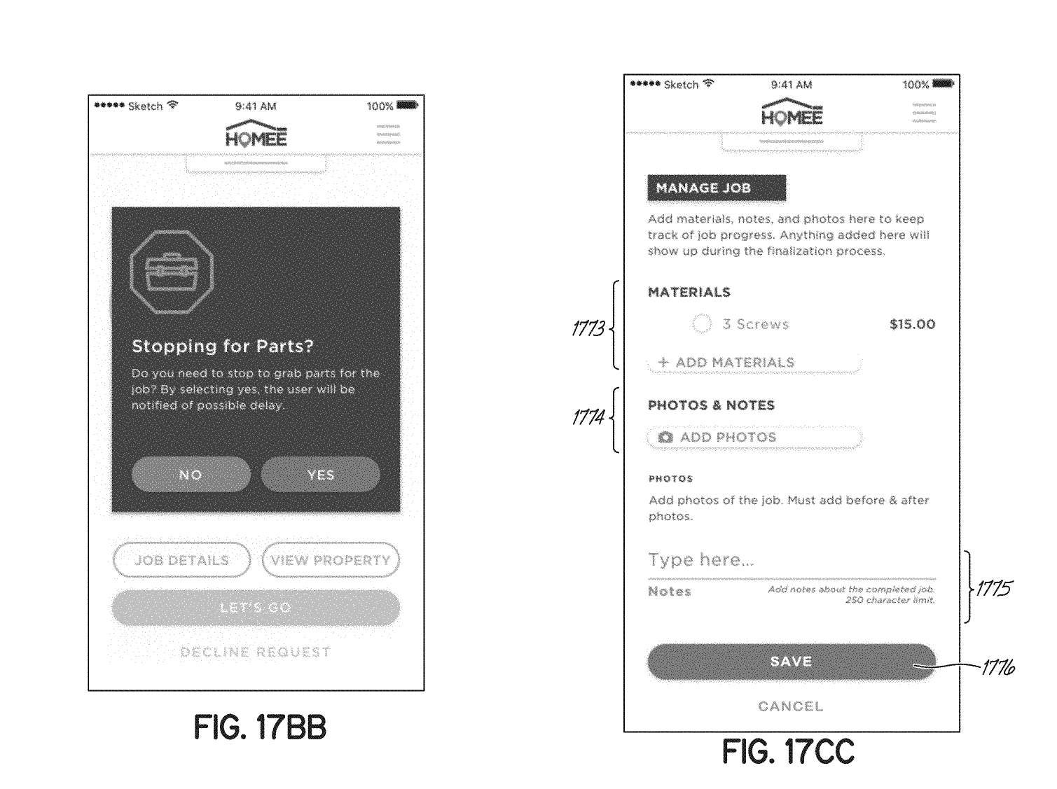

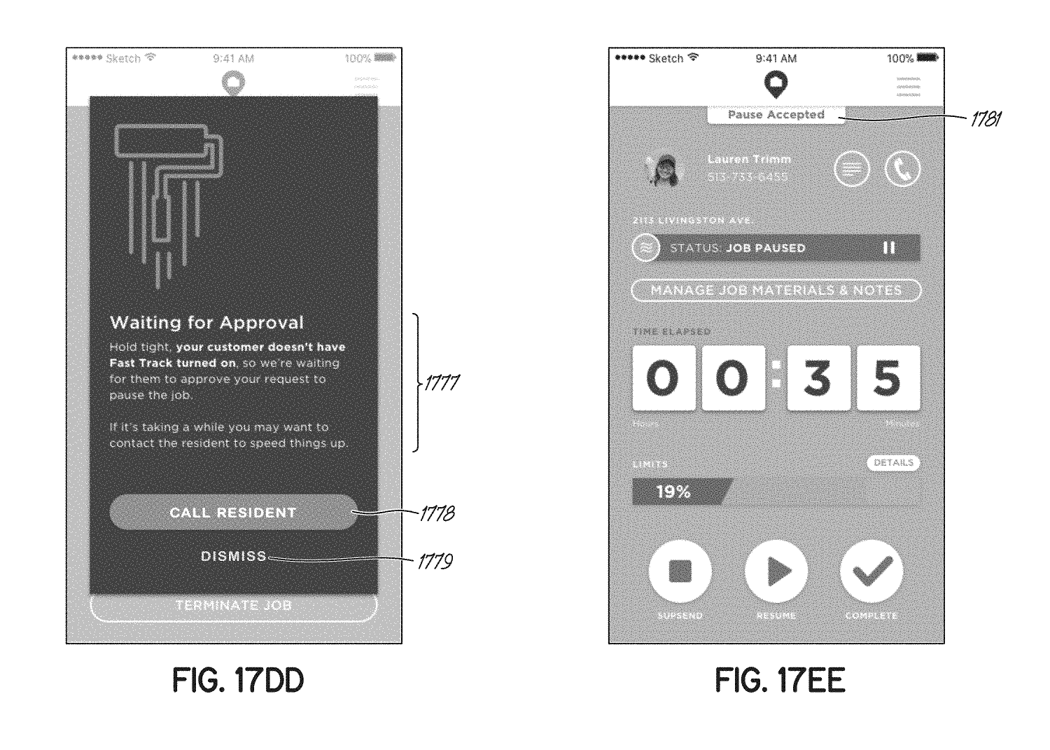

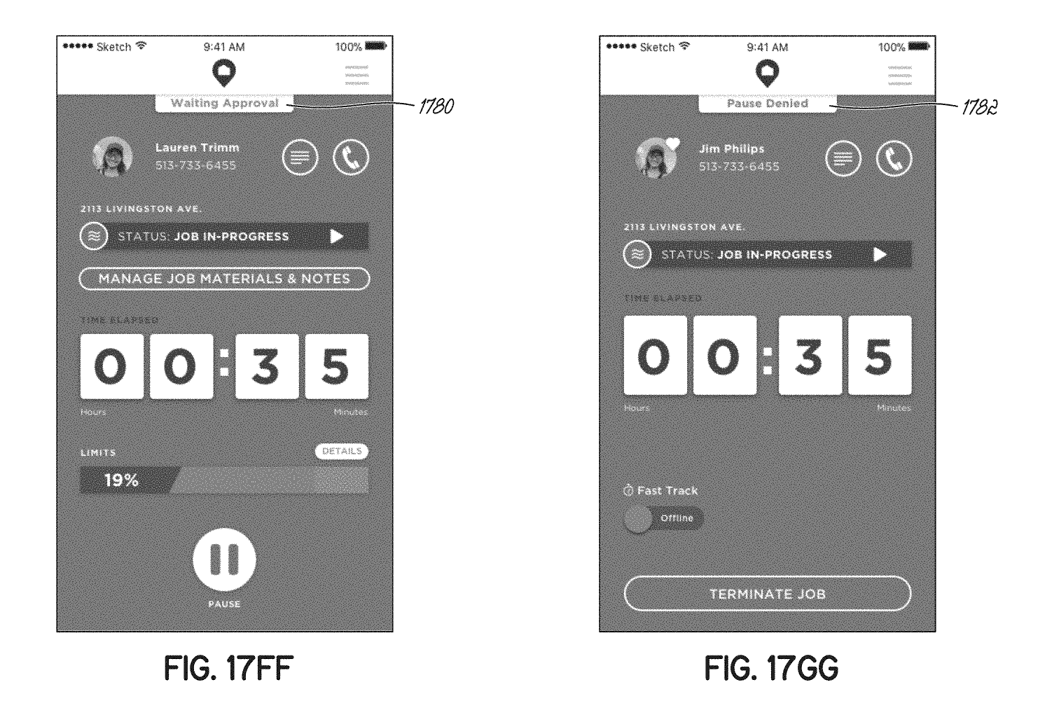

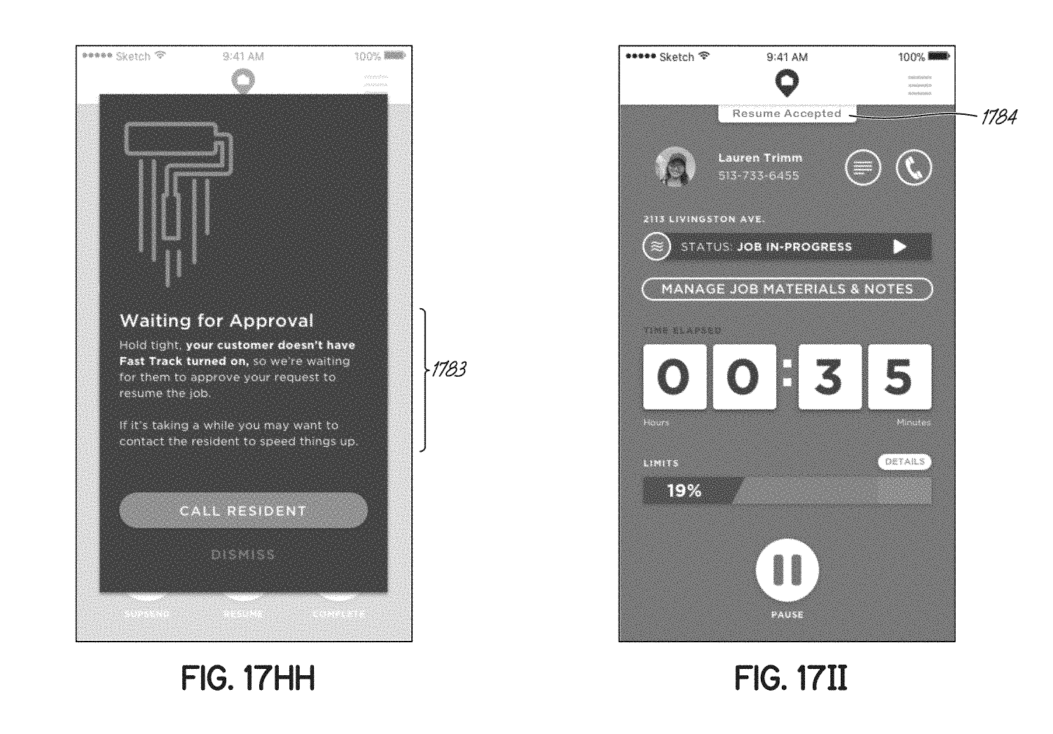

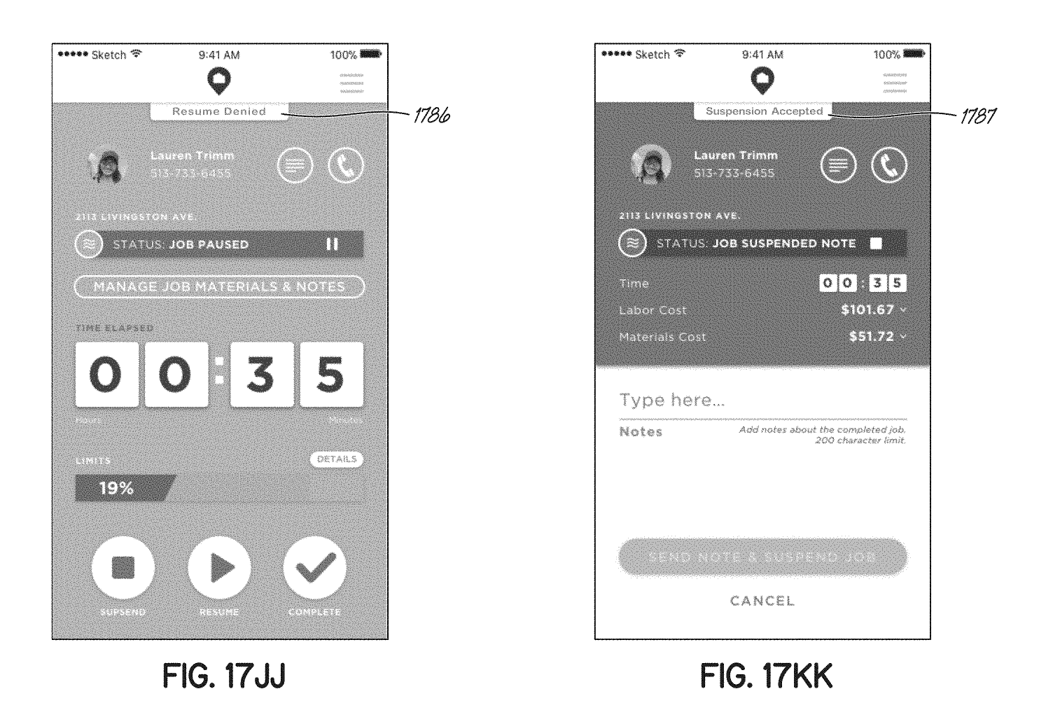

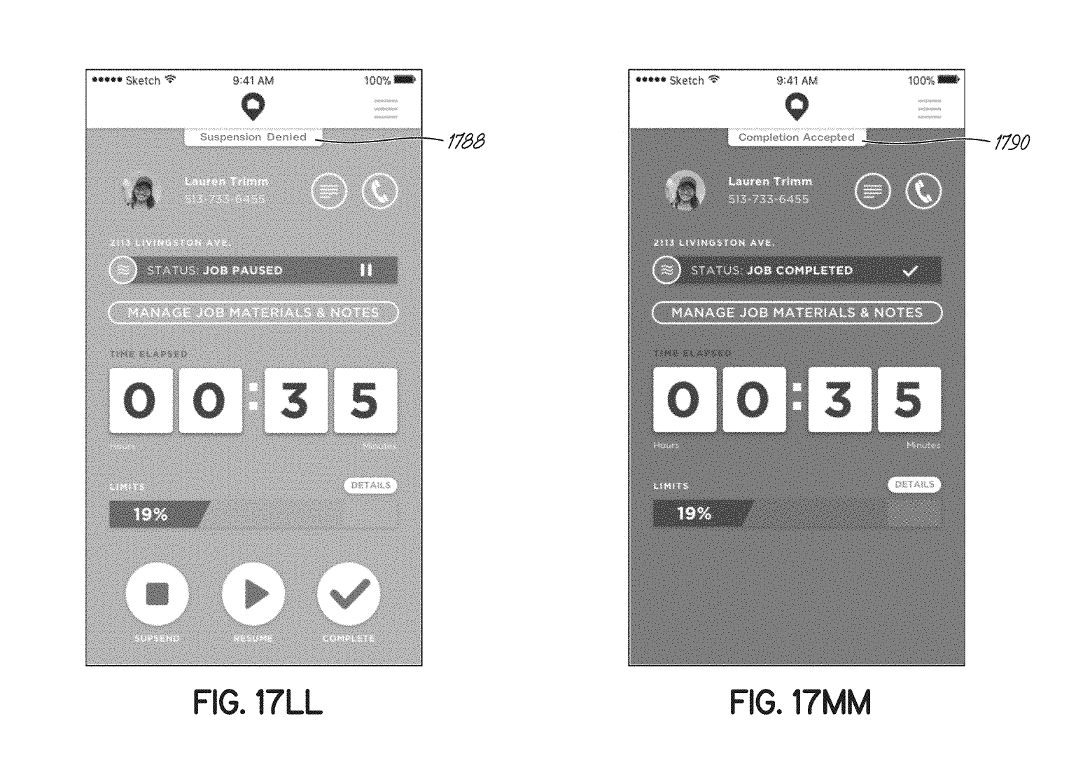

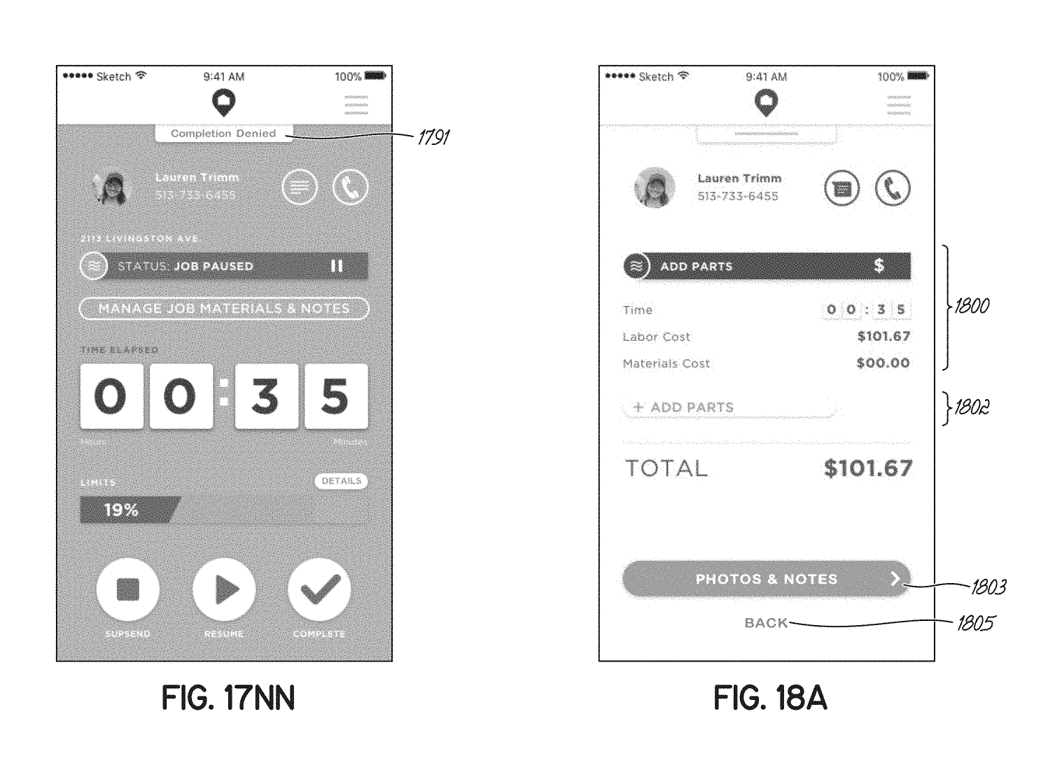

For the provider active job workflow, the screen of FIG. 17A is presented to a provider, such as an independent provider, when a job has been accepted and is to begin. The screen includes information about the consumer in field 1700 so that they might be contacted. Information about the service type and the time and distance from the job site as well as the address of the job site might also be provided in fields 1702. A navigation map 1704 is provided so the provider can watch as they move along a computed route. Navigation can begin with engagement with field 1706 and navigation will occur utilizing an appropriate mapping application in the system, such as Google Maps. Also, if navigation is not utilized but the provider arrives on site, the provider can indicate that they are on site through field 1708. Also, through an appropriate field 1709 the job can be cancelled.

Referring to FIG. 17B, upon navigation the user will get typical navigation instructions through the map process. Also, through field 1710 the consumer may be contacted. The provider can pause navigation through field 1712. Pausing navigation will present the provider with the screen of FIG. 17C which has various of the information fields and selectable fields as FIG. 17A.

Once the provider is on-site, the screen of FIG. 17D is provided. The on-site screen for example may turn a different color, such as gray, due to the geofencing function of the map applications once a provider pulls into the designated address or location. Various of the information and contact fields remain as does the status field for the job. Rather than navigation the status as illustrated in FIG. 17A will be an “on-site” status. The job is now ready to be started by the provider. Through selecting fields 1714 a provider may see property details as well as job details associated with the job site. The timer is then ready to be started and through field 1716, the provider can then request that the timer be started. In accordance with one aspect of the invention, since the timer has to be approved by a consumer a waiting screen of FIG. 17E is provided with suitable message fields indicating the waiting process and the status changed to “waiting approval”. Once a timer has been accepted by a consumer the screen in FIG. 17F is presented with a suitable timer field 1720 and other informational fields. Also, if the job has limits indication of the progression of those limits might also be provided similar to what is provided to a consumer as illustrated in field 1722. The job will then progress. A provider can stop or pause the job through field 1724. Then the job would progress as typical with different status indications provided by different background screens similar to the consumer job flow screens. For example, FIGS. 17G and 17H might indicate paused and completed jobs.

If, for some reason, a start of the timer is declined, and the provider is in the waiting screen, the provider is presented with screen of FIG. 17I with a modal message field 1730 indicating that a start has been declined and prompting the consumer to call the resident through engagement with field 1731. An additional field 1732 can allow the consumer to dismiss the declined timer. The provider will then again be provided with a screen similar to FIG. 17D.

As noted herein, an employer of service providers can act as a service provider themselves and can also set up a company under which the other employee service providers are engaged. To that end, as illustrated in FIG. 17J, a provider's navigation screen might also indicate a field 1740 indicating that they are an employer and that they can access information regarding other employee service providers and their jobs and job status. Acting as an employer service provider they can also accept job requests and perform jobs. With an employer accepting a job and arriving at the job site through screen 17J, the job flow will proceed as noted with respect to FIGS. 17A-17I, for example. The start timer can then be started or declined as noted.

If the company has been set up, the service provider might be an employee of the company. As such, when a job is beginning as indicated by the navigation screen of FIG. 17K, the contact information of field 1734 might include engageable subfields for contacting not only the consumer, but also the employer or boss. Such contact fields may remain throughout the various screens, such as screens similar to those shown in FIGS. 17A-17I in order for the provider to make the necessary contact. Generally, such contact may be through a phone call or a text message. The job navigation, arrival and start of a timer will then proceed in the described manner and illustrated in FIG. 5D.

As noted, an employer may have a provider screen with the suitable field 1740 indicating that they are an employer and will have one or more employees that they may be responsible for. Engaging field 1740 will allow an employer to review the jobs of their employees. As discussed herein with respect to setting up a company, an employer will send a code to an employee and ask them to join their company. FIG. 17L illustrates a home screen of an employer with field 1740 indicated. If field 1740 is engaged and the employer does not have any providers added as employees their employee page will generally be empty and they will be presented with a screen of FIG. 17M where they can send the employee code 1742 directly from the page by engaging an appropriate field 1743. The field 1740 may also include particular indications, such as badges etc. that change color depending upon whether the employer is engaged in an active job. That is, the employer might be engaged in an active job and may still be able to check on various employees and their active jobs. In the screen of FIGS. 17L and 17M the field 1740 has a gray badge on the icon and thus indicates that the employer is not in an active job. If employees have been added to the company, engagement of field 1740 through the screen of FIG. 17N will provide the screen of FIG. 17O as an employee page. Employees of a company of the provider are listed with various active jobs and their status through fields 1744. Various employees might also be indicated as online or offline through fields 1745 and 1746. The search field 1747 is also provided to search the various employees with appropriate search criteria such as the name of the employee, the status of the job, etc. The page of FIG. 17O may be manipulated as appropriate to show different information regarding the various employees. Engaging an icon indicating a specific provider, the employer might be presented with the screen of FIG. 17P which indicates the services provided 1750 as well as information about the company 1748 and past job receipts 1749 for completed jobs. As may be appreciated, engaging certain selectable subfields within the fields will provide additional screens with information regarding each of those areas. For example, the screen of FIG. 17Q might indicate information regarding a past completed job receipt. The screen of FIG. 17R might indicate company information and the company profile which indicates the employees of the company as well as the services provided and other information. Furthermore, as shown in FIG. 17R the employer code might be sent from the screen of FIG. 17R as well.

As noted, an employer might also be actively engaged in a job. As such, rather the screen of FIG. 17N, the screen of FIG. 17S might be presented to an employer provider indicating their current job. From there, through field 1740 the various other employees might be monitored or evaluated as set forth in FIGS. 17N-17R.

As discussed, an ongoing active job may be suspended. Referring to FIG. 17F, field 1724 allows a job to be paused. Then, the pause screen of FIG. 17G presents fields for suspending the job 1750, resuming a paused job 1751, or completing a job 1752. If the job is suspended, the screen of FIG. 17T is presented to a provider and the background may change to a different color such as gray to indicate the suspension. The status set forth in the field 1702 might indicate that he job has been suspended. Furthermore, through fields 1754, information regarding the job fees and time of the job might be provided. For suspension, the provider must leave suitable notes in field 1755 and then finalize or cancel the suspension through appropriate fields 1756. Generally, the subfield for sending the note and suspending the job may not be engageable until suitable notes have been presented in field 1755. Once the job has been suspended and the consumer has approved of such suspension, the home screen as illustrated in FIG. 17U might be presented to the provider with an appropriate message field 1757 of the suspended job.

Once a job has been suspended, a provider may want to unsuspend the job and thereby complete it. To access suspended jobs, through the provider home page such as illustrated in FIG. 17L the global menu field 1758 might be engaged yielding the screen of FIG. 17V. Therein, the job history field 1759 might be engaged to provide the screen of FIG. 17W which shows various active and completed job fields as well as suspended job fields 1760. Engaging that suspended job, the screen of FIG. 17X is provided with contact fields 1761 as well as job detail fields 1762 with a breakdown of costs/time and any suspension notes that were written at the time job was suspended as discussed herein. A provider can then restart the job through engagement with field of 1763 or complete the job through field 1764. If the provider chooses to complete the job they will be presented with a completion screen, such as that shown in FIG. 17H. If the provider decides to restart the job, they will be presented with the screen of FIG. 17Y which indicates that they are waiting for the consumers approval to resume or unsuspend the job. The provider can also call the resident through engagement with 1764 or cancel the unsuspension request through field 1765.

If the request to unsuspend the job is not given and the consumer declines, the screen of FIG. 17Z is provided with a suitable message indicating that the restart of the job has been declined. Then upon dismissing the message (okay) the provider is brought back to a home screen, such as similar to the screen of FIG. 17L. If, however, the request to restart a job is approved, the screen of FIG. 17AA is provided with a field 1766 indicating approval and the property details. Also, as discussed herein, the consumer can delay the start or restart and that information might be given to the provider through field 1768. Furthermore, other job information may be selectable by the provider through a field 1770.

To start navigation back to the jobsite, or to cancel the restarted job, field 1772 might be engaged as appropriate. If navigation is to start through selection of the appropriate field in FIG. 17AA, the screen in FIG. 1766 may be presented which provides a message field with appropriate selectable fields indicating that the provider may be stopping for parts. As noted with respect to the consumer, if the provider indicates they are stopping for parts, that message will be conveyed to the consumer app and presented to the consumer. Then the navigation and job flow progress will proceed similar to that illustrated with respect to FIGS. 17C-17I. Upon arriving at the job site, the provider will decide to start a timer which then must be approved or declined by the consumer as discussed herein.

During the process of the job through the provider, the provider can manage the job by adding materials, notes, and photos to keep track of the job progress. Anything then added will be presented during the finalization process for the job. Referring to FIG. 17F for an active job, field 1703 may be engaged to manage the job materials and add notes and photos. Upon engaging the field, screen 17CC is presented with fields 1773 and 1774 for adding materials and photos respectively. Notes might be added through field 1775. As may be appreciated, engaging one of the fields 1773, 1774, 1775, a series of drop down menus and other fields might be provided to facilitate adding the additional information, including materials, notes, and photos. Upon completion of that information entry, field 1776 might be engaged to save the job information.

Various of the provider job flows discussed assume that the provider has been put on a fast track. However, the consumer may not approve that provider for a fast track and thus various of the junctures wherein a job is paused and resumed, paused and suspended, or paused and completed will require specific interaction between the provider and consumer with consumer approval with each of the various junctures. To that end, if a job is active, the active screen of FIG. 17F is presented to the provider giving them the ability to pause the job through interaction through field 1724. If a job is paused, the provider is presented with the screen of FIG. 17DD with a modal message field 1777 that indicates that the consumer must provide approval and that the provider must wait. Through field 1778 the provider can call the consumer or resident. Also, through field 1779 the modal message field 1777 might be dismissed and the active job screen as illustrated in FIG. 17FF might be provided with a message indicating that the provider is still awaiting approval from the consumer as shown in field 1780. If the pause is accepted by the consumer, screen of FIG. 17EE with a suitable message 1781 regarding the acceptance of the paused status is shown in the provider App.

If the pause is denied, the screen of FIG. 17GG is provided with a suitable message field 1782 indicating the denial. Once paused, the screen of FIG. 17G is presented to the provider which gives them selectable fields 1750, 1751, and 1752 for suspending the paused job, resuming the paused job, or completing the paused job respectively. If the provider seeks to resume the paused job, the provider App presents the screen of FIG. 17HH and the modal message 1783 indicating they must wait for the consumers approval. If the consumer approves the resumption of the job, the provider is presented with the screen of FIG. 1711 with a suitable message 1784 indicating that the request has been accepted. The screen thus returns to an active job screen. If the requested resumption is denied, the provider is presented with the screen of FIG. 17JJ and message 1786. Also, the screen remains in a paused job status as illustrated.

If the provider seeks to suspend a job, such as through engagement with field 1750, they will again be presented with a waiting screen, similar to the screen of FIG. 17HH. Then if the suspension is accepted by the consumer, the provider screen will switch to a suspended screen as illustrated in FIG. 17KK with a suitable message 1787 indicating that the suspension has been accepted by the consumer. If the suspension request is denied, the provider is presented with the screen of FIG. 17LL with a suitable message 1788 and the job remains in the paused status with the appropriate screen of FIG. 17LL.

If the provider wishes to complete the job such as by engagement with field 1752 in FIG. 17G, they again must wait for approval (FIG. 17HH) and if the competition request is accepted, they are presented with the screen for a completed job status as illustrated in FIG. 17MM with an appropriate message field 1790 indicating that the completion is accepted. If the completion request is denied the job will remain at a paused status as indicated by FIG. 17NN with an appropriate message field 1791 noting that the consumer has denied the providers request.

### Limits

In accordance with another feature of the invention, in the interaction between a provider and consumer, a property owner can set up limits with respect to various jobs that are performed at the property as disclosed in the flow of FIGS. 5E, 5F. Generally, such a scenario might be appropriate with a managed property, wherein a property manager will be approving jobs that are requested by a consumer, such as a resident at the managed property. When setting up or creating a property as disclosed herein, the property manager has the ability to set certain limits. A service provider can hit limits in various different ways depending upon how they are set up by the property manager. For example, a materials limit, a labor limit, or a general total limit might be set by the property manager. Such limits might be in a “not-to-exceed” format, that is associated with the created property in the inventive system. In accordance with another feature of the invention, the property manager may have the ability to extend the job limit by time or by some monetary amount when a limit has been set. For example, for limits associated with materials or generally a total for the job, the limit might be extended by an amount of money. For labor, the limit might be extended by an amount of time.

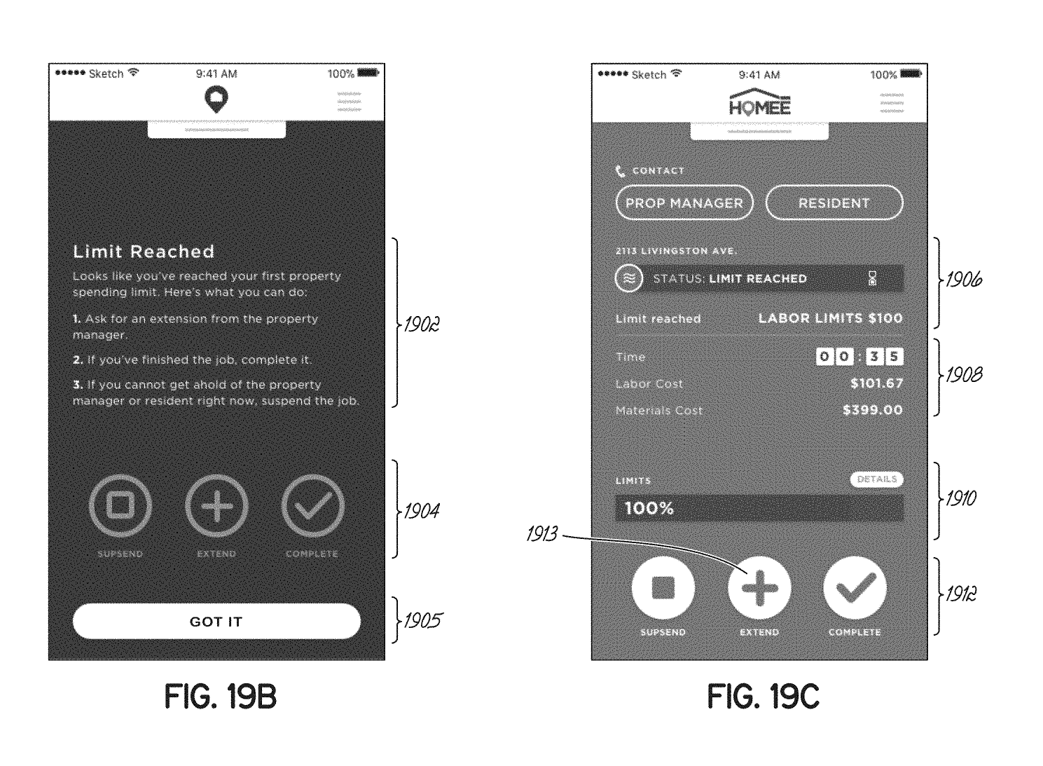

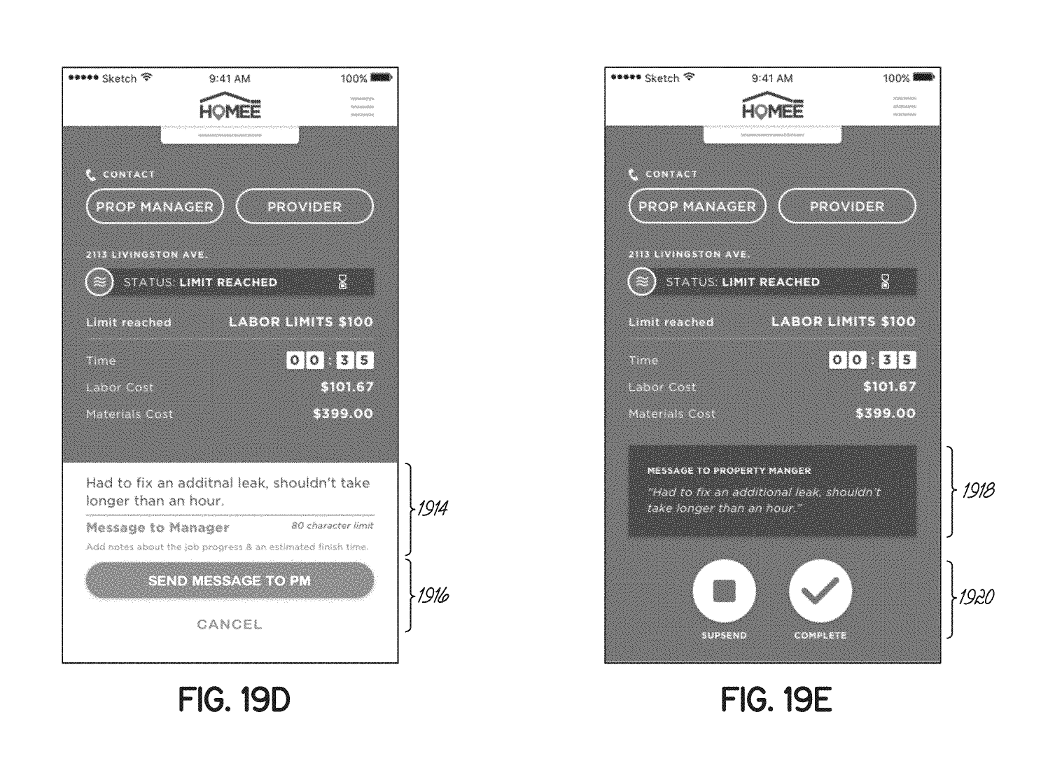

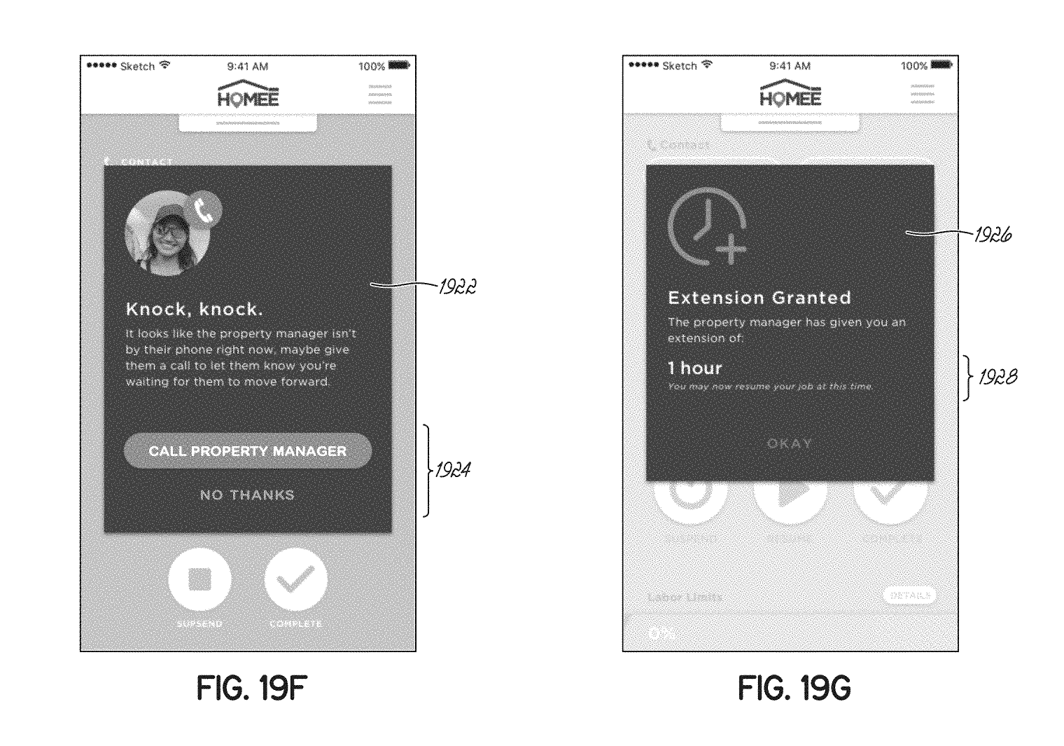

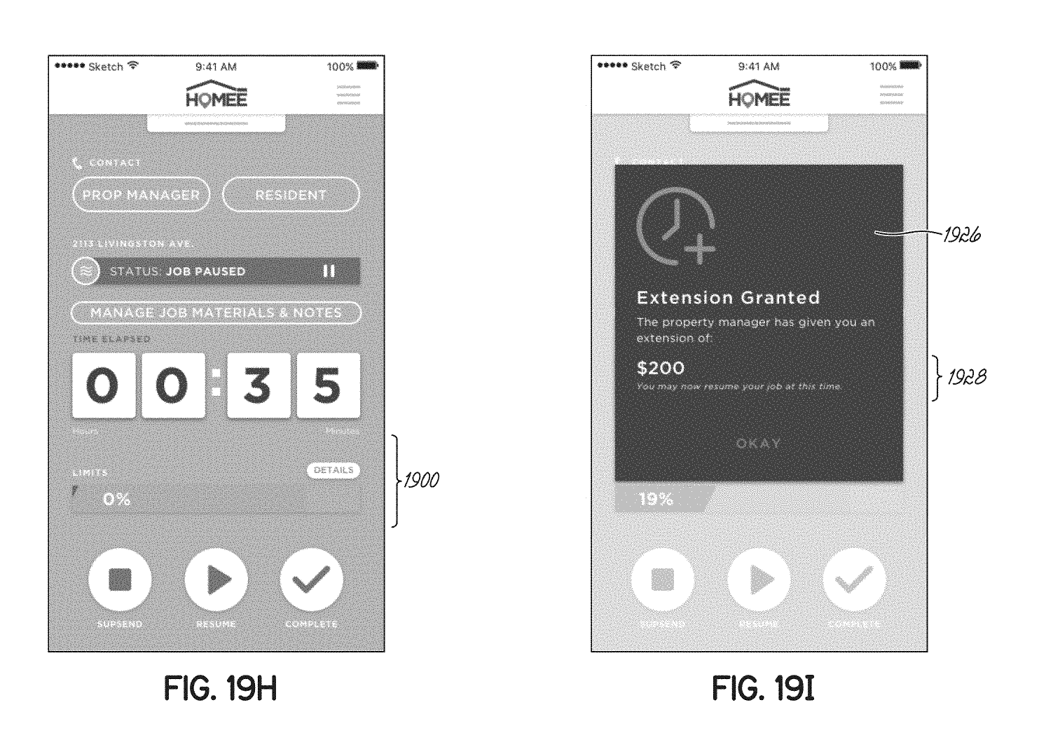

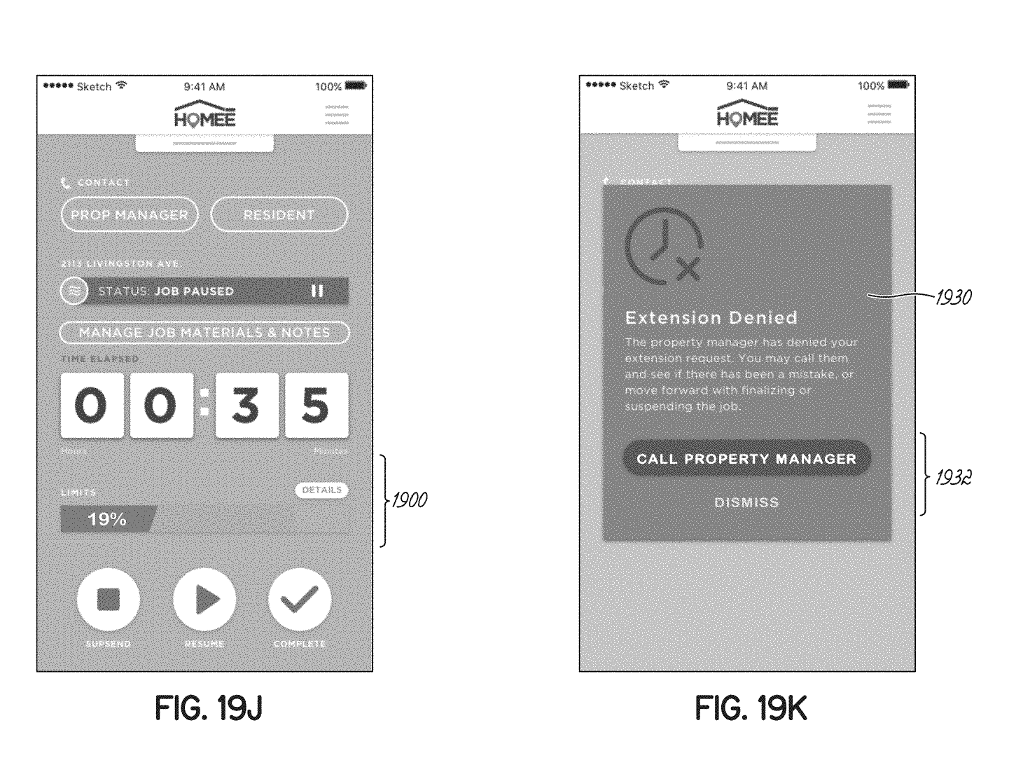

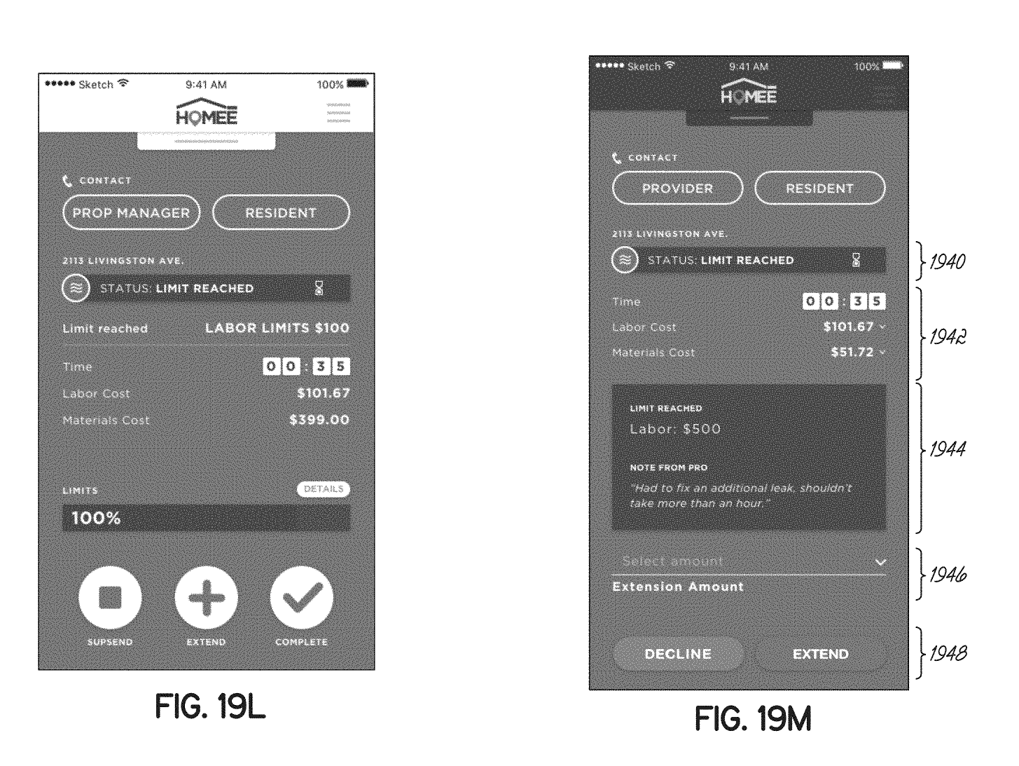

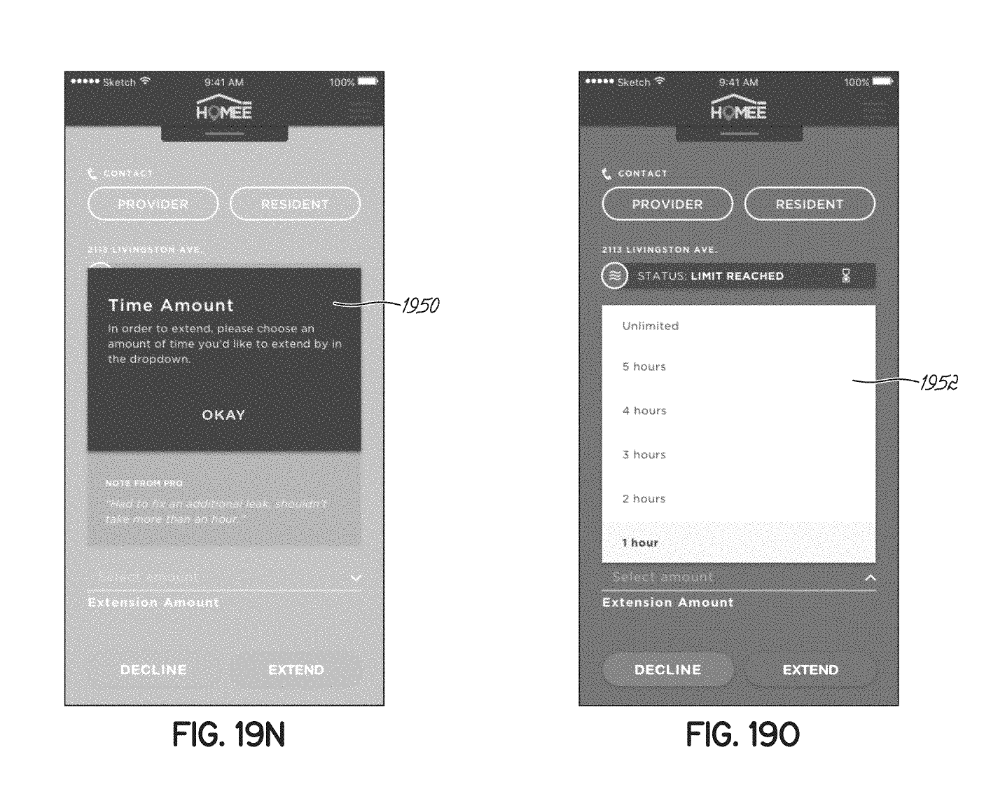

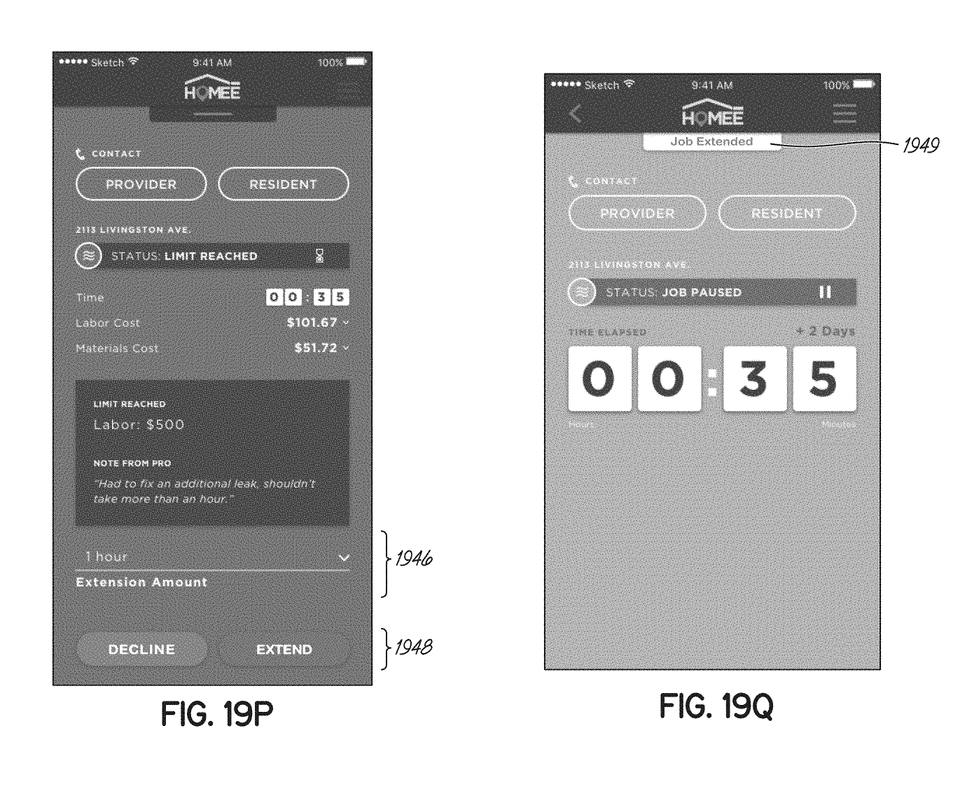

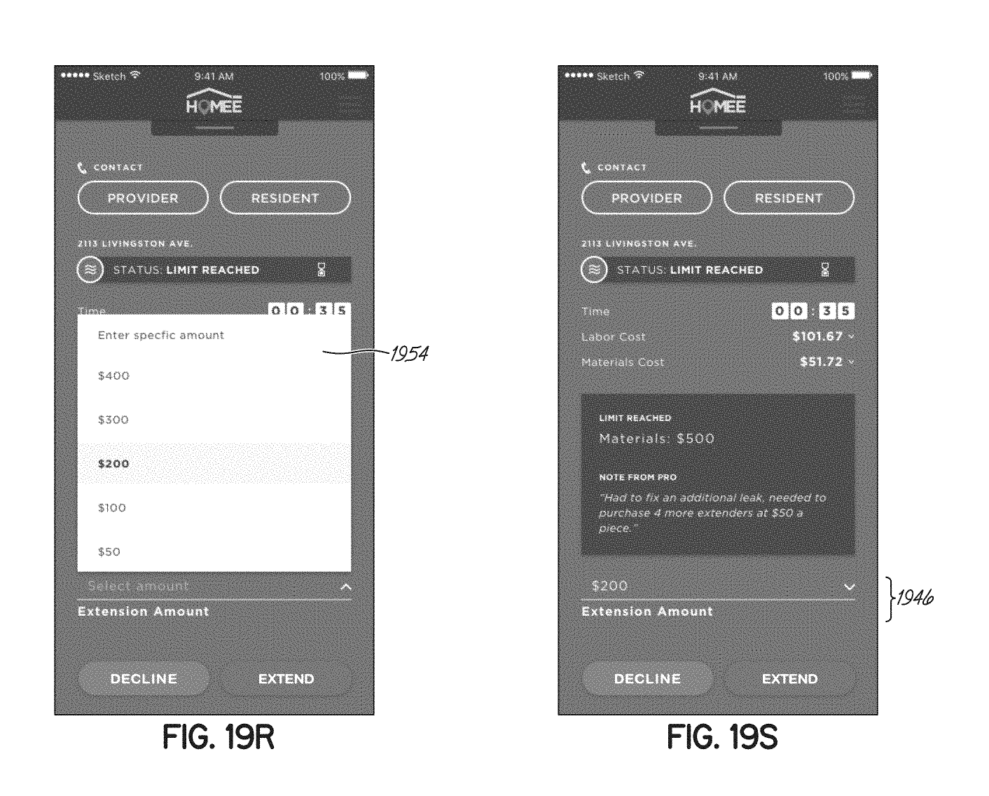

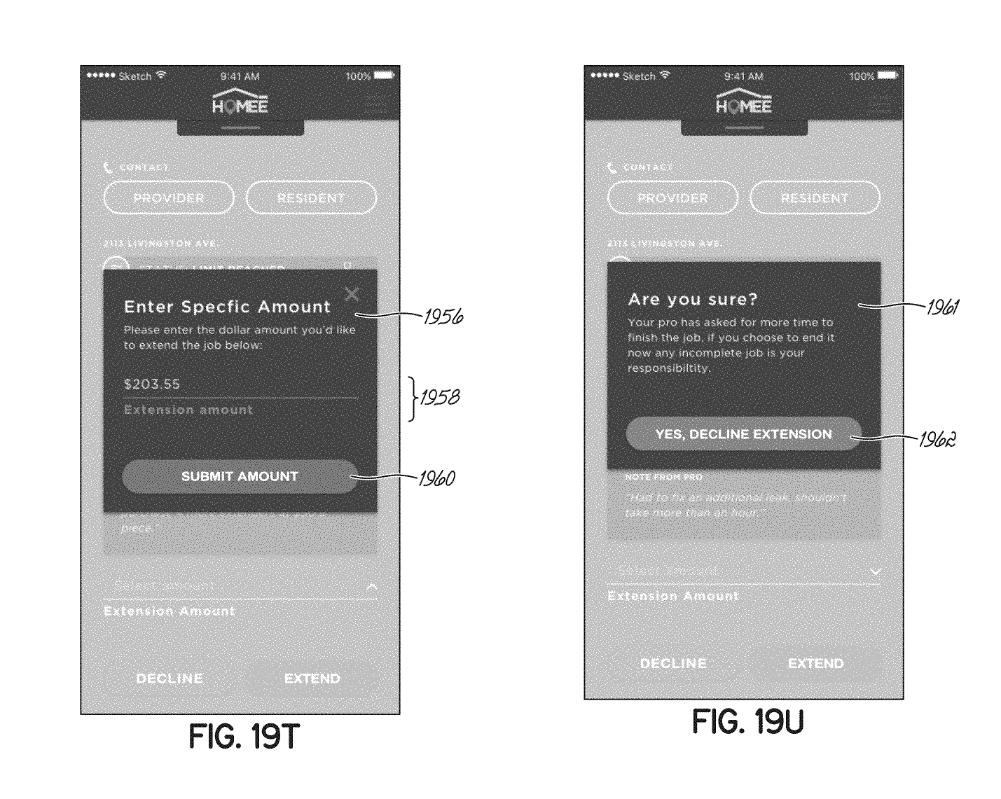

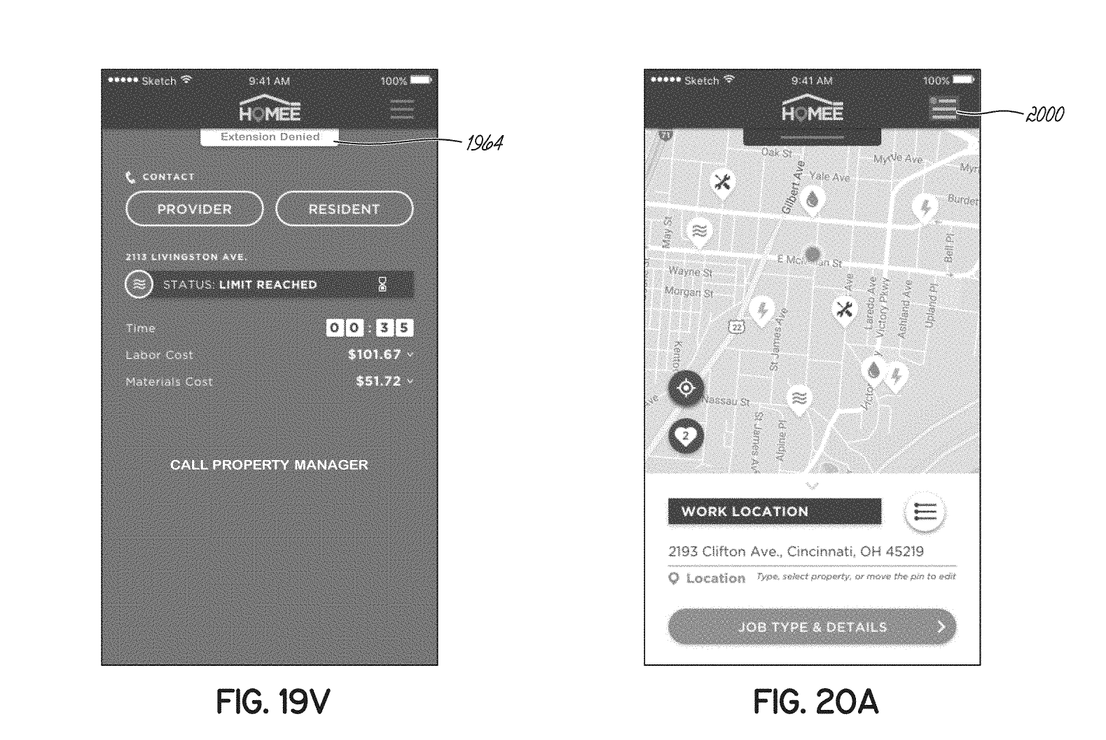

Referring to FIG. 19A an active job is illustrated to a provider with a FIG. 19A. The screen includes a limit indicator field 1900 that shows that the limit is almost reached. Upon reaching a limit, the provider is presented with the screen of FIG. 19B wherein a message field 1902 indicates that the limited has been reached and how to respond. The screen of FIG. 19B, which is essentially a teaching screen, would generally only appear the first time that the lim it has been exceeded so that the provider knows how to take action. Various action button fields 1904 may also be displayed indicating action that can be taken for the job. Through field 1905 the teaching screen of FIG. 19B may be dismissed. The job is then considered suspended and the provider is presented with a screen of FIG. 19C that includes fields 1906 indicating that the status of the job is that a limit has been reached and also showing that limit. Furthermore, that field 1908 is presented with information regarding the labor and material cost and time for the job. The limit indicator field 1900 also shows that the limit is at 100% and has been reached. The selectable field 1912 include field 1913 for extending that limit.

Once a provider selects to extend a job they are asked to add a message. Specifically, they are presented with the screen of FIG. 19D with a selectable field 1914 for adding a message to be sent to a property manager. Once the message has been entered, selectable fields 1916 may be engaged in order to send the message to the property manager or to cancel the requested limit extension.

Once the message has been sent, such as to a property manager, it will be recorded as part of the job in the job details. The screen of FIG. 19A as presented to the provider has a field 1918 showing the message that is sent to the property manager. Also, selectable field 1920 presents the provider with the ability to still suspend the job or complete the job up until the property manager responds. After a certain amount of time, the screen of FIG. 19F is presented to the provider which includes a modal message that the property manager has not responded and presents fields 1924 that may be used to call the property manager or to dismiss the message 1922.

If the extension of the limit is granted the screen of FIG. 19G is presented and modal message field 1926 is presented to inform the provider that extension has been granted. Certain extensions may involve money and other extensions may involve time. In the screen of FIG. 19G, the extension is indicated in the section of the message 1928 that the extension is for one hour of time. Then, upon dismissal of the message 1926 by the provider, the provider screen returns to a job that is in a paused state. When the extension that has been granted is time, the limit indicator 1900 is generally brought to 0% and that indicator will track that new time extension. The options are then given as in all paused jobs for the job to be suspended, resumed, or completed as illustrated in the screen of FIG. 19H.

While one extension might apply to time, another extension that might be granted may apply to an amount of money. In such a scenario, the screen of FIG. 19I might be presented where the message 1926 indicates such an extension and the message portion 1928 indicates a dollar amount of extension. Then when message 1926 is dismissed by a provider the paused job screen of FIG. 19J is presented. Therein, the job extension indicator 1900 might not automatically reset to 0 since the extension applied to a dollar amount rather than to time.

An extension of a limit may also be denied. If so, the screen of FIG. 19K is presented to a provider with a modal message field 1930 indicating a denial and providing selectable fields to dismiss the message or to call the property manager who has denied the extension request. Then, the provider is brought back to a suspended job and the screen of FIG. 19L.

On the other side of the transaction of the invention, the property manager must decide whether to extend the limits or to decline and also must decide how much of an extension will be granted either in time or a dollar amount. When a provider has requested an extension, the job extension screen of FIG. 19M is provided to the property manager through the consumer App. The screen of FIG. 19M includes information fields 1940 which indicate the property where the extension is requested as well as the status of the job which is now indicated as “limit reached”. Field 1942 provides additional information regarding the current labor costs, material costs, and the time indication of the job timer. Also, informational field 1944 provides the amount of the limit that has been reached and what that limit is, such as labor. It is noted, limits can be reached in both labor and materials and time. On the screen of FIG. 19M, a labor limit has been reached of $500. Field 1944 also includes a note from the provider with respect to the limit overrun. The screen of FIG. 19M also presents a selectable field 1946 for adding an extension amount that can be an increment of time or money. Through selectable field 1948 the property manager has the option to end the job or to extend the limit and thus extend the job.

If the provider engages the extend field without setting forth any extension amount in field 1946, the screen of FIG. 19N is presented with a modal message1950 that they must select a time amount. Once the property manager has dismissed the message 1950, the illustrated screen of FIG. 19O has a pop-up menu field 1952 showing a number of selectable time increments. A time increment may be selected by engaging the screen upon that selected amount, as entered in field 1946 and displayed for the provider as shown in the screen of FIG. 19P. Then upon engaging an extend field 1948 the job is put in the pause state with an appropriate message field 1949 that the job has been extended. The job is now ready to be resumed by the provider as shown in the consumer screen of FIG. 19Q.

If the limit is to be extended by a particular dollar amount, the field 1946 is engaged. The property manager through the consumer app is presented with the screen of FIG. 19R with a drop-down menu of 1954 having a number of selectable monetary amounts. Selection of one of those amounts will then be displayed through the screen of FIG. 19S and the field 1946 and again the extension of the limit will present the job to a consumer in a paused state as shown in in the screen of FIG. 19Q. As noted in the drop-down menu field 1954 the property manager can also select a specific amount rather than a set amount. Upon doing so, the property manager is presented with a screen of FIG. 19T with a modal message field 1956 that may be engaged appropriately to enter the extension amount through field 1958 and then submit that amount through field 1960 as illustrated in the screen of FIG. 19T. Once the amount is submitted screens of FIGS. 19P and 19Q are utilized to submit the extension and present the job in a paused state and ready to be resumed by the provider.

Although the discussed scenarios all yielded granted extensions, an extension can be declined. For example, by engaging the appropriate field 1948, the property manager can decline the extension. They will then be presented with the screen 19U with a modal message field 1961 that explains that they may have an unfinished job if they do not extend the job. They are then given the ability to continue to decline the extension through field 1962, where they are presented with the screen of FIG. 19V where in the message 1964 indicates that the extension was denied, and the job is essentially in a suspended state with certain information and contact information provided in the screen as shown in FIG. 19V.

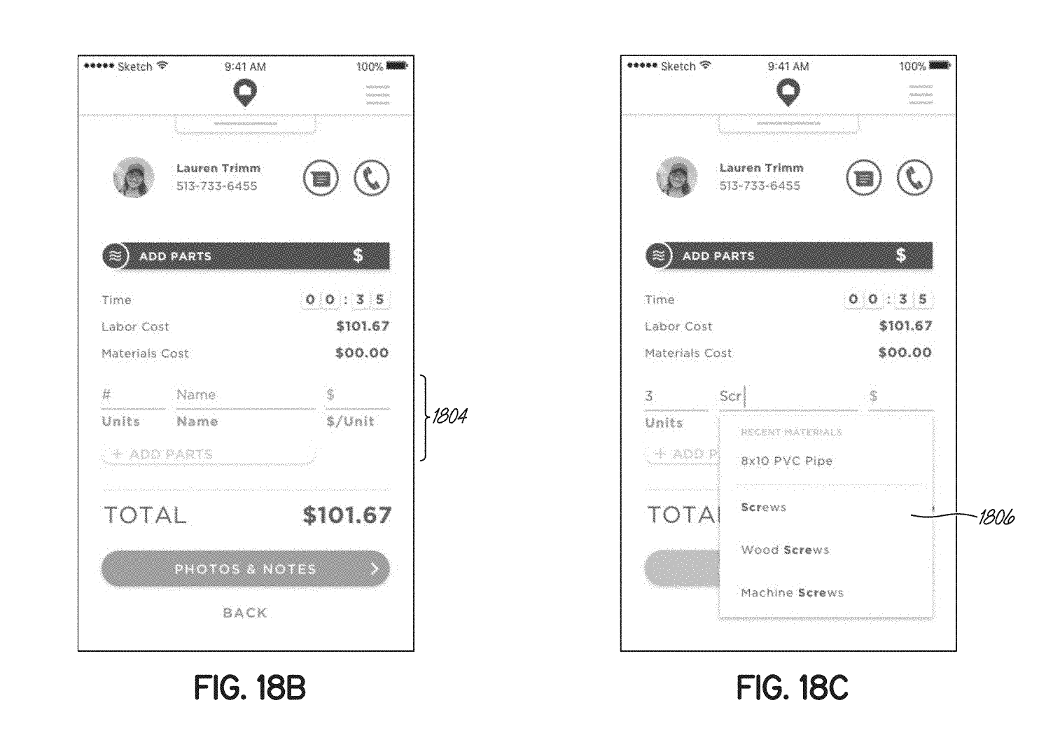

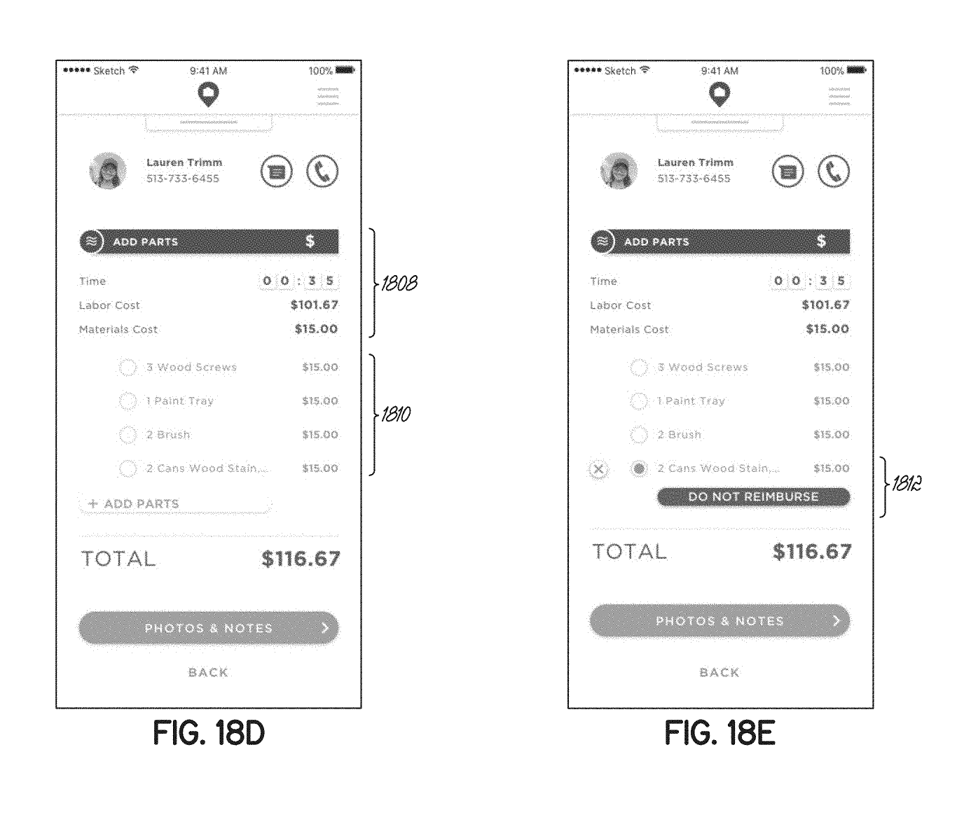

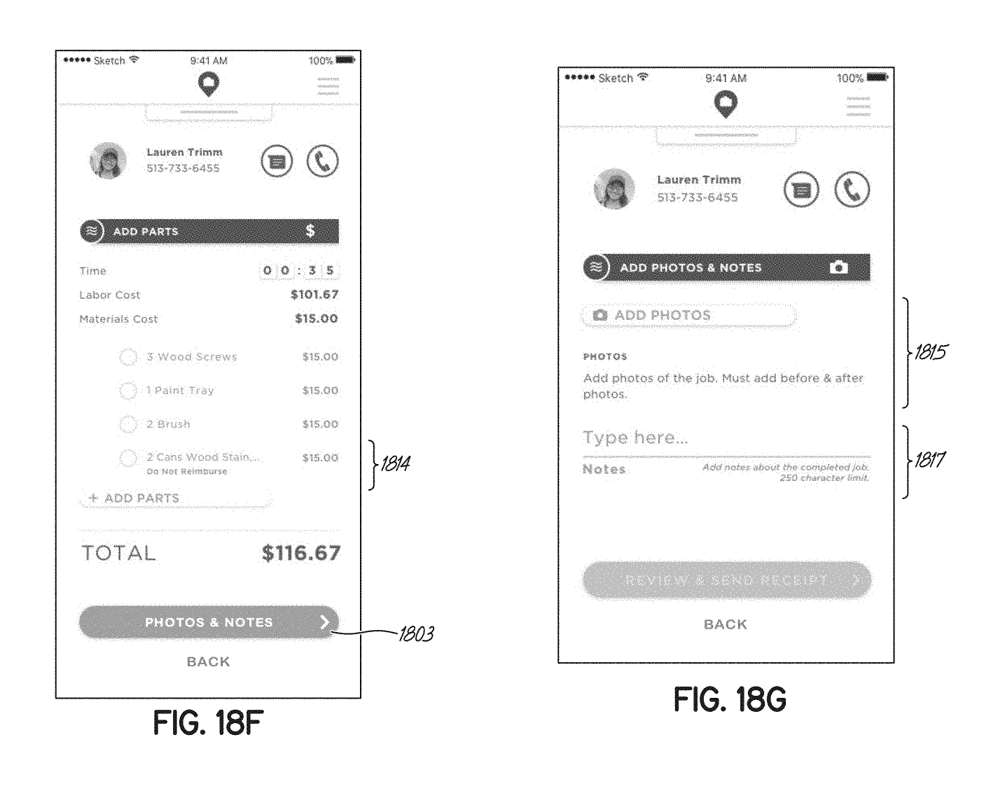

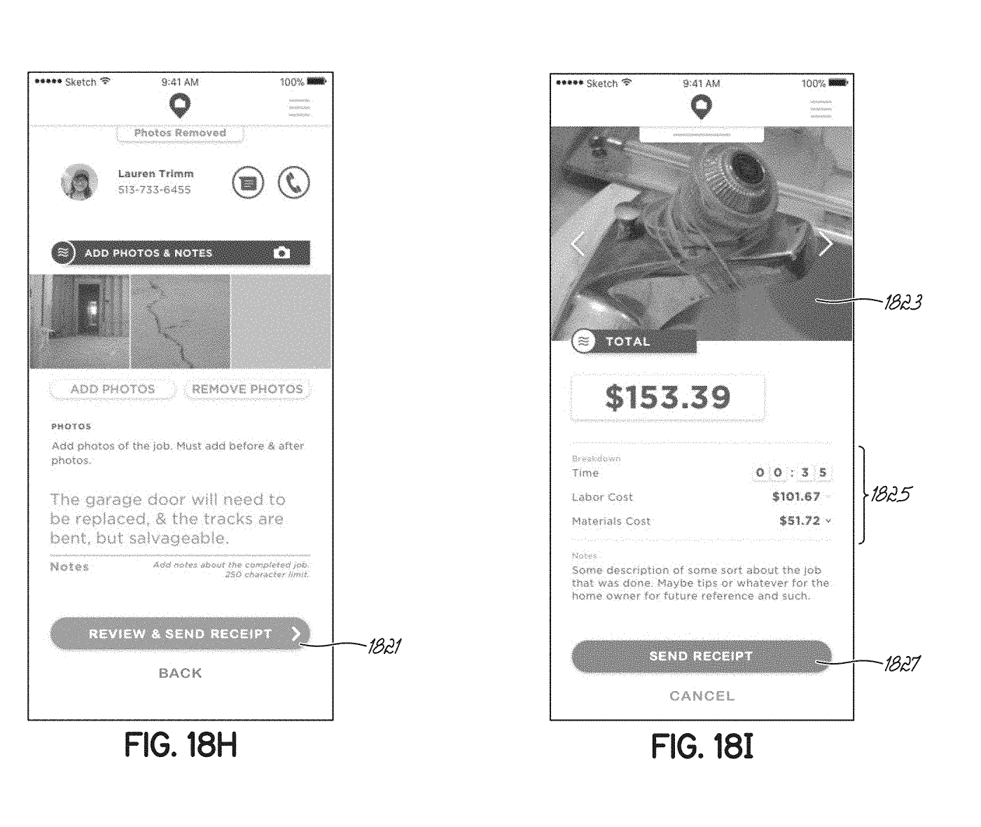

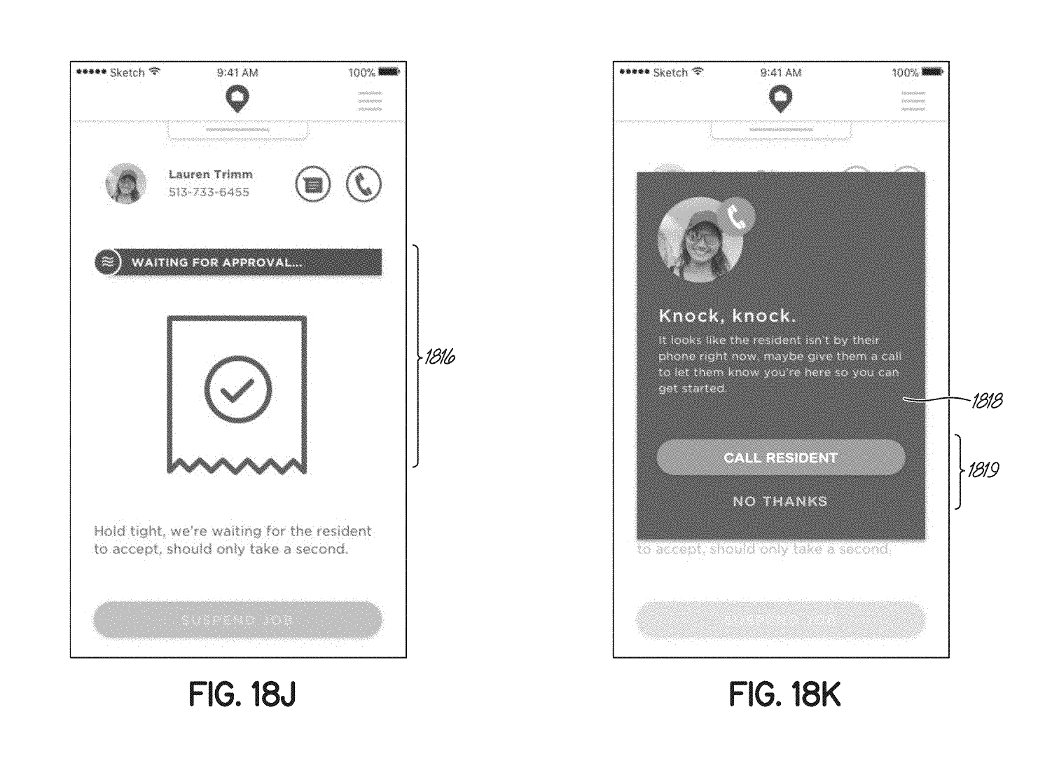

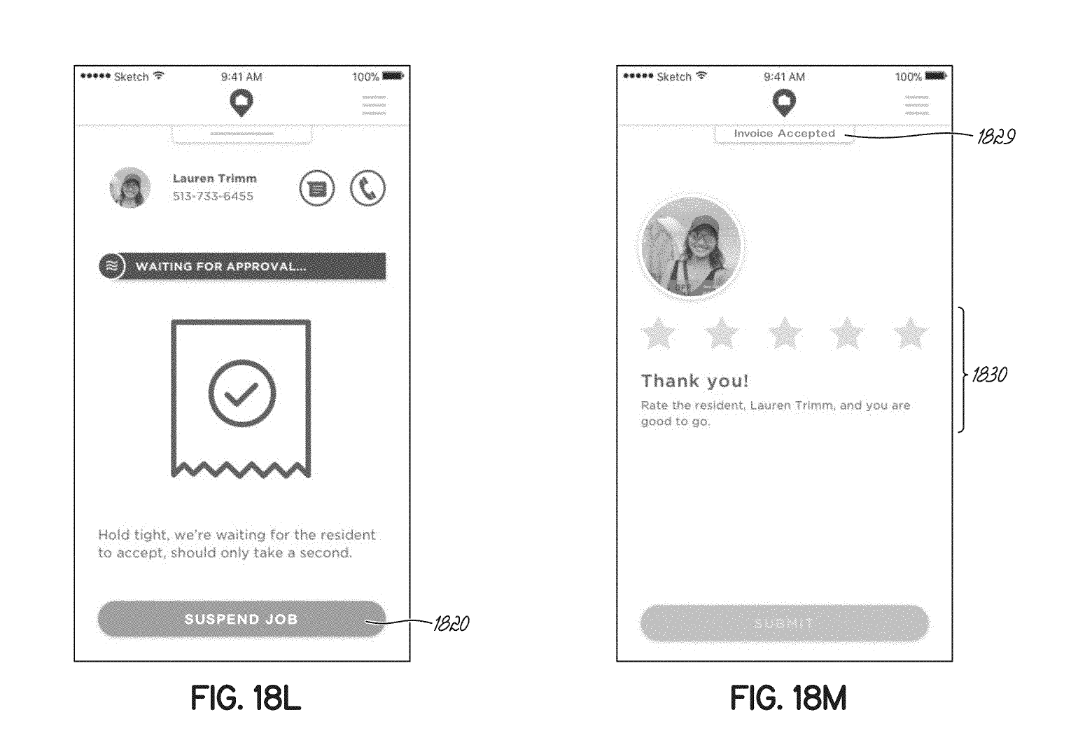

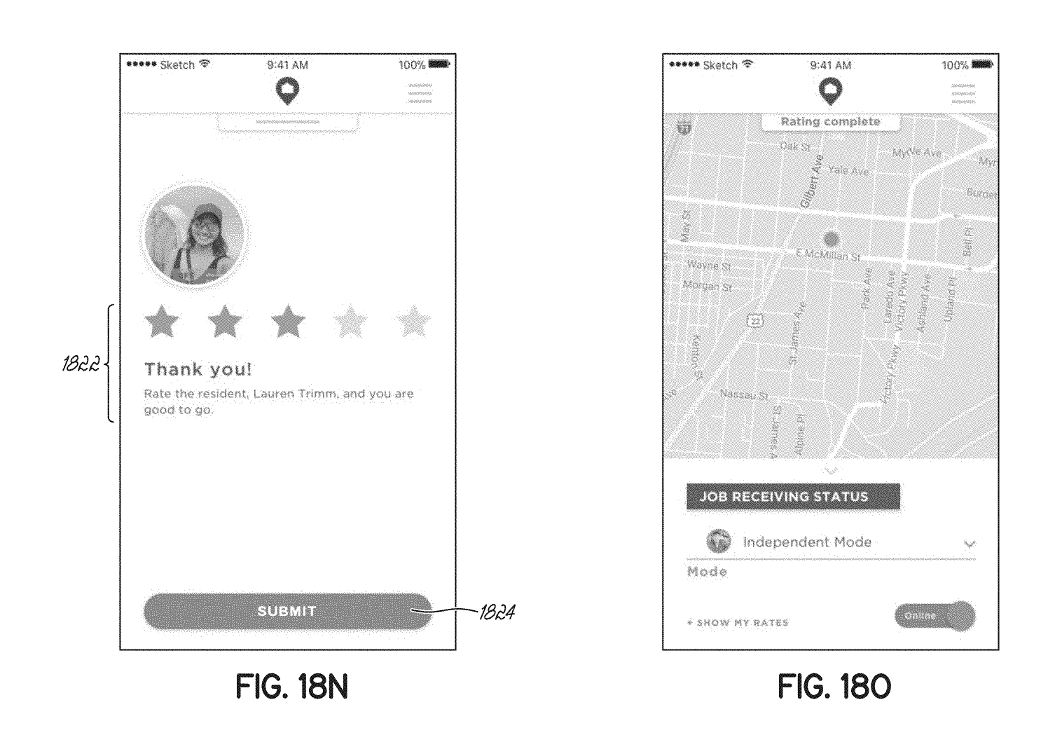

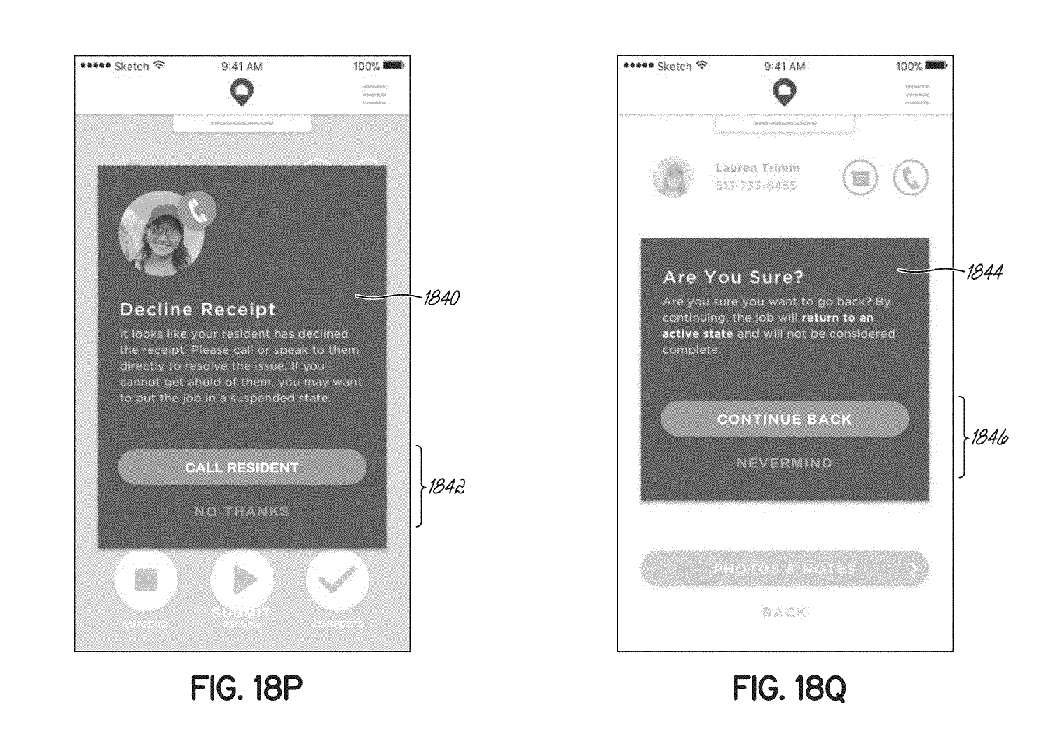

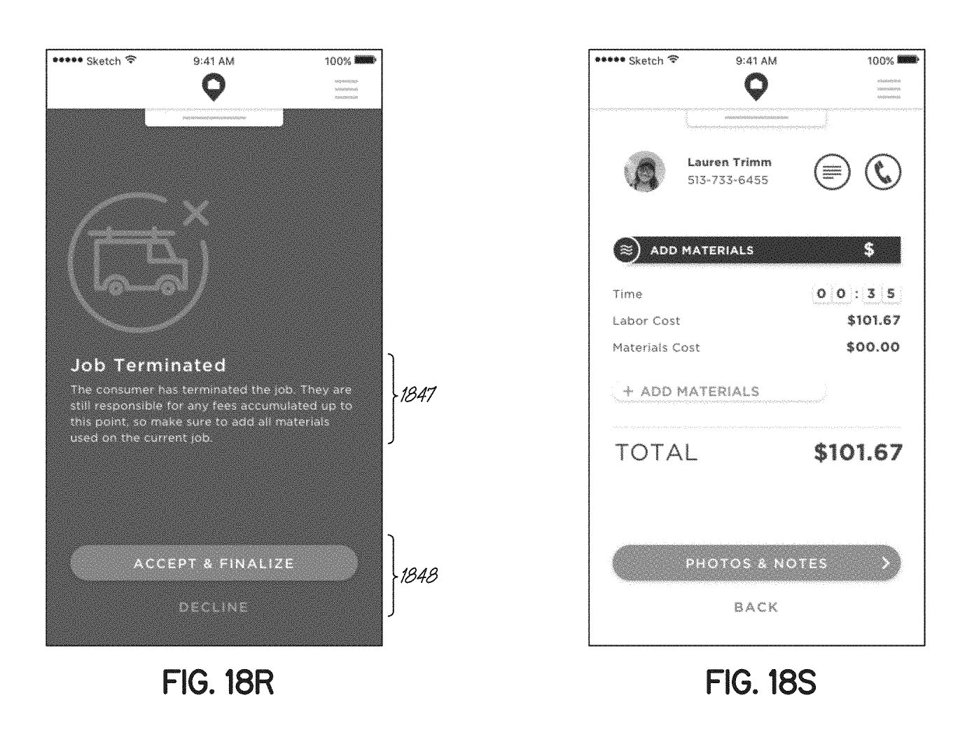

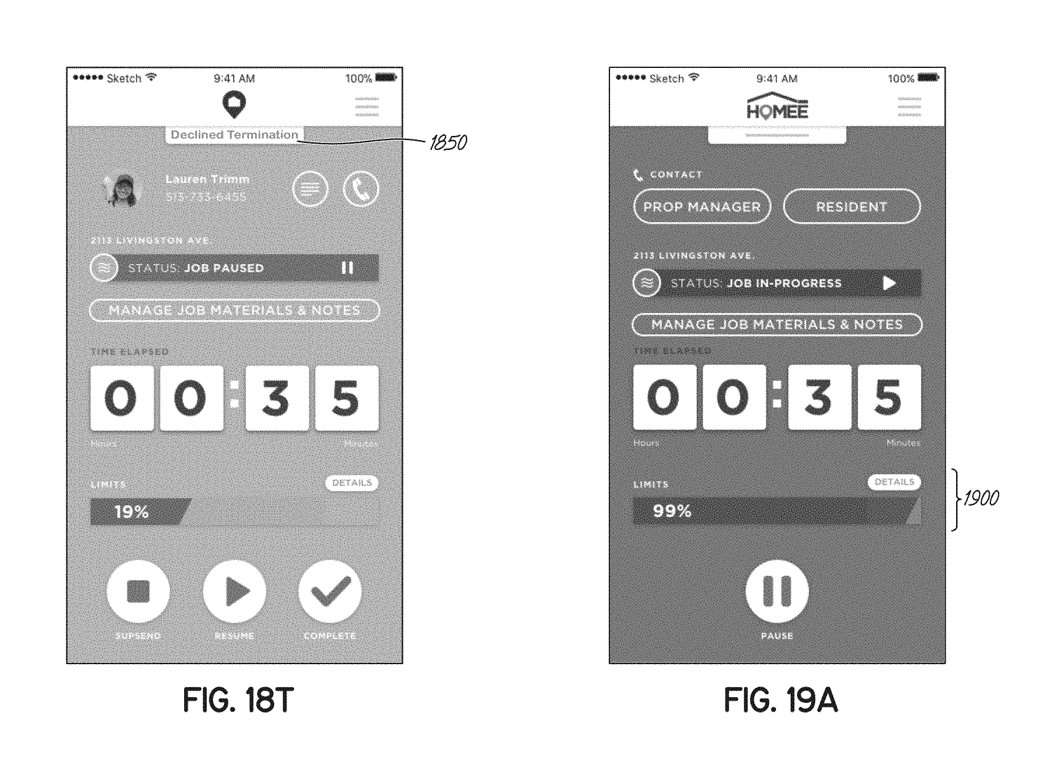

Ultimately a job will be completed and there is a settlement between the service provider and a consumer. For completion of a job and to stop the timer as well as complete the transaction involving both labor costs and material costs in the job, the job is paused, and then a completion request is made. Specifically, referring to FIGS. 17F-17H, an active job may be appropriately paused, such as engaging field 1724. When the paused screen of FIG. 17G is presented, the provider can engage field 1752 and request that the job be considered completed. A completed job screen as in FIG. 17H is provided. The job completed screen of FIG. 17H is shown briefly to the provider and then a screen of FIG. 18A is illustrated to begin the process of generating a receipt with the necessary detail. Referring to the screen of FIG. 18A, fields are presented showing labor costs and material costs in appropriate fields 1800. The field 1802 is also presented for adding parts and can be engaged by the provider. Furthermore, field 1803, when engaged, will allow the provider to add photos and notes. Depending on the job, the addition of parts will generally be optional. If the provider engages field 1802 to add parts, the screen in FIG. 18B is illustrated with additional selectable fields 1804 for adding information regarding the parts such as the number of units, the name as well as the cost. Furthermore, various drop-down menus 1806 as illustrated in FIG. 18C may be used for adding parts. When the parts have been added they are displayed in fields 1810 is shown in FIG. 18D. Furthermore, the labor and material cost field 1800 are updated with the information. The providers App also gives the provider the ability to categorize and edit various of the materials as illustrated in FIG. 18E. Certain materials can be deleted by tapping appropriate fields 1812 or the provider can indicate the parts and costs thereof are not to be reimbursed by an appropriate field. That is, the provider can select certain materials and delete or designate them as non-reimbursable as appropriate through field 1812. Turning to the screen of FIG. 18F, if they are not to be reimbursed, as illustrated in field 1814, that information will be shown to the provider.

Once materials have been added field 1803 can be engaged which will present the screen of FIG. 18G with selectable fields 1815, 1817 for adding photos and notes, respectively. Once the appropriate photos and notes have been added as illustrated in FIG. 18H a selectable field 1821 is provided to allow the provider the ability to review what has been added and then to send the receipt. Upon engaging field 1821, the screen of FIG. 18I is presented that displays a carousel of photos 1823 as well as information regarding time, labor cost, material costs, and a grand total in fields 1825. Field 1827 can then be engaged to send the receipt to the consumer for approval. At that stage, the provider App will present the screen of FIG. 18J indicating through appropriate field 1816 that the application is waiting for the consumer's approval. If approval is not forthcoming in some selected time, such as two minutes, the modal message field 1818 as illustrated in FIG. 18K might be provided which presents selectable fields 1819 for calling the consumer or simply waiting further. After the modal message field 1818 is gone, the screen of FIG. 18L is presented. As noted in selectable field 1820 the provider still has the ability to suspend a job. However, if a request for completing the job has been accepted, these screen of FIG. 18M is presented with an appropriate message field 1829 and a request to the provider to rate the consumer through the message field 1830. That is, the consumer is also noted by the provider in the transaction. Referring to the screen of FIG. 18N, through selectable fields 1822, the provider can rate the consumer, such as on a scale of 1 to 5 stars, and then may engage field 1824 to submit the rating. Generally, field 1824 will not be selectable until the provider has rated the consumer. Once the job has been completed and the receipt accepted, the provider is returned to a home screen as illustrated in FIG. 18O to await future jobs.

If for some reason, the receipt is declined by the consumer, the provider waits through the screen of FIG. 18J, the provider will then be notified through an appropriate modal message 1840 as illustrated in the screen of FIG. 18P. Selectable fields 1842 may then be provided for the provider to call the consumer or to dismiss the message field 1840. The job and provider screen will then revert to a paused job as illustrated in FIG. 17G.

Also, when the job completion screen is presented as illustrated in FIG. 17H and the completion process begins, such as through presentation of the FIG. 18A, the provider has the ability to go back to the job by engaging field 1805. For example, if the provider has mistakenly indicated that they want to complete the job, they can return to the active job. As such, they will be presented with the screen of FIG. 18Q that has a modal message field 1844 asking the provider if they desire to go back to the active state for the job. If they do, they can engage one of appropriate fields 1846 to continue back the job, or to stay with the completion process.

As discussed herein, the consumer has the ability to terminate jobs at various junctures. If the consumer terminates the job, the provider is presented with the screen of FIG. 18R with the message field 1846 indicating that the job has been terminated and presenting the provider with the ability to accept the termination or to decline it as illustrated by selectable fields 1848. If the provider accepts the termination, they will then be presented with the various receipt generation screens as illustrated in FIG. 18S and begin the process of entering any materials, photos, notes and submitting the receipt for approval in a normal fashion as discussed herein. However, upon declining the job termination, the provider is presented with the screen of FIG. 18T which is a pause screen with an appropriate message 1850 indicating that termination was declined, and the job is still considered active but paused.

### Networks

In accordance with another aspect of invention, property managers can set up a network of companies for a property. That is, service providers of a networked company will be given priority in the inventive process as a member of a network. Particularly, to add a provider to a network, they must be affiliated with a company that is set up as discussed herein. Once a company is a part of a network, they will have a priority on job requests that issue from the property manager if the request is then filtered through their designated network, such as a preferred network or in-house network as illustrated in FIGS. 5K-5M. When setting up the network, a property manager will send an invite to the company owner and the company owner has to then accept the invite to become a part of the network. Then, the network can be edited, and companies can be added to the network as well as additional services for a particular company.

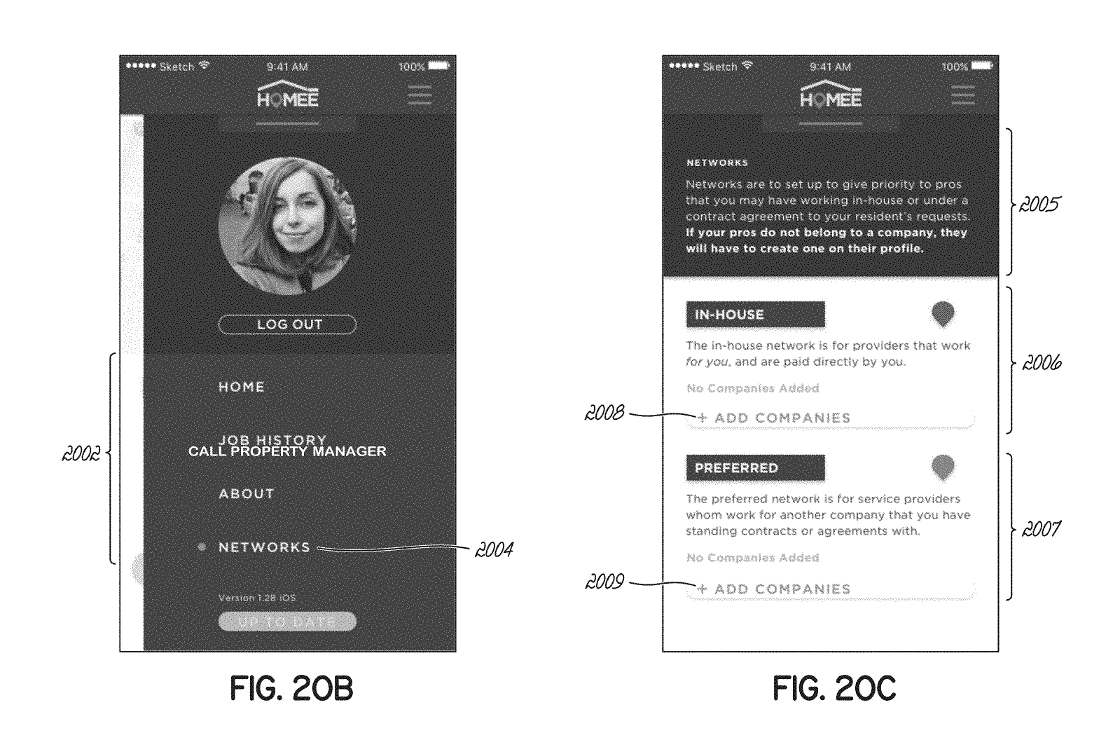

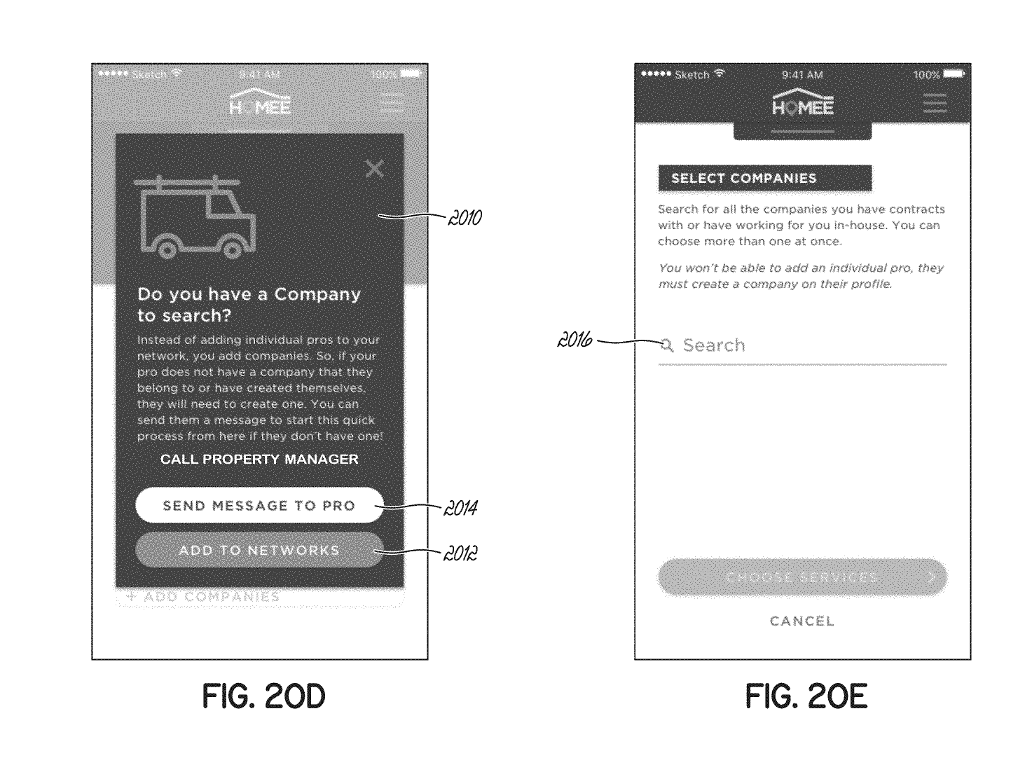

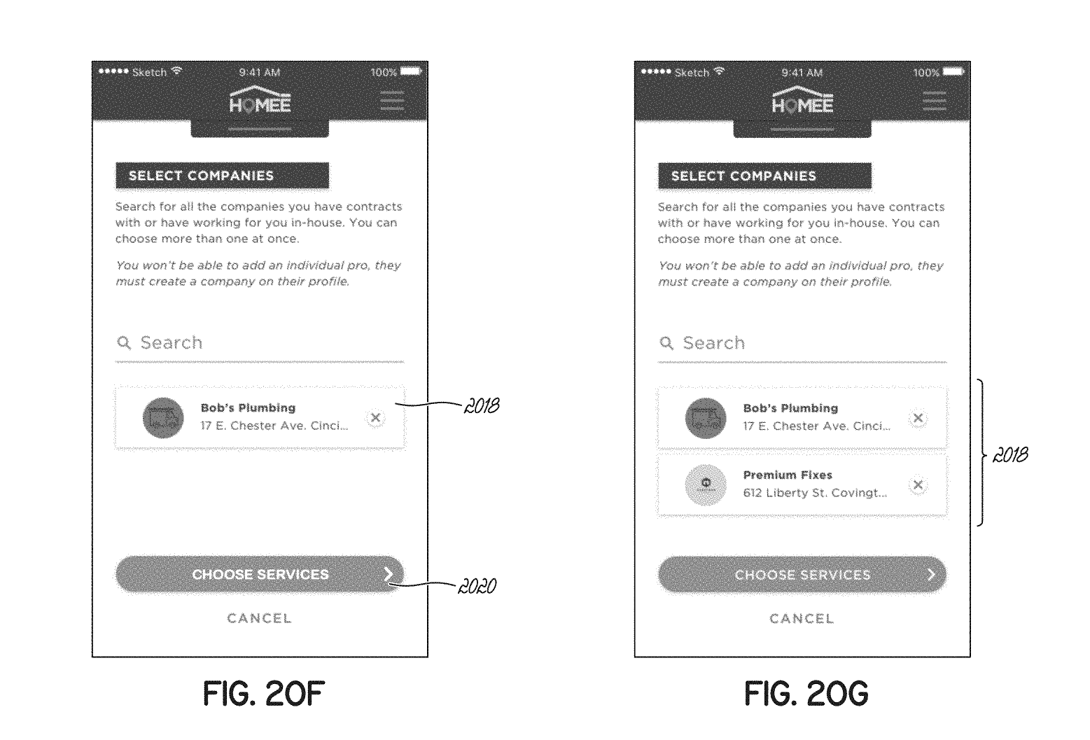

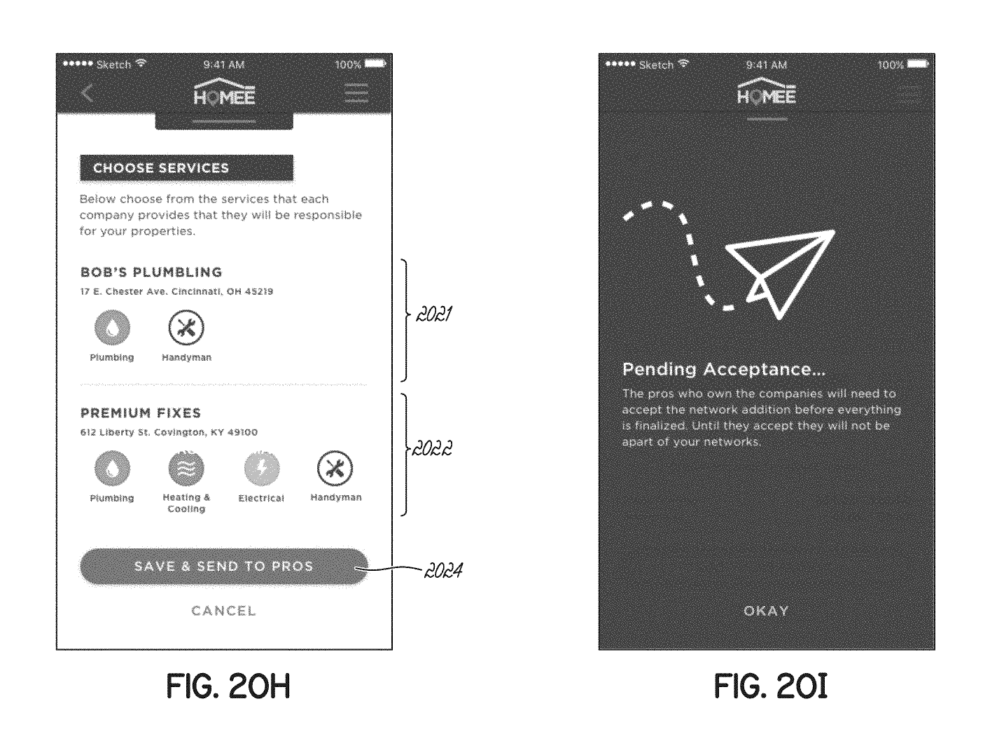

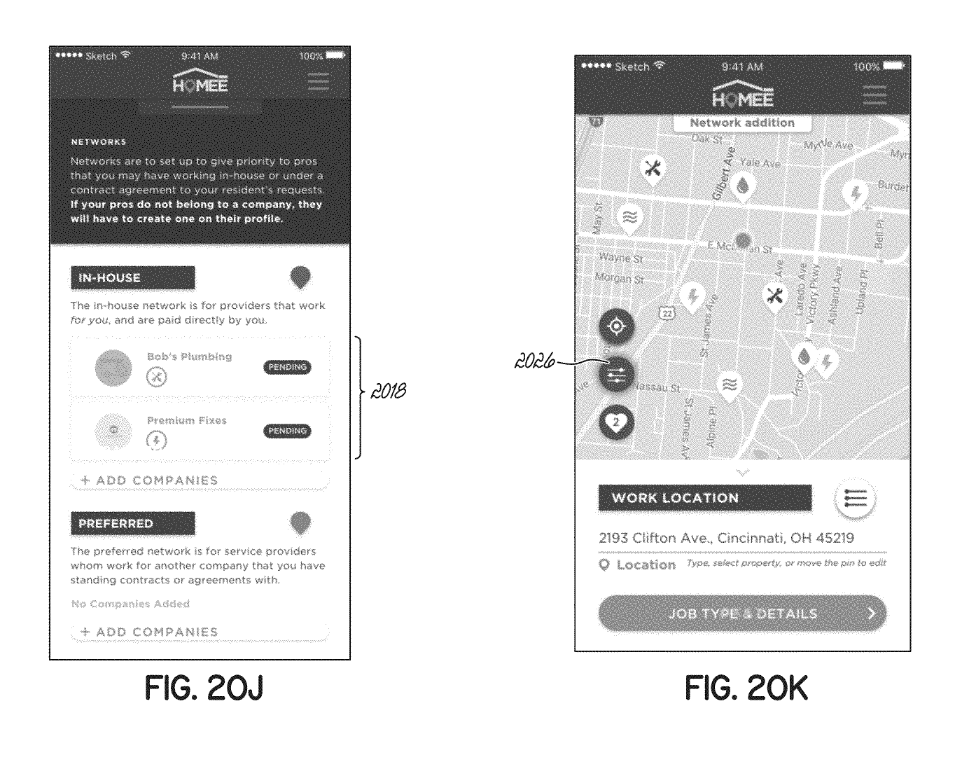

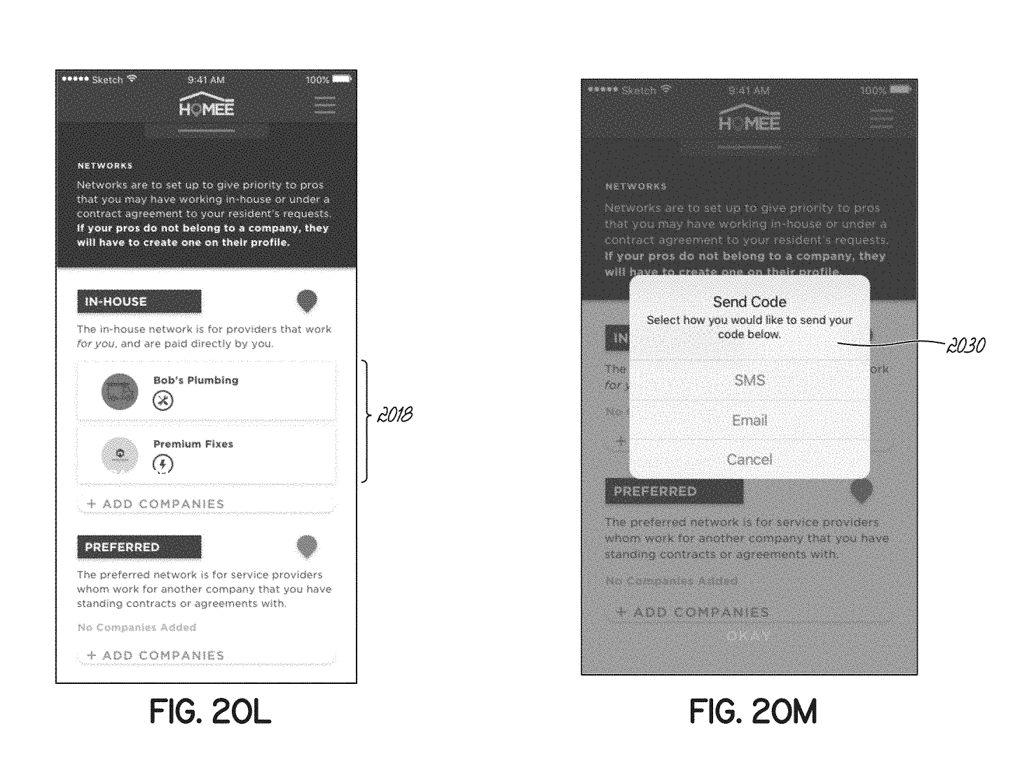

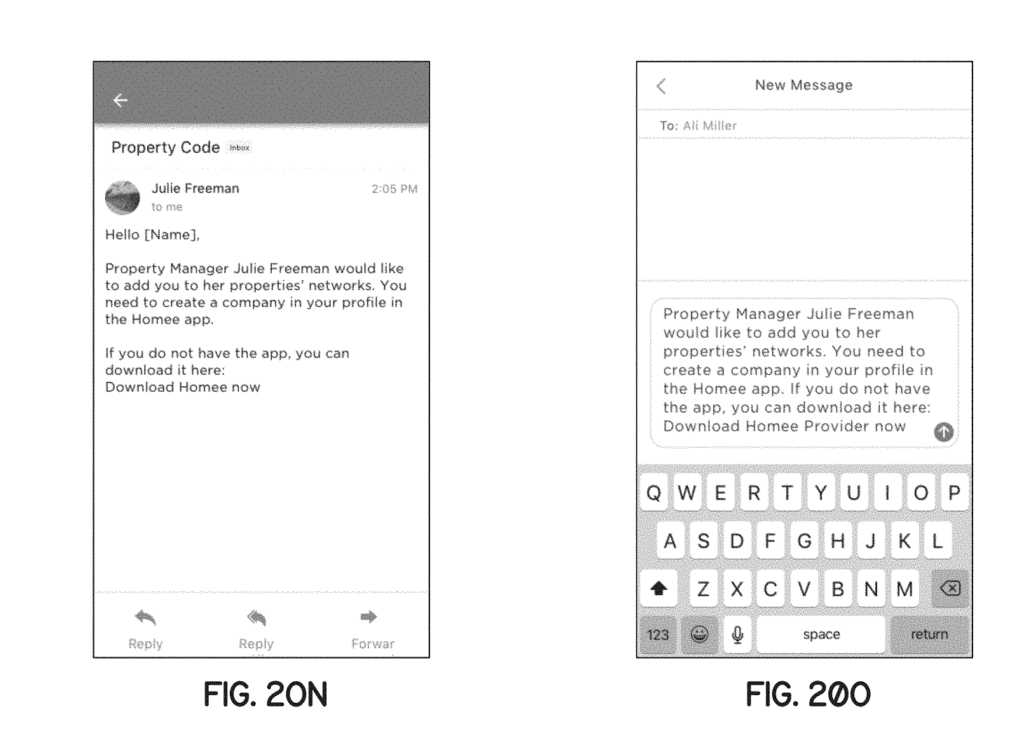

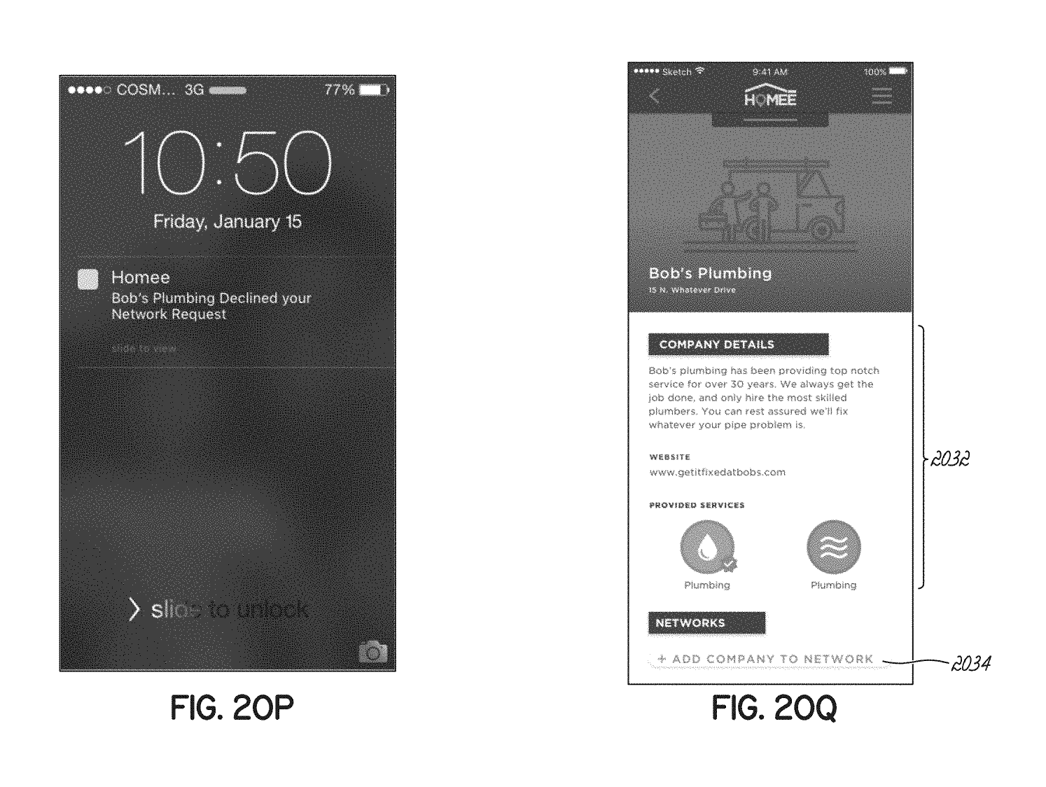

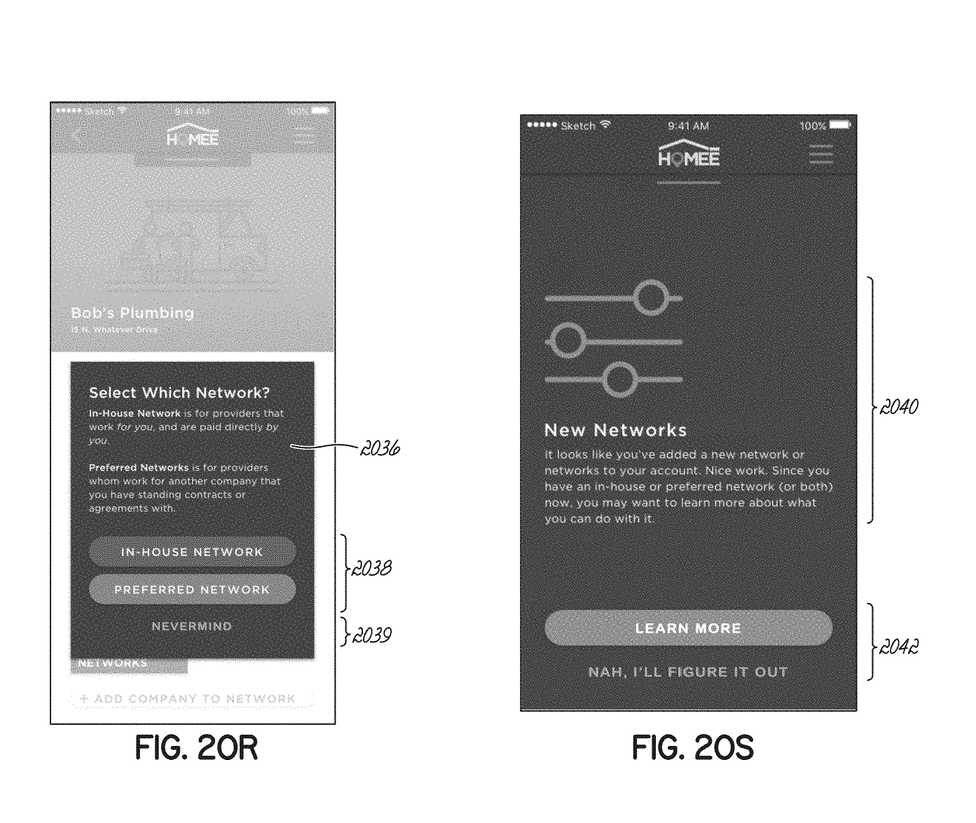

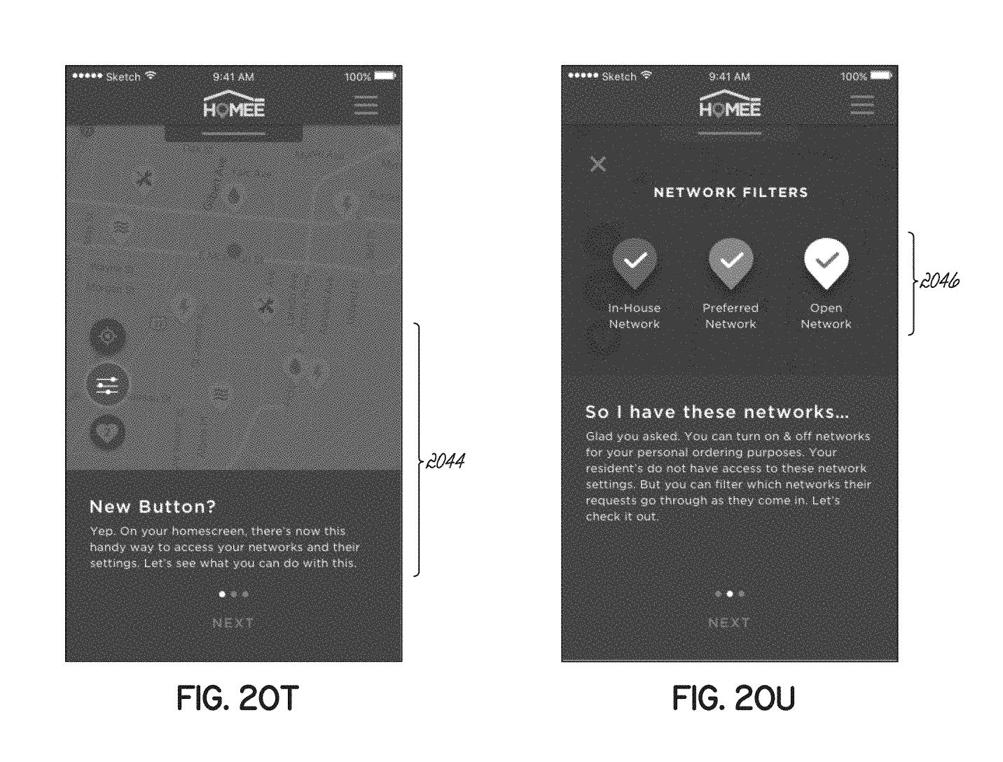

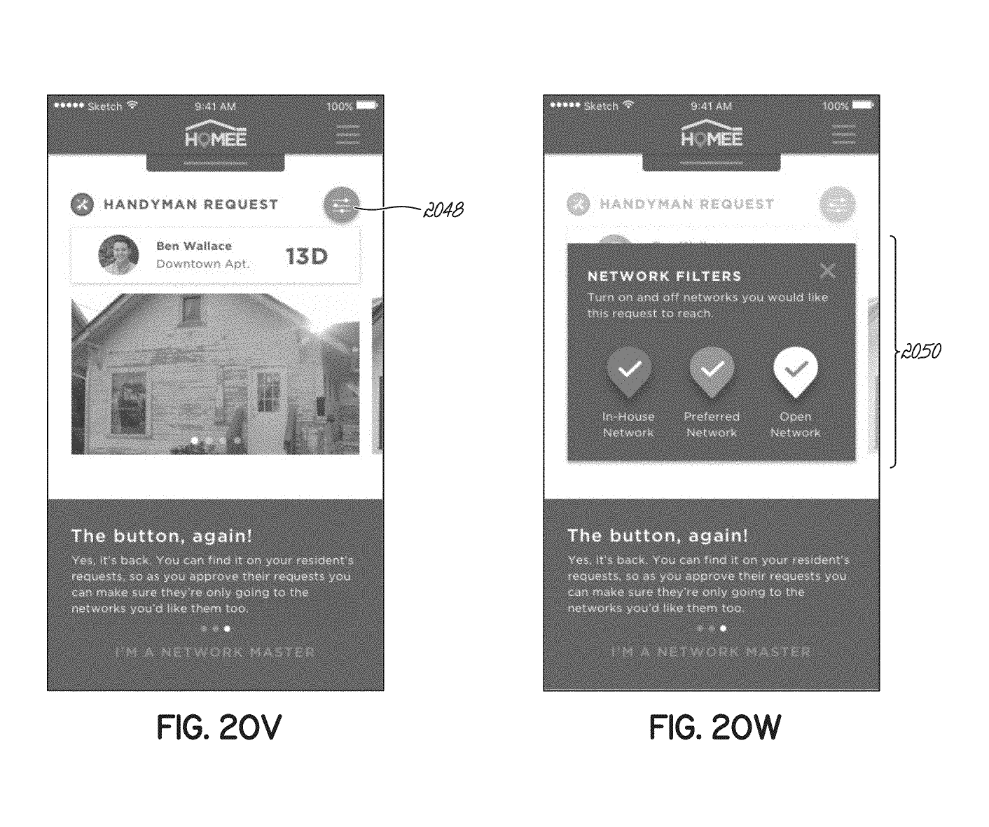

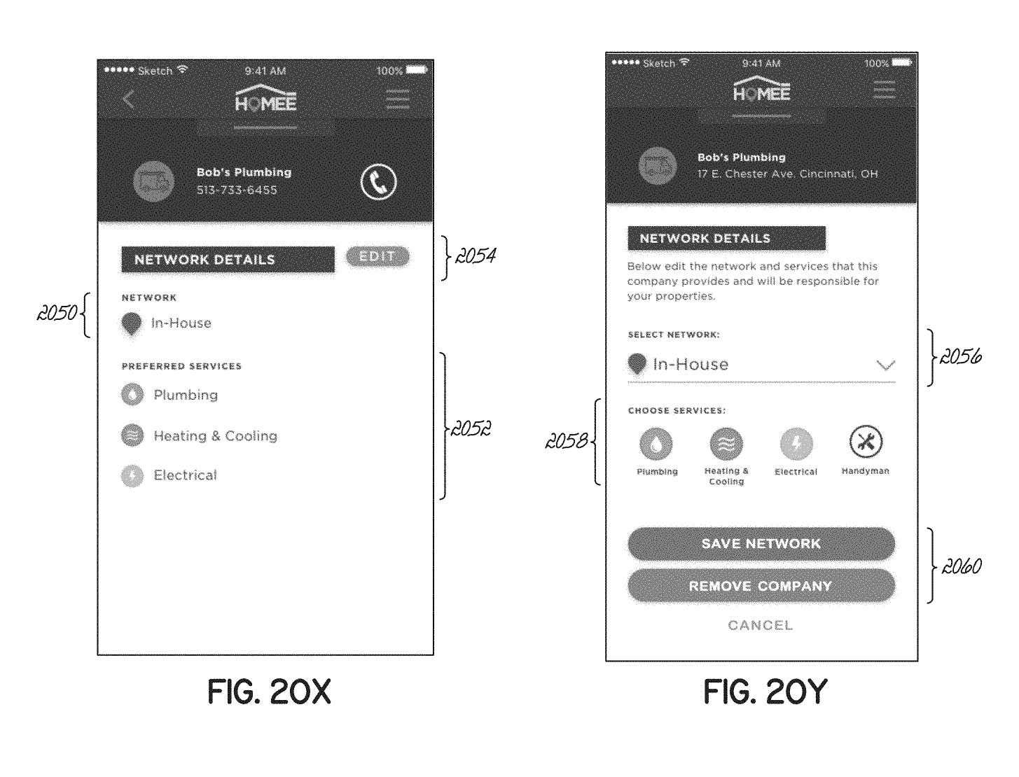

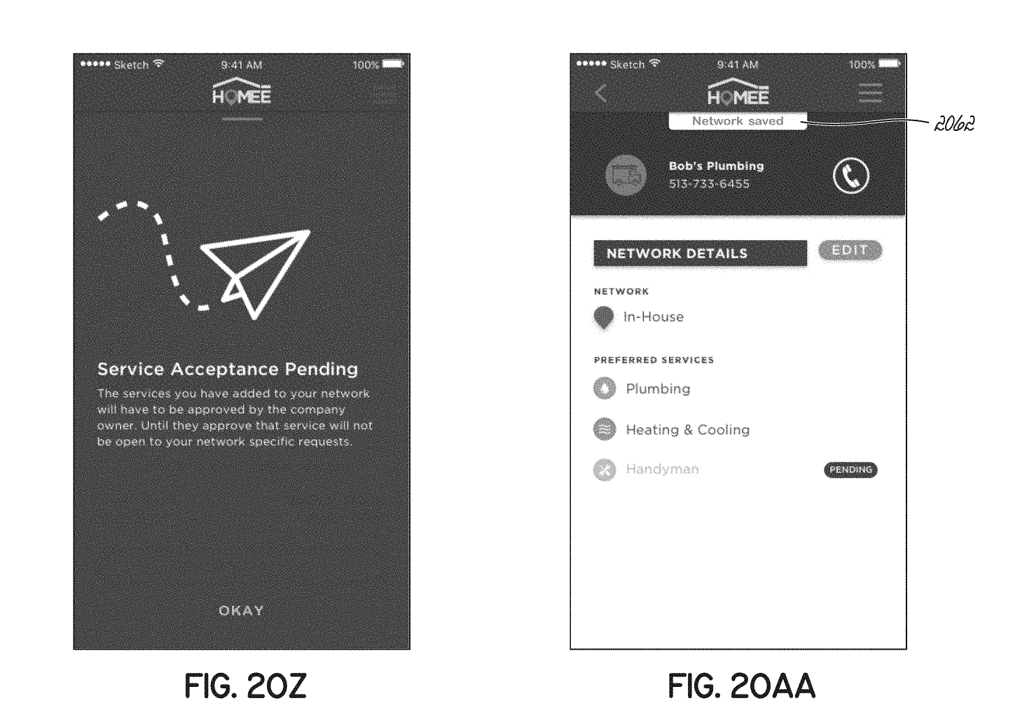

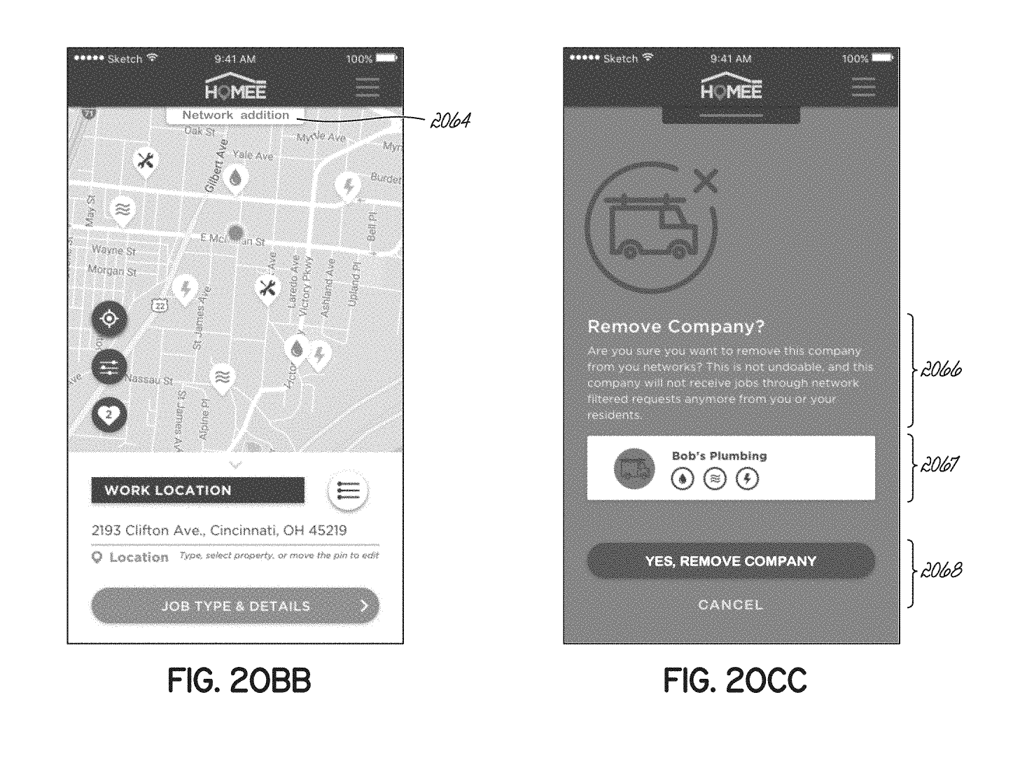

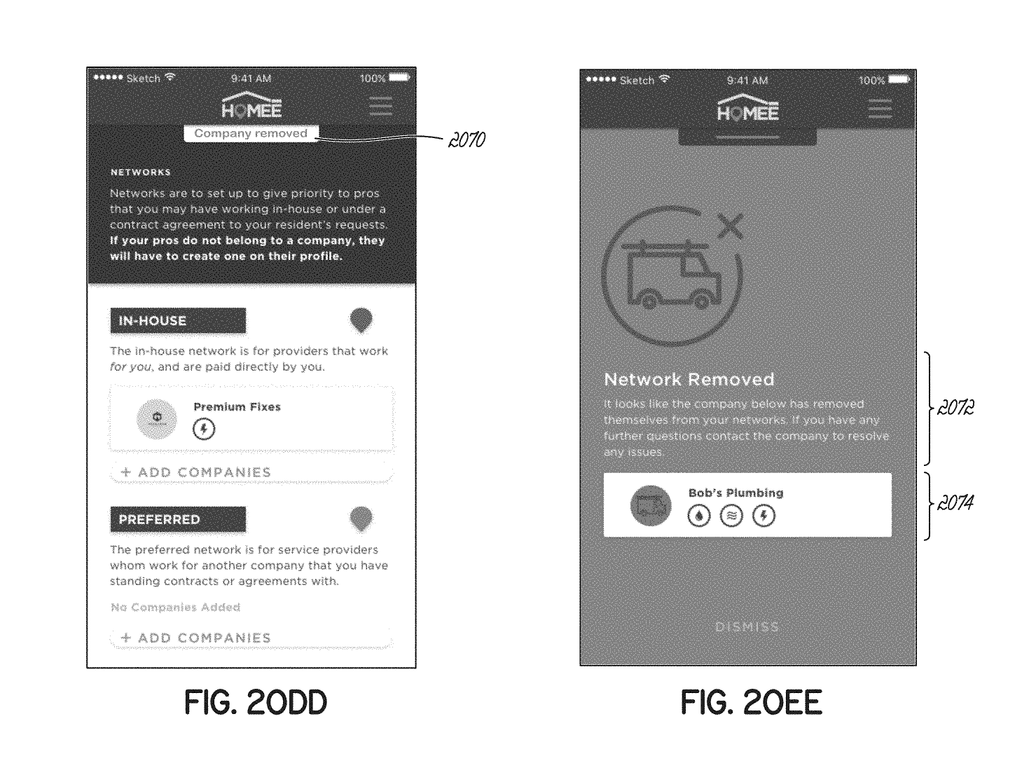

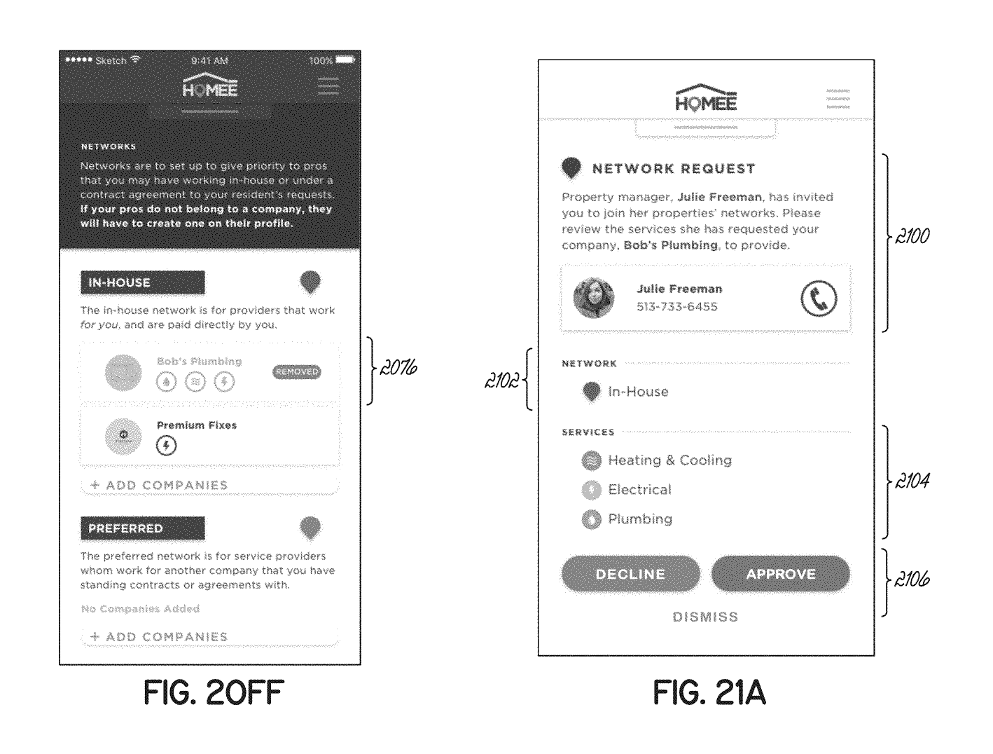

Turning to the screen of FIG. 20A the home screen of a consumer is illustrated, such as home screen of a consumer that is a property manager. Once the consumer adds a property as a managed property to the consumer profile, the main menu field 2000 as illustrated in the screen of FIG. 20A will add a network selection to their profile menu. Once the main menu field 2000 is engaged, the screen of FIG. 20B is presented to a consumer, such as a property manager with a series of selectable menu options 2002. One of those menu options will now include an option for networks 2004. By engaging that “networks” field 2004 a network screen is presented as illustrated in FIG. 20C. Therein, an informational field 2005 is presented to explain the networks and different categories of networks 2006, 2007 might be presented. Other categories of networks might also be utilized and thus the illustrated screen is not limiting to the invention.

Through engagement with the fields 2006, 2007, various different companies can be added to the network of a property manager. For example, 2006 illustrates fields associated with in-house networks. Generally, such a network will be for a provider that works for the property manager, such as the property manager staff that are paid directly by the property manager. Alternatively, those service providers that work for another company the property manager might have contracts or agreements with can be added as “preferred companies”. Through the engagement of appropriate fields to “add companies” as shown at 2008, 2009, one or more companies can be added to the networks as in-house or preferred providers. By engaging one of the fields 2008, 2009 the screen of FIG. 20D is presented to the property manager with a modal message field 2010. The model message asks the property manager if they are searching by company and notes that if a provider is to be added they have to be associated with a company. If they do accompany to search, they might engage field 2012. Alternatively, if the property manager would like to get a provider that does not have a company that can send a message to the provider or to some other entity to have them create a company within their provider profile by engaging field 2014. If the property manager wants to move forward by adding a company, engagement field 2012 will cause the consumer App to present screen of FIG. 20E which includes a search field 2016 for the property manager to search for a company that they would like to add to a network. The screen of FIG. 20E might also include additional information indicating that providers must be part of a company to be added to a network. A search may be made and then a company added which will then be illustrated in a selectable field 2018 as illustrated in screen of FIG. 20F. If the company such as “Bob's Plumbing” is selected, field 2020 is presented and may be engaged for choosing the services of the company. The selected service will be a service that the company will provide in the network that they are added to. While the screen of FIG. 20F shows a single company, multiple companies can be added at a time. For example, the screen of FIG. 20G illustrates multiple company fields 2018.

If the property manager engages field 2020 to choose services, the screen of FIG. 20H is presented in selectable service fields 2021 and 2022 are presented and are selectable service fields that can be engaged for selecting one or more services of a company to be part of the network.

In accordance with one feature of the invention, the company of the provider still must accept being added to a network. Accordingly, once one or more services per company is selected for adding to the network, field 2024 may be engaged to save the selections and then also to have a consumer App send a network request to the provider as discussed herein. That network request will generally note to the provider that a certain property manager has invited them to join a network for the property managers properties. They can then decline or approve. Pending approval, the property manager is presented with the screen of FIG. 20I that notes the acceptance is pending. If the property manager dismisses the screen of FIG. 20I, the screen of FIG. 20J is presented and the fields 2018 for the various companies to be added to the network or indicate as “pending”. If the provider has accepted the network request, the home screen of the property manager, as illustrated in FIG. 20K will now include a selectable network field 2026. The network field 2026 is made available after the first company accepts the property managers network request to join a network. Once the request is no longer pending, the pending designations are removed, and the various companies are shown in the fields 2018 as set forth in the networks screen of FIG. 20L.

Referring to the screen of FIG. 20D, if the property manager does not want to search for company but rather would like to send message to a provider, upon engaging field 2014, they may be presented with the screen of FIG. 20M that includes a menu field 2030 with selectable sub-fields for selecting how they would wish to send the message. For example, as illustrated in the screens of FIGS. 20N and 200 the message might be sent either as an email or SMS message. Such messages will inform the provider to create a company profile in their provider App on their device.

While a provider might accept an addition to a network as illustrated in the screen of FIG. 20K, a provider might also decline. If the provider declines, a message will be sent from the provider App to the property manager App. For example, the message might come as a notification to the property managers App as illustrated in the screen of FIG. 20P.

The present invention also provides a streamlined way to add a company to a property managers network, such as through the profile of the company. For example, referring to the screen of FIG. 20F, the company field 2018 can be selected to add to the network. Alternatively, that card field might also be engaged to open up the company profile then, a screen as illustrated in FIG. 20Q is presented. That screen may include informational field 2032 that has various company details including the services they provide, a website address, etc. Also, a selectable field with 2034 may be presented for adding the company to a network. If field 2034 is engaged, the screen of FIG. 20R is presented with a modal message field asking which network a company is to be added to. For example, as discussed with respected FIG. 20C various network such as an in-house network or preferred network might be available. The modal message field 2036 has various selectable fields 2038 for selecting the network to which the company is to be added. The property manager can also cancel the process through an available field 2039. Once the network has been selected and the noted company is to be added as shown in FIG. 20Q, the network addition process will proceed as discussed with respect to FIGS. 20F-20L.

In accordance with one aspect of invention, as shown in the screen of FIG. 20K, a networks field 2026 provide a property manager with the ability to create and edit networks. The networks can also be selectively activated for job requests from a consumer/resident for a property with which the networks are associated. Once a property manager sets up a network, and they return to the home screen, the screen of 20S is provided having informational field 2040 and a selectable field 2442 for getting additional information. If additional information is requested, the screen of FIG. 20T is provided with additional informational field 2044. Swiping or scrolling through the available information fields the screen of FIG. 20U and the screen of FIG. 20V are presented. The screen of 20U describes the networks and provides the property manager with the ability to select or deselect one or more network fields 2046. Similarly, as shown in the screen of FIG. 20V a screen reflective of a resident job request to the PM is shown with a selectable networks field 2048 that may be engaged by the property manager. Upon engagement, the screen of FIG. 20W with network filter fields that may be selected and deselected by the property manager for use with a resident's job request is presented to the PM. Upon approval to a job request, the property manager thereby make sure that their job search goes to the various networks selected in a particular order as discussed herein. FIG. 5G illustrates the flow for the creation of provider networks as described herein.

In accordance with another feature of the invention, once a network is set up by property manager for a property, the property manager can edit the network. For example, when reviewing networks, such as from the screen of FIG. 20L, the various company fields 2018 in the network can be selected to see details on any of the companies that belong to the network. The property manager can engage the company card or field 2018 and is presented with the screen of FIG. 20X which includes informational fields 2050 and 2052 that show the network that the company is associated with, as well as the details regarding the services that the company provides in that network, respectively. To edit those details, selectable edit field 2054 is provided. Upon engaging the edit field, the screen of FIG. 20Y is presented that has selectable fields 2056 and 2058. Through field 2056, the property manager can switch the network that the company is in, such as through a drop-down menu. Alternatively, through field 2058 a property manager can select and unselect services associated with the company. Then through fields 2060, the property manager can save the edited changes, canceled the editing process, or remove the company from the network. If the editing changes are saved, the screen of FIG. 20Z might be presented to the property manager notifying them that they have to wait until the provider approves the network changes they have made before those changes will be added to the network for the company. This may happen for certain edits, for example, if the property manager adds new services or if they change the network they are under, the changes might be considered pending. If the property manager takes away services, there will be no pending period and the changes will be made immediately. Providers are notified and need to approve of network changes (for example from preferred to in-house) and service additions but will not be notified about service subtractions. Then the screen of FIG. 20AA is presented with message field 2062 indicating that changes have been saved. Once the provider who owns the company accepts the changes, screen of FIG. 2066 is presented with message field 2062 indicating that the network changes have been added for that company with respect to the network of the property manager.

Alternatively, if the field 2064 for removing the company is engaged, the property manager is presented with the screen of FIG. 20CC that has an informational field 2066 regarding the removal of the company from the network and the ramifications. Furthermore, informational field 2067 provides information about the company that is to be removed. Finally, by engaging one of the fields 2068, the company can be removed, or the removal process can be canceled. If the property manager proceeds, the company is removed and the screen of FIG. 20DD is provided to the property manager with message field 2070 indicating that the company has been removed.

Similarly, a company can remove themselves from a network. As such, if a provider removes their company, it will be removed from the network and the property manager is presented with the screen of FIG. 20EE. An informational field 2072 informs the property manager that company has removed themselves from a designated network and informational field 2074 provides information about the company. Once a company has been removed, the informational card field 2076 for the company will be modified to indicate its removed status until a property manager opens it at least once and then the designation might be removed from the network profile as illustrated in the screen of FIG. 20FF.

As discussed, providers are engaged in the networking process by accepting a property manager's request that they join the network. They can control membership in such a network by accepting a network request, declining a network request, or having the inventive system remove them from the network once they have joined. When a property manager sends a network request to a provider, the provider App presents screen of FIG. 21A to the provider and invites them to join. Fields 2100 provide an indication of the property manager who has invited the provider to join a network for the property as well as contact information for that property manager. Field 2102 provides an indication of the network to be joined and fields 2104 provide an indication of the services that are requested for the company of the provider. Selectable fields 2106 are used to approve or decline the network request or to simply dismiss the process. If dismissed, the process can be dealt with later by the company. If the provider approves the network request by engaging the appropriate field 2106, the company is added and the screen of FIG. 21B is presented to the provider which shows the providers profile and indicates with a message field 2108 that a network has been added for that company and for particular property manager. As illustrated in the company profile fields 2110, the various networks are indicated as are the property managers associated with those networks. The noted network fields can be engaged and expanded as illustrating the screen of FIG. 21C for seeing additional information about each of the PMs and networks provided in fields 2112.

If a provider declines the network request through the engagement of the appropriate field 2106, they are presented with the screen of FIG. 21D with informational fields showing the property manager and asking whether they wish to continue to decline the network requests. As illustrated in fields 2114 by engaging one of the selected fields 2116, the provider can continue to decline the network or simply cancel the process. Upon declining the network, they are not added to the network and are presented with the screen of FIG. 21E in their company profile with an appropriate message field 2118 that the network has been declined.

Furthermore, a provider, once they are a member to network, can remove themselves and their company from that network as disclosed. To do so, within the providers profile screen as illustrated in FIG. 21B, an edit field 2109 might be engaged which will put the profile into an edit mode and present fields 2120 and 2122 for the different networks as shown in the screen of FIG. 21F. Each of those fields includes a delete field 2124 that may be engaged for selecting that network to be removed from the company profile. Then upon engagement with field 2124, the provider is presented with the screen of FIG. 21G with a modal message field 2126 asking them to confirm that they wish to disconnect from the network. Upon confirming by engaging the appropriate field of field 2126 the network can be removed. If confirmed, the provider is presented with the screen of FIG. 21H where they must engage a field 2128 to save the changes made to the company profile in order to complete the deletion and remove the network. If the deletion is complete, they will be provided with the screen of FIG. 21I with message field 2130 indicating that the company information has been saved. The network fields 2112 will no longer show information regarding the deleted or disconnected network.

### Companies

In accordance with another aspect of the invention, a provider can be engaged with a company and provide services as part of the company. They must be a part of a company to be added to a network. The provider can be engaged as an owner of the company and thus an employer of other service providers. The provider/employer can also operate as a service provider themselves. As a company, an employer can add licenses to certain services within their provider profile and various of the employees that are associated with the company of the employer can work or operate under those licenses. Furthermore, a provider that is an employer can adjust the rates of the employee providers and can adjust how much the employee providers see from each receipt of a finished job. The process flow as described herein is illustrated in FIG. 5I.

In accordance with one aspect of the invention, the employer provider and employee provider have separate interactions within the inventive system wherein the employee provider is presented with an invitation and a company code which can then be accepted by the employee provider so that the employer and employee are connected within the inventive system for providing service to various consumers. Furthermore, as disclosed herein, a provider in a company can be added to one or more networks associated with the property that is run by a property manager. As such, employee providers of the company can then be treated in a preferential way in a job request search depending upon the services that are requested by a consumer, such as a property manager.

A provider can be affiliated with a company either as the business owner of the company and an employer, or as an employee that will work for the company or work for the owner of the company.

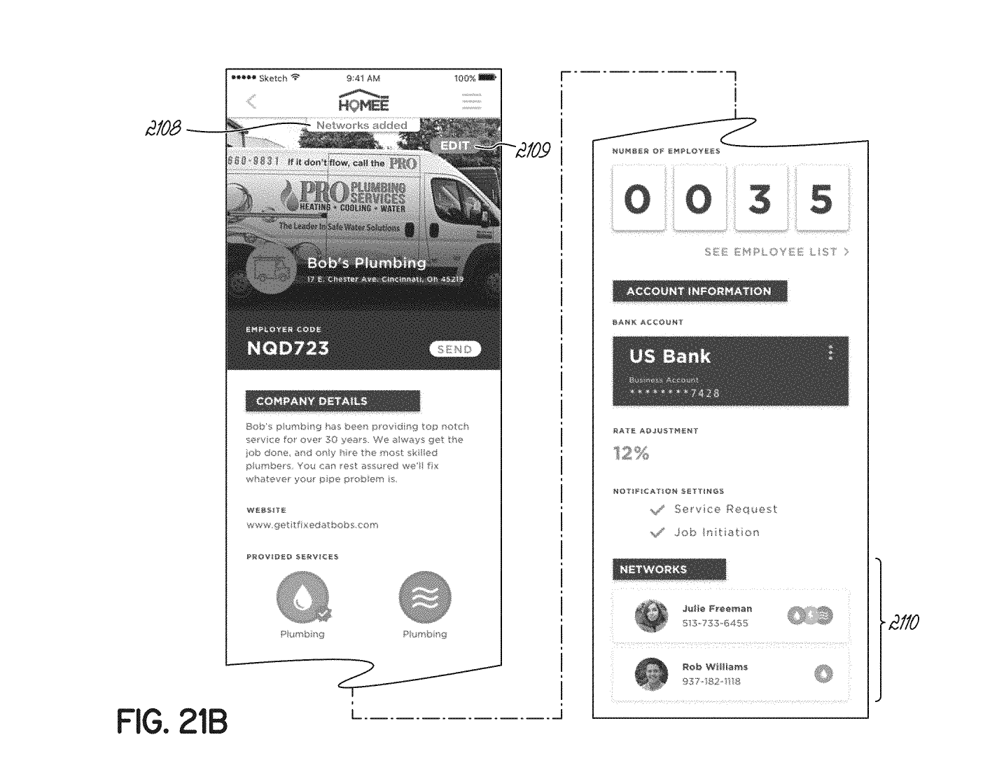

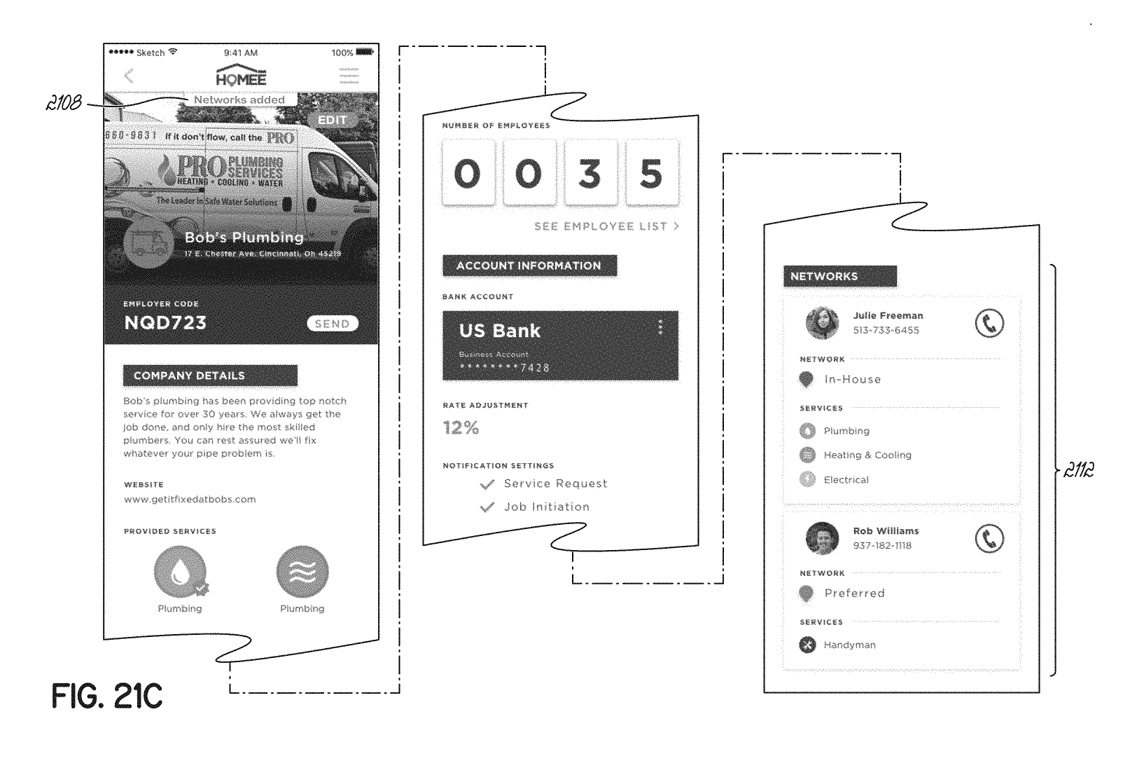

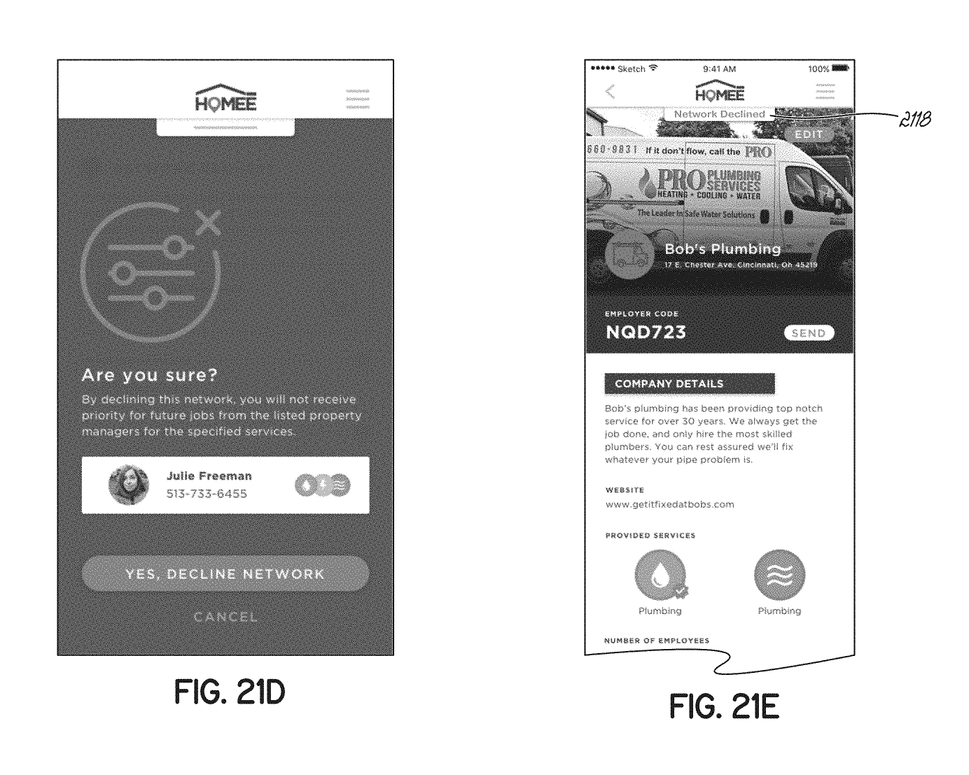

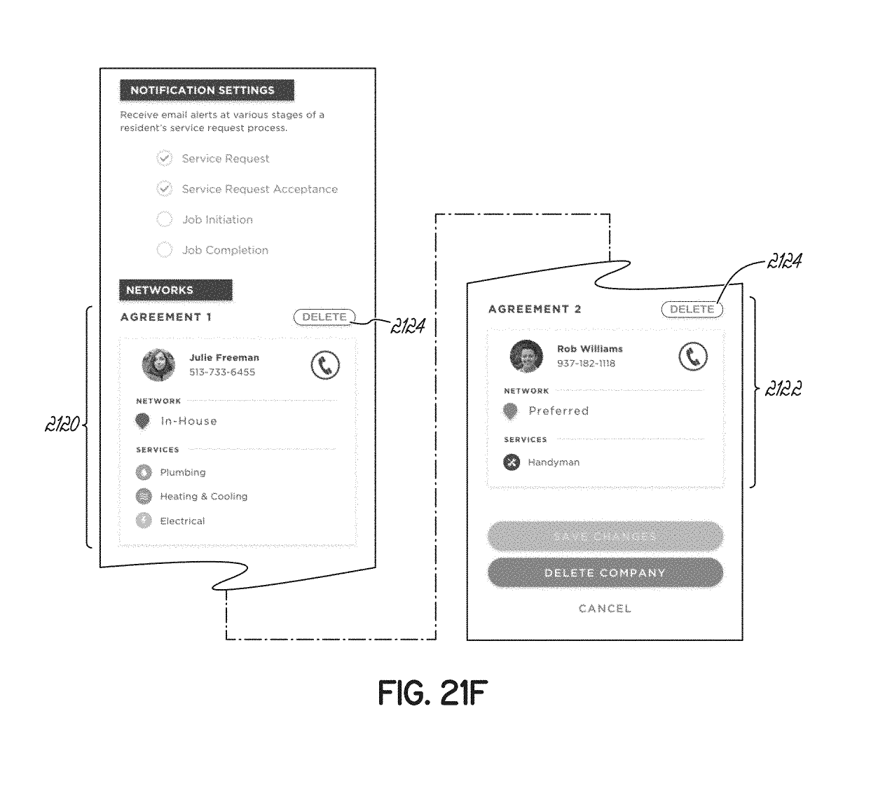

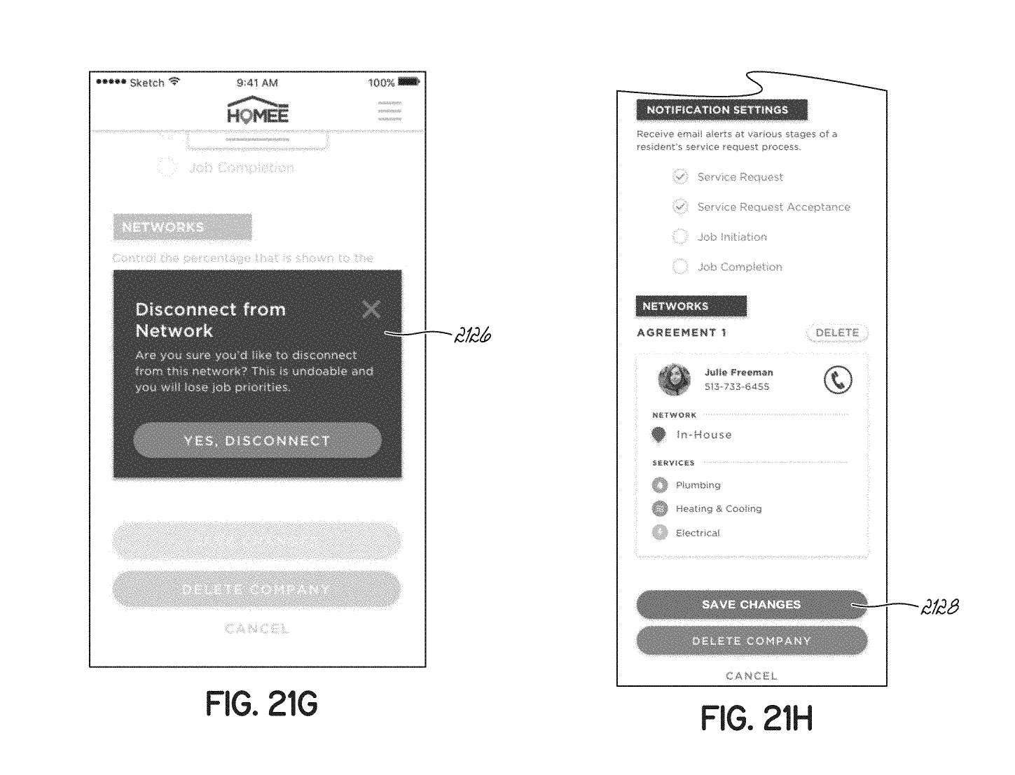

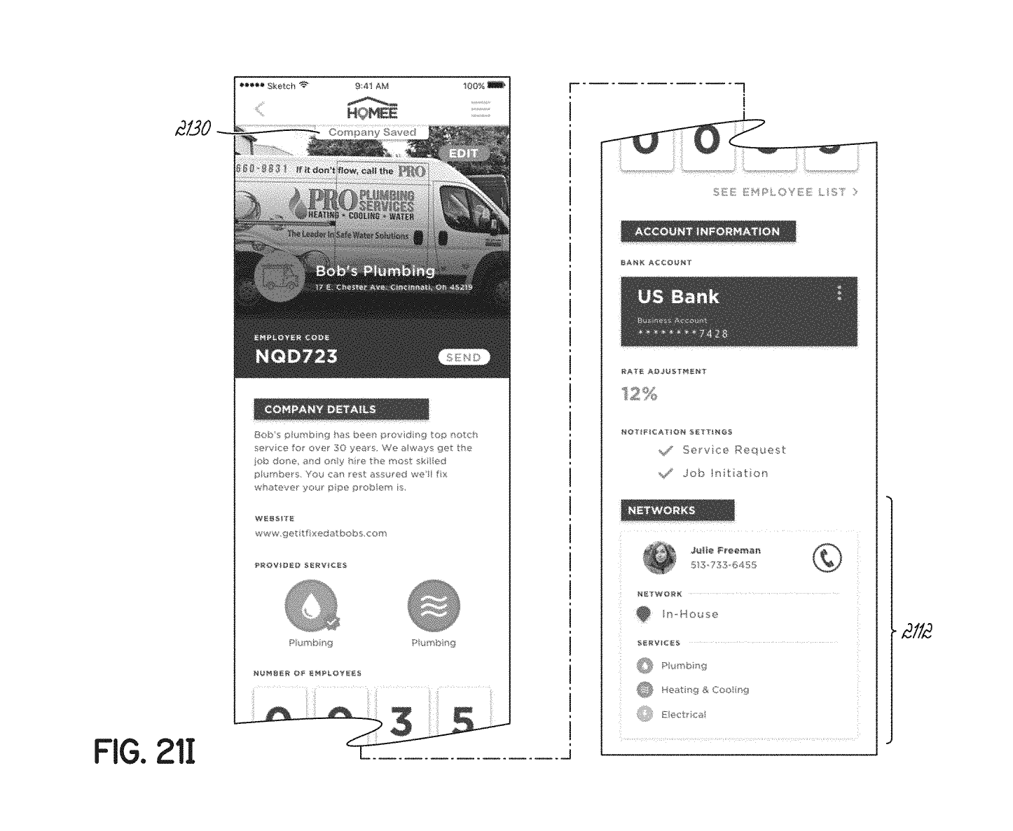

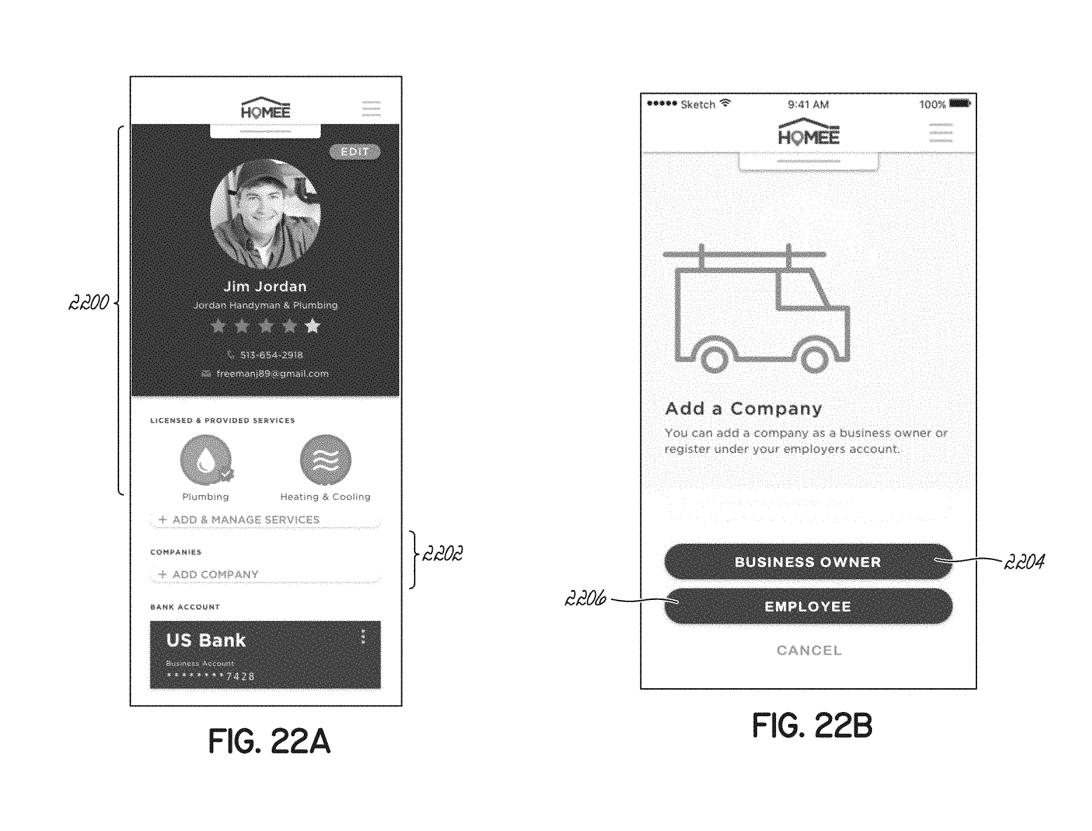

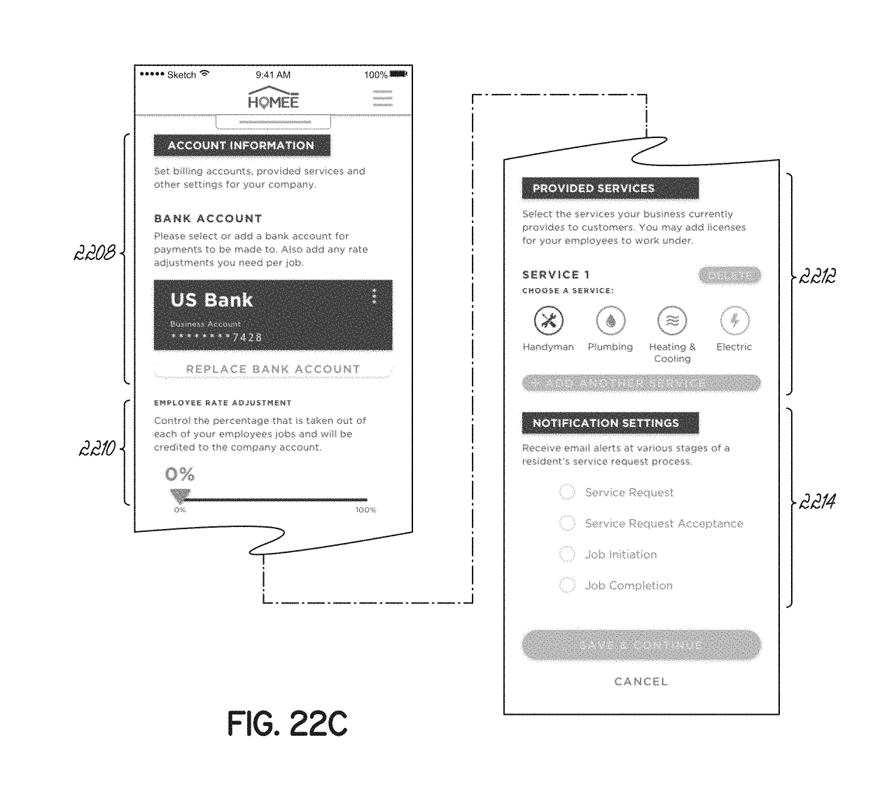

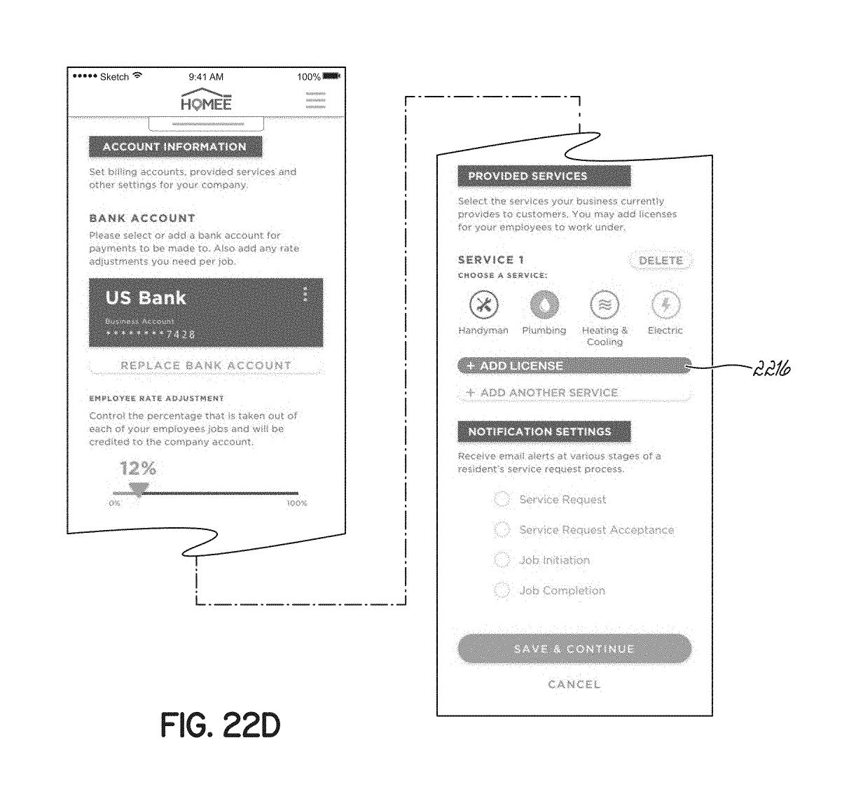

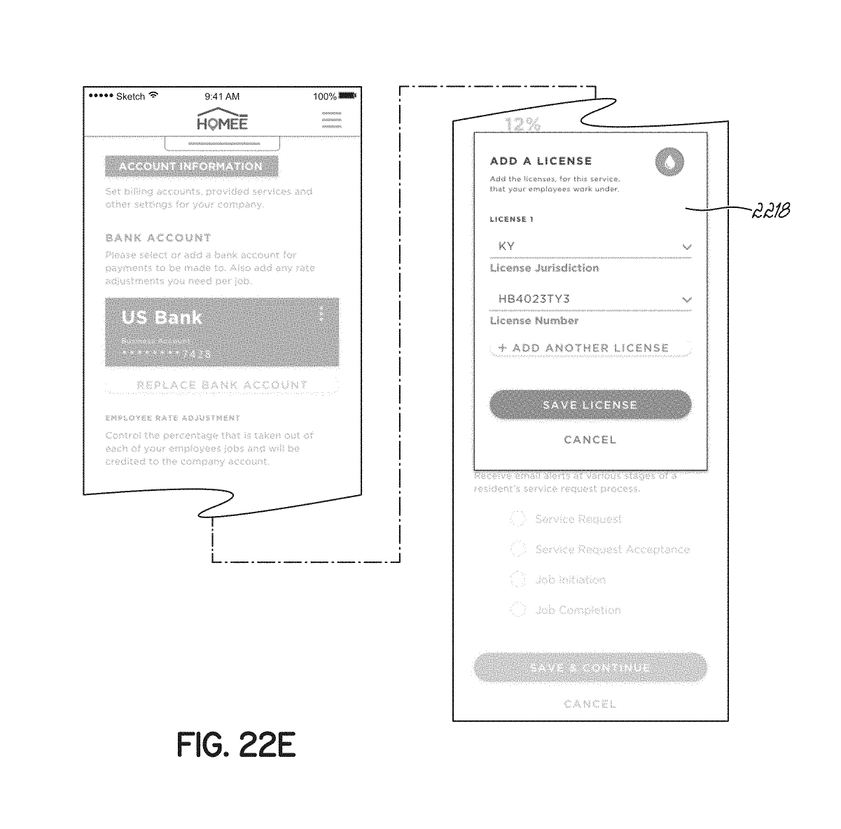

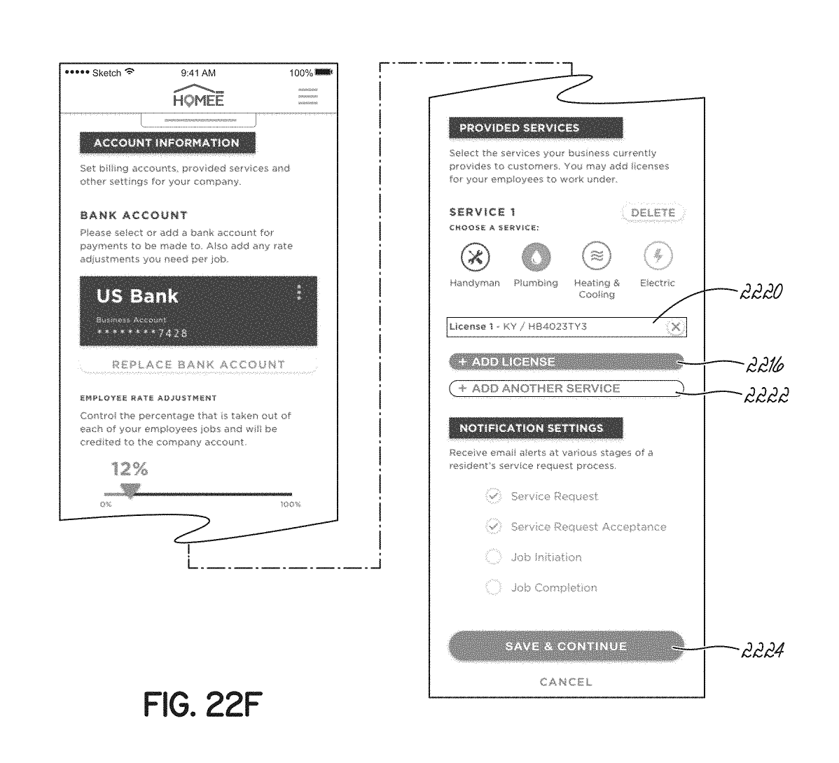

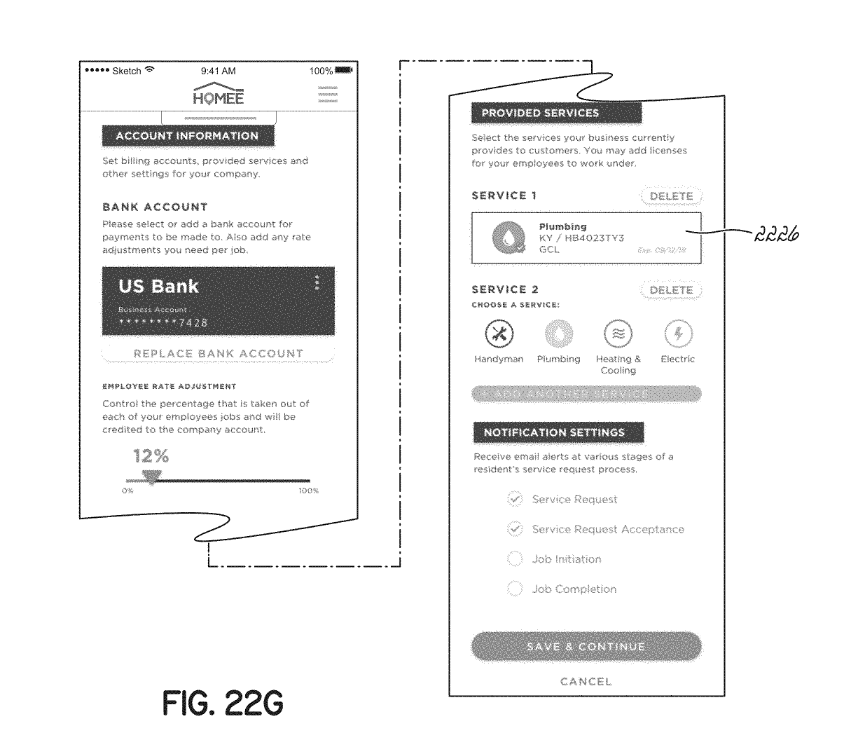

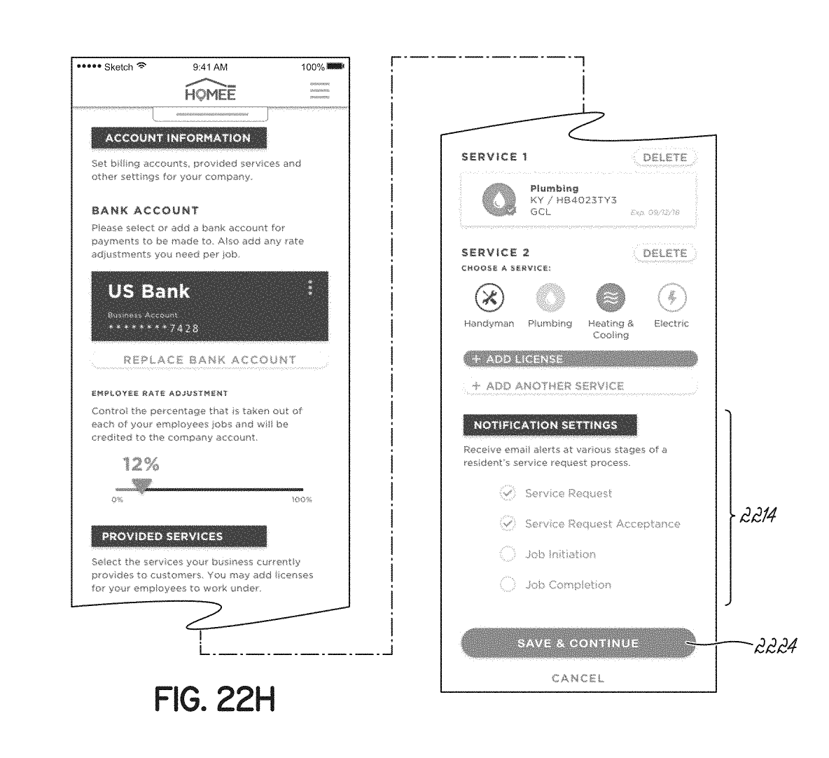

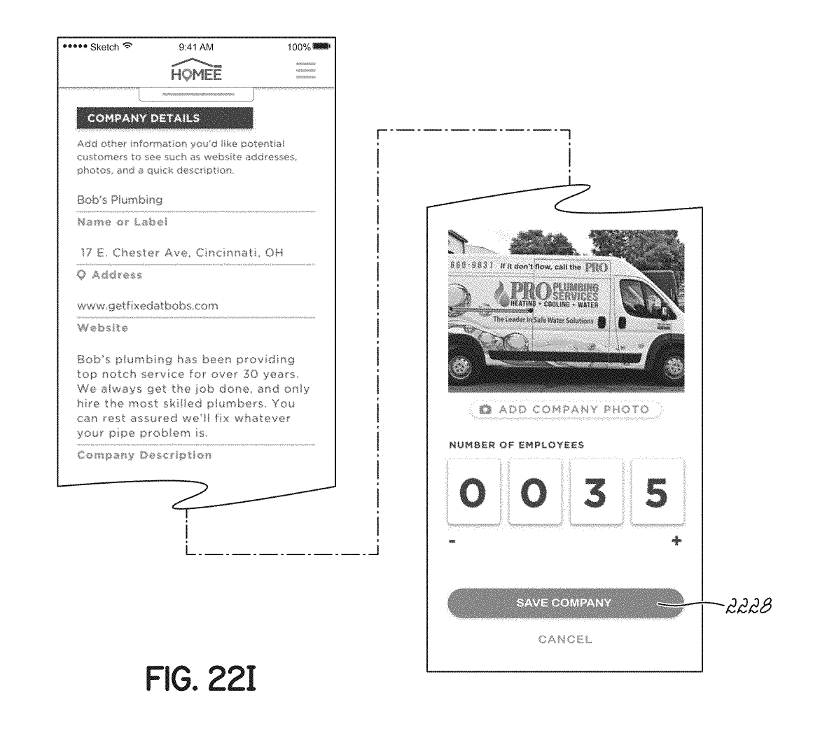

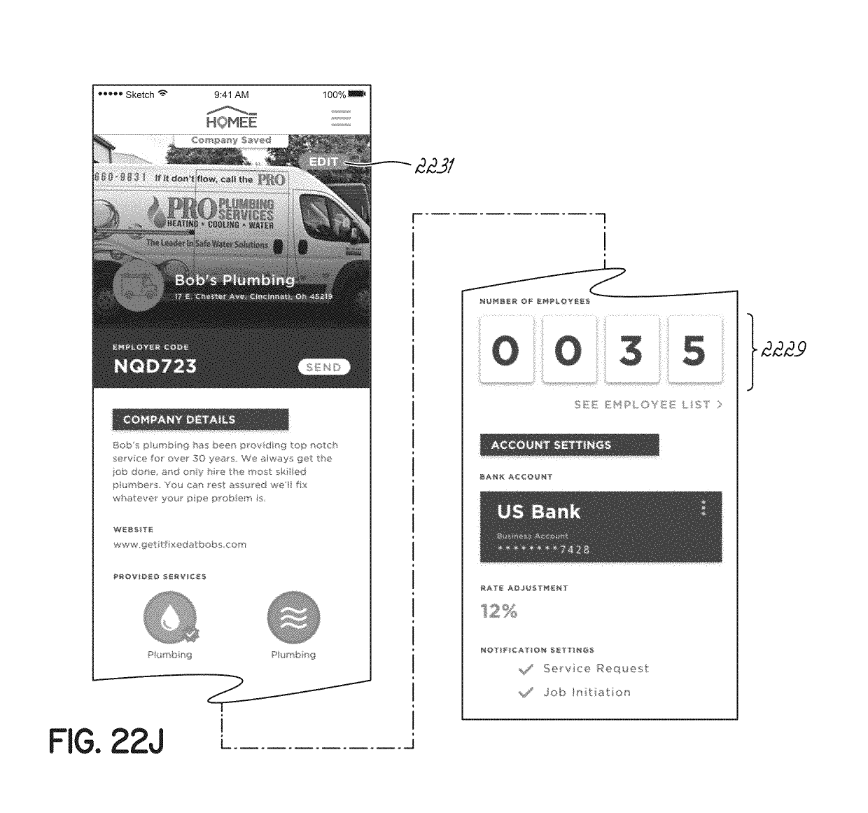

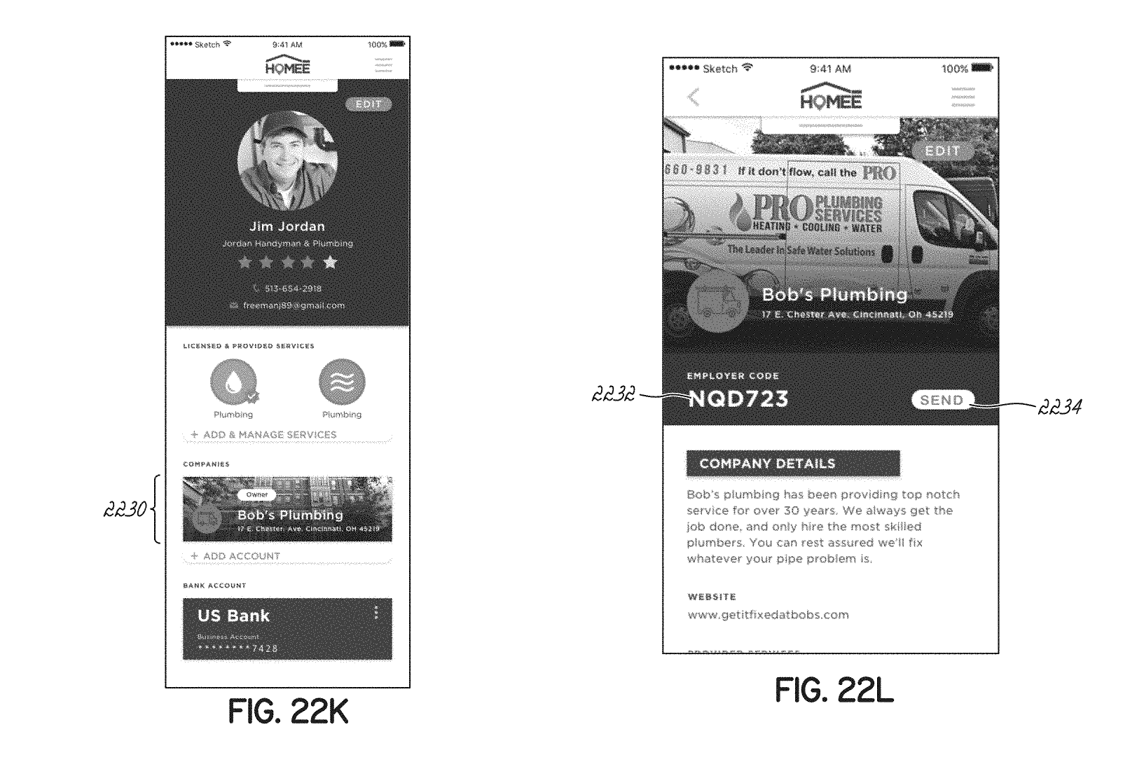

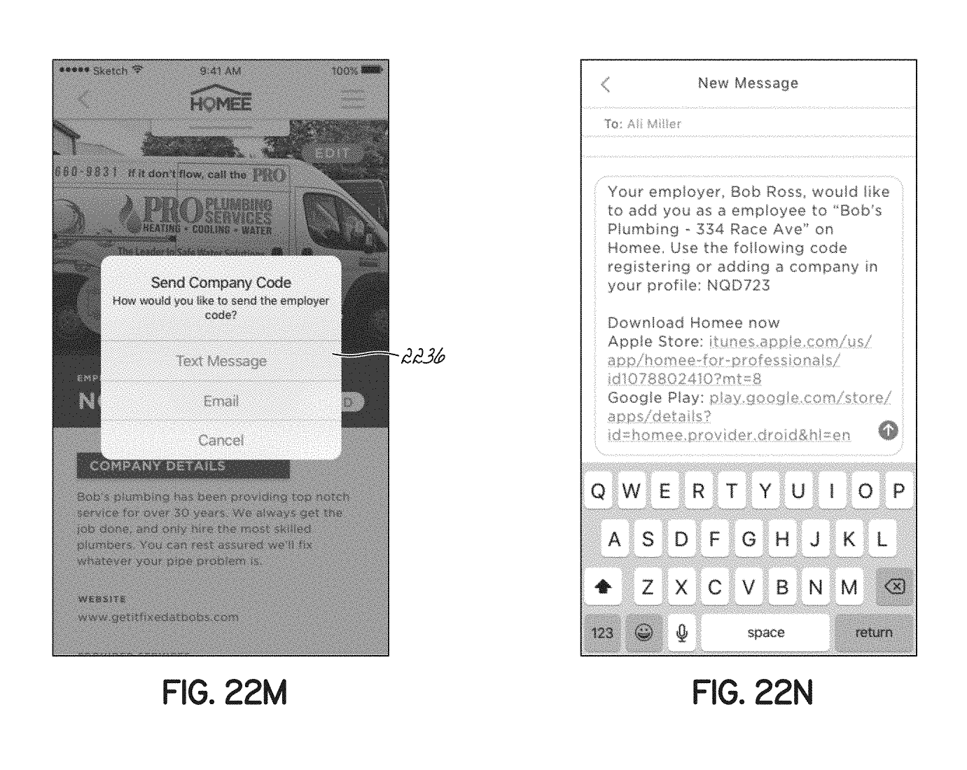

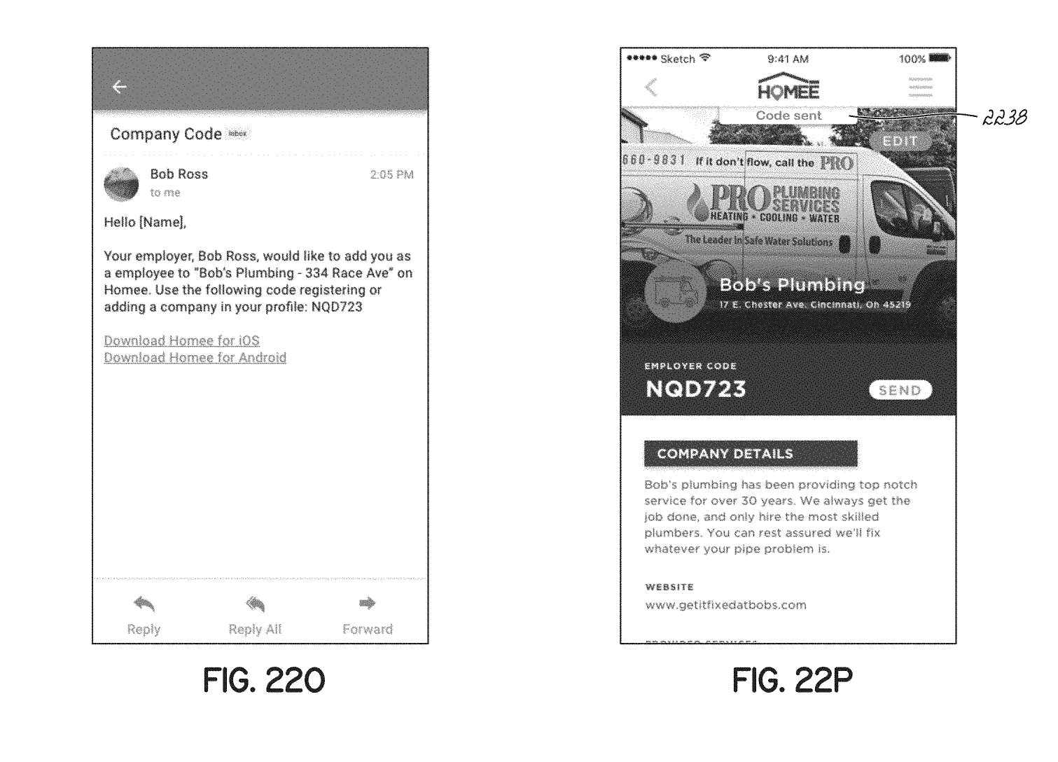

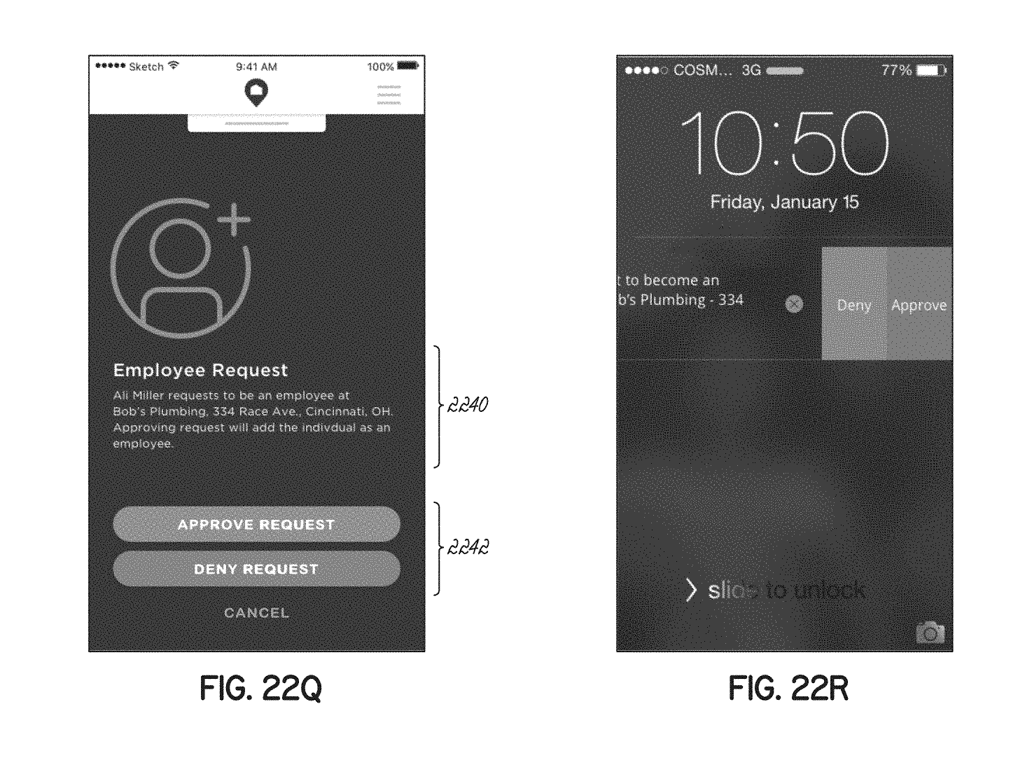

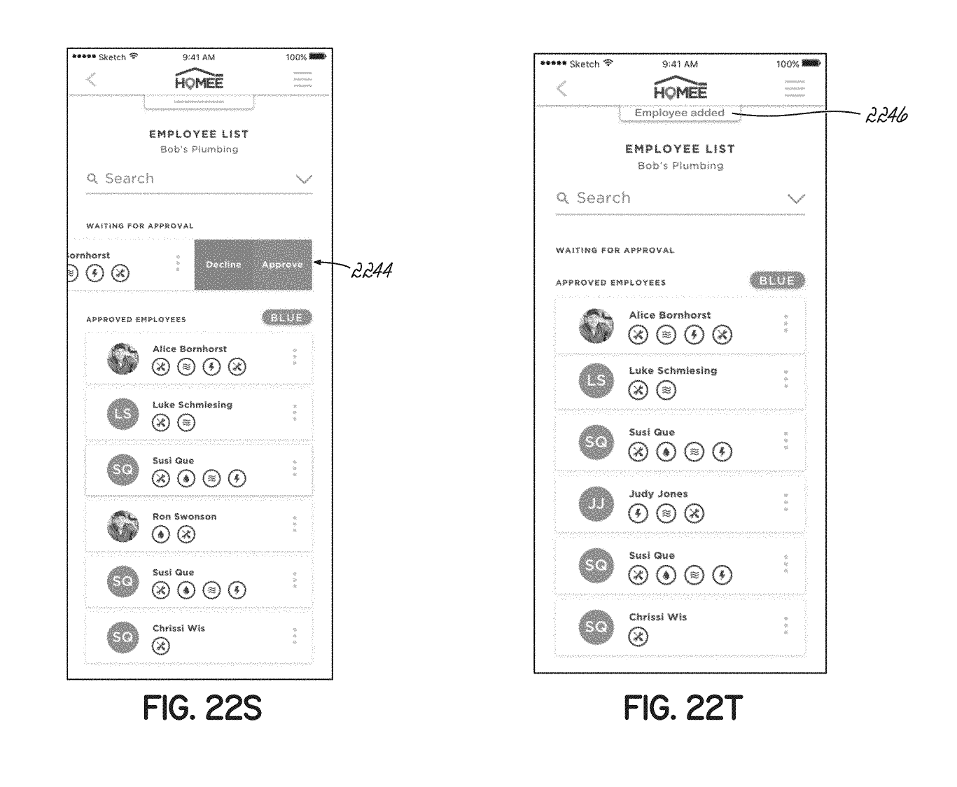

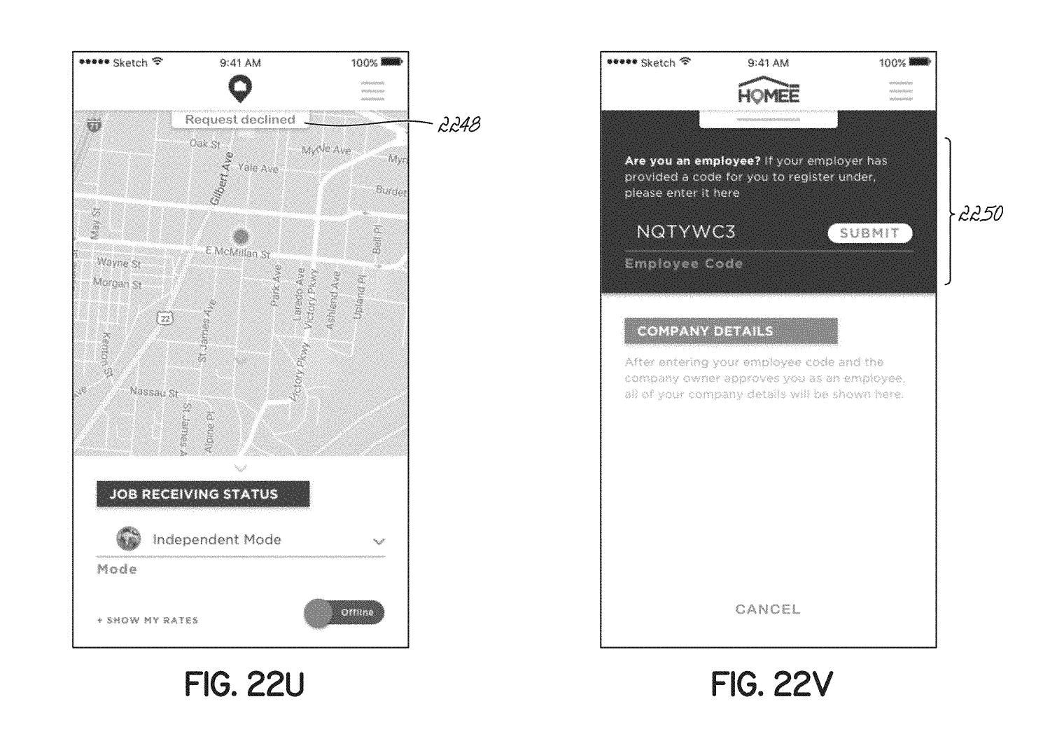

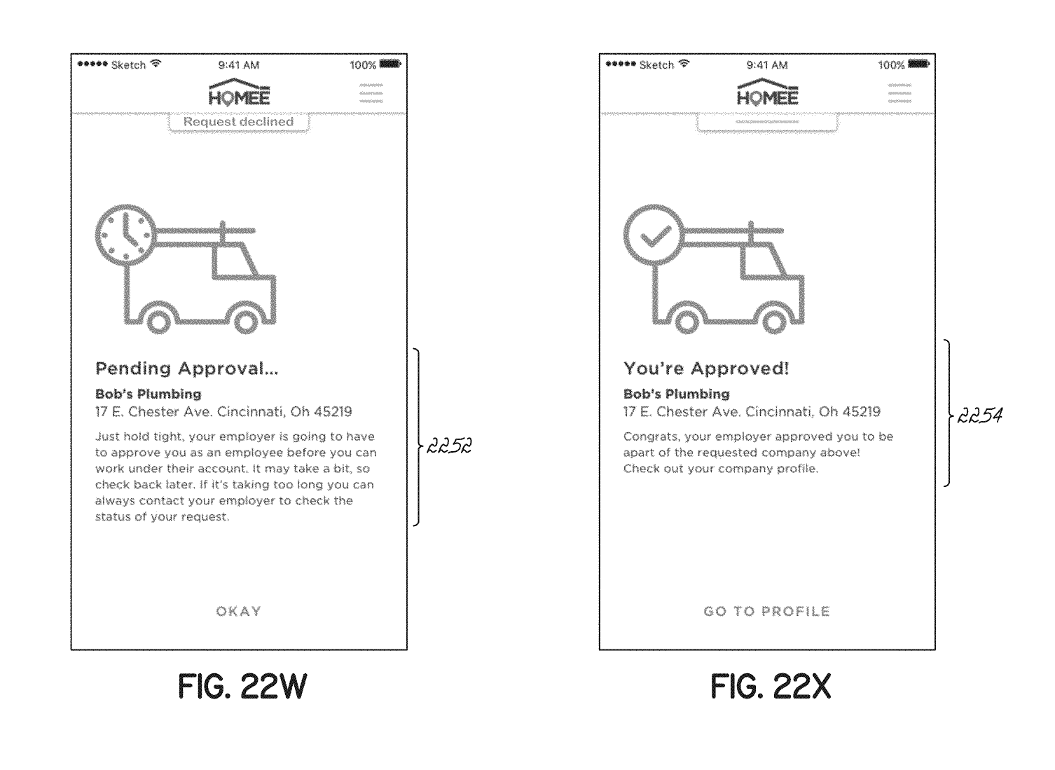

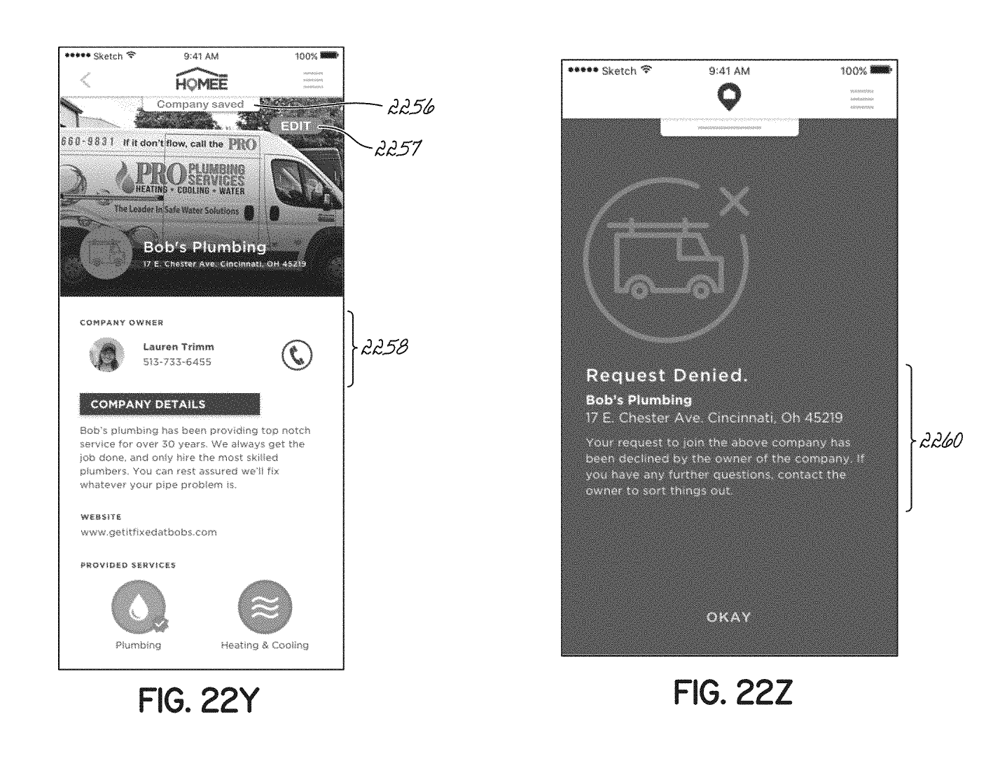

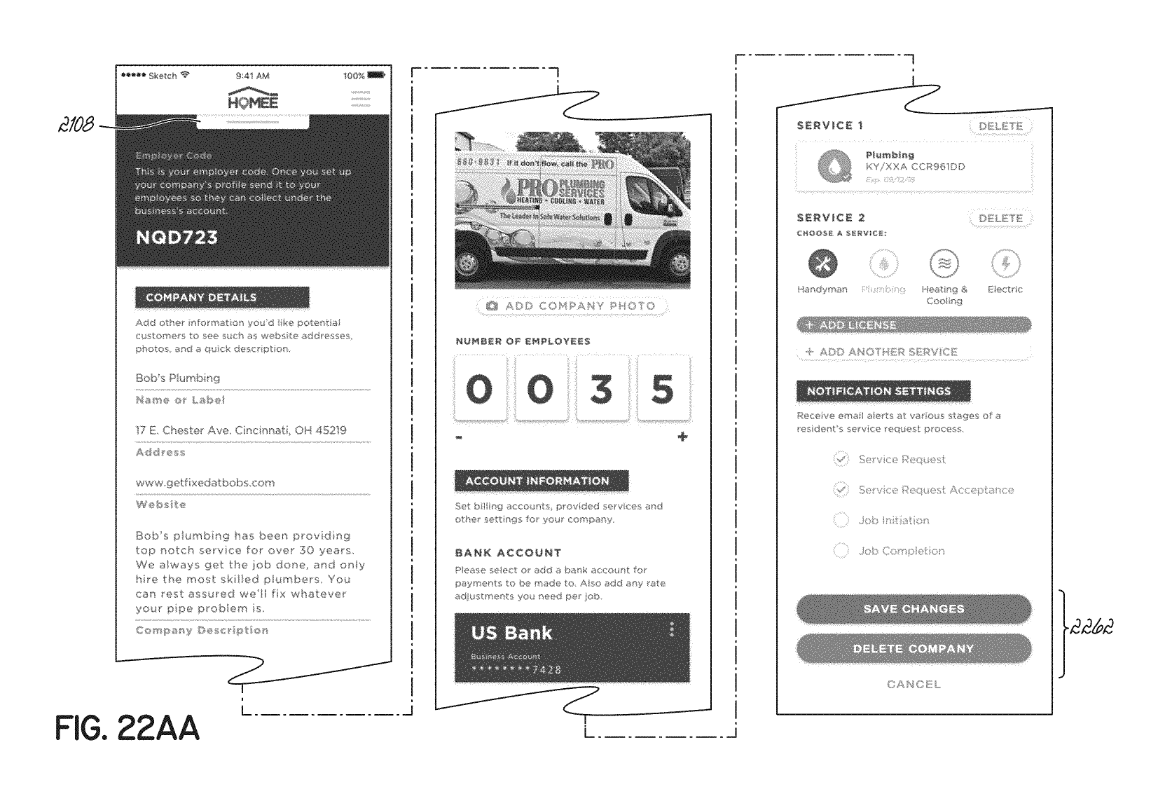

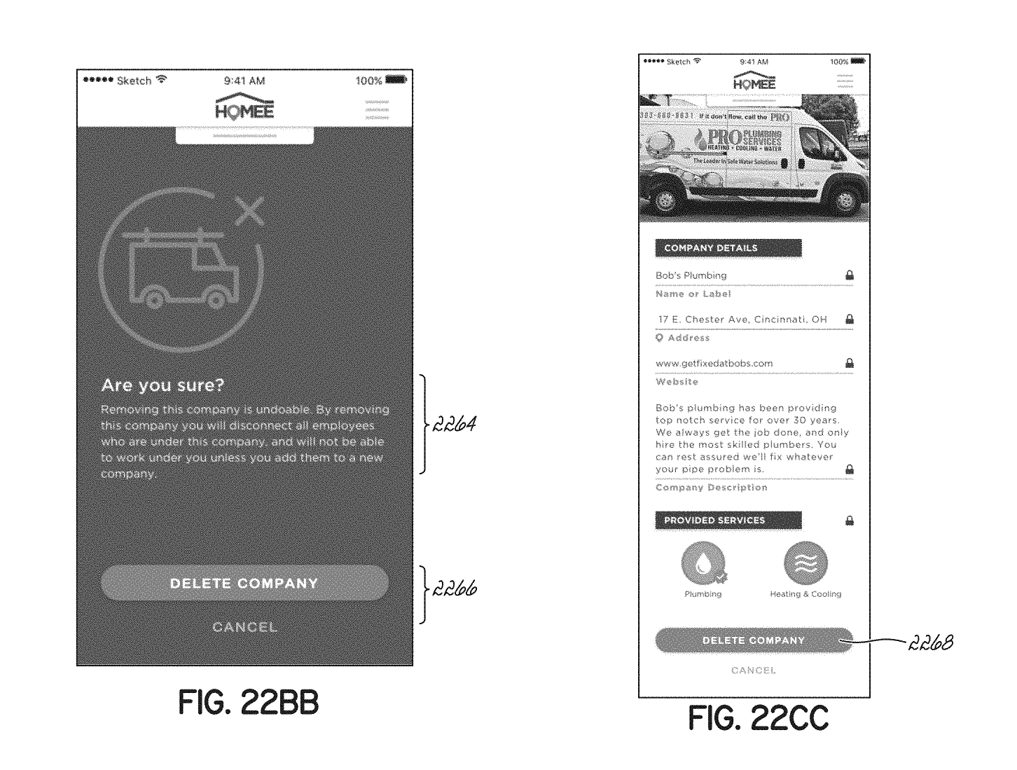

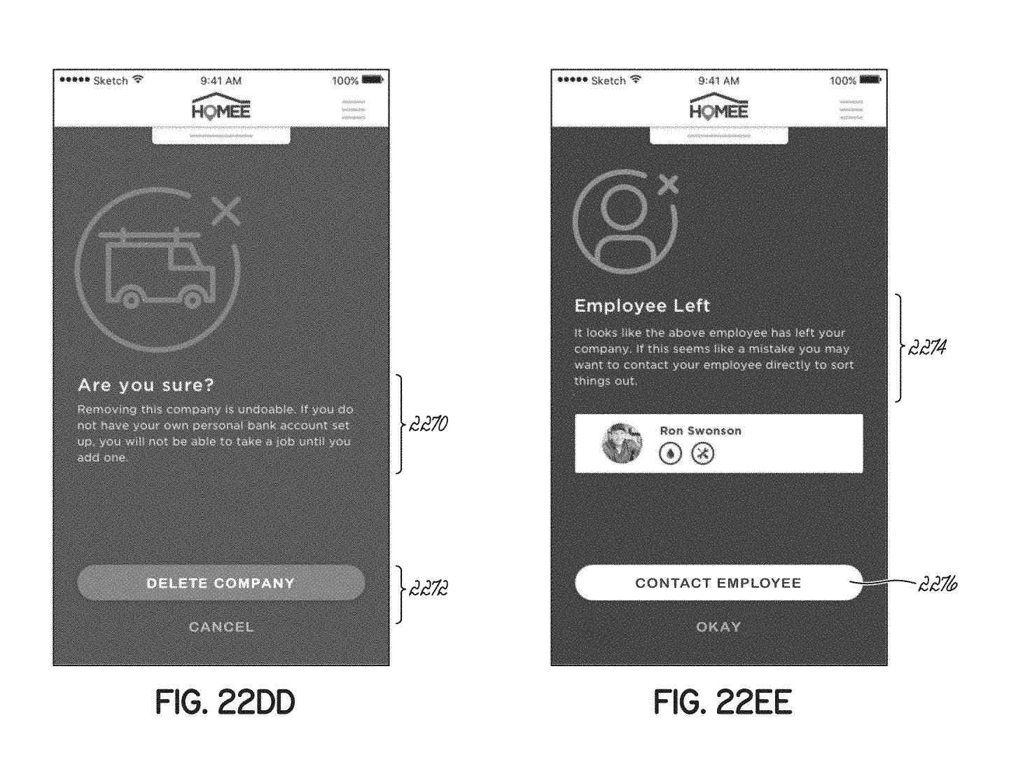

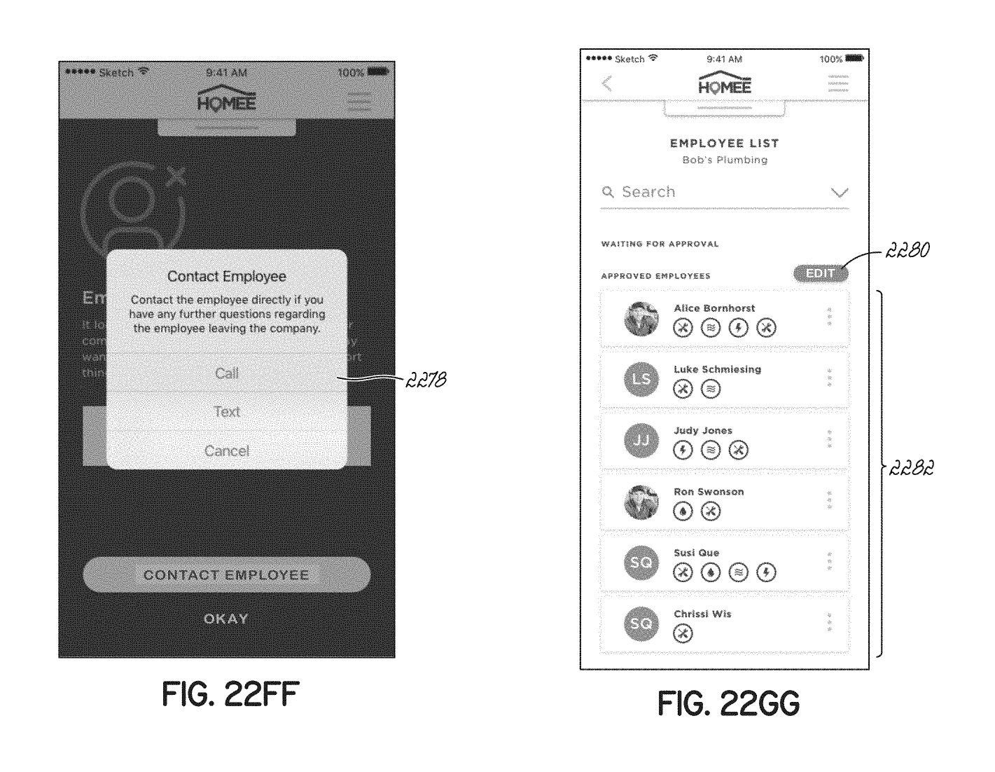

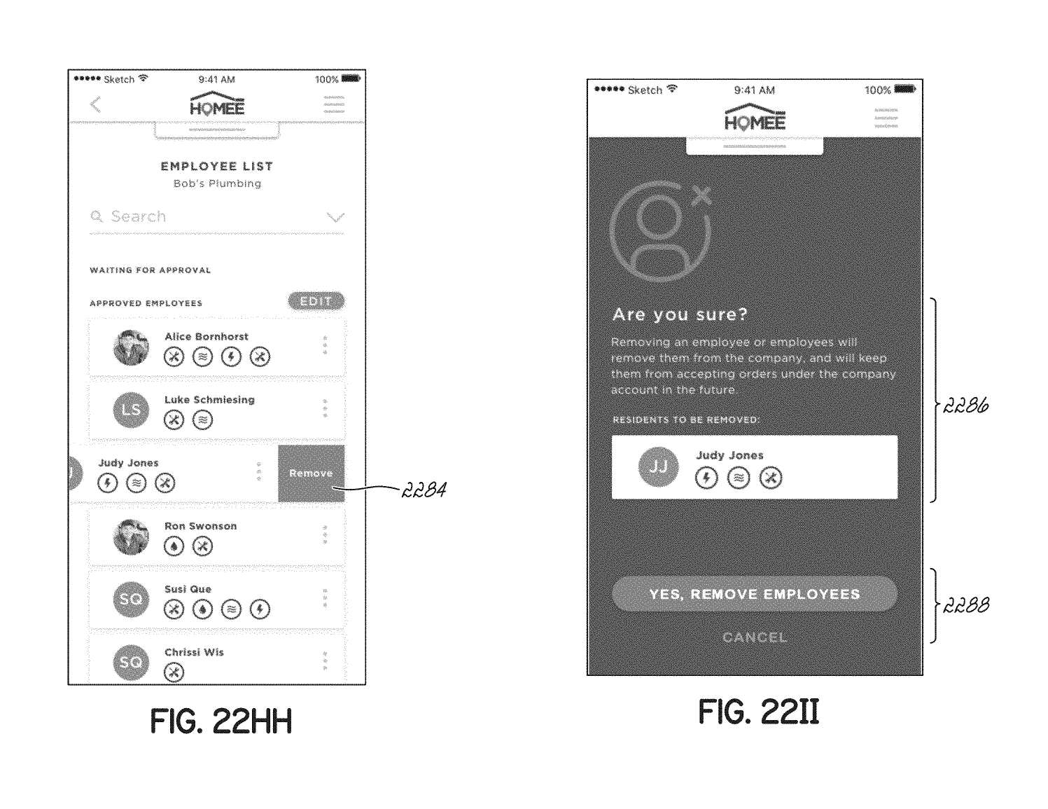

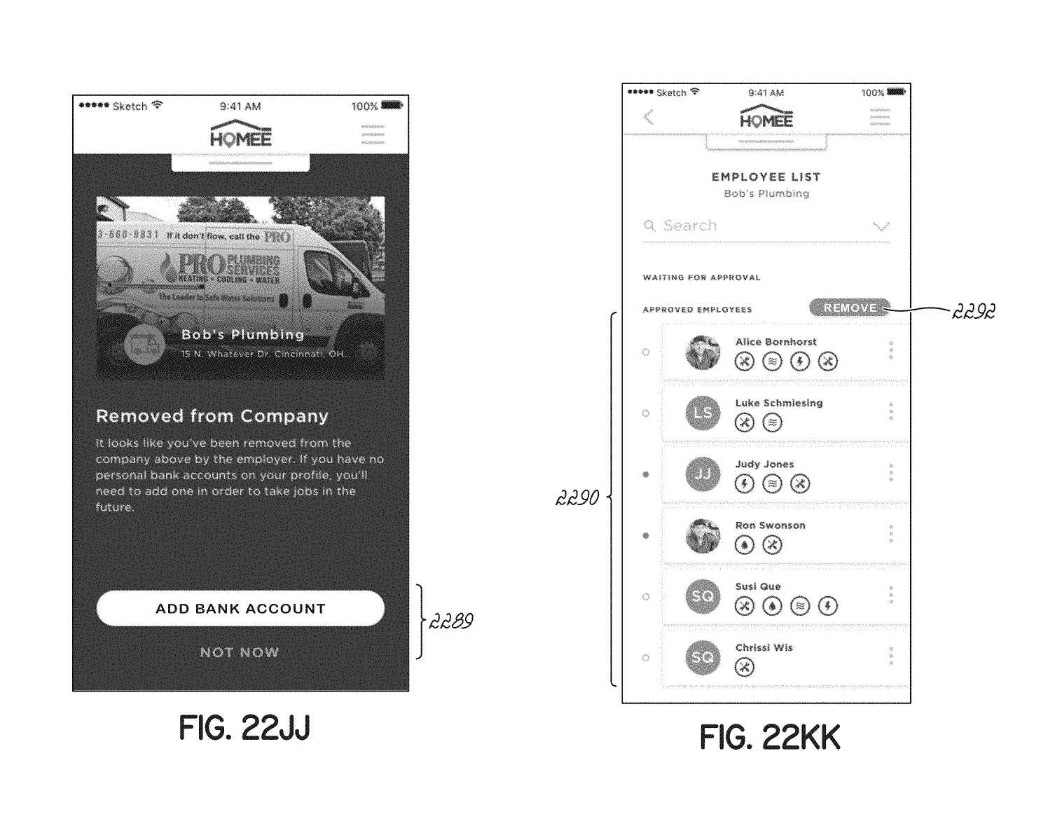

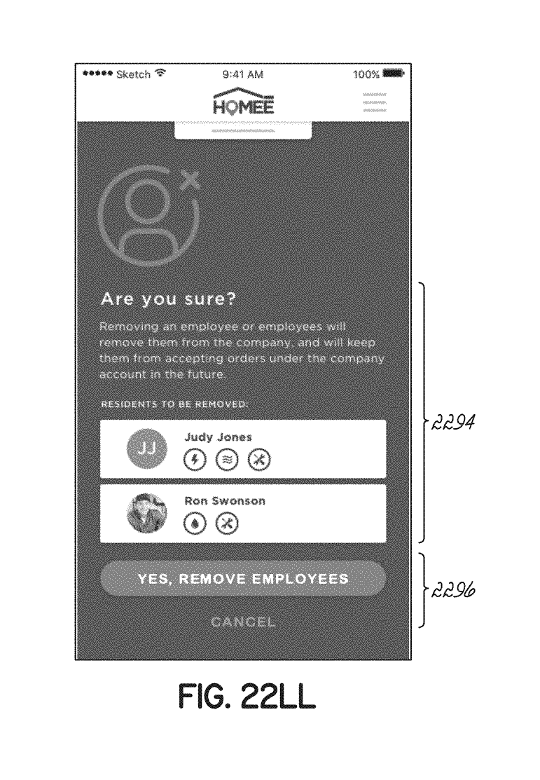

In a provider profile, as selected from the menu in the provider App, the provider is presented with the screen of Figured 22A that has informational fields 2200 about the provider and the services that are provided. The company field 2202 is also included and may be engaged for adding a company to be associated with the provider. Upon engaging the field 2202 in the screen of FIG. 22B is presented to the provider which gives the provider the ability to add the company as a business owner or employer or to add the company as an employee through engagement with a selected one of the fields 2204, 2206. The addition of the company could also be canceled through an appropriate field on screen of FIG. 22B. Once the provider has selected their status as a business owner or employee, the screen of FIG. 22C is presented which includes a number of informational fields and selectable or engageable fields for entering information associated with the company to then be used within the inventive system during the provision of service between a consumer and a provider as discussed herein. The present invention will walk the provider through a series of screens and require certain information before proceeding to add the appropriate company information to the providers profile in order to use that company information, such as for allowing the provider to join a network of the property manager as discussed herein. The screen in FIG. 22C may include a number of fields with information and selectable subfields for entering information regarding the provider. For example, fields 2208 might include bank information indicating the bank account for the provider and allowing for the bank account information to be replaced. In accordance with one feature of the invention, the company owner/employer can control what rate is seen by an employee for the work of the employee provider. The rate adjustment field 2210 has a slider mechanism that allows the employer to control the percentage that is shown to an employee provider working for the company after a job is completed. That is, the employer will have the ability to charge an employee at a higher rate than the employee will be allowed to see at the completion of a job. Fields 2012 allow for one or more services to be selected that will be provided to consumers.

In accordance with one aspect of the invention, notification fields 2214 are provided so an employer may select a particular notification setting to find out about the progression of jobs by an employer. With such notifications, an employer will receive message alert, such as email alerts at various stages of a consumer's service request process wherein an employee of the company is providing the service. For example, depending upon the selected notification setting in field 2214, the employer might receive a message alert upon the initiation of a service request, upon the acceptance of the service request, upon initiation of a job, and upon the completion of the job. Once one or more services of field 2012 are selected as well as one or more notification settings of field 2214, the provider can proceed to add licenses associated with various of the selected services.

Once a service is selected, the screen in FIG. 22D is presented to the provider selectable field 2216 that allows the provider to license associated with the service. Upon engagement with that field, screen of FIG. 22E is presented to the provider which includes a modal message field 2218 where selectable subfields for adding license information, such as a licensed jurisdiction as well as a license number are presented. Once that information is provided, the license can be saved. In the profile screen as shown in the screen of FIG. 22F, the added license information 2220 is shown for the noted service. The license may be deleted through field 2220. Field 2216 can be again engaged to add another license. In accordance with the invention, the employees linked to the company as described herein can operate to provider services under the company licenses that are in the company profile.

Upon addition of one service, a field 2222 is presented in the screen for adding another service upon engagement by a provider. Field 2224 may then be engaged to save the information. As illustrated in FIG. 22G, once additional services are added the current service might be condensed into a card field 2226 as shown in the provider screen of FIG. 22G. As illustrated in the screen of FIG. 22H, as notification settings in field 2214 may be selected for particular notification. Once that information has been added and saved through engagement with field 2224 the provider is presented with the screen of FIG. 22I for entering additional company details including company name, the address which might be required, and other optional information, such as a website, company description, company photo, and the number of employees for that particular company. Once that is entered, field 2228 may be engaged to save the company information. Once saved, the company profile is created as illustrated in FIG. 22J. Furthermore, as illustrated in FIG. 22K, the providers profile will also include a card field 2230 with the company information that may then be engaged to view the company profile is illustrated in the screen of FIG. 22J.

In accordance with another aspect the invention, a company as an employer may link one or more employees with the company. Specifically, the employer provider, through the company's profile, can send an employer code to one or more employees and invite them to join the company through the inventive system. In that way, the employer is linked with the company for various reasons as discussed herein.

When the company profile is selected by a provider through an appropriate menu, the screen of FIG. 22L is presented that includes employer code 2232 to be sent to a potential employee as well as an engageable field 2234 for sending that code. Upon engaging field 2234, a modal message field 2236 is presented for sending the company code via a text message or email. The provider can cancel out of the process as well. If a text messages selected, a prefilled message as shown in the screen of FIG. 22N is provided. If email selected, the prefilled email as shown in the screen of FIG. 22O is provided the varies email or message screens can then be sent. Upon being sent, the profile page of FIG. 22P is presented with a message field 2238 that the code has been sent. An employee will then receive the code and will have to use that code to send a request to join the company as disclosed herein. Once an employee requests to join the company with the appropriate code, the employer provider is presented with the screen of FIG. 22Q with an informational field 2240 and selectable fields 2242 for either approving a request or denying the request. If the screen is locked, a similar information message with selectable fields may be provided as shown in the screen of FIG. 22R.

If the employer request is accepted, an employee will be added to a list of employees as illustrated in the screen of FIG. 22S that are associated with the company and might be shown by engagement with a field 2229 as illustrated in the screen of FIG. 22J. Approval or denial can also happen right in the list as illustrated in FIG. 22S wherein pending employees are shown and include selectable fields 2244 that an employer provider can use to approve or decline the request. Once approved, the employee is added to the company and the employee list as shown in FIG. 22T will have a message field 2246 indicating that an employee was added. Alternatively, if the employer request is declined, the screen of FIG. 22U, which is a home screen for the provider is presented which includes a message field 2248 indicating that the request has been declined. In that case, the employee will not be added to the company.

Referring to FIGS. 22A and 22B, through a provider's profile screen the employee can select a company and then are given the choice to add the company as an employee or business owner. If the employee field 2206 is selected, the employee provider is presented through the provider App as the screen of FIG. 22V where they have to enter an employee code that was previously provided to them by the employer or owner of the company and then submit their request with the code as shown in fields 2250 of FIG. 22V. A valid code must be entered and then once a valid code has been submitted, screen of FIG. 22W is presented to the employee with informational field 2252 regarding the company as well as information that the employer must approve joining that company. That is, the employer must approve the employee. The employee is then brought back to their profile screen similar to that shown in FIG. 22K and any company field 2230 will be grayed out or unclickable until approval has occurred. Once approved, the screen of FIG. 22X is provided with field 2254 indicating the approval and other information regarding the company. The screen of FIG. 22Y is presented to the employee indicating the company profile with suitable message field 2256 indicating that the information has been saved in a company profile. Furthermore, the company profile will include field 2258 for contacting the employer. Also, the company will be added to the employee's profile is shown in screen of FIG. 22K.

If the request to join a company is denied by the employer, the employee is provided with the screen of FIG. 22Z with informational field 2260 indicating information about the company and that the request to join as a potential employee has been denied. Once a company has been created, the employer may edit the company profile as illustrated in screen of FIG. 22J by engaging an edit field 2231 then, the scrollable screen as illustrated in FIG. 22A as presented so that the employer may engage the various fields and subfields and then save or cancel out of the editing process through engagement with fields 2262. While an employee may engage the edit button and be presented with the screen of FIG. 22A and company profile, they will not have the ability to edit any of the information.

Once a company has been created the company and company profile can also be deleted from the inventive system. More specifically, when the edit field is engaged in the company profile and the screen of FIG. 22A is presented, field 2262 includes a selectable field for deleting the company profile. Upon engaging that field, the screen of FIG. 2266 is presented to the employer with the message field 2264 warning an employer that deleting the company could create some complications. Also, fields 2266 are presented to be selected for continuing with the deletion of the company or canceling the process. Deletion of the company will remove the company profile as well as remove the company profile from the employee's profile. Any employees that are affiliated with the company but still have separate provider profiles can work as an independent provider by setting up the themselves appropriately, such as with a bank account.

Just as an employer can delete the company, an employee can break from the company and also delete the company from their provider App and provider profile. For example, the company profile accessible through an employee's provider App is illustrated in FIG. 22Y and has an engageable edit field 2257. Upon engagement of that edit field, screen of FIG. 22CC is provided with a selectable field 2268 for deleting the company. Upon engaging the field, the screen of FIG. 22D is provided with informational fields 2270 indicating that deleting the company could create complications and also providing fields 2272 that may be engaged to delete the company as well as cancel the process.

In accordance with one aspect of the invention, upon an employee deleting their membership or relationship with the company, a notification is sent to an employer and so the screen of FIG. 22EE is presented through the provider App to the employer provider. The screen of FIG. 22EE includes fields 2274 regarding the employee that left and the field 2276 it may be engaged to contact that employee. If contact is desired, the screen of FIG. 22FF may be presented with a message field 2278 giving the employer the ability to call or text the employee or otherwise cancel the process.

An employer can also remove an employee from the company. As noted with respect to the screen of FIG. 22T, an employee list for a particular company may be reviewed as illustrated in FIG. 22GG. Therein, in addition to listing various fields with employees as shown, an edit field 2280 may be engaged for selecting and deleting multiple employees or the individual employee fields 2282 might be engaged. Upon such engagement, a slidable field 2284 is presented as illustrated in FIG. 22HH which is presented to the employer. Upon engaging the “remove” field, the screen of FIG. 2211 is presented to the employer with fields 2286 indicating the employee to be removed and asking the employer to confirm such removal. Then fields 2288 might be engaged to further remove employee or cancel the process. As noted, when an employee is removed they can still act as a provider to provide service, simply as an individual but apart from the company. A notification is provided to the employee through the provider app as illustrated in FIG. 22JJ. If they do not have a bank account, they will need one to continue as an individual and thus are presented with the field 2289 for adding a bank account to their provider profile.

If the added field 2280 is engaged in the employee list screen of FIG. 22GG, an altered list is presented to the employer as shown in the screen of FIG. 22KK wherein fields 2290 are presented for selecting one or more employees. If one or more of the employees is selected, a field 2292 is presented to be engaged for removing the selected employees. Upon doing so, the employer is presented through the provider App with the screen of FIG. 22LL with fields 2294 asking them to confirm that the employees are to be removed and also giving information regarding employees. Furthermore, fields 2296 are presented for completing the removal or canceling the process. As noted, each of the employees might be also notified with a screen similar to that shown in FIG. 22JJ to determine if they want to proceed as individual providers apart from the company.

### Properties

In accordance with another feature of the invention, to facilitate interaction between a service provider and a consumer, a consumer running the consumer App might be a property manager that manages a number of properties for which service might be requested, that is, a “managed property”. The property might be affiliated with a number of residents who can request service jobs. In one embodiment as disclosed herein, job requests will need to be approved by the property manager before proceeding. In another embodiment, the property manager (PM) might allow residents to order jobs without requiring approval. Furthermore, a property manager might request a job for a resident who is not a consumer within the inventive system and is not operating a device running a consumer App. Furthermore, the property can be set up as a managed property in order to be able to engage various service providers and to have them join a network associated with the property so that they may have priority in a search protocol as disclosed herein. The flow of the program is disclosed herein in the FIG. 5H.

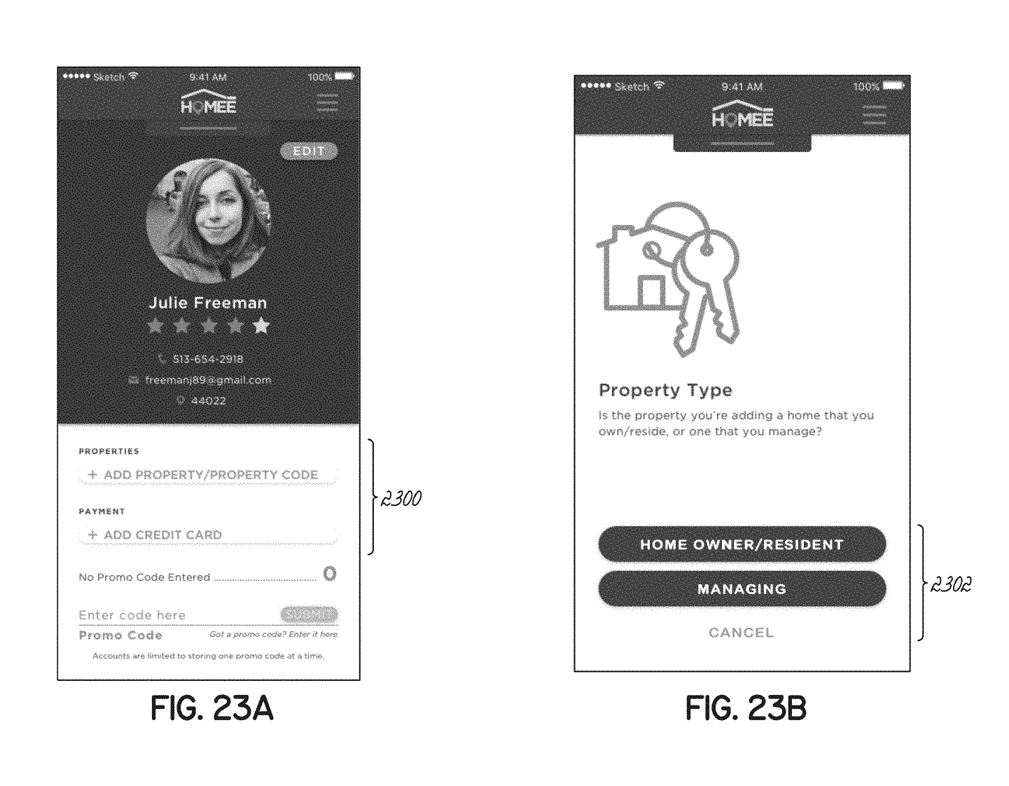

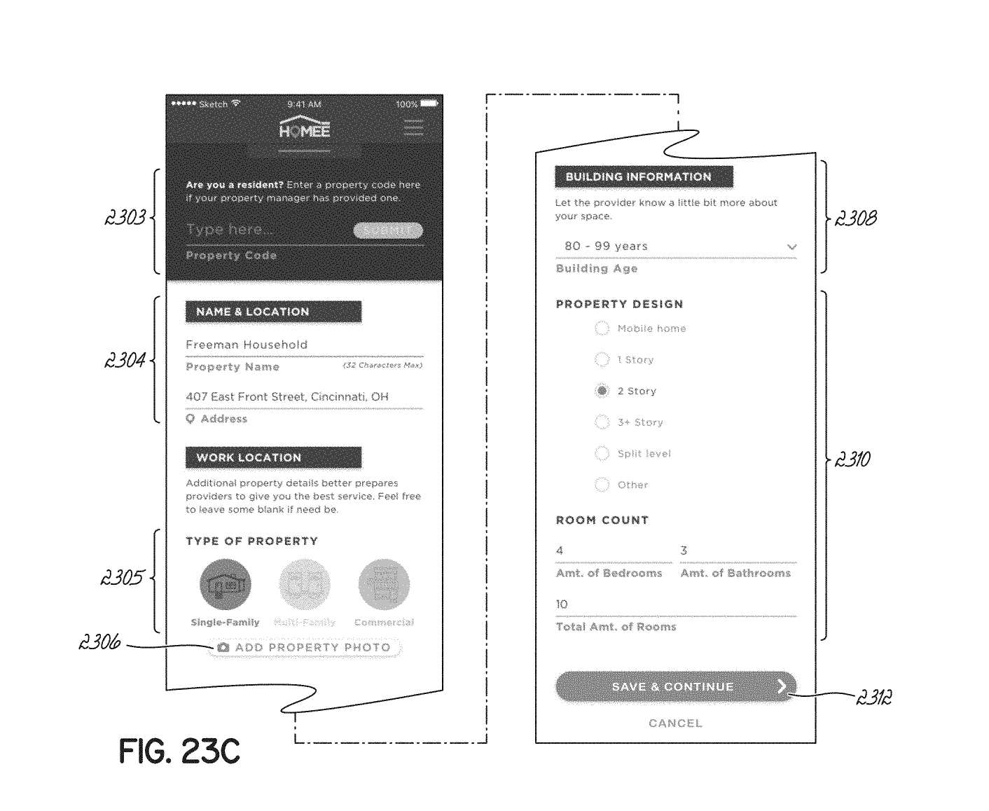

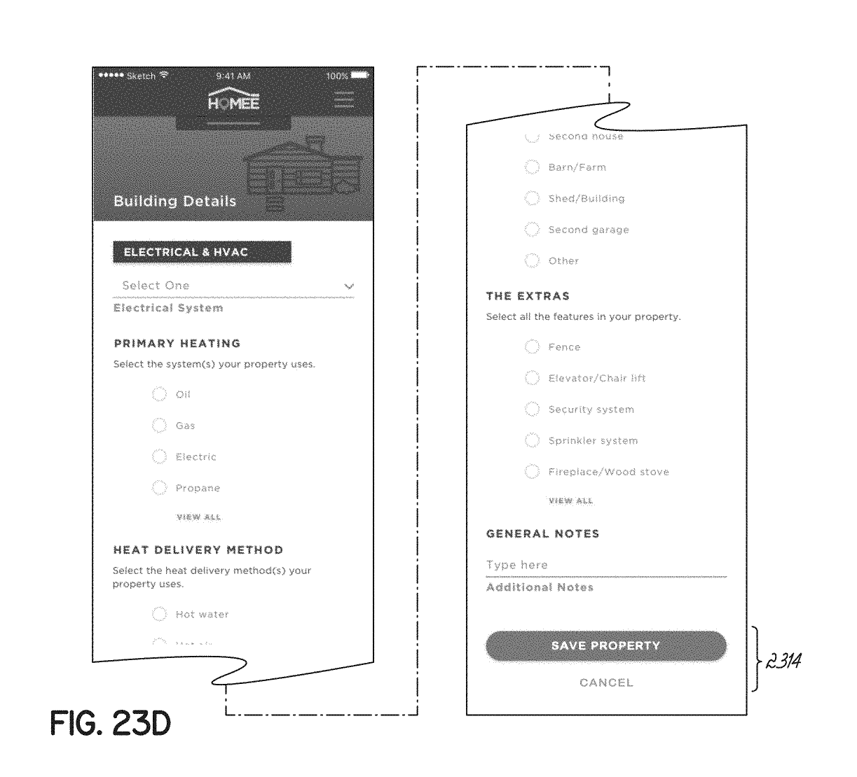

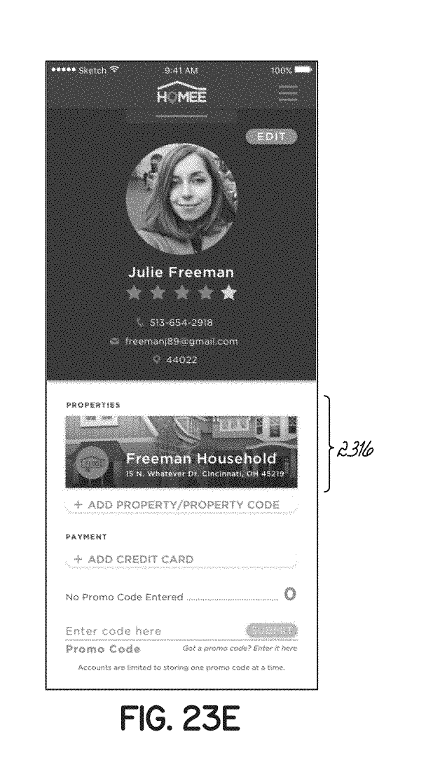

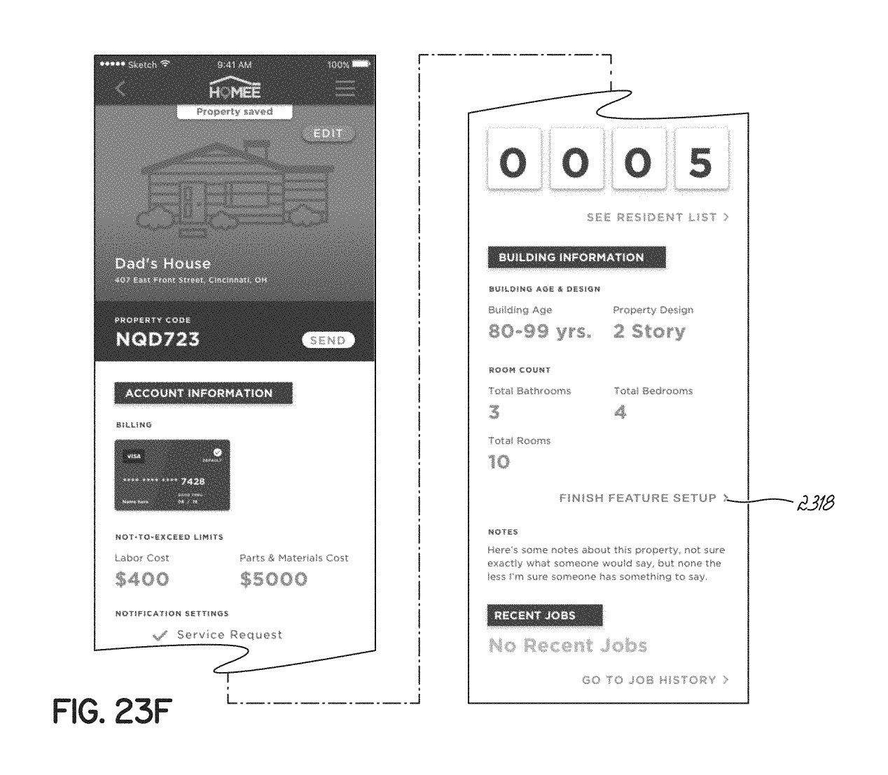

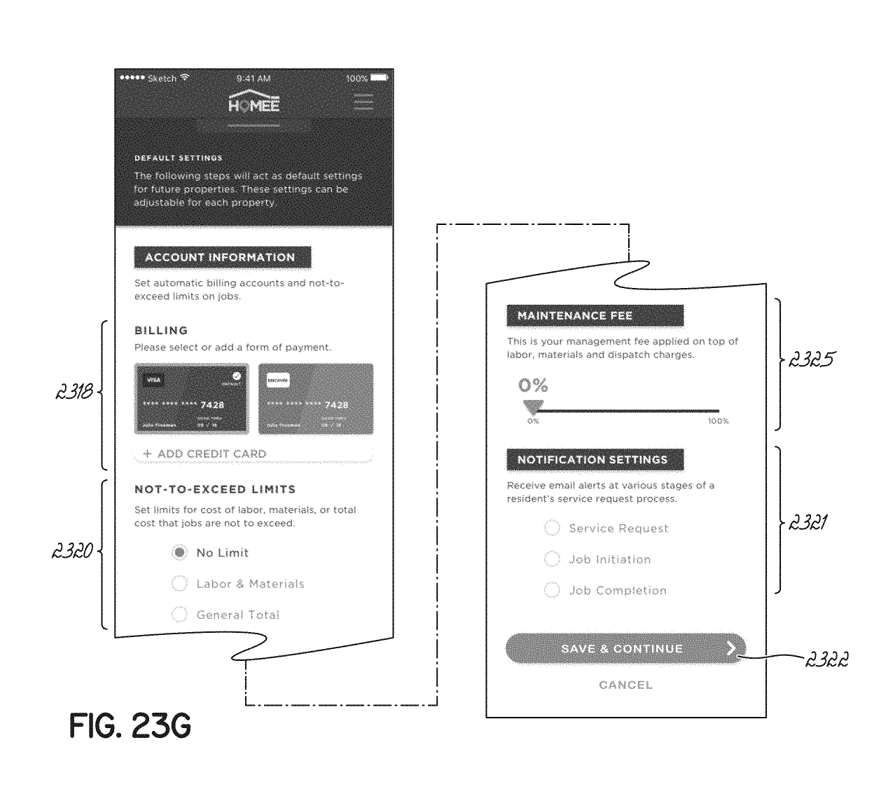

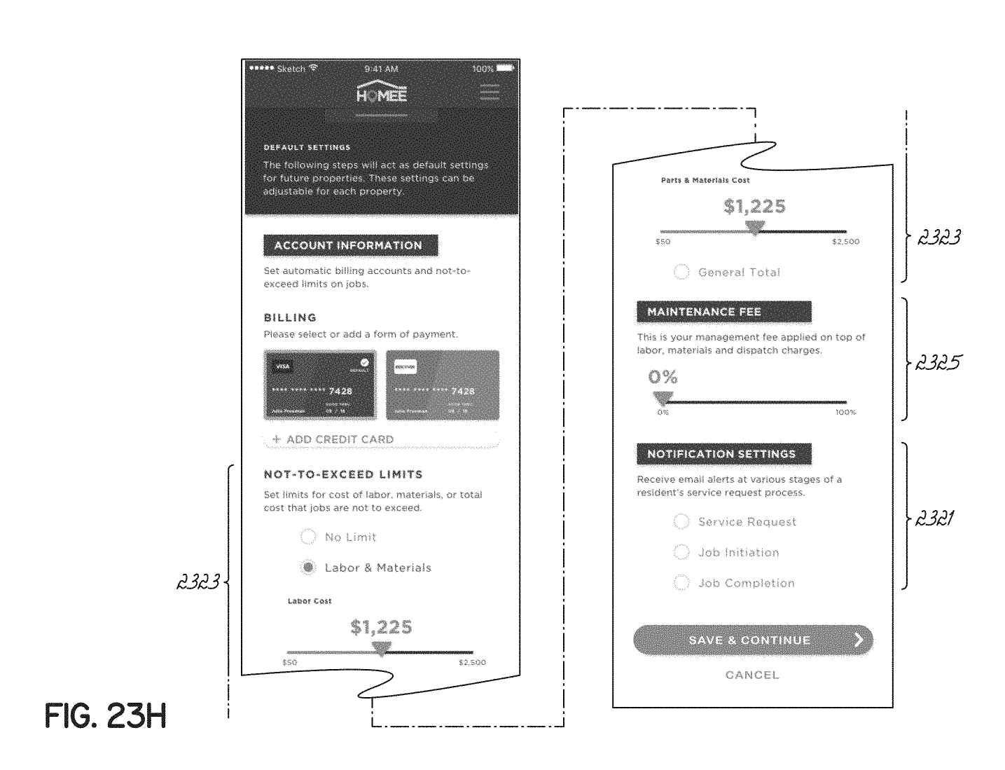

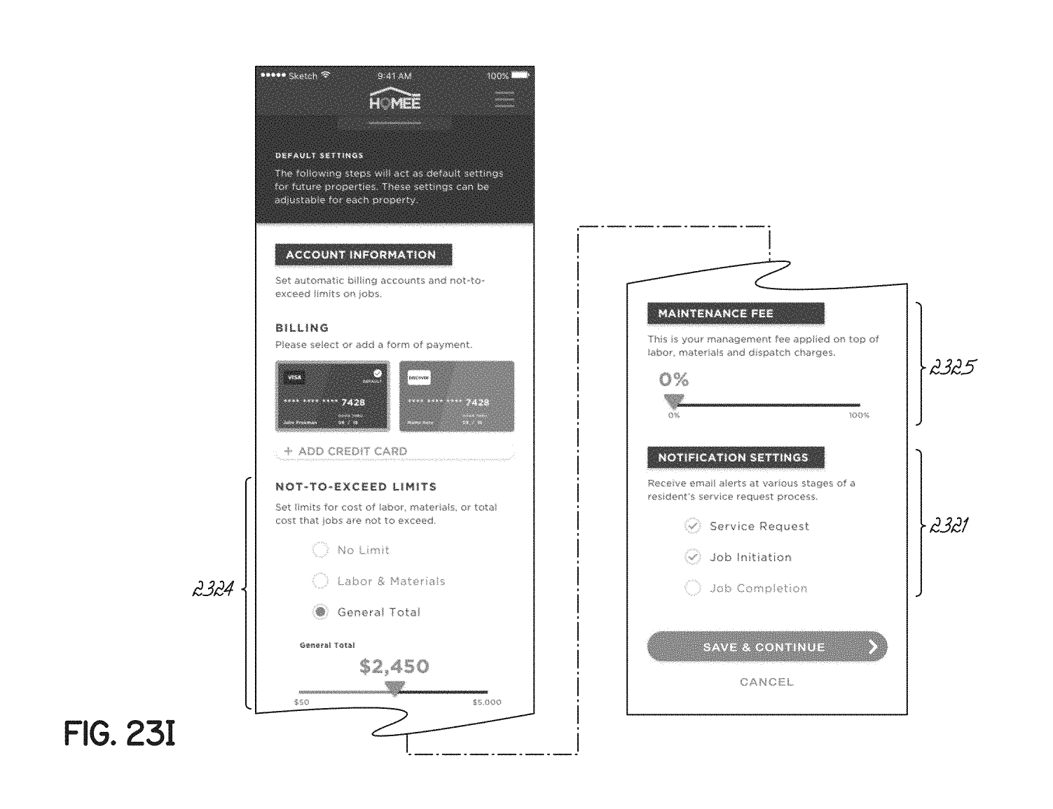

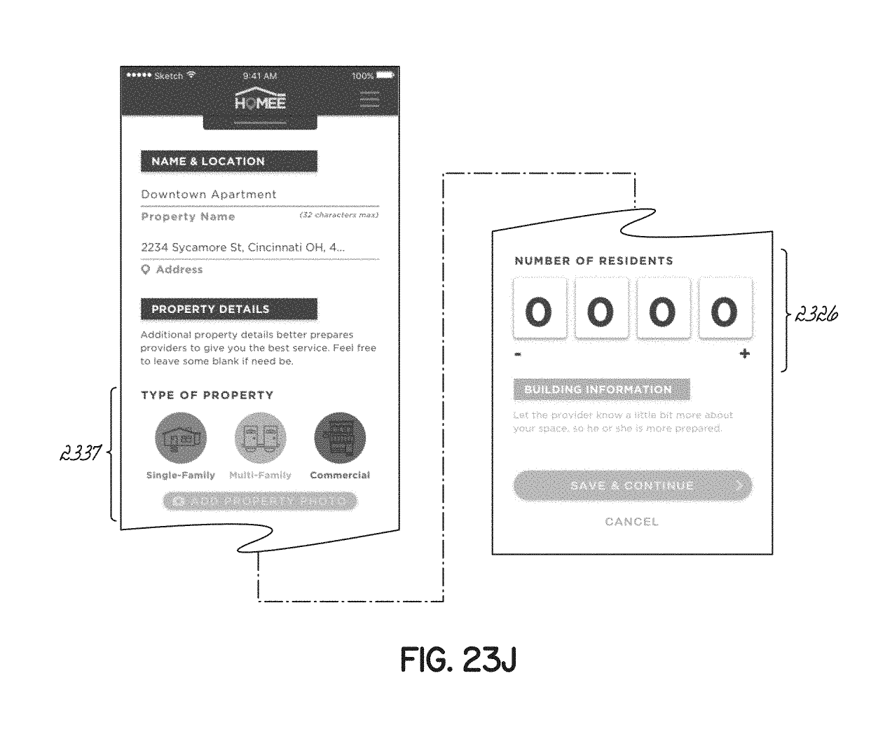

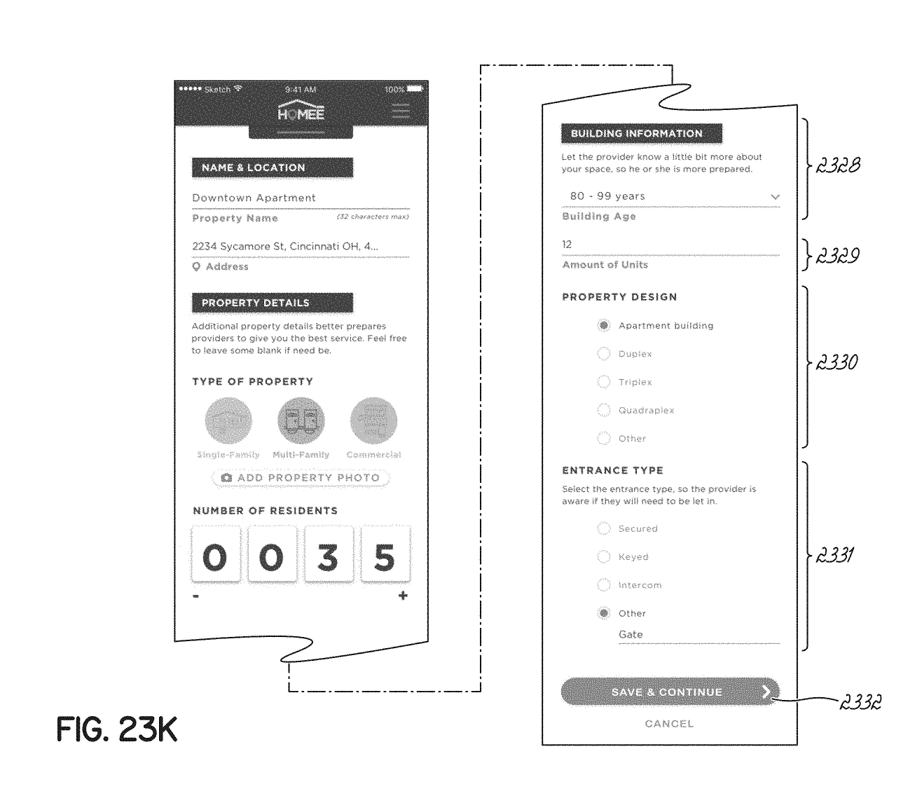

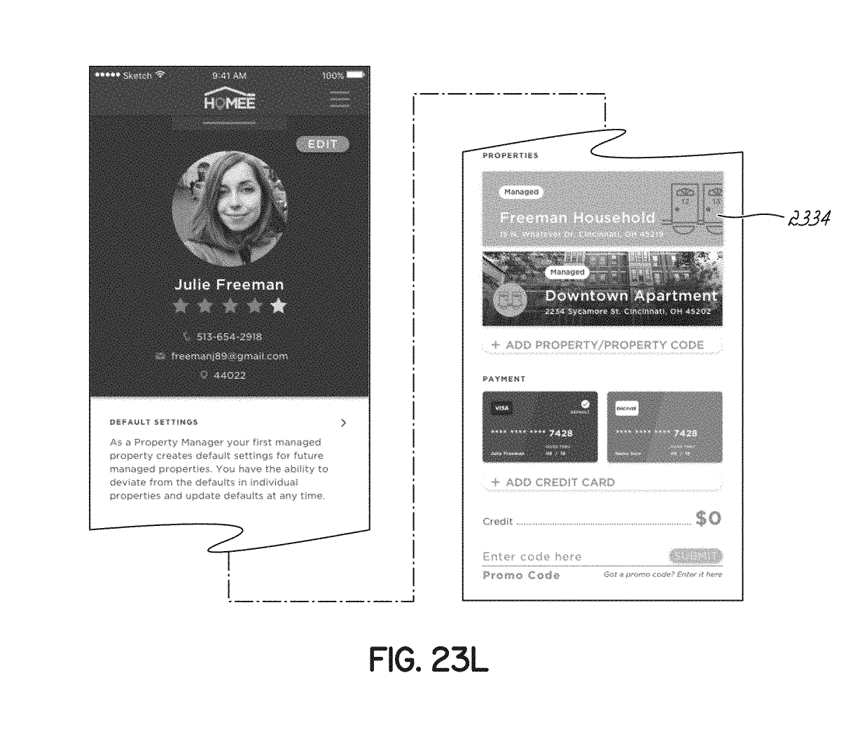

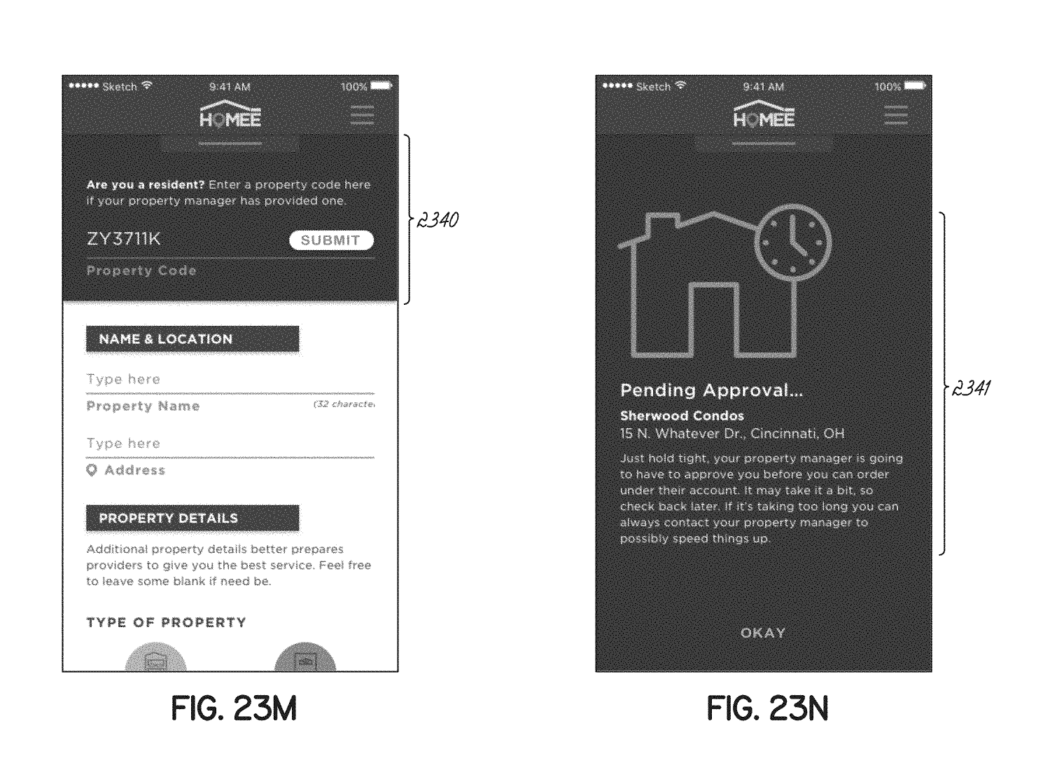

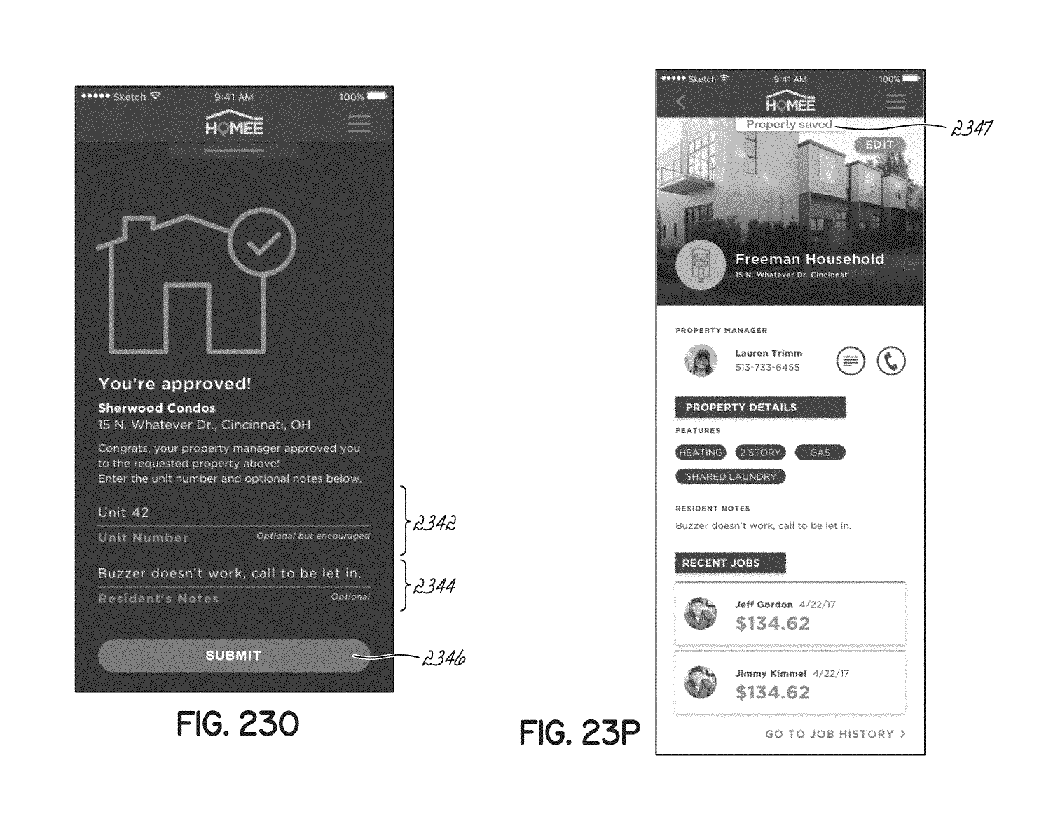

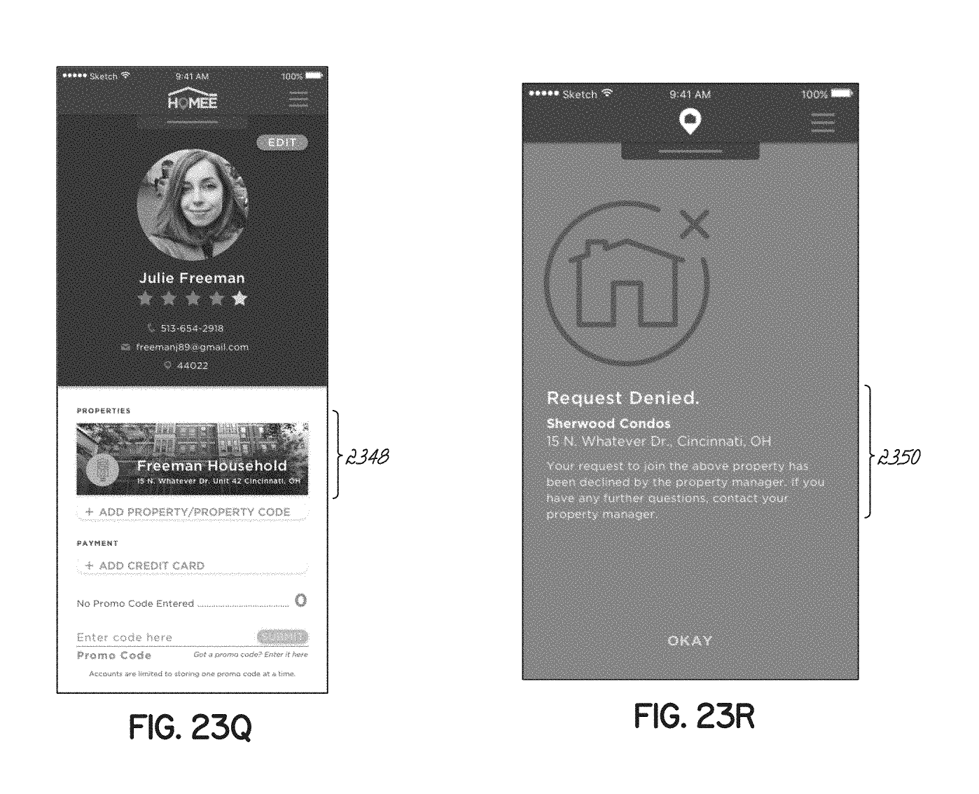

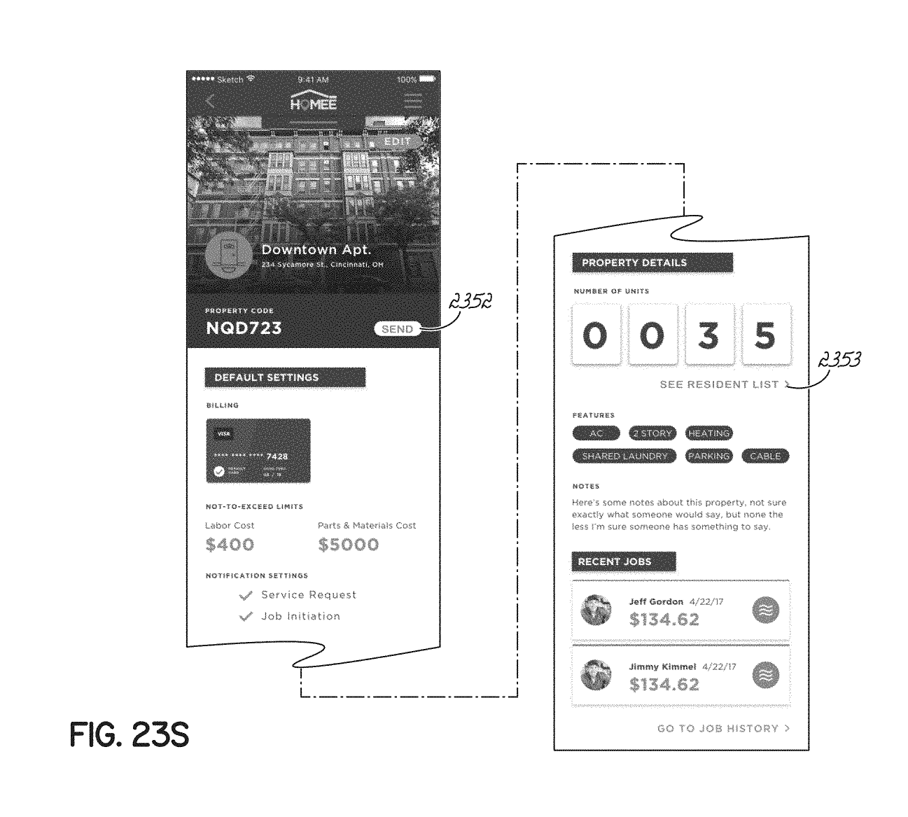

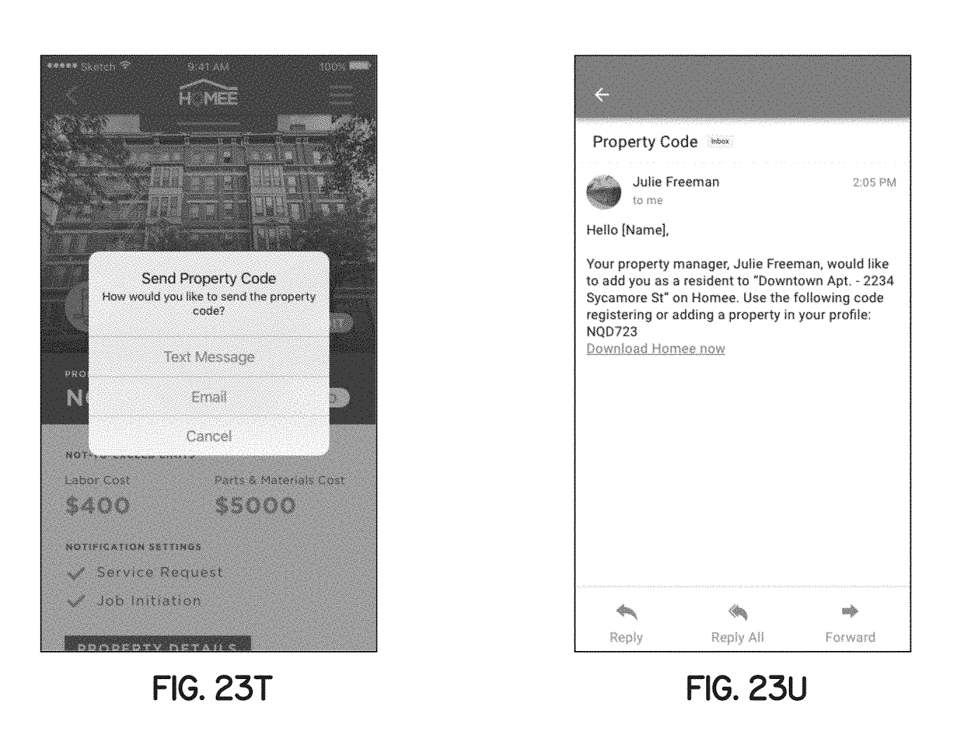

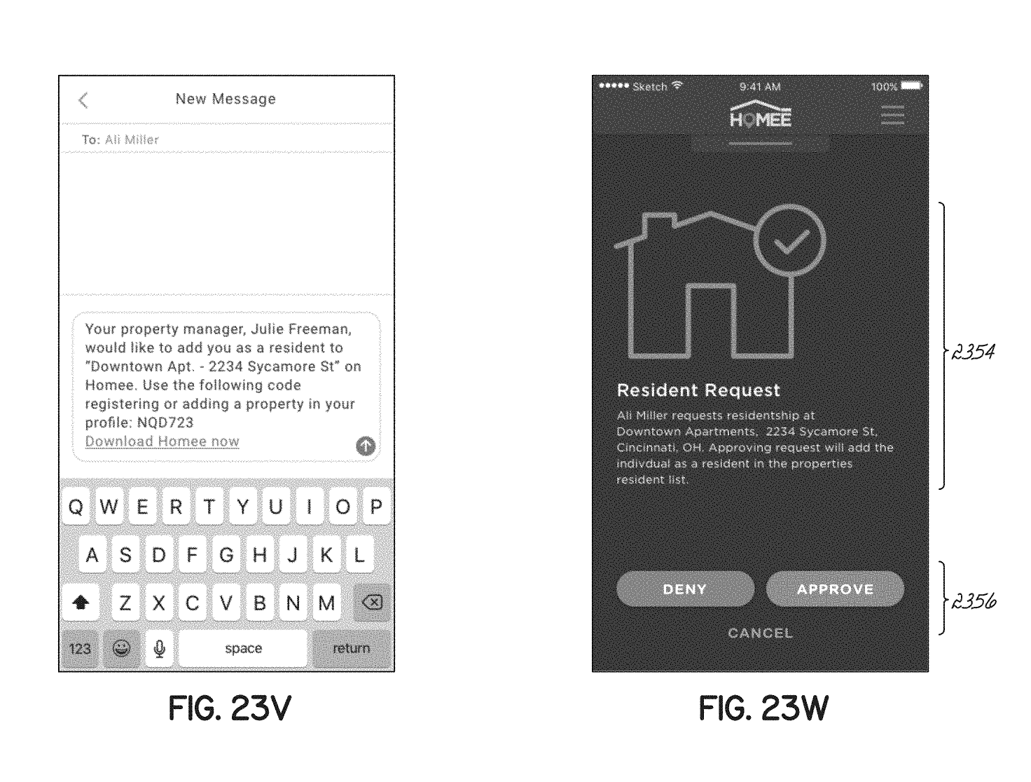

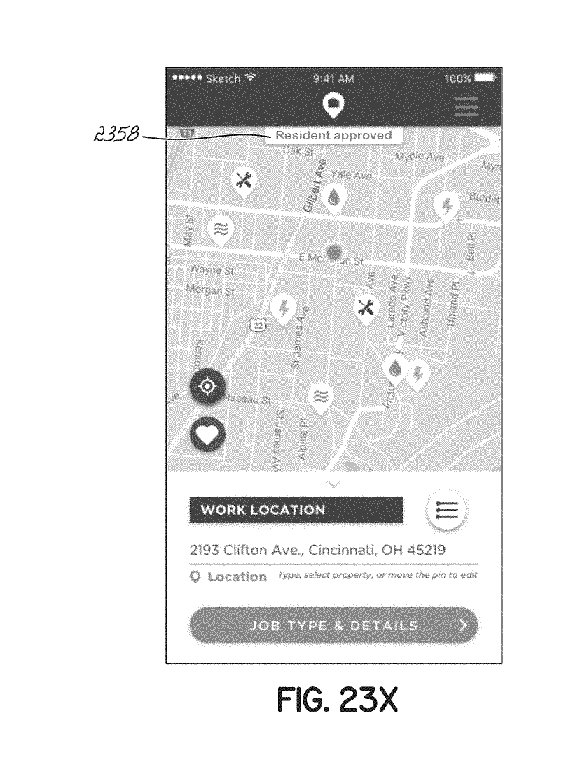

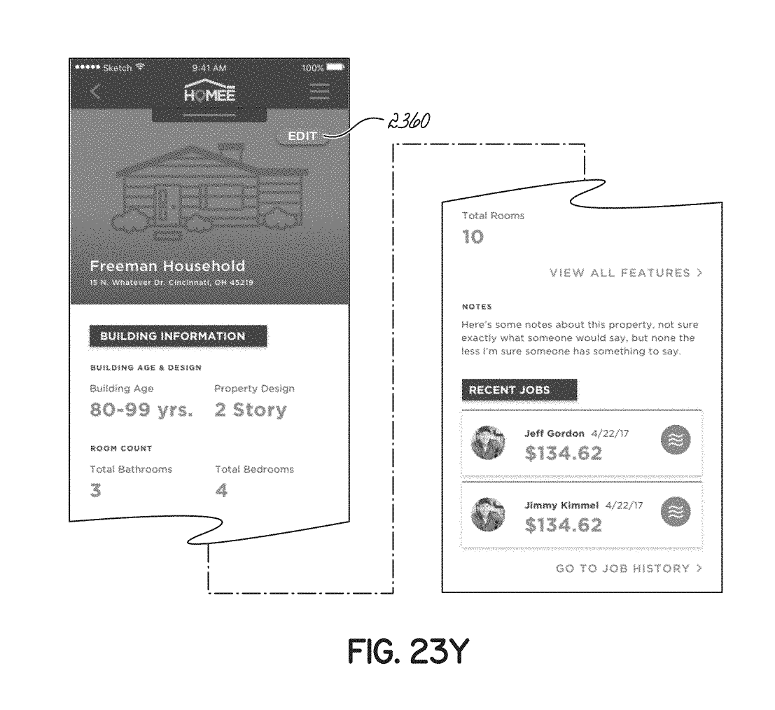

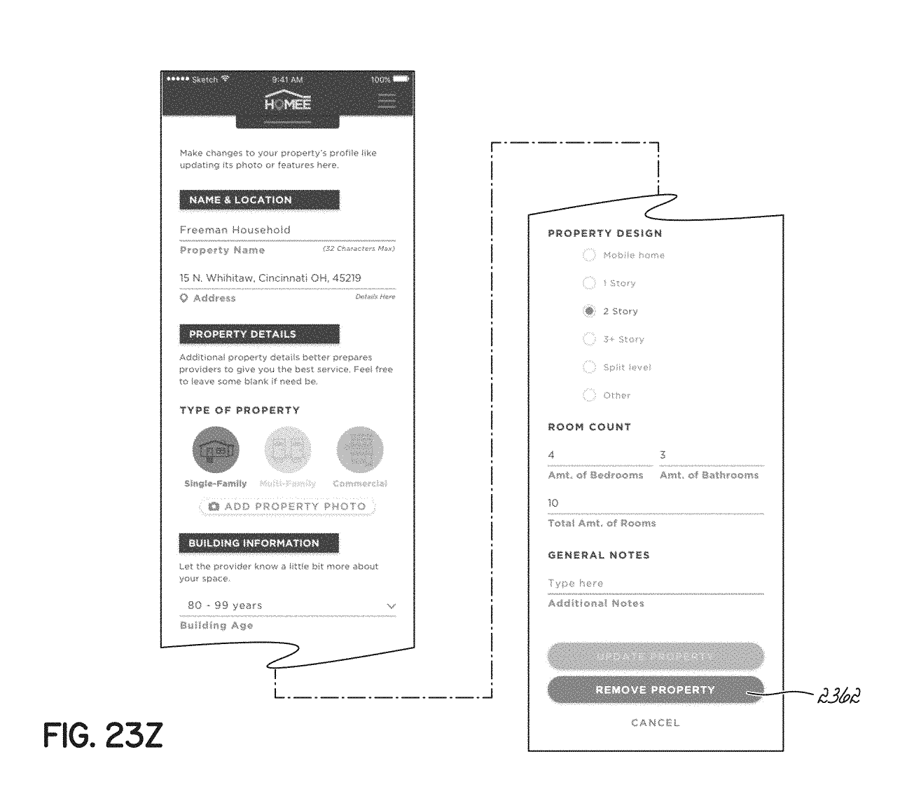

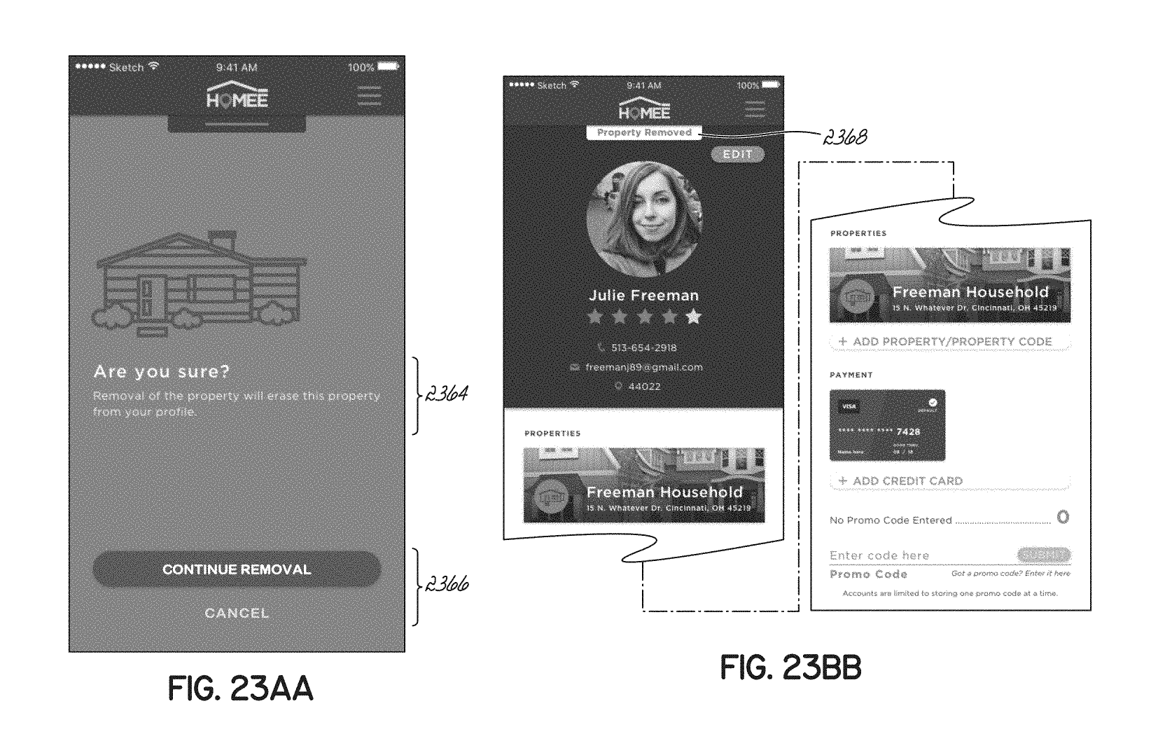

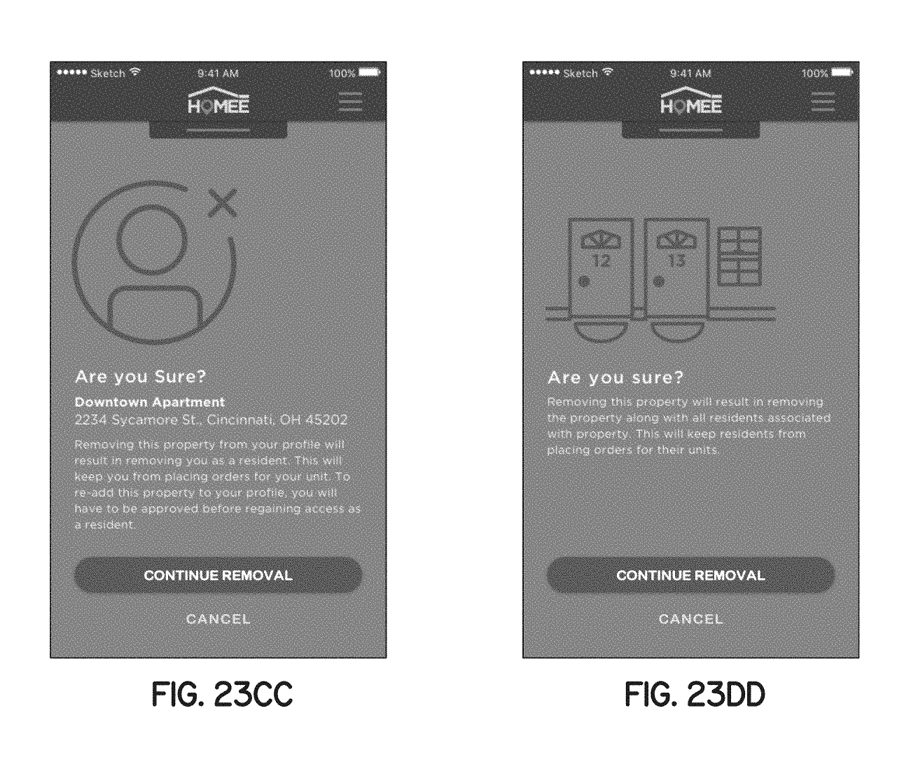

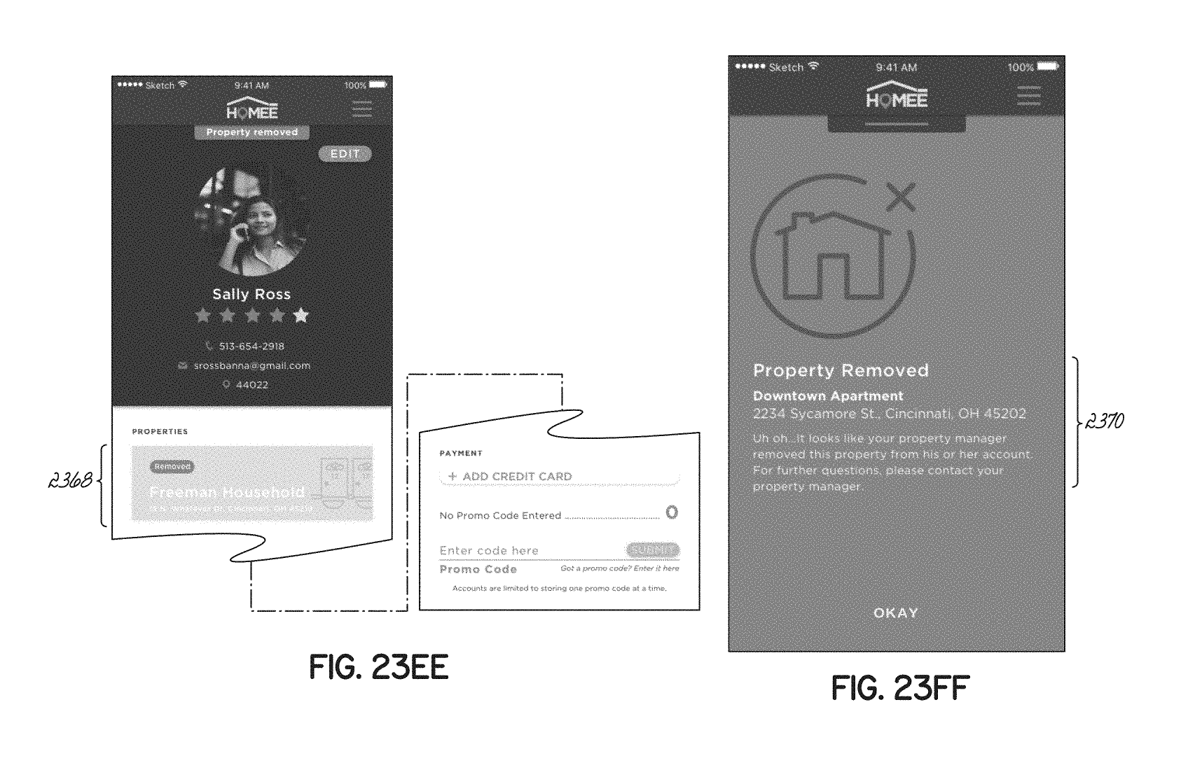

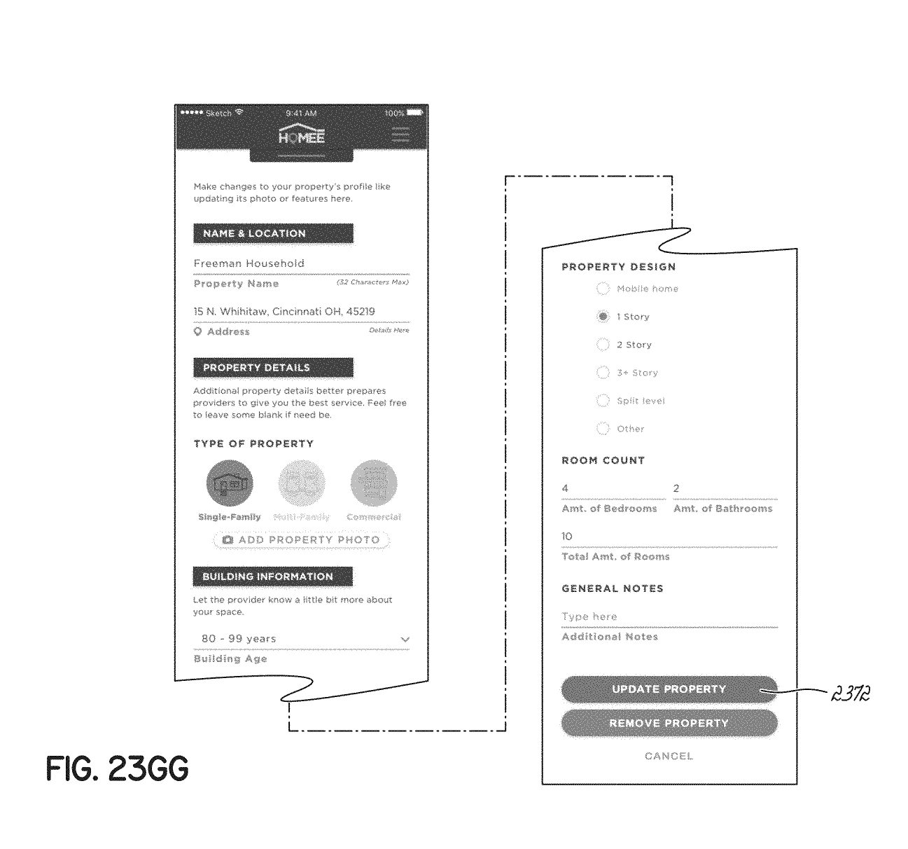

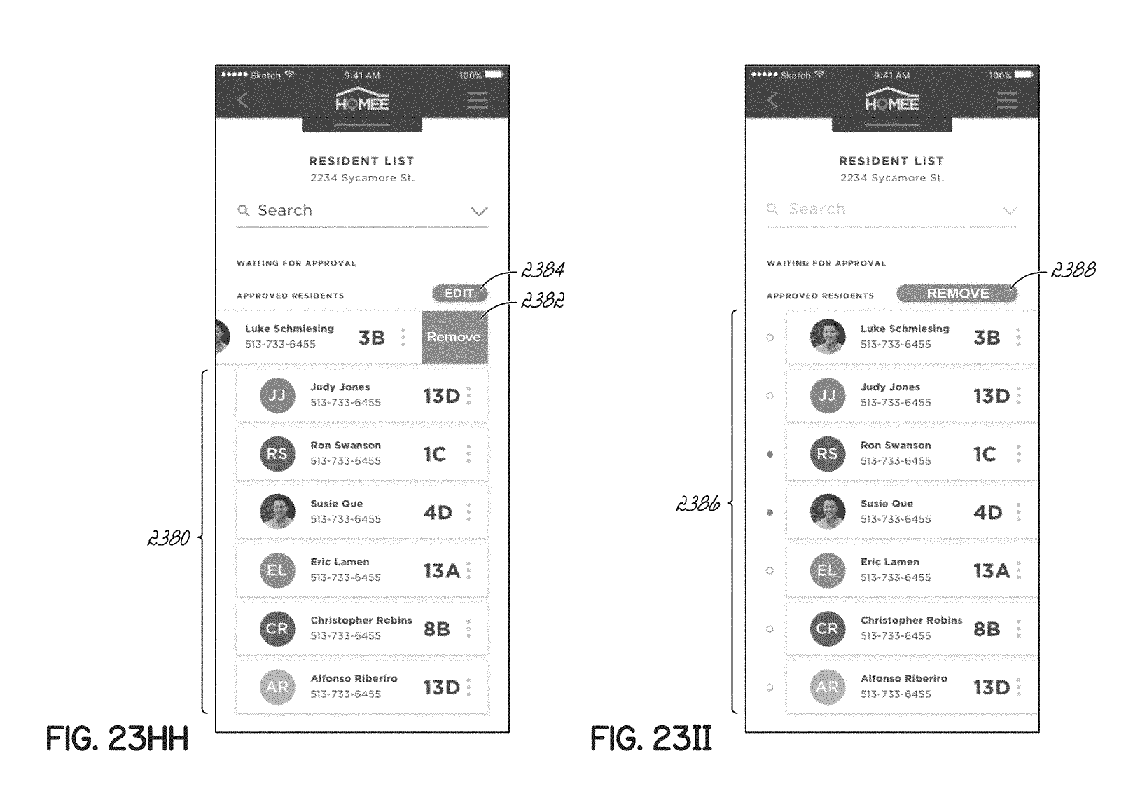

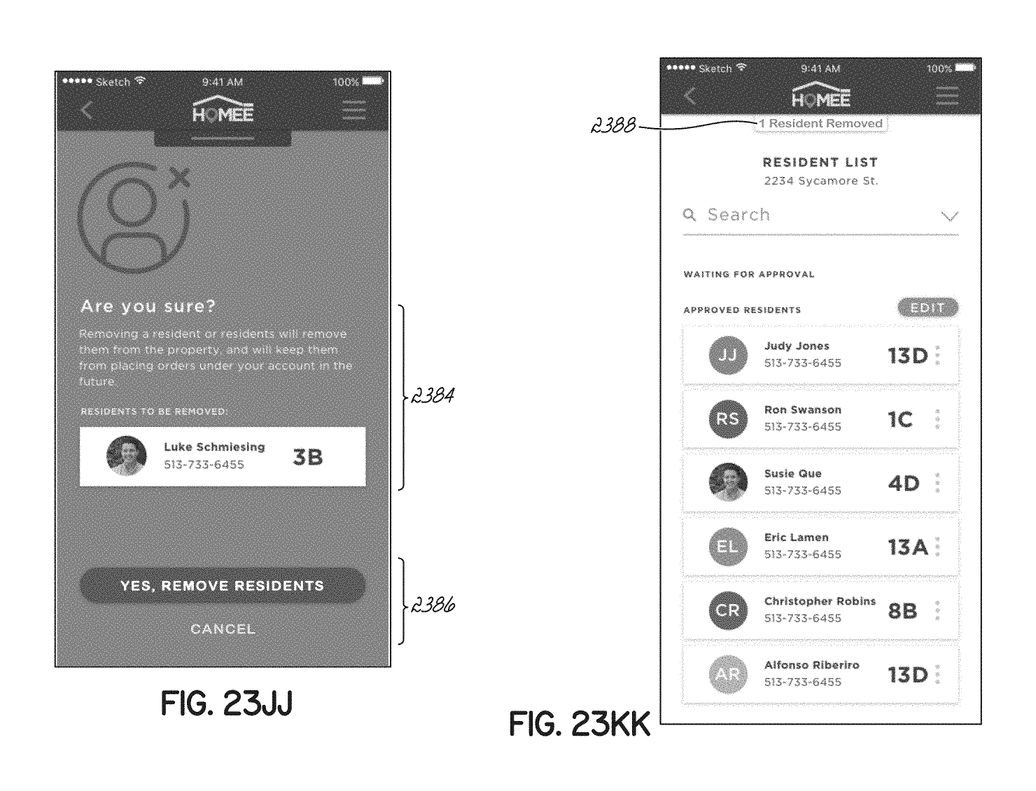

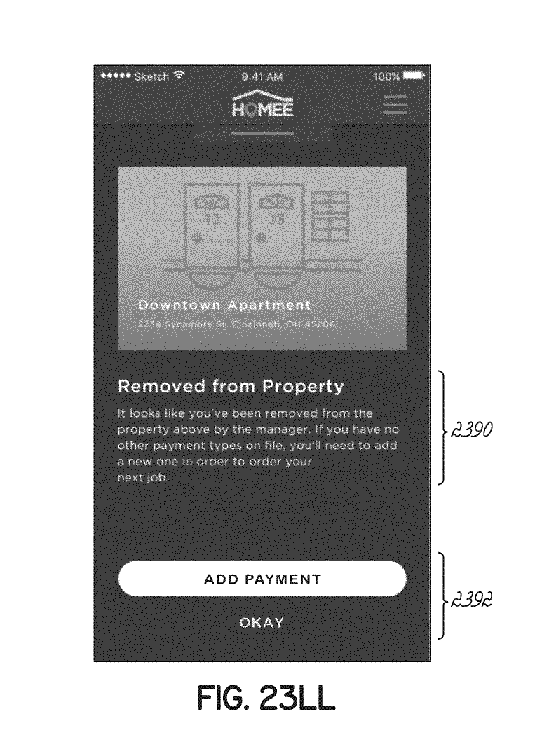

An individual home owner may create a property profile for their home. For example, the consumer profile screen may be accessed through a main menu providing a screen of FIG. 23A to the consumer/homeowner which includes a field 2300 for adding a property to the consumer's profile. Engaging field 2300, the screen of FIG. 23B is presented that includes selectable fields for creating a property profile within the consumer profile. The fields 2302 provide the ability to add a property as the homeowner or resident of the property or to add the property as being a managed property by a property manager as disclosed herein. The process can be canceled as well through fields 2302.

Engaging the homeowner/resident field 2302, the screen of FIG. 23C is presented to the consumer for adding information regarding the property. For example, screen of FIG. 23C includes fields 2304 for entering a property name and address, fields 2305 for indicating the type of property such as a single-family, multifamily, commercial, or etc. Field 2306 may be engaged to add one or more photos of the property. Fields 2308 may be engaged for adding information regarding the age of the building. Fields 2310 might be engaged for adding property design information, as well as the amount of rooms such as bedrooms, bathrooms, and total rooms in the property. Engaging the photo field 2306 will allow one or more photos to be selected from a gallery on the consumer device or to be selected for pictures that are taken. Field 2312 may then be engaged for saving that information and continuing the process. Certain amounts of information, such as those shown in FIG. 23C may be a minimal amount of information that must be added to the property profile to be saved. Once field 2312 is engaged, an additional scrollable screen, as illustrated in FIG. 23D, may be presented for creating additional information, such as information regarding, for example, the electrical system, primary heating, heat delivery method, the cooling system, cooking fuel system, water system, hot water system, sewer system, foundation, groove shape, roof material, exterior material, basement, attic type, flooring, garage, parking, porch/deck, pool, other structures, any extras in the house that might be of relevance, and any general notes. Such information can be filled in as desired by the consumer. Once a consumer is finished entering any information they desire, they can scroll to the end of the screen to be presented with field 2314 for saving the property.

Once complete, the property card field is added to the consumer's profile as illustrated in the screen of FIG. 23E. Engaging to 2316 will provide the screen of the property profile an example of which is illustrated in the screen of FIG. 23F. the property profile also has a selectable field 2318 that the consumer may engage for adding any additional details about the property that was skipped in the original setup.

Referring to FIG. 23B, when the field 2302 for a managed property is selected, the screen of FIG. 23G may be presented for collecting required fields such as billing information fields 2318 and any limit fields 2320. As discussed, limits may be set associated with the property that will then be implemented within the job flow as disclosed herein. Also, a management maintenance fee might be added for the cost of the job on top of labor, materials, and dispatch charges. Through an engageable field such as a slider field 2325, a certain percentage of the job may be assessed as a maintenance fee for the PM. Furthermore, notification settings for a property manager to receive email alerts at various junctures of a service request process initiated by a resident of the managed property might be selected through fields 2321. After a certain number of required fields, such as billing fields and limit fields 2318, 2320 are selected, field 2322 might be engaged to save that information to continue the process. Various other fields that may or may not be required and the invention is not limited to what fields might be required before a property may be set up.

Referring to the screen of FIGS. 23G and 23H, depending upon what fields 2320 are selected for job limits, different fields, such as slider fields may pop up in the screens of FIGS. 23G and 23H. For example, a default might be to have no limit associated with the job request. Alternatively, if labor and materials are selected as a limit is shown in field 2323 of FIG. 23G, appropriate slider fields might appear for setting labor costs as well as parts and material costs for the limits. Similarly, as illustrated in FIG. 23H, if a general total limit is selected, one or more fields 2324, such as slider fields might be presented for selecting a general total limit. Once the account information is saved through engagement with field 2322, additional property information may be added for the property profile. For example, the screen of FIG. 23I might be presented to the property manager through the consumer app to gather information as noted herein. For example, in addition to some of the similar information as would be associated with an individual home, a managed property might have a field 2326 for adding the number of residents in the manage property. Furthermore, certain of the information, such as the name, address and the type of property might be required before the information might be saved. Once the type of property is selected through the appropriate field, the screen such as that illustrated in FIG. 23J is presented for entering building information. The building information fields for entering the information might be different depending upon the type of property that is selected. For example, single family might have different fields than a multifamily, which might have still different fields from commercial property. Although various of the fields might overlap as those properties may share some common information or information fields. For example, referring the to the screen of FIG. 23J, the building information may also include some mandatory required fields, such as field 2328 for entering the age of the building, field 2329 for entering the number of units in the building, field 2334 for entering the property design, and field 2331 for entering the entrance type. After one or more required fields and the necessary information is entered, field 2332 might be engaged to save that information and continue the process. As disclosed herein, an additional scrollable screen such as that illustrated in FIG. 23D might be presented which will allow the entry of other information to be saved for the property profile. Once the information is saved for the property that property will be presented in the property manager profile as illustrated screen of FIG. 23L. As noted in the card field 2334 a managed property will be indicated as managed.

In accordance with another aspect of the invention, a resident as a consumer running a consumer App can link or join with a managed property so that they might be able to order jobs for that managed property which would then need to be approved by the property manager as disclosed herein. To that end, referring to the screen of FIG. 23A, a consumer may seek to add a property to their profile through engagement of field 2300. Then, when presented with the screen of FIG. 23B, it would choose a field 2302 indicating that they are a resident. At that point, a screen similar to FIG. 23C is presented. Referring to the screen of FIG. 23M a portion of that screen is illustrated wherein fields 2340 are presented for a consumer that is a resident to enter the code they have been given by property manager to effectively add the property to their profile as a resident. As illustrated, the new code may be entered and then submitted through field 2340. Once submitted, the resident will have to wait until they are approved by the property manager to join the property. Accordingly, once the property code has been transmitted by a resident, they are presented with a screen of FIG. 23N with fields 2341 indicating that approval is pending. Once approved, they are presented with the screen of FIG. 23O were they are presented with fields to enter information about where they live, such as the unit number the building through field 2342 and any notes regarding the property to field 2344. Once that information is entered, they can engage field 2346 and submit the information. They are then linked by the system to the property. They are then brought to the property profile as illustrated and screen of FIG. 23P with a message field 2347 that indicates the property has been saved for their consumer profile. The screen of FIG. 23Q indicates the consumer profile for the resident with the property joined noted in field 2348.

A resident joining a property may also be declined for some reason by a property manager. In such a scenario, the screen of FIG. 23R is presented to the resident with an informational field 2350 indicating the denial of the request.

As noted, the property manager must facilitate the addition of the resident to a particular property. To that end, a property manager can initiate adding a resident to a property. When a property manager pulls up the property profile for the managed property, as illustrated in the screen of FIG. 23R, fields 2352 show the property code for the property and present an engageable field for sending that code to a resident. When the send field 2352 is engaged, the screens as illustrated in FIGS. 23S, 23T, and 23U provide the property manager with the ability to send a text or email message that is prefilled as illustrated. As disclosed herein, once the resident receives the code, they can send it back with the request to join the property. The property manager is then presented with the screen of FIG. 23W with an informational field 2354 indicating a resident request (returned code) and engageable fields 2356 for approving or denying a resident request. If the request is approved, the screen of FIG. 23X is presented to the PM with an appropriate field 2358 indicating that the resident has been approved. If the request is denied, field 2358 will indicate that the resident has been declined.

Just as a homeowner can add a property to their consumer profile, they can delete the property as well. To do so, referring to the screen of FIG. 23E, the consumer can engage field 2316 to select the property. Screen of FIG. 23Y provides a field 2360 to be engaged for editing the property profile. When engaged, screen of FIG. 23Z is presented with information about the property and also providing a field 2362 that may be engaged to remove the property. Upon removing the property, the screen of FIG. 23AA asks the consumer to confirm through field 2364 and provides fields 2366 for continuing the removal process or canceling it. Once the property is removed, the customers profile as illustrated in the screen of FIG. 2366 provides field 2368 confirming the removal and the property card field associated with that property is no longer visible in the consumer's profile screen. Similarly, a resident or property manager may delete a property profile from their consumer profile. However, different screen such as illustrated in FIGS. 23CC and 23DD are presented depending upon the message presented in field 2364.

In accordance with one aspect of the invention, since one or more residents may be linked to a managed property, if a property manager removes the property from their profile, the listed resident will be presented with the screen of FIG. 23EE wherein the property field 2368 within their consumer profile will note that the property has been removed. Engaging that property will then present the resident with the screen of FIG. 23FF with information provided in field 2370 regarding the removal of the property. Once the screen of FIG. 23FF is viewed, the field 2368 is actually removed from the resident's consumer profile.

In accordance with another aspect of the invention, each of various consumers can also edit a property profile. For example, as illustrated in the screen of FIG. 23X, upon engaging the edit field 2360 the editable fields of FIG. 23Y may be presented. If one or more fields are edited, field 2372 as shown in the screen of FIG. 23GG may be engaged for updating the property. Generally, an individual homeowner consumer or a property manager consumer will be able to edit all of the fields in the property profile. However, a resident, will only have selectable fields that are editable. Such as their unit number, or any notes they have put within the property details of the profile.

The property managers also have the ability to remove a residence once they have been added to the property. That is, the property remains, but a resident is removed. For example, referring to the screen of FIG. 23R during display of a property profile for a property manager, selectable field 2353 can be engaged to see a resident list. Upon engagement, the screen of FIG. 23HH is presented showing fields 2380 of the various residents. By swiping one of the resident fields to one side, the “remove” field might be presented. For removing multiple residents, the resident field can be engaged which will provide a field 2382 for removing that resident. If multiple residents are to be removed, the edit field 2384 might be engaged which will present the screen of FIG. 2311 with selectable fields 2386 for selecting multiple residence. Once selected, field 2388 may be engaged to remove all those selected residents. The system removes the link between the property and resident. Upon removal, a confirmation screen of FIG. 23JJ is presented with fields 2384 with information regarding the removed resident and fields 2386 that may be engaged for completing the removal process or canceling it. Upon removal, the resident list screen of FIG. 23KK is presented with a message field 2388 about one or more removed residents. The resident is also informed of their removal. As illustrated in the screen of FIG. 23LL, a resident consumer will receive a message 2390 that they have been removed from the property. Also, since their payment method may have been through the property manager as a resident, if they want to continue to be a consumer within the inventive system and to order jobs, they are given the opportunity to engage field 2392 and add a payment, or just dismiss the screen of FIG. 23LL.

In accordance with another feature of the invention, a property manager may add a number of different properties that are to be managed. For example, such managed properties may include commercial properties, multifamily properties, or single-family properties that are also managed. Referring to the screen of FIG. 23I the type of property might be selected to field 2337. When any property, certain basic information may be required as disclosed herein. However, additional building information may also be added, and the property manager is given the ability to do through engagement with a field that then provides a scrollable screen wherein different building information may be added.

For example, referring to the screen of FIG. 24A, the property profile is shown with basic information regarding the property in field 2400 may be selected for adding additional information. Through a scrollable screen, different sections of the building information may be engaged and may be presented with different headers reflective of a particular set or subset of building information. For example, this screen of FIG. 24B may indicate various fields that are selectable for an electrical and HVAC system of the property. Similarly, screen sections as illustrated in FIGS. 24C, 24D, 24E and 24F may be presented for getting information into pertinent fields associated with plumbing and water, exterior features, interior features, and bells and whistles, for example. As may be appreciated, the various different fields may be presented for selection and for data entry as would be understood by a person of ordinary skill in the art. Furthermore, in accordance with another aspect the invention, depending upon the type of property, the various different screens and fields may be different. Then, once all of the information's been added suitable field, such as field 2314 as illustrated in screen of FIG. 23D may be selected for saving all the property information for that property. As noted herein, once the property profile is then created, the information can also be edited by engaging selectable edit fields within the property profile and then adding or changing information.

In accordance with one aspect the invention, the property profile view presented to different parties will change. For example, a service provider may see information associated with the building and other property details, but they will not see financial details, such as billing information and limit information that would be available to the property manager. The entity that sets up the property as a managed property will be considered the property manager.

As will be appreciated, the informational fields may be presented with various drop-down menus, selectable fields, fillable fields and expandable and collapsible fields as necessary for facilitating the entry of the information by a consumer. As such, the present invention is not limited to the layout of how such information is captured.

In accordance with one aspect the invention, when a resident is associated with the property and seeks to make a job request, in order to get to an active job, the property manager must approve the residents request. As disclosed herein, the system of invention presents an engagement between the resident and property manager and service provider for providing that approval.

In accordance with another feature of the invention, the property manager may allow one or more residents to order a service job without getting approval. To that end, when the PM is setting up a managed property, they can designate their approval protocol and the consumer App will facilitate that protocol within the resident job ordering scenario. For example, referring to FIG. 25, a portion of the managed property profile as illustrated providing field 2500 with selectable subfields to indicate the property manager's preference with respect to a resident ordering a job. Specifically, they can require approval or allow residents to proceed without approval depending upon the selection in fields 2500. In one embodiment, requiring approval will be a default protocol. The property manager would then have to select otherwise within field 2500 so that the consumer App of the property manager and resident will facilitate the selected protocol. Any resident under the property with the noted setting will have that specific approval setting applied to the job requests.

### Organizations

As various providers can be organized under a company profile and structure, in accordance with another aspect of the invention, various consumers can be organized under an organization structure as members. Specifically, just as a company may be set up, an organization can be set up with consumers joining as members.

In accordance with one feature, one consumer will be set up as the administrator member of the organization. The administrator member role will control the creation and modification of shared resources associated with the organization, as well as determining which users can access those resources. The administrator member will also have access to all jobs of the members in a job screen or dashboard. That is, the administrator is linked to jobs that were ordered by other members of the organization or by residents of properties that are managed by a member of the organization, such as a property manager. Other consumer members that are not the administrator can access shared resources of the organization. Accordingly, the organization will allow a group of users or consumers to access certain common or shared resources of the organization. In one embodiment of the invention, members might be able to join the organization through interfacing with the administrator, similar to the way in which various providers might join a company as disclosed herein.

In accordance with one feature of the invention, the organization will contain or provide access to shared resources, such as shared credit cards, shared networks, and invoicing features that may be accessed by members of the organization. The shared resources might be owned by the organization and then any member can use those resources.

With respect to a shared credit card, an organization administrator member may be able to save one or more credit cards that will be associated with the organization. In that way, the share credit cards are available for use by organization members. While such use is provided to members, only administrators may update shared credit card information, add additional cards, or delete certain credit cards. Such a shared account might provide a number of property managers, for example, access to the same account under the umbrella of one organization.

In accordance with another feature of the invention, an organization may own one or more shared networks. As noted herein, various networks, such as an in-house network, a preferred network, or an open network, might be created by a consumer that is a property manager. Other property managers that are somehow affiliated with that property manager that set up the network might want to also share in those networks. For example, an organization that covers multiple property managers might have an administrator to set up one or more networks to be accessed by the property managers. In accordance with the network features of the invention, each provider or service company of providers are considered part of an open network. However, with an organization, the organization administrator member may search for existing companies within that open network and add them to other networks such as an in-house network or preferred network for the organization. The organization administrator would have to request permission from the provider or service company owner to add them to a specific organization network.

An organization administrator will also be able to define which services that each company within the organization's network would provide. Any addition of new services for a company within the organization's network would require permission from the company owner for that service to be added. For the removal of a company from an organization's network, such removal may be initiated by either the company owner or the organization administrator. The other party would then be notified by a suitable notification message that the removal has occurred. With a shared network under an organization, other members of the organization will have access for searching for a provider using that specific network, similar to the way in which they would have access to a shared credit card.

In accordance with another aspect of the invention an organization can provide invoicing for certain jobs. As disclosed herein, one embodiment of the invention provides immediate settlement of charges for the services provided. In another feature of the invention, utilizing an organization, a service provider might invoice a member of the organization. Accordingly, in accordance with one aspect of the invention, an organization would have an accounts payable contact or entity that is part of the organization and is on record including contact information such as a name, telephone number, and mailing address. For example, an administrator of the organization might be that contact information. Then, through the organization, the consumer members might be invoiced appropriately for payment of the service provider. Various terms could be provided through the invoicing, including immediate payment or net payment terms, such as net 15, net 30, net 45, net 64 for some provisions where payment is due within a certain number of days of receipt of an invoice from the organization.

Other shared features of the organization might be provided to the members. Accordingly, in a similar way in which service providers are linked to a company to use the account of the company, or residents are linked to a property manager to one network of the property manager, one or more consumer members will be linked to an organization for sharing of information and common access of the shared resources as noted.

### Product Installation

In accordance with another feature of the invention, a service provider may be engaged for installing a product that was purchased from a third party such as a vendor or store or from an original equipment manufacturer (OEM). For example, a customer may order a product such as an air conditioner through a company, such as through a call center. Alternatively, an order might be made through an e-commerce site. In either such scenario, the inventive system that manages the relationship between a customer and a service provider will receive notification and information about the product and installation, such as through an email to a party who is running the inventive system, or through a network communication to the inventive system, such as through an API. A product can be ordered and may be delivered to a customer or may remain at third-party location to be picked up by a service provider.

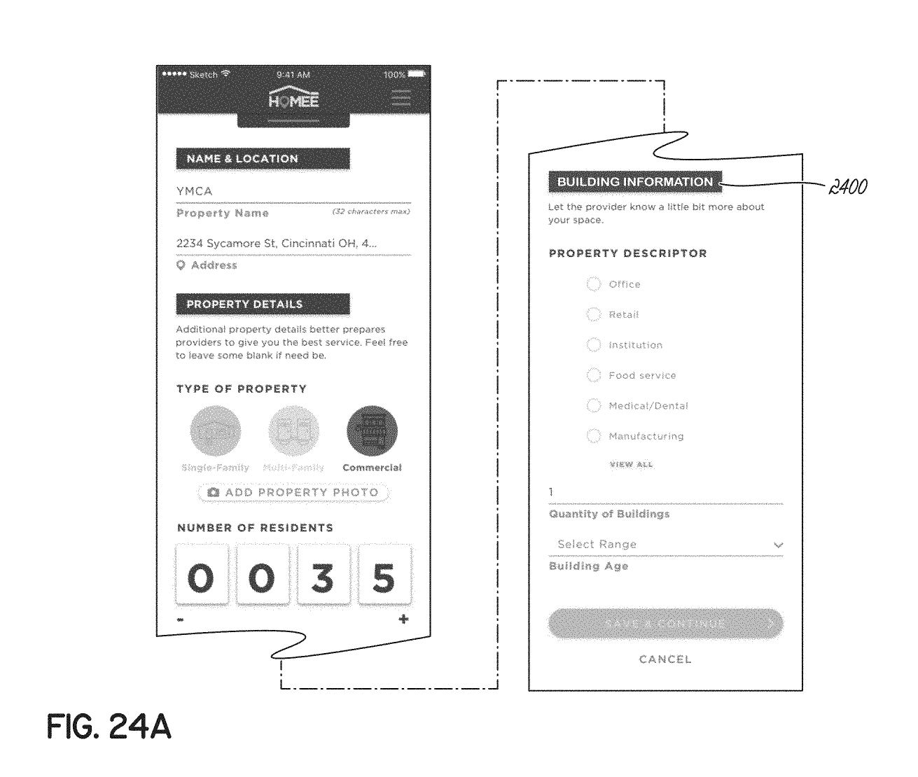

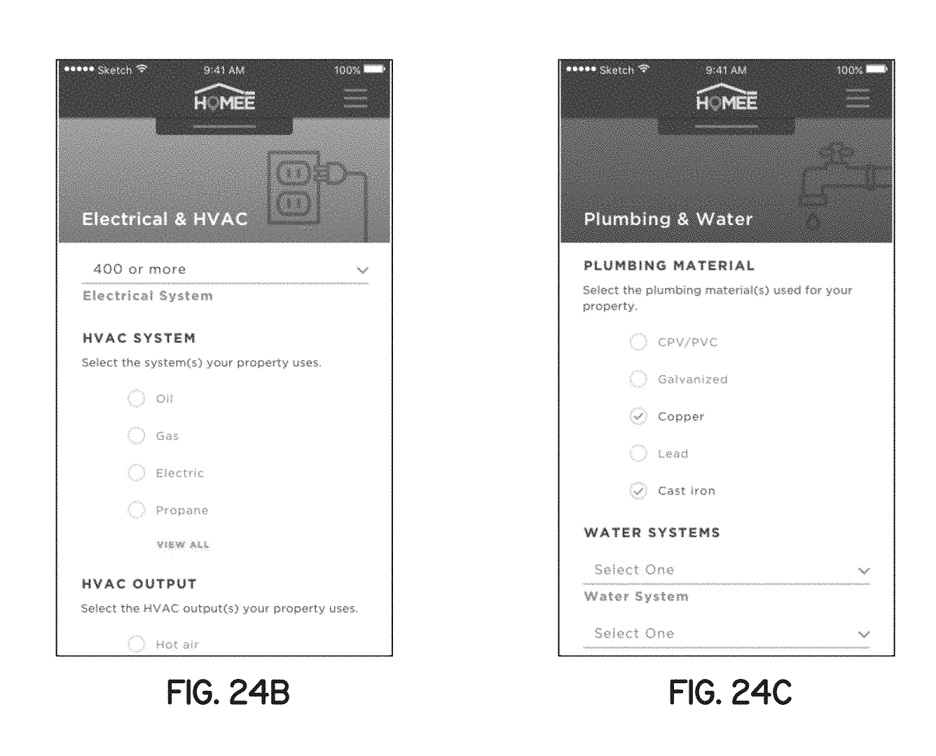

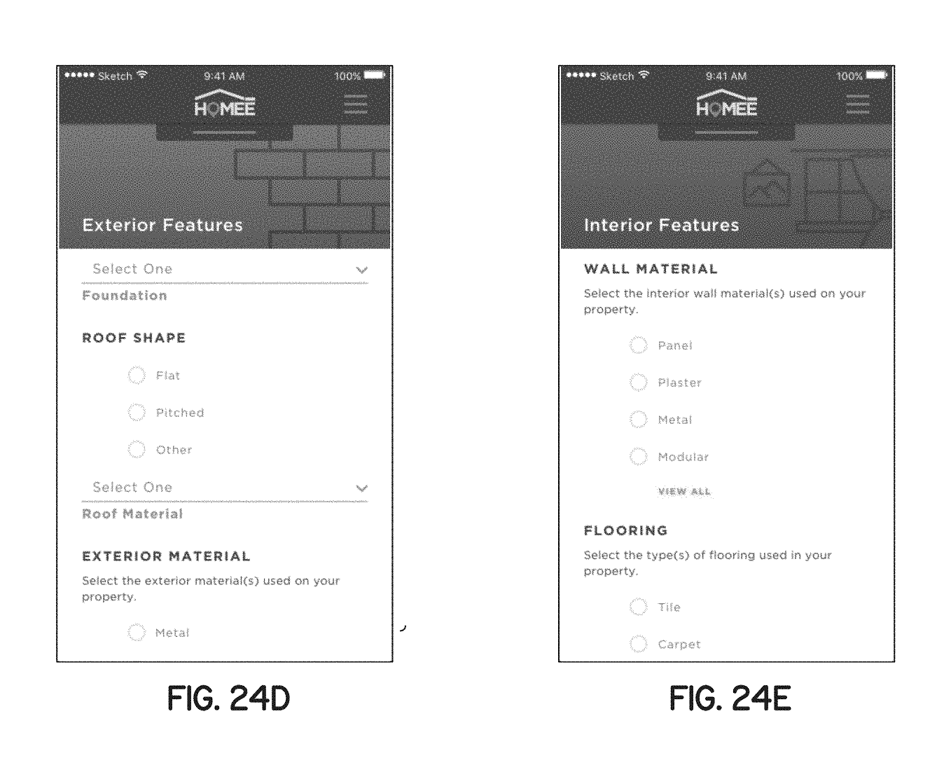

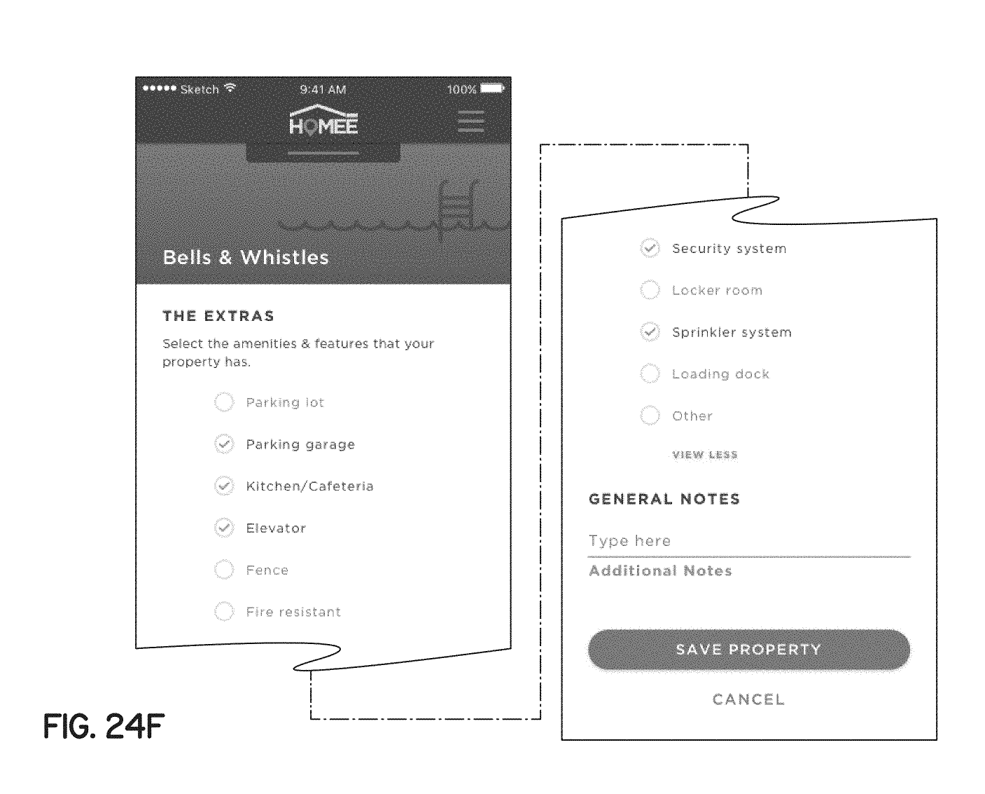

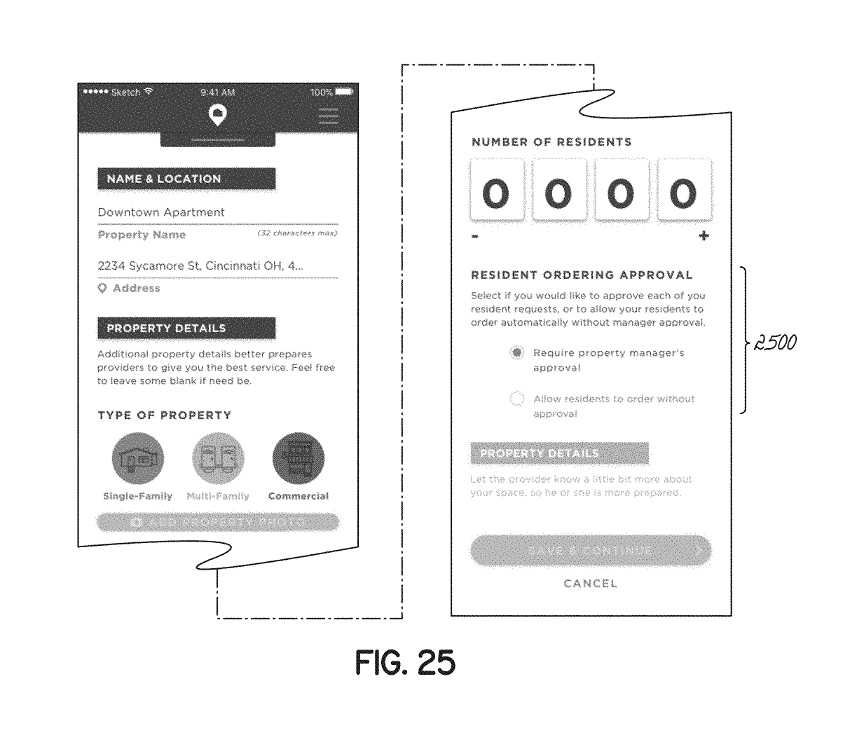

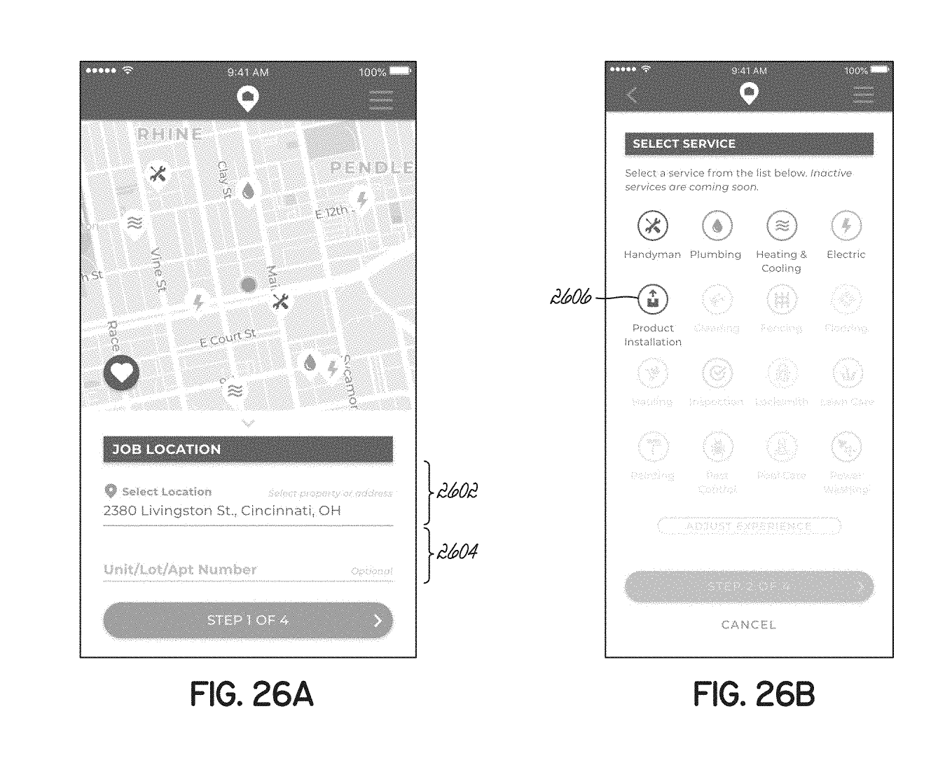

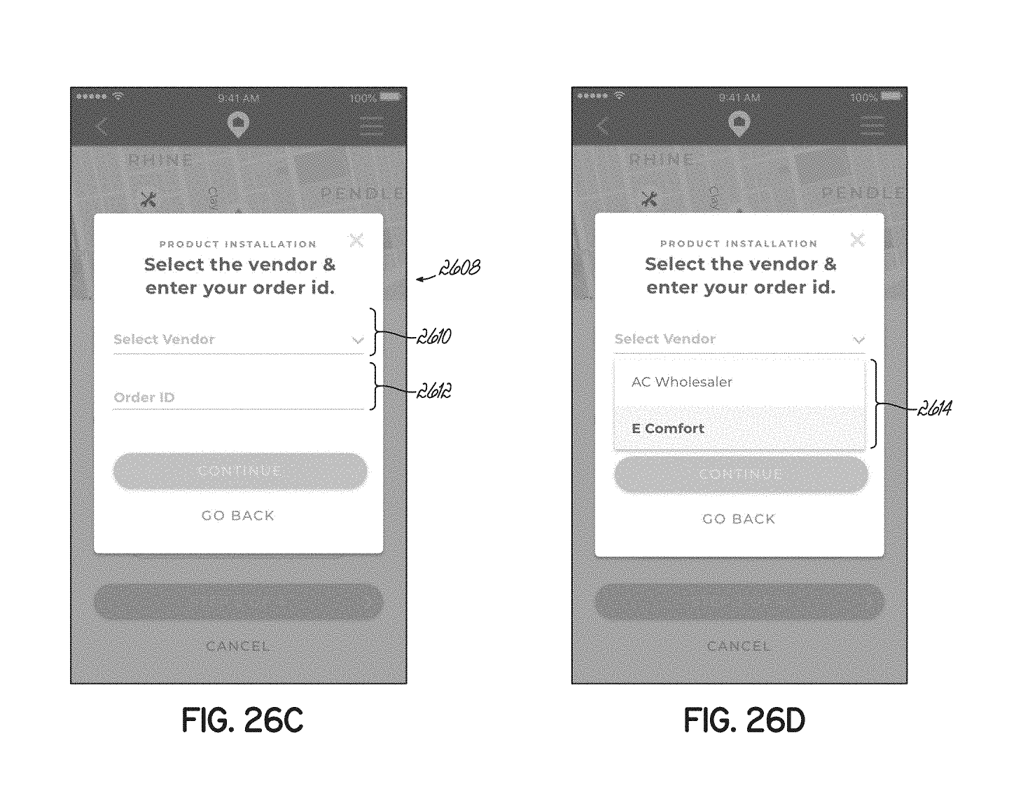

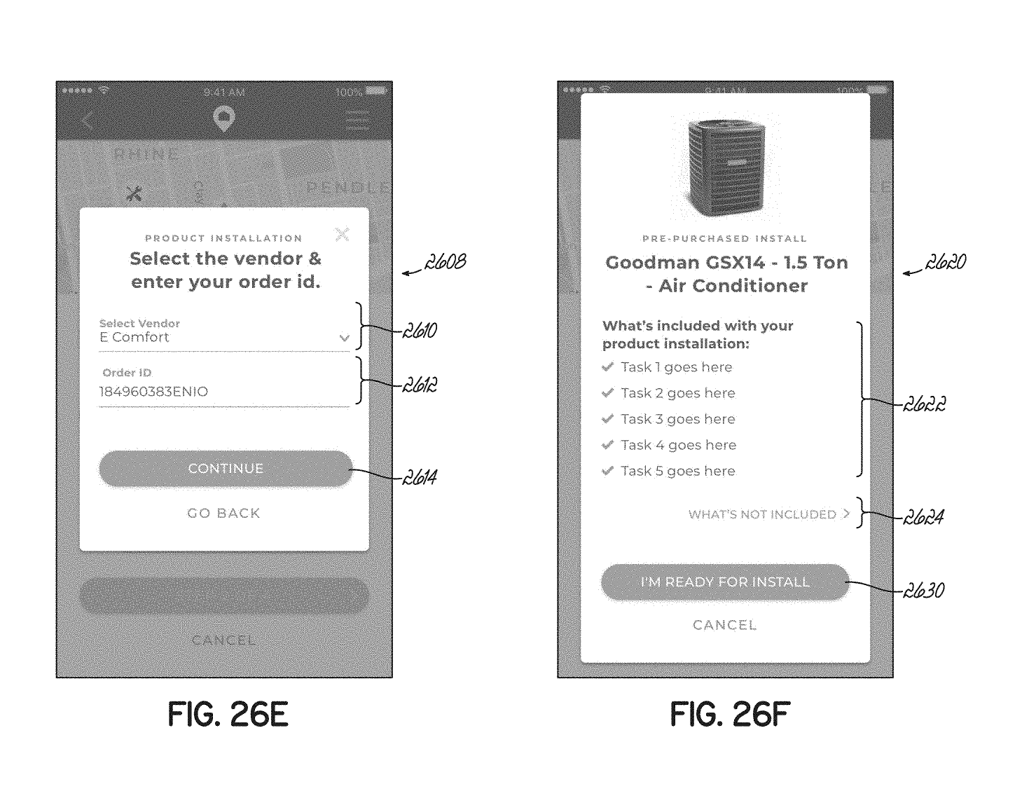

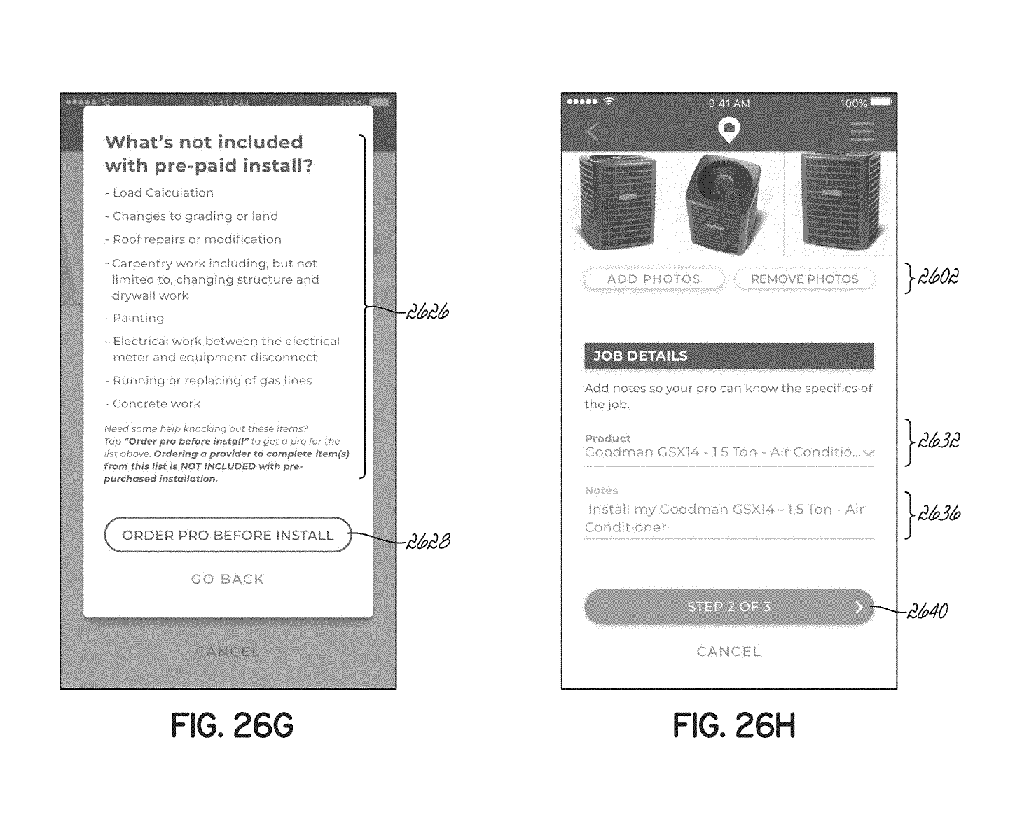

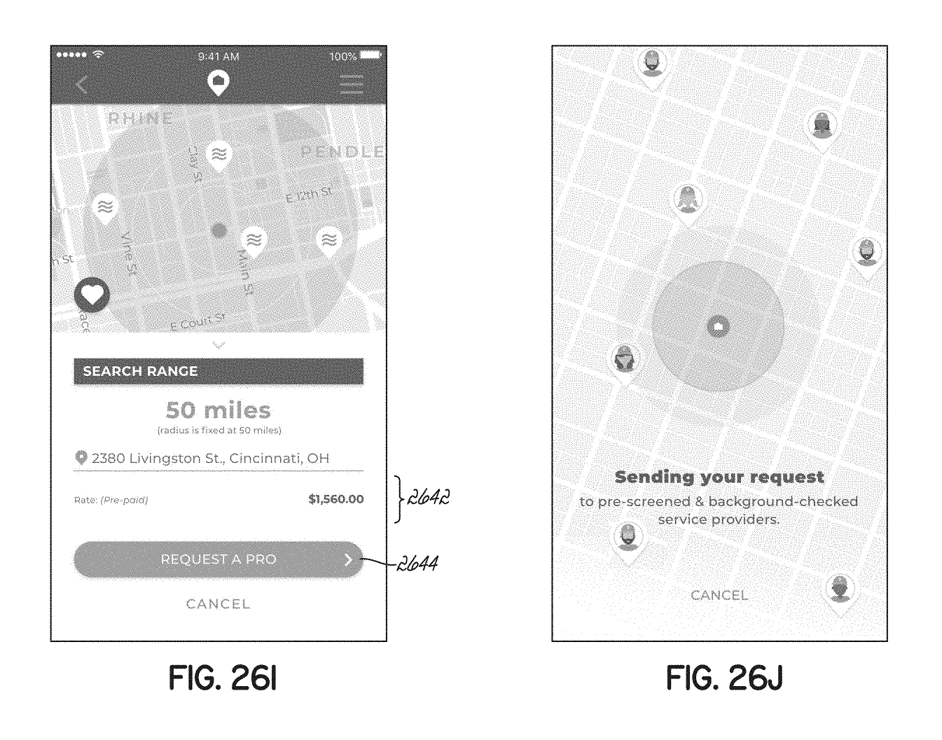

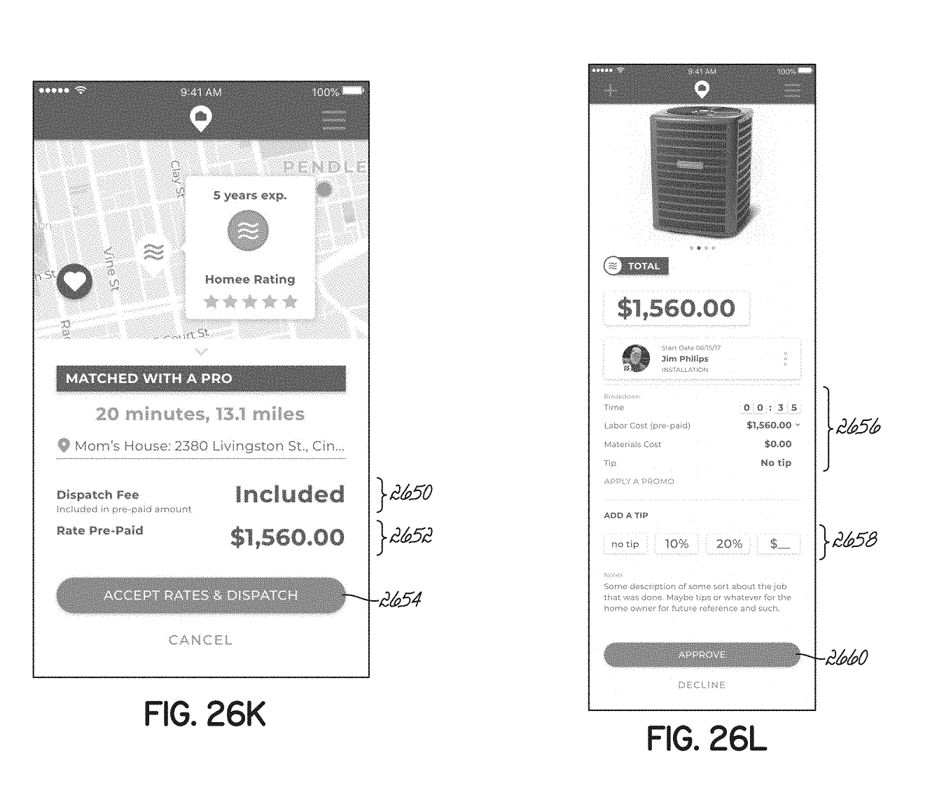

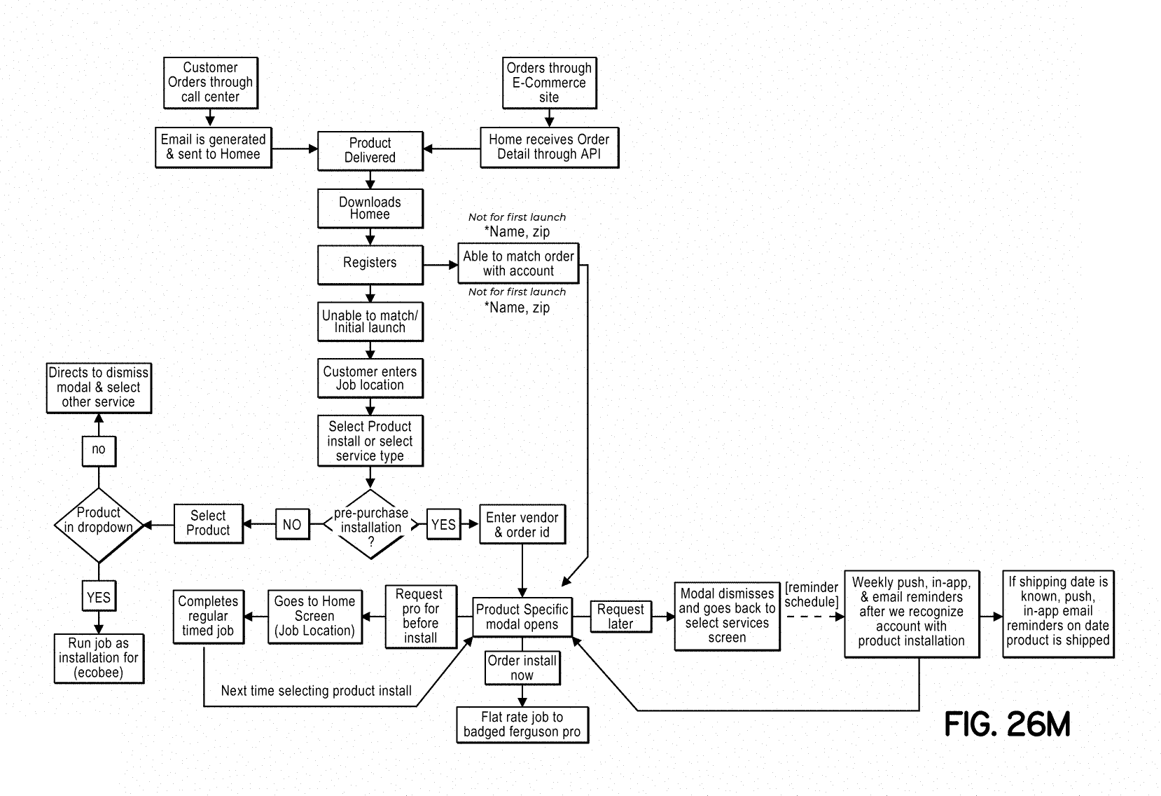

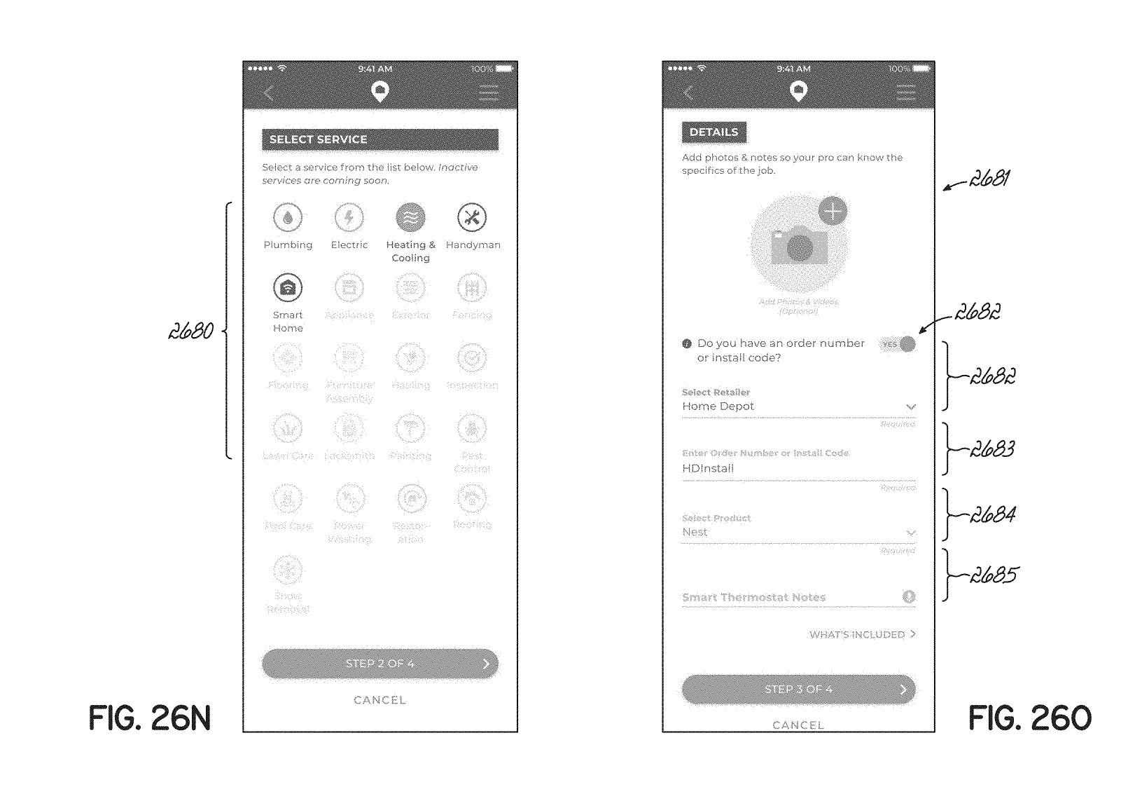

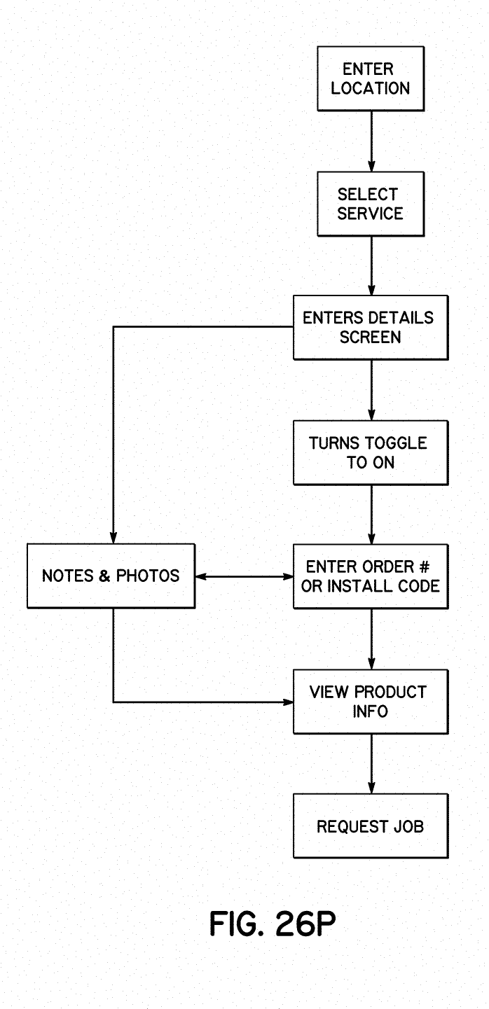

A consumer running a portion of the inventive system on their device may be presented with an ordering screen or home screen as illustrated in FIG. 26A. They enter the address of a home or property in fields 2602, 2604 as the job location. Then, as illustrated in FIG. 26B, they are presented with the screen for selecting the service they desire. In such a case, a field 2606 setting forth “product installation” as a selectable service is presented. They may select that field for obtaining a service provider to install the product they have purchased.

In many such cases, the installation will have been previously paid for. As such, the product installation service may be associated with a flat rate which will be handled by a service provider at that flat rate. Alternatively, a provider might be requesting installation as part of a regular job that operates according to a timer as described herein. When the installation is for a product that has been pre-purchased and paid, a screen as in FIG. 26C is presented as an open product installation modal window 2608 may be opened. In the modal window, information regarding a vendor where the product was purchased may be entered in field 2610 and an order ID that may have been received by the customer from the vendor may be entered through field 2612. As shown in FIG. 26D, a drop-down menu may be available for selecting a vendor known in field 2614. Referring to the screen of FIG. 26E, once order ID information has been entered, the process may continue through field 2614. Engaging field 2614 may show the product and job details, as illustrated in FIG. 26F and screen 2620. Therein, various information might be provided with respect to what the product installation entails and the various tasks that are to be performed as shown in fields 2622. Alternatively, there may be a number of tasks which will not be included for the pre-paid fee. By engaging field 2624, a list of what is not included is also provided as shown in the screen of FIG. 26G and modal window 2626. Referring to the screen of FIG. 26G, if the customer desires a professional to be ordered for the installation that is not for the purposes of the pre-purchased installation, they may engage field 2628 and seek a professional for the installation, such as through a traditional job request. That is, the program may return to the home screen for obtaining a typical timed job from a provider.

In an alternative flow of the invention, in the screen of FIG. 26B, a customer might request some other service other than a product installation. For example, they might select a heating and cooling (HVAC) service or a handyman service. In that case, they may be presented with a screen that requests product information similar to the screen of FIG. 26C, wherein information about an order number, or an installation code or other product information might be obtained. Then once that information is obtained, the flow could proceed as shown in FIG. 26A-26M.

Turning to FIG. 26N, once a service is selected such as from field 26, a customer is presented with a details screen of FIG. 26O to enter information. The customer may add details of the job per field 2681 or toggle field 2682 to indicate they have a product to install and that there is an order number or install code and other information that may be entered in fields 2683, 2684, 2685, for example. FIG. 26P shows the flow of the program of the invention for the alternative selection of services for such a product installation.

Once information has been entered, a customer may be presented with product information of the product to be installed, such as in FIG. 26H and the flow may proceed to requesting a provider for the job.

Referring to FIG. 26F, once a customer is ready for the installation, they may engage field 2630 to proceed. Product information may be presented in a following screen as illustrated in FIG. 26H. Product information may be prefilled and as shown in field 2632. Furthermore, through fields 2634 and 2636, photos and notes may be entered by the customer. Depending on the product, the notes as shown in field 2636 might also be prefilled associated with the product. If the information is satisfactory, the process may be continued through engagement with field 2640. Then, the screen of FIG. 26I is presented for requesting a service provider and showing a map with the search range that keys off the location of the job and installation. Field 2642 indicates the rate for the installation and also indicates that the installation has been prepaid, such as through the purchase process of the product with a third party. Accordingly, the job will proceed in a slightly different format from a job that utilizes a timer in accordance with pre-paid aspects of the invention.

Upon engagement of field 2644, a service provider is requested. The search may go out to service providers that are associated with or “badged” with an approval by the third party that sold the product or by some other third-party, such as the manufacturer of the product. As the search proceeds, the screen of FIG. 26J may be presented to show that the search for a provider is in its normal course. If a service provider match is found, the screen in FIG. 26K is shown with various information regarding the service provider as well as their location. Furthermore, information regarding the rate is provided in fields 2650, 2652. Generally, for such installations, a dispatch fee associated with the service provider will be included in the rate as shown in field 2650. Also, the prepaid rate amount is illustrated in field 2652 to further indicate to a customer that the job will proceed at the fixed rate and not driven according to a timer. If that is suitable, the customer can engage field 2654 and the jobs will proceed in a similar fashion as described herein, just without a timer. For example, the service provider may be in route or at the jobsite. Furthermore, job may proceed and may be in progress, paused, or may be completed as described herein. Once the job is completed, the customer may be presented with a receipt screen is shown in FIG. 26L. As illustrated in the cost fields 2656, the labor cost will be indicated is prepaid at a prepaid rate. A field 2658 for tipping the service provider for the pre-paid work might be used. If the receipt is suitable, the job completion may be approved through field 2660 and the service provider may be rated as described herein. The installation is then complete.

FIG. 26M illustrates a flowchart regarding product installation for a product that is purchased through a third party. As discussed, generally such an installation may involve a prepaid service charge and thus a flat or prepaid rate associated with the transaction. The customer is presented with any product and prepaid rate information upon entering vendor information and identification information associated with the purchase and order.

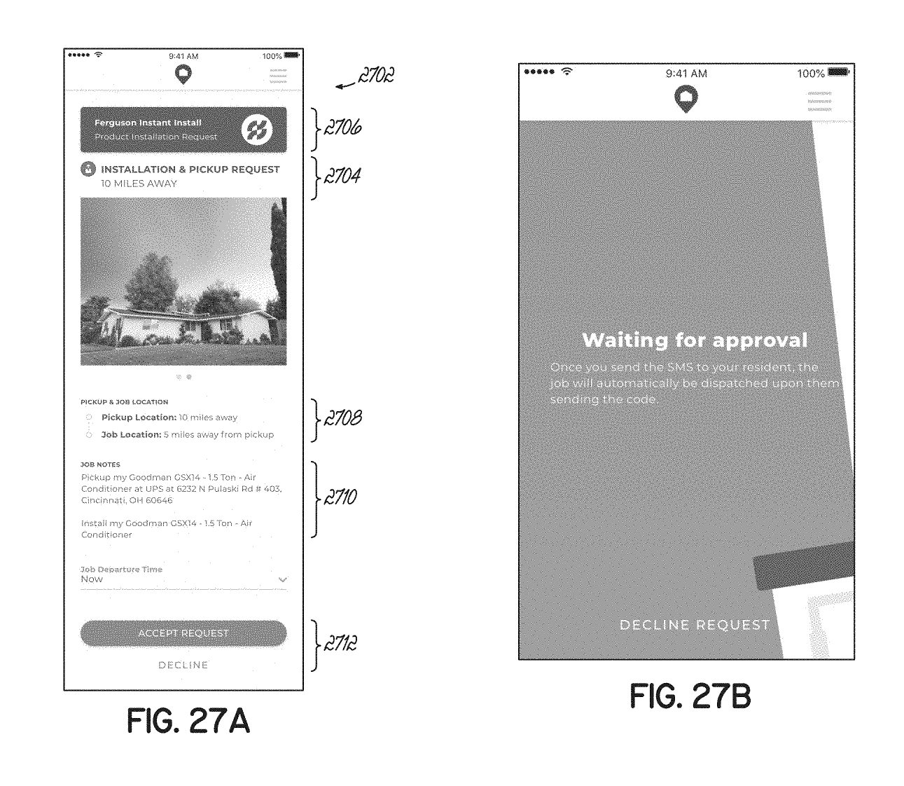

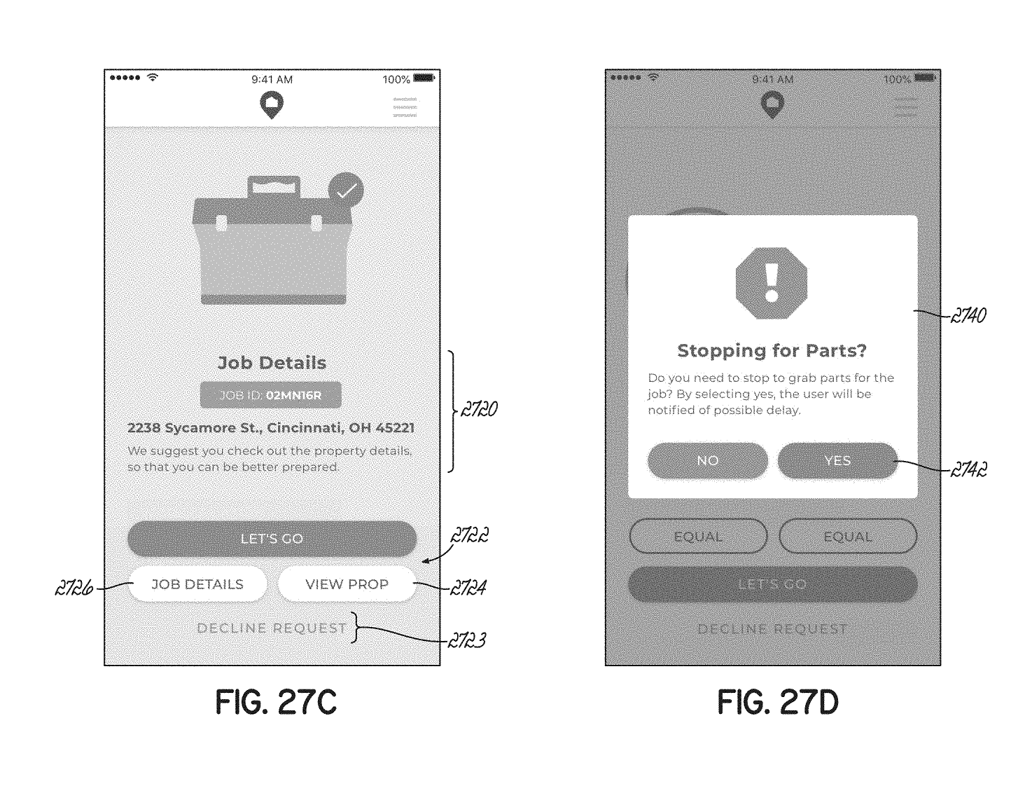

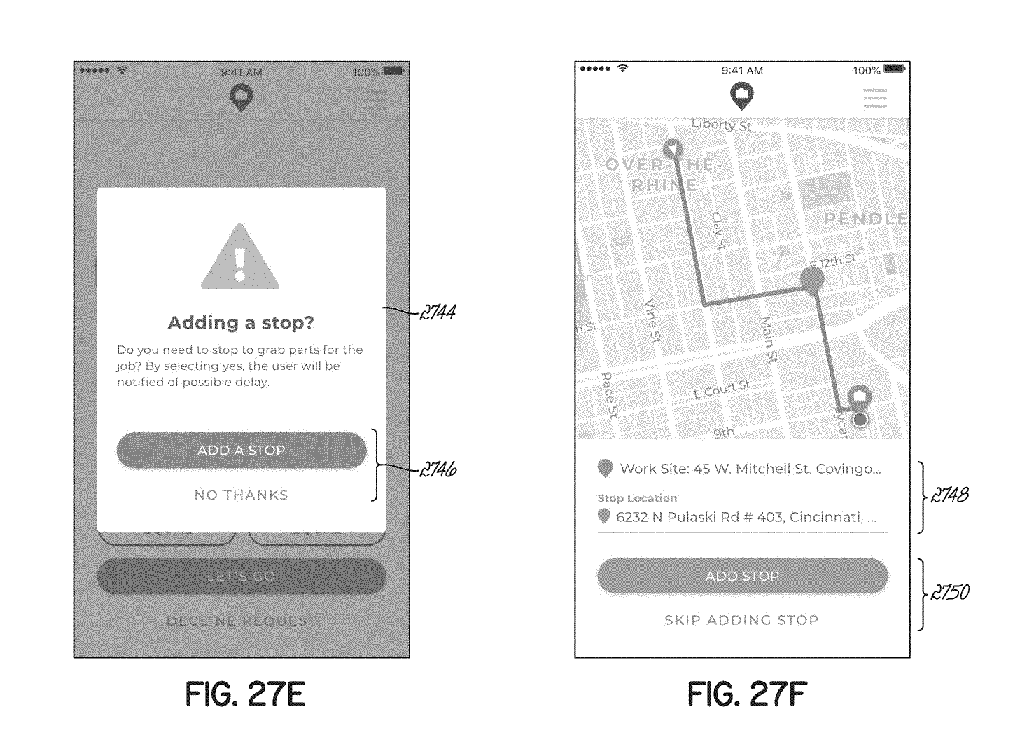

FIG. 27A illustrates a screen for a provider with the requested product installation service. In screen 2072 of FIG. 27A, field 2704 will indicate that there is a pickup request associated with the item or system that has been purchased for installation. Field 2708 provides additional information regarding the location of the pickup and its relationship to the job location, while field 2710 indicates additional information regarding the product as well as the pickup location. Referring to FIG. 27A, for providers that are certified for or badged for certain products, the provider will see an indication that the job is associated with a particular product vendor as well as a product installation request in field 2706. In that way, the service provider will know the purpose of the job and the kind of product that is to be installed. In field 2712, the request can be accepted or denied by the service provider.

Referring to FIG. 27B, once a service provider indicates the acceptance of the job, the job can proceed. In one embodiment, the consumer may be placed in control of when the job begins and thus the provider may be presented which the screen of FIG. 27B wherein the consumer may release the job, such as through sending an SMS code back to the provider's device. Once that occurs and the job is proceeding, the screen of FIG. 27C is presented to the provider with fields 2720 indicating information and details regarding the installation job. Additional information regarding the property or location of the job or job details may be obtained through engagement with appropriate fields 2724, 2726. The service provider can then proceed with the job or decline the request upon further details by engagement with appropriate fields 2722, 2723. Generally, for installation, it is necessary for the service provider to make a pickup of the product or system that was purchased from a third party. For example, as shown in FIG. 27A, the pickup information for the particular job request is noted.

Accordingly, referring to FIG. 27B, a modal window 2740 provides a service provider with a way to indicate that they will be stopping for parts or particularly stopping for product pickup. Engaging field 2742 and indicating that a stop is necessary will yield modal window 2744 of FIG. 27E wherein through fields 2746 a stop may be added. As noted, when a stop is selected, the consumer will be notified of the stop. If the stop is to be added, the service provider is presented with the screen of FIG. 27F again showing fields 2748 with information regarding the jobsite or worksite and also the location of the stop. Then through engagement with fields 2750 the service provider can add or skip adding a particular product pickup stop. Thereafter, returning to the screen of FIG. 27C, engagement of field 2722 will allow the service provider to proceed with the job in a typical courses as described herein where the job is handled in various ways as disclosed herein.

### Smart Home

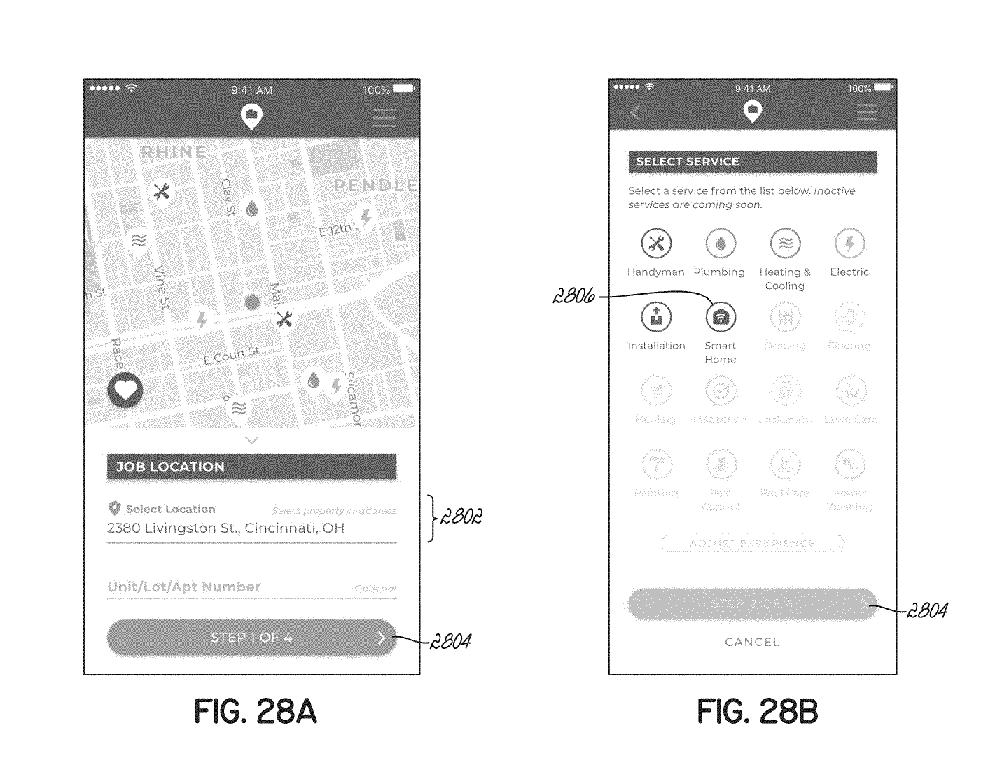

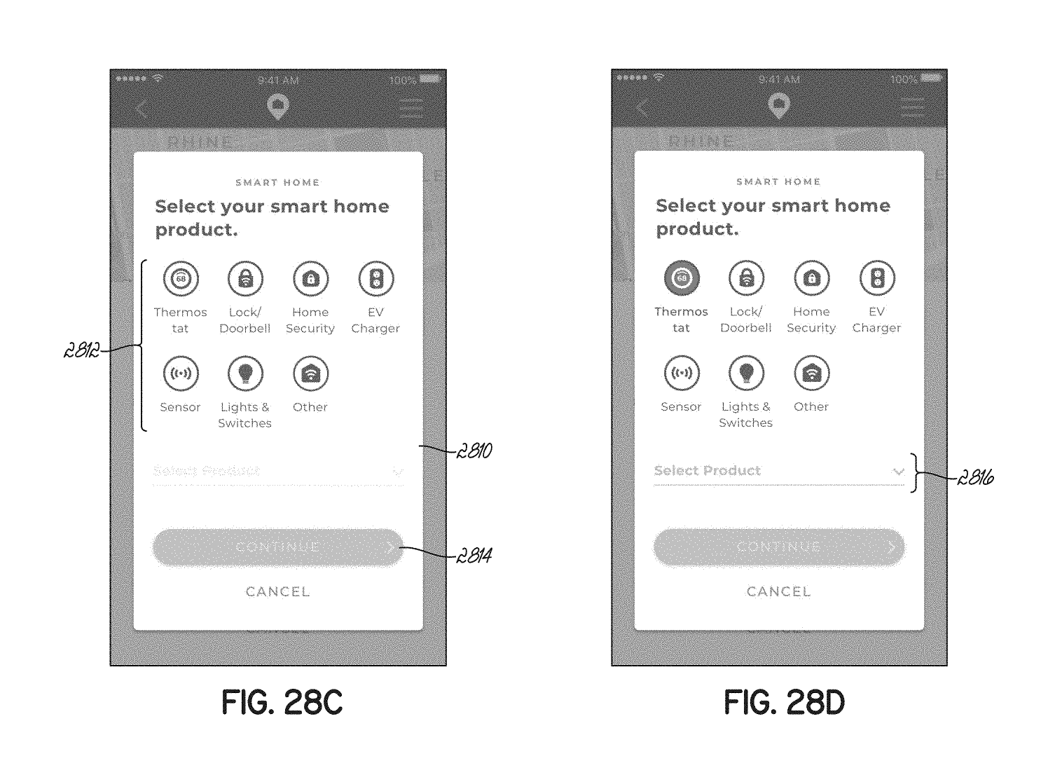

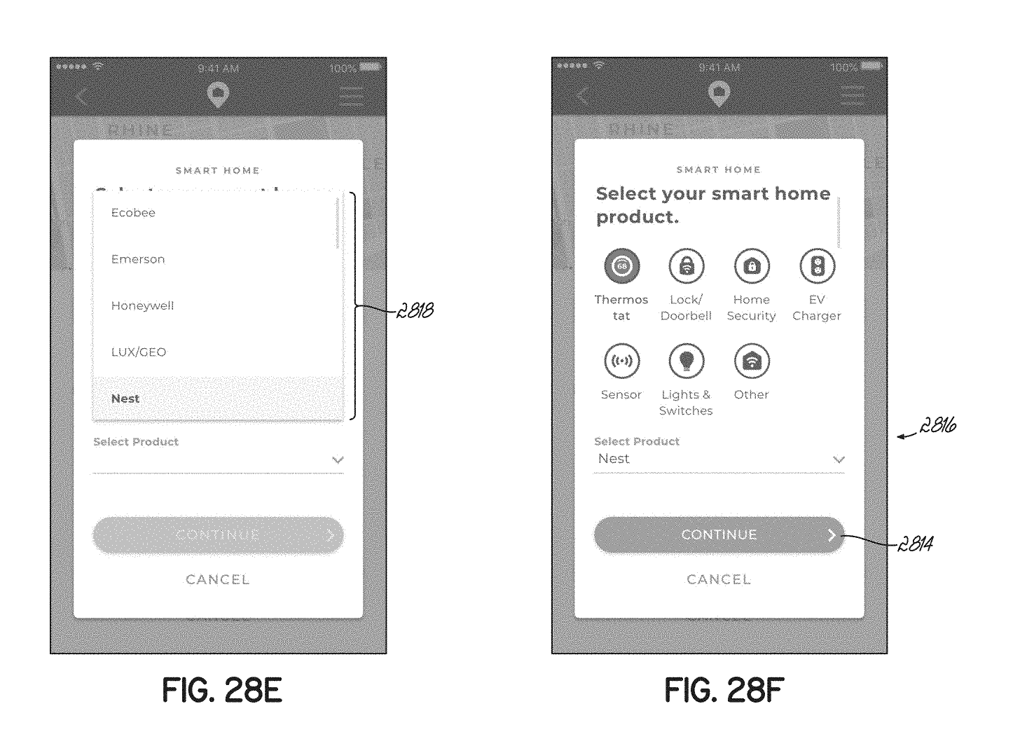

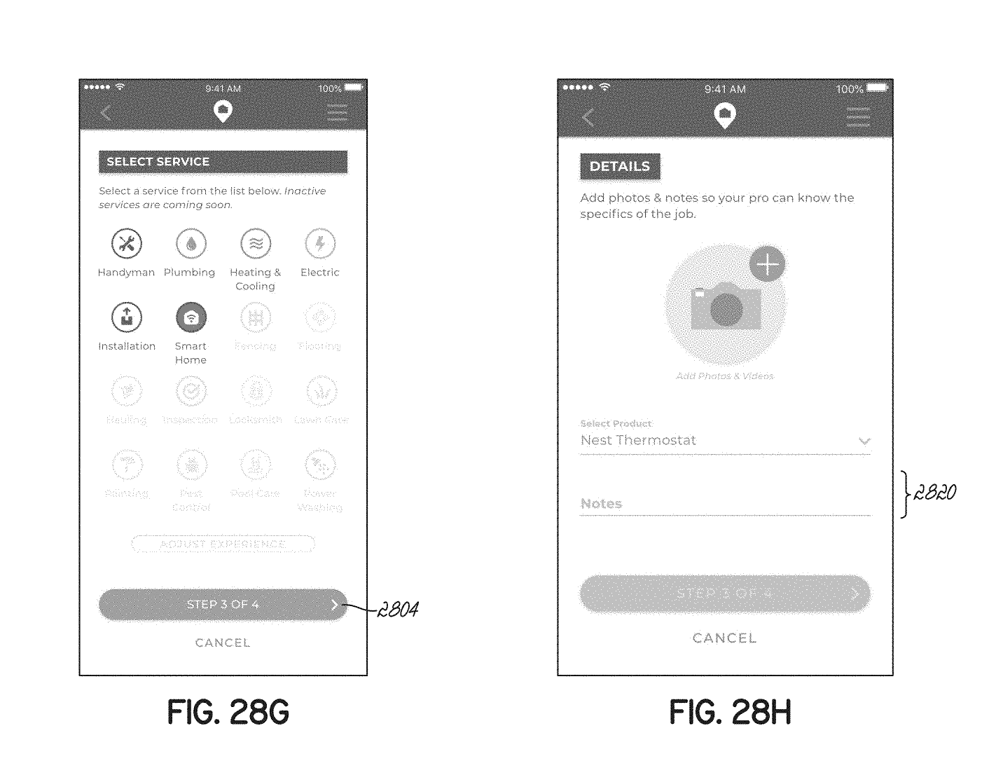

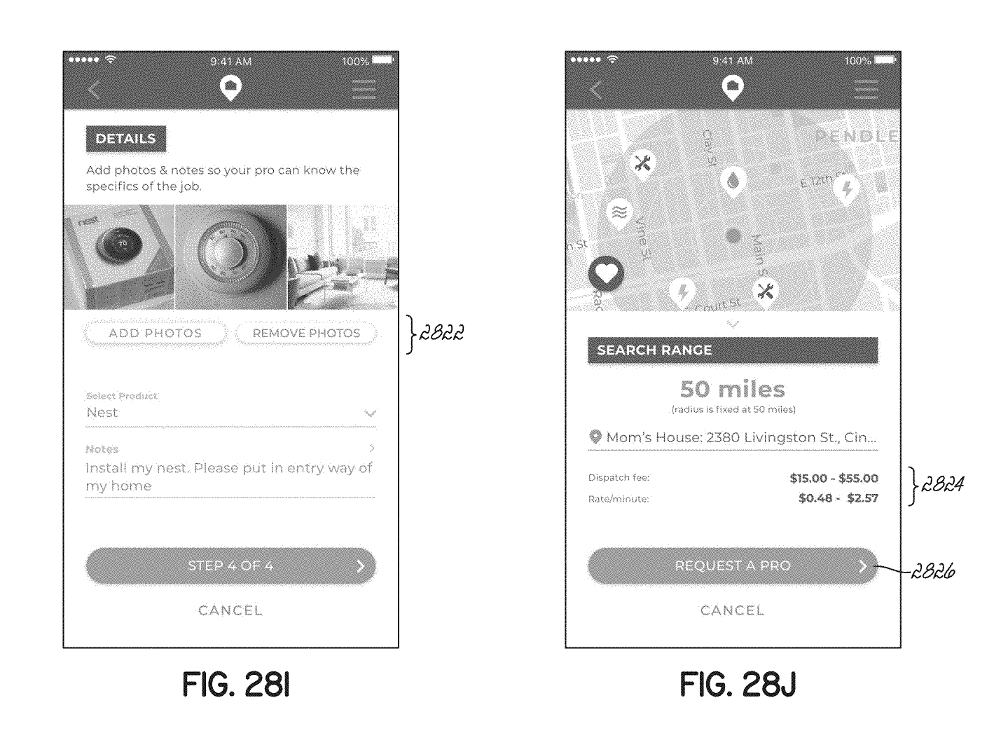

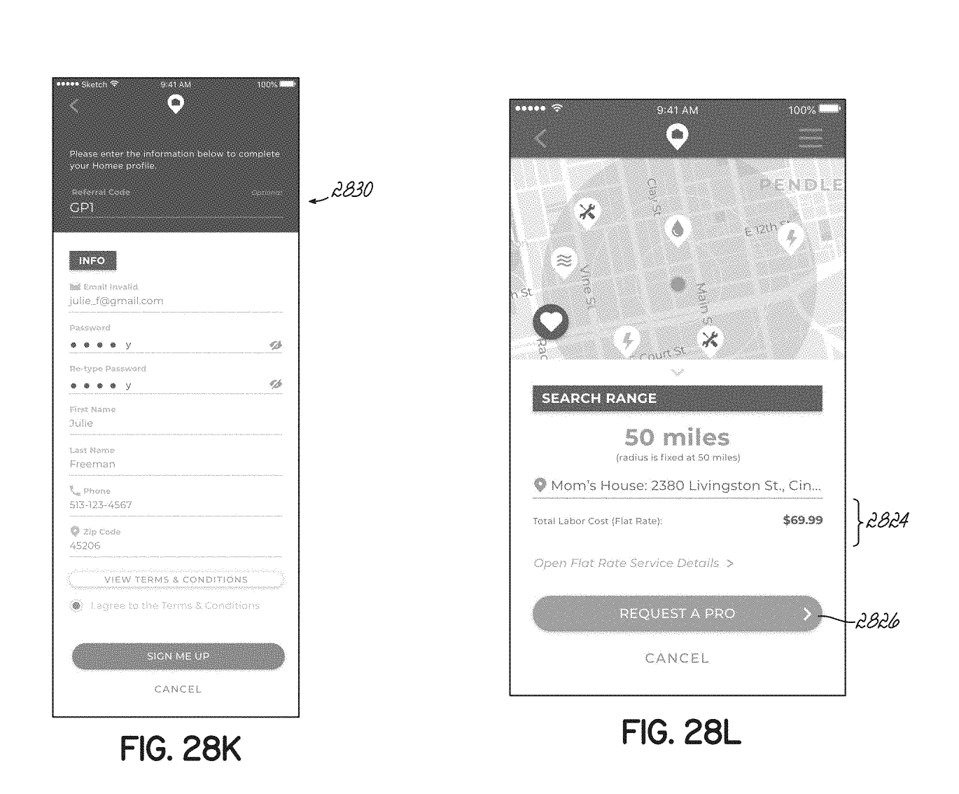

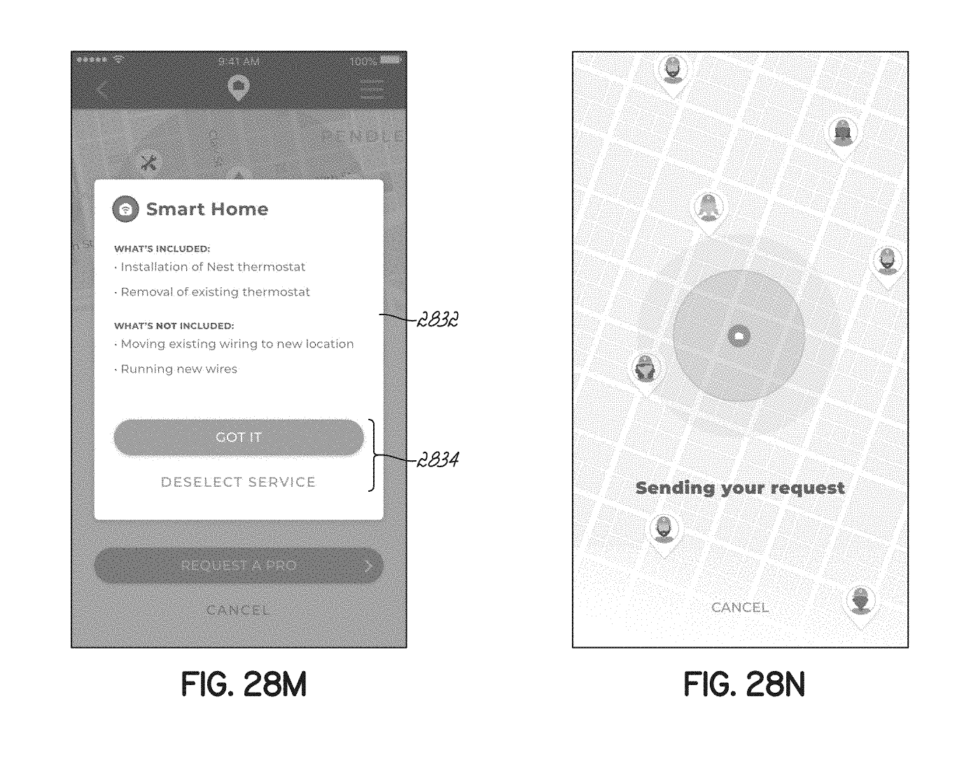

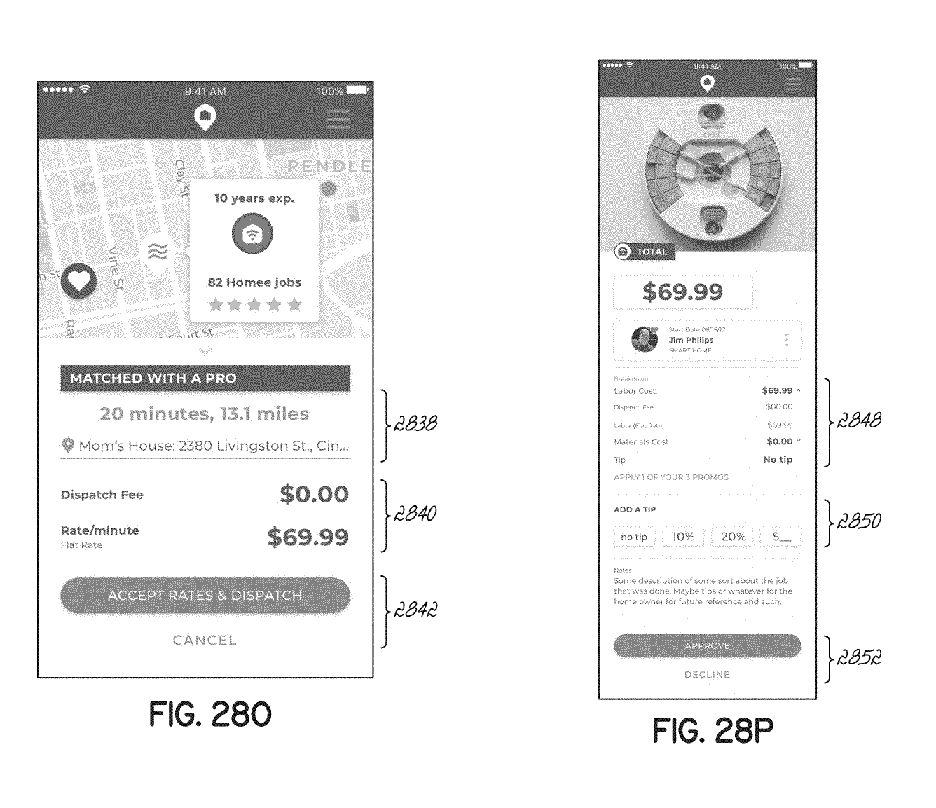

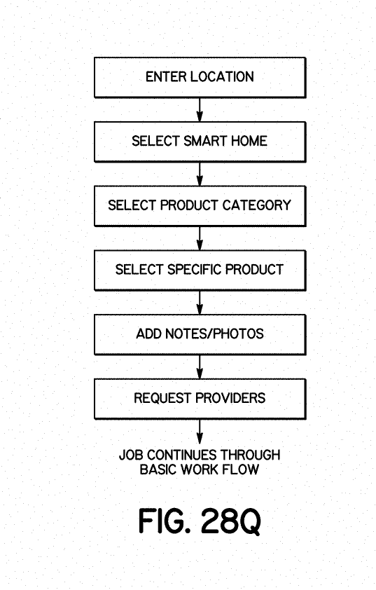

In accordance with another feature of the invention, product installation may be associated with products that are considered smart products, such as thermostats, smoked detectors, security cameras, light switches, etc. that are coupled with a Wi-Fi network and are programmable. In accordance with one embodiment of the invention, the product installation for such products may be affiliated with a certain select group of service providers that are specifically trained and authorized for such products. Accordingly, depending upon the particular smart products selected, job requests may only go to those service providers which are specifically certified or badged to install such products. Accordingly, referring to FIG. 28A, a consumer home screen is presented with field 2802 indicating a property for service. A job request may begin by engaging field 2804 to start a job request process with a number of steps.

In accordance with one embodiment of the invention, such smart products and their installation are segregated for specific service requests and are handled separately in order to properly link a consumer and a certified service provider and to ensure that the installation is done properly. Furthermore, in accordance with an embodiment of the invention, service providers can become certified or badged, as discussed herein, by consuming educational content, such as by reading informational text, or watching videos associated with a particular product and its operation and installation. In that way, badged or certified service providers, that are linked with particular products and brands, are given priority in the search and selection process to be selected by a consumer for certain installations. Alternatively, as described herein, providers that are not badged but qualify for the service type will also be able to get the job request but will not get priority to the job request and will receive it later in the search and match process. If a service provider that is not badged actually gets the request, they will be given the option to get badged after accepting the job. All such products are grouped together under a flexible service indicated as “Smart Home” services. Once a consumer begins the process of requesting a job, FIG. 28B is presented and includes a field 2806 for selecting a service associated with smart home and the installation of smart products. Once a service is selected, field 2804 is engaged and a modal window 2810 is presented showing the various different smart home products that might be selected for installation. As may be appreciated, various different fields 2812 are provided so a consumer may select a particular product. Once a product has been selected, field 2814 is engaged to continue the process, and additional product field 2816 is presented as illustrated in FIG. 28D. Product field 2816 may include a drop-down menu 2818 that is displayed as shown in FIG. 28E. Thereby, a consumer may select one or more branded products associated with the particular type of product selected. In the example as illustrated, a thermostat was selected and menu 2818 provides various different thermostat manufacturers/brands that might be selected. As shown in the screen in FIG. 28F, once the particular brand is selected, it is displayed in field 2816. Then, in field 2814 the process may continue wherein the screen of FIG. 28G is presented and field 2804 indicates a certain number of steps that have been completed for the job request process. Continuing further through engagement with field 2804, a consumer may add various notes and photos associated with the job request through fields 2820 through the screen of FIG. 28H and fields 2822 in the screen of FIG. 28I.

In accordance with one embodiment of the invention, certain consumers may take advantage of flat rate installation and they use their profile to obtain such a flat rate. Alternatively, the job may proceed as a typical job wherein a timer is utilized, and a certain time-based installation rate is used. For example, once the smart home and product information has been entered, the screen as illustrated in FIG. 28J is provided to the consumer with location information for the job as well as a search map and information in fields 2824. In field 2826, a provider might be requested.

Alternatively, if the consumer is affiliated with a particular corporate partner, the inventive system is able to accommodate a flat rate for the consumer that is associated with that corporate partner. Specifically, in a consumer profile screen as illustrated in FIG. 28K a referral code for the corporate partner associated with the flat rate might be entered in field 2830. As such a referral code is in place in the consumer's profile and linked with the consumer, the alternative job request screen as illustrated in FIG. 28L might be provided where the pricing information in fields 2824 provides the flat rate cost for the service.

Accordingly, the inventive system can link certain consumers that are affiliated with a corporate partner to service providers that have agreed to handle flat rate installation for certain brands of products. As noted, the search launched from screens 28J or 28L will search for providers that are badged or certified to install the selected brand of smart product.

In order to inform the consumer and to avoid any misunderstandings with respect to the service provided, for flat rate service launched with a particular referral code in field 2830 as shown in the screen of FIG. 28K, the consumer might be presented with a modal window 2832 that indicates what type of service is to be provided and what is not included in the job as shown in the screen of FIG. 28M. If the information is suitable, the consumer can proceed to select the service or deselect the service through fields 2834. If service is requested, the screen of FIG. 28N may be shown to indicate that the job request is proceeding. Then, when the job request is matched with a provider a screen such as in FIG. 28O may be presented having informational fields 2838 regarding the job and cost fields 2840 regarding the cost, including the flat rate cost associated with the selected product installation for that particular customer due to that customer being linked with a corporate partner. Engagement with an appropriate field 2842 may accept the provider and proceed with the job request or may cancel the job request. If the job request proceeds, it will proceed in the typical fashion with an appropriate timer and engagement with the service provider until completion of the job or the job is paused or otherwise disposed of. In accordance with one embodiment of the invention, if the consumer is linked with a corporate partner and entitled to a flat rate, a timer might not be utilized, and any completed job would just indicate a flat rate cost. For example, for a completed job with the flat rate, a receipt is shown in the screen FIG. 28P might be provided wherein the cost fields 2848 indicate a flat rate and fields 2850 are provided, such as for adding a tip. Through fields 2852, the receipt can be approved or declined. FIG. 28Q illustrates a flowchart associated with a job request for installation of a smart product and selection of the smart home service.

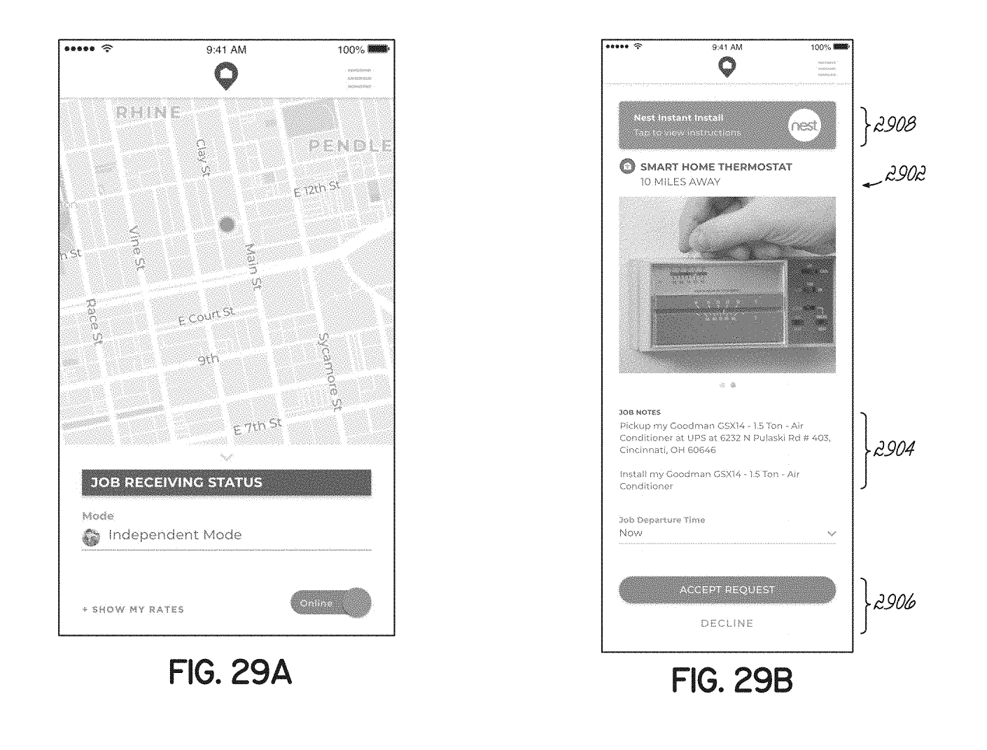

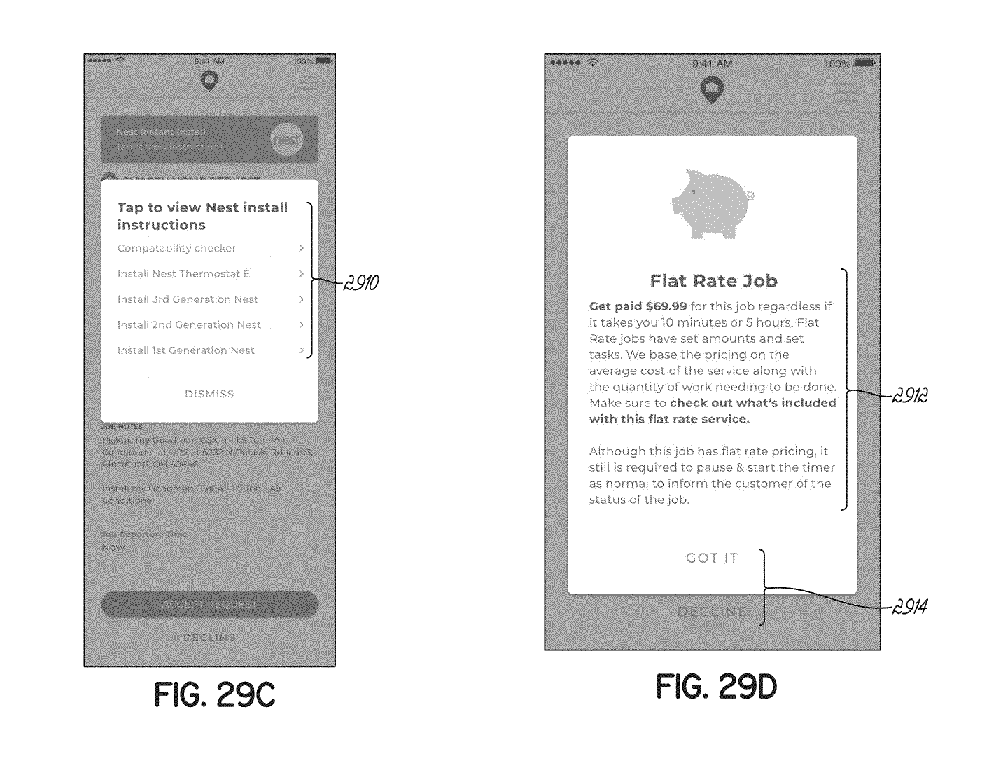

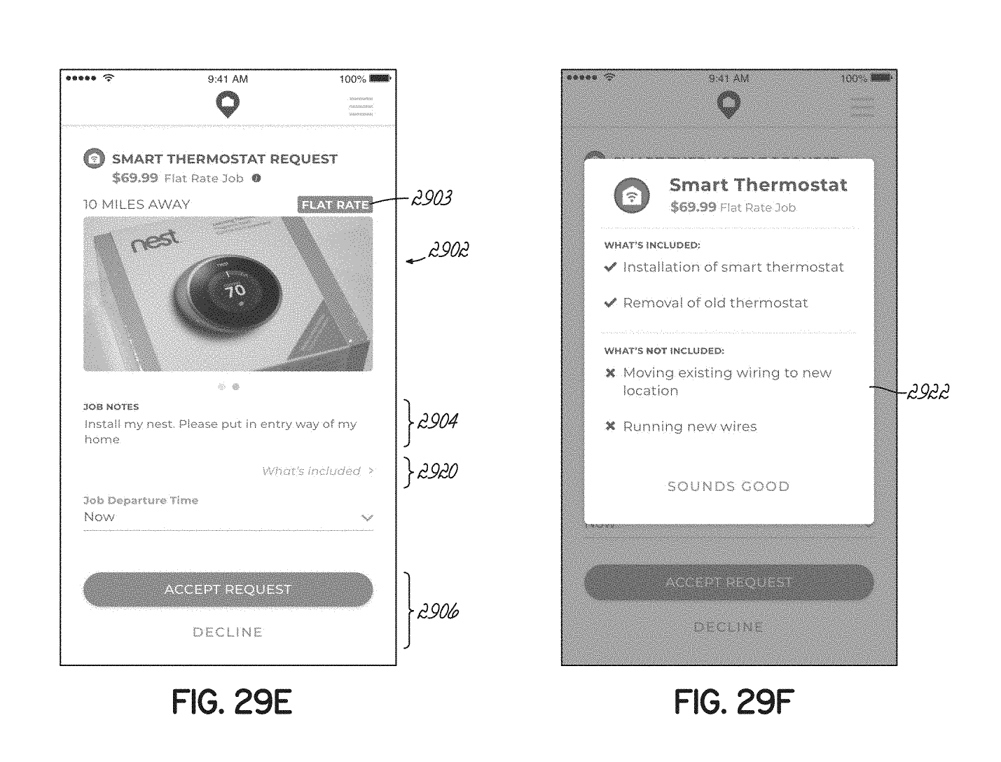

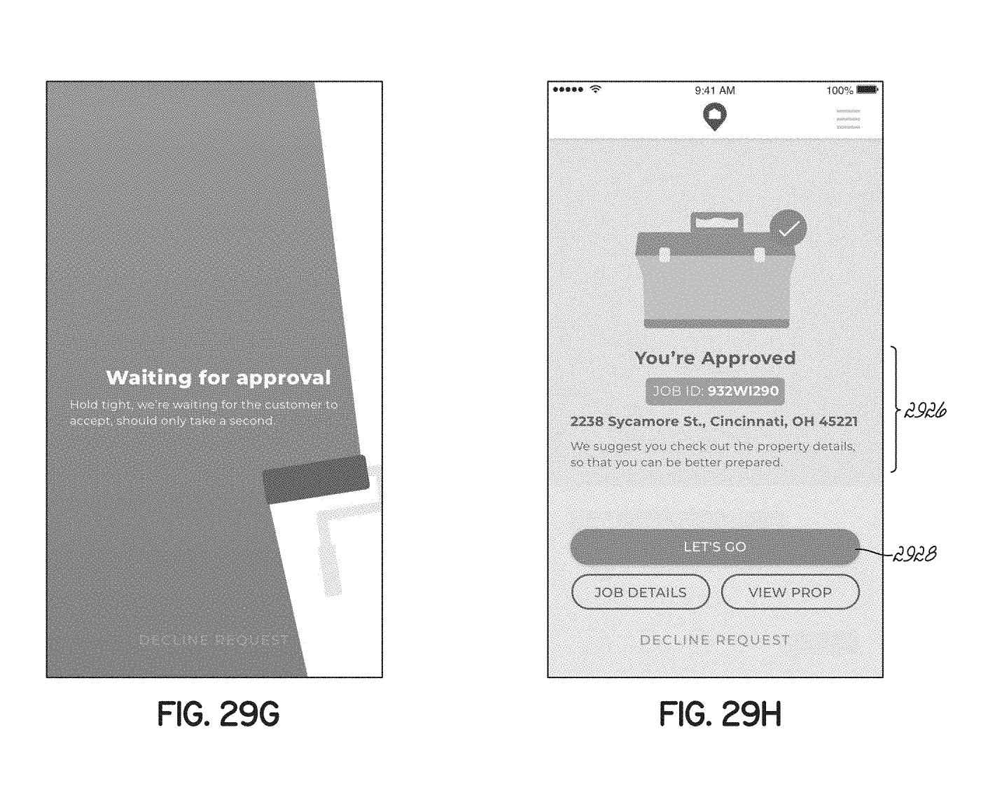

FIG. 29A illustrates a home screen for a service provider indicating that they are online and ready to receive job requests. FIG. 29B illustrates a screen for a possible job request for a selected smart home service from a consumer. Field 2902 indicates the type of service requested as well as the distance away from the service provider. Fields 2904 indicate information about the job request. The job request can then be accepted or declined through fields 2906. In accordance with one aspect of the invention, a service provider may be badged or certified for particular smart home products and installation. If so, then field 2908 may indicate the particular badge. Field 2908 may be selected for providing installation information associated with the smart home product. For example, as illustrated in the screen of FIG. 29C, if field 2908 is engaged, fields 2910 may be displayed for selection in order to obtain product installation information and other educational information associated with the badge or associated with products for a particular manufacturer. Selecting one or more of the fields 2910 will provide that content to the service provider through their device.

In accordance with another aspect of the invention, a consumer may be entitled to a smart home service at a flat rate. For example, a particular corporate partner may be associated with the consumer and codes for that corporate partner may be utilized in the profile of the consumer for obtaining service at a flat rate for a particular job request. If that is the case, a modal window 2912 is presented to the service provider when the job request initially displays as illustrated in FIG. 29D. The informational window provides information that the requested job is at a flat rate. For appropriate fields, the service provider can close the window. With a pending job request, the screen in FIG. 29E is again presented to the service provider. Fields 2902 include the information regarding the flat rate job. Similarly, fields 2904 indicate job notes.

In accordance with one aspect of the invention, with a flat rate job, certain tasks are included, and certain tasks are not included. For a clear understanding by the service providers, field 2920 may be engaged to then provide a modal window 2922 as illustrated in FIG. 29F to show what is included and what is not included in the flat rate job. Then the invention flow proceeds to the screen in FIG. 29E for accepting or declining the job through fields 2906. If the job request is accepted, the screen of FIG. 29G may provide the indication that the service provider is waiting for the consumer's approval. Upon approval, the screen of FIG. 29H is presented showing fields 4926 regarding the job. Through field 2928, the job can proceed and may proceed in a similar fashion as other jobs described herein implementing a timer. If the job is a flat rate job, no timer may need to be utilized. The job may then proceed in a normal fashion wherein the service provider navigates to the job and the job is proceeding, paused, or completed. For a completed a job, a receipt will then be prepared by the service provider including appropriate pictures, videos or notes and labor and material cost information. Upon presentation of the receipt and approval by the consumer, the provider can then rate the consumer.

### Certification/Badging

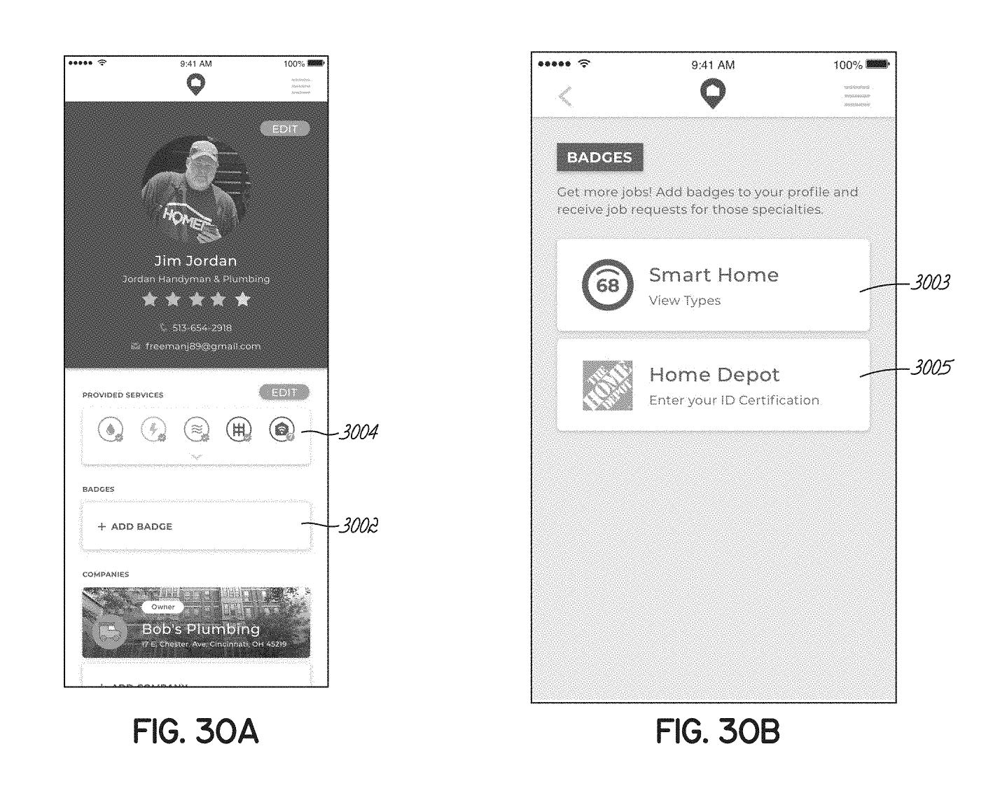

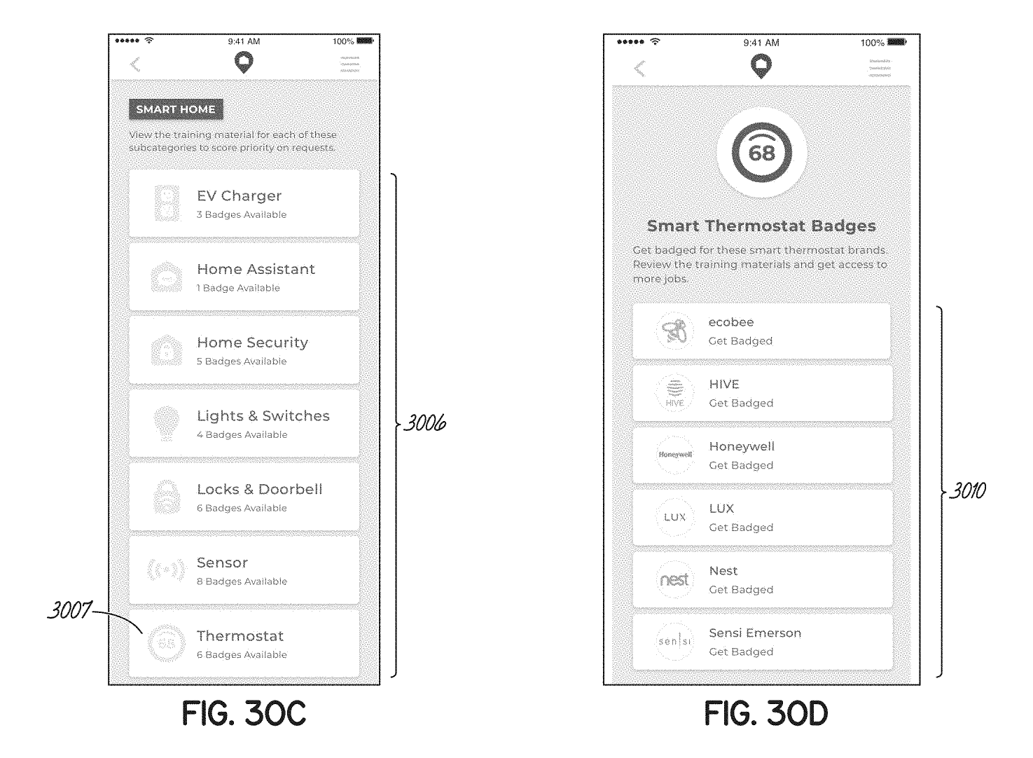

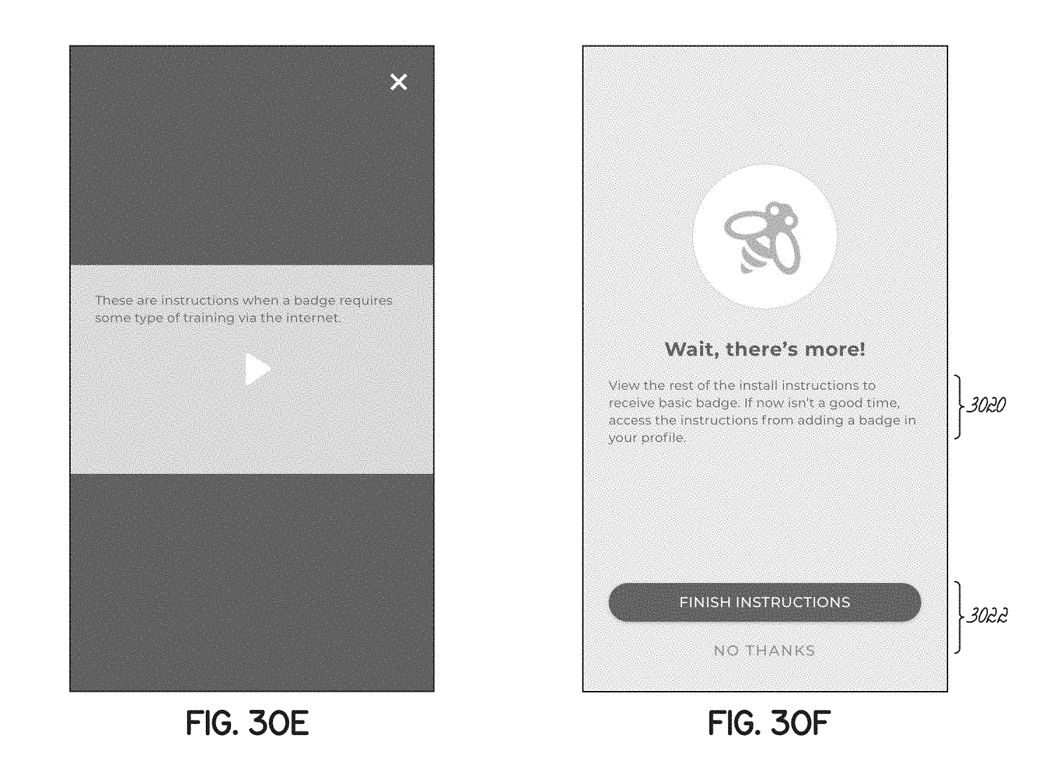

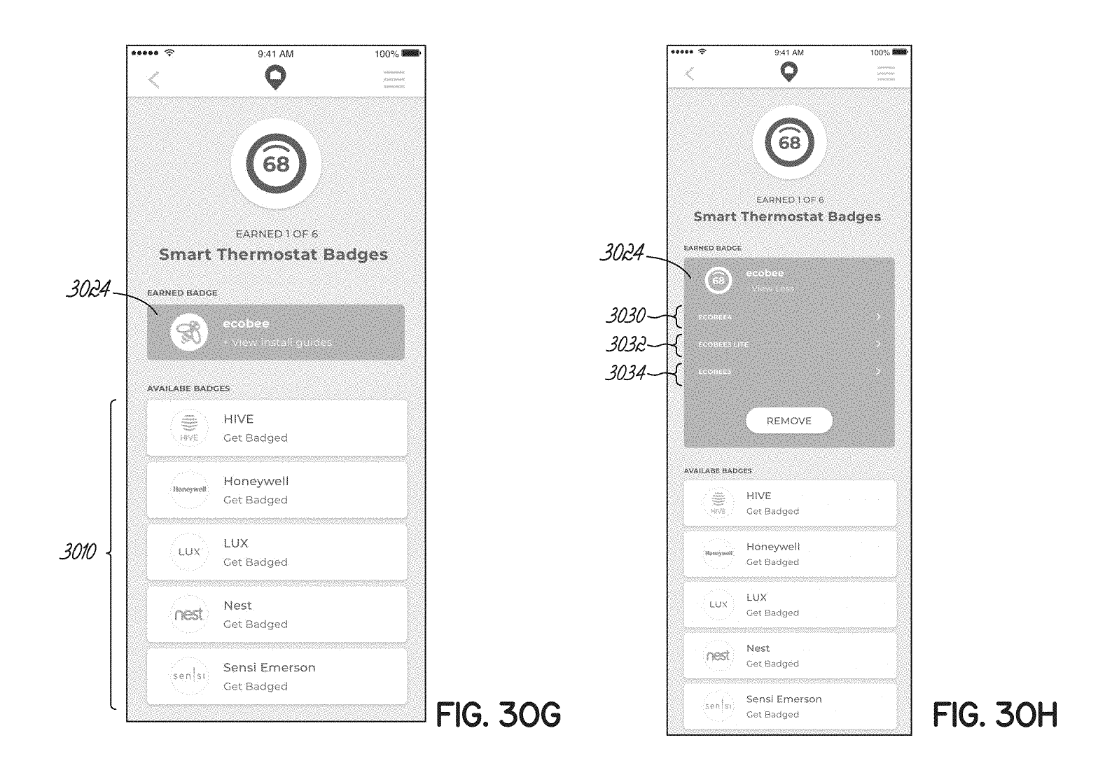

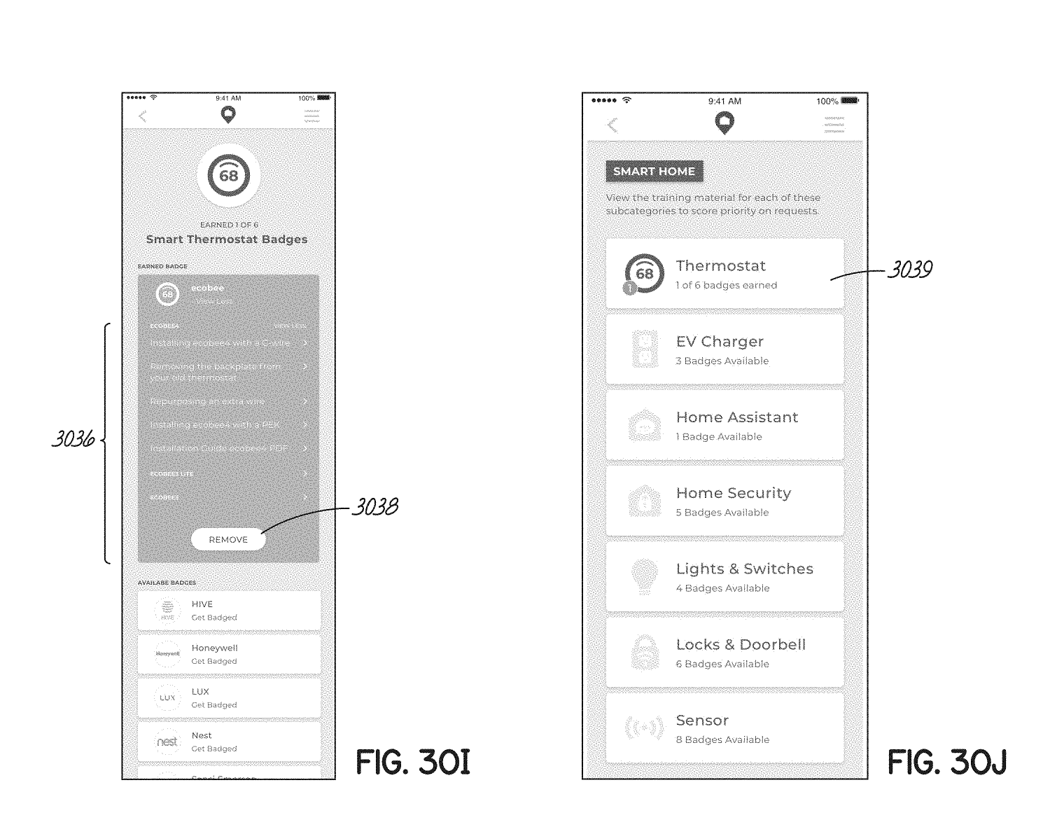

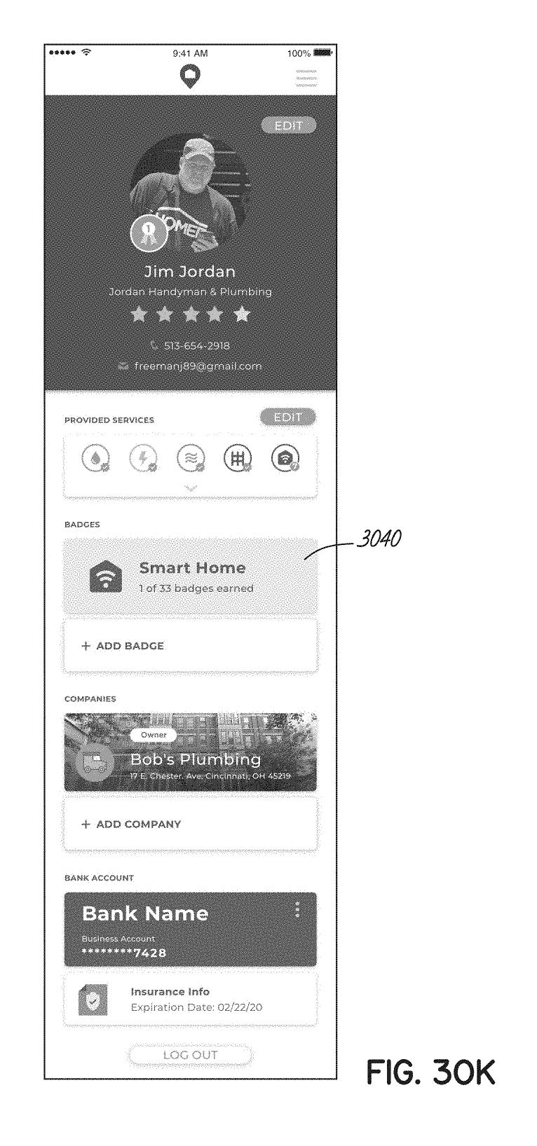

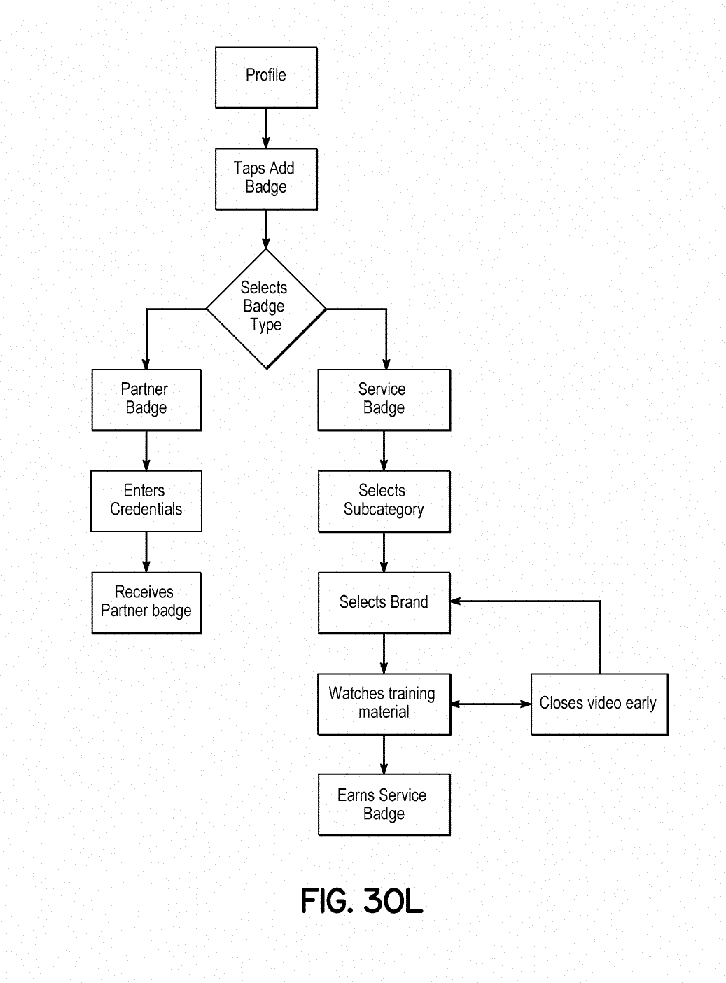

As noted, for certain product installations and smart home services, it will be necessary for a service provider to be certified to handle such an installation. In that way, search requests are filtered based upon such a certification or badge earned by a service provider. To that end, as illustrated in the screen of FIG. 30A, when setting up a profile screen of a service provider in the program, the service provider can select one or more badges to add to their profile through field 3002. Such badges indicate that the service provider meets particular criteria or conditions. Such criteria are used as a search parameter when making a job request. That is, a consumer may request a service provider that has a certain badge and the search is limited as described herein. The provider offers a plurality of services, and in field 3004 “Smart Home” services are available as a service through a provider. Therefore, the service provider may need to have certification for one or more branded products that are associated with a “Smart Home.” Also, a provider might be certified or linked with a vendor or partner. By engaging the field 3002 to add a badge, a list of available and selectable badges might be presented to the service provider on their device as shown in the screen interface of FIG. 30B. For example, the provider may be able to get a badge to certify that they are familiar with or have expertise for a certain brand and can be associated with one or more service badges. Alternatively, they may be linked with certain vendors or partners and so may be associated with one or more partner badges. The provider may select such different badges. Referring to FIG. 30B, the provider might select a service badge through field 3003 or a partner badge through field 3005. The field 3003 provides one or more badges that might be associated with a “Smart Home” service and one or more categories of products/brands that might be selected by a provider. In one exemplary embodiment, the provider program presents the brand or product badges through one or more product categories/subcategories. Upon engagement with field 3003, the provider is presented with product categories to choose from such as through one or more fields 3006 as illustrated in the screen of FIG. 30C. Each of the product categories is associated with one or more brands. For example, upon selecting a product category, such as “thermostats” of field 3007, the provider is presented with one or more brand badges to select from.

Selecting one or more of the product categories, such as in the fields 3006, in turn, will yield the screen of FIG. 30D wherein the different brands or products associated with a product category 3006 are shown, such as in fields 3010. The service provider then selects one or more of the available brand badges and may be presented with educational or certification material for the service provider to use. For example, the video screen as shown in FIG. 30E may be watched by the service provider for training purposes. Upon completion, the screen of FIG. 30F may be presented with an informational field 3020 indicating that there is additional information for obtaining the badge. That additional information may then be obtained and reviewed or disregarded, such as through fields 3022. Upon being trained or educated appropriately, the service provider can have the badge. Once a badge is earned by a provider, it will be so indicated in their records, such as in field 3024 of the screen of FIG. 30G showing a vendor or brand and the available badges and earned badges. For example, referring to FIG. 30G, the particular service provider has earned a badge for a brand ECOBEE for a thermostat product.

As a next level, the service provider can then engage field 3024 and through the earned badge view product specific details to reference for the particular brands and/or products for which the badge has been earned. For example, there may be different models or versions of a branded product with information and instructions for each. The screen of FIG. 30H illustrates such badge expansion and shows various product or model fields 3030, 3032 and 3034. Each of those model fields may then be further expanded upon for product information as illustrated in the screen a FIG. 30I. The program provides further product/model information through drop down fields and links 3036. The badge might also be removed if desired through field 3038. As badges are earned, the provider is notified and given information about the badges earned and available, such as through the badge screens of FIG. 30B, or FIG. 30C as displayed in the appropriate fields 3003, 3005, 3006. Then, as shown in the updated profile screens of FIG. 30J, 30K, numbers of the earned badges 3039, 3040 are shown. Such as for a particular product or as an overall count. Once the service provider has earned one or more of the badges, they may then be included in the search for particular service providers in a “Smart Home” job request to provide installation and other services associated with a particular branded product as described herein. FIG. 30L illustrates the program flow associated with obtaining a badge in accordance with the invention. Such badges are used as a search criteria in selecting service providers as disclosed herein.

### Inspections

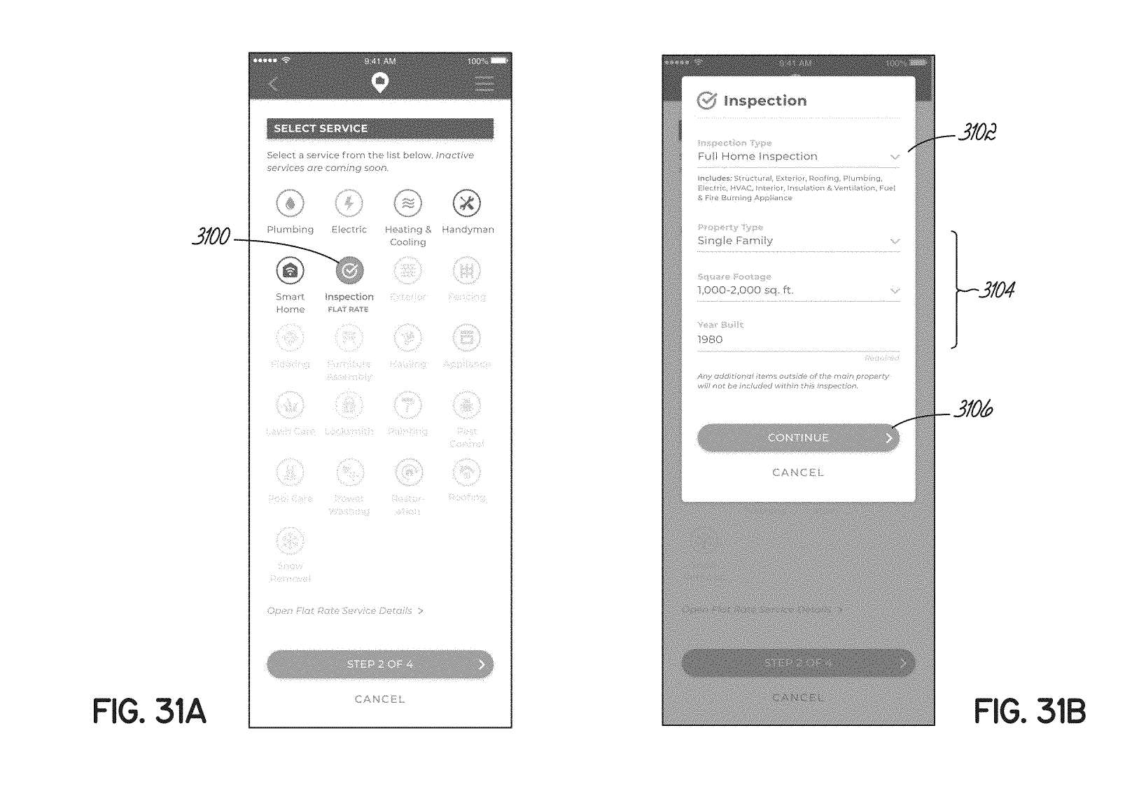

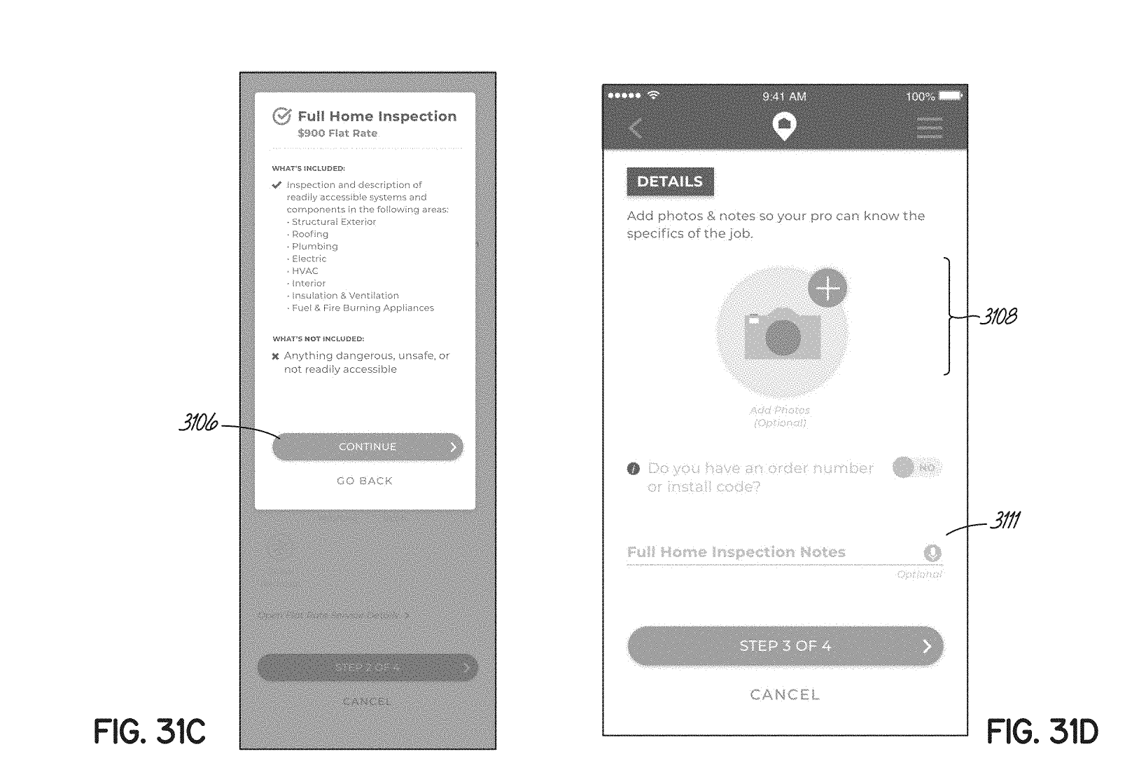

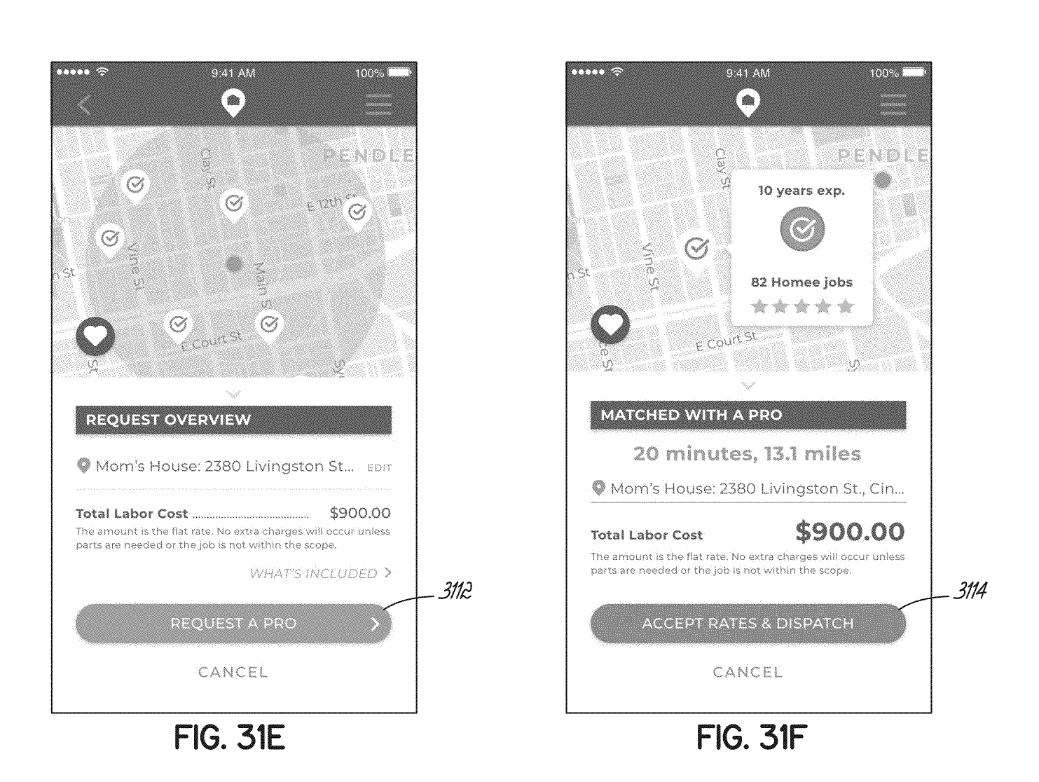

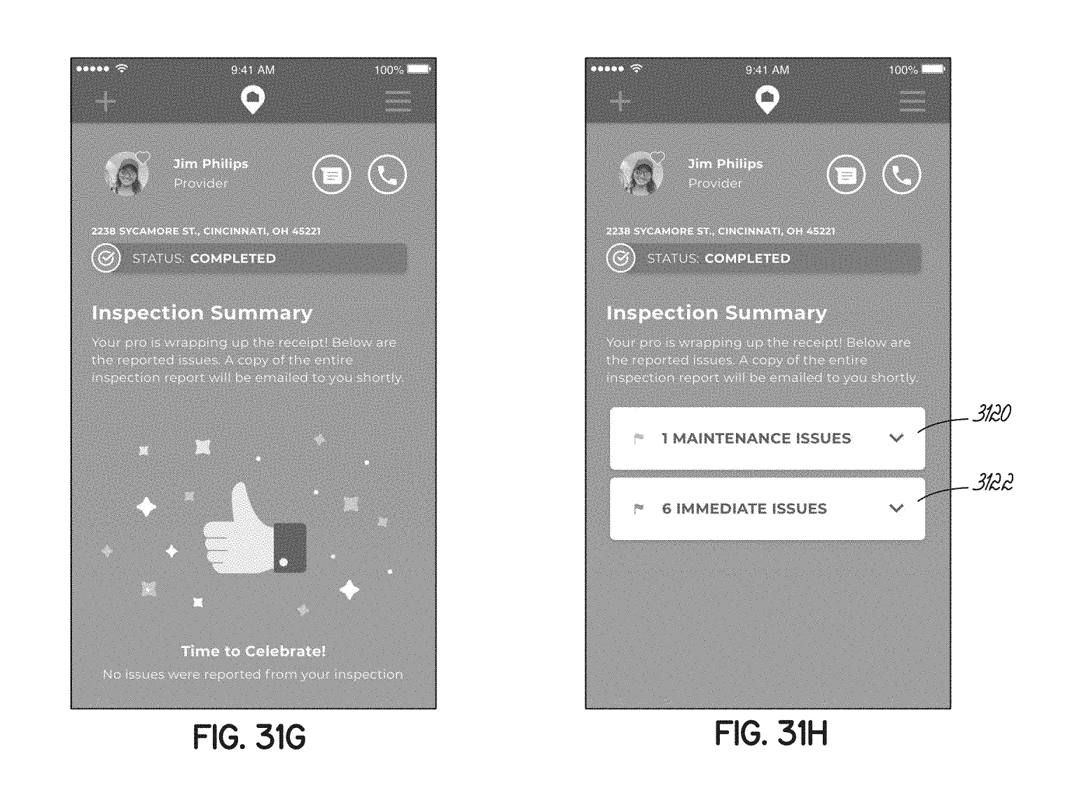

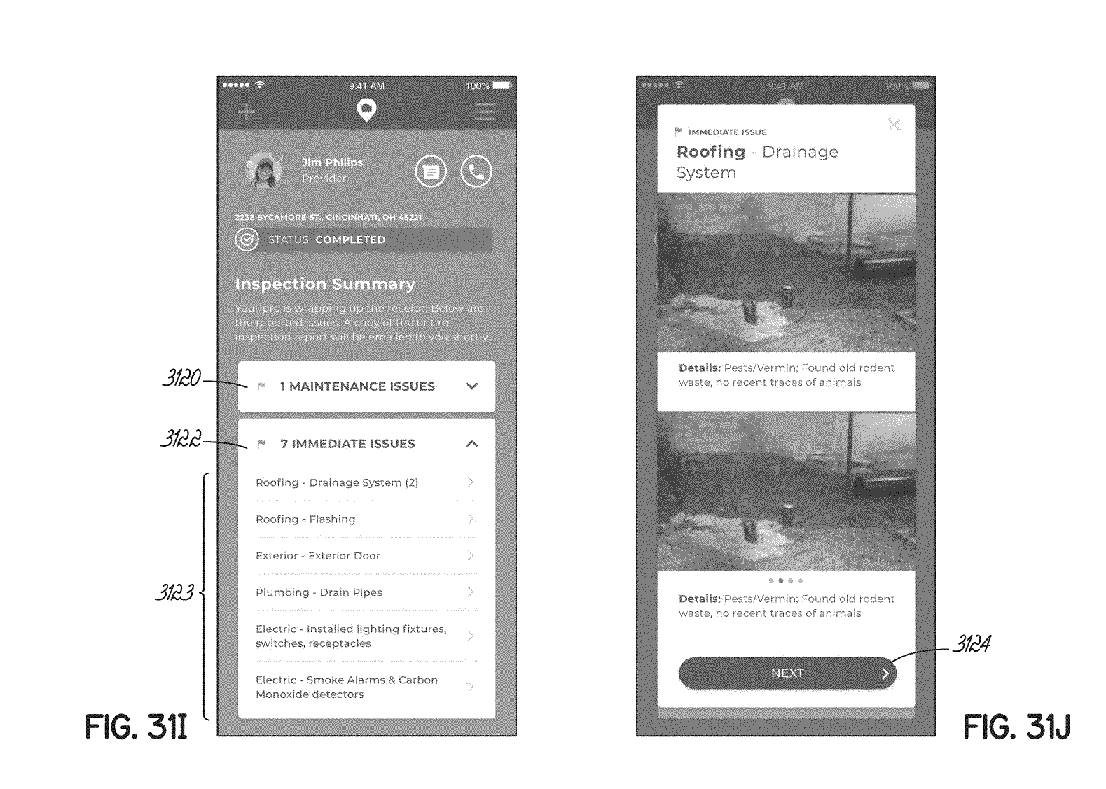

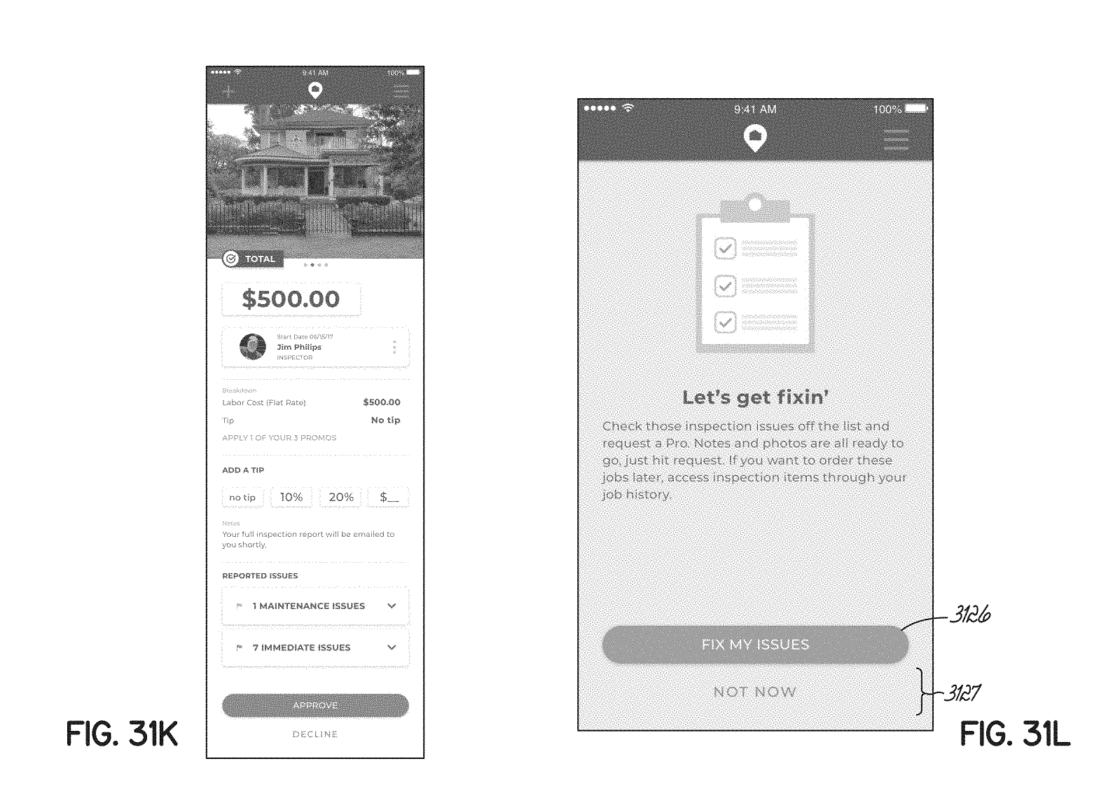

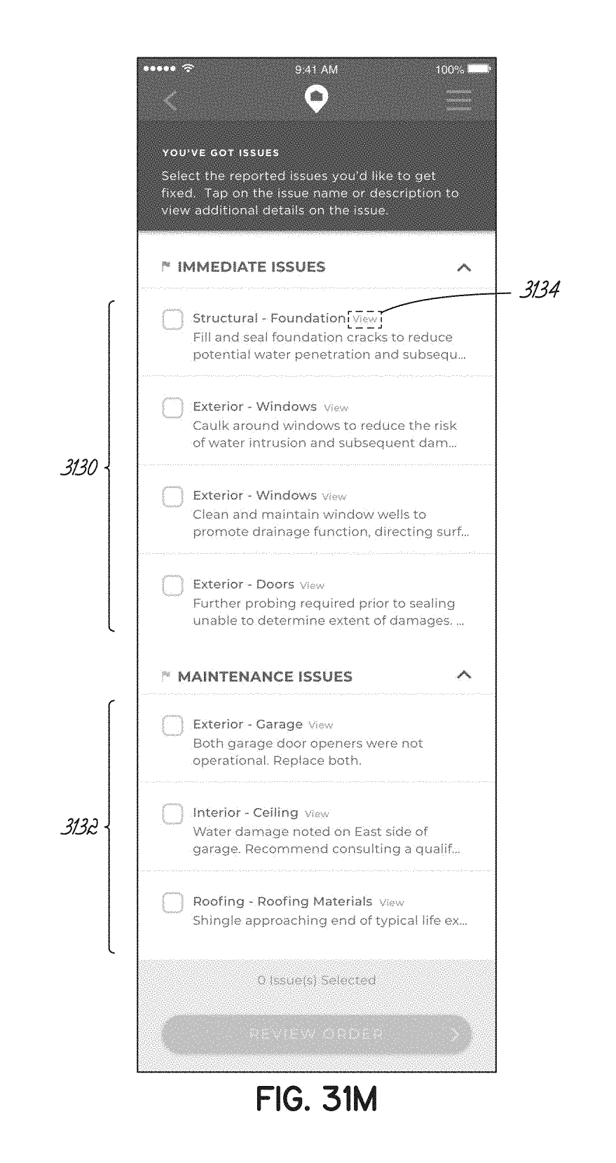

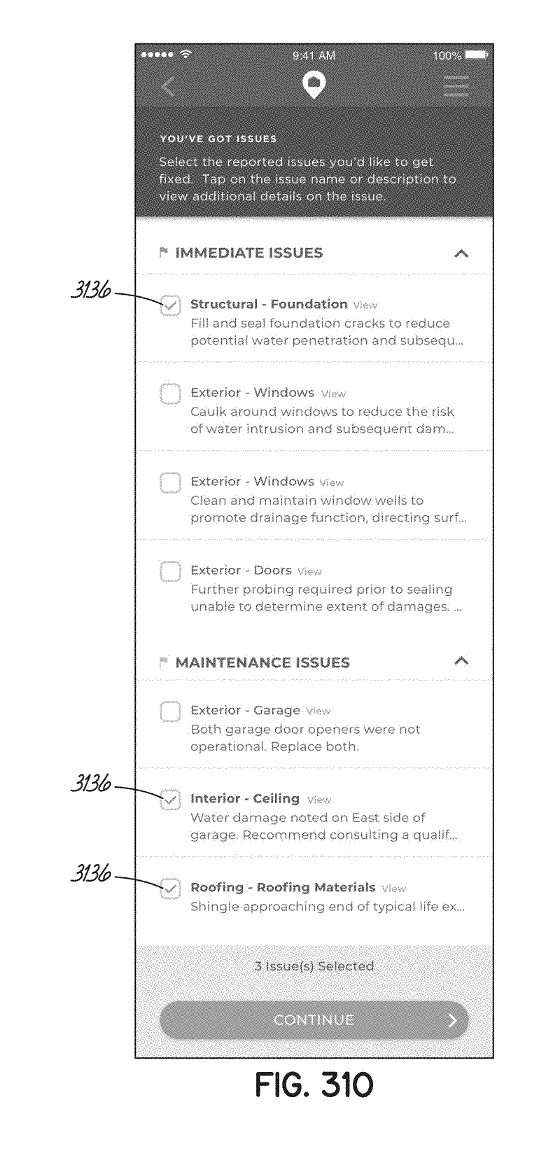

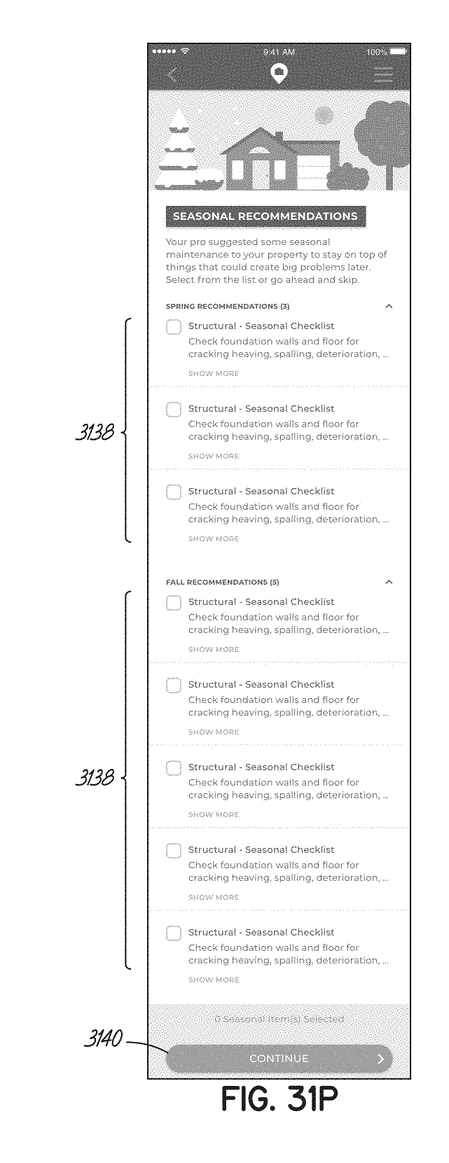

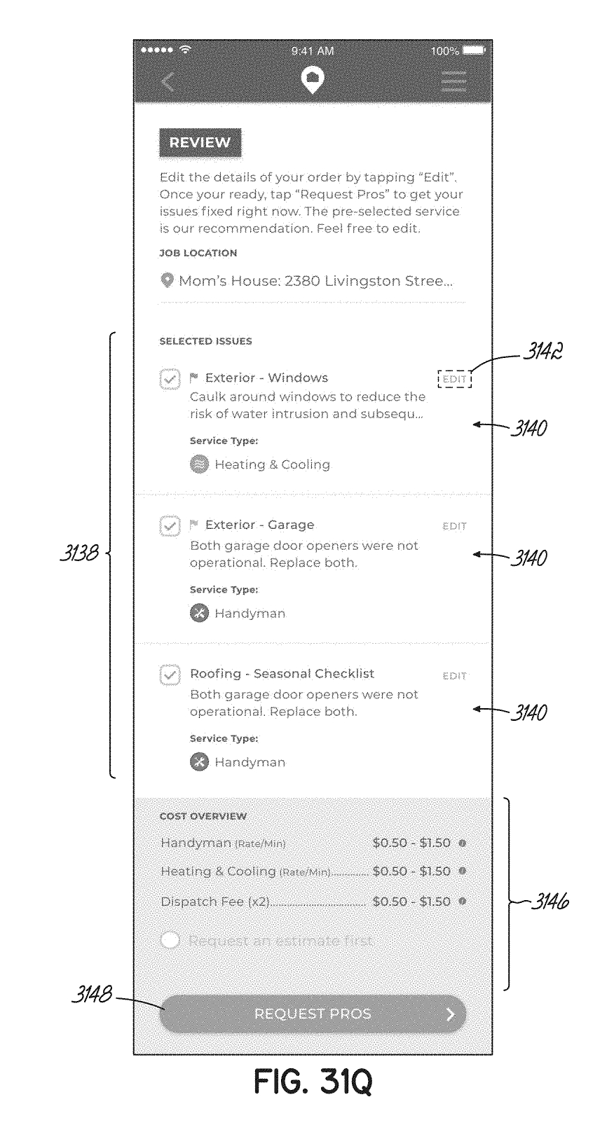

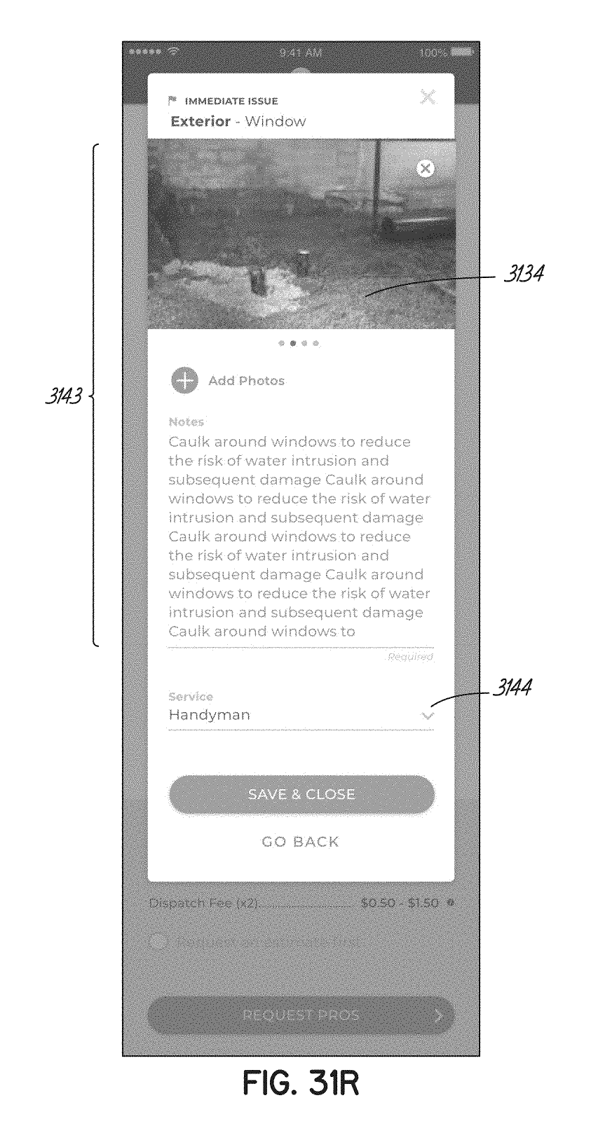

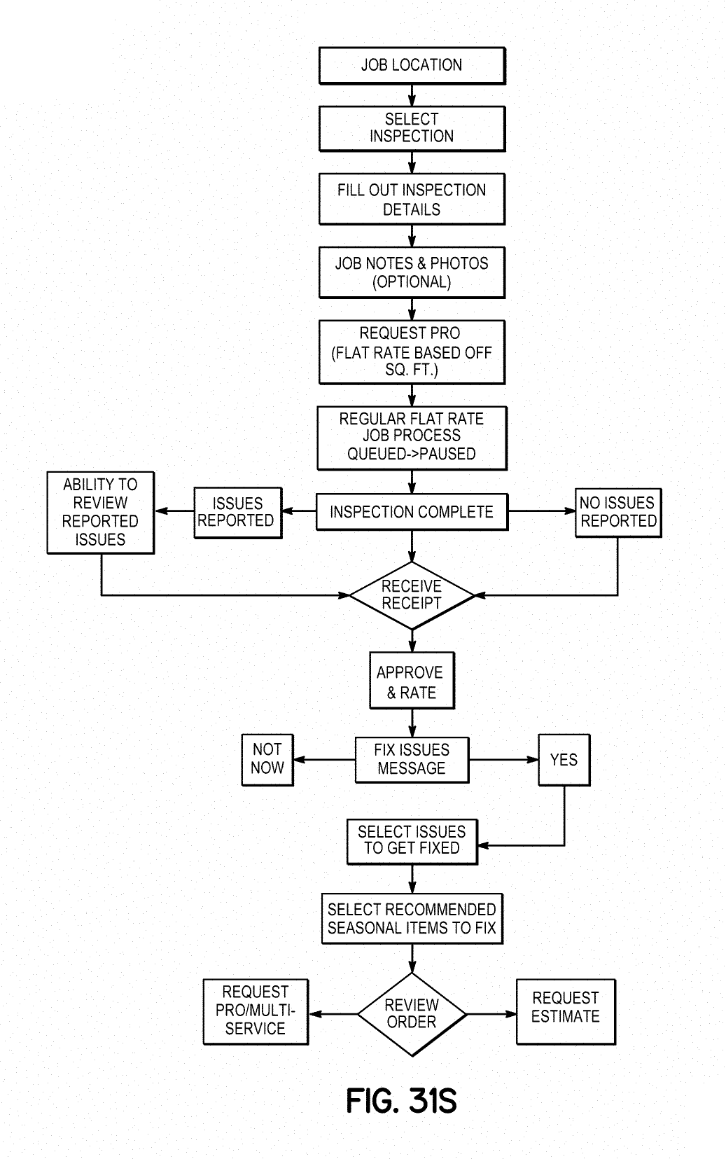

In accordance with another feature of the invention, a property may be inspected and then the inspection used as a path for a specific job request with real time interaction between a service provider and consumer. More specifically, items or issues noted or recognized in an inspection service are then made entry points into another job request. To that end, referring to FIG. 31A, at the beginning of a typical job request when different types of services may be selected, an inspection job might be requested, such as through one or more fields 3100 as shown in the screen of FIG. 31A. Such an inspection may be run as a flat rate job without a timer, which then leads to one or more traditional timer jobs, in accordance with the invention. Upon requesting an inspection, the consumer is presented with information, such as through a pop-up informational screen as shown in FIG. 31B. Information may be entered with respect to the type of inspection as through fields 3102 and information regarding the property may be entered such as through one or more fields 3104. If the property is setup in the system, the informational fields may be populated with data or alternatively, data may be obtained from public records, such as county property records. Upon continuing through the inspection request via fields 3106, additional information, such as through another window, is presented regarding the cost of the inspection service as well as what is included, as illustrated in FIG. 31C. A consumer may further continue through the process to request an inspection job or service and may add additional information for the request, such as through the screen of FIG. 31D, including pictures and notes through appropriate fields 3108 and 3110. Once information has been added, the consumer may then request a service provider and a search will be made under certain job search criteria as discussed herein. For example, information about the property and cost may be provided as illustrated in the screen of FIG. 31E for making a job request, and appropriate fields 3112 provide for the request of the suitable service provider. Other information is also provided as illustrated.

Once an appropriate service provider is matched with the job request, the job can begin. The consumer is presented with an indication that a service provider has been found and matched with the job, as illustrated in the screen of FIG. 31F. The consumer can then engage fields 3114 to accept the cost and begin the job of an inspection. In accordance with aspects of the invention, the service provider travels to the property or job site and begins the inspection, ultimately resulting in the generation of an inspection report as described herein. From the inspection report, there may be issues that need to be addressed or the inspection may be a clean inspection with no issues to be addressed. Upon completion of the inspection, with a clean inspection, the consumer will be provided with that information, such as through a screen as illustrated in FIG. 31G.

Alternatively, the inspection may raise several issues that may need to be addressed. For example, some issues may be maintenance issues per the inspection and others me be issues that require immediate attention. In accordance with one aspect of the invention, such an inspection report or summary that raises one or more issues may provide a platform for requesting services through a job request seamlessly through the program and from within the inspection report or summary.

More specifically, the consumer is notified of issues found in the inspection, such as through the screen in FIG. 31H wherein field 3120 may indicate one or more maintenance issues and field 3122 may indicate one or more immediate issues. Those fields can be engaged as appropriate to expand and present the consumer with information from the inspection report about each of the noted issues. For example, when field 3122 is engaged that has a number of issues, as illustrated in the screen of FIG. 31I, those issues may be listed in an expanded field. Then upon engaging one or more of the subfields 3123 additional information may be displayed regarding the particular issue to be addressed. For example, photos and notes may be displayed to the consumer for an issue as shown in the screen of FIG. 31J. The consumer can scroll through the various photos in the display and make progress through each of the noted issues through an appropriate fields 3124 so that they may see the detail of the issues raised in the inspection summary. Completing a review, a consumer can then approve the completion of the job and the cost aspects like a typical job and the consumer, through the screen as shown in FIG. 31K, approves or declines the job completion. The inspector or other service provider can then be rated.

In accordance with one aspect of the invention, the completion of the inspection process can be utilized as an immediate request for one or more jobs to take care of the issues that were noted in the inspection summary or report. To that end, the consumer may start a job request and is presented with a selectable field, such as through the screen of FIG. 31L to make job requests for one or more of the noted issues by engaging the field 3126. Alternatively, the consumer can also decide to not proceed immediately with addressing the issues, such as through field 3127. In that case, the consumer would return to their home screen and can request jobs as they deem necessary.

Engaging fields 3126 provides the consumer with a selectable list of issues to be addressed, such as through a job request. Referring to FIG. 31M, the consumer who desires to fix the issues immediately is presented with a number of selectable fields 3130 and 3132. In the disclosed example, some issues are indicated as immediate and others are considered to be maintenance issues, but other categories might also be utilized for noting the issues to be addressed and to provide a platform for an immediate job request. Information, such as photos and notes from the inspection report may be obtained by the consumer, such as through engagement with one or more of the fields 3134 for each of the noted issues. The consumer is then presented with such information and may scroll through each of the issues through appropriate pop-up windows as presented in FIG. 31N. Certain of the issues may be selected such as by checking appropriate fields 3136 as shown in FIG. 31O in order to begin the job request process of the invention. The issues are presented through sequential screens. Furthermore, in accordance with another aspect of the invention, other seasonal issues may be presented that were not from a particular inspection process but are suggested, such as through fields 3138 of FIG. 31P. In that way, additional issues unrelated to the inspection report may be utilized for initiating a job request in accordance with the invention. The consumer may scroll through the various issues, such as through fields 3140 and then upon completion may select one or more of the issues to be addressed through a job request. To that end, once one or more issues are selected as shown in FIG. 31Q, service providers may be requested in the invention.

To expedite a job request, each of the selected issues may have a service type indicated for the consumer. Referring to FIG. 31Q, the information is displayed to the consumer with fields 3140 that indicate a type of service that may be associated with the particular issue. The consumer can edit each of the issues through fields 3142 and may add photos and notes through an appropriate interface as illustrated in FIG. 31R that has engageable fields 3143 for adding notes and photos. Through fields 3144 the service type might also be changed as appropriate before making a job request for a particular issue. Once all of the issues have been selected and appropriately edited as desired by the consumer, the consumer can make a job request. Referring again to FIG. 31Q, information might be presented through fields 3146 for the consumer to see the types of rates associated with the services to be requested. Then, through engagement with appropriate fields 3148 one or more service providers can be requested. The search will then proceed as disclosed herein to find an appropriate service provider for each job request.

FIG. 31S provides a flowchart of the program flow of the invention for the inspection process through the consumer application illustrating both the selection of an inspection as well as utilizing the inspection information as a platform for requesting service in accordance with the invention to address one or more of the issues raised in the inspection report. Once an inspection job has been instigated, various providers are contacted as described herein.

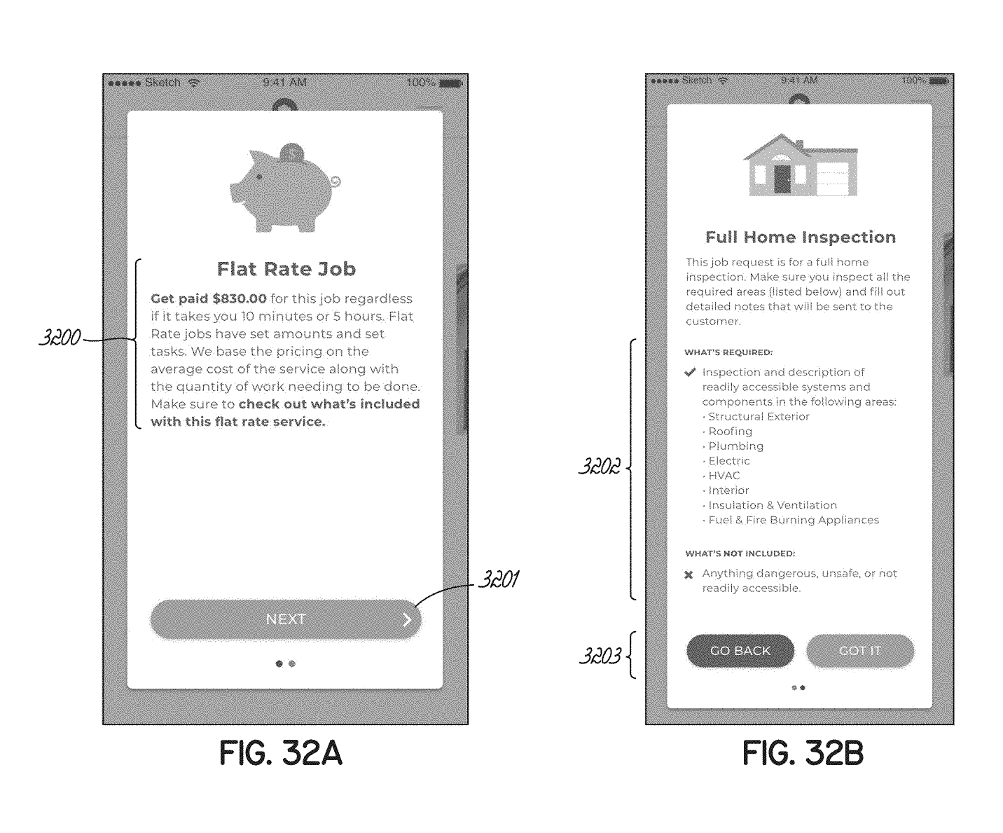

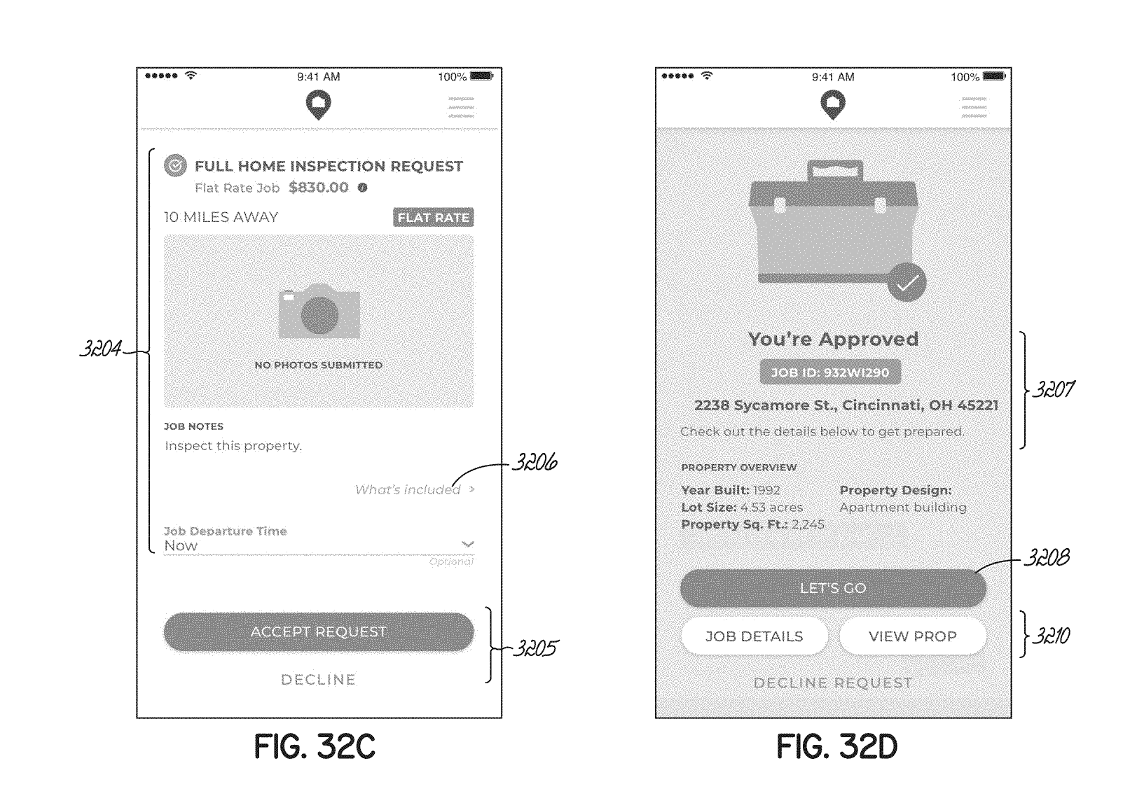

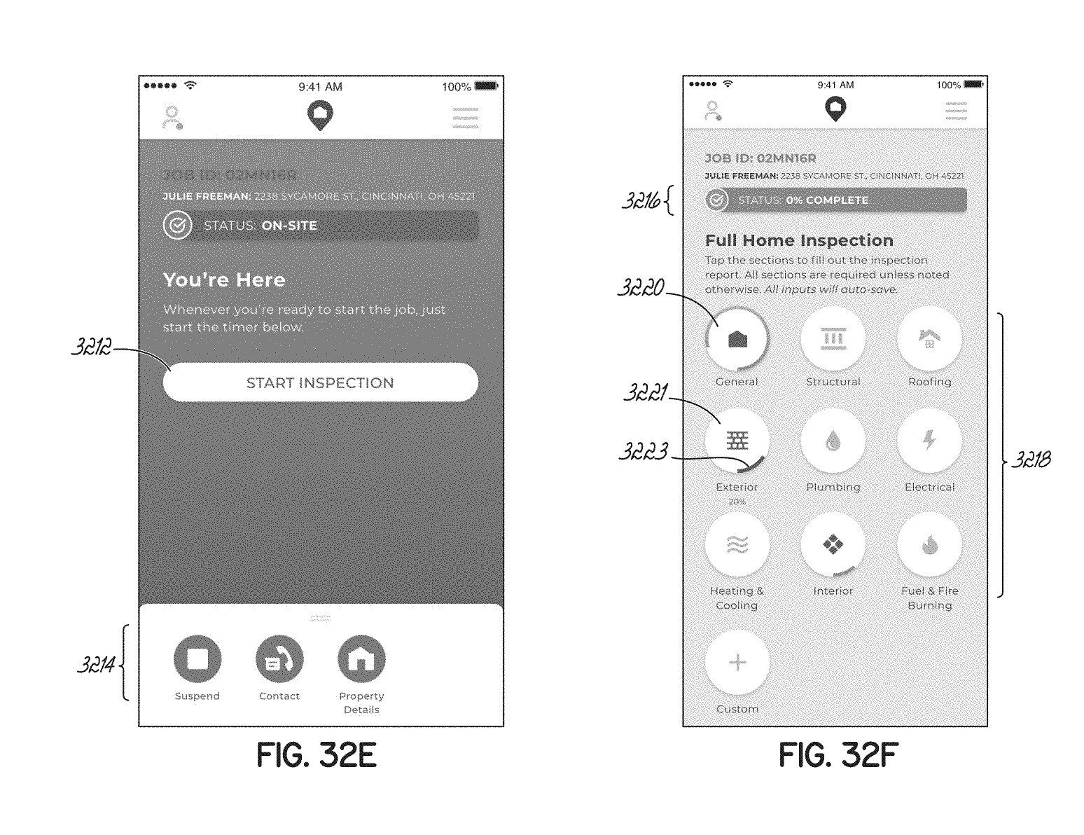

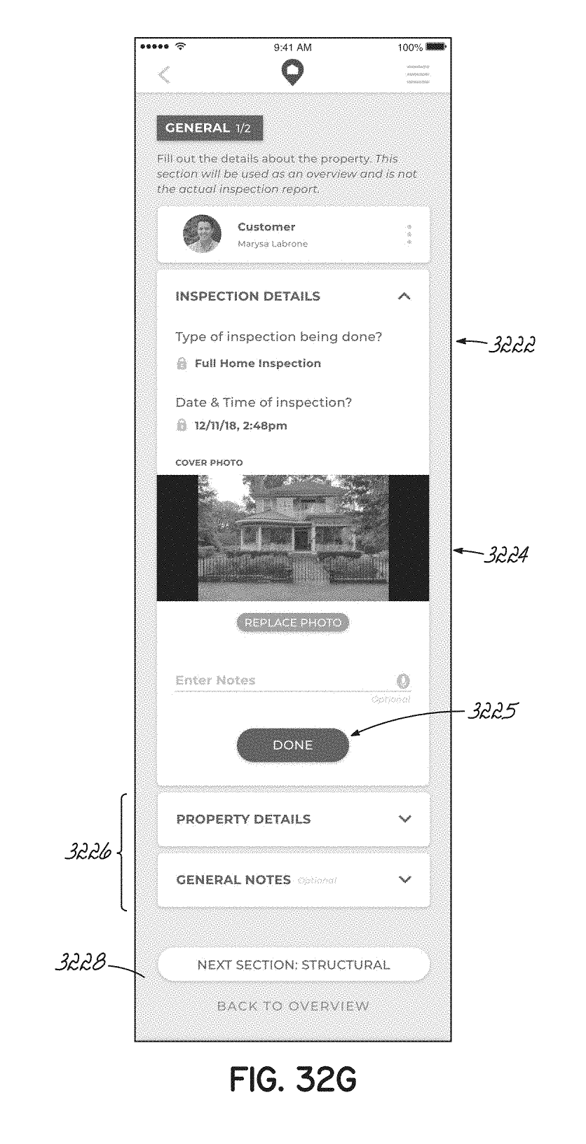

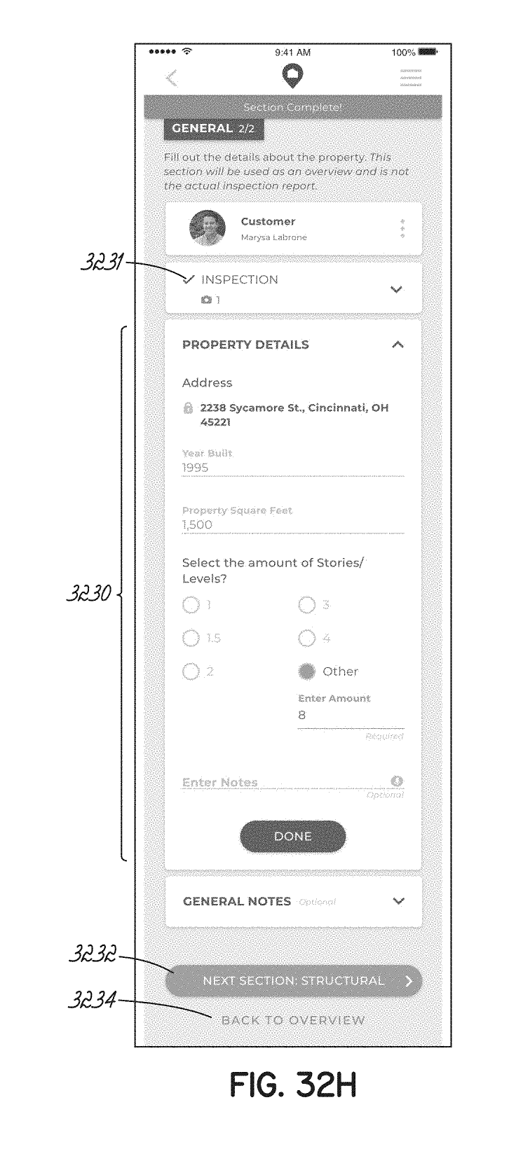

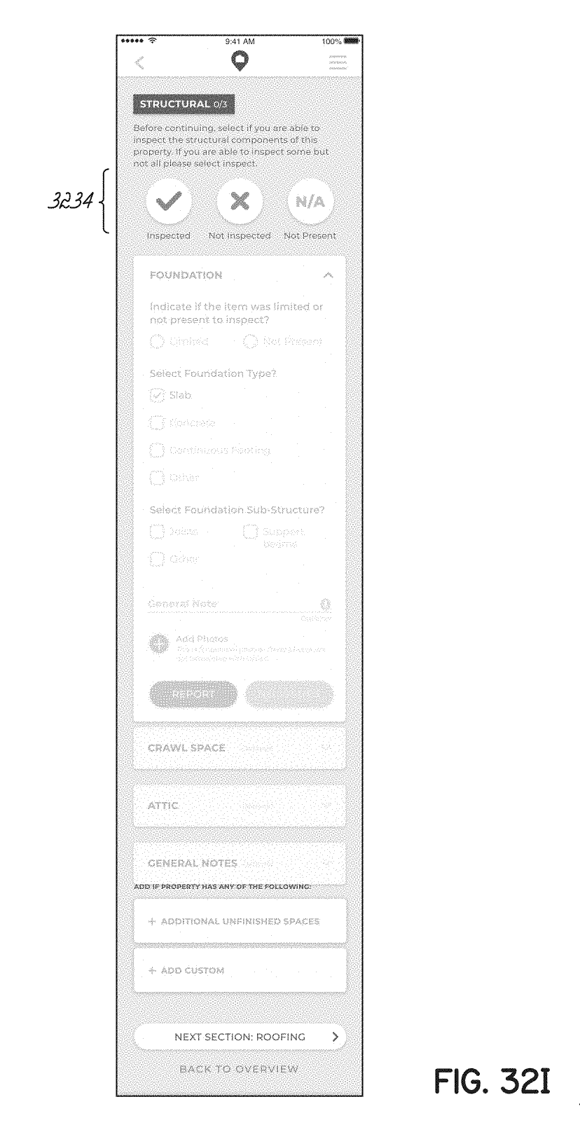

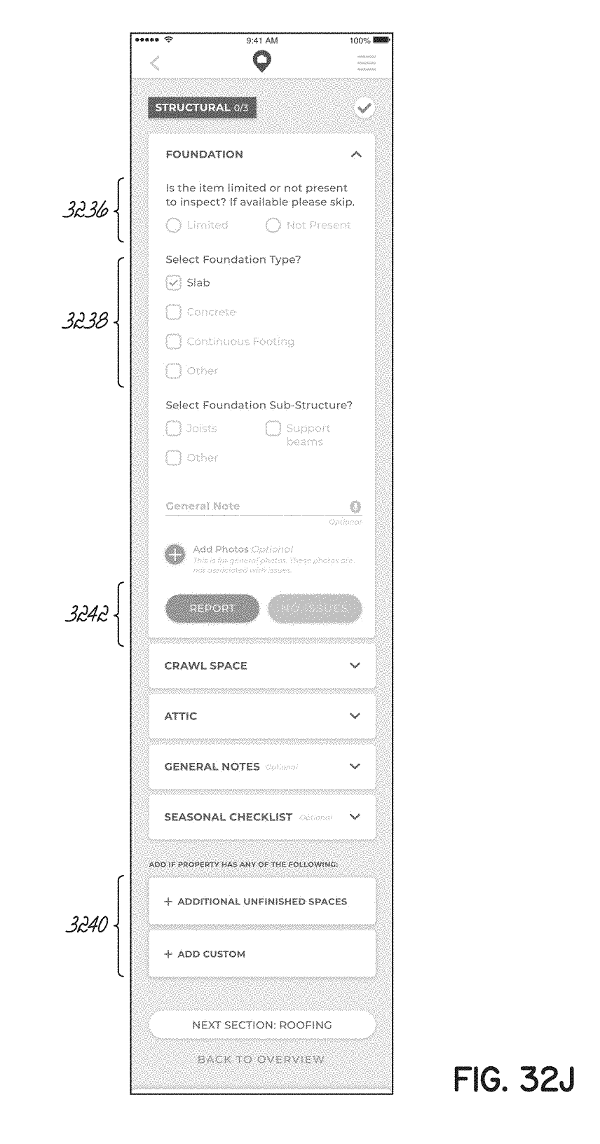

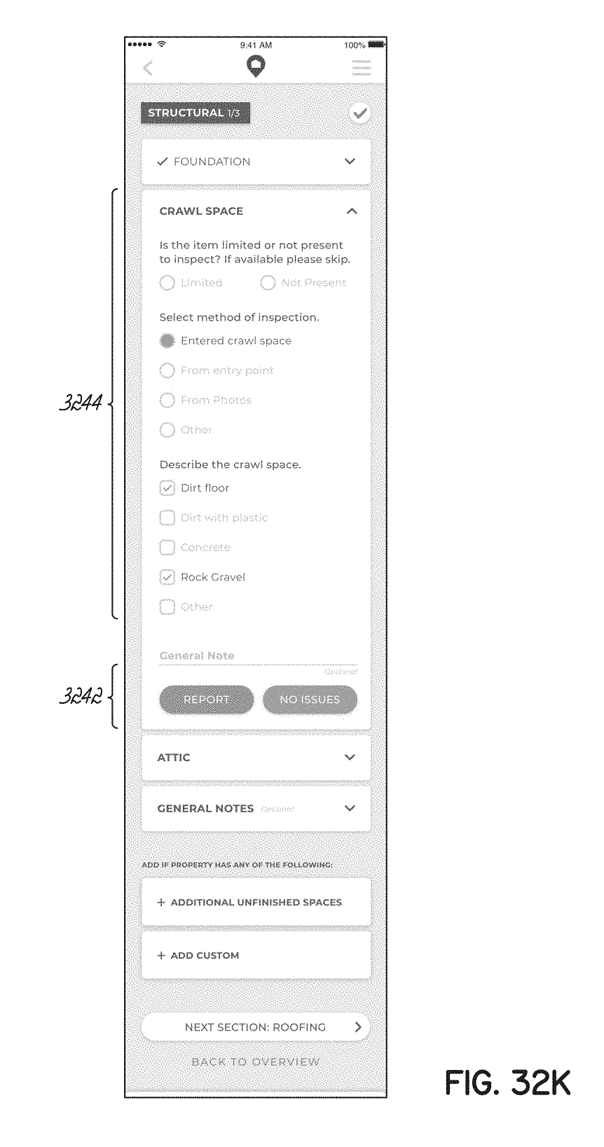

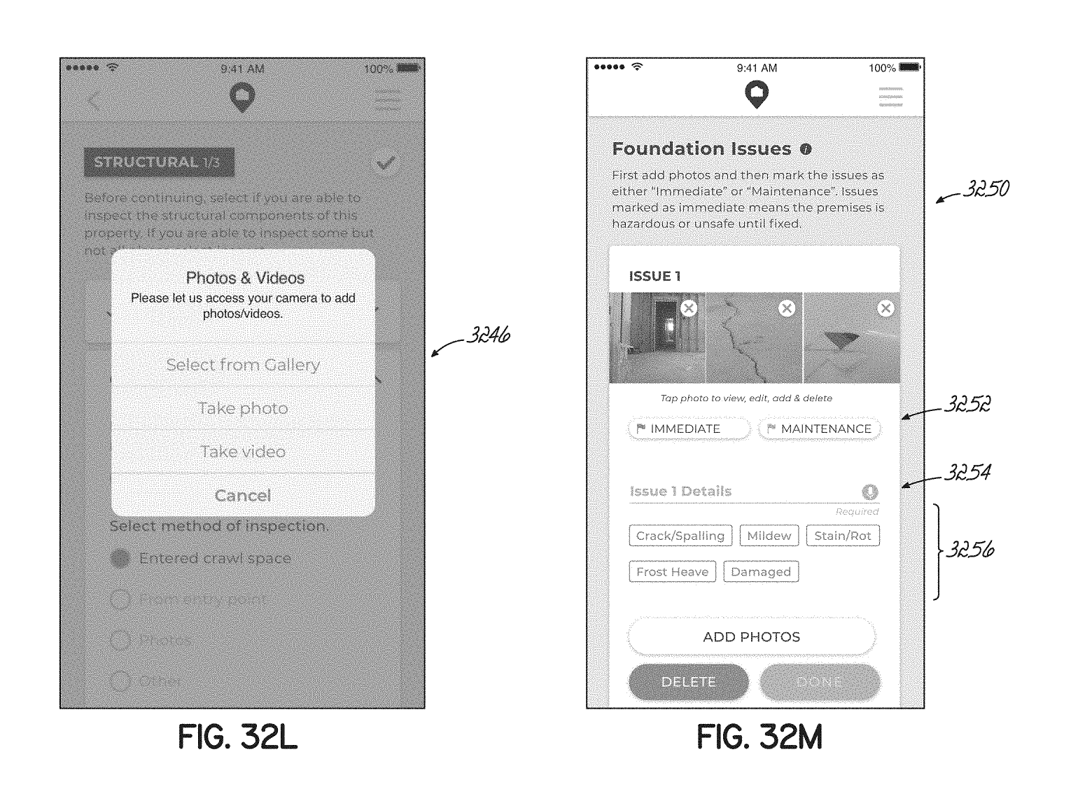

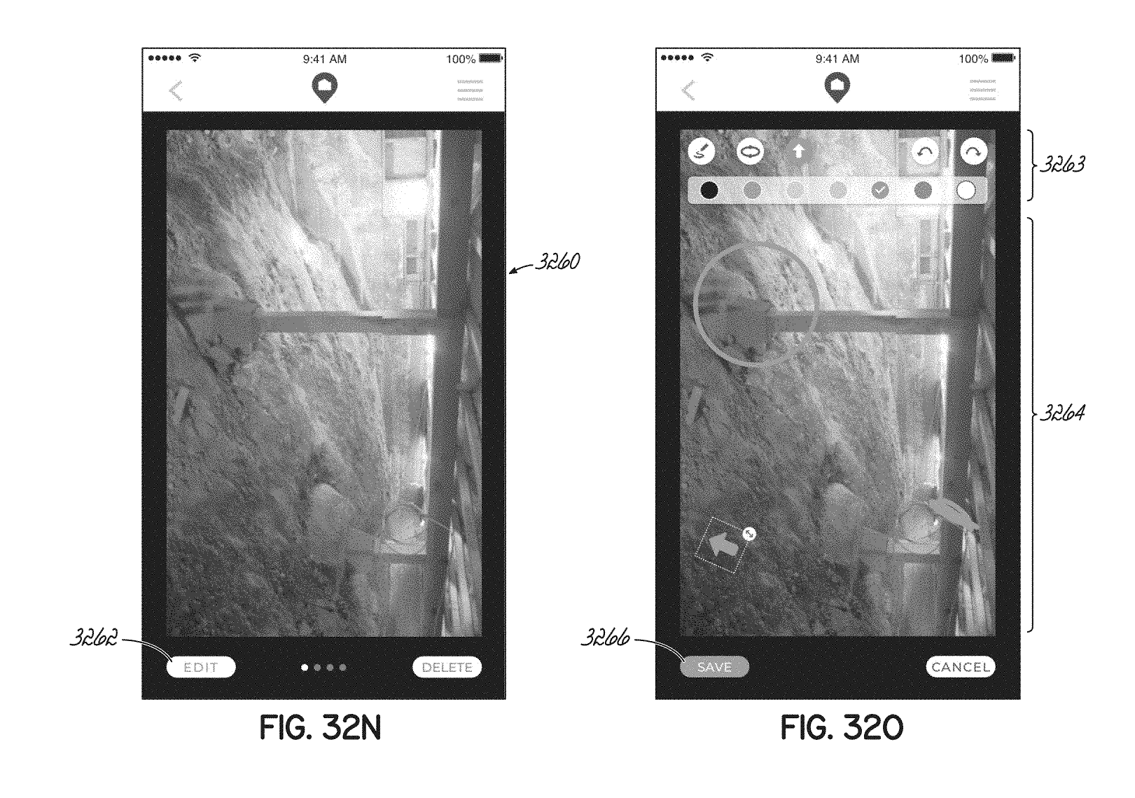

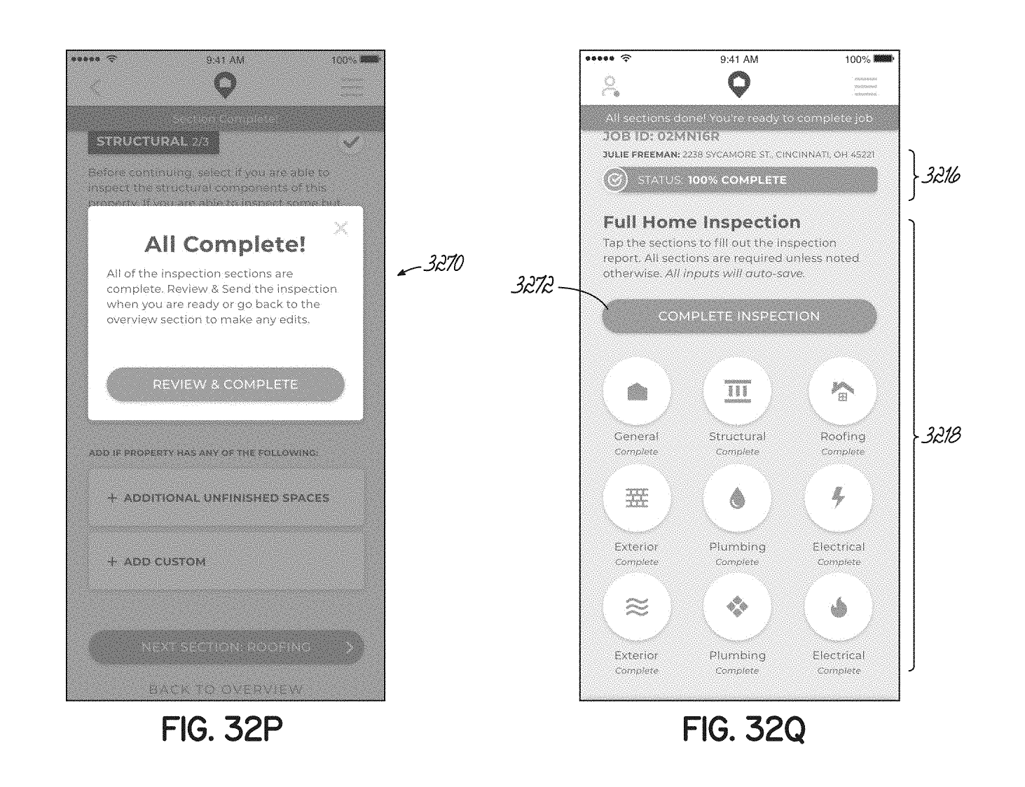

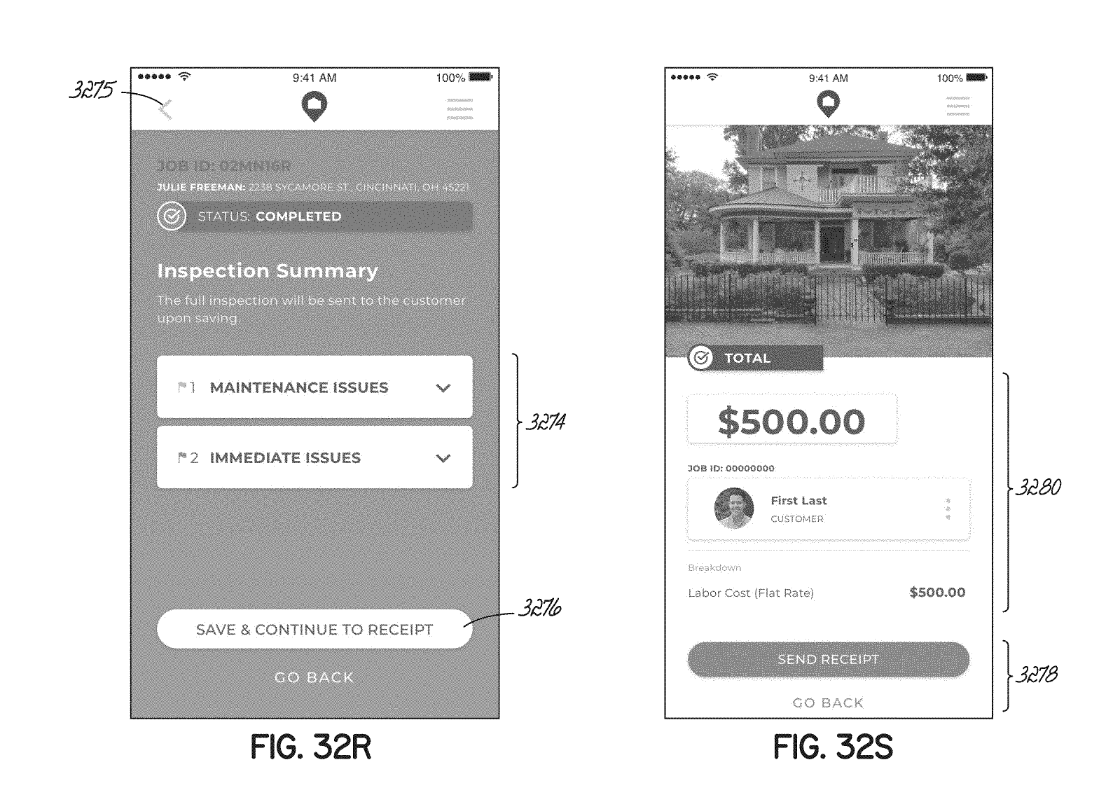

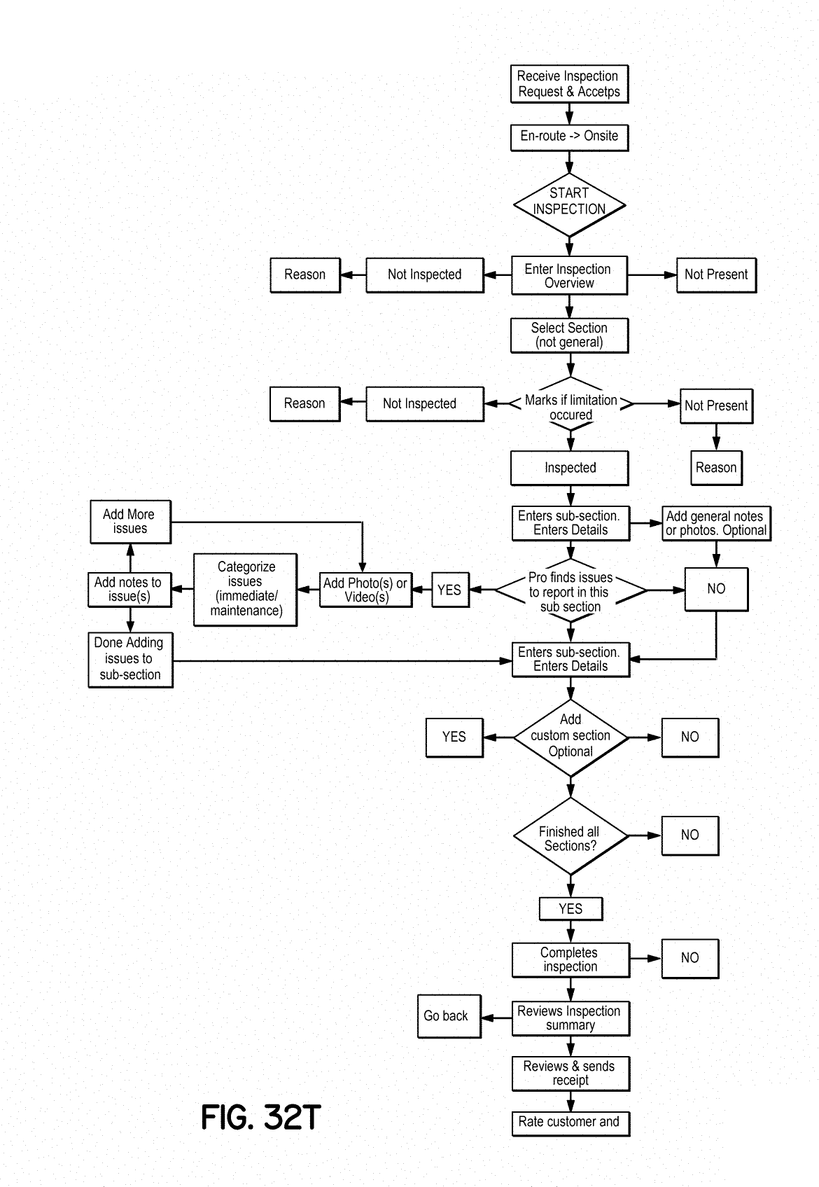

Generally, an inspection job will be done at a flat rate rather than according to a timer as in other jobs in accordance with the invention. The service provider is instructed of such a flat rate feature, such as through the screen of FIG. 32A, and field 3200 indicates the nature of the job and the rate. If that is suitable, the service provider is then given information regarding what is required in the job and what would not be included so that they are clear as to what the inspection entails. To that end, the provider may be presented with information through fields 3202 as shown in the screen of FIG. 32B. If such information is suitable, the provider can then go back or proceed through to fields 3203 and will then be presented with additional information about the job, such as the location, any notes and photos associated with the job from the consumer and any other appropriate information. Such information will be presented to the service provider such as through the screen of FIG. 32C where they can then accept or decline the job request such as through fields 3205. If the service provider still wants additional information with respect to the inspection job, they can engage the program appropriately for additional information, such as through fields 3206.

In accordance with one aspect the invention, the additional information might include requirements from the American Society of Home Inspectors (ASHI). If the information is suitable, the service provider can accept the request, and then once approved by the consumer, will be notified of additional information regarding the job along with the approval, such as through fields 3207 as illustrated in the screen of FIG. 32D. The provider can then proceed to the job, such as through engagement with fields 3208 or may get additional information about the inspection job as well as the property through one or more fields 3210. As noted herein, if the service provider proceeds with the job, they will then proceed to navigate to the job site and their progress is indicated to the consumer, and upon arrival they can start the inspection. For example, upon arrival, the service provider may be presented with the screen of FIG. 32E presenting fields 3212 for starting the inspection and other fields 3214 to otherwise dispose of the job, such as to suspended it, contact the property owner or consumer or obtain additional property details as desired.

Once the inspection begins, the service provider is presented with an inspection overview and may select individual sections for entering or providing information with respect to that aspect of the inspection process. For example, the provider may be presented with the screen of FIG. 32F having a number of different section fields 3218 for providing information associated with the inspection. The inspection fields may include a general fields 3224 for entering basic information about the inspection. Also, fields 3216 may present an indication of how much of the inspection is complete so that the provider can track how far along the job has progressed and when they are finished. Also, each of the section indicators may have “clock face” notations indicating how far along a section inspection has progressed. Different inspection sections are presented associated with different portions of a property, such as the structure, the roof, plumbing, electrical, heating/cooling, etc. Of course, the invention is not limited to the number of sections or the arrangement thereof for the inspection job request.

For providing general information, the provider is presented with appropriate screens and fields for entering data associated with that section. For example, referring to the screen of FIGS. 32G, fields 3222 and 3224 are provided for entering details about the inspection being done as well as one or more photos associated with property. Additionally, other property details or general notes might be provided through drop-down fields 3226. Certain information may be required and upon entering all the necessary information and other information, the provider may be presented with fields 3225 for closing the screen and proceeding onto other sections of inspection, such as through fields 3228 as illustrated. In that way, the provider can progress through various sections and indicate inspection details or also indicate that a certain section of the property was inspected or not inspected as discussed herein.

For example, property details may need to be entered and appropriate fields 3230 are provided to the service provider, such as through the screen of FIG. 32H wherein the program will capture entered information for use in an inspection report provided to the consumer as discussed herein. Through other fields 3232 and 3234, the service provider can progress back and forth through the inspection sections providing the necessary details of the inspection. Based upon information regarding the property that has been entered as noted in the application, certain of the property detail fields may be prefilled and can be edited as necessary by the service provider. Once certain sections are complete, they might be indicated as such by one or more icons, such as a checkmark 3231 as illustrated in the screen of FIG. 32H. As noted herein, there may be necessary information that must be filled in and therefore fields such as 3232 may not be selectable until all the required information has been entered in accordance with one aspect the invention.

When all of the various information has been presented for a particular section and for the subsections, the service provider can indicate that they are done with that section and in the overall fields it might be presented differently to indicate that the section has been completed. For example, as illustrated in the screen of FIG. 32F, in the fields 3218, the subfield for general information 3220 might be indicated as complete such as with a different color and also without the “clock face” indication that the section has not been completed. As illustrated in fields 3221 for the exterior of the property, an indication 3223 might provide a quick visual indication for a service provider that the section is only partially completed. As illustrated in the screen of FIG. 32F, other of the fields 3218 might also indicate their partial completeness to give a service provider an overall view of how the inspection is progressing and where to turn additional attention.

Accordingly, different sessions are presented to the service provider and manipulated as data is entered. In accordance with one aspect of the invention, the service provider is able to indicate that a certain section has been inspected or not inspected or is not part of the property. For example, there may be screens presented with respect to each of the sections for capturing data as illustrated in the screen of FIG. 32I and appropriate fields 3234 might be utilized for the service provider to indicate the status of that inspected section, such as whether it was inspected, not inspected, or not present. Such an indication may be required for each section. If a section is inspected, additional screens and interfaces are presented for gathering data. For example, some of that data might only give limited selectability, such as a single entry as illustrated in the fields 3236 in the screen of FIG. 32J. Alternatively, other sections may allow multiple selections, such as the fields 3238 as illustrated. The present invention allows the inspector or service provider to progress through the various sections. Furthermore, the inspector can add additional spaces or add custom spaces associated with the inspection in addition to any that are preset, such as illustrated in the screen of FIG. 32F. Furthermore, in accordance with another aspect the invention, the service provider is given the ability to report issues associated with the inspection of a particular section, such as through fields 3242 as discussed further herein. In accordance with one particular aspect of the invention, the reporting of an issue that must be addressed provides a path for a specific job request in accordance with the invention that occurs in response to the reported issue. Within a particular section, when the provider finds an issue and reports it within the section or subsection of an inspection process, they can add information including photos, a video and/or various notes, and can also categorize the type of issue that it is, such as whether it is an issue that needs immediate attention and should therefore lead to a job request or is one that is a maintenance issue. One or more issues can be added with each section or subsection of the inspection process and therefore there may be various job requests that occur out of certain sections in accordance with the invention.

Turning to the screen of FIG. 32K for example, various fields 3244 may be presented to a service provider for entering the data associate with that inspection. Also, through fields 3242, the inspector can report an issue or indicate that no issues are associated with that section or subsection of the inspection. As noted, in accordance with one feature of the invention, such reported issues provide a path for a specific job request associated with the issue in accordance with the invention.

For example, referring to FIG. 32M a screen is provided for noting an issue to report. One or more photos might be taken as shown in field 3250. Also, the issue might be designated as an immediate issue or a maintenance issue, for example, through fields 3252. Also, issue details might be added, such as through field 3254. These might also be pre-selected notes/details to add, such as through field 3256.

Once an issue is reported, the service provider is presented with one or more screens and fields for entering visual images, such as photos and videos as well as notes. For example, the screen of FIG. 32L might be presented with fields 3246 to be selected for adding photos and video. Such photos and video can be added as described herein for other portions of the application. However, in the inspection process, the program provides an additional ability to annotate and otherwise mark photos. For example, the screen of FIG. 32N might be presented with a functional menu for working on a photo as appropriate either with a pen, with geometric shapes, such as circles, and also with icons, such as an aerial for indicating to the inspector as well as the consumer where issues may lie with respect to that section of the property or structure. Referring to the screen of FIG. 32N, fields 3262 may allow editing and the selection of the annotation functions. Once a photo is to be edited, as illustrated in interface of the screen of FIG. 32D and the figure field 3263, certain indications may be provided in a photo, for example. Using the marking and annotation tools of field 3263, the photo field 3264 may be marked up and annotated. Once that is complete, the photo can be saved through appropriate fields 3266 and will be part of an inspection report for the consumer as discussed herein. In that way, the consumer can use the reported issues in the inspection report as discussed herein in order to request certain jobs to address those issues. Once the service provider is finished with all of the sections they are given the chance to review and complete the inspection process, such as through appropriate fields 3270 as illustrated in the screen of FIG. 32P. To further review and edit or enter additional details, the fields 3270 might be appropriately closed such as by engaging the field and then the service provider may be again presented with the screen showing the different inspection sections and fields 3218 as illustrated in the screen of FIG. 32Q. Fields 3218 may be engaged for adding to or editing information in those sections of the inspection report. Once the inspection is complete, that status is indicated, such as through fields 3216 and the service provider is then able to complete the inspection process, such as through engagement with fields 3272.

In accordance with another feature of the invention, an inspection summary is presented to the service provider that indicates the various issues noted, such as immediate issues to address or maintenance issues. Those issues can be reviewed similarly to the way in which information in those sections of the inspection report. Once the inspection is complete, that status is indicated, such as through fields 3216 and the service provider is then able to complete the inspection process, such as through engagement with field 3272.

In accordance with another feature of the invention, an inspection summary is presented to the service provider that indicates the various issues noted, such as immediate issues to address or maintenance issues. Those issues can be reviewed similarly to the way in which the consumer reviews such issues inspection report. For example, it is illustrated in the screen in FIG. 32R presented to a service provider, fields 3274 might be engaged to see the issues and the detail associated with those issues and the section of the inspection report. The inspector also has the ability to go back and edit the inspection report further and appropriate fields, such as field 3275, may be presented to allow access to the inspection report for changes and edits. If the inspection summary is suitable, the service provider can continue to a receipt and to a finalized job, such as through appropriate fields 3276. Upon completion, information may be presented to the service provider, such as the rate as well as information about the consumer as shown in the screen of FIG. 32S and fields 3280. The service provider can then dispose of the inspection job by sending that receipt or going back to further engage in the inspection process as illustrated by appropriate fields 3278. That job completion might then wait for approval from the consumer and an appropriate rating of job as described herein in the completion of a job.

The function of the inspection process as described herein, and the flow of the invention is further illustrated in the flowchart of FIG. 32Q showing the process flow and functionality provided by the provider application associated with an inspection job or inspection process.

### Job Queue

In accordance with another aspect of the invention, as discussed herein, if a service provider is currently working at a job, such as on a timer, and then gets a job request for another job, they can accept the job request for the future and put it into a queue and continue to work on the current job. If the current job has been completed, they will be notified that they have one or more queued jobs that they might then select. In such a scenario, a service provider makes the decision to queue the job and the consumer is then notified that the job is queued. They can then decide if they want to have their job queued or if they would like to have a service provider immediately answer the job request or move on to another provider. If the consumer is content with having the job(s) queued, they can indicate that to the provider and wait or they can simply cancel the job and proceed with a search for another provider. As noted, once a provider completes their current job, they can take up one or more of the queued jobs at their control. Referring now to FIG. 33A, if a service provider indicates that they would like to queue the job, the consumer is notified, such as through an appropriate field 3300, as illustrated in FIG. 33A. The consumer is then given the chance to accept the queued job or rather accept the provider's desire to queue the job. To that end, the consumer is presented with information about the provider, such as their location and fees associated with their work, such as through an informational screen, as illustrated in FIG. 33B. Therein, information about the provider 3302 is presented and the consumer can accept that information and queue the job through field 3304 or cancel the job request through field 3305. Once queued, the job request will show up as a queued job within the consumer's job section. For example, as illustrated in FIG. 33C, the job might be indicated and its status through the display of field 3306 as illustrated in FIG. 33C.

With a queued job, the provider is able to proceed with their current time job. More specifically, the provider may be in progress with a job and presented with the timer screen 3400 as illustrated in FIG. 34A. Upon receiving another job request, they are informed such as through an informational field 3402, as illustrated in FIG. 34B. If they are not interested in taking any more jobs, they can decline through field 3405 or they can view details of the job before making the decision, such as through field 3404. If details are desired by the provider, they can request them and thereby may be shown pictures and notes associated with the job request 3406 as illustrated in FIG. 34C. Again, at that point, they can accept the job request through field 3408 or may decline through field 3410. If the service provider accepts, the consumer will be notified that the job would be queued as described herein and the provider may need to be further approved for that queued job. For example, the provider might be presented with a screen, such as illustrated in FIG. 9L, indicating that they are waiting for some approval.

Once the service provider has been approved or confirmed, they are notified, and the job is put into a queue. For example, the provider is presented with information 3412, such as through the screen of FIG. 34D, regarding the queued job. They can then also review their current jobs through field 3414 and the queued job, along with any jobs in progress or other jobs are presented to the service provider. For example, as illustrated screen of FIG. 34E, a list of jobs 3415 is shown to the provider with an indication of the job in progress 3416, as well as, any queued jobs 3418.

The service provider can then return to their current time job to finish that job as illustrated in the timer screen 3420 as shown in FIG. 34F. The current job can then proceed as noted herein, to be paused or completed with the appropriate pictures and notes and the sending of a receipt and approval and rating as discussed herein. Once the current job has been completed, the provider is notified that they have one or more queued jobs. For example, the information field 3422 is presented to the service provider and indicates that queued jobs exist, and the service provider can view those jobs through field 3426 or go back to their home screen 3424 as illustrated in the screen of FIG. 34G. Viewing the current jobs, as shown in FIG. 34E, the provider is presented with the additional information associated with the queued job, such as through field 3418. Information regarding the queued job is presented to the provider, such as through field 3430 of the screen of FIG. 34H. The provider can then see additional job details or view the property, such as through appropriate fields 3432. Alternatively, they could go right to the queued job, such as through field 3434, or may cancel the job, such as through field 3436. Selecting the queued job, the provider will then progress to the job site through a normal workflow as described herein. Similarly, the queued job could be canceled as described herein.

In some scenarios, access to the property may be necessary. For example, for in-house service providers that may do work for tenants or other residents, the service provider may have to obtain access before proceeding to the job. To that end, for providers that are in a customer's in-house network, they may need to contact the resident. They are presented with various options, such as through the informational field 3438 of FIG. 34I. Therein, through engagement with field 3442, the provider may call the resident. If they already have access, they can indicate that through field 3444 and then proceed to the job. In various different scenarios, the service provider may have access to all the various units or properties where they would answer job requests. As such, the provider may be presented with the ability to not see the message of informational field 3438 anymore as a reminder. Accordingly, through engagement with field 3440 the message content may be toggled on and off. After indicating that they have access or after calling a resident, the job can proceed in a normal fashion wherein the service provider navigates to the jobsite or property.

FIG. 34J illustrates the described program flow of the job queuing feature of the invention for allowing busy providers to continue to accept additional jobs that can be handled in the future, such as sequentially after they complete their current job.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of applicant's general inventive concept.

What is claimed is:

1. A method for the on-demand provision of a property service job through a computing system with at least one processor and interfacing with a plurality of devices, the method comprising:
maintaining a plurality of profiles for service providers that provide property services;
capturing, through the computing system, a consumer job request from a device of a consumer for a job at a jobsite;
generating a plurality of provider job requests for the service providers, a job request being associated with the job and job site associated with the consumer;
directing job requests to devices of a plurality of service providers in a sequential fashion controlled by provider criteria;
receiving, an acceptance of the job request from a device of at least one service provider;
upon acceptance of the job request by the at least one provider device, evaluating a location of the at least one service provider device with respect to the job site; generating a timer that is associated with the job, the timer configured for being started and stopped with the device of the service provider;
obtaining approval from the consumer for the start of a timer through the consumer device;
monitoring a subsequent progression of the timer associated with the job.

2. The method of claim 1 further comprising evaluating a stop of the timer by a provider and upon a requested restart of the timer by a provider, communicating information of the restart of the timer to the consumer for obtaining approval from the consumer before a restart of the timer.

3. The method of claim 1 further comprising determining, at a stop of the timer, the status of the job, the status of the job including at least one of paused, suspended or finished.

4. The method of claim 1 further comprising directing job requests in a sequential fashion using provider criteria including at least one of the location of the provider with respect to the job site, the favorite status of the provider, service type of the job, the years of experience of a provider, the trade licensing of a provider, the work status of a provider.

5. The method of claim further comprising directing job requests to devices of a plurality of service providers in a sequential fashion including directing job requests based on one set of provider criteria for a first duration and based on another set of provider criteria for another duration.

6. The method of claim 1 further comprising upon determination, at a stop of the timer, that the job has a finished status, obtaining additional job information from the provider through the provider device.

7. The method of claim 6 wherein additional job information from the provider include pre-job information and post-job information.

8. The method of claim 6 further comprising determining a charge to the consumer for the job based upon the timer associated with the job and the additional job information.

9. The method of claim 1 further comprising, upon receipt of a consumer job request, engaging a property manager through a property manager device and obtaining approval of the consumer job request as a condition for generating a plurality of provider job requests for the service providers.

10. The method of claim 9 further comprising, obtaining additional job information from the provider through the provider device and directing the additional information to the property manager device for obtaining approval of the consumer job request.

11. A system for the on-demand provision of a property service job comprising:
a computing system with at least one processor, the system configured for interfacing with a plurality of remote devices and maintaining a plurality of profiles for service providers that provide property services;
at least one consumer device including at least one processor, the consumer device configured for capturing a consumer job request from a consumer for a job at a jobsite and interfacing with the computing system;
at least one provider device including at least one processor and configured for receiving provider job requests from the computing system;
the computing system configured for generating a plurality of provider job requests for one or more service providers in response to receiving a consumer job request, a provider job request being associated with the job and job site associated with the consumer;
the computing system further configured for directing job requests to devices of a plurality of service providers in a sequential fashion controlled by provider criteria; the at least one provider device configured for generating an acceptance of the provider of a service provider;
the computing system further configured, upon receiving an acceptance of the job request from the provider device, for generating a timer that is associated with the job, the timer configured for being started and stopped with the device of the service provider based on approval from the consumer for the start of a timer through the consumer device;
the computing system monitoring a subsequent progression of the timer associated with the job.

12. The system of claim 11 wherein the computing system is further configured for evaluating a stop of the timer through a provider device, and upon a requested restart of the timer through a provider device, communicating information of the restart of the timer to the consumer device for obtaining approval through the consumer device before a restart of the timer.

13. The system of claim 11 wherein the computing system is further configured for determining, at a stop of the timer, the status of the job, the status of the job including at least one of paused, suspended or finished.

14. The system of claim 11 wherein the computing system is further configured for directing job requests in a sequential fashion using provider criteria including at least one of the location of the provider with respect to the job site, the favorite status of the provider, service type of the job, the years of experience of a provider, the trade licensing of a provider, the work status of a provider.

15. The system of claim 11 wherein the computing system is further configured for directing job requests to provider devices of a plurality of service providers in a sequential fashion including directing job requests based on one set of provider criteria for a first duration and based on another set of provider criteria for another duration.

16. The system of claim 11 wherein the computing system is further configured for determining, at a stop of the timer, that the job has a finished status, and obtaining additional job information through the provider device.

17. The system of claim 16 wherein additional job information from the provider include pre-job information and post-job information.

18. The system of claim 11 wherein the computing system is further configured for determining a charge to the consumer for the job based upon the timer associated with the job and the additional job information.

19. The system of claim 11 further comprising at least one property manager device, wherein the computing system is further configured for, upon receipt of a consumer job request, engaging a property manager through the property manager device and obtaining approval of the consumer job request as a condition for generating a plurality of provider job requests for the service providers.

20. The system of claim 11 wherein the computing system is further configured for obtaining additional job information from the provider through the provider device and directing the additional information to the property manager device for obtaining approval of the consumer job request.
